(19) United States
(12) Patent Application Publication
(10) Pub. No.: US 2022/0246538 A1
(43) Pub. Date: Aug. 4, 2022

(54) CIRCUIT BOARD, SEMICONDUCTOR APPARATUS, AND ELECTRONIC EQUIPMENT

(71) Applicant: SONY SEMICONDUCTOR SOLUTIONS CORPORATION, KANAGAWA (JP)

(72) Inventors: TAKASHI MIYAMOTO, KANAGAWA (JP); TORU AKISHITA, KANAGAWA (JP); HARUNAGA HIWATARI, KANAGAWA (JP)

(21) Appl. No.: 17/309,714

(22) PCT Filed: Dec. 13, 2019
(86) PCT No.: PCT/JP2019/048896

§ 371 Date: Jun. 16, 2021

(30) Foreign Application Priority Data
Dec. 26, 2018 (JP) 2018-242203

(51) Int. Cl. H01L 23/552; H01L 27/146; H01L 23/00; H04N 5/374; H04L 9/30; H04L 9/08

(52) U.S. Cl. CPC H01L 23/552; H01L 2224/08145; H01L 27/14634; H01L 24/05; H01L 24/08; H01L 23/573; H01L 23/576; H04N 5/374; H04L 9/30; H04L 9/088; H01L 2224/05624; H01L 2224/05647; H01L 2224/05644; H01L 2224/05578; H01L 27/1464

(57) ABSTRACT

The present technology relates to a semiconductor apparatus and electronic equipment that are configured to make it possible to take measures more effectively against malfunctions arising from electromagnetic waves. A semiconductor apparatus includes a first base that transmits at least part of an electromagnetic wave, a first transistor group related to to-be-protected information, and an electromagnetic-wave attenuating unit that is provided in at least part of a region between the first base and the first transistor group and attenuates the electromagnetic wave. The present technology can be applied to a solid-state image pickup apparatus and the like, for example.

### TECHNICAL FIELD

The present technology relates to a semiconductor apparatus and electronic equipment, and in particular relates to a semiconductor apparatus and electronic equipment that are configured to make it possible to take measures more effectively against malfunctions arising from electromagnetic waves.

### BACKGROUND ART

As a method of enhancing the tamper resistance to attacks on particular portions, for example, microprobing, fault injection, electromagnetic wave analysis, and the like, that are made on the basis of knowledge about the layout of functional blocks in semiconductor chips, there is a method of stacking multiple IC chips that execute the same encryption computation in parallel (see PTL 1, for example). This is one example of a method of taking measures against malfunctions arising from electromagnetic waves that come from the outside of a semiconductor apparatus (hereinafter, referred to as externally-generated electromagnetic waves).

In addition, as a method of providing a sensing apparatus that can sense side channel attacks, there is a method of deciding the approach to a probe or the opening of an LSI package by a side channel attack, on the basis of an output of sensing means that has a coil as an inductor or a capacitor arranged near an information processing apparatus such as an encryption processing circuit to be a target of the side channel attack and senses changes of the inductance of the coil or the capacitance of the capacitor (see PTL 2, for example). This is one example of a method of taking measures against malfunctions arising from electromagnetic waves that leak from the inside of a semiconductor apparatus (hereinafter, referred to as leaked electromagnetic waves).

### CITATION LIST

### Patent Literature

### [PTL 1]

Japanese Patent Laid-open No. 2016-58777

### [PTL 2]

Japanese Patent Laid-open No. 2017-79336

### SUMMARY

### Technical Problem

It should be noted however that the technologies disclosed in PTL 1 and PTL 2 mentioned above do not take into consideration cases in which a semiconductor has a backside-type structure, and a structure that is suitable for a semiconductor with a backside-type structure is desired.

The present technology has been made in view of such a situation and is to make it possible to take measures more effectively against malfunctions arising from electromagnetic waves.

### Solution to Problem

A semiconductor apparatus of a first aspect of the present technology includes a first base that transmits at least part of an electromagnetic wave, a first transistor group related to to-be-protected information, and an electromagnetic-wave attenuating unit that is provided in at least part of a region between the first base and the first transistor group and attenuates the electromagnetic wave.

Electronic equipment of a second aspect of the present technology includes a semiconductor apparatus, the semiconductor apparatus including a first base that transmits at least part of an electromagnetic wave, a first transistor group related to to-be-protected information, and an electromagnetic-wave attenuating unit that is provided in at least part of a region between the first base and the first transistor group and attenuates the electromagnetic wave.

In the configurations in the first and second aspects of the present technology, provided are a first base that transmits at least part of an electromagnetic wave, a first transistor group related to to-be-protected information, and an electromagnetic-wave attenuating unit that is provided in at least part of a region between the first base and the first transistor group and attenuates the electromagnetic wave.

The semiconductor apparatus and the electronic equipment may be independent apparatuses or may be modules to be incorporated into other apparatuses.

### BRIEF DESCRIPTION OF DRAWINGS

FIG. 1 is a figure for explaining a change of an induced electromotive force as a result of a change of a conductor loop.

FIG. 2 is a block diagram depicting a configuration example of a solid-state image pickup apparatus to which the present technology is applied.

FIG. 3 is a block diagram depicting main constituent element examples of a pixel/analog processing unit.

FIG. 4 is a figure depicting a detailed configuration example of a pixel array.

FIG. 5 is a circuit diagram depicting a configuration example of a pixel.

FIG. 6 is a block diagram depicting a cross-sectional structure example of the solid-state image pickup apparatus.

FIG. 7 is a schematic configuration diagram depicting planar arrangement examples of circuit blocks including regions where active element groups are formed.

FIG. 8 is a figure depicting an example of a positional relation between a target region to be blocked off from light by a light-blocking structure, and an active element group region and a buffer region.

FIG. 9 is a figure depicting a first comparative example of conductor layers A and B.

FIG. 10 is a figure depicting the condition of electric currents flowing in the first comparative example.

FIG. 11 is a figure depicting a result of a simulation of inductive noise corresponding to the first comparative example.

FIG. 12 is a figure depicting a first configuration example of the conductor layers A and B.

FIG. 13 is a figure depicting the condition of electric currents flowing in the first configuration example.

FIG. 14 is a figure depicting a result of a simulation of inductive noise corresponding to the first configuration example.

FIG. 15 is a figure depicting a second configuration example of the conductor layers A and B.

FIG. 16 is a figure depicting the condition of electric currents flowing in the second configuration example.

FIG. 17 is a figure depicting a result of a simulation of inductive noise corresponding to the second configuration example.

FIG. 18 is a figure depicting a second comparative example of the conductor layers A and B.

FIG. 19 is a figure depicting a result of a simulation of inductive noise corresponding to the second comparative example.

FIG. 20 is a figure depicting a third comparative example of the conductor layers A and B.

FIG. 21 is a figure depicting a result of a simulation of inductive noise corresponding to the third comparative example.

FIG. 22 is a figure depicting a third configuration example of the conductor layers A and B.

FIG. 23 is a figure depicting the condition of electric currents flowing in the third configuration example.

FIG. 24 is a figure depicting a result of a simulation of inductive noise corresponding to the third configuration example.

FIG. 25 is a figure depicting a fourth configuration example of the conductor layers A and B.

FIG. 26 is a figure depicting a fifth configuration example of the conductor layers A and B.

FIG. 27 is a figure depicting a sixth configuration example of the conductor layers A and B.

FIG. 28 is a figure depicting results of simulations of inductive noise corresponding to the fourth to sixth configuration examples.

FIG. 29 is a figure depicting a seventh configuration example of the conductor layers A and B.

FIG. 30 is a figure depicting the condition of electric currents flowing in the seventh configuration example.

FIG. 31 is a figure depicting a result of a simulation of inductive noise corresponding to the seventh configuration example.

FIG. 32 is a figure depicting an eighth configuration example of the conductor layers A and B.

FIG. 33 is a figure depicting a ninth configuration example of the conductor layers A and B.

FIG. 34 is a figure depicting a tenth configuration example of the conductor layers A and B.

FIG. 35 is a figure depicting results of simulations of inductive noise corresponding to the eighth to tenth configuration examples.

FIG. 36 is a figure depicting an eleventh configuration example of the conductor layers A and B.

FIG. 37 is a figure depicting the condition of electric currents flowing in the eleventh configuration example.

FIG. 38 is a figure depicting a result of a simulation of inductive noise corresponding to the eleventh configuration example.

FIG. 39 is a figure depicting a twelfth configuration example of the conductor layers A and B.

FIG. 40 is a figure depicting a thirteenth configuration example of the conductor layers A and B.

FIG. 41 is a figure depicting results of simulations of inductive noise corresponding to the twelfth and thirteenth configuration examples.

FIG. 42 is a plan view depicting a first arrangement example of pads in a semiconductor board.

FIG. 43 is a plan view depicting a second arrangement example of pads in the semiconductor board.

FIG. 44 is a plan view depicting a third arrangement example of pads in the semiconductor board.

FIG. 45 is a figure depicting examples of conductors with an X-direction resistance value and a Y-direction resistance value that are different from each other.

FIG. 46 is a figure depicting a modification example in which X-direction conductor pitches in the second configuration example of the conductor layers A and B are halved, and depicting an effect attained thereby.

FIG. 47 is a figure depicting a modification example in which the X-direction conductor pitches in the fifth configuration example of the conductor layers A and B are halved, and depicting an effect attained thereby.

FIG. 48 is a figure depicting a modification example in which the X-direction conductor pitches in the sixth configuration example of the conductor layers A and B are halved, and depicting an effect attained thereby.

FIG. 49 is a figure depicting a modification example in which Y-direction conductor pitches in the second configuration example of the conductor layers A and B are halved, and depicting an effect attained thereby.

FIG. 50 is a figure depicting a modification example in which the Y-direction conductor pitches in the fifth configuration example of the conductor layers A and B are halved, and depicting an effect attained thereby.

FIG. 51 is a figure depicting a modification example in which the Y-direction conductor pitches in the sixth configuration example of the conductor layers A and B are halved, and depicting an effect attained thereby.

FIG. 52 is a figure depicting a modification example in which X-direction conductor widths in the second configuration example of the conductor layers A and B are doubled, and depicting an effect attained thereby.

FIG. 53 is a figure depicting a modification example in which the X-direction conductor widths in the fifth configuration example of the conductor layers A and B are doubled, and depicting an effect attained thereby.

FIG. 54 is a figure depicting a modification example in which the X-direction conductor widths in the sixth configuration example of the conductor layers A and B are doubled, and depicting an effect attained thereby.

FIG. 55 is a figure depicting a modification example in which Y-direction conductor widths in the second configuration example of the conductor layers A and B are doubled, and depicting an effect attained thereby.

FIG. 56 is a figure depicting a modification example in which the Y-direction conductor widths in the fifth configuration example of the conductor layers A and B are doubled, and depicting an effect attained thereby.

FIG. 57 is a figure depicting a modification example in which the Y-direction conductor widths in the sixth configuration example of the conductor layers A and B are doubled, and depicting an effect attained thereby.

FIG. 58 is a figure depicting modification examples of mesh conductors forming each configuration example of the conductor layers A and B.

FIG. 59 is a figure for explaining an enhancement of the degree of freedom of layouts.

FIG. 60 is a figure for explaining reductions of voltage drops (IR-Drop).

FIG. 61 is a figure for explaining reductions of voltage drops (IR-Drop).

FIG. 62 is a figure for explaining reductions of capacitive noise.

FIG. 63 is figure for explaining main conductor sections and lead conductor sections of conductor layers.

FIG. 64 is a figure depicting the eleventh configuration example of the conductor layers A and B.

FIG. 65 is a figure depicting a fourteenth configuration example of the conductor layers A and B.

FIG. 66 is a figure depicting a first modification example of the fourteenth configuration example of the conductor layers A and B.

FIG. 67 is a figure depicting a second modification example of the fourteenth configuration example of the conductor layers A and B.

FIG. 68 is a figure depicting a third modification example of the fourteenth configuration example of the conductor layers A and B.

FIG. 69 is a figure depicting a fifteenth configuration example of the conductor layers A and B.

FIG. 70 is a figure depicting a first modification example of the fifteenth configuration example of the conductor layers A and B.

FIG. 71 is a figure depicting a second modification example of the fifteenth configuration example of the conductor layers A and B.

FIG. 72 is a figure depicting a sixteenth configuration example of the conductor layers A and B.

FIG. 73 is a figure depicting a first modification example of the sixteenth configuration example of the conductor layers A and B.

FIG. 74 is a figure depicting a second modification example of the sixteenth configuration example of the conductor layers A and B.

FIG. 75 is a figure depicting a seventeenth configuration example of the conductor layers A and B.

FIG. 76 is a figure depicting a first modification example of the seventeenth configuration example of the conductor layers A and B.

FIG. 77 is a figure depicting a second modification example of the seventeenth configuration example of the conductor layers A and B.

FIG. 78 is a figure depicting an eighteenth configuration example of the conductor layers A and B.

FIG. 79 is a figure depicting a nineteenth configuration example of the conductor layers A and B.

FIG. 80 is a figure depicting a modification example of the nineteenth configuration example of the conductor layers A and B.

FIG. 81 is a figure depicting a twentieth configuration example of the conductor layers A and B.

FIG. 82 is a figure depicting a twenty-first configuration example of the conductor layers A and B.

FIG. 83 is a figure depicting a twenty-second configuration example of the conductor layers A and B.

FIG. 84 is a figure depicting another configuration example of the conductor layer B in the twenty-second configuration example.

FIG. 85 is a figure depicting a twenty-third configuration example of the conductor layers A and B.

FIG. 86 is a figure depicting a twenty-fourth configuration example of the conductor layers A and B.

FIG. 87 is a figure depicting a twenty-fifth configuration example of the conductor layers A and B.

FIG. 88 is a figure depicting a twenty-sixth configuration example of the conductor layers A and B.

FIG. 89 is a figure depicting a twenty-seventh configuration example of the conductor layers A and B.

FIG. 90 is a figure depicting a twenty-eighth configuration example of the conductor layers A and B.

FIG. 91 is a figure depicting other configuration examples of the conductor layer A in the twenty-eighth configuration example.

FIG. 92 is a plan view depicting the whole of the conductor layer A formed on a board.

FIG. 93 is a plan view depicting a fourth arrangement example of pads.

FIG. 94 is a plan view depicting a fifth arrangement example of pads.

FIG. 95 is a plan view depicting a sixth arrangement example of pads.

FIG. 96 is a plan view depicting a seventh arrangement example of pads.

FIG. 97 is a plan view depicting an eighth arrangement example of pads.

FIG. 98 is a plan view depicting a ninth arrangement example of pads.

FIG. 99 is a plan view depicting a tenth arrangement example of pads.

FIG. 100 is a plan view depicting an eleventh arrangement example of pads.

FIG. 101 is a plan view depicting a twelfth arrangement example of pads.

FIG. 102 is a plan view depicting a thirteenth arrangement example of pads.

FIG. 103 is a plan view depicting a fourteenth arrangement example of pads.

FIG. 104 is a plan view depicting a fifteenth arrangement example of pads.

FIG. 105 is a plan view depicting a sixteenth arrangement example of pads.

FIG. 106 is a plan view depicting a seventeenth arrangement example of pads.

FIG. 107 is a plan view depicting an eighteenth arrangement example of pads.

FIG. 108 is a plan view depicting a nineteenth arrangement example of pads.

FIG. 109 is a cross-sectional view depicting board arrangement examples of a Victim conductor loop and Aggressor conductor loops.

FIG. 110 is a cross-sectional view depicting board arrangement examples of the Victim conductor loop and the Aggressor conductor loops.

FIG. 111 is a figure for explaining arrangement examples of the Victim conductor loop and the Aggressor conductor loops in a structure in which three types of board are stacked.

FIG. 112 is a figure for explaining arrangement examples of the Victim conductor loop and the Aggressor conductor loops in structures in which the three types of board are stacked.

FIG. 113 is a figure depicting package stacking examples of a first semiconductor board and a second semiconductor board forming the solid-state image pickup apparatus.

FIG. 114 is a cross-sectional view depicting configuration examples provided with conductive shields.

FIG. 115 is a cross-sectional view depicting configuration examples provided with conductive shields.

FIG. 116 is a figure depicting a first configuration example of the arrangement of a conductive shield relative to signal lines, and a planar shape.

FIG. 117 is a figure depicting a second configuration example of the arrangement of a conductive shield relative to signal lines, and a planar shape.

FIG. 118 is a figure depicting a third configuration example of the arrangement of a conductive shield relative to signal lines, and a planar shape.

FIG. 119 is a figure depicting a fourth configuration example of the arrangement of a conductive shield relative to signal lines, and a planar shape.

FIG. 120 is a figure depicting arrangement examples in a case in which there are three conductor layers.

FIG. 121 is a figure for explaining a problem in a case in which there are three conductor layers.

FIG. 122 is a figure depicting a first configuration example of three conductor layers.

FIG. 123 is a figure depicting a second configuration example of three conductor layers.

FIG. 124 is a figure depicting a first modification example of the second configuration example of three conductor layers.

FIG. 125 is a figure depicting a second modification example of the second configuration example of three conductor layers.

FIG. 126 is a figure depicting a third configuration example of three conductor layers.

FIG. 127 is a figure depicting a modification example of the third configuration example of three conductor layers.

FIG. 128 is a figure depicting a fourth configuration example of three conductor layers.

FIG. 129 is a figure depicting a first modification example of the fourth configuration example of three conductor layers.

FIG. 130 is a figure depicting a second modification example of the fourth configuration example of three conductor layers.

FIG. 131 is a figure depicting a fifth configuration example of three conductor layers.

FIG. 132 is a figure depicting a sixth configuration example of three conductor layers.

FIG. 133 is a figure depicting a modification example of the sixth configuration example of three conductor layers.

FIG. 134 is a figure depicting a seventh configuration example of three conductor layers.

FIG. 135 is a figure depicting an eighth configuration example of three conductor layers.

FIG. 136 is a figure depicting a first modification example of the eighth configuration example of three conductor layers.

FIG. 137 is a figure depicting a second modification example of the eighth configuration example of three conductor layers.

FIG. 138 is a figure depicting a third modification example of the eighth configuration example of three conductor layers.

FIG. 139 is a figure depicting a fourth modification example of the eighth configuration example of three conductor layers.

FIG. 140 is a figure depicting a fifth modification example of the eighth configuration example of three conductor layers.

FIG. 141 is a figure depicting a ninth configuration example of three conductor layers.

FIG. 142 is a figure depicting a first modification example of the ninth configuration example of three conductor layers.

FIG. 143 is a figure depicting a second modification example of the ninth configuration example of three conductor layers.

FIG. 144 is a figure depicting a third modification example of the ninth configuration example of three conductor layers.

FIG. 145 is a figure depicting a fourth modification example of the ninth configuration example of three conductor layers.

FIG. 146 is a figure depicting a tenth configuration example of three conductor layers.

FIG. 147 is a figure depicting a modification example of the tenth configuration example of three conductor layers.

FIG. 148 is a figure depicting an eleventh configuration example of three conductor layers.

FIG. 149 is a figure depicting a twelfth configuration example of three conductor layers.

FIG. 150 is a figure depicting a first modification example of the twelfth configuration example of three conductor layers.

FIG. 151 is a figure depicting a second modification example of the twelfth configuration example of three conductor layers.

FIG. 152 is a figure depicting a thirteenth configuration example of three conductor layers.

FIG. 153 is a figure depicting a fourteenth configuration example of three conductor layers.

FIG. 154 is a figure depicting a first modification example of the fourteenth configuration example of three conductor layers.

FIG. 155 is a figure depicting a second modification example of the fourteenth configuration example of three conductor layers.

FIG. 156 is a figure depicting a third modification example to a fifth modification example of the fourteenth configuration example of three conductor layers.

FIG. 157 is a figure depicting a sixth modification example to an eighth modification example of the fourteenth configuration example of three conductor layers.

FIG. 158 is a figure depicting a ninth modification example to an eleventh modification example of the fourteenth configuration example of three conductor layers.

FIG. 159 is a figure depicting a twelfth modification example to a fourteenth modification example of the fourteenth configuration example of three conductor layers.

FIG. 160 is a figure depicting a fifteenth modification example to a seventeenth modification example of the fourteenth configuration example of three conductor layers.

FIG. 161 is a figure depicting an eighteenth modification example to a twentieth modification example of the fourteenth configuration example of three conductor layers.

FIG. 162 is a figure depicting a twenty-first modification example to a twenty-third modification example of the fourteenth configuration example of three conductor layers.

FIG. 163 is a figure depicting a twenty-fourth modification example to a twenty-sixth modification example of the fourteenth configuration example of three conductor layers.

FIG. 164 is a figure for explaining capacitive noise of a mesh conductor.

FIG. 165 is a figure for explaining capacitive noise of a mesh conductor for which a predetermined displacement amount is set.

FIG. 166 is a figure for explaining conductor widths and gap widths in a first displacement configuration example of a mesh conductor.

FIG. 167 is a plan view of the first displacement configuration example of a mesh conductor.

FIG. 168 is a plan view of the first displacement configuration example of a mesh conductor.

FIG. 169 is a figure depicting theoretical values of capacitive noise in the first displacement configuration example.

FIG. 170 is a figure depicting theoretical values of capacitive noise in the first displacement configuration example.

FIG. 171 is a figure for explaining a definition of a mesh conductor.

FIG. 172 is a figure for explaining a definition of a mesh conductor.

FIG. 173 is a plan view depicting first and second modification examples of the first displacement configuration example.

FIG. 174 is a plan view depicting third and fourth modification examples of the first displacement configuration example.

FIG. 175 is a plan view depicting fifth and sixth modification examples of the first displacement configuration example.

FIG. 176 is a plan view depicting seventh and eighth modification examples of the first displacement configuration example.

FIG. 177 is a plan view depicting ninth and tenth modification examples of the first displacement configuration example.

FIG. 178 is a plan view depicting eleventh and twelfth modification examples of the first displacement configuration example.

FIG. 179 is a plan view depicting thirteenth and fourteenth modification examples of the first displacement configuration example.

FIG. 180 is a plan view depicting fifteenth and sixteenth modification examples of the first displacement configuration example.

FIG. 181 is a plan view depicting seventeenth and eighteenth modification examples of the first displacement configuration example.

FIG. 182 is a plan view of a second displacement configuration example of a mesh conductor.

FIG. 183 is a figure depicting theoretical values of capacitive noise in the second displacement configuration example.

FIG. 184 is a figure depicting theoretical values of capacitive noise in the second displacement configuration example.

FIG. 185 is a figure for explaining conductor widths and gap widths in a third displacement configuration example of a mesh conductor.

FIG. 186 is a plan view of the third displacement configuration example of a mesh conductor.

FIG. 187 is a plan view of the third displacement configuration example of a mesh conductor.

FIG. 188 is a figure depicting theoretical values of capacitive noise in the third displacement configuration example.

FIG. 189 is a figure depicting theoretical values of capacitive noise in the third displacement configuration example.

FIG. 190 is a figure for explaining conductor widths and gap widths in a fourth displacement configuration example of a mesh conductor.

FIG. 191 is a plan view of the fourth displacement configuration example of a mesh conductor.

FIG. 192 is a plan view of the fourth displacement configuration example of a mesh conductor.

FIG. 193 is a figure depicting theoretical values of capacitive noise in the fourth displacement configuration example.

FIG. 194 is a figure depicting theoretical values of capacitive noise in the fourth displacement configuration example.

FIG. 195 is a figure for explaining conductor widths and gap widths in a fifth displacement configuration example of a mesh conductor.

FIG. 196 is a plan view of the fifth displacement configuration example of a mesh conductor.

FIG. 197 is a plan view of the fifth displacement configuration example of a mesh conductor.

FIG. 198 is a plan view of the fifth displacement configuration example of a mesh conductor.

FIG. 199 is a figure depicting theoretical values of capacitive noise in the fifth displacement configuration example.

FIG. 200 is a figure depicting theoretical values of capacitive noise in the fifth displacement configuration example.

FIG. 201 is a figure for explaining conductor widths and gap widths in a sixth displacement configuration example of a mesh conductor.

FIG. 202 is a plan view of the sixth displacement configuration example of a mesh conductor.

FIG. 203 is a plan view of the sixth displacement configuration example of a mesh conductor.

FIG. 204 is a figure depicting theoretical values of capacitive noise in the sixth displacement configuration example.

FIG. 205 is a figure depicting theoretical values of capacitive noise in the sixth displacement configuration example.

FIG. 206 is a figure for explaining conductor widths and gap widths in a seventh displacement configuration example of a mesh conductor.

FIG. 207 is a plan view of the seventh displacement configuration example of a mesh conductor.

FIG. 208 is a plan view of the seventh displacement configuration example of a mesh conductor.

FIG. 209 is a figure depicting theoretical values of capacitive noise in the seventh displacement configuration example.

FIG. 210 is a figure depicting theoretical values of capacitive noise in the seventh displacement configuration example.

FIG. 211 includes conceptual diagrams depicting cases in which the solid-state image pickup apparatus has two power supplies and three power supplies.

FIG. 212 is a plan view of a first configuration example of three power supplies.

FIG. 213 is a plan view of the first configuration example of three power supplies.

FIG. 214 is a plan view of a first modification example of the first configuration example of three power supplies.

FIG. 215 is a plan view of the first modification example of the first configuration example of three power supplies.

FIG. 216 is a plan view of a second modification example of the first configuration example of three power supplies.

FIG. 217 is a plan view of the second modification example of the first configuration example of three power supplies.

FIG. 218 is a plan view of a third modification example of the first configuration example of three power supplies.

FIG. 219 is a plan view of the third modification example of the first configuration example of three power supplies.

FIG. 220 is a plan view of a fourth modification example of the first configuration example of three power supplies.

FIG. 221 is a plan view of the fourth modification example of the first configuration example of three power supplies.

FIG. 222 is a plan view of a second configuration example of three power supplies.

FIG. 223 is a plan view of the second configuration example of three power supplies.

FIG. 224 is a plan view of the second configuration example of three power supplies.

FIG. 225 is a plan view of the second configuration example of three power supplies.

FIG. 226 is a plan view of a first modification example of the second configuration example of three power supplies.

FIG. 227 is a plan view of a second modification example of the second configuration example of three power supplies.

FIG. 228 is a plan view of a third configuration example of three power supplies.

FIG. 229 is a plan view of the third configuration example of three power supplies.

FIG. 230 is a plan view of the third configuration example of three power supplies.

FIG. 231 is a plan view of the third configuration example of three power supplies.

FIG. 232 is a plan view of a first modification example of the third configuration example of three power supplies.

FIG. 233 is a plan view of the first modification example of the third configuration example of three power supplies.

FIG. 234 is a plan view of a second modification example of the third configuration example of three power supplies.

FIG. 235 is a plan view of a third modification example of the third configuration example of three power supplies.

FIG. 236 is a plan view of a fourth modification example and a fifth modification example of the third configuration example of three power supplies.

FIG. 237 is a plan view of a fourth configuration example of three power supplies.

FIG. 238 is a plan view of the fourth configuration example of three power supplies.

FIG. 239 is a plan view of the fourth configuration example of three power supplies.

FIG. 240 is a plan view of the fourth configuration example of three power supplies.

FIG. 241 is a plan view of a fifth configuration example of three power supplies.

FIG. 242 is a plan view of the fifth configuration example of three power supplies.

FIG. 243 is a plan view of the fifth configuration example of three power supplies.

FIG. 244 is a plan view of the fifth configuration example of three power supplies.

FIG. 245 is a plan view of a first modification example of the fifth configuration example of three power supplies.

FIG. 246 is a plan view of the first modification example of the fifth configuration example of three power supplies.

FIG. 247 is a plan view of a second modification example and a third modification example of the fifth configuration example of three power supplies.

FIG. 248 is a plan view of a sixth configuration example of three power supplies.

FIG. 249 is a plan view of a first modification example of the sixth configuration example of three power supplies.

FIG. 250 is a plan view of a second modification example of the sixth configuration example of three power supplies.

FIG. 251 is a plan view of a third modification example of the sixth configuration example of three power supplies.

FIG. 252 is a plan view of a fourth modification example of the sixth configuration example of three power supplies.

FIG. 253 is a plan view of a fifth modification example of the sixth configuration example of three power supplies.

FIG. 254 is a plan view of a seventh configuration example of three power supplies.

FIG. 255 is a plan view of a modification example of the seventh configuration example of three power supplies.

FIG. 256 is a plan view of an eighth configuration example of three power supplies.

FIG. 257 is a plan view of a first modification example of the eighth configuration example of three power supplies.

FIG. 258 is a plan view of a second modification example of the eighth configuration example of three power supplies.

FIG. 259 is a plan view of a third modification example of the eighth configuration example of three power supplies.

FIG. 260 is a plan view of a fourth modification example of the eighth configuration example of three power supplies.

FIG. 261 is a plan view of a ninth configuration example of three power supplies.

FIG. 262 is a block diagram depicting a configuration example of an image pickup apparatus.

FIG. 263 is a cross-sectional view depicting a schematic configuration example of a back-illuminated image sensor including a to-be-protected circuit.

FIG. 264 is a cross-sectional view depicting a first stacked structure example of a solid-state image pickup apparatus to which the present technology is applied.

FIG. 265 is a cross-sectional view depicting a second stacked structure example of the solid-state image pickup apparatus to which the present technology is applied.

FIG. 266 is a cross-sectional view depicting a modification example of the second stacked structure example of the solid-state image pickup apparatus to which the present technology is applied.

FIG. 267 is a cross-sectional view depicting a third stacked structure example of the solid-state image pickup apparatus to which the present technology is applied.

FIG. 268 is a more detailed cross-sectional view of the modification example of the second stacked structure example.

FIG. 269 is a figure for explaining effects of an electromagnetic-wave attenuating unit.

FIG. 270 is a figure for explaining effects of the electromagnetic-wave attenuating unit.

FIG. 271 is a figure for explaining effects of the electromagnetic-wave attenuating unit.

FIG. 272 is a figure for explaining effects of the electromagnetic-wave attenuating unit.

FIG. 273 is a figure for explaining effects of the electromagnetic-wave attenuating unit.

FIG. 274 is a figure for explaining a positional relation between the electromagnetic-wave attenuating unit and the to-be-protected circuit.

FIG. 275 is a figure for explaining the positional relation between the electromagnetic-wave attenuating unit and the to-be-protected circuit.

FIG. 276 is a figure for explaining the positional relation between the electromagnetic-wave attenuating unit and the to-be-protected circuit.

FIG. 277 is a figure for explaining an attack probe.

FIG. 278 is a figure for explaining a sensing region where an attack probe is sensed and a sensing circuit that senses the attack probe.

FIG. 279 is a block diagram depicting a main circuit configuration of the solid-state image pickup apparatus to which the present technology is applied.

FIG. 280 is a flowchart of a first basic process of performing an authentication process including a probe-deciding process.

FIG. 281 is a flowchart depicting details of the authentication process in FIG. 280.

FIG. 282 is a flowchart depicting a first process that can be executed as the probe-deciding process in FIG. 281.

FIG. 283 is a flowchart depicting a second process that can be executed as the probe-deciding process in FIG. 281.

FIG. 284 is a flowchart of a second basic process of performing the authentication process including the probe-deciding process.

FIG. 285 is a flowchart of a third basic process of performing the authentication process including the probe-deciding process.

FIG. 286 is a schematic diagram of the solid-state image pickup apparatus in a case in which the solid-state image pickup apparatus includes an electromagnetic-wave sensing functionality.

FIG. 287 is a detailed cross-sectional view of a case in which the sensing region is formed in a multi-layer wiring layer of the second semiconductor board.

FIG. 288 is a detailed cross-sectional view of a case in which the sensing region is formed in a multi-layer wiring layer of the first semiconductor board.

FIG. 289 is a schematic diagram of the solid-state image pickup apparatus in which the sensing region is provided not to be superimposed on a pixel array.

FIG. 290 is a figure depicting an example of a case in which a sensing unit includes a coil.

FIG. 291 is a schematic diagram of the solid-state image pickup apparatus in which the sensing region is provided not to be superimposed on a to-be-protected region.

FIG. 292 is a schematic diagram of the solid-state image pickup apparatus in which the sensing region is provided not to be superimposed on the to-be-protected region.

FIG. 293 is a schematic diagram of the solid-state image pickup apparatus provided with dummy sensing regions.

FIG. 294 is a schematic diagram of the solid-state image pickup apparatus provided with the dummy sensing regions.

FIG. 295 is a schematic diagram of the solid-state image pickup apparatus in which a coil as the sensing unit includes a control line(s) or a signal line(s).

FIG. 296 is a block diagram depicting a circuit configuration example of the solid-state image pickup apparatus with a focus on the sensing unit.

FIG. 297 is a block diagram depicting a configuration example of the sensing unit in a case in which the sensing unit has multiple sensing regions.

FIG. 298 is a block diagram depicting a configuration example of the sensing unit in a case in which the sensing unit has multiple sensing regions.

FIG. 299 is a block diagram depicting a detailed configuration example of the sensing circuit.

FIG. 300 is a block diagram depicting circuit configuration examples of the solid-state image pickup apparatus additionally having a board-damage sensing functionality.

FIG. 301 is a flowchart of the authentication process in a case in which the authentication process is performed by using a change in an image-formation state.

FIG. 302 is a flowchart of the authentication process in a case in which the authentication process is performed by using a lens state.

FIG. 303 is a block diagram depicting a configuration example of an image pickup apparatus provided with a vibration unit.

FIG. 304 is a block diagram depicting an example of a schematic configuration of an in-vivo information acquisition system.

FIG. 305 is a view depicting an example of a schematic configuration of an endoscopic surgery system.

FIG. 306 is a block diagram depicting an example of a functional configuration of a camera head and a camera control unit (CCU).

FIG. 307 is a block diagram depicting an example of schematic configuration of a vehicle control system.

FIG. 308 is a diagram of assistance in explaining an example of installation positions of an outside-vehicle information detecting section and an imaging section.

### DESCRIPTION OF EMBODIMENTS

Hereinafter, best modes for carrying out the present technology (hereinafter, referred to as embodiments) are explained in detail with reference to the drawings. Note that explanations are given in the following order.

1. Victim Conductor Loop and Magnetic Flux

2. Configuration Example of Solid-State Image Pickup Apparatus which is Embodiment of Present Technology

3. Structure to Block Hot Carrier Light Emissions

4. Configuration Examples of Conductor Layers A and B

5. Arrangement Examples of Electrodes in Semiconductor Board in which Conductor Layers A and B are Formed

6. Modification Examples of Configuration Examples of Conductor Layers A and B

7. Modification Examples of Mesh Conductors

8. Various Effects

9. Configuration Examples with Different Lead Sections

10. Configuration Examples of Connections with Pads

11. Arrangement Examples of Conductive Shields

12. Configuration Examples in Case in which There are Three Conductor Layers

13. Application Examples

14. Displacement Configuration Examples of Mesh Conductor

15. Configuration Examples of Three Power Supplies

16. Configuration Examples of Image Pickup Apparatus

17. Configuration Example Taking into Consideration Tamper Resistance to Electromagnetic Waves

18. Examples of Application to In-vivo Information Acquisition System

19. Examples of Application to Endoscopic Surgery System

20. Examples of Application to Mobile Body

### 1. Victim Conductor Loop and Magnetic Flux

For example, in a case in which there is a circuit in which a Victim conductor loop is formed near a power supply wire in a solid-state image pickup apparatus (semiconductor apparatus) such as a CMOS image sensor, a change in magnetic flux passing across the loop plane of the Victim conductor loop changes an induced electromotive force generated to the Victim conductor loop, and generates noise in pixel signals in some cases. Note that it is sufficient if the Victim conductor loop at least partially includes a conductor. In addition, the Victim conductor loop may be entirely formed with a conductor.

Here, the Victim conductor loop (first conductor loop) means a conductor loop that is on the side to be influenced by a change of a magnetic field strength that occurs nearby. On the other hand, a conductor loop that is near the Victim conductor loop, generates a change of a magnetic field strength as a result of a change of a current flowing through the conductor loop, and is on the side to influence the Victim conductor loop is referred to as an Aggressor conductor loop (second conductor loop).

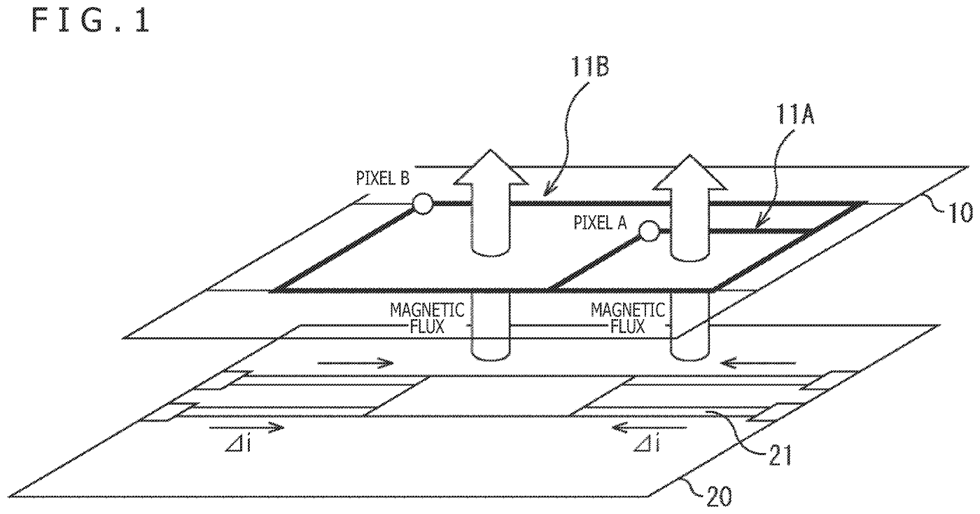

FIG. 1 is a figure for explaining a change of an induced electromotive force as a result of a change of the Victim conductor loop. For example, the solid-state image pickup apparatus such as a CMOS image sensor depicted in FIG. 1 includes a pixel board 10 and a logic board 20 that are stacked in this order from above. In the solid-state image pickup apparatus in FIG. 1, at least part of a Victim conductor loop 11 (11A and 11B) is formed in a pixel region of the pixel board 10, and a power supply wire 21 for supplying a (digital) power supply is formed near the Victim conductor loop 11 and on the logic board 20 stacked with the pixel board 10.

Then, magnetic flux generated by the power supply wire 21 passes across the loop plane of the Victim conductor loop 11 on the pixel board 10, and an induced electromotive force is generated to the Victim conductor loop 11 thereby.

Note that an induced electromotive force Vemf generated to the Victim conductor loop 11 can be computed according to the following Formulae (1) and (2). Note that Φ represents magnetic flux, H represents a magnetic field strength, μ represents permeability, and S represents the area size of the Victim conductor loop 11.

$$\begin{matrix}[ Math . 1 ] & \\ Φ = {\int }_{S} μ H \cdot d S & ( 1 ) \\ [ Math . 2 ] & \\ {V}_{emf} = - \frac{d Φ}{d t} & ( 2 )\end{matrix}$$

The loop path of the Victim conductor loop 11 formed in the pixel region of the pixel board 10 varies depending on the position of a pixel selected as a readout target pixel from which a pixel signal is to be read out. In the case of the example in FIG. 1, the loop path of the Victim conductor loop 11A formed when a pixel A is selected is different from the loop path of the Victim conductor loop 11B formed when a pixel B at a position different from the position of the pixel A is selected. In other words, the effective shape of the conductor loop changes depending on the position of a selected pixel.

If the loop path of the Victim conductor loop 11 changes in this manner, magnetic flux passing across the loop plane of the Victim conductor loop changes, and an induced electromotive force generated to the Victim conductor loop thereby changes significantly in some cases. In addition, as a result of the change of the induced electromotive force, noise (inductive noise) is generated to a pixel signal read out from a pixel in some cases. Then, the inductive noise generates stripe image noise to a captured image in some cases. That is, the image quality of the captured image lowers in some cases.

In view of this, the present disclosure proposes a technology of suppressing the occurrence of inductive noise as a result of an induced electromotive force in the Victim conductor loop.

### 2. Configuration Example of Solid-State Image Pickup Apparatus (Semiconductor Apparatus) which is Embodiment of Present Technology

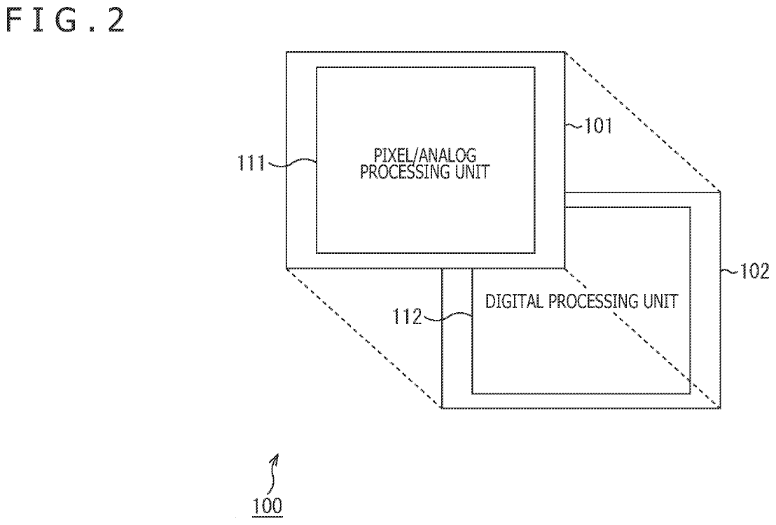

FIG. 2 is a block diagram depicting a main configuration example of the solid-state image pickup apparatus which is an embodiment of the present technology.

A solid-state image pickup apparatus 100 depicted in FIG. 2 is a device that photoelectrically converts light from a subject and outputs the photoelectrically converted light as image data. For example, the solid-state image pickup apparatus 100 is configured as a back-illuminated CMOS image sensor using a CMOS, or the like.

As depicted in FIG. 2, the solid-state image pickup apparatus 100 includes a first semiconductor board 101 and a second semiconductor board 102 that are stacked one on another.

A pixel/analog processing unit 111 having pixels, an analog circuit and the like is formed in the first semiconductor board 101. A digital processing unit 112 having a digital circuit and the like is formed in the second semiconductor board 102.

The first semiconductor board 101 and the second semiconductor board 102 are superimposed in a state in which the first semiconductor board 101 and the second semiconductor board 102 are insulated from each other. That is, configurations of the pixel/analog processing unit 111 and configurations of the second semiconductor board 102 are basically insulated from each other. Note that although an illustration is omitted, configurations formed in the pixel/analog processing unit 111 and configurations formed in the digital processing unit 112 are, as necessary (at sections that are necessary to be done so), electrically connected with each other via conductor vias, through silicon vias (TSV), junctions between the same type of metal such as Cu—Cu junctions, Au—Au junctions, or Al—Al junctions, junctions between different types of metal such as Cu—Au junctions, Cu—Al junctions, or Au—Al junctions, bonding wires, or the like, for example.

Note that while the solid-state image pickup apparatus 100 includes two stacked layers of boards in the example explained with reference to FIG. 2, the number of stacked layers of boards included in the solid-state image pickup apparatus 100 may be any number. For example, the number of stacked layers may be one, or three or larger. In the cases explained hereinafter, the solid-state image pickup apparatus 100 includes two layers of boards as in the example in FIG. 2.

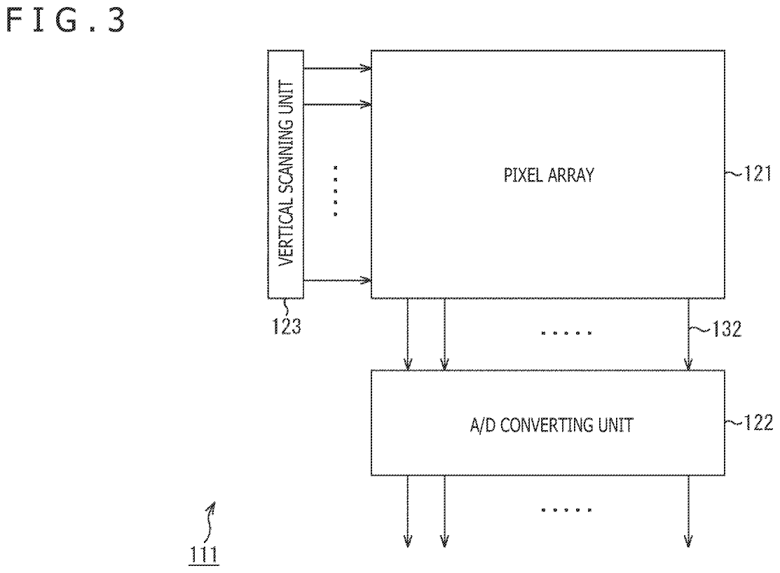

FIG. 3 is a block diagram depicting main constituent element examples formed in the pixel/analog processing unit 111.

As depicted in FIG. 3, a pixel array 121, an A/D converting unit 122, a vertical scanning unit 123, and the like are formed in the pixel/analog processing unit 111.

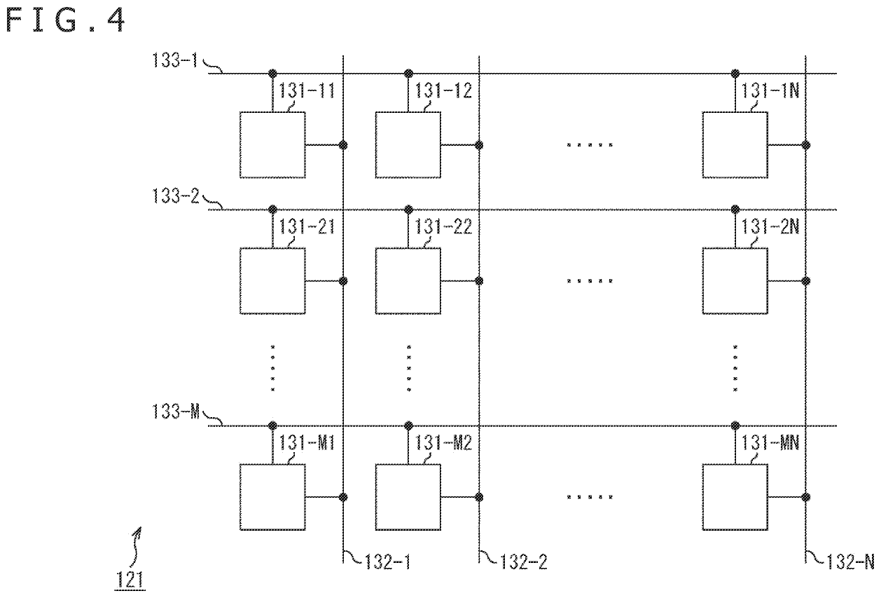

The pixel array 121 includes multiple pixels 131 (FIG. 4) that are arranged lengthwise and breadthwise, and each of the multiple pixels 131 has a photoelectric converting element such as a photodiode.

The A/D converting unit 122 A/D-converts an analog signal or the like read out from each pixel 131 in the pixel array 121 and outputs a digital pixel signal obtained as a result of the A/D conversion.

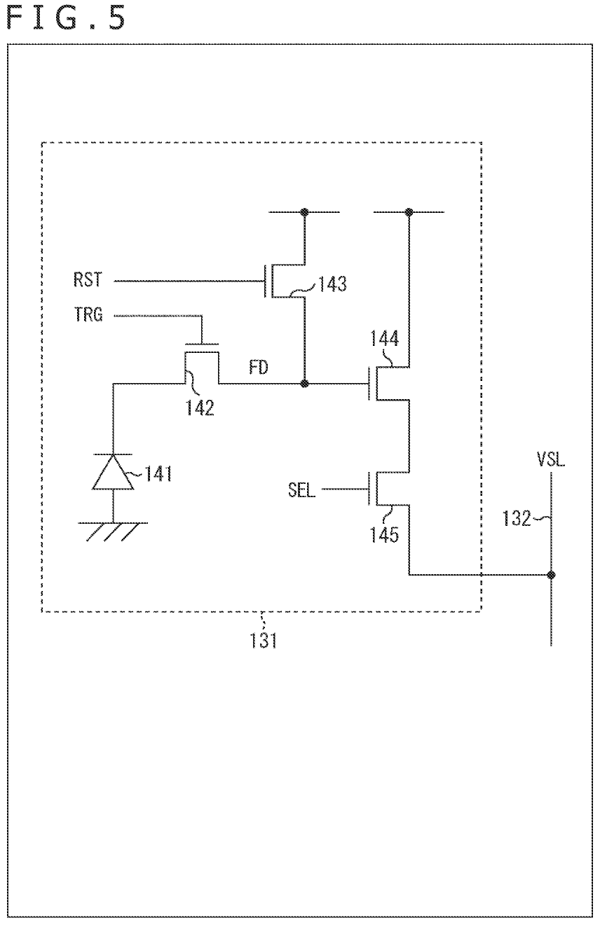

The vertical scanning unit 123 controls operation of a transistor (a transfer transistor 142 illustrated in FIG. 5 etc.) of each pixel 131 in the pixel array 121. That is, an electric charge accumulated in each pixel 131 in the pixel array 121 is read out under the control of the vertical scanning unit 123, is supplied as a pixel signal to the A/D converting unit 122 via a signal line 132 (FIG. 4) for each column of unit pixels, and is A/D-converted.

For each column of pixels 131, the A/D converting unit 122 supplies results of the A/D conversion (digital pixel signals) to a logic circuit (not depicted) formed in the digital processing unit 112.

FIG. 4 is a figure depicting a detailed configuration example of the pixel array 121. Pixels 131-11 to 131-MN are formed in the pixel array 121 (M and N are natural numbers). That is, in the pixel array 121, M rows and N columns of pixels 131 are arranged in a matrix (in an array). Hereinafter, the pixels 131-11 to 131-MN are referred to as pixels 131 in a case in which it is not necessary to distinguish between individual ones of them.

Signal lines 132-1 to 132-N and control lines 133-1 to 133-M are formed in the pixel array 121. Hereinafter, the signal lines 132-1 to 132-N are referred to as signal lines 132 in a case in which it is not necessary to distinguish between individual ones of them, and the control lines 133-1 to 133-M are referred to as control lines 133 in a case in which it is not necessary to distinguish between individual ones of them.

Each column of pixels 131 is connected with a signal line 132 corresponding to the column. In addition, each row of pixels 131 is connected to a control line 133 corresponding to the row. Control signals from the vertical scanning unit 123 are transferred to the pixels 131 via the control lines 133.

Analog pixel signals are output from the pixels 131 to the A/D converting unit 122 via the signal lines 132.

Next, FIG. 5 is a circuit diagram depicting a configuration example of a pixel 131. The pixel 131 has a photodiode 141 as a photoelectric converting element, a transfer transistor 142, a reset transistor 143, an amplification transistor 144, and a select transistor 145.

The photodiode 141 photoelectrically converts received light into an optical electric charge (here, photoelectrons) of an electric charge amount corresponding to the amount of the light and accumulates the optical electric charge. The anode electrode of the photodiode 141 is connected to GND, and the cathode electrode is connected to a floating diffusion (FD) via the transfer transistor 142. Needless to say, in one possible manner, the cathode electrode of the photodiode 141 may be connected to a power supply, the anode electrode may be connected to a floating diffusion via the transfer transistor 142, and an optical electric charge is read out as photoholes.

The transfer transistor 142 controls operation of reading out an optical electric charge from the photodiode 141. The drain electrode of the transfer transistor 142 is connected to the floating diffusion, and the source electrode is connected to the cathode electrode of the photodiode 141. In addition, the gate electrode of the transfer transistor 142 is connected with a transfer control line that transfers a transfer control signal TRG supplied from the vertical scanning unit 123 (FIG. 3). When the transfer control signal TRG (i.e., the gate potential of the transfer transistor 142) is in the OFF state, transfer of an optical electric charge from the photodiode 141 is not performed (an optical electric charge is accumulated in the photodiode 141). When the transfer control signal TRG (i.e., the gate potential of the transfer transistor 142) is in the ON state, an optical electric charge accumulated in the photodiode 141 is transferred to the floating diffusion.

The reset transistor 143 resets the potential of the floating diffusion. The drain electrode of the reset transistor 143 is connected to the power supply potential, and the source electrode is connected to the floating diffusion. In addition, the gate electrode of the reset transistor 143 is connected with a reset control line that transfers a reset control signal RST supplied from the vertical scanning unit 123. When the reset control signal RST (i.e., the gate potential of the reset transistor 143) is in the OFF state, the floating diffusion is disconnected from the power supply potential. When the reset control signal RST (i.e., the gate potential of the reset transistor 143) is in the ON state, an electric charge in the floating diffusion is discharged to the power supply potential, and the floating diffusion is reset.

The amplification transistor 144 outputs an electric signal (analog signal) (causes a current to flow) according to the voltage of the floating diffusion. The gate electrode of the amplification transistor 144 is connected to the floating diffusion, the drain electrode is connected to a (source follower) power supply voltage, and the source electrode is connected to the drain electrode of the select transistor 145. For example, the amplification transistor 144 outputs, to the select transistor 145 and as a pixel signal, a reset signal (reset level) as an electric signal according to the voltage of the floating diffusion reset by the reset transistor 143. In addition, the amplification transistor 144 outputs, to the select transistor 145 and as a pixel signal, an optical accumulation signal (signal level) as an electric signal according to the voltage of the floating diffusion to which an optical electric charge has been transferred by the transfer transistor 142.

The select transistor 145 controls output of the electric signal supplied from the amplification transistor 144 to a signal line (VSL) 132 (i.e., the A/D converting unit 122). The drain electrode of the select transistor 145 is connected to the source electrode of the amplification transistor 144, and the source electrode is connected to the signal line 132. In addition, the gate electrode of the select transistor 145 is connected with a select control line that transfers a select control signal SEL supplied from the vertical scanning unit 123. When the select control signal SEL (i.e., the gate potential of the select transistor 145) is in the OFF state, the amplification transistor 144 and the signal line 132 are electrically disconnected. Accordingly, in this state, a reset signal and an optical accumulation signal as pixel signals from the pixel 131 are not output. When the select control signal SEL (i.e., the gate potential of the select transistor 145) is in the ON state, the pixel 131 is in the selected state. That is, the amplification transistor 144 and the signal line 132 are electrically connected, and a reset signal and an optical accumulation signal as pixel signals output from the amplification transistor 144 are supplied to the A/D converting unit 122 via the signal line 132. That is, the reset signal and the optical accumulation signal as pixel signals are read out from the pixel 131.

Note that the pixel 131 may have any configuration, and the configuration is not limited to the one in the example in FIG. 5.

When pixels 131 are selected as targets of operation to read out analog signals as pixel signals in the thus-configured pixel/analog processing unit 111, various Victim conductor loops (loop-shaped (annular) conductors) are formed with control lines 133 to control the various types of transistor, signal lines 132, power supply wires (analog power supply wires, and digital power supply wires), and the like that are mentioned above. When magnetic flux generated from nearby wires or the like passes across the loop planes of the Victim conductor loops, induced electromotive forces occur.

It is sufficient if a Victim conductor loop includes a partial wire of at least one of a control line 133 or a signal line 132. In addition, there may be a Victim conductor loop including part of a control line 133, and a Victim conductor loop including part of a signal line 132, as independent Victim conductor loops. Moreover, the Victim conductor loops may be partially or entirely included in the second semiconductor board 102. Furthermore, the Victim conductor loops may have variable or fixed loop paths.

Although the wiring directions of a control line 133 and a signal line 132 forming a Victim conductor loop are desirably substantially orthogonal to each other, they may be substantially parallel to each other.

Note that conductor loops that are near another conductor loop can be Victim conductor loops. For example, even a conductor loop that is not influenced even if a change occurs in a magnetic field strength as a result of a change of a current flowing through a nearby Aggressor loop can be a Victim conductor loop.

If a high-frequency signal flows through a wire (Aggressor conductor loop) near a Victim conductor loop, and a magnetic field strength around the Aggressor conductor loop changes, an induced electromotive force is generated to the Victim conductor loop as a result of the influence of the change, and noise occurs in the Victim conductor loop, in some cases. Particularly, in a case in which wires through which currents flow in mutually the same direction are densely arranged near a Victim conductor loop, a change of a magnetic field strength increases, and an induced electromotive force (i.e., noise) that occurs in the Victim conductor loop also increases.

In view of this, in the present disclosure, the direction of magnetic flux generated from the loop plane of an Aggressor conductor loop is adjusted, and the magnetic field formed with the magnetic flux is prevented from passing across the Aggressor conductor loop.

### 3. Structure to Block Hot Carrier Light Emissions

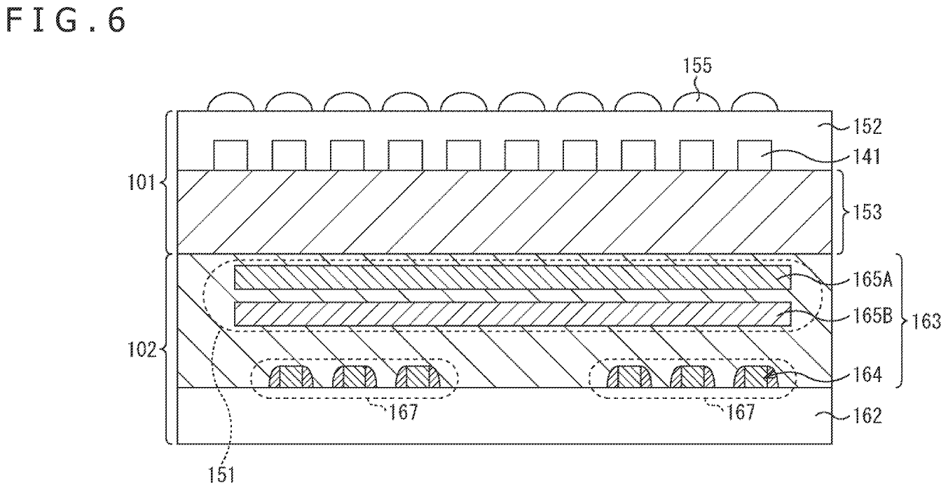

FIG. 6 is a figure depicting a cross-sectional structure example of the solid-state image pickup apparatus 100.

As mentioned above, the solid-state image pickup apparatus 100 includes the first semiconductor board 101 and the second semiconductor board 102 that are stacked one on another.

In the first semiconductor board 101, a pixel array including multiple two-dimensionally arrayed pixel units each including a photodiode 141 to serve as a photoelectric converting unit, and multiple pixel transistors (the transfer transistors 142 to the select transistor 145 in FIG. 5), for example, is formed.

In a well region formed in a semiconductor base 152, a photodiode 141 includes an n-type semiconductor region and a p-type semiconductor region on the base front surface side (the lower side in the figure), for example. Multiple pixel transistors (the transfer transistor 142 to the select transistor 145 in FIG. 5) are formed on the semiconductor base 152.

On the front surface side of the semiconductor base 152, a multi-layer wiring layer 153 in which multiple layers of wires are arranged via interlayer dielectric films is formed. The wires are formed with copper wires, for example. Wires in different wiring layers of the pixel transistors, the vertical scanning unit 123, and the like are connected, at portions that are necessary to be done so, by connection conductors that penetrate the wiring layers. On the back surface (the upper surface in the figure) of the semiconductor base 152, optical members 155 such as antireflection films, light-blocking films to block predetermined regions, and color filters or microlenses provided at positions corresponding to photodiodes 141 are formed, for example.

On the other hand, a logic circuit as the digital processing unit 112 (FIG. 2) is formed in the second semiconductor board 102. The logic circuit includes multiple MOS transistors 164 formed in p-type semiconductor well regions of a semiconductor base 162, for example.

Furthermore, a multi-layer wiring layer 163 including multiple wiring layers in which wires are arranged via interlayer dielectric films is formed on the semiconductor base 162. FIG. 6 depicts two wiring layers (wiring layers 165A and 165B) in the multiple wiring layers forming the multi-layer wiring layer 163.

In the solid-state image pickup apparatus 100, the wiring layer 165A and the wiring layer 165B form a light-blocking structure 151.

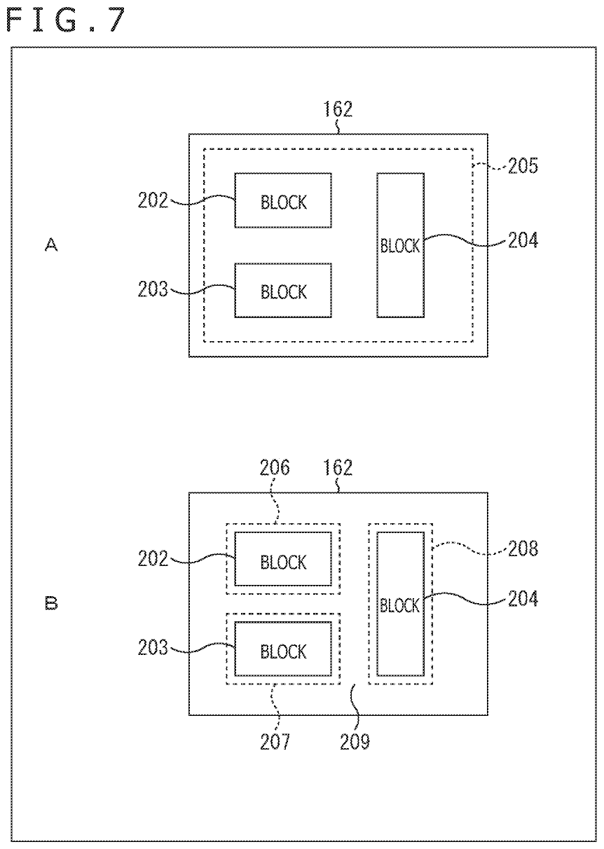

Here, a region that is in the second semiconductor board 102, and in which active elements such as MOS transistors 164 are formed is treated as an active element group 167. In the second semiconductor board 102, for example, a circuit for realizing one functionality includes a combination of multiple active elements such as nMOS transistors and pMOS transistors. Then, the region in which the active element group 167 is formed is treated as a circuit block (corresponding to circuit blocks 202 to 204 in FIG. 7). Note that, besides the MOS transistors 164, there can be diodes and the like as active elements formed in the second semiconductor board 102.

Then, the presence of the light-blocking structure 151 including the wiring layer 165A and the wiring layer 165B between the active element groups 167 and the photodiodes 141 in the multi-layer wiring layer 163 of the second semiconductor board 102 suppresses leakages of hot carrier light emissions generated from the active element groups 167 into the photodiodes 141 (details thereof are mentioned below).

Hereinafter, the wiring layer 165A that is one of the wiring layer 165A and the wiring layer 165B forming the light-blocking structure 151, and is closer to the first semiconductor board 101 in which the photodiodes 141 and the like are formed is referred to as a conductor layer A (first conductor layer). In addition, the wiring layer 165B closer to the active element groups 167 is referred to as a conductor layer B (second conductor layer).

It should be noted however that the wiring layer 165A which is closer to the first semiconductor board 101 in which the photodiodes 141 and the like are formed may be treated as the conductor layer B, and the wiring layer 165B closer to the active element group 167 may be treated as the conductor layer A. In addition, any of an insulation layer, a semiconductor layer, another conductor layer, and the like may be provided between the conductor layers A and B. Furthermore, any of an insulation layer, a semiconductor layer, another conductor layer, and the like may be provided not only between the conductor layers A and B.

The conductor layer A and the conductor layer B are desirably, but are not limited to be, conductor layers which are the easiest for currents to flow through in the circuit board, the semiconductor board, and the electronic equipment.

Desirably, one of the conductor layer A and the conductor layer B is, but is not limited to be, a conductor layer which is the easiest for currents to flow through in the circuit board, the semiconductor board, and the electronic equipment, and the other of the conductor layer A and the conductor layer B is, but is not limited to be, a conductor layer which is the second easiest for currents to flow through in the circuit board, the semiconductor board, and the electronic equipment.

One of the conductor layer A and the conductor layer B is desirably, but is not limited to be, not a conductor layer which is the hardest for currents to flow through in the circuit board, the semiconductor board, and the electronic equipment. None of the conductor layer A and the conductor layer B is desirably, but is not limited to be, a conductor layer which is the hardest for currents to flow through in the circuit board, the semiconductor board, and the electronic equipment.

For example, one of the conductor layer A and the conductor layer B may be a conductor layer which is the easiest for currents to flow through in the first semiconductor board 101, and the other of the conductor layer A and the conductor layer B may be a conductor layer which is the second easiest for currents to flow through in the first semiconductor board 101.

For example, one of the conductor layer A and the conductor layer B may be a conductor layer which is the easiest for currents to flow through in the second semiconductor board 102, and the other of the conductor layer A and the conductor layer B may be a conductor layer which is the second easiest for currents to flow through in the second semiconductor board 102.

For example, one of the conductor layer A and the conductor layer B may be a conductor layer which is the easiest for currents to flow through in the first semiconductor board 101, and the other of the conductor layer A and the conductor layer B may be a conductor layer which is the easiest for currents to flow through in the second semiconductor board 102.

For example, one of the conductor layer A and the conductor layer B may be a conductor layer which is the easiest for currents to flow through in the first semiconductor board 101, and the other of the conductor layer A and the conductor layer B may be a conductor layer which is the second easiest for currents to flow through in the second semiconductor board 102.

For example, one of the conductor layer A and the conductor layer B may be a conductor layer which is the second easiest for currents to flow through in the first semiconductor board 101, and the other of the conductor layer A and the conductor layer B may be a conductor layer which is the easiest for currents to flow through in the second semiconductor board 102.

For example, one of the conductor layer A and the conductor layer B may be a conductor layer which is the second easiest for currents to flow through in the first semiconductor board 101, and the other of the conductor layer A and the conductor layer B may be a conductor layer which is the second easiest for currents to flow through in the second semiconductor board 102.

For example, one of the conductor layer A and the conductor layer B does not have to be a conductor layer which is the hardest for currents to flow through in the first semiconductor board 101 or the second semiconductor board 102.

For example, none of the conductor layer A and the conductor layer B does not have to be a conductor layer which is the hardest for currents to flow through in the first semiconductor board 101 or the second semiconductor board 102.

Note that the “easiest” or “hardest” in the explanation mentioned above can be replaced with the “third easiest” or “third hardest,” “fourth easiest” or “fourth hardest,” or “N-th easiest” or “N-th hardest” (N is a positive number), and the “second easiest” or “second hardest” in the explanation mentioned above also can be replaced with the “third easiest” or “third hardest,” “fourth easiest” or “fourth hardest,” or “N-th easiest” or “N-th hardest” (N is a positive number).

Note that it may be considered that a conductor layer which is easier for currents to flow through in the circuit board, the semiconductor board, and the electronic equipment mentioned above is any one of a conductor layer which is easier for currents to flow through in the circuit board, a conductor layer which is easier for currents to flow through in the semiconductor board, and a conductor layer which is easier for currents to flow through in the electronic equipment. In addition, it may be considered that a conductor layer which is harder for currents to flow through in the circuit board, the semiconductor board, and the electronic equipment mentioned above is any one of a conductor layer which is harder for currents to flow through in the circuit board, a conductor layer which is harder for currents to flow through in the semiconductor board, and a conductor layer which is harder for currents to flow through in the electronic equipment. In addition, the conductor layer which is easier for currents to flow through mentioned above can instead be expressed as a conductor layer with a low sheet resistance, and the conductor layer which is harder for currents to flow through mentioned above can instead be expressed as a conductor layer with a high sheet resistance.

Note that as conductor materials to be used for the conductor layers A and B, metals such as copper, aluminum, tungsten, chromium, nickel, tantalum, molybdenum, titanium, gold, silver, or iron, and mixtures, compounds, or alloys at least containing any of the metals are used mainly. In addition, semiconductors such as silicon, germanium, compound semiconductors, or organic semiconductors may be contained. Furthermore, insulators such as cotton, paper, polyethylene, polyvinyl chloride, natural rubber, polyester, epoxy resin, melamine resin, phenolic resin, polyurethane, synthetic resin, mica, asbestos, glass fiber, or porcelain may be contained.

The conductor layers A and B forming the light-blocking structure 151 can be Aggressor conductor loops due to currents flowing therethrough.

Next, a region to be blocked off from light (light-blocking target region) by the light-blocking structure 151 is explained.

FIG. 7 is a schematic configuration diagram depicting planar arrangement examples of circuit blocks that are in the semiconductor base 162 and include regions where active element groups 167 are formed.

A in FIG. 7 is an example of a case in which multiple circuit blocks 202 to 204 are treated collectively as a target region to be blocked off from light by the light-blocking structure 151, and a region 205 including all of the circuit blocks 202, 203, and 204 is treated as a light-blocking target region.

B in FIG. 7 is an example of a case in which the multiple circuit blocks 202 to 204 are treated separately as target regions to be blocked off from light by the light-blocking structure 151, regions 206, 207, and 208 including the circuit blocks 202, 203, and 204, respectively, are treated separately as light-blocking target regions, and a region 209 other than the regions 206 to 208 is not a light-blocking target region.

In the case of the example depicted in B in FIG. 7, it is possible to avoid restrictions on the degrees of freedom of the layouts of the conductor layers A and B forming the light-blocking structure 151. However, the layouts of the conductor layers A and B become complicated, and so it becomes necessary to make a considerable effort for designing the layouts of the conductor layers A and B.

In order to design the layouts of the conductor layers A and B forming the light-blocking structure 151 easily, desirably the example depicted in A in FIG. 7 is adopted, and the multiple circuit blocks are treated collectively as a light-blocking target region.

In view of this, the present disclosure proposes a structure of the conductor layers A and B that allows easy designing of the layouts while restrictions on the degrees of freedom of the layouts of the conductor layers A and B are avoided.

Note that, in addition to circuit blocks representing regions of active element groups 167 to be light emission sources of hot carrier light emissions, a buffer region is provided around the circuit blocks in the light-blocking target region in the present embodiment such that the buffer region also becomes a light-blocking target region. By providing the buffer region around the circuit blocks, it is possible to hinder leakages, into photodiodes 141, of hot carrier light emissions emitted from the circuit blocks in diagonal directions.

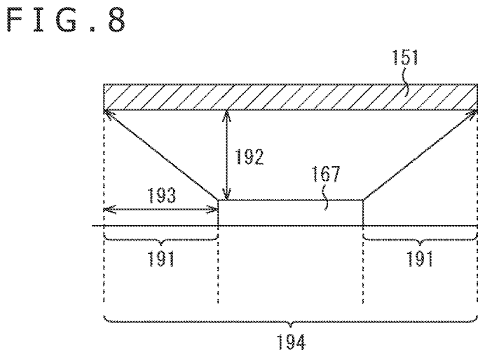

FIG. 8 is a figure depicting an example of a positional relation between a target region to be blocked off from light by the light-blocking structure 151, and an active element group region and a buffer region.

In the example depicted in FIG. 8, a region where an active element group 167 is formed, and a buffer region 191 surrounding the active element group 167 form a light-blocking target region 194, and the light-blocking structure 151 is formed to face the light-blocking target region 194.

Here, the length from the active element group 167 to the light-blocking structure 151 is referred to as an interlayer distance 192. In addition, the length from an end section of the active element group 167 to an end section of the light-blocking structure 151 including wires is referred to as a buffer region width 193.

The light-blocking structure 151 is formed such that the buffer region width 193 is larger than the interlayer distance 192. Thereby, it becomes possible to also block diagonal components of hot carrier light emissions that are generated from a point light source.

Note that the appropriate value of the buffer region width 193 varies depending on the interlayer distance 192 between the light-blocking structure 151 and the active element group 167. For example, in a case in which the interlayer distance 192 is long, it is necessary to provide a larger buffer region 191 such that diagonal components of hot carrier light emissions from the active element group 167 can be blocked sufficiently. On the other hand, in a case in which the interlayer distance 192 is short, hot carrier light emissions from the active element group 167 can be blocked sufficiently even if a large buffer region 191 is not provided. Accordingly, by forming the light-blocking structure 151 by using wiring layers that are included in multiple wiring layers included in the multi-layer wiring layer 163 and are close to the active element group 167, the degrees of freedom of the layouts of the conductor layers A and B can be enhanced. It should be noted however that it is difficult in many cases to form the light-blocking structure 151 by using wiring layers close to the active element group 167 for reasons such as layout constraints of the wiring layers close to the active element group 167. In the present technology, a high degree of freedom of layouts can be attained even in a case in which the light-blocking structure 151 is formed by using wiring layers far from the active element group 167.

### 4. Configuration Examples of Conductor Layers A and B

Hereinafter, configuration examples of the conductor layer A (wiring layer 165A) and the conductor layer B (wiring layer 165B) forming the light-blocking structure 151 which can be an Aggressor conductor loop in the solid-state image pickup apparatus 100 to which the present technology is applied are explained. Before the explanation, a comparative example as a comparison target of the configuration examples is explained.

### First Comparative Example

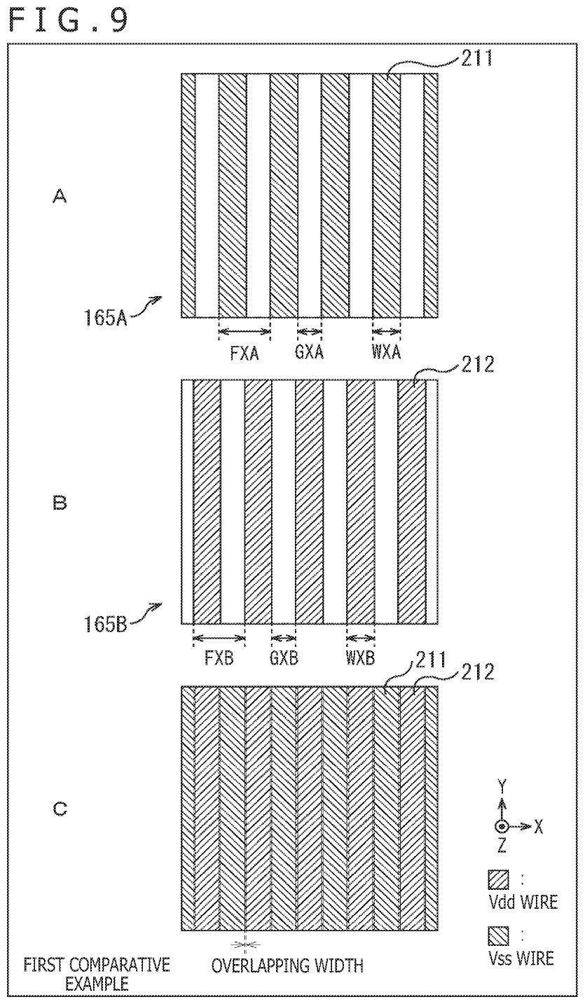

FIG. 9 is a plan view depicting a first comparative example to be compared with multiple configuration examples of the conductor layers A and B forming the light-blocking structure 151 that are mentioned below. Note that A in FIG. 9 depicts the conductor layer A, and B in FIG. 9 depicts the conductor layer B. In the coordinate system in FIG. 9, the X axis lies in the lateral direction, the Y axis lies in the longitudinal direction, and the Z axis lies in a direction perpendicular to the XY plane.

The conductor layer A in the first comparative example includes linear conductors 211 that are long in the Y direction and are arranged regularly at an X-direction conductor pitch FXA. Note that (conductor pitch FXA)=(X-direction conductor width WXA)+(X-direction gap width GXA) is satisfied. Each linear conductor 211 is a wire (Vss wire) connected to GND or a negative power supply, for example.

The conductor layer B in the first comparative example includes linear conductors 212 that are long in the Y direction and are arranged regularly at an X-direction conductor pitch FXB. Note that (conductor pitch FXB)=(X-direction conductor width WXB)+(X-direction gap width GXB) is satisfied. Each linear conductor 212 is a wire (Vdd wire) connected to a positive power supply, for example. Here, (conductor pitch FXB)=(conductor pitch FXA) is satisfied.

Note that points to which the conductor layers A and B are connected may be switched such that each linear conductor 211 is a Vdd wire and each linear conductor 212 is a Vss wire.

C in FIG. 9 depicts a state of the conductor layers A and B depicted in A and B in FIG. 9, respectively, as seen from the side where photodiodes 141 are located (the backside). In the case of the first comparative example, as depicted in C in FIG. 9, the linear conductors 211 and 212 are formed such that, in a case in which the linear conductors 211 included in the conductor layer A and the linear conductors 212 included in the conductor layer B are arranged to overlap each other, there are overlapping sections where conductor sections are superimposed. Accordingly, hot carrier light emissions from an active element group 167 can be blocked sufficiently. Note that the width of an overlapping section is also referred to as an overlapping width.

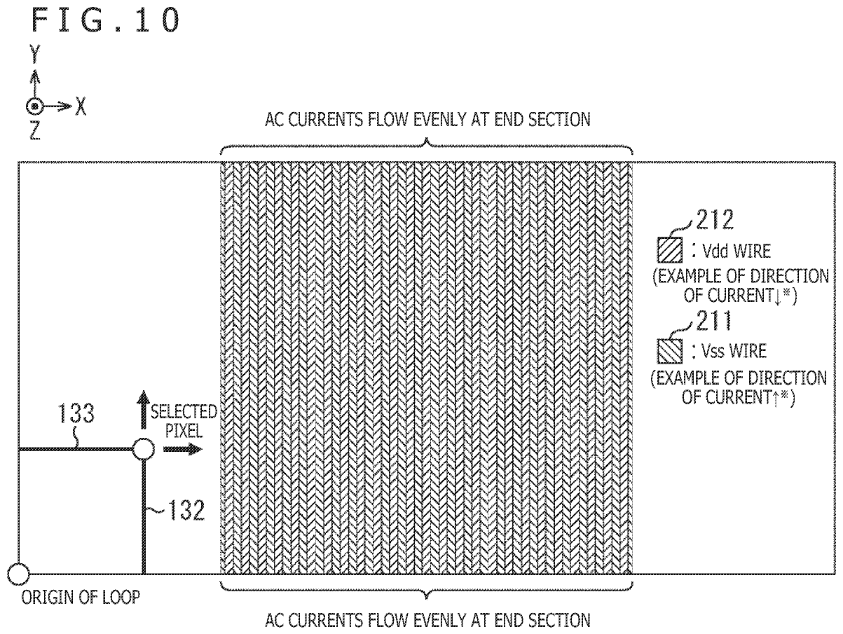

FIG. 10 is a figure depicting the condition of electric currents flowing in the first comparative example (FIG. 9).

It is assumed that AC currents flow evenly at end sections of the linear conductors 211 included in the conductor layer A and of the linear conductors 212 included in the conductor layer B. It should be noted however that directions of electric currents change over time. For example, it is assumed that, when currents flow through the linear conductors 212, which are Vdd wires, from the upper side to the lower side in the figure, currents flow through the linear conductors 211, which are Vss wires, from the lower side to the upper side in the figure.

In a case in which currents flow as depicted in FIG. 10 in the first comparative example, magnetic flux substantially in the Z direction occurs more easily between the linear conductors 211, which are Vss wires, and the linear conductors 212, which are Vdd wires, due to conductor loops that include adjacent linear conductors 211 and 212 and have loop planes almost parallel to the XY plane in the plan view of FIG. 10.

On the other hand, in the pixel array 121 of the first semiconductor board 101 stacked on the second semiconductor board 102 in which the light-blocking structure 151 including the conductor layers A and B is formed, as depicted in FIG. 10, a Victim conductor loop including a signal line 132 and a control line 133 is formed on the XY plane. An induced electromotive force is generated in the Victim conductor loop formed on the XY plane more easily due to magnetic flux in the Z direction. The larger a change of the induced electromotive force is, the worse an image output from the solid-state image pickup apparatus 100 is (the larger the inductive noise is).

Furthermore, depending on the configuration of Aggressor conductor loops, if the effective dimensions of the Victim conductor loop including a signal line 132 and a control line 133 change as pixels at different positions are selected in the pixel array 121, changes of the induced electromotive force become noticeable because an induced electromotive force is proportional to the dimensions of a Victim conductor loop.

In the case of the first comparative example, the direction of magnetic flux (substantially in the Z direction) generated from the loop planes of the Aggressor conductor loops of the light-blocking structure 151 including the conductor layers A and B substantially coincides with the direction of magnetic flux (in the Z direction) that more easily generates an induced electromotive force to the Victim conductor loop, and so it is expected that an image output from the solid-state image pickup apparatus 100 worsens (inductive noise occurs).

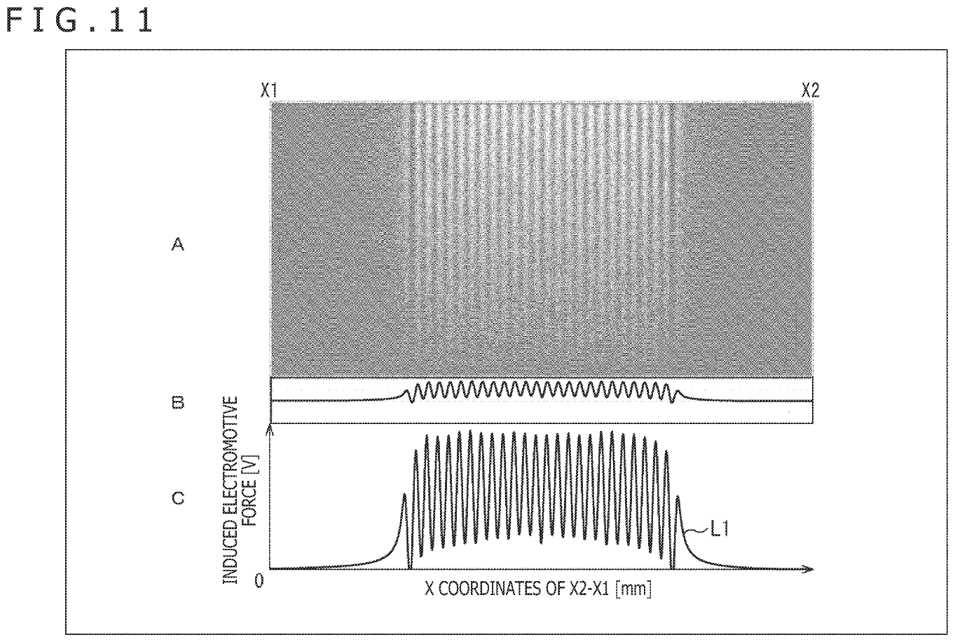

FIG. 11 depicts a result of a simulation of inductive noise that occurs in a case in which the first comparative example is applied to the solid-state image pickup apparatus 100.

A in FIG. 11 depicts an image that is output from the solid-state image pickup apparatus 100 and has inductive noise generated therein. B in FIG. 11 depicts changes of pixel signals along a line segment X1-X2 in the image depicted in A in FIG. 11. C in FIG. 11 depicts a solid line L1 representing an induced electromotive force that has generated the inductive noise in the image. The horizontal axis in C in FIG. 11 represents the X-axis coordinate of an image, and the vertical axis represents the magnitude of an induced electromotive force.

Hereinafter, the solid line L1 depicted in C in FIG. 11 is used for comparisons with results of simulations of inductive noise generated in cases in which configuration examples of the conductor layers A and B forming the light-blocking structure 151 are applied to the solid-state image pickup apparatus 100.

### First Configuration Example

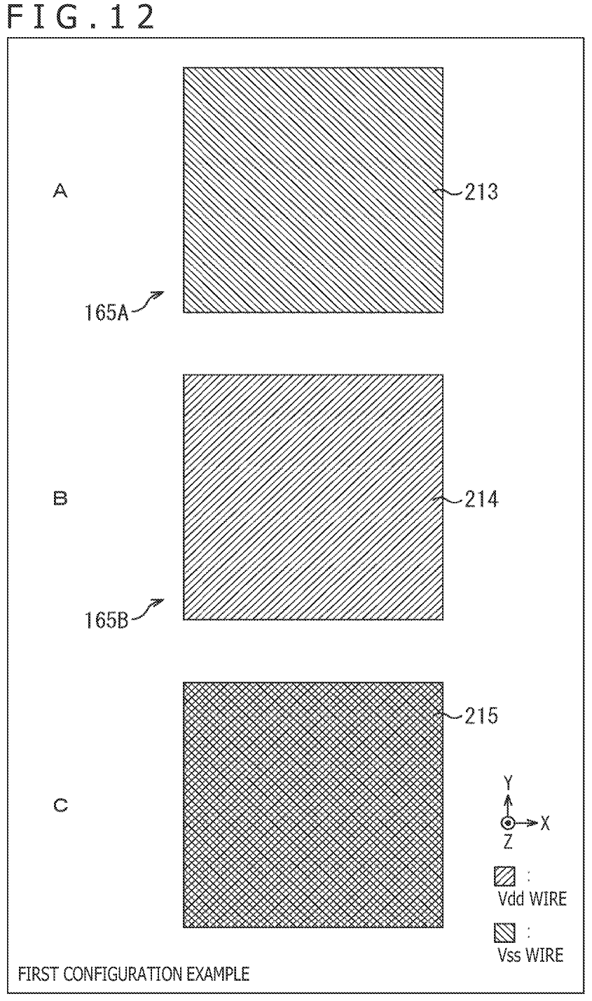

FIG. 12 depicts a first configuration example of the conductor layers A and B. Note that A in FIG. 12 depicts the conductor layer A, and B in FIG. 12 depicts the conductor layer B. In the coordinate system in FIG. 12, the X axis lies in the lateral direction, the Y axis lies in the longitudinal direction, and the Z axis lies in a direction perpendicular to the XY plane.

The conductor layer A in the first configuration example includes a planar conductor 213. The planar conductor 213 is a wire (Vss wire) connected to GND or a negative power supply, for example.

The conductor layer B in the first comparative example includes a planar conductor 214. The planar conductor 214 is a wire (Vdd wire) connected to a positive power supply, for example.

Note that points to which the conductor layers A and B are connected may be switched such that the planar conductor 213 is a Vdd wire and the planar conductor 214 is a Vss wire. This similarly applies also to each configuration example explained later.

C in FIG. 12 depicts a state of the conductor layers A and B depicted in A and B in FIG. 12, respectively, as seen from the side where photodiodes 141 are located (the backside). It should be noted however that a hatched region 215 in which diagonal lines cross in C in FIG. 12 represents a region where the planar conductor 213 in the conductor layer A and the planar conductor 214 in the conductor layer B overlap. Accordingly, in the case of C in FIG. 12, it is depicted that the planar conductor 213 in the conductor layer A and the planar conductor 214 in the conductor layer B overlap over the entire surfaces. Because the planar conductor 213 in the conductor layer A and the planar conductor 214 in the conductor layer B overlap over the entire surfaces in the case of the first configuration example, hot carrier light emissions from an active element group 167 can be blocked surely.

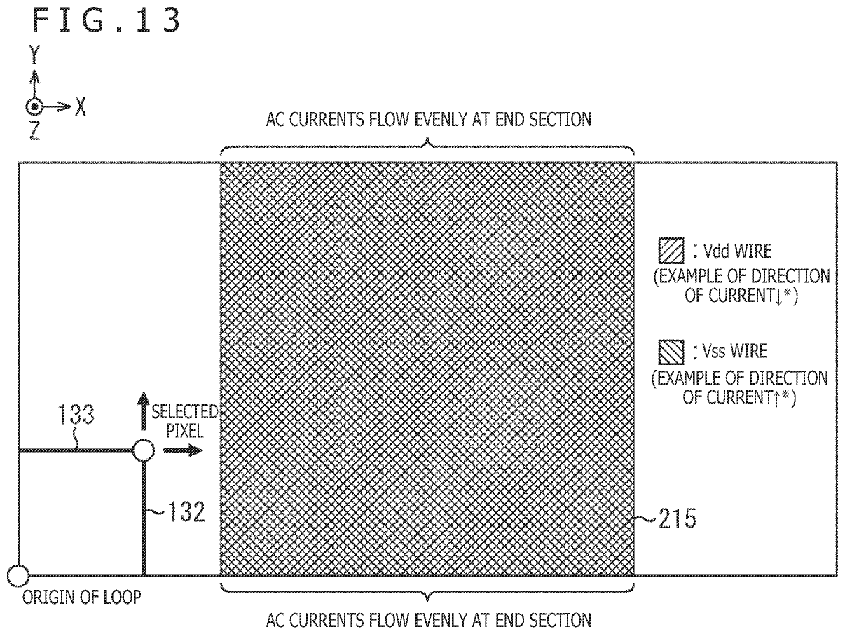

FIG. 13 is a figure depicting the condition of electric currents flowing in the first configuration example (FIG. 12).

It is assumed that AC currents flow evenly at end sections of the planar conductor 213 included in the conductor layer A and of the planar conductor 214 included in the conductor layer B. It should be noted however that directions of electric currents change over time. For example, it is assumed that, when currents flow through the planar conductor 214, which is a Vdd wire, from the upper side to the lower side in the figure, currents flow through the planar conductor 213, which is a Vss wire, from the lower side to the upper side in the figure.

In a case in which currents flow as depicted in FIG. 13 in the first configuration example, magnetic flux substantially in the X direction and substantially in the Y direction occurs more easily between the planar conductor 213, which is a Vss wire, and the planar conductor 214, which is a Vdd wire, due to conductor loops that include (cross-sections of) the planar conductors 213 and 214 in cross-sections along which the planar conductors 213 and 214 are arranged and have loop planes that are almost perpendicular to the X axis, and conductor loops that include (cross-sections of) the planar conductors 213 and 214 in cross-sections along which the planar conductors 213 and 214 are arranged and have loop planes that are almost perpendicular to the Y axis.

On the other hand, in the pixel array 121 of the first semiconductor board 101 stacked on the second semiconductor board 102 in which the light-blocking structure 151 including the conductor layers A and B is formed, as depicted in FIG. 13, a Victim conductor loop including a signal line 132 and a control line 133 is formed on the XY plane. An induced electromotive force due to magnetic flux in the Z-axis direction is generated more easily in the Victim conductor loop formed on the XY plane. The larger a change of the induced electromotive force is, the worse an image output from the solid-state image pickup apparatus 100 is (the larger the inductive noise is).

Furthermore, if the effective dimensions of the Victim conductor loop including a signal line 132 and a control line 133 change as pixels at different positions are selected in the pixel array 121, changes of the induced electromotive force become noticeable.

In the case of the first configuration example, the directions of magnetic flux (substantially in the X direction and substantially in the Y direction) generated from the loop planes of the Aggressor conductor loops of the light-blocking structure 151 including the conductor layers A and B and the direction of magnetic flux (in the Z direction) that generates an induced electromotive force to the Victim conductor loop are substantially orthogonal and different by approximately 90 degrees. In other words, the direction of the loop planes that generate magnetic flux from the Aggressor conductor loops and the direction of the loop plane that generates an induced electromotive force to the Victim conductor loop are different by approximately 90 degrees. Accordingly, it is expected that a worsening (the occurrence of inductive noise) of an image output from the solid-state image pickup apparatus 100 is mitigated as compared with the case of the first comparative example.

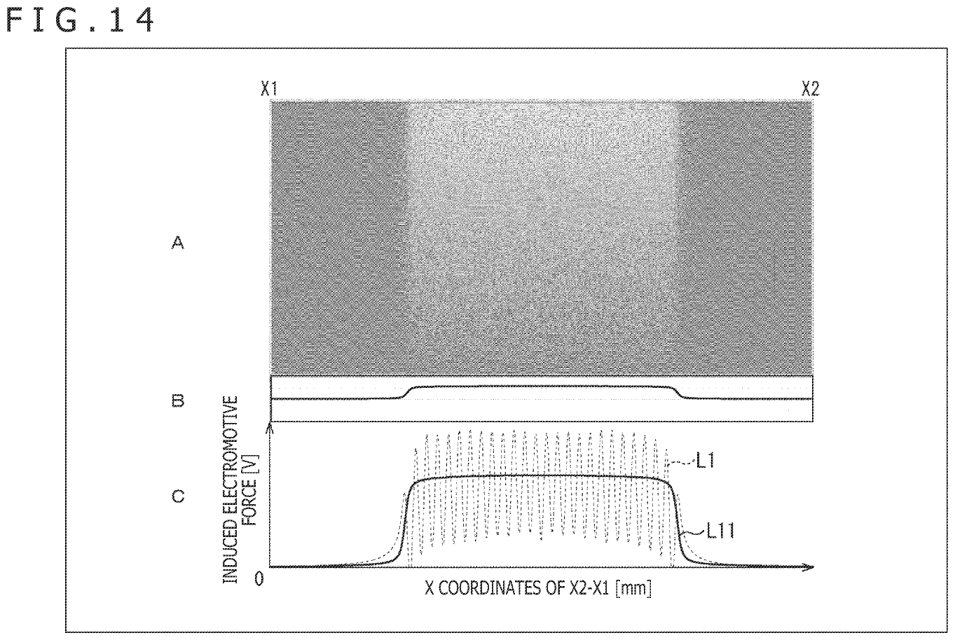

FIG. 14 depicts a result of a simulation of inductive noise that occurs in a case in which the first configuration example (FIG. 12) is applied to the solid-state image pickup apparatus 100.

A in FIG. 14 depicts an image that is output from the solid-state image pickup apparatus 100 and can have inductive noise generated therein. B in FIG. 14 depicts changes of pixel signals along a line segment X1-X2 in the image depicted in A in FIG. 14. C in FIG. 14 depicts a solid line L11 representing an induced electromotive force that has generated the inductive noise in the image. The horizontal axis in C in FIG. 14 represents the X-axis coordinate of an image, and the vertical axis represents the magnitude of an induced electromotive force. Note that a dotted line L1 in C in FIG. 14 corresponds to the first comparative example (FIG. 9).

As is apparent from a comparison between the solid line L11 and the dotted line L1 depicted in C in FIG. 14, the first configuration example can suppress changes of the induced electromotive force generated to the Victim conductor loop as compared with the first comparative example. Therefore, the occurrence of the inductive noise in an image output from the solid-state image pickup apparatus 100 can be hindered.

### Second Configuration Example

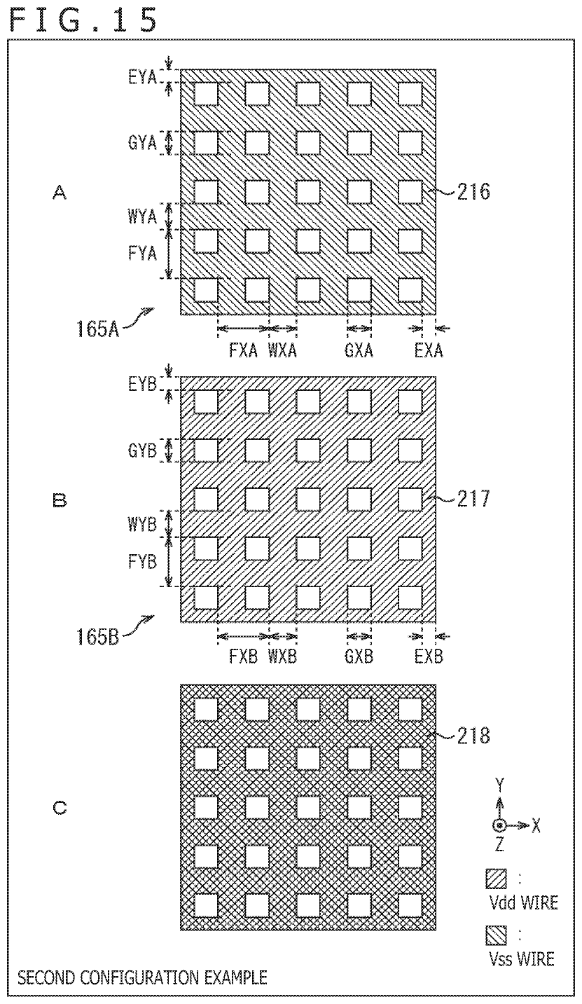

FIG. 15 depicts a second configuration example of the conductor layers A and B. Note that A in FIG. 15 depicts the conductor layer A, and B in FIG. 15 depicts the conductor layer B. In the coordinate system in FIG. 15, the X axis lies in the lateral direction, the Y axis lies in the longitudinal direction, and the Z axis lies in a direction perpendicular to the XY plane.

The conductor layer A in the second configuration example includes a mesh conductor 216. The X-direction conductor width of the mesh conductor 216 is designated as WXA, the X-direction gap width is designated as GXA, the X-direction conductor pitch is designated as FXA (=(conductor width WXA)+(gap width GXA)), and the X-direction end-section width is designated as EXA (=(conductor width WXA)/2). In addition, the Y-direction conductor width of the mesh conductor 216 is designated as WYA, the Y-direction gap width is designated as GYA, the Y-direction conductor pitch is designated as FYA (=(conductor width WYA)+(gap width GYA)), and the Y-direction end-section width is designated as EYA (=(conductor width WYA)/2). The mesh conductor 216 is a wire (Vss wire) connected to GND or a negative power supply, for example.

The conductor layer B in the second configuration example includes a mesh conductor 217. The X-direction conductor width of the mesh conductor 217 is designated as WXB, the X-direction gap width is designated as GXB, the X-direction conductor pitch is designated as FXB (=(conductor width WXB)+(gap width GXB)), and the X-direction end-section width is designated as EXB (=(conductor width WXB)/2). In addition, the Y-direction conductor width of the mesh conductor 217 is designated as WYB, the Y-direction gap width is designated as GYB, the Y-direction conductor pitch is designated as FYB (=(conductor width WYB)+(gap width GYB)), and the Y-direction end-section width is designated as EYB (=(conductor width WYB)/2). The mesh conductor 217 is a wire (Vdd wire) connected to a positive power supply, for example.

Note that the mesh conductor 216 and the mesh conductor 217 desirably satisfy the following relations.

(Conductor width WXA)=(conductor width WYA)=(conductor width WXB)=(conductor width WYB)

(Gap width GXA)=(gap width GYA)=(gap width GXB)=(gap width GYB)

(End-section width EXA)=(end-section width EYA)=(end-section width EXB)=(end-section width EYB)

(Conductor pitch FXA)=(conductor pitch FYA)=(conductor pitch FXB)=(conductor pitch FYB)

C in FIG. 15 depicts a state of the conductor layers A and B depicted in A and B in FIG. 15, respectively, as seen from the side where photodiodes 141 are located (the backside). It should be noted however that a hatched region 218 in which diagonal lines cross in C in FIG. 15 represents a region where the mesh conductor 216 in the conductor layer A and the mesh conductor 217 in the conductor layer B overlap. Because gaps in the mesh conductor 216 forming the conductor layer A and gaps in the mesh conductor 217 forming the conductor layer B match in the case of the second configuration example, hot carrier light emissions from an active element group 167 cannot be blocked sufficiently. It should be noted however that, as mentioned below, the occurrence of inductive noise can be suppressed.

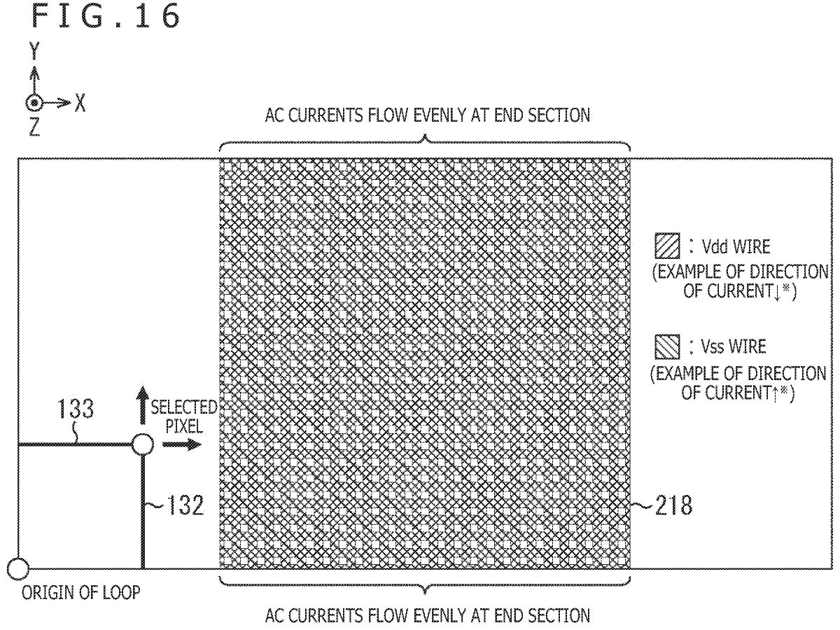

FIG. 16 is a figure depicting the condition of electric currents flowing in the second configuration example (FIG. 15).

It is assumed that AC currents flow evenly at end sections of the mesh conductor 216 included in the conductor layer A and of the mesh conductor 217 included in the conductor layer B. It should be noted however that directions of electric currents change over time. For example, it is assumed that, when currents flow through the mesh conductor 217, which is a Vdd wire, from the upper side to the lower side in the figure, currents flow through the mesh conductor 216, which is a Vss wire, from the lower side to the upper side in the figure.

In a case in which currents flow as depicted in FIG. 16 in the second configuration example, magnetic flux substantially in the X direction and substantially in the Y direction occurs more easily between the mesh conductor 216, which is a Vss wire, and the mesh conductor 217, which is a Vdd wire, due to conductor loops that include (cross-sections of) the mesh conductors 216 and 217 in cross-sections along which the mesh conductors 216 and 217 are arranged and have loop planes that are almost perpendicular to the X axis, and conductor loops that include (cross-sections of) the mesh conductors 216 and 217 in cross-sections along which the mesh conductors 216 and 217 are arranged and have loop planes that are almost perpendicular to the Y axis.

On the other hand, in the pixel array 121 of the first semiconductor board 101 stacked on the second semiconductor board 102 in which the light-blocking structure 151 including the conductor layers A and B is formed, as depicted in FIG. 16, a Victim conductor loop including a signal line 132 and a control line 133 is formed on the XY plane. An induced electromotive force is generated in the Victim conductor loop formed on the XY plane more easily due to magnetic flux in the Z direction. The larger a change of the induced electromotive force is, the worse an image output from the solid-state image pickup apparatus 100 is (the larger the inductive noise is).

Furthermore, if the effective dimensions of the Victim conductor loop including a signal line 132 and a control line 133 change as pixels at different positions are selected in the pixel array 121, changes of the induced electromotive force become noticeable.

In the case of the second configuration example, the directions of magnetic flux (substantially in the X direction and substantially in the Y direction) generated from the loop planes of the Aggressor conductor loops of the light-blocking structure 151 including the conductor layers A and B and the direction of magnetic flux (in the Z direction) that generates an induced electromotive force to the Victim conductor loop are substantially orthogonal and different by approximately 90 degrees. In other words, the directions of the loop planes that generate magnetic flux from the Aggressor conductor loops and the direction of the loop plane that generates an induced electromotive force to the Victim conductor loop are different by approximately 90 degrees. Accordingly, it is expected that a worsening (the occurrence of inductive noise) of an image output from the solid-state image pickup apparatus 100 is mitigated as compared with the first comparative example.

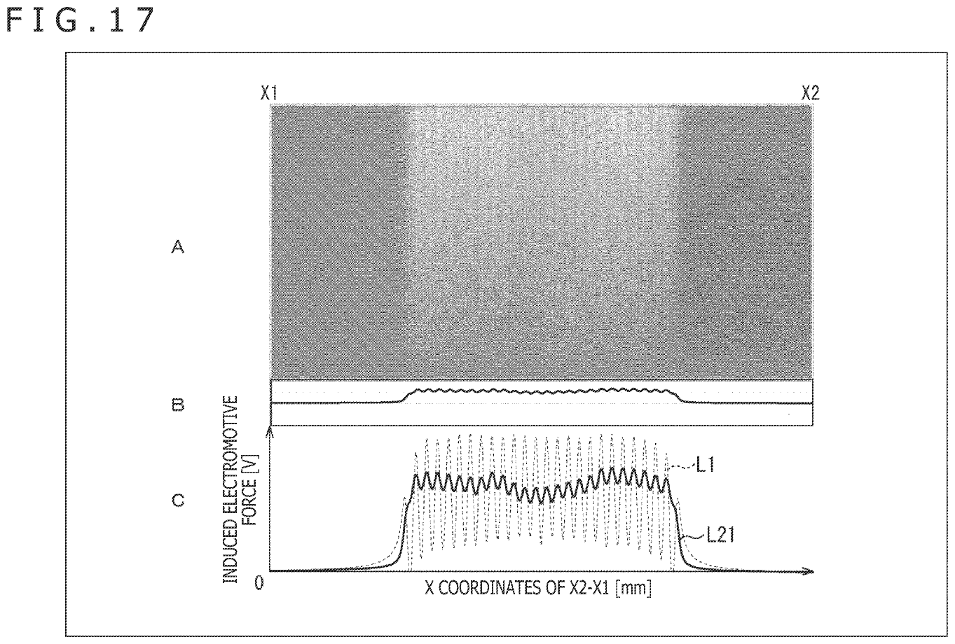

FIG. 17 depicts a result of a simulation of inductive noise that occurs in a case in which the second configuration example (FIG. 15) is applied to the solid-state image pickup apparatus 100.

A in FIG. 17 depicts an image that is output from the solid-state image pickup apparatus 100 and can have inductive noise generated therein. B in FIG. 17 depicts changes of pixel signals along a line segment X1-X2 in the image depicted in A in FIG. 17. C in FIG. 17 depicts a solid line L21 representing an induced electromotive force that has generated the inductive noise in the image. The horizontal axis in C in FIG. 17 represents the X-axis coordinate of an image, and the vertical axis represents the magnitude of an induced electromotive force. Note that the dotted line L1 in C in FIG. 17 corresponds to the first comparative example (FIG. 9).

As is apparent from a comparison between the solid line L21 and the dotted line L1 depicted in C in FIG. 17, the second configuration example can suppress changes of the induced electromotive force generated to the Victim conductor loop as compared with the first comparative example. Therefore, the occurrence of the inductive noise in an image output from the solid-state image pickup apparatus 100 can be hindered.

### Second Comparative Example

In the second configuration example (FIG. 15), the mesh conductor 216 forming the conductor layer A and the mesh conductor 217 forming the conductor layer B are configured to satisfy the relation, (conductor pitch FXA)=(conductor pitch FYA)=(conductor pitch FXB)=(conductor pitch FYB).

By making the X-direction conductor pitch FXA of the conductor layer A, the Y-direction conductor pitch FYA of the conductor layer A, the X-direction conductor pitch FXB of the conductor layer B, and the X-direction conductor pitch FYB of the conductor layer B equal to each other in this manner, the occurrence of inductive noise can be suppressed.

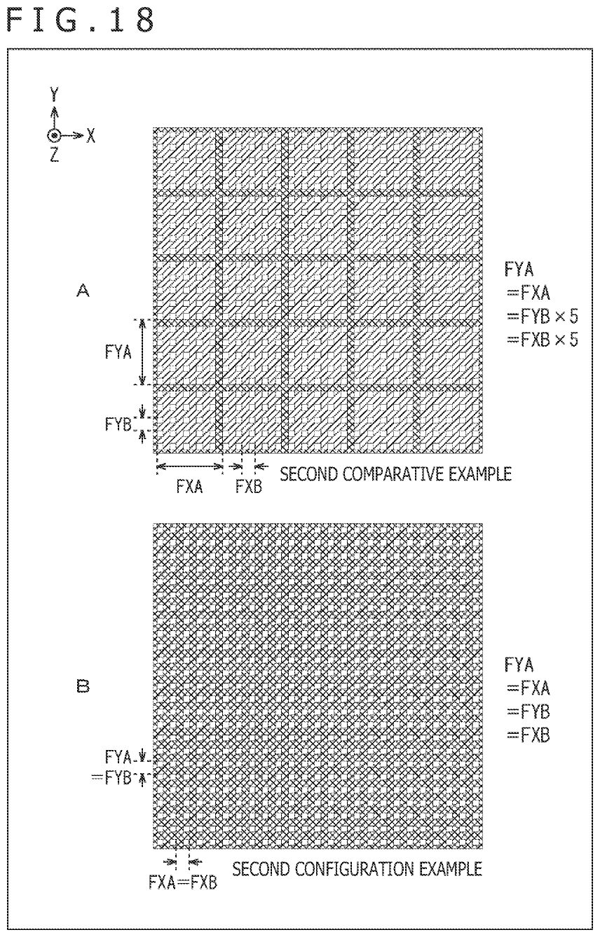

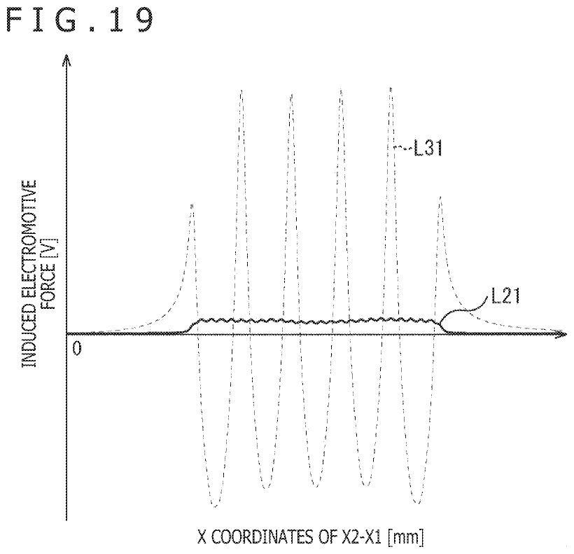

FIG. 18 and FIG. 19 are figures for explaining that the occurrence of inductive noise can be suppressed by making all the conductor pitches of the conductor layer A and the conductor layer B equal to each other.

A in FIG. 18 depicts a second comparative example obtained by modifying the second configuration example, for a comparison with the second configuration example depicted in FIG. 15. In the second comparative example, the X-direction gap width GXA and the Y-direction gap width GYA of the mesh conductor 216 forming the conductor layer A in the second configuration example are widened, and the X-direction conductor pitch FXA and the Y-direction conductor pitch FYA are made 500% of those in the second configuration example. Note that it is assumed that the mesh conductor 217 forming the conductor layer B in the second comparative example is the same as that in the second configuration example.

B in FIG. 18 depicts the second configuration example depicted in C in FIG. 15 at the same magnification as that of A in FIG. 18.

FIG. 19 depicts changes of induced electromotive forces that generate inductive noise in images, as results of simulations of the cases in which the second comparative example (A in FIG. 18) and the second configuration example (B in FIG. 18) are applied to the solid-state image pickup apparatus 100. Note that it is assumed that the condition of electric currents flowing in the second comparative example is similar to that in the case depicted in FIG. 16. The horizontal axis in FIG. 19 represents the X-axis coordinate of images, and the vertical axis represents the magnitudes of the induced electromotive forces.

The solid line L21 in FIG. 19 corresponds to the second configuration example, and a dotted line L31 corresponds to the second comparative example.

As is apparent from a comparison between the solid line L21 and the dotted line L31, it can be known that the second configuration example can suppress changes of the induced electromotive force generated to the Victim conductor loop and suppress inductive noise, as compared with the second comparative example.

### Third Comparative Example

Meanwhile, the occurrence of inductive noise can be suppressed also in a case in which the conductor widths of the mesh conductor forming the conductor layer A in the second comparative example are widened.

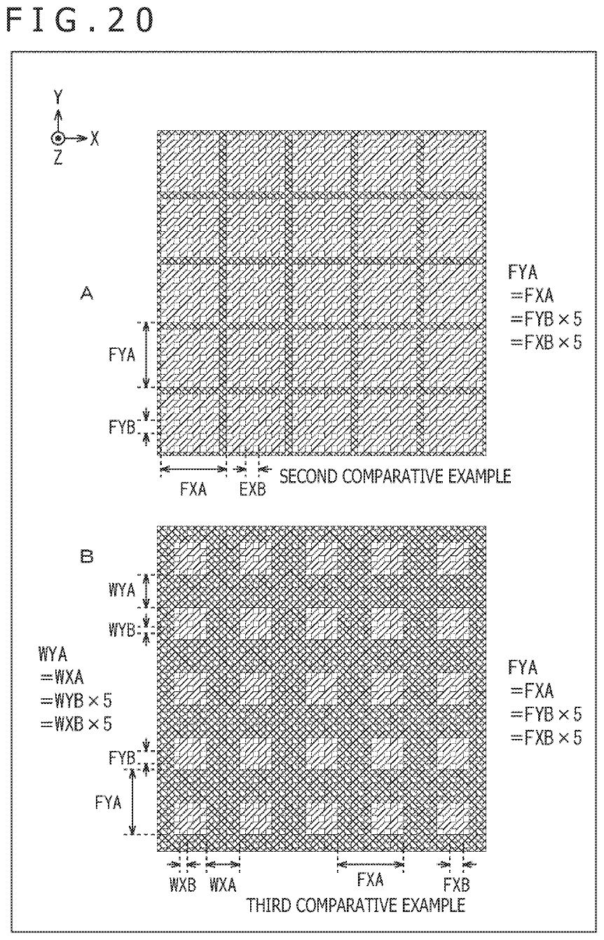

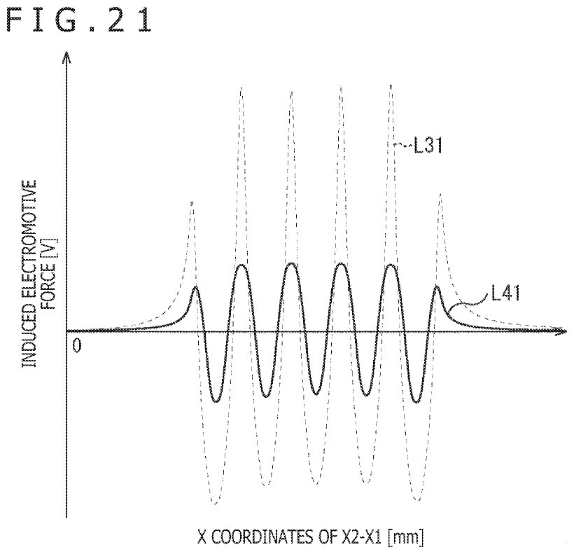

FIG. 20 and FIG. 21 are figures for explaining that the occurrence of inductive noise can be suppressed by widening the conductor widths of the mesh conductor forming the conductor layer A.

A in FIG. 20 is presented again to depict the second comparative example depicted in A in FIG. 18.

B in FIG. 20 depicts a third comparative example obtained by modifying the second configuration example, for a comparison with the second comparative example. In the third comparative example, the X-direction and Y-direction conductor widths WXA and WYA of the mesh conductor 216 forming the conductor layer A in the second configuration example are widened and are 500% of those in the second configuration example. Note that it is assumed that the mesh conductor 217 forming the conductor layer B in the third comparative example is the same as that in the second configuration example.

FIG. 21 depicts changes of induced electromotive forces that generate inductive noise in images, as results of simulations of the cases in which the third comparative example and the second comparative example are applied to the solid-state image pickup apparatus 100. Note that it is assumed that the condition of electric currents flowing in the third comparative example is similar to that in the case depicted in FIG. 16. The horizontal axis in FIG. 21 represents the X-axis coordinate of images, and the vertical axis represents the magnitudes of the induced electromotive forces.

A solid line L41 in FIG. 21 corresponds to the third comparative example, and the dotted line L31 corresponds to the second comparative example.

As is apparent from a comparison between the solid line L41 and the dotted line L31, it can be known that the third comparative example can suppress changes of the induced electromotive force generated to the Victim conductor loop and suppress inductive noise, as compared with the second comparative example.

### Third Configuration Example

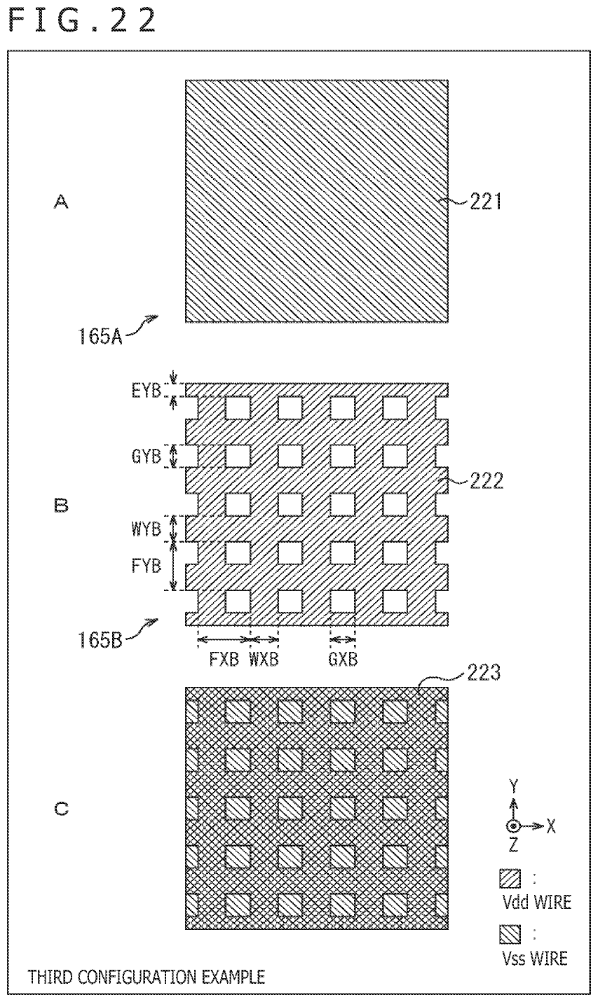

Next, FIG. 22 depicts a third configuration example of the conductor layers A and B. Note that A in FIG. 22 depicts the conductor layer A, and B in FIG. 22 depicts the conductor layer B. In the coordinate system in FIG. 22, the X axis lies in the lateral direction, the Y axis lies in the longitudinal direction, and the Z axis lies in a direction perpendicular to the XY plane.

The conductor layer A in the third configuration example includes a planar conductor 221. The planar conductor 221 is a wire (Vss wire) connected to GND or a negative power supply, for example.

The conductor layer B in the third configuration example includes a mesh conductor 222. The X-direction conductor width of the mesh conductor 222 is designated as WXB, the X-direction gap width is designated as GXB, the X-direction conductor pitch is designated as FXB (=(conductor width WXB)+(gap width GXB)). In addition, the Y-direction conductor width of the mesh conductor 222 is designated as WYB, the Y-direction gap width is designated as GYB, the Y-direction conductor pitch is designated as FYB (=(conductor width WYB)+(gap width GYB)), and the Y-direction end-section width is designated as EYB. The mesh conductor 222 is a wire (Vdd wire) connected to a positive power supply, for example.

Note that the mesh conductor 222 desirably satisfies the following relations.

(Conductor width WXB)=(conductor width WYB)

(Gap width GXB)=(gap width GYB)

(End-section width EYB)=(conductor width WYB)/2

(Conductor pitch FXB)=(conductor pitch FYB)

By making the conductor widths, the conductor pitches, and the gap widths equal to each other in the X direction and Y-direction as in the relations mentioned above, wire resistances and wire impedance of the mesh conductor 222 become uniform in the X direction and Y direction. Accordingly, the magnetic-field resistances and voltage drops can be made even magnetic-field resistances and even voltage drops in the X direction and Y-direction.

In addition, by making the end-section width EYB half of the conductor width WYB, it is possible to suppress an induced electromotive force generated to a Victim conductor loop as a result of a magnetic field occurring around end sections of the mesh conductor 222.

C in FIG. 22 depicts a state of the conductor layers A and B depicted in A and B in FIG. 22, respectively, as seen from the side where photodiodes 141 are located (the backside). It should be noted however that a hatched region 223 in which diagonal lines cross in C in FIG. 22 represents a region where the planar conductor 221 in the conductor layer A and the mesh conductor 222 in the conductor layer B overlap. Because an active element group 167 is covered with at least one of the conductor layer A or the conductor layer B in the case of the third configuration example, hot carrier light emissions from the active element group 167 can be blocked.

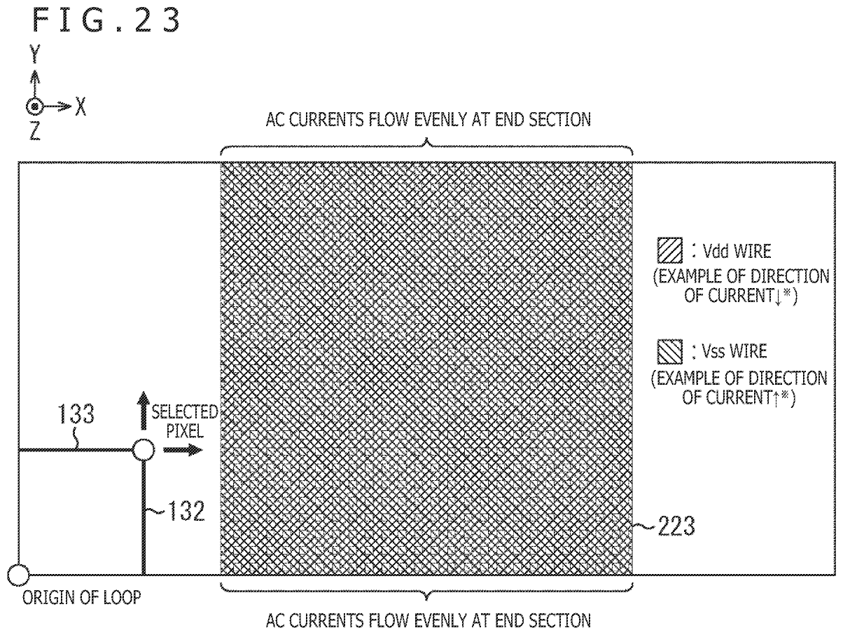

FIG. 23 is a figure depicting the condition of electric currents flowing in the third configuration example (FIG. 22).

It is assumed that AC currents flow evenly at end sections of the planar conductor 221 included in the conductor layer A and of the mesh conductor 222 included in the conductor layer B. It should be noted however that directions of electric currents change over time. For example, it is assumed that, when currents flow through the mesh conductor 222, which is a Vdd wire, from the upper side to the lower side in the figure, currents flow through the planar conductor 221, which is a Vss wire, from the lower side to the upper side in the figure.

In a case in which currents flow as depicted in FIG. 23 in the third configuration example, magnetic flux substantially in the X direction and substantially in the Y direction occurs more easily between the planar conductor 221, which is a Vss wire, and the mesh conductor 222, which is a Vdd wire, due to conductor loops that include (cross-sections of) the planar conductor 221 and the mesh conductor 222 in cross-sections along which the planar conductors 221 and the mesh conductor 222 are arranged and have loop planes that are almost perpendicular to the X axis, and conductor loops that include (cross-sections of) the planar conductor 221 and the mesh conductor 222 in cross-sections along which the planar conductors 221 and the mesh conductor 222 are arranged and have loop planes that are almost perpendicular to the Y axis.

On the other hand, in the pixel array 121 of the first semiconductor board 101 stacked on the second semiconductor board 102 in which the light-blocking structure 151 including the conductor layers A and B is formed, a Victim conductor loop including a signal line 132 and a control line 133 is formed on the XY plane. An induced electromotive force is generated in the Victim conductor loop formed on the XY plane more easily due to magnetic flux in the Z direction. The larger a change of the induced electromotive force is, the worse an image output from the solid-state image pickup apparatus 100 is (the larger the inductive noise is).

Furthermore, if the effective dimensions of the Victim conductor loop including a signal line 132 and a control line 133 change as pixels at different positions are selected in the pixel array 121, changes of the induced electromotive force become noticeable.

In the case of the third configuration example, the directions of magnetic flux (substantially in the X direction and substantially in the Y direction) generated from the loop planes of the Aggressor conductor loops of the light-blocking structure 151 including the conductor layers A and B and the direction of magnetic flux (in the Z direction) that generates an induced electromotive force to the Victim conductor loop are substantially orthogonal and different by approximately 90 degrees. In other words, the directions of the loop planes that generate magnetic flux from the Aggressor conductor loops and the direction of the loop plane that generates an induced electromotive force to the Victim conductor loop are different by approximately 90 degrees. Accordingly, it is expected that a worsening (the occurrence of inductive noise) of an image output from the solid-state image pickup apparatus 100 is mitigated as compared with the first comparative example.

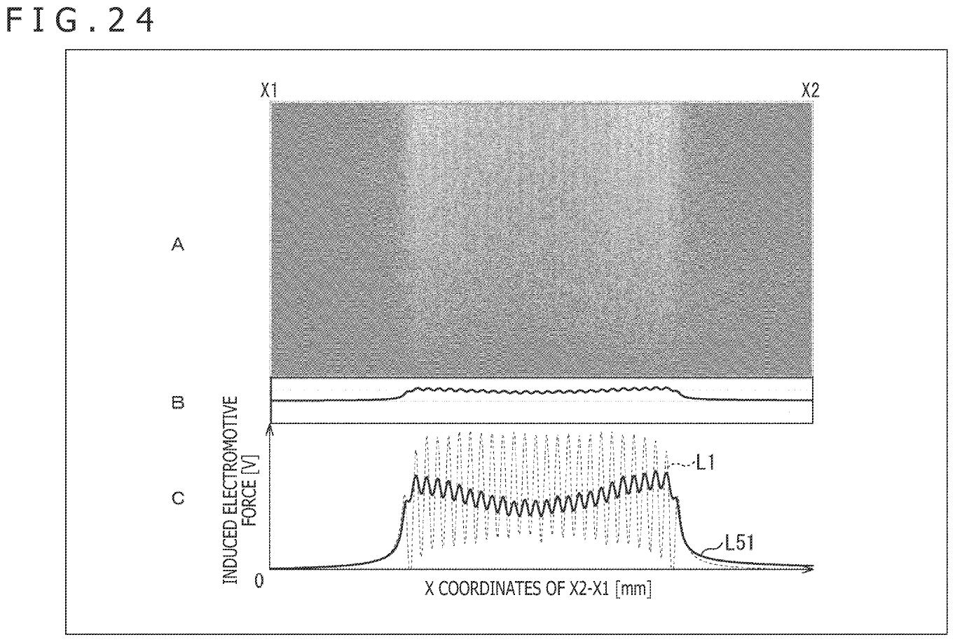

FIG. 24 depicts a result of a simulation of inductive noise that occurs in a case in which the third configuration example (FIG. 22) is applied to the solid-state image pickup apparatus 100.

A in FIG. 24 depicts an image that is output from the solid-state image pickup apparatus 100 and can have inductive noise generated therein. B in FIG. 24 depicts changes of pixel signals along a line segment X1-X2 in the image depicted in A in FIG. 24. C in FIG. 24 depicts a solid line L51 representing an induced electromotive force that has generated the inductive noise in the image. The horizontal axis in C in FIG. 24 represents the X-axis coordinate of an image, and the vertical axis represents the magnitude of an induced electromotive force. Note that the dotted line L1 in C in FIG. 24 corresponds to the first comparative example (FIG. 9).

As is apparent from a comparison between the solid line L51 and the dotted line L1 depicted in C in FIG. 24, the third configuration example can suppress changes of the induced electromotive force generated to the Victim conductor loop as compared with the first comparative example. Therefore, the occurrence of the inductive noise in an image output from the solid-state image pickup apparatus 100 can be hindered.

### Fourth Configuration Example

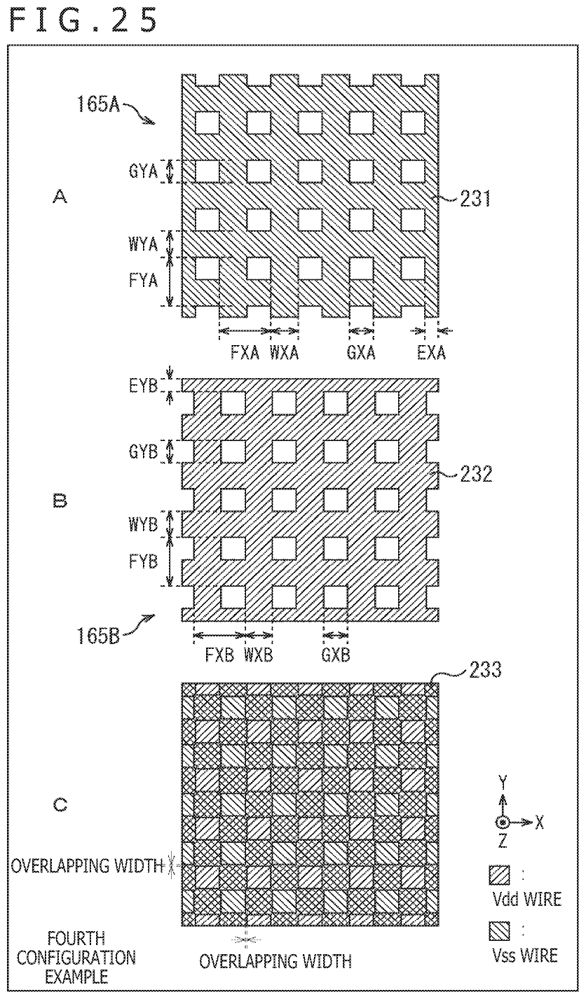

Next, FIG. 25 depicts a fourth configuration example of the conductor layers A and B. Note that A in FIG. 25 depicts the conductor layer A, and B in FIG. 25 depicts the conductor layer B. In the coordinate system in FIG. 25, the X axis lies in the lateral direction, the Y axis lies in the longitudinal direction, and the Z axis lies in a direction perpendicular to the XY plane.

The conductor layer A in the fourth configuration example includes a mesh conductor 231. The X-direction conductor width of the mesh conductor 231 is designated as WXA, the X-direction gap width is designated as GXA, the X-direction conductor pitch is designated as FXA (=(conductor width WXA)+(gap width GXA)), and the X-direction end-section width is designated as EXA (=(conductor width WXA)/2). In addition, the Y-direction conductor width of the mesh conductor 231 is designated as WYA, the Y-direction gap width is designated as GYA, and the Y-direction conductor pitch is designated as FYA (=(conductor width WYA)+(gap width GYA)). The mesh conductor 231 is a wire (Vss wire) connected to GND or a negative power supply, for example.

The conductor layer B in the fourth configuration example includes a mesh conductor 232. The X-direction conductor width of the mesh conductor 232 is designated as WXB, the X-direction gap width is designated as GXB, the X-direction conductor pitch is designated as FXB (=(conductor width WXB)+(gap width GXB)). In addition, the Y-direction conductor width of the mesh conductor 232 is designated as WYB, the Y-direction gap width is designated as GYB, the Y-direction conductor pitch is designated as FYB (=(conductor width WYB)+(gap width GYB)), and the Y-direction end-section width is designated as EYB (=(conductor width WYB)/2). The mesh conductor 232 is a wire (Vdd wire) connected to a positive power supply, for example.

Note that the mesh conductor 231 and the mesh conductor 232 desirably satisfy the following relations.

(Conductor width WXA)=(conductor width WYA)=(conductor width WXB)=(conductor width WYB)

(Gap width GXA)=(gap width GYA)=(gap width GXB)=(gap width GYB)

(End-section width EXA)=(end-section width EYB)

(Conductor pitch FXA)=(conductor pitch FYA)=(conductor pitch FXB)=(conductor pitch FYB)

(Conductor width WYA)=2×(overlapping width)+(gap width GYA),(conductor width WXA)=2×(overlapping width)+(gap width GXA)

(Conductor width WYB)=2×(overlapping width)+(gap width GYB),(conductor width WXB)=2×(overlapping width)+(gap width GXB)

Here, the overlapping width is the width of an overlapping section at which conductor sections overlap in a case in which the mesh conductor 231 in the conductor layer A and the mesh conductor 232 in the conductor layer B are arranged to overlap each other.

By making all the X-direction and Y-direction conductor pitches of the mesh conductor 231 and the mesh conductor 232 equal to each other as in the relations mentioned above, the current distribution in the mesh conductor 231 and the current distribution in the mesh conductor 232 can be made substantially even distributions and can be caused to have mutually reverse characteristics. Accordingly, the magnetic field generated by the current distribution in the mesh conductor 231 and the magnetic field generated by the current distribution in the mesh conductor 232 can be offset effectively.

In addition, by making all the X-direction and Y-direction conductor pitches, conductor widths, and gap widths of the mesh conductor 231 and the mesh conductor 232 equal to each other, wire resistances and wire impedance of the mesh conductor 231 and the mesh conductor 232 become uniform in the X direction and the Y direction. Accordingly, the magnetic-field resistances and voltage drops can be made even magnetic-field resistances and even voltage drops in the X direction and Y-direction.

In addition, by making the end-section width EXA of the mesh conductor 231 half of the conductor width WXA, it is possible to suppress an induced electromotive force generated to a Victim conductor loop as a result of a magnetic field occurring around end sections of the mesh conductor 231. In addition, by making the end-section width EYB of the mesh conductor 232 half of the conductor width WYB, it is possible to suppress an induced electromotive force generated to a Victim conductor loop as a result of a magnetic field occurring around end sections of the mesh conductor 231.

Note that, instead of providing end sections in the X direction of the mesh conductor 231 in the conductor layer A, end sections in the X direction of the mesh conductor 232 in the conductor layer B may be provided. In addition, instead of providing end sections in the Y direction of the mesh conductor 232 in the conductor layer B, end sections in the Y direction of the mesh conductor 231 in the conductor layer A may be provided.

C in FIG. 25 depicts a state of the conductor layers A and B depicted in A and B in FIG. 25, respectively, as seen from the side where photodiodes 141 are located (the backside). It should be noted however that hatched regions 233 in which diagonal lines cross in C in FIG. 25 represent regions where the mesh conductor 231 in the conductor layer A and the mesh conductor 232 in the conductor layer B overlap. Because an active element group 167 is covered with at least one of the conductor layer A or the conductor layer B in the case of the fourth configuration example, hot carrier light emissions from the active element group 167 can be blocked.

It should be noted however that, in order to block hot carrier light emissions completely by the mesh conductor 231 in the conductor layer A and the mesh conductor 232 in the conductor layer B, the following relations need to be satisfied.

(Conductor width WYA)≥(gap width GYA)

(Conductor width WXA)≥(gap width GXA)

(Conductor width WYB)≥(gap width GYB)

(Conductor width WXB)≥(gap width GXB)

In this case, the following relations are satisfied.

(Conductor width WYA)=2×(overlapping width)+(gap width GYA)

(Conductor width WXA)=2×(overlapping width)+(gap width GXA)

(Conductor width WYB)=2×(overlapping width)+(gap width GYB)

(Conductor width WXB)=2×(overlapping width)+(gap width GXB)

In a case in which currents flow similarly to the case depicted in FIG. 23 in the fourth configuration example, magnetic flux substantially in the X direction and substantially in the Y direction occurs more easily between the mesh conductor 231, which is a Vss wire, and the mesh conductor 232, which is a Vdd wire, due to conductor loops that include (cross-sections of) the mesh conductors 231 and 232 in cross-sections along which the mesh conductors 231 and 232 are arranged and have loop planes that are almost perpendicular to the X axis, and conductor loops that include (cross-sections of) the mesh conductors 231 and 232 in cross-sections along which the mesh conductors 231 and 232 are arranged and have loop planes that are almost perpendicular to the Y axis.

### Fifth Configuration Example

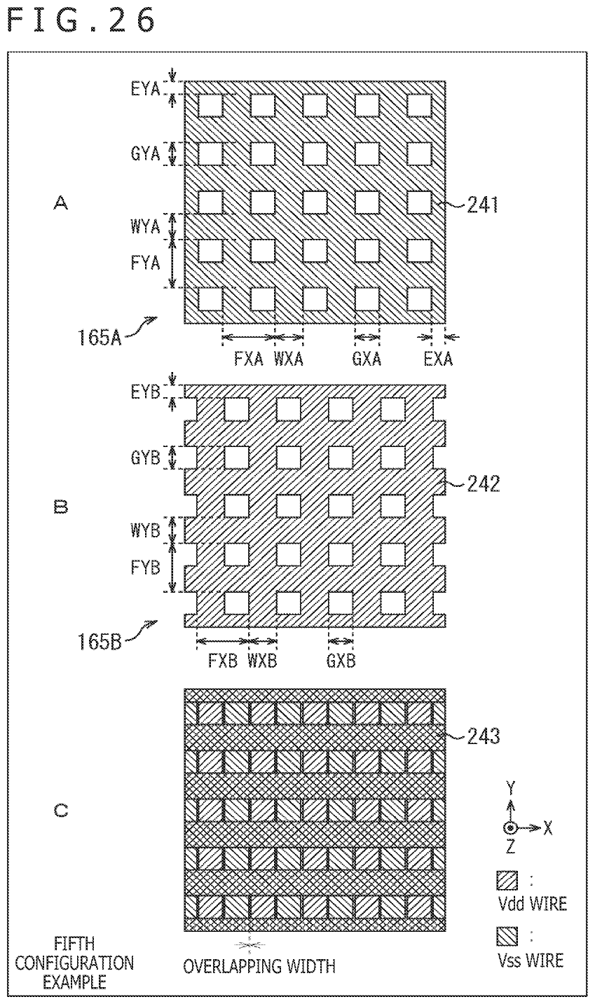

Next, FIG. 26 depicts a fifth configuration example of the conductor layers A and B. Note that A in FIG. 26 depicts the conductor layer A, and B in FIG. 26 depicts the conductor layer B. In the coordinate system in FIG. 26, the X axis lies in the lateral direction, the Y axis lies in the longitudinal direction, and the Z axis lies in a direction perpendicular to the XY plane.

The conductor layer A in the fifth configuration example includes a mesh conductor 241. The mesh conductor 241 is obtained by shifting the mesh conductor 231 forming the conductor layer A in the fourth configuration example (FIG. 25) by (conductor pitch FYA)/2 in the Y direction. The mesh conductor 241 is a wire (Vss wire) connected to GND or a negative power supply, for example.

The conductor layer B in the fifth configuration example includes a mesh conductor 242. The mesh conductor 242 has a shape similar to that of the mesh conductor 232 forming the conductor layer B in the fourth configuration example (FIG. 25), and so an explanation thereof is omitted. The mesh conductor 242 is a wire (Vdd wire) connected to a positive power supply, for example.

Note that the mesh conductor 241 and the mesh conductor 242 desirably satisfy the following relations.

(Conductor width WXA)=(conductor width WYA)=(conductor width WXB)=(conductor width WYB)

(Gap width GXA)=(gap width GYA)=(gap width GXB)=(gap width GYB)

(End-section width EXA)=(end-section width EYB)

(Conductor pitch FXA)=(conductor pitch FYA)=(conductor pitch FXB)=(conductor pitch FYB)

(Conductor width WYA)=2×(overlapping width)+(gap width GYA),(conductor width WXA)=2×(overlapping width)+(gap width GXA)

(Conductor width WYB)=2×(overlapping width)+(gap width GYB),(conductor width WXB)=2×(overlapping width)+(gap width GXB)

Here, the overlapping width is the width of an overlapping section at which conductor sections overlap in a case in which the mesh conductor 241 in the conductor layer A and the mesh conductor 242 in the conductor layer B are arranged to overlap each other.

C in FIG. 26 depicts a state of the conductor layers A and B depicted in A and B in FIG. 26, respectively, as seen from the side where photodiodes 141 are located (the backside). It should be noted however that hatched regions 243 in which diagonal lines cross in C in FIG. 26 represent regions where the mesh conductor 241 in the conductor layer A and the mesh conductor 242 in the conductor layer B overlap. Because an active element group 167 is covered with at least one of the conductor layer A or the conductor layer B in the case of the fifth configuration example, hot carrier light emissions from the active element group 167 can be blocked.

In addition, in the case of the fifth configuration example, the regions 243 where the mesh conductor 241 and the mesh conductor 242 overlap are continuous in the X direction. Because currents with mutually different polarities flow through the mesh conductor 241 and the mesh conductor 242 in the regions 243 where the mesh conductor 241 and the mesh conductor 242 overlap, magnetic fields generated from the regions 243 are cancelled out with each other. Therefore, the occurrence of inductive noise near the regions 243 can be suppressed.

In a case in which currents flow similarly to the case depicted in FIG. 23 in the fifth configuration example, magnetic flux substantially in the X direction and substantially in the Y direction occurs more easily between the mesh conductor 241, which is a Vss wire, and the mesh conductor 242, which is a Vdd wire, due to conductor loops that include (cross-sections of) the mesh conductors 241 and 242 in cross-sections along which the mesh conductors 241 and 242 are arranged and have loop planes that are almost perpendicular to the X axis, and conductor loops that include (cross-sections of) the mesh conductors 241 and 242 in cross-sections along which the mesh conductors 241 and 242 are arranged and have loop planes that are almost perpendicular to the Y axis.

### Sixth Configuration Example

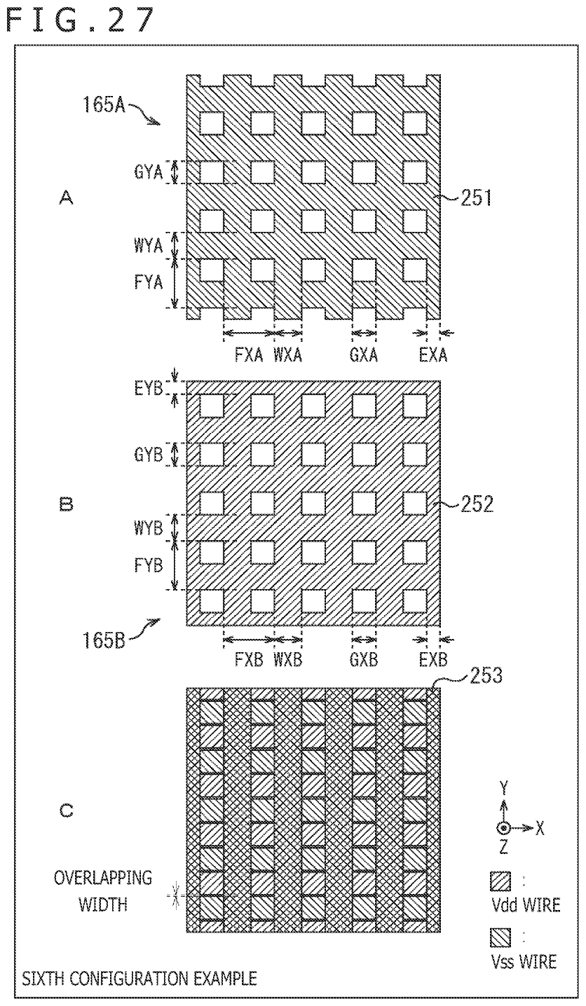

Next, FIG. 27 depicts a sixth configuration example of the conductor layers A and B. Note that A in FIG. 27 depicts the conductor layer A, and B in FIG. 27 depicts the conductor layer B. In the coordinate system in FIG. 27, the X axis lies in the lateral direction, the Y axis lies in the longitudinal direction, and the Z axis lies in a direction perpendicular to the XY plane.

The conductor layer A in the sixth configuration example includes a mesh conductor 251. The mesh conductor 251 has a shape similar to that of the mesh conductor 231 forming the conductor layer A in the fourth configuration example (FIG. 25), and so an explanation thereof is omitted. The mesh conductor 251 is a wire (Vss wire) connected to GND or a negative power supply, for example.

The conductor layer B in the sixth configuration example includes a mesh conductor 252. The mesh conductor 252 is obtained by shifting the mesh conductor 232 forming the conductor layer B in the fourth configuration example (FIG. 25) by (conductor pitch FXB)/2 in the X direction. The mesh conductor 252 is a wire (Vdd wire) connected to a positive power supply, for example.

Note that the mesh conductor 251 and the mesh conductor 252 desirably satisfy the following relations.

(Conductor width WXA)=(conductor width WYA)=(conductor width WXB)=(conductor width WYB)

(Gap width GXA)=(gap width GYA)=(gap width GXB)=(gap width GYB)

(End-section width EXA)=(end-section width EYB)

(Conductor pitch FXA)=(conductor pitch FYA)=(conductor pitch FXB)=(conductor pitch FYB)

(Conductor width WYA)=2×(overlapping width)+(gap width GYA),(conductor width WXA)=2×(overlapping width)+(gap width GXA)

(Conductor width WYB)=2×(overlapping width)+(gap width GYB),(conductor width WXB)=2×(overlapping width)+(gap width GXB)

Here, the overlapping width is the width of an overlapping section at which conductor sections overlap in a case in which the mesh conductor 251 in the conductor layer A and the mesh conductor 252 in the conductor layer B are arranged to overlap each other.

C in FIG. 27 depicts a state of the conductor layers A and B depicted in A and B in FIG. 27, respectively, as seen from the side where photodiodes 141 are located (the backside). It should be noted however that hatched regions 253 in which diagonal lines cross in C in FIG. 27 represent regions where the mesh conductor 251 in the conductor layer A and the mesh conductor 252 in the conductor layer B overlap. Because an active element group 167 is covered with at least one of the conductor layer A or the conductor layer B in the case of the sixth configuration example, hot carrier light emissions from the active element group 167 can be blocked.

In a case in which currents flow similarly to the case depicted in FIG. 23 in the sixth configuration example, magnetic flux substantially in the X direction and substantially in the Y direction occurs more easily between the mesh conductor 251, which is a Vss wire, and the mesh conductor 252, which is a Vdd wire, due to conductor loops that include (cross-sections of) the mesh conductors 251 and 252 in cross-sections along which the mesh conductors 251 and 252 are arranged and have loop planes that are almost perpendicular to the X axis, and conductor loops that include (cross-sections of) the mesh conductors 251 and 252 in cross-sections along which the mesh conductors 251 and 252 are arranged and have loop planes that are almost perpendicular to the Y axis.

Furthermore, in the case of the sixth configuration example, the regions 253 where the mesh conductor 251 and the mesh conductor 252 overlap are continuous in the Y direction. Because currents with mutually different polarities flow through the mesh conductor 251 and the mesh conductor 252 in the regions 253 where the mesh conductor 251 and the mesh conductor 252 overlap, magnetic fields generated from the regions 253 are cancelled out with each other. Therefore, the occurrence of inductive noise near the regions 253 can be suppressed.

### Results of Simulations of Fourth to Sixth Configuration Examples

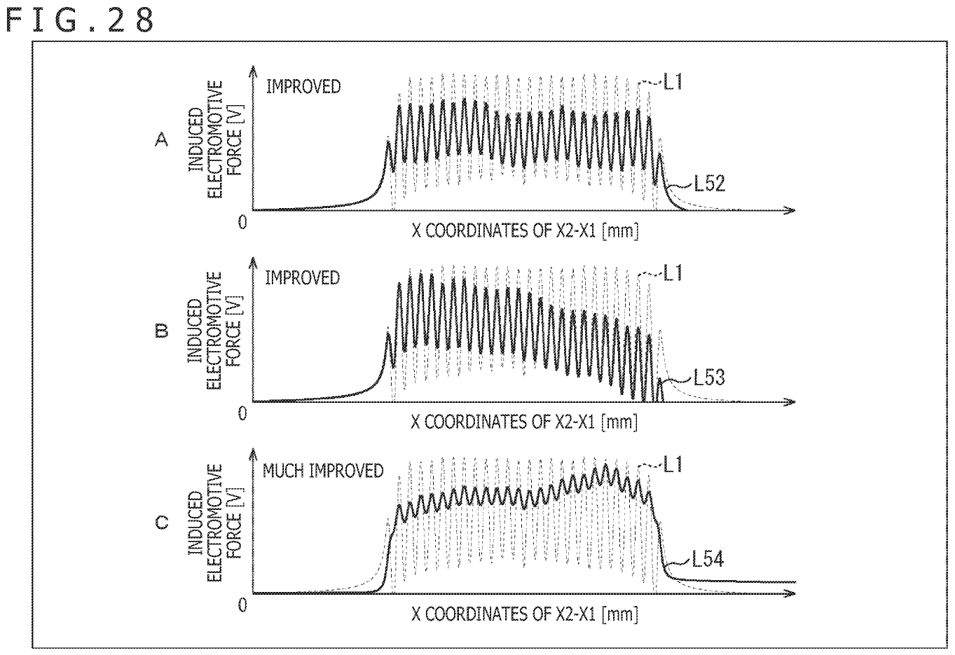

FIG. 28 depicts changes of induced electromotive forces that generate inductive noise in images, as results of simulations of the cases in which the fourth to sixth configuration examples (FIG. 25 to FIG. 27) are applied to the solid-state image pickup apparatus 100. Note that it is assumed that conditions of electric currents flowing in the fourth to sixth configuration examples are similar to those in the case depicted in FIG. 23. The horizontal axis in FIG. 28 represents the X-axis coordinate of images, and the vertical axis represents the magnitudes of the induced electromotive forces.

A solid line L52 in A in FIG. 28 corresponds to the fourth configuration example (FIG. 25), and the dotted line L1 corresponds to the first comparative example (FIG. 9). As is apparent from a comparison between the solid line L52 and the dotted line L1, it can be known that the fourth configuration example can suppress changes of the induced electromotive force generated to the Victim conductor loop and suppress inductive noise, as compared with the first comparative example.

A solid line L53 in B in FIG. 28 corresponds to the fifth configuration example (FIG. 26), and the dotted line L1 corresponds to the first comparative example (FIG. 9). As is apparent from a comparison between the solid line L53 and the dotted line L1, it can be known that the fifth configuration example can suppress changes of the induced electromotive force generated to the Victim conductor loop and suppress inductive noise, as compared with the first comparative example.

A solid line L54 in C in FIG. 28 corresponds to the sixth configuration example (FIG. 27), and the dotted line L1 corresponds to the first comparative example (FIG. 9). As is apparent from a comparison between the solid line L54 and the dotted line L1, it can be known that the sixth configuration example can suppress changes of the induced electromotive force generated to the Victim conductor loop and suppress inductive noise, as compared with the first comparative example.

In addition, as is apparent from a comparison among the solid lines L52 to L54, it can be known that the sixth configuration example can further suppress changes of the induced electromotive force generated to the Victim conductor loop and further suppress inductive noise, as compared with the fourth configuration example and the fifth configuration example.

### Seventh Configuration Example

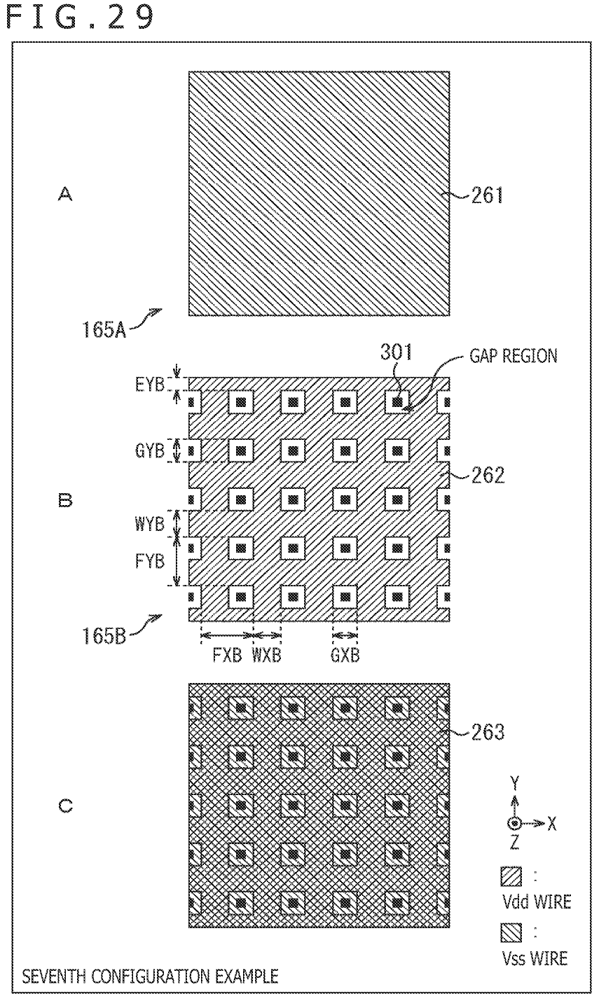

Next, FIG. 29 depicts a seventh configuration example of the conductor layers A and B. Note that A in FIG. 29 depicts the conductor layer A, and B in FIG. 29 depicts the conductor layer B. In the coordinate system in FIG. 29, the X axis lies in the lateral direction, the Y axis lies in the longitudinal direction, and the Z axis lies in a direction perpendicular to the XY plane.

The conductor layer A in the seventh configuration example includes a planar conductor 261. The planar conductor 261 is a wire (Vss wire) connected to GND or a negative power supply, for example.

The conductor layer B in the seventh configuration example includes a mesh conductor 262 and relay conductors 301. The mesh conductor 262 has a shape similar to that of the mesh conductor 222 in the conductor layer B in the third configuration example (FIG. 22), and so an explanation thereof is omitted. The mesh conductor 262 is a wire (Vdd wire) connected to a positive power supply, for example.

The relay conductors (other conductors) 301 are arranged in non-conductor gap regions in the mesh conductor 262, are electrically insulated from the mesh conductor 262, and are connected to Vss connected with the planar conductor 261 in the conductor layer A.

The shapes of the relay conductors 301 can be any shapes and desirably are circular or polygonal shapes which have symmetry like rotational symmetry, mirror symmetry, or the like. The relay conductors 301 can be arranged at the middle positions or any other positions in gap regions of the mesh conductor 262. The relay conductors 301 may be connected to a conductor layer as a Vss wire other than the conductor layer A. The relay conductors 301 may be connected to a conductor layer as a Vss wire on a side closer to an active element group 167 than to the conductor layer B. The relay conductors 301 can be connected to a conductor layer other than the conductor layer A, or a conductor layer or the like on a side closer to an active element group 167 than to the conductor layer B, via conductor vias extending in the Z direction.

C in FIG. 29 depicts a state of the conductor layers A and B depicted in A and B in FIG. 29, respectively, as seen from the side where photodiodes 141 are located (the backside). It should be noted however that a hatched region 263 in which diagonal lines cross in C in FIG. 29 represents a region where the planar conductor 261 in the conductor layer A and the mesh conductor 262 in the conductor layer B overlap. Because an active element group 167 is covered with at least one of the conductor layer A or the conductor layer B in the case of the seventh configuration example, hot carrier light emissions from the active element group 167 can be blocked.

In addition, in the case of the seventh configuration example, providing the relay conductors 301 makes it possible to connect the planar conductor 261, which is a Vss wire, with the active element group 167 with substantially the shortest distance or with a short distance. Connecting the planar conductor 261 and the active element group 167 with substantially the shortest distance or with a short distance makes it possible to reduce voltage drops, energy loss, or inductive noise between the planar conductor 261 and the active element group 167.

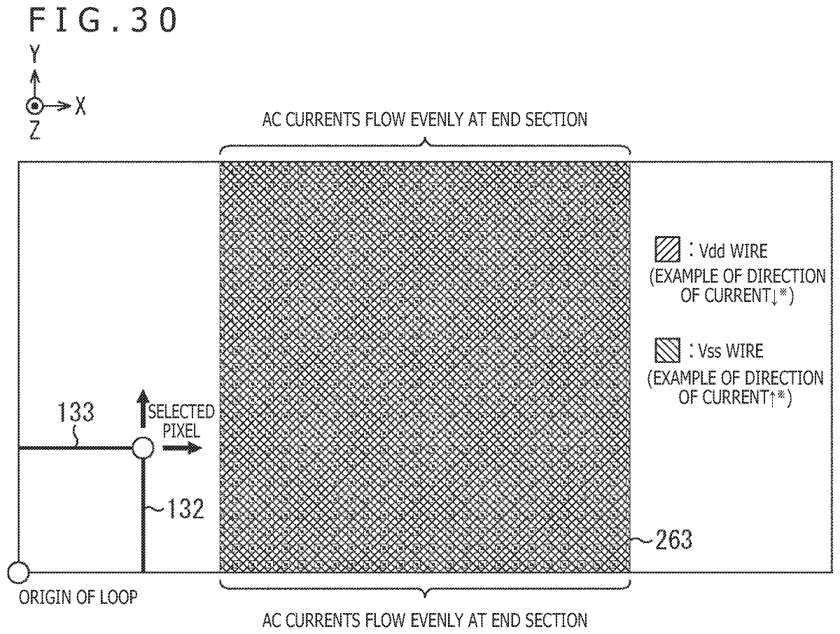

FIG. 30 is a figure depicting the condition of electric currents flowing in the seventh configuration example (FIG. 29).

It is assumed that AC currents flow evenly at end sections of the planar conductor 261 included in the conductor layer A and of the mesh conductor 262 included in the conductor layer B. It should be noted however that directions of electric currents change over time. For example, it is assumed that, when currents flow through the mesh conductor 262, which is a Vdd wire, from the upper side to the lower side in the figure, currents flow through the planar conductor 261, which is a Vss wire, from the lower side to the upper side in the figure.

In a case in which currents flow as depicted in FIG. 30 in the seventh configuration example, magnetic flux substantially in the X direction and substantially in the Y direction occurs more easily between the planar conductor 261, which is a Vss wire, and the mesh conductor 262, which is a Vdd wire, due to conductor loops that include (cross-sections of) the planar conductor 261 and the mesh conductor 262 in cross-sections along which the planar conductors 261 and the mesh conductor 262 are arranged and have loop planes that are almost perpendicular to the X axis, and conductor loops that include (cross-sections of) the planar conductor 261 and the mesh conductor 262 in cross-sections along which the planar conductors 261 and the mesh conductor 262 are arranged and have loop planes that are almost perpendicular to the Y axis.

On the other hand, in the pixel array 121 of the first semiconductor board 101 stacked on the second semiconductor board 102 in which the light-blocking structure 151 including the conductor layers A and B is formed, a Victim conductor loop including a signal line 132 and a control line 133 is formed on the XY plane. An induced electromotive force is generated in the Victim conductor loop formed on the XY plane more easily due to magnetic flux in the Z direction. The larger a change of the induced electromotive force is, the worse an image output from the solid-state image pickup apparatus 100 is (the larger the inductive noise is).

Furthermore, if the effective dimensions of the Victim conductor loop including a signal line 132 and a control line 133 change as pixels at different positions are selected in the pixel array 121, changes of the induced electromotive force become noticeable.

In the case of the seventh configuration example, the directions of magnetic flux (substantially in the X direction and substantially in the Y direction) generated from the loop planes of the Aggressor conductor loops of the light-blocking structure 151 including the conductor layers A and B and the direction of magnetic flux (in the Z direction) that generates an induced electromotive force to the Victim conductor loop are substantially orthogonal and different by approximately 90 degrees. In other words, the directions of the loop planes that generate magnetic flux from the Aggressor conductor loops and the direction of the loop plane that generates an induced electromotive force to the Victim conductor loop are different by approximately 90 degrees. Accordingly, it is expected that a worsening (the occurrence of inductive noise) of an image output from the solid-state image pickup apparatus 100 is mitigated as compared with the first comparative example.

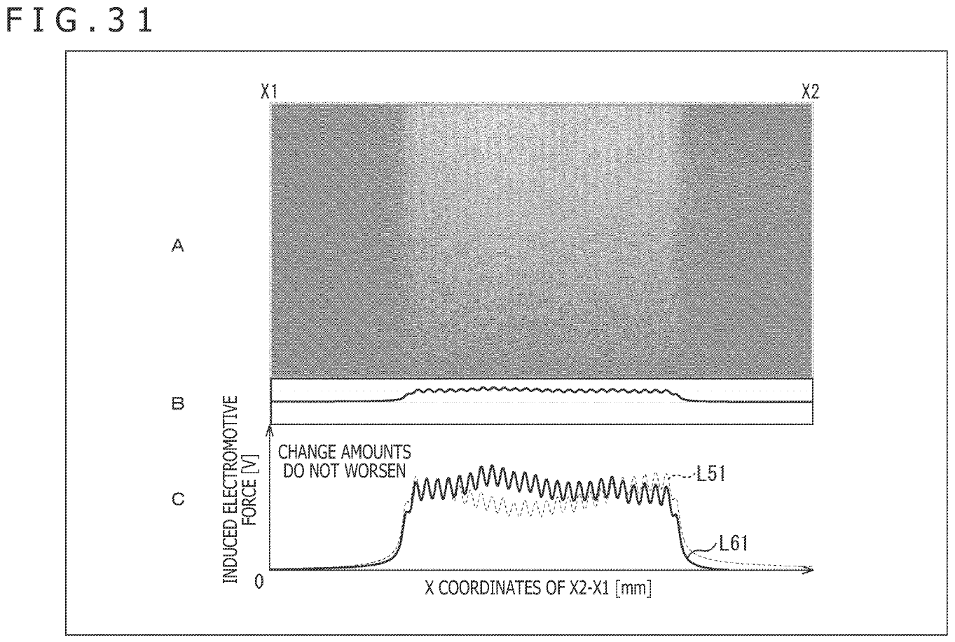

FIG. 31 depicts a result of a simulation of inductive noise that occurs in a case in which the seventh configuration example (FIG. 29) is applied to the solid-state image pickup apparatus 100.

A in FIG. 31 depicts an image that is output from the solid-state image pickup apparatus 100 and can have inductive noise generated therein. B in FIG. 31 depicts changes of pixel signals along a line segment X1-X2 in the image depicted in A in FIG. 31. C in FIG. 31 depicts a solid line L61 representing an induced electromotive force that has generated the inductive noise in the image. The horizontal axis in C in FIG. 31 represents the X-axis coordinate of an image, and the vertical axis represents the magnitude of an induced electromotive force. Note that a dotted line L51 in C in FIG. 31 corresponds to the third configuration example (FIG. 22).

As is apparent from a comparison between the solid line L61 and the dotted line L51 depicted in C in FIG. 31, it can be known that the seventh configuration example does not worsen changes of an induced electromotive force generated to the Victim conductor loop as compared with the third configuration example. That is, also in the seventh configuration example in which the relay conductors 301 are arranged in the gaps of the mesh conductor 262 in the conductor layer B, it is possible to suppress the occurrence of inductive noise in an image output from the solid-state image pickup apparatus 100 to the same degree as that in the third configuration example. It should be noted however that the simulation result represents a result of a simulation of a case in which the planar conductor 261 is not connected with an active element group 167 and the mesh conductor 262 is not connected with an active element group 167. For example, in a case in which the planar conductor 261 and at least part of an active element group 167 are connected with each other with substantially the shortest distance or with a short distance via conductor vias or the like, or in a case in which the mesh conductor 262 and at least part of an active element group 167 are connected with each other with substantially the shortest distance or with a short distance via conductor vias or the like, the amount of currents flowing through the planar conductor 261 or the mesh conductor 262 gradually decreases depending on positions. In such a case, there is also a condition under which voltage drops, energy loss, or inductive noise are/is ameliorated significantly to be half or smaller by providing the relay conductors 301.

### Eighth Configuration Example

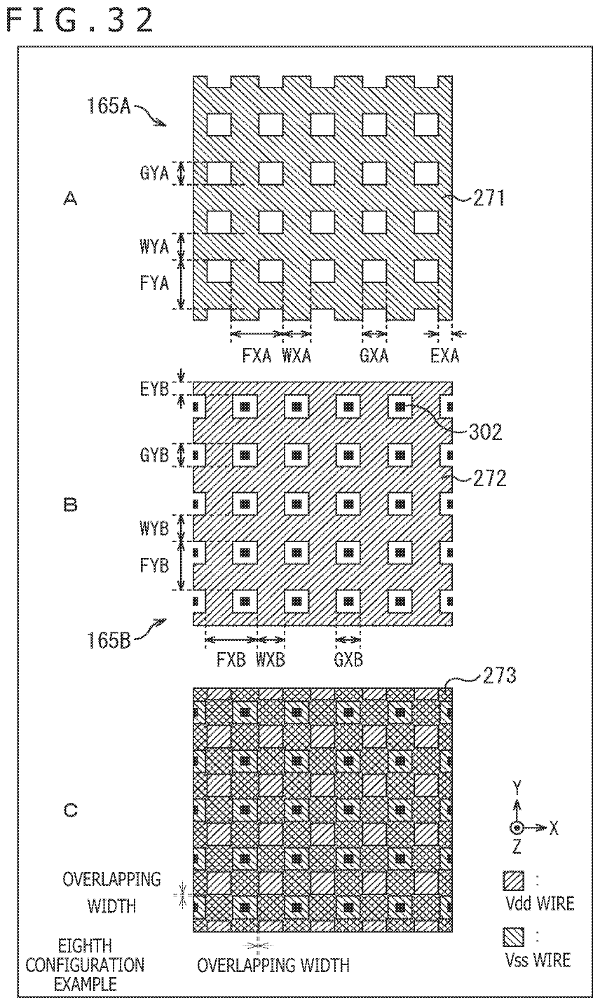

Next, FIG. 32 depicts an eighth configuration example of the conductor layers A and B. Note that A in FIG. 32 depicts the conductor layer A, and B in FIG. 32 depicts the conductor layer B. In the coordinate system in FIG. 32, the X axis lies in the lateral direction, the Y axis lies in the longitudinal direction, and the Z axis lies in a direction perpendicular to the XY plane.

The conductor layer A in the eighth configuration example includes a mesh conductor 271. The mesh conductor 271 has a shape similar to that of the mesh conductor 231 in the conductor layer A in the fourth configuration example (FIG. 25), and so an explanation thereof is omitted. The mesh conductor 271 is a wire (Vss wire) connected to GND or a negative power supply, for example.

The conductor layer B in the eighth configuration example includes a mesh conductor 272 and relay conductors 302. The mesh conductor 272 has a shape similar to that of the mesh conductor 232 in the conductor layer B in the fourth configuration example (FIG. 25), and so an explanation thereof is omitted. The mesh conductor 232 is a wire (Vdd wire) connected to a positive power supply, for example.

The relay conductors (other conductors) 302 are arranged in non-conductor gap regions in the mesh conductor 272, are electrically insulated from the mesh conductor 272, and are connected to Vss connected with the mesh conductor 271 in the conductor layer A.

Note that the shapes of the relay conductors 302 can be any shapes and desirably are circular or polygonal shapes which have symmetry like rotational symmetry, mirror symmetry, or the like. The relay conductors 302 can be arranged at the middle positions or any other positions in gap regions of the mesh conductor 272. The relay conductors 302 may be connected to a conductor layer as a Vss wire other than the conductor layer A. The relay conductors 302 may be connected to a conductor layer as a Vss wire on a side closer to an active element group 167 than to the conductor layer B. The relay conductors 302 can be connected to a conductor layer other than the conductor layer A, or a conductor layer or the like on a side closer to an active element group 167 than to the conductor layer B, via conductor vias extending in the Z direction.

C in FIG. 32 depicts a state of the conductor layers A and B depicted in A and B in FIG. 32, respectively, as seen from the side where photodiodes 141 are located (the backside). It should be noted however that hatched regions 273 in which diagonal lines cross in C in FIG. 32 represent regions where the mesh conductor 271 in the conductor layer A and the mesh conductor 272 in the conductor layer B overlap. Because an active element group 167 is covered with at least one of the conductor layer A or the conductor layer B in the case of the eighth configuration example, hot carrier light emissions from the active element group 167 can be blocked.

In a case in which currents flow similarly to the case depicted in FIG. 30 in the eighth configuration example, magnetic flux substantially in the X direction and substantially in the Y direction occurs more easily between the mesh conductor 271, which is a Vss wire, and the mesh conductor 272, which is a Vdd wire, due to conductor loops that include (cross-sections of) the mesh conductors 271 and 272 in cross-sections along which the mesh conductors 271 and 272 are arranged and have loop planes that are almost perpendicular to the X axis, and conductor loops that include (cross-sections of) the mesh conductors 271 and 272 in cross-sections along which the mesh conductors 271 and 272 are arranged and have loop planes that are almost perpendicular to the Y axis.

In addition, in the case of the eighth configuration example, providing the relay conductors 302 makes it possible to connect the mesh conductor 271, which is a Vss wire, with the active element group 167 with substantially the shortest distance or with a short distance. Connecting the mesh conductor 271 and the active element group 167 with substantially the shortest distance or with a short distance makes it possible to reduce voltage drops, energy loss, or inductive noise between the mesh conductor 271 and the active element group 167.

### Ninth Configuration Example

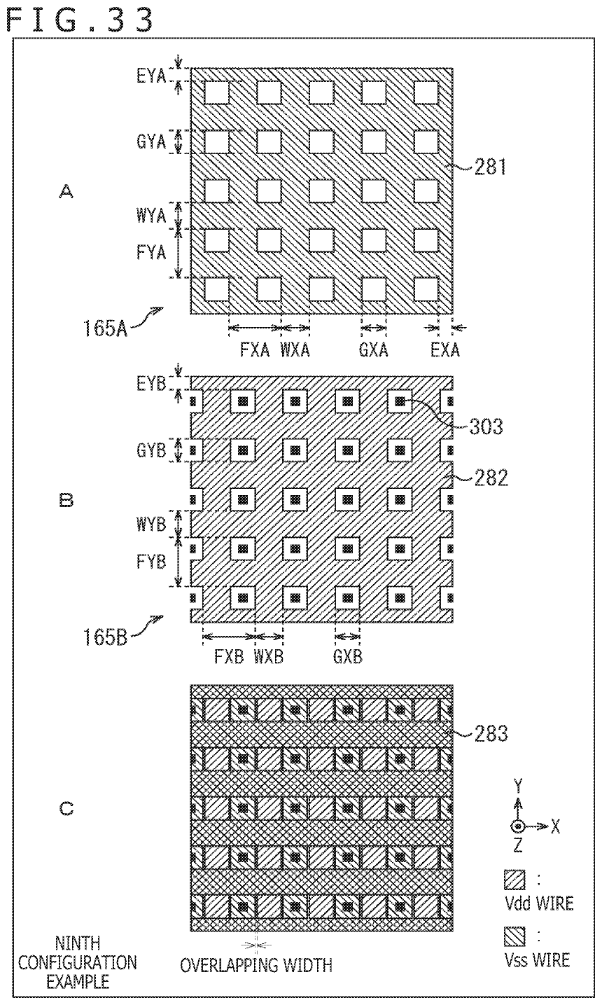

Next, FIG. 33 depicts a ninth configuration example of the conductor layers A and B. Note that A in FIG. 33 depicts the conductor layer A, and B in FIG. 33 depicts the conductor layer B. In the coordinate system in FIG. 33, the X axis lies in the lateral direction, the Y axis lies in the longitudinal direction, and the Z axis lies in a direction perpendicular to the XY plane.

The conductor layer A in the ninth configuration example includes a mesh conductor 281. The mesh conductor 281 has a shape similar to that of the mesh conductor 241 in the conductor layer A in the fifth configuration example (FIG. 26), and so an explanation thereof is omitted. The mesh conductor 281 is a wire (Vss wire) connected to GND or a negative power supply, for example.

The conductor layer B in the ninth configuration example includes a mesh conductor 282 and relay conductors 303. The mesh conductor 282 has a shape similar to that of the mesh conductor 242 in the conductor layer B in the fifth configuration example (FIG. 26), and so an explanation thereof is omitted. The mesh conductor 282 is a wire (Vdd wire) connected to a positive power supply, for example.

The relay conductors (other conductors) 303 are arranged in non-conductor gap regions in the mesh conductor 282, are electrically insulated from the mesh conductor 282, and are connected to Vss connected with the mesh conductor 281 in the conductor layer A.

Note that the shapes of the relay conductors 303 can be any shapes and desirably are circular or polygonal shapes which have symmetry like rotational symmetry, mirror symmetry, or the like. The relay conductors 303 can be arranged at the middle positions or any other positions in gap regions of the mesh conductor 282. The relay conductors 303 may be connected to a conductor layer as a Vss wire other than the conductor layer A. The relay conductors 303 may be connected to a conductor layer as a Vss wire on a side closer to an active element group 167 than to the conductor layer B. The relay conductors 303 can be connected to a conductor layer other than the conductor layer A, or a conductor layer or the like on a side closer to an active element group 167 than to the conductor layer B, via conductor vias extending in the Z direction.

C in FIG. 33 depicts a state of the conductor layers A and B depicted in A and B in FIG. 33, respectively, as seen from the side where photodiodes 141 are located (the backside). It should be noted however that hatched regions 283 in which diagonal lines cross in C in FIG. 33 represent regions where the mesh conductor 281 in the conductor layer A and the mesh conductor 282 in the conductor layer B overlap. Because an active element group 167 is covered with at least one of the conductor layer A or the conductor layer B in the case of the ninth configuration example, hot carrier light emissions from the active element group 167 can be blocked.

In a case in which currents flow similarly to the case depicted in FIG. 30 in the ninth configuration example, magnetic flux substantially in the X direction and substantially in the Y direction occurs more easily between the mesh conductor 281, which is a Vss wire, and the mesh conductor 282, which is a Vdd wire, due to conductor loops that include (cross-sections of) the mesh conductors 281 and 282 in cross-sections along which the mesh conductors 281 and 282 are arranged and have loop planes that are almost perpendicular to the X axis, and conductor loops that include (cross-sections of) the mesh conductors 281 and 282 in cross-sections along which the mesh conductors 281 and 282 are arranged and have loop planes that are almost perpendicular to the Y axis.

In addition, in the case of the ninth configuration example, providing the relay conductors 303 makes it possible to connect the mesh conductor 281, which is a Vss wire, with the active element group 167 with substantially the shortest distance or with a short distance. Connecting the mesh conductor 281 and the active element group 167 with substantially the shortest distance or with a short distance makes it possible to reduce voltage drops, energy loss, or inductive noise between the mesh conductor 281 and the active element group 167.

### Tenth Configuration Example

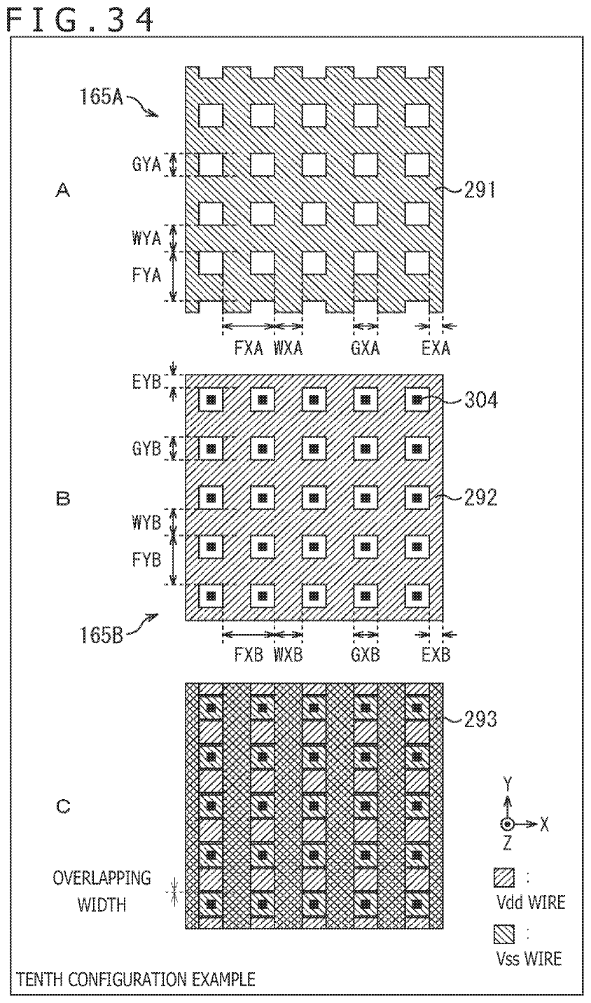

Next, FIG. 34 depicts a tenth configuration example of the conductor layers A and B. Note that A in FIG. 34 depicts the conductor layer A, and B in FIG. 34 depicts the conductor layer B. In the coordinate system in FIG. 34, the X axis lies in the lateral direction, the Y axis lies in the longitudinal direction, and the Z axis lies in a direction perpendicular to the XY plane.

The conductor layer A in the tenth configuration example includes a mesh conductor 291. The mesh conductor 291 has a shape similar to that of the mesh conductor 251 in the conductor layer A in the sixth configuration example (FIG. 27), and so an explanation thereof is omitted. The mesh conductor 291 is a wire (Vss wire) connected to GND or a negative power supply, for example.

The conductor layer B in the tenth configuration example includes a mesh conductor 292 and relay conductors 304. The mesh conductor 292 has a shape similar to that of the mesh conductor 252 in the conductor layer B in the sixth configuration example (FIG. 27), and so an explanation thereof is omitted. The mesh conductor 292 is a wire (Vdd wire) connected to a positive power supply, for example.

The relay conductors (other conductors) 304 are arranged in non-conductor gap regions in the mesh conductor 292, are electrically insulated from the mesh conductor 292, and are connected to Vss connected with the mesh conductor 291 in the conductor layer A.

Note that the shapes of the relay conductors 304 can be any shapes and desirably are circular or polygonal shapes which have symmetry like rotational symmetry, mirror symmetry, or the like. The relay conductors 304 can be arranged at the middle positions or any other positions in gap regions of the mesh conductor 292. The relay conductors 304 may be connected to a conductor layer as a Vss wire other than the conductor layer A. The relay conductors 304 may be connected to a conductor layer as a Vss wire on a side closer to an active element group 167 than to the conductor layer B. The relay conductors 304 can be connected to a conductor layer other than the conductor layer A, or a conductor layer or the like on a side closer to an active element group 167 than to the conductor layer B, via conductor vias extending in the Z direction.

C in FIG. 34 depicts a state of the conductor layers A and B depicted in A and B in FIG. 34, respectively, as seen from the side where photodiodes 141 are located (the backside). It should be noted however that hatched regions 293 in which diagonal lines cross in C in FIG. 34 represent regions where the mesh conductor 291 in the conductor layer A and the mesh conductor 292 in the conductor layer B overlap. Because an active element group 167 is covered with at least one of the conductor layer A or the conductor layer B in the case of the tenth configuration example, hot carrier light emissions from the active element group 167 can be blocked.

In a case in which currents flow similarly to the case depicted in FIG. 30 in the tenth configuration example, magnetic flux substantially in the X direction and substantially in the Y direction occurs more easily between the mesh conductor 291, which is a Vss wire, and the mesh conductor 292, which is a Vdd wire, due to conductor loops that include (cross-sections of) the mesh conductors 291 and 292 in cross-sections along which the mesh conductors 291 and 292 are arranged and have loop planes that are almost perpendicular to the X axis, and conductor loops that include (cross-sections of) the mesh conductors 291 and 292 in cross-sections along which the mesh conductors 291 and 292 are arranged and have loop planes that are almost perpendicular to the Y axis.

In addition, in the case of the tenth configuration example, providing the relay conductors 304 makes it possible to connect the mesh conductor 291, which is a Vss wire, with the active element group 167 with substantially the shortest distance or with a short distance. Connecting the mesh conductor 291 and the active element group 167 with substantially the shortest distance or with a short distance makes it possible to reduce voltage drops, energy loss, or inductive noise between the mesh conductor 291 and the active element group 167.

### Results of Simulations of Eighth to Tenth Configuration Examples

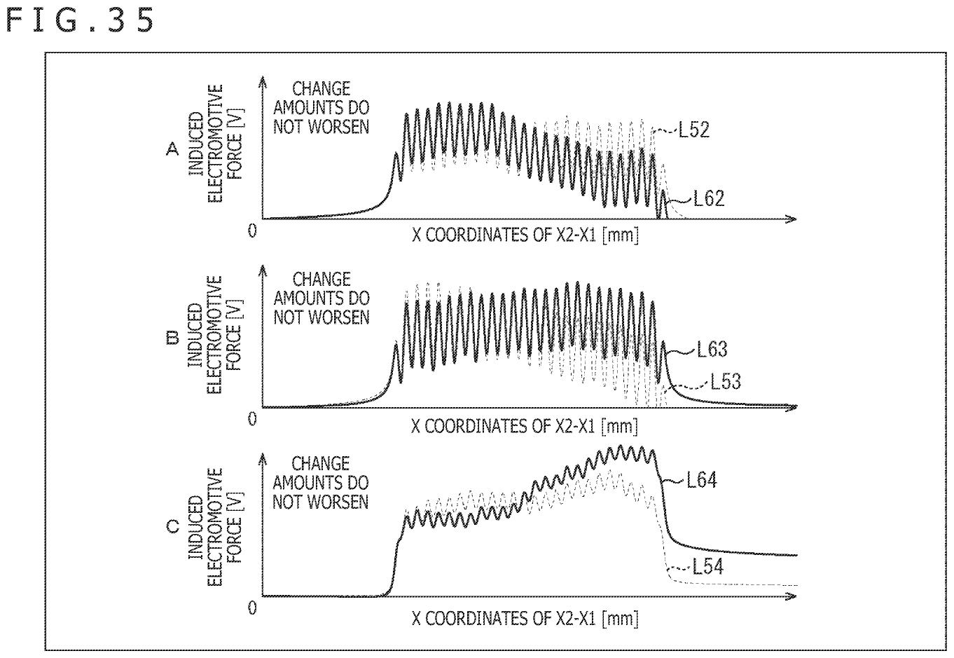

FIG. 35 depicts changes of induced electromotive forces that generate inductive noise in images, as results of simulations of the cases in which the eighth to tenth configuration examples (FIG. 32 to FIG. 34) are applied to the solid-state image pickup apparatus 100. Note that it is assumed that conditions of electric currents flowing in the eighth to tenth configuration examples are similar to those in the case depicted in FIG. 30. The horizontal axis in FIG. 35 represents the X-axis coordinate of images, and the vertical axis represents the magnitudes of the induced electromotive forces.

A solid line L62 in A in FIG. 35 corresponds to the eighth configuration example (FIG. 32), and a dotted line L52 corresponds to the fourth configuration example (FIG. 25). As is apparent from a comparison between the solid line L62 and the dotted line L52, it can be known that the eighth configuration example does not worsen changes of an induced electromotive force generated to the Victim conductor loop as compared with the fourth configuration example. That is, also in the eighth configuration example in which the relay conductors 302 are arranged in the gaps of the mesh conductor 272 in the conductor layer B, it is possible to suppress the occurrence of inductive noise in an image output from the solid-state image pickup apparatus 100 to the same degree as that in the fourth configuration example. It should be noted however that the simulation result represents a result of a simulation of a case in which the mesh conductor 271 is not connected with an active element group 167 and the mesh conductor 272 is not connected with an active element group 167. For example, in a case in which the mesh conductor 271 and at least part of an active element group 167 are connected with each other with substantially the shortest distance or with a short distance via conductor vias or the like, or in a case in which the mesh conductor 272 and at least part of an active element group 167 are connected with each other with substantially the shortest distance or with a short distance via conductor vias or the like, the amount of currents flowing through the mesh conductor 271 or the mesh conductor 272 gradually decreases depending on positions. In such a case, there is also a condition under which voltage drops, energy loss, or inductive noise are/is ameliorated significantly to be half or smaller by providing the relay conductors 302.

A solid line L63 in B in FIG. 35 corresponds to the ninth configuration example (FIG. 33), and a dotted line L53 corresponds to the fifth configuration example (FIG. 26). As is apparent from a comparison between the solid line L63 and the dotted line L53, it can be known that the ninth configuration example does not worsen changes of an induced electromotive force generated to the Victim conductor loop as compared with the fifth configuration example. That is, also in the ninth configuration example in which the relay conductors 303 are arranged in the gaps of the mesh conductor 282 in the conductor layer B, it is possible to suppress the occurrence of inductive noise in an image output from the solid-state image pickup apparatus 100 to the same degree as that in the fifth configuration example. It should be noted however that the simulation result represents a result of a simulation of a case in which the mesh conductor 281 is not connected with an active element group 167 and the mesh conductor 282 is not connected with an active element group 167. For example, in a case in which the mesh conductor 281 and at least part of an active element group 167 are connected with each other with substantially the shortest distance or with a short distance via conductor vias or the like, or in a case in which the mesh conductor 282 and at least part of an active element group 167 are connected with each other with substantially the shortest distance or with a short distance via conductor vias or the like, the amount of currents flowing through the mesh conductor 281 or the mesh conductor 282 gradually decreases depending on positions. In such a case, there is also a condition under which voltage drops, energy loss, or inductive noise are/is ameliorated significantly to be half or smaller by providing the relay conductors 303.

A solid line L64 in C in FIG. 35 corresponds to the tenth configuration example (FIG. 34), and a dotted line L54 corresponds to the sixth configuration example (FIG. 27). As is apparent from a comparison between the solid line L64 and the dotted line L54, it can be known that the tenth configuration example does not worsen changes of an induced electromotive force generated to the Victim conductor loop as compared with the sixth configuration example. That is, also in the tenth configuration example in which the relay conductors 304 are arranged in the gaps of the mesh conductor 292 in the conductor layer B, it is possible to suppress the occurrence of inductive noise in an image output from the solid-state image pickup apparatus 100 to the same degree as that in the sixth configuration example. It should be noted however that the simulation result represents a result of a simulation of a case in which the mesh conductor 291 is not connected with an active element group 167 and the mesh conductor 292 is not connected with an active element group 167. For example, in a case in which the mesh conductor 291 and at least part of an active element group 167 are connected with each other with substantially the shortest distance or with a short distance via conductor vias or the like, or in a case in which the mesh conductor 292 and at least part of an active element group 167 are connected with each other with substantially the shortest distance or with a short distance via conductor vias or the like, the amount of currents flowing through the mesh conductor 291 or the mesh conductor 292 gradually decreases depending on positions. In such a case, there is also a condition under which voltage drops, energy loss, or inductive noise are/is ameliorated significantly to be half or smaller by providing the relay conductors 304.

In addition, as is apparent from a comparison among the solid lines L62 to L64, it can be known that the tenth configuration example can further suppress changes of the induced electromotive force generated to the Victim conductor loop and further suppress inductive noise, as compared with the eighth configuration example and the ninth configuration example.

### Eleventh Configuration Example

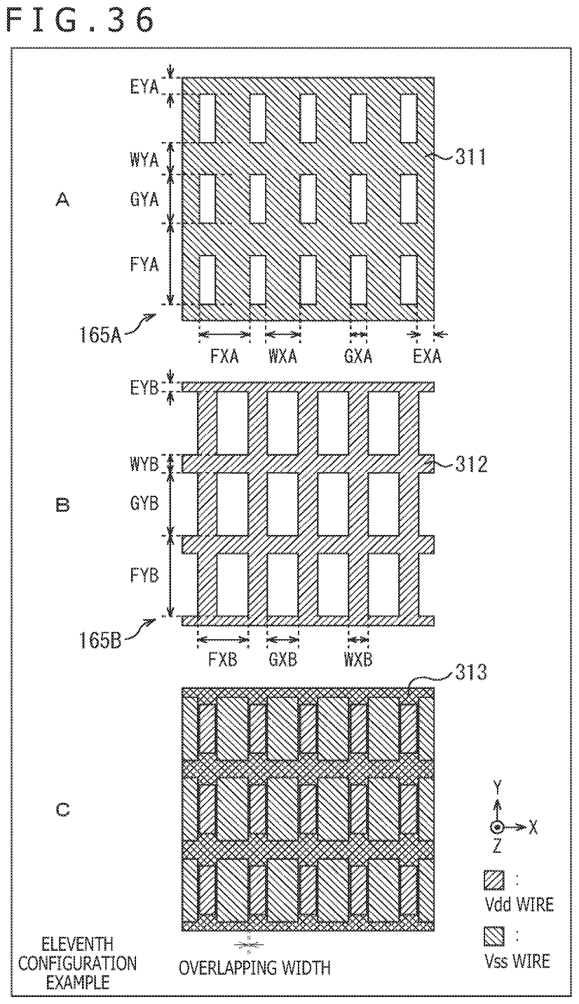

Next, FIG. 36 depicts an eleventh configuration example of the conductor layers A and B. Note that A in FIG. 36 depicts the conductor layer A, and B in FIG. 36 depicts the conductor layer B. In the coordinate system in FIG. 36, the X axis lies in the lateral direction, the Y axis lies in the longitudinal direction, and the Z axis lies in a direction perpendicular to the XY plane.

The conductor layer A in the eleventh configuration example includes a mesh conductor 311 with an X-direction (first-direction) resistance value and a Y-direction (second-direction) resistance value that are different from each other. The mesh conductor 311 is a wire (Vss wire) connected to GND or a negative power supply, for example.

The X-direction conductor width of the mesh conductor 311 is designated as WXA, the X-direction gap width is designated as GXA, the X-direction conductor pitch is designated as FXA (=(conductor width WXA)+(gap width GXA)), and the X-direction end-section width is designated as EXA (=(conductor width WXA)/2). In addition, the Y-direction conductor width of the mesh conductor 311 is designated as WYA, the Y-direction gap width is designated as GYA, the Y-direction conductor pitch is designated as FYA (=(conductor width WYA)+(gap width GYA)), and the Y-direction end-section width is designated as EYA (=(conductor width WYA)/2). The mesh conductor 311 satisfies (gap width GYA)>(gap width GXA). Accordingly, gap regions of the mesh conductor 311 have shapes which are longer in the Y direction than in the X direction. The mesh conductor 311 has mutually different X-direction and Y-direction resistance values, and the Y-direction resistance value is smaller than the X-direction resistance value.

The conductor layer B in the eleventh configuration example includes a mesh conductor 312 with an X-direction resistance value and a Y-direction resistance value that are different from each other. The mesh conductor 312 is a wire (Vdd wire) connected to a positive power supply, for example.

The X-direction conductor width of the mesh conductor 312 is designated as WXB, the X-direction gap width is designated as GXB, and the X-direction conductor pitch is designated as FXB (=(conductor width WXB)+(gap width GXB)). In addition, the Y-direction conductor width of the mesh conductor 312 is designated as WYB, the Y-direction gap width is designated as GYB, the Y-direction conductor pitch is designated as FYB (=(conductor width WYB)+(gap width GYB)), and the Y-direction end-section width is designated as EYB (=(conductor width WYB)/2). The mesh conductor 312 satisfies (gap width GYB)>(gap width GXB). Accordingly, gap regions of the mesh conductor 312 have shapes which are longer in the Y direction than in the X direction. The mesh conductor 312 has mutually different X-direction and Y-direction resistance values, and the Y-direction resistance value is smaller than the X-direction resistance value.

Note that in a case in which the sheet resistance value of the mesh conductor 311 is larger than the sheet resistance value of the mesh conductor 312, the mesh conductor 311 and the mesh conductor 312 desirably satisfy the following relations.

(Conductor width WYA)≥(conductor width WYB)

(Conductor width WXA)≥(conductor width WXB)

(Gap width GXA)≤(gap width GXB)

(Gap width GYA)≤(gap width GYB)

In contrast, in a case in which the sheet resistance value of the mesh conductor 311 is smaller than the sheet resistance value of the mesh conductor 312, the mesh conductor 311 and the mesh conductor 312 desirably satisfy the following relations.

(Conductor width WYA)≤(conductor width WYB)

(Conductor width WXA)≤(conductor width WXB)

(Gap width GXA)≥(gap width GXB)

(Gap width GYA)≥(gap width GYB)

Furthermore, the sheet resistance values and conductor widths of the mesh conductors 311 and 312 desirably satisfy the following relations.

(Sheet resistance value of mesh conductor 311)/(sheet resistance value of mesh conductor 312)≈(conductor width WYA)/(conductor width WYB)

(Sheet resistance value of mesh conductor 311)/(sheet resistance value of mesh conductor 312)≈(conductor width WXA)/(conductor width WXB)

Limitations related to dimensional relations disclosed in the present specification are not essential limitations, but desirably the mesh conductor 311 and the mesh conductor 312 are configured such that the current distribution in the mesh conductor 311 and the current distribution in the mesh conductor 312 are substantially even, substantially the same, or substantially similar current distributions and are current distributions with reverse characteristics.

For example, the mesh conductor 311 and the mesh conductor 312 are desirably configured such that the ratio between the X-direction wire resistance of the mesh conductor 311 and the Y-direction wire resistance of the mesh conductor 311, and the ratio between the X-direction wire resistance of the mesh conductor 312 and the Y-direction wire resistance of the mesh conductor 312 are substantially the same.

In addition, the mesh conductor 311 and the mesh conductor 312 are desirably configured such that the ratio between the X-direction wire inductance of the mesh conductor 311 and the Y-direction wire inductance of the mesh conductor 311, and the ratio between the X-direction wire inductance of the mesh conductor 312 and the Y-direction wire inductance of the mesh conductor 312 are substantially the same.

In addition, the mesh conductor 311 and the mesh conductor 312 are desirably configured such that the ratio between the X-direction wire capacitance of the mesh conductor 311 and the Y-direction wire capacitance of the mesh conductor 311, and the ratio between the X-direction wire capacitance of the mesh conductor 312 and the Y-direction wire capacitance of the mesh conductor 312 are substantially the same.

In addition, the mesh conductor 311 and the mesh conductor 312 are desirably configured such that the ratio between the X-direction wire impedance of the mesh conductor 311 and the Y-direction wire impedance of the mesh conductor 311, and the ratio between the X-direction wire impedance of the mesh conductor 312 and the Y-direction wire impedance of the mesh conductor 312 are substantially the same.

In other words, the mesh conductor 311 and the mesh conductor 312 desirably, but not essentially, satisfy any of the relations:

((X-direction wire resistance of mesh conductor 311)×(Y-direction wire resistance of mesh conductor 312))≈((X-direction wire resistance of mesh conductor 312)×(Y-direction wire resistance of mesh conductor 311));

((X-direction wire inductance of mesh conductor 311)×(Y-direction wire inductance of mesh conductor 312))≈((X-direction wire inductance of mesh conductor 312)×(Y-direction wire inductance of mesh conductor 311));

((X-direction wire capacitance of mesh conductor 311)×(Y-direction wire capacitance of mesh conductor 312))≈((X-direction wire capacitance of mesh conductor 312)×(Y-direction wire capacitance of mesh conductor 311)); and

((X-direction wire impedance of mesh conductor 311)×(Y-direction wire impedance of mesh conductor 312))≈((X-direction wire impedance of mesh conductor 312)×(Y-direction wire impedance of mesh conductor 311)).

Note that the wire resistances, wire inductances, wire capacitance, and wire impedances mentioned above can be replaced with conductor resistances, conductor inductance, conductor capacitance, and conductor impedances, respectively.

Note that the impedance Z, resistance R, inductance L, and capacitance C mentioned above have the relation,

Z=R+jωL+1/(jωC), in terms of an angular frequency ω and an imaginary unit j.

Note that it is sufficient if these relations in terms of the ratios are satisfied by the mesh conductor 311 and the mesh conductor 312 as a whole, are satisfied by partial areas of the mesh conductor 311 and the mesh conductor 312, or are satisfied in certain areas.

Furthermore, a circuit that performs adjustments such that the current distributions become substantially even, substantially the same, or substantially similar distributions and have mutually reverse characteristics may be provided.

By satisfying the relations mentioned above, the current distribution in the mesh conductor 311 and the current distribution in the mesh conductor 312 can be made substantially even distributions and can be caused to have mutually reverse characteristics. Accordingly, the magnetic field generated by the current distribution in the mesh conductor 311 and the magnetic field generated by the current distribution in the mesh conductor 312 can be offset effectively.

C in FIG. 36 depicts a state of the conductor layers A and B depicted in A and B in FIG. 36, respectively, as seen from the side where photodiodes 141 are located (the backside). It should be noted however that hatched regions 313 in which diagonal lines cross in C in FIG. 36 represent regions where the mesh conductor 311 in the conductor layer A and the mesh conductor 312 in the conductor layer B overlap. Because an active element group 167 is covered with at least one of the conductor layer A or the conductor layer B in the case of the eleventh configuration example, hot carrier light emissions from the active element group 167 can be blocked.

In addition, in the case of the eleventh configuration example, the regions 313 where the mesh conductor 311 and the mesh conductor 312 overlap are continuous in the X direction. Because currents with mutually different polarities flow through the mesh conductor 311 and the mesh conductor 312 in the regions 313 where the mesh conductor 311 and the mesh conductor 312 overlap, magnetic fields generated from the regions 313 are cancelled out with each other. Therefore, the occurrence of inductive noise near the regions 313 can be suppressed.

In addition, in the case of the eleventh configuration example, the mesh conductor 311 is formed to have a different Y-direction gap width GYA and X-direction gap width GXA, and the mesh conductor 312 is formed to have a different Y-direction gap width GYB and X-direction gap width GXB.

By forming the mesh conductors 311 and 312 such that they have shapes with differences of the X-direction and Y-direction gap widths in this manner, it is possible to cope with constraints in terms of dimensions of wire regions, dimensions of gap regions, the occupancy of a wire region in each conductor layer, and the like, and to enhance the degrees of freedom of designing of the wiring layouts when conductor layers are actually designed and manufactured. In addition, as compared with a case in which gap widths are not made different, it is possible to design wires with layouts which are advantageous in terms of voltage drops (IR-Drop), inductive noise, and the like.

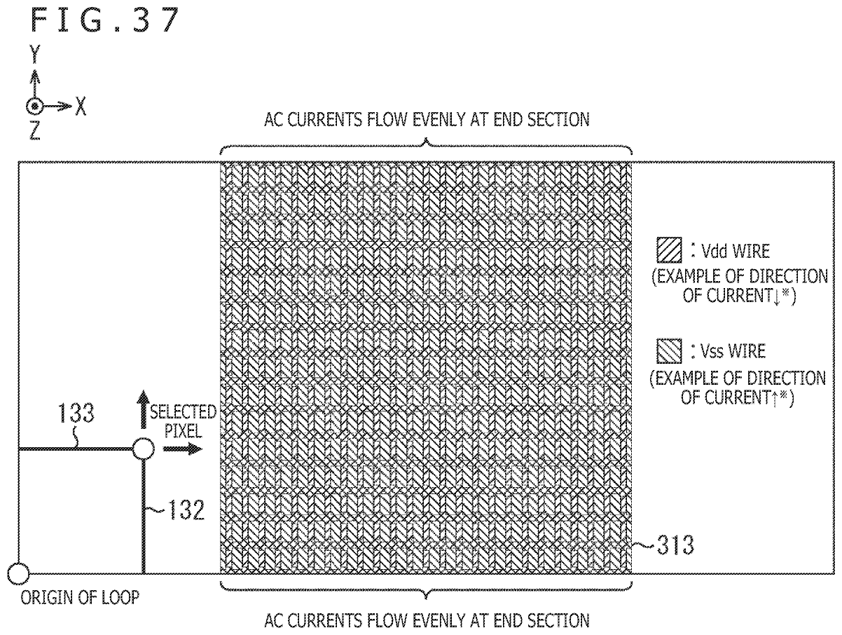

FIG. 37 is a figure depicting the condition of electric currents flowing in the eleventh configuration example (FIG. 36).

It is assumed that AC currents flow evenly at end sections of the mesh conductor 311 included in the conductor layer A and of the mesh conductor 312 included in the conductor layer B. It should be noted however that directions of electric currents change over time. For example, it is assumed that, when currents flow through the mesh conductor 312, which is a Vdd wire, from the upper side to the lower side in the figure, currents flow through the mesh conductor 311, which is a Vss wire, from the lower side to the upper side in the figure.

In a case in which currents flow as depicted in FIG. 37 in the eleventh configuration example, magnetic flux substantially in the X direction and substantially in the Y direction occurs more easily between the mesh conductor 311, which is a Vss wire, and the mesh conductor 312, which is a Vdd wire, due to conductor loops that include (cross-sections of) the mesh conductors 311 and 312 in cross-sections along which the mesh conductors 311 and 312 are arranged and have loop planes that are almost perpendicular to the X axis, and conductor loops that include (cross-sections of) the mesh conductors 311 and 312 in cross-sections along which the mesh conductors 311 and 312 are arranged and have loop planes that are almost perpendicular to the Y axis.

On the other hand, in the pixel array 121 of the first semiconductor board 101 stacked on the second semiconductor board 102 in which the light-blocking structure 151 including the conductor layers A and B is formed, a Victim conductor loop including a signal line 132 and a control line 133 is formed on the XY plane. An induced electromotive force is generated in the Victim conductor loop formed on the XY plane more easily due to magnetic flux in the Z direction. The larger a change of the induced electromotive force is, the worse an image output from the solid-state image pickup apparatus 100 is (the larger the inductive noise is).

Furthermore, if the effective dimensions of the Victim conductor loop including a signal line 132 and a control line 133 change as pixels at different positions are selected in the pixel array 121, changes of the induced electromotive force become noticeable.

In the case of the eleventh configuration example, the directions of magnetic flux (substantially in the X direction and substantially in the Y direction) generated from the loop planes of the Aggressor conductor loops of the light-blocking structure 151 including the conductor layers A and B and the direction of magnetic flux (in the Z direction) that generates an induced electromotive force to the Victim conductor loop are substantially orthogonal and different by approximately 90 degrees. In other words, the directions of the loop planes that generate magnetic flux from the Aggressor conductor loops and the direction of the loop plane that generates an induced electromotive force to the Victim conductor loop are different by approximately 90 degrees. Accordingly, it is expected that a worsening (the occurrence of inductive noise) of an image output from the solid-state image pickup apparatus 100 is mitigated as compared with the first comparative example.

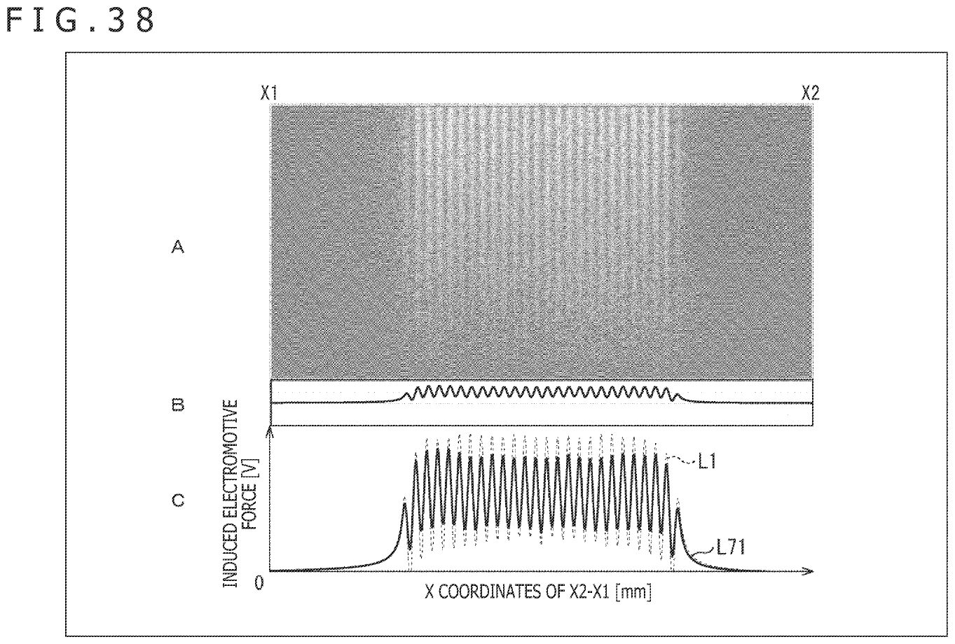

FIG. 38 depicts a result of a simulation of inductive noise that occurs in a case in which the eleventh configuration example (FIG. 36) is applied to the solid-state image pickup apparatus 100.

A in FIG. 38 depicts an image that is output from the solid-state image pickup apparatus 100 and can have inductive noise generated therein. B in FIG. 38 depicts changes of pixel signals along a line segment X1-X2 in the image depicted in A in FIG. 38. C in FIG. 38 depicts a solid line L71 representing an induced electromotive force that has generated the inductive noise in the image. The horizontal axis in C in FIG. 38 represents the X-axis coordinate of an image, and the vertical axis represents the magnitude of an induced electromotive force. Note that the dotted line L1 in C in FIG. 38 corresponds to the first comparative example (FIG. 9).

As is apparent from a comparison between the solid line L71 and the dotted line L1 depicted in C in FIG. 38, it can be known that the eleventh configuration example can suppress changes of the induced electromotive force generated to the Victim conductor loop and suppress inductive noise, as compared with the first comparative example.

Note that the eleventh configuration example may be used by being rotated by 90 degrees on the XY plane. In addition, the eleventh configuration example may be used by being rotated not only by 90 degrees, but by any angle. For example, the eleventh configuration example may be modified to be at an angle relative to the X axis and the Y axis.

### Twelfth Configuration Example

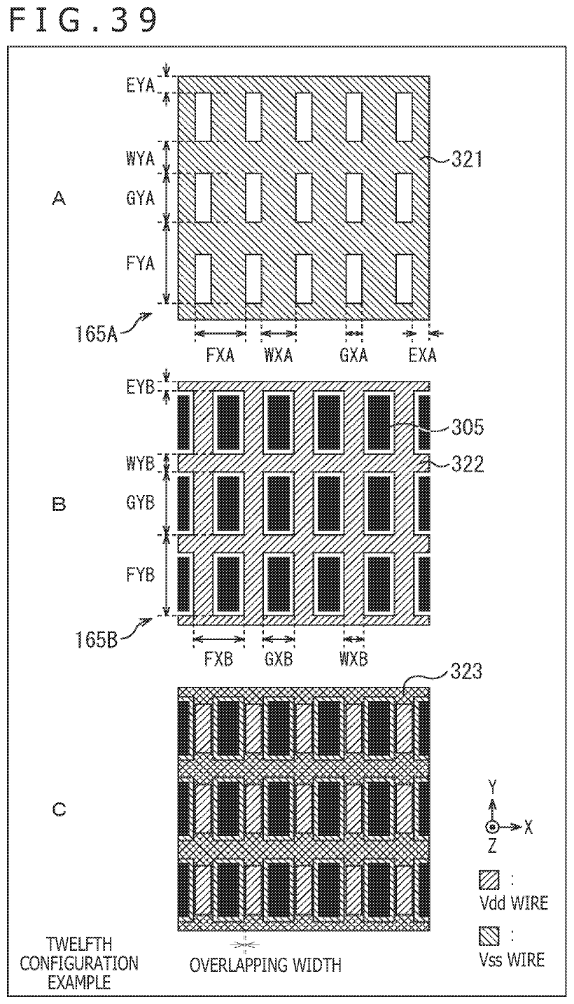

Next, FIG. 39 depicts a twelfth configuration example of the conductor layers A and B. Note that A in FIG. 39 depicts the conductor layer A, and B in FIG. 39 depicts the conductor layer B. In the coordinate system in FIG. 39, the X axis lies in the lateral direction, the Y axis lies in the longitudinal direction, and the Z axis lies in a direction perpendicular to the XY plane.

The conductor layer A in the twelfth configuration example includes a mesh conductor 321. The mesh conductor 321 has a shape similar to that of the mesh conductor 311 in the conductor layer A in the eleventh configuration example (FIG. 36), and so an explanation thereof is omitted. The mesh conductor 321 is a wire (Vss wire) connected to GND or a negative power supply, for example.

The conductor layer B in the twelfth configuration example includes a mesh conductor 322 and relay conductors 305. The mesh conductor 322 has a shape similar to that of the mesh conductor 312 in the conductor layer B in the eleventh configuration example (FIG. 36), and so an explanation thereof is omitted. The mesh conductor 322 is a wire (Vdd wire) connected to a positive power supply, for example.

The relay conductors (other conductors) 305 are arranged in non-conductor oblong rectangular gap regions in the mesh conductor 322 that are long in the Y direction. The relay conductors 305 are electrically insulated from the mesh conductor 322 and are connected to Vss connected with the mesh conductor 321 in the conductor layer A.

Note that the shapes of the relay conductors 305 can be any shapes and desirably are circular or polygonal shapes which have symmetry like rotational symmetry, mirror symmetry, or the like. The relay conductors 305 can be arranged at the middle positions or any other positions in gap regions of the mesh conductor 322. The relay conductors 305 may be connected to a conductor layer as a Vss wire other than the conductor layer A. The relay conductors 305 may be connected to a conductor layer as a Vss wire on a side closer to an active element group 167 than to the conductor layer B. The relay conductors 305 can be connected to a conductor layer other than the conductor layer A, or a conductor layer or the like on a side closer to an active element group 167 than to the conductor layer B, via conductor vias extending in the Z direction.

C in FIG. 39 depicts a state of the conductor layers A and B depicted in A and B in FIG. 39, respectively, as seen from the side where photodiodes 141 are located (the backside). It should be noted however that hatched regions 323 in which diagonal lines cross in C in FIG. 39 represent regions where the mesh conductor 321 in the conductor layer A and the mesh conductor 322 in the conductor layer B overlap. Because an active element group 167 is covered with at least one of the conductor layer A or the conductor layer B in the case of the twelfth configuration example, hot carrier light emissions from the active element group 167 can be blocked.

In a case in which currents flow similarly to the case depicted in FIG. 37 in the twelfth configuration example, magnetic flux substantially in the X direction and substantially in the Y direction occurs more easily between the mesh conductor 321, which is a Vss wire, and the mesh conductor 322, which is a Vdd wire, due to conductor loops that include (cross-sections of) the mesh conductors 321 and 322 in cross-sections along which the mesh conductors 321 and 322 are arranged and have loop planes that are almost perpendicular to the X axis, and conductor loops that include (cross-sections of) the mesh conductors 321 and 322 in cross-sections along which the mesh conductors 321 and 322 are arranged and have loop planes that are almost perpendicular to the Y axis.

Furthermore, in the case of the twelfth configuration example, the regions 323 where the mesh conductor 321 and the mesh conductor 322 overlap are continuous in the X direction. Because currents with mutually different polarities flow through the mesh conductor 321 and the mesh conductor 322 in the regions 323 where the mesh conductor 321 and the mesh conductor 322 overlap, magnetic fields generated from the regions 323 are cancelled out with each other. Therefore, the occurrence of inductive noise near the regions 323 can be suppressed.

In addition, in the case of the twelfth configuration example, providing the relay conductors 305 makes it possible to connect the mesh conductor 321, which is a Vss wire, with the active element group 167 with substantially the shortest distance or with a short distance. Connecting the mesh conductor 321 and the active element group 167 with substantially the shortest distance or with a short distance makes it possible to reduce voltage drops, energy loss, or inductive noise between the mesh conductor 321 and the active element group 167.

Note that the twelfth configuration example may be used by being rotated by 90 degrees on the XY plane. In addition, the twelfth configuration example may be used by being rotated not only by 90 degrees, but by any angle. For example, the twelfth configuration example may be modified to be at an angle relative to the X axis and the Y axis.

### Thirteenth Configuration Example

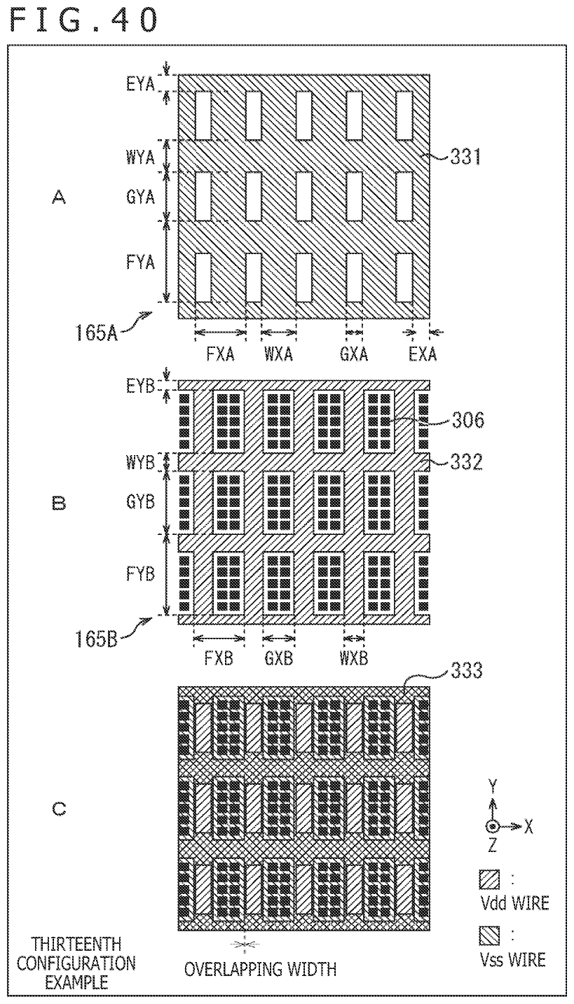

Next, FIG. 40 depicts a thirteenth configuration example of the conductor layers A and B. Note that A in FIG. 40 depicts the conductor layer A, and B in FIG. 40 depicts the conductor layer B. In the coordinate system in FIG. 40, the X axis lies in the lateral direction, the Y axis lies in the longitudinal direction, and the Z axis lies in a direction perpendicular to the XY plane.

The conductor layer A in the thirteenth configuration example includes a mesh conductor 331. The mesh conductor 331 has a shape similar to that of the mesh conductor 311 in the conductor layer A in the eleventh configuration example (FIG. 36), and so an explanation thereof is omitted. The mesh conductor 331 is a wire (Vss wire) connected to GND or a negative power supply, for example.

The conductor layer B in the thirteenth configuration example includes a mesh conductor 332 and relay conductors 306. The mesh conductor 332 has a shape similar to that of the mesh conductor 312 in the conductor layer B in the eleventh configuration example (FIG. 36), and so an explanation thereof is omitted. The mesh conductor 332 is a wire (Vdd wire) connected to a positive power supply, for example.

The relay conductors (other conductors) 306 are obtained by dividing each of the relay conductors 305 in the twelfth configuration example (FIG. 39) into multiple pieces (ten pieces in the case of FIG. 40) with intervals being provided therebetween. The relay conductors 306 are arranged in oblong rectangular gap regions that are in the mesh conductor 332 and are long in the Y direction. The relay conductors 306 are electrically insulated from the mesh conductor 332 and are connected to Vss connected with the mesh conductor 331 in the conductor layer A. The number of division of each relay conductor and whether or not the relay conductors are connected to Vss may differ between different regions. Because the current distribution can be adjusted finely at the time of designing in this case, this can lead to inductive noise suppression and a reduction of voltage drops (IR-Drop).

Note that the shapes of the relay conductors 306 can be any shapes and desirably are circular or polygonal shapes which have symmetry like rotational symmetry, mirror symmetry, or the like. The number of division of each relay conductor 306 can be modified as desired. The relay conductors 306 can be arranged at the middle positions or any other positions in gap regions of the mesh conductor 332. The relay conductors 306 may be connected to a conductor layer as a Vss wire other than the conductor layer A. The relay conductors 306 may be connected to a conductor layer as a Vss wire on a side closer to an active element group 167 than to the conductor layer B. The relay conductors 306 can be connected to a conductor layer other than the conductor layer A, or a conductor layer or the like on a side closer to an active element group 167 than to the conductor layer B, via conductor vias extending in the Z direction.

C in FIG. 40 depicts a state of the conductor layers A and B depicted in A and B in FIG. 40, respectively, as seen from the side where photodiodes 141 are located (the backside). It should be noted however that hatched regions 333 in which diagonal lines cross in C in FIG. 40 represent regions where the mesh conductor 331 in the conductor layer A and the mesh conductor 332 in the conductor layer B overlap. Because an active element group 167 is covered with at least one of the conductor layer A or the conductor layer B in the case of the thirteenth configuration example, hot carrier light emissions from the active element group 167 can be blocked.

In a case in which currents flow similarly to the case depicted in FIG. 37 in the thirteenth configuration example, magnetic flux substantially in the X direction and substantially in the Y direction occurs more easily between the mesh conductor 331, which is a Vss wire, and the mesh conductor 332, which is a Vdd wire, due to conductor loops that include (cross-sections of) the mesh conductors 331 and 332 in cross-sections along which the mesh conductors 331 and 332 are arranged and have loop planes that are almost perpendicular to the X axis, and conductor loops that include (cross-sections of) the mesh conductors 331 and 332 in cross-sections along which the mesh conductors 331 and 332 are arranged and have loop planes that are almost perpendicular to the Y axis.

Furthermore, in the case of the thirteenth configuration example, the regions 333 where the mesh conductor 331 and the mesh conductor 332 overlap are continuous in the X direction. Because currents with mutually different polarities flow through the mesh conductor 331 and the mesh conductor 332 in the regions 333, magnetic fields generated from the regions 333 are cancelled out with each other. Therefore, the occurrence of inductive noise near the regions 333 can be suppressed.

In addition, in the case of the thirteenth configuration example, providing the relay conductors 306 makes it possible to connect the mesh conductor 331, which is a Vss wire, with the active element group 167 with substantially the shortest distance or with a short distance. Connecting the mesh conductor 331 and the active element group 167 with substantially the shortest distance or with a short distance makes it possible to reduce voltage drops, energy loss, or inductive noise between the mesh conductor 331 and the active element group 167.

Furthermore, it is possible in the thirteenth configuration example to make the current distribution in the conductor layer A and the current distribution in the conductor layer B substantially uniform and have reverse polarities by dividing each relay conductor 306 into multiple pieces. Accordingly, it is possible to make a magnetic field generated from the conductor layer A and a magnetic field generated from the conductor layer B cancel each other. Accordingly, it is possible in the thirteenth configuration example to make it difficult for a difference to be generated between the current distributions in Vdd wires and Vss wires due to an external factor. Therefore, the sixteenth configuration example is suitable for a case in which current distributions on the XY plane are complicated, and a case in which the impedances of conductors connected to the mesh conductors 331 and 332 are different between the Vdd wires and the Vss wires.

Note that the thirteenth configuration example may be used by being rotated by 90 degrees on the XY plane. In addition, the thirteenth configuration example may be used by being rotated not only by 90 degrees, but by any angle. For example, the thirteenth configuration example may be modified to be at an angle relative to the X axis and the Y axis.

### Results of Simulations of Twelfth and Thirteenth Configuration Examples

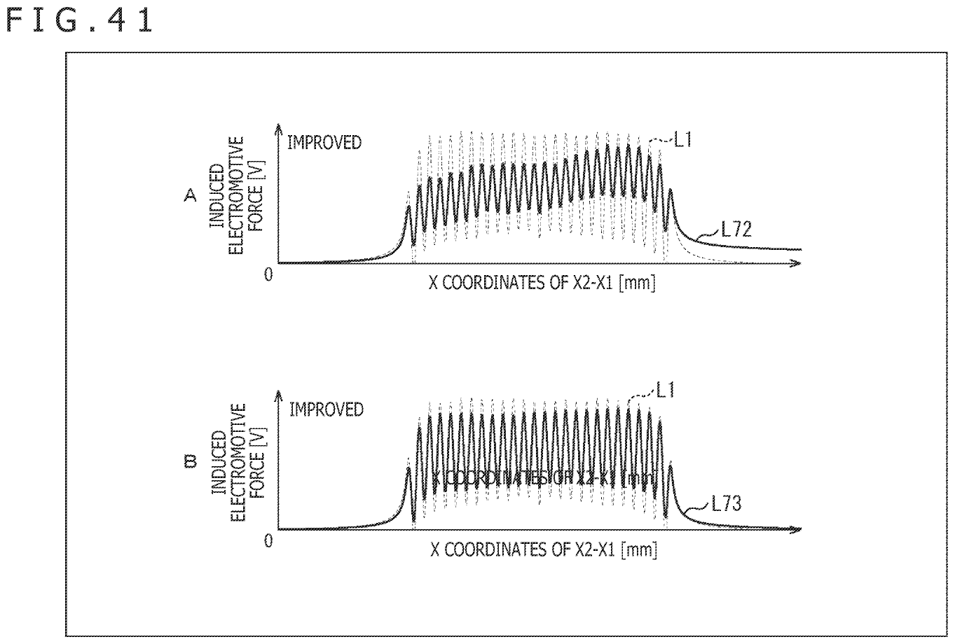

FIG. 41 depicts changes of induced electromotive forces that generate inductive noise in images, as results of simulations of the cases in which the twelfth configuration example (FIG. 39) and the thirteenth configuration example (FIG. 40) are applied to the solid-state image pickup apparatus 100. Note that it is assumed that conditions of electric currents flowing in the twelfth and thirteenth configuration examples are similar to those in the case depicted in FIG. 37. The horizontal axis in FIG. 41 represents the X-axis coordinate of images, and the vertical axis represents the magnitudes of the induced electromotive forces.

A solid line L72 in A in FIG. 41 corresponds to the twelfth configuration example (FIG. 39), and the dotted line L1 corresponds to the first comparative example (FIG. 9). As is apparent from a comparison between the solid line L72 and the dotted line L1, it can be known that the twelfth configuration example does not vary an induced electromotive force generated to the Victim conductor loop as compared with the first comparative example. Therefore, as compared with the first comparative example, the twelfth configuration example can suppress inductive noise in an image output from the solid-state image pickup apparatus 100. It should be noted however that the simulation result represents a result of a simulation of a case in which the mesh conductor 321 is not connected with an active element group 167 and the mesh conductor 322 is not connected with an active element group 167. For example, in a case in which the mesh conductor 321 and at least part of an active element group 167 are connected with each other with substantially the shortest distance or with a short distance via conductor vias or the like, or in a case in which the mesh conductor 322 and at least part of an active element group 167 are connected with each other with substantially the shortest distance or with a short distance via conductor vias or the like, the amount of currents flowing through the mesh conductor 321 or the mesh conductor 322 gradually decreases depending on positions. In such a case, there is also a condition under which voltage drops, energy loss, or inductive noise are/is ameliorated significantly to be half or smaller by providing the relay conductors 305.

A solid line L73 in B in FIG. 41 corresponds to the thirteenth configuration example (FIG. 40), and the dotted line L1 corresponds to the first comparative example (FIG. 9). As is apparent from a comparison between the solid line L73 and the dotted line L1, it can be known that the thirteenth configuration example does not vary an induced electromotive force generated to the Victim conductor loop as compared with the first comparative example. Therefore, as compared with the first comparative example, the thirteenth configuration example can suppress inductive noise in an image output from the solid-state image pickup apparatus 100. It should be noted however that the simulation result represents a result of a simulation of a case in which the mesh conductor 331 is not connected with an active element group 167 and the mesh conductor 332 is not connected with an active element group 167. For example, in a case in which the mesh conductor 331 and at least part of an active element group 167 are connected with each other with substantially the shortest distance or with a short distance via conductor vias or the like, or in a case in which the mesh conductor 332 and at least part of an active element group 167 are connected with each other with substantially the shortest distance or with a short distance via conductor vias or the like, the amount of currents flowing through the mesh conductor 331 or the mesh conductor 332 gradually decreases depending on positions. In such a case, there is also a condition under which voltage drops, energy loss, or inductive noise are/is ameliorated significantly to be half or smaller by providing the relay conductors 306.

### 5. Arrangement Examples of Electrodes in Semiconductor Board in which Conductor Layers A and B are Formed

Next, arrangements of electrodes in a semiconductor board in which conductors with different Y-direction and X-direction resistance values are formed as in the eleventh to thirteenth configuration examples of the conductor layers A and B mentioned above are explained.

Note that, in examples explained in the following explanation, the thirteenth configuration example (FIG. 40) including the conductor layers A and B including conductors (the mesh conductors 331 and 332) with Y-direction resistance values smaller than their X-direction resistance values is formed in a semiconductor board. It should be noted however that a similar explanation applies also to a case in which the eleventh and twelfth configuration examples of the conductor layers A and B including conductors with Y-direction resistance values smaller than their X-direction resistance values are formed on the semiconductor board.

In the thirteenth configuration example of the conductor layers A and B formed in the semiconductor board, the Y-direction resistance values of the conductors (mesh conductors 331 and 332) are smaller than their X-direction resistance values, and so currents flow more easily in the Y direction. Accordingly, in order to reduce voltage drops (IR-Drop) in the conductors in the thirteenth configuration example of the conductor layers A and B as much as possible, multiple pads (electrodes) to be arranged on the semiconductor board are desirably arranged more densely in the X direction, in which direction the conductors have larger resistance values, than in the Y direction, in which direction the conductors have smaller resistance values, but they may be arranged more densely in the Y direction than in the X direction.

### First Arrangement Example of Pads on Semiconductor Board

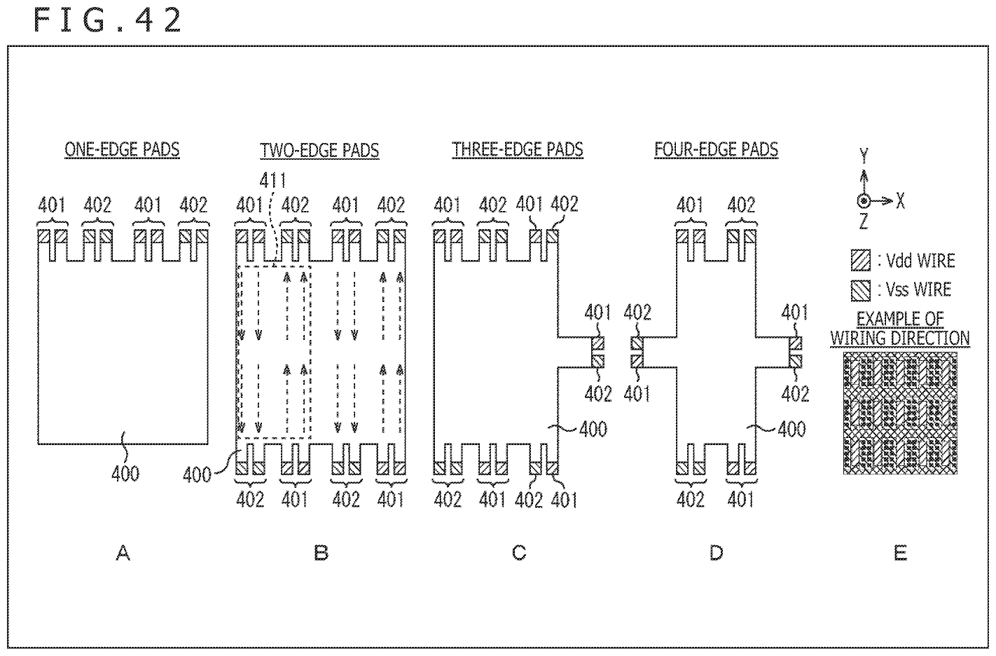

FIG. 42 is a plan view depicting a first arrangement example in which pads are arranged more densely in the X direction than in the Y direction on a semiconductor board. Note that, in the coordinate system in FIG. 42, the X axis lies in the lateral direction, the Y axis lies in the longitudinal direction, and the Z axis lies in a direction perpendicular to the XY plane.

A in FIG. 42 depicts a case in which pads are arranged along one edge of a wire region 400 in which the multiple thirteenth configuration examples (FIG. 40) including the conductor layers A and B are formed. B in FIG. 42 depicts a case in which pads are arranged along two edges that are opposite to each other in the Y direction of the wire region 400 in which the multiple thirteenth configuration examples (FIG. 40) including the conductor layers A and B are formed. Note that dotted arrows in the figure represent examples of the directions of currents flowing therethrough, and a current loop 411 due to the currents represented by the dotted arrows is generated. The directions of currents represented by the dotted arrows change from moment to moment.

C in FIG. 42 depicts a case in which pads are arranged along three edges of the wire region 400 in which the multiple thirteenth configuration examples (FIG. 40) including the conductor layers A and B are formed. D in FIG. 42 depicts a case in which pads are arranged along four edges of the wire region 400 in which the multiple thirteenth configuration examples (FIG. 40) including the conductor layers A and B are formed. E in FIG. 42 depicts the directions of the multiple thirteenth configuration examples of the conductor layers A and B formed in the wire region 400.

Pads 401 arranged in the wire region 400 are connected to a Vdd wire, and pads 402 are wires (Vss wires) connected to GND or a negative power supply, for example.

Each of the pads 401 and 402 in the case of the first arrangement example depicted in FIG. 42 includes one pad or multiple pads (two pads in the case of FIG. 42) arranged adjacent to each other. The pads 401 and 402 are arranged adjacent to each other. A pad 401 including one pad, and a pad 402 including one pad are arranged adjacent to each other, and a pad 401 including two pads and a pad 402 including two pads are arranged adjacent to each other. The polarities of the pads 401 and 402 (points to which the pads 401 and 402 are connected are one of and the other of a Vdd wire and a Vss wire) are reverse polarities. The number of pads 401 to be arranged in the wire region 400 and the number of the pads 402 to be arranged in the wire region 400 are substantially the same numbers.

Thereby, the distributions of currents to flow through the conductor layers A and B formed in the wire region 400 can be made substantially uniform and given reverse polarities, and so magnetic fields generated from the conductor layers A and B and induced electromotive forces based on the magnetic fields can be offset effectively.

In addition, in a case in which pads are formed along two or more edges of the wire region 400 as depicted in B, C, and D in FIG. 42, the polarities of pads that are arranged along opposite edges and are opposite to each other are set to reverse polarities. Thereby, as represented by the dotted arrows in B in FIG. 42, currents in the same direction are distributed more easily at positions in the wire region 400 with the same X coordinate and different Y coordinates.

### Second Arrangement Example of Pads on Semiconductor Board

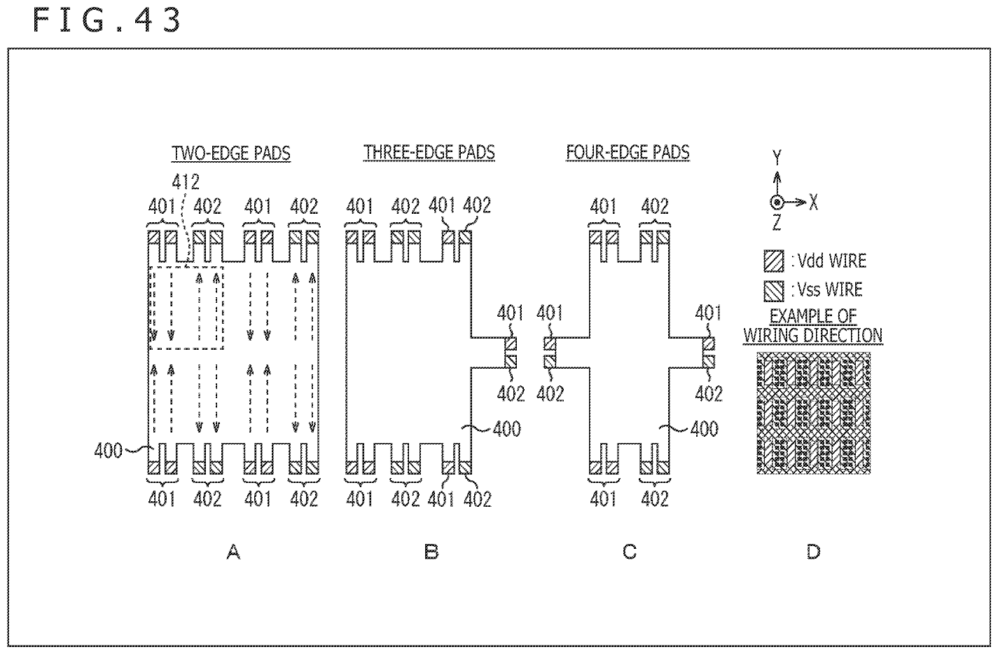

Next, FIG. 43 is a plan view depicting a second arrangement example in which pads are arranged more densely in the X direction than in the Y direction on a semiconductor board. Note that, in the coordinate system in FIG. 43, the X axis lies in the lateral direction, the Y axis lies in the longitudinal direction, and the Z axis lies in a direction perpendicular to the XY plane.

A in FIG. 43 depicts a case in which pads are arranged along two edges that are opposite to each other in the Y direction of the wire region 400 in which the multiple thirteenth configuration examples (FIG. 40) including the conductor layers A and B are formed. Note that dotted arrows in the figure represent the directions of currents flowing therethrough, and a current loop 412 due to the currents represented by the dotted arrows is generated. The directions of currents represented by the dotted arrows change from moment to moment.

B in FIG. 43 depicts a case in which pads are arranged along three edges of the wire region 400 in which the multiple thirteenth configuration examples (FIG. 40) including the conductor layers A and B are formed. C in FIG. 43 depicts a case in which pads are arranged along four edges of the wire region 400 in which the multiple thirteenth configuration examples (FIG. 40) including the conductor layers A and B are formed. D in FIG. 43 depicts the directions of the multiple thirteenth configuration examples of the conductor layers A and B formed in the wire region 400.

Pads 401 arranged in the wire region 400 are connected to a Vdd wire, and pads 402 are wires (Vss wires) connected to GND or a negative power supply, for example.

The pads 401 and 402 in the case of the second arrangement example depicted in FIG. 43 include multiple pads (two pads in the case of FIG. 43) arranged adjacent to each other. The pads 401 and 402 are arranged adjacent to each other. A pad 401 including one pad and a pad 402 including one pad are arranged adjacent to each other, and a pad 401 including two pads and a pad 402 including two pads are arranged adjacent to each other. The polarities of the pads 401 and 402 (points to which the pads 401 and 402 are connected are one of and the other of a Vdd wire and a Vss wire) are reverse polarities. The number of pads 401 to be arranged in the wire region 400 and the number of the pads 402 to be arranged in the wire region 400 are substantially the same numbers.

Thereby, the distributions of currents to flow through the conductor layers A and B formed in the wire region 400 can be made substantially uniform and given reverse polarities, and so magnetic fields generated from the conductor layers A and B and induced electromotive forces based on the magnetic fields can be offset effectively.

Furthermore, the polarities of pads that are arranged along opposite edges and are opposite to each other are the same polarities in the second arrangement example. It should be noted however that the polarities of some of pads that are arranged along opposite edges and are opposite to each other may be reverse polarities. Thereby, the current loop 412 which is smaller than the current loop 411 depicted in B in FIG. 42 is generated in the wire region 400. The size of a current loop influences the distribution range of a magnetic field. The smaller the electrical field loop is, the narrower the distribution range of the magnetic field is. Accordingly, the distribution range of the magnetic field is narrower in the second arrangement example as compared with the first arrangement example. Therefore, as compared with the first arrangement example, the second arrangement example can reduce induced electromotive forces to be generated and inductive noise based on the induced electromotive forces.

### Third Arrangement Example of Pads on Semiconductor Board

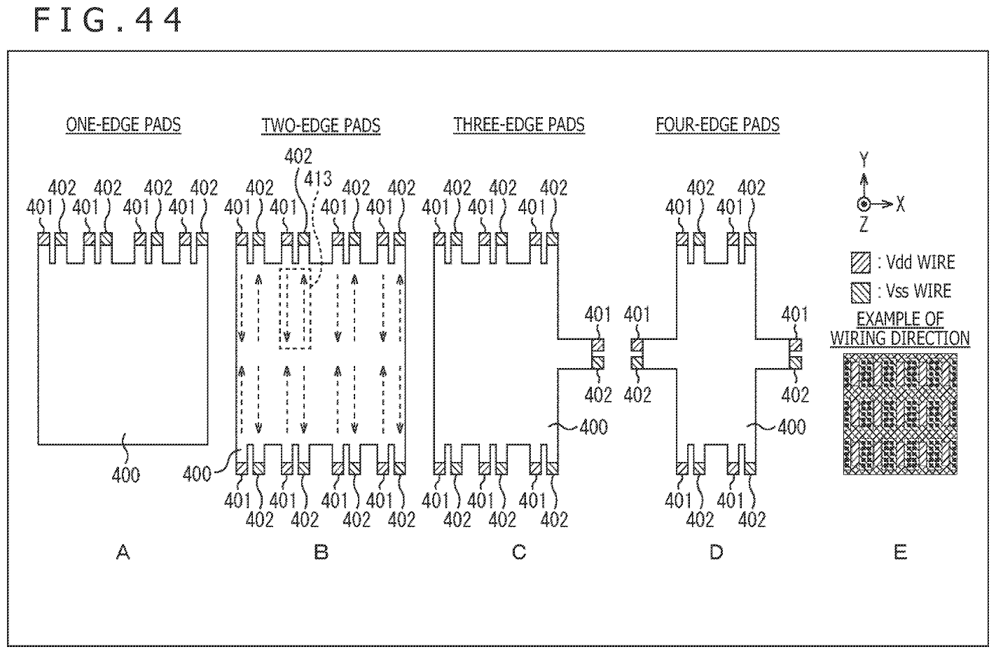

Next, FIG. 44 is a plan view depicting a third arrangement example in which pads are arranged more densely in the X direction than in the Y direction on a semiconductor board. Note that, in the coordinate system in FIG. 44, the X axis lies in the lateral direction, the Y axis lies in the longitudinal direction, and the Z axis lies in a direction perpendicular to the XY plane.

A in FIG. 44 depicts a case in which pads are arranged along one edge of the wire region 400 in which the multiple thirteenth configuration examples (FIG. 40) including the conductor layers A and B are formed. B in FIG. 44 depicts a case in which pads are arranged along two edges that are opposite to each other in the Y direction of the wire region 400 in which the multiple thirteenth configuration examples (FIG. 40) including the conductor layers A and B are formed. Note that dotted arrows in the figure represent the directions of currents flowing therethrough, and a current loop 413 due to the currents represented by the dotted arrows is generated.

C in FIG. 44 depicts a case in which pads are arranged along three edges of the wire region 400 in which the multiple thirteenth configuration examples (FIG. 40) including the conductor layers A and B are formed. D in FIG. 44 depicts a case in which pads are arranged along four edges of the wire region 400 in which the multiple thirteenth configuration examples (FIG. 40) including the conductor layers A and B are formed. E in FIG. 44 depicts the directions of the multiple thirteenth configuration examples of the conductor layers A and B formed in the wire region 400.

Pads 401 arranged in the wire region 400 are connected to a Vdd wire, and pads 402 are wires (Vss wires) connected to GND or a negative power supply, for example.

In the case of the third arrangement example depicted in FIG. 44, the polarities of pads (points to which the pads are connected are one of and the other of a Vdd wire and a Vss wire) forming a pad group including multiple pads (two pads in the case of FIG. 44) arranged adjacent to each other are reverse polarities. The number of pads 401 to be arranged along one edge or all the edges of the wire region 400 and the number of the pads 402 to be arranged along one edge or all the edges of the wire region 400 are substantially the same numbers.

Furthermore, the polarities of pads that are arranged along opposite edges and are opposite to each other are the same polarities in the third arrangement example. It should be noted however that the polarities of some of pads that are arranged along opposite edges and are opposite to each other may be reverse polarities.

Thereby, the current loop 413 which is smaller than the current loop 412 depicted in A in FIG. 43 is generated in the wire region 400. Accordingly, the distribution range of the magnetic field is narrower in the third arrangement example as compared with the second arrangement example. Therefore, as compared with the second arrangement example, the third arrangement example can reduce induced electromotive forces to be generated and inductive noise based on the induced electromotive forces.

### Examples of Conductors with Different Y-Direction Resistance Values and X-Direction Resistance Values

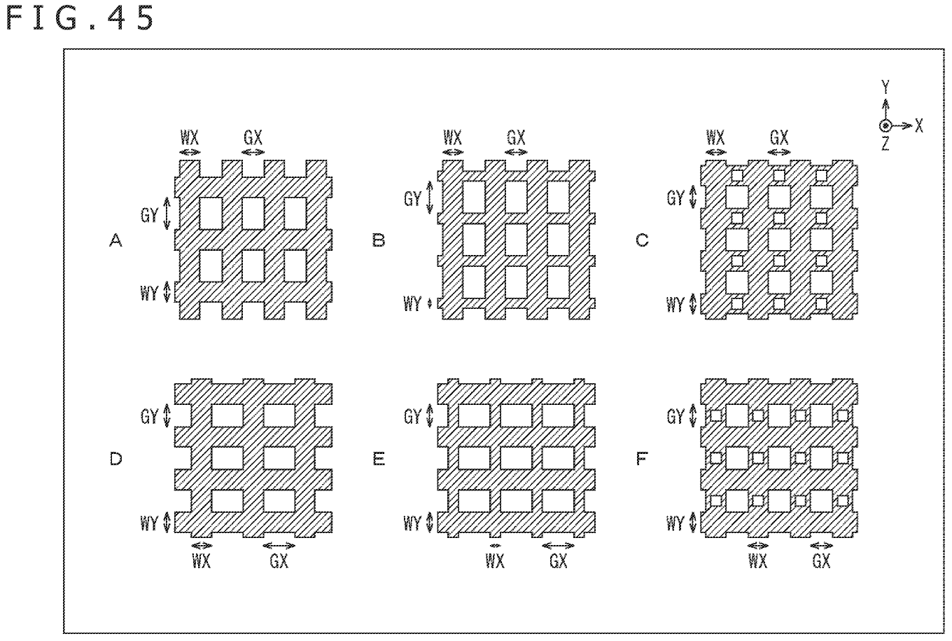

FIG. 45 is a plan view depicting other examples of conductors included in the conductor layers A and B. That is, FIG. 45 is a plan view depicting examples of conductors having a Y-direction resistance value and an X-direction resistance value that are different from each other. Note that A to C in FIG. 45 depict examples in which Y-direction resistance values are smaller than X-direction resistance values, and D to F in FIG. 45 depict examples in which X-direction resistance values are smaller than Y-direction resistance values.

A in FIG. 45 depicts a mesh conductor having an X-direction conductor width WX and a Y-direction conductor width WY which are equal to each other, and an X-direction gap width GX which is narrower than a Y-direction gap width GY. B in FIG. 45 depicts a mesh conductor having the X-direction conductor width WX wider than the Y-direction conductor width WY, and the X-direction gap width GX which is narrower than the Y-direction gap width GY. C in FIG. 45 depicts a mesh conductor having the X-direction conductor width WX and the Y-direction conductor width WY which are equal to each other, and the X-direction gap width GX and the Y-direction gap width GY which are equal to each other. The mesh conductor is provided with holes in regions which are in sections having the conductor width WY and longer in the X direction and do not cross sections having the conductor width WX and longer in the Y direction.

D in FIG. 45 depicts a mesh conductor having the X-direction conductor width WX and the Y-direction conductor width WY which are equal to each other, and the X-direction gap width GX which is wider than the Y-direction gap width GY. E in FIG. 45 depicts a mesh conductor having the X-direction conductor width WX narrower than the Y-direction conductor width WY, and the X-direction gap width GX which is wider than the Y-direction gap width GY. F in FIG. 45 depicts a mesh conductor having the X-direction conductor width WX and the Y-direction conductor width WY which are equal to each other, and the X-direction gap width GX and the Y-direction gap width GY which are equal to each other. The mesh conductor is provided with holes in regions which are in sections having the conductor width WX and longer in the Y direction and do not cross sections having the conductor width WY and longer in the X direction.

In a case in which conductors like the ones depicted in A to C in FIG. 45 whose Y-direction resistance values are smaller than their X-direction resistance values, and in which currents flow more easily in the Y direction are formed in the wire region 400, the first to third arrangement examples of pads in the wire region 400 depicted in FIG. 42 to FIG. 44 provide an effect of suppressing voltage drops (IR-Drop) in the conductors.

In addition, in a case in which conductors like the ones depicted in D to F in FIG. 45 whose X-direction resistance values are smaller than their Y-direction resistance values, and in which currents flow more easily in the X direction are formed in the wire region 400, it can be expected that the first to third arrangement examples of pads in the wire region 400 depicted in FIG. 42 to FIG. 44 provide an effect of being able to suppress the occurrence of inductive noise because the currents are diffused more easily in the X direction and it becomes difficult for magnetic fields near pads arranged along edges of the wire region 400 to be concentrated.

### 6. Modification Examples of Configuration Examples of Conductor Layers A and B

Next, modification examples of several configuration examples in the first to thirteenth configuration examples of the conductor layers A and B mentioned above are explained.

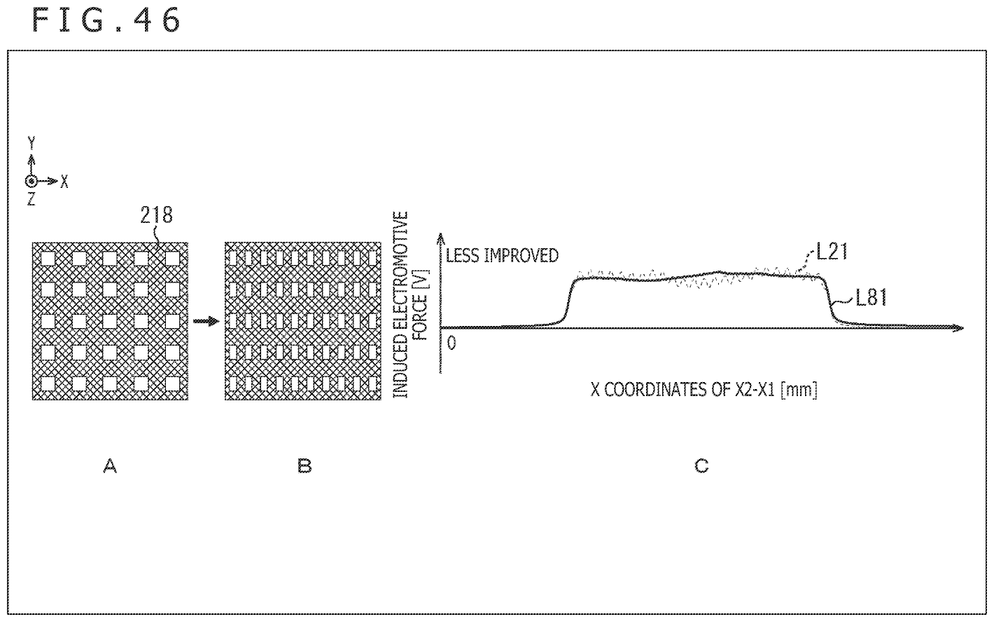

FIG. 46 is a figure depicting a modification example in which the X-direction conductor pitches in the second configuration example (FIG. 15) of the conductor layers A and B are halved, and depicting an effect attained thereby. Note that A in FIG. 46 depicts the second configuration example of the conductor layers A and B, and B in FIG. 46 depicts the modification example of the second configuration example of the conductor layers A and B.

C in FIG. 46 depicts changes of an induced electromotive force that generates inductive noise in an image, as a result of a simulation of the case in which the modification example depicted in B in FIG. 46 is applied to the solid-state image pickup apparatus 100. Note that it is assumed that the condition of electric currents flowing in this modification example is similar to that in the case depicted in FIG. 13. The horizontal axis in FIG. 46 represents the X-axis coordinate of an image, and the vertical axis represents the magnitude of an induced electromotive force.

A solid line L81 in C in FIG. 46 corresponds to the modification example depicted in B in FIG. 46, and a dotted line L21 corresponds to the second configuration example (FIG. 15). As is apparent from a comparison between the solid line L81 and the dotted line L21, this modification example generates slightly smaller changes of an induced electromotive force generated to the Victim conductor loop as compared with the second configuration example. Therefore, it can be known that this modification example can suppress inductive noise slightly more as compared with the second configuration example.

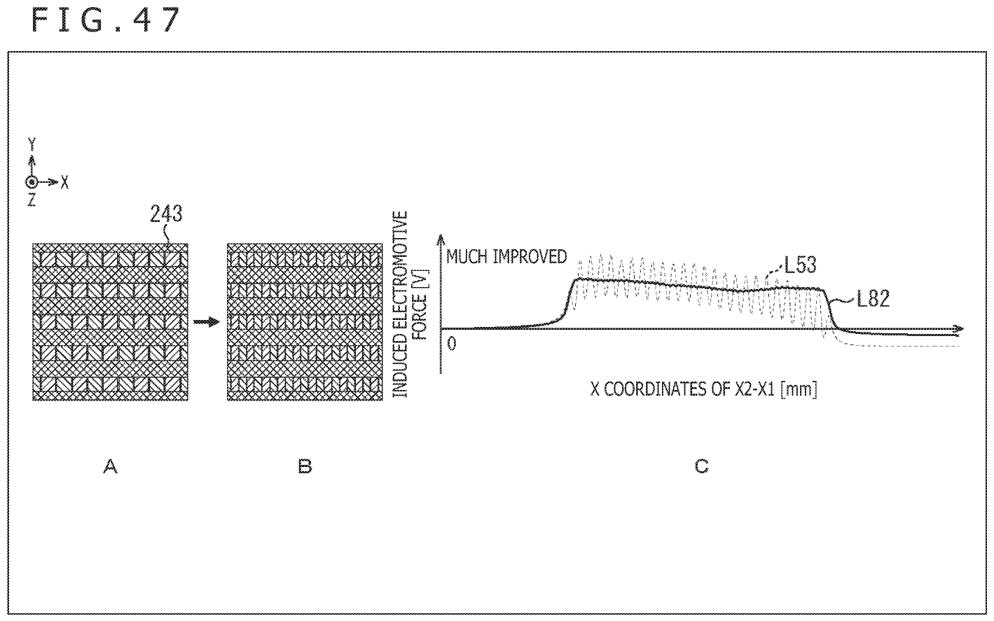

FIG. 47 is a figure depicting a modification example in which the X-direction conductor pitches in the fifth configuration example (FIG. 26) of the conductor layers A and B are halved, and depicting an effect attained thereby. Note that A in FIG. 47 depicts the fifth configuration example of the conductor layers A and B, and B in FIG. 47 depicts the modification example of the fifth configuration example of the conductor layers A and B.

C in FIG. 47 depicts changes of an induced electromotive force that generates inductive noise in an image, as a result of a simulation of the case in which the modification example depicted in B in FIG. 47 is applied to the solid-state image pickup apparatus 100. Note that it is assumed that the condition of electric currents flowing in this modification example is similar to that in the case depicted in FIG. 23. The horizontal axis in FIG. 47 represents the X-axis coordinate of an image, and the vertical axis represents the magnitude of an induced electromotive force.

A solid line L82 in C in FIG. 47 corresponds to the modification example depicted in B in FIG. 47, and the dotted line L53 corresponds to the fifth configuration example (FIG. 26). As is apparent from a comparison between the solid line L82 and the dotted line L53, this modification example generates much smaller changes of an induced electromotive force generated to the Victim conductor loop as compared with the fifth configuration example. Therefore, it can be known that this modification example can further suppress inductive noise as compared with the fifth configuration example.

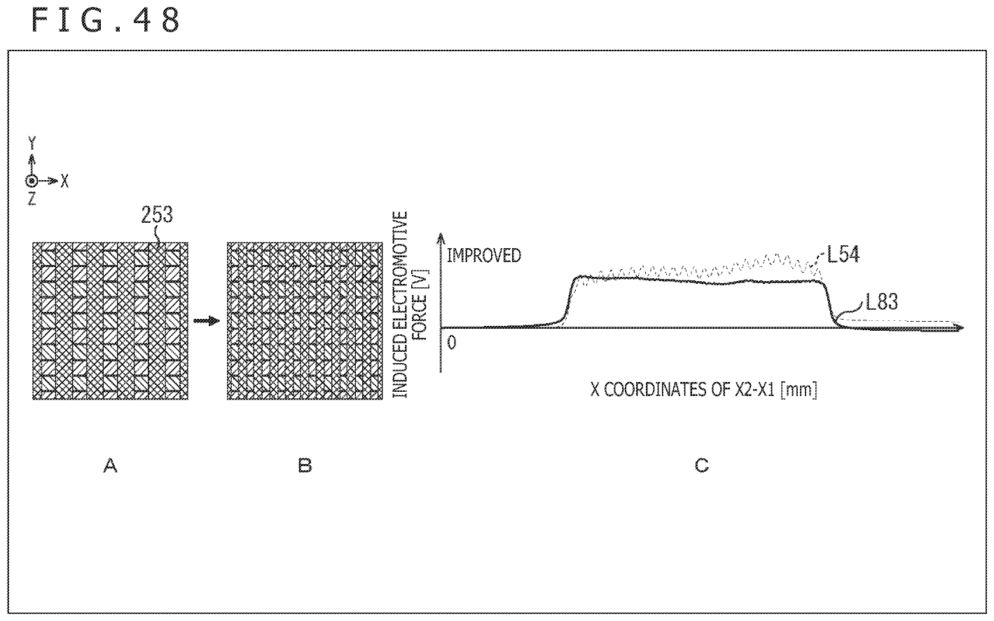

FIG. 48 is a figure depicting a modification example in which the X-direction conductor pitches in the sixth configuration example (FIG. 27) of the conductor layers A and B are halved, and depicting an effect attained thereby. Note that A in FIG. 48 depicts the sixth configuration example of the conductor layers A and B, and B in FIG. 48 depicts the modification example of the sixth configuration example of the conductor layers A and B.

C in FIG. 48 depicts changes of an induced electromotive force that generates inductive noise in an image, as a result of a simulation of the case in which the modification example depicted in B in FIG. 48 is applied to the solid-state image pickup apparatus 100. Note that it is assumed that the condition of electric currents flowing in this modification example is similar to that in the case depicted in FIG. 23. The horizontal axis in FIG. 48 represents the X-axis coordinate of an image, and the vertical axis represents the magnitude of an induced electromotive force.

A solid line L83 in C in FIG. 48 corresponds to the modification example depicted in B in FIG. 48, and the dotted line L54 corresponds to the sixth configuration example (FIG. 27). As is apparent from a comparison between the solid line L83 and the dotted line L54, this modification example generates smaller changes of an induced electromotive force generated to the Victim conductor loop as compared with the sixth configuration example. Therefore, it can be known that this modification example can suppress inductive noise more as compared with the sixth configuration example.

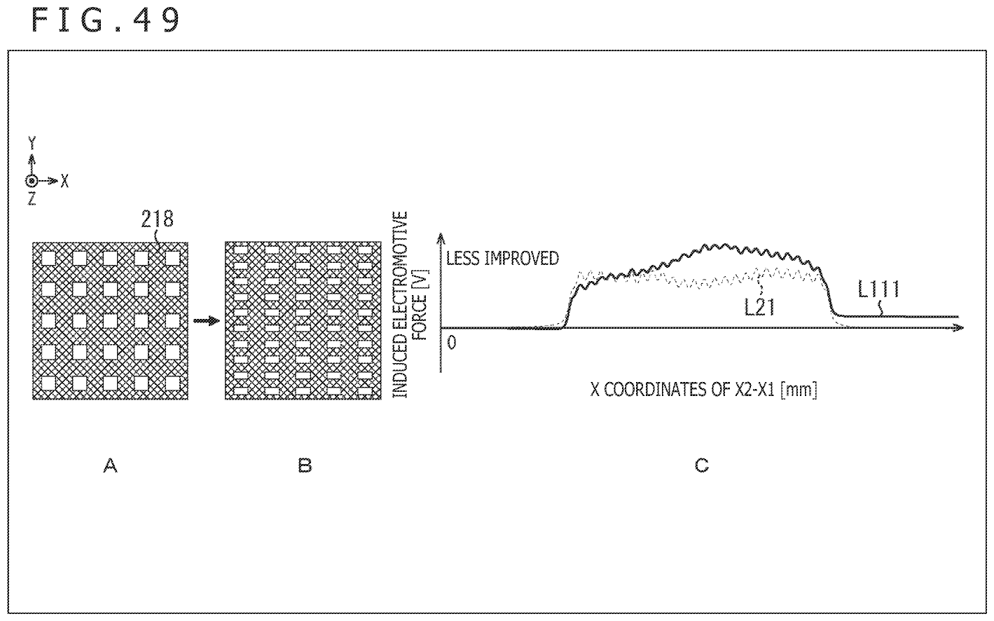

FIG. 49 is a figure depicting a modification example in which the Y-direction conductor pitches in the second configuration example (FIG. 15) of the conductor layers A and B are halved, and depicting an effect attained thereby. Note that A in FIG. 49 depicts the second configuration example of the conductor layers A and B, and B in FIG. 49 depicts the modification example of the second configuration example of the conductor layers A and B.

C in FIG. 49 depicts changes of an induced electromotive force that generates inductive noise in an image, as a result of a simulation of the case in which the modification example depicted in B in FIG. 49 is applied to the solid-state image pickup apparatus 100. Note that it is assumed that the condition of electric currents flowing in this modification example is similar to that in the case depicted in FIG. 13. The horizontal axis in FIG. 49 represents the X-axis coordinate of an image, and the vertical axis represents the magnitude of an induced electromotive force.

A solid line L111 in C in FIG. 49 corresponds to the modification example depicted in B in FIG. 49, and the dotted line L21 corresponds to the second configuration example. As is apparent from a comparison between the solid line L111 and the dotted line L21, this modification example generates slightly smaller changes of an induced electromotive force generated to the Victim conductor loop as compared with the second configuration example. Therefore, it can be known that this modification example can suppress inductive noise slightly more as compared with the second configuration example.

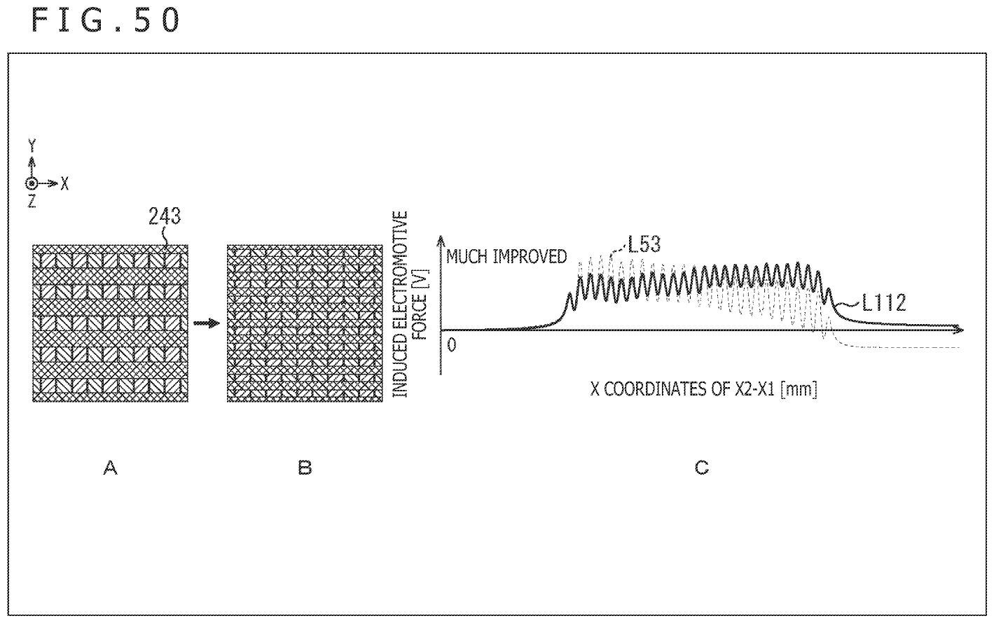

FIG. 50 is a figure depicting a modification example in which the Y-direction conductor pitches in the fifth configuration example (FIG. 26) of the conductor layers A and B are halved, and depicting an effect attained thereby. Note that A in FIG. 50 depicts the fifth configuration example of the conductor layers A and B, and B in FIG. 50 depicts the modification example of the fifth configuration example of the conductor layers A and B.

C in FIG. 50 depicts changes of an induced electromotive force that generates inductive noise in an image, as a result of a simulation of the case in which the modification example depicted in B in FIG. 50 is applied to the solid-state image pickup apparatus 100. Note that it is assumed that the condition of electric currents flowing in this modification example is similar to that in the case depicted in FIG. 23. The horizontal axis in FIG. 50 represents the X-axis coordinate of an image, and the vertical axis represents the magnitude of an induced electromotive force.

A solid line L112 in C in FIG. 50 corresponds to the modification example depicted in B in FIG. 50, and the dotted line L53 corresponds to the fifth configuration example. As is apparent from a comparison between the solid line L112 and the dotted line L53, this modification example generates much smaller changes of an induced electromotive force generated to the Victim conductor loop as compared with the fifth configuration example. Therefore, it can be known that this modification example can further suppress inductive noise as compared with the fifth configuration example.

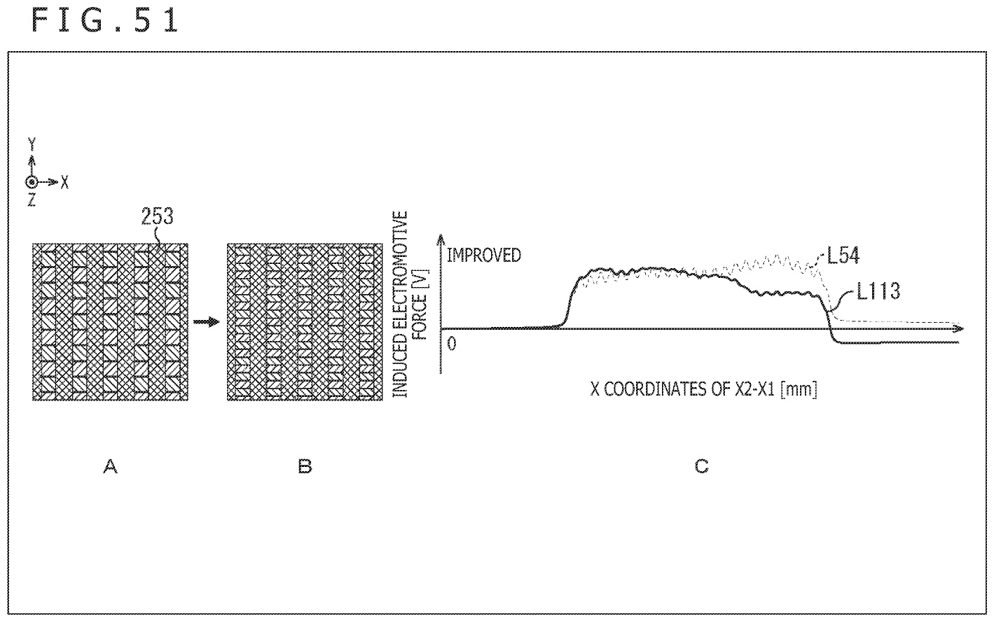

FIG. 51 is a figure depicting a modification example in which the Y-direction conductor pitches in the sixth configuration example (FIG. 27) of the conductor layers A and B are halved, and depicting an effect attained thereby. Note that A in FIG. 51 depicts the sixth configuration example of the conductor layers A and B, and B in FIG. 51 depicts the modification example of the sixth configuration example of the conductor layers A and B.

C in FIG. 51 depicts changes of an induced electromotive force that generates inductive noise in an image, as a result of a simulation of the case in which the modification example depicted in B in FIG. 51 is applied to the solid-state image pickup apparatus 100. Note that it is assumed that the condition of electric currents flowing in this modification example is similar to that in the case depicted in FIG. 23. The horizontal axis in FIG. 51 represents the X-axis coordinate of an image, and the vertical axis represents the magnitude of an induced electromotive force.

A solid line L113 in C in FIG. 51 corresponds to the modification example depicted in B in FIG. 51, and the dotted line L54 corresponds to the sixth configuration example. As is apparent from a comparison between the solid line L113 and the dotted line L54, this modification example generates smaller changes of an induced electromotive force generated to the Victim conductor loop as compared with the sixth configuration example. Therefore, it can be known that this modification example can suppress inductive noise more as compared with the sixth configuration example.

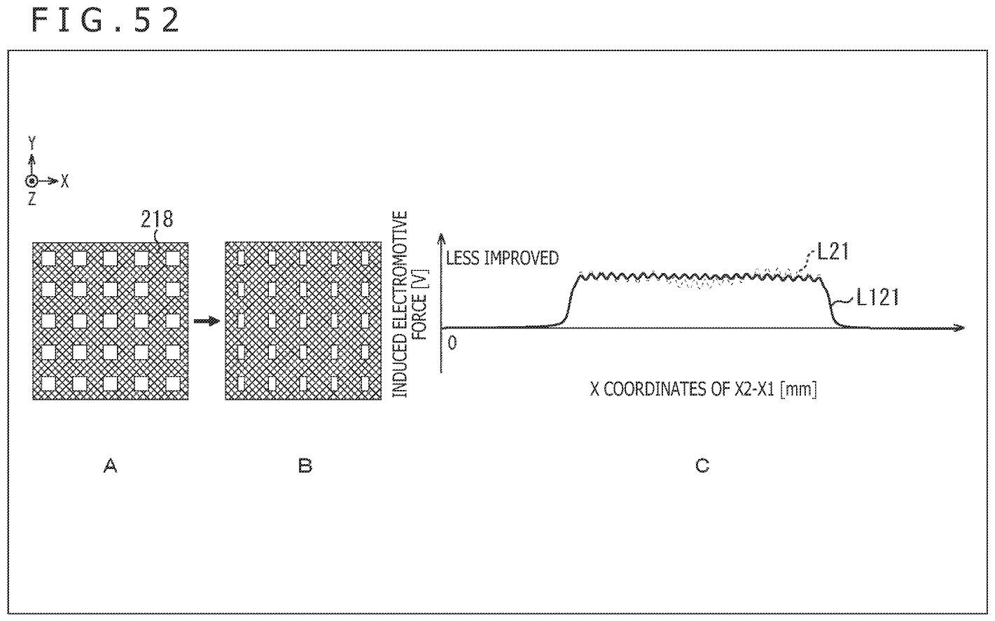

FIG. 52 is a figure depicting a modification example in which the X-direction conductor widths in the second configuration example (FIG. 15) of the conductor layers A and B are doubled, and depicting an effect attained thereby. Note that A in FIG. 52 depicts the second configuration example of the conductor layers A and B, and B in FIG. 52 depicts the modification example of the second configuration example of the conductor layers A and B.

C in FIG. 52 depicts changes of an induced electromotive force that generates inductive noise in an image, as a result of a simulation of the case in which the modification example depicted in B in FIG. 52 is applied to the solid-state image pickup apparatus 100. Note that it is assumed that the condition of electric currents flowing in this modification example is similar to that in the case depicted in FIG. 13. The horizontal axis in FIG. 52 represents the X-axis coordinate of an image, and the vertical axis represents the magnitude of an induced electromotive force.

A solid line L121 in C in FIG. 52 corresponds to the modification example depicted in B in FIG. 52, and the dotted line L21 corresponds to the second configuration example. As is apparent from a comparison between the solid line L121 and the dotted line L21, this modification example generates slightly smaller changes of an induced electromotive force generated to the Victim conductor loop as compared with the second configuration example. Therefore, it can be known that this modification example can suppress inductive noise slightly more as compared with the second configuration example.

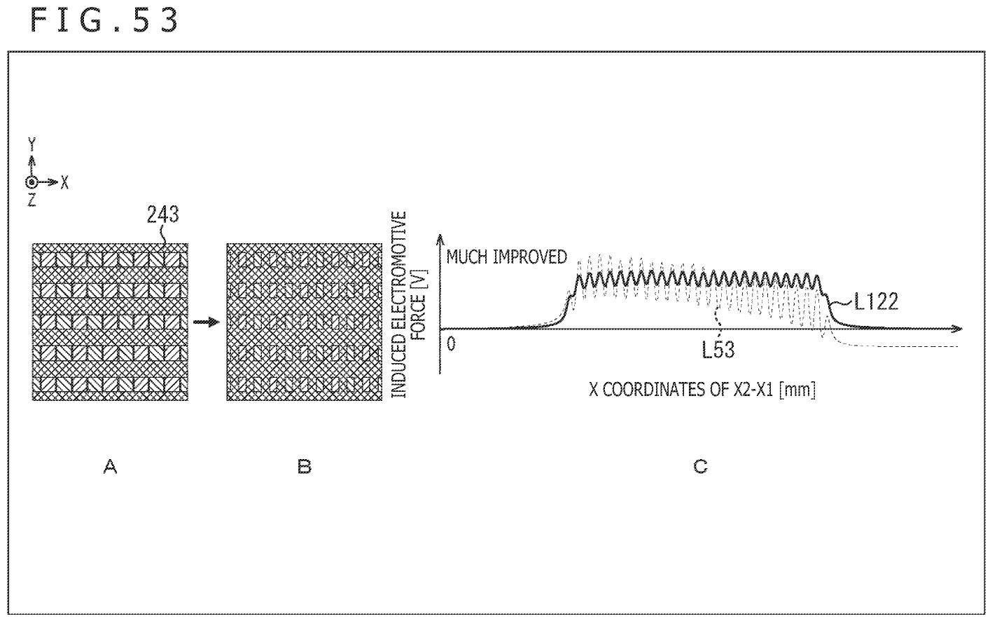

FIG. 53 is a figure depicting a modification example in which the X-direction conductor widths in the fifth configuration example (FIG. 26) of the conductor layers A and B are doubled, and depicting an effect attained thereby. Note that A in FIG. 53 depicts the fifth configuration example of the conductor layers A and B, and B in FIG. 53 depicts the modification example of the fifth configuration example of the conductor layers A and B.

C in FIG. 53 depicts changes of an induced electromotive force that generates inductive noise in an image, as a result of a simulation of the case in which the modification example depicted in B in FIG. 53 is applied to the solid-state image pickup apparatus 100. Note that it is assumed that the condition of electric currents flowing in this modification example is similar to that in the case depicted in FIG. 23. The horizontal axis in FIG. 53 represents the X-axis coordinate of an image, and the vertical axis represents the magnitude of an induced electromotive force.

A solid line L122 in C in FIG. 53 corresponds to the modification example depicted in B in FIG. 53, and the dotted line L53 corresponds to the fifth configuration example. As is apparent from a comparison between the solid line L122 and the dotted line L53, this modification example generates much smaller changes of an induced electromotive force generated to the Victim conductor loop as compared with the fifth configuration example. Therefore, it can be known that this modification example can further suppress inductive noise as compared with the fifth configuration example.

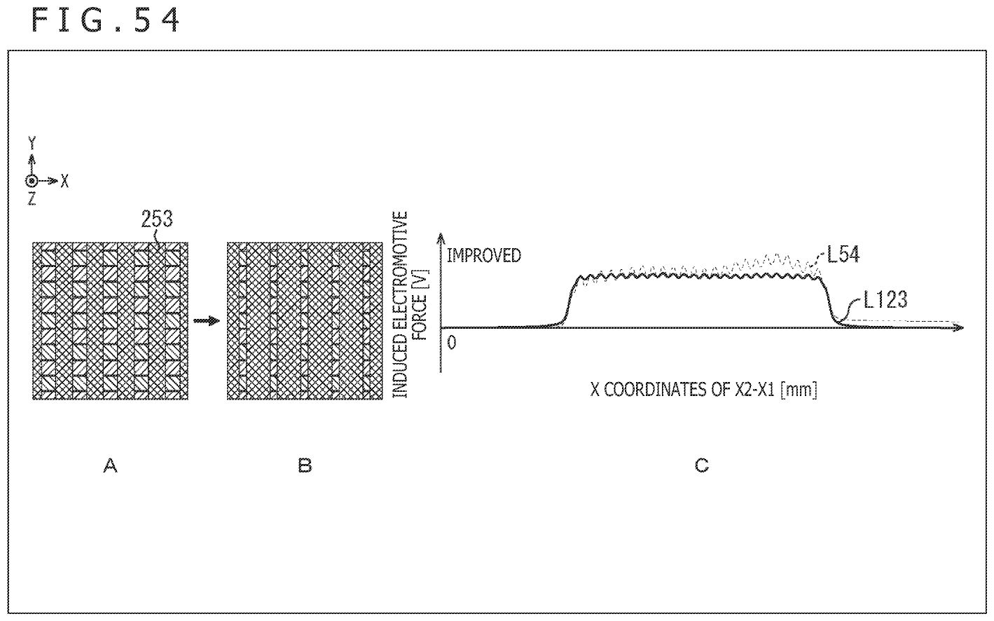

FIG. 54 is a figure depicting a modification example in which the X-direction conductor widths in the sixth configuration example (FIG. 27) of the conductor layers A and B are doubled, and depicting an effect attained thereby. Note that A in FIG. 54 depicts the sixth configuration example of the conductor layers A and B, and B in FIG. 54 depicts the modification example of the sixth configuration example of the conductor layers A and B.

C in FIG. 54 depicts changes of an induced electromotive force that generates inductive noise in an image, as a result of a simulation of the case in which the modification example depicted in B in FIG. 54 is applied to the solid-state image pickup apparatus 100. Note that it is assumed that the condition of electric currents flowing in this modification example is similar to that in the case depicted in FIG. 23. The horizontal axis in FIG. 54 represents the X-axis coordinate of an image, and the vertical axis represents the magnitude of an induced electromotive force.

A solid line L123 in C in FIG. 54 corresponds to the modification example depicted in B in FIG. 54, and the dotted line L54 corresponds to the sixth configuration example. As is apparent from a comparison between the solid line L123 and the dotted line L54, this modification example generates smaller changes of an induced electromotive force generated to the Victim conductor loop as compared with the sixth configuration example. Therefore, it can be known that this modification example can suppress inductive noise more as compared with the sixth configuration example.

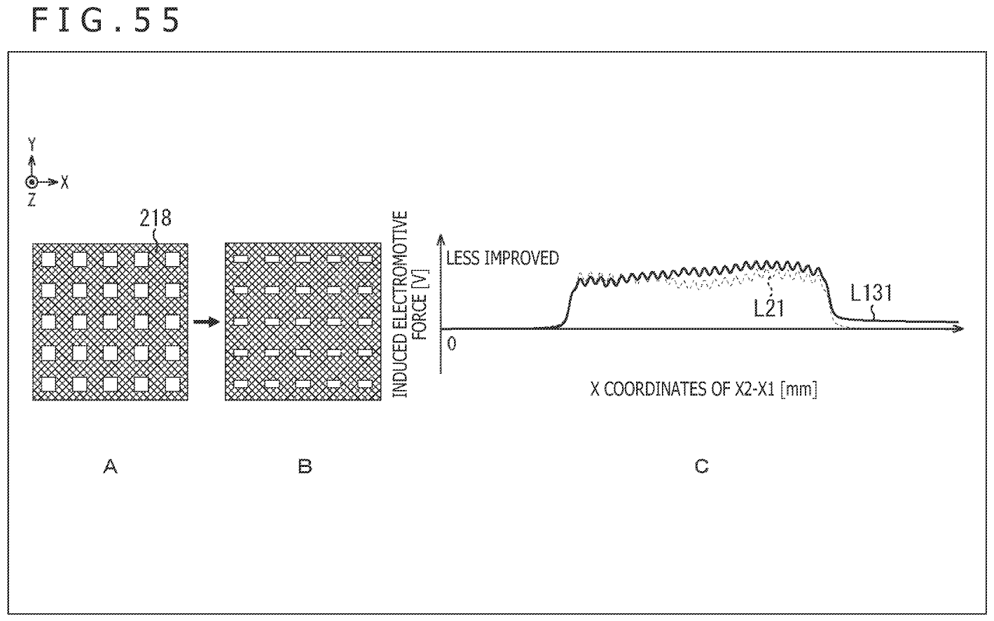

FIG. 55 is a figure depicting a modification example in which the Y-direction conductor widths in the second configuration example (FIG. 15) of the conductor layers A and B are doubled, and depicting an effect attained thereby. Note that A in FIG. 55 depicts the second configuration example of the conductor layers A and B, and B in FIG. 55 depicts the modification example of the second configuration example of the conductor layers A and B.

C in FIG. 55 depicts changes of an induced electromotive force that generates inductive noise in an image, as a result of a simulation of the case in which the modification example depicted in B in FIG. 55 is applied to the solid-state image pickup apparatus 100. Note that it is assumed that the condition of electric currents flowing in this modification example is similar to that in the case depicted in FIG. 13. The horizontal axis in FIG. 55 represents the X-axis coordinate of an image, and the vertical axis represents the magnitude of an induced electromotive force.

A solid line L131 in C in FIG. 55 corresponds to the modification example depicted in B in FIG. 55, and the dotted line L21 corresponds to the second configuration example. As is apparent from a comparison between the solid line L131 and the dotted line L21, this modification example generates slightly smaller changes of an induced electromotive force generated to the Victim conductor loop as compared with the second configuration example. Therefore, it can be known that this modification example can suppress inductive noise slightly more as compared with the second configuration example.

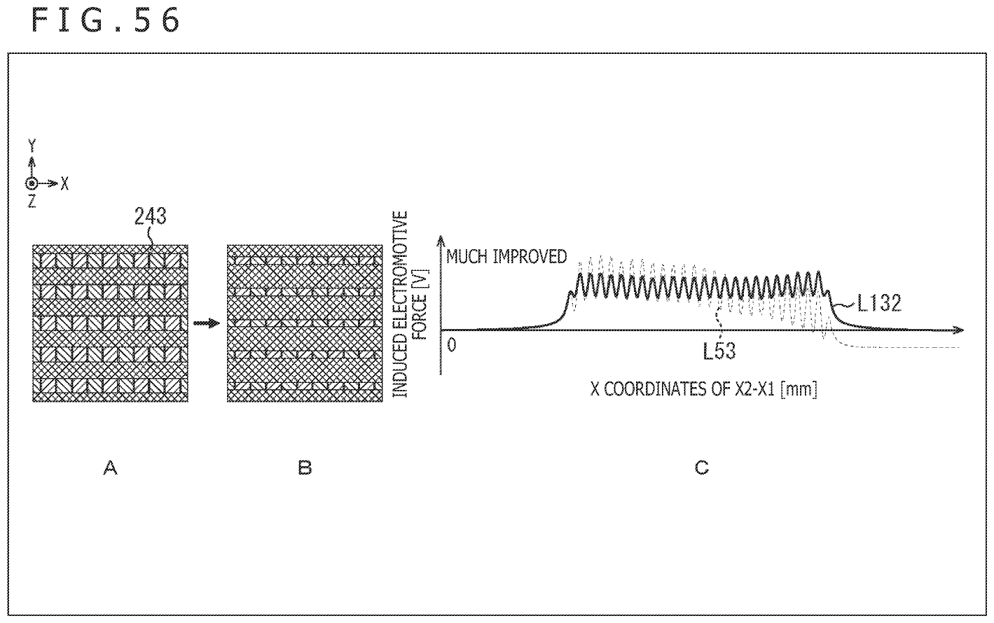

FIG. 56 is a figure depicting a modification example in which the Y-direction conductor widths in the fifth configuration example (FIG. 26) of the conductor layers A and B are doubled, and depicting an effect attained thereby. Note that A in FIG. 56 depicts the fifth configuration example of the conductor layers A and B, and B in FIG. 56 depicts the modification example of the fifth configuration example of the conductor layers A and B.

C in FIG. 56 depicts changes of an induced electromotive force that generates inductive noise in an image, as a result of a simulation of the case in which the modification example depicted in B in FIG. 56 is applied to the solid-state image pickup apparatus 100. Note that it is assumed that the condition of electric currents flowing in this modification example is similar to that in the case depicted in FIG. 23. The horizontal axis in FIG. 56 represents the X-axis coordinate of an image, and the vertical axis represents the magnitude of an induced electromotive force.

A solid line L132 in C in FIG. 56 corresponds to the modification example depicted in B in FIG. 56, and the dotted line L53 corresponds to the fifth configuration example. As is apparent from a comparison between the solid line L132 and the dotted line L53, this modification example generates much smaller changes of an induced electromotive force generated to the Victim conductor loop as compared with the fifth configuration example. Therefore, it can be known that this modification example can further suppress inductive noise as compared with the fifth configuration example.

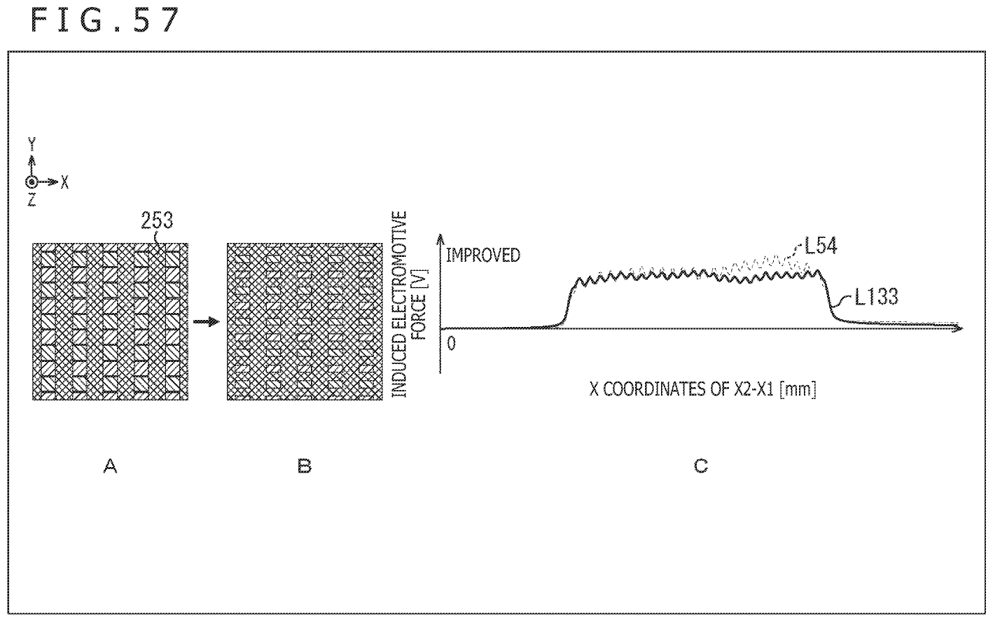

FIG. 57 is a figure depicting a modification example in which the Y-direction conductor widths in the sixth configuration example (FIG. 27) of the conductor layers A and B are doubled, and depicting an effect attained thereby. Note that A in FIG. 57 depicts the sixth configuration example of the conductor layers A and B, and B in FIG. 57 depicts the modification example of the sixth configuration example of the conductor layers A and B.

C in FIG. 57 depicts changes of an induced electromotive force that generates inductive noise in an image, as a result of a simulation of the case in which the modification example depicted in B in FIG. 57 is applied to the solid-state image pickup apparatus 100. Note that it is assumed that the condition of electric currents flowing in this modification example is similar to that in the case depicted in FIG. 23. The horizontal axis in FIG. 57 represents the X-axis coordinate of an image, and the vertical axis represents the magnitude of an induced electromotive force.

A solid line L133 in C in FIG. 57 corresponds to the modification example depicted in B in FIG. 57, and the dotted line L54 corresponds to the sixth configuration example. As is apparent from a comparison between the solid line L133 and the dotted line L54, this modification example generates smaller changes of an induced electromotive force generated to the Victim conductor loop as compared with the sixth configuration example. Therefore, it can be known that this modification example can suppress inductive noise more as compared with the sixth configuration example.

### 7. Modification Examples of Mesh Conductors

Next, FIG. 58 is a plan view depicting modification examples of mesh conductors that can be applied to each configuration example of the conductor layers A and B mentioned above.

A in FIG. 58 depicts a simplified form of the shapes of the mesh conductors adopted for each configuration example of the conductor layers A and B mentioned above. The mesh conductors adopted for each configuration example of the conductor layers A and B mentioned above have rectangular gap regions which are arranged linearly in the X direction and the Y direction.

B in FIG. 58 depicts a simplified form of a first modification example of the mesh conductors. The first modification example of the mesh conductors has rectangular gap regions which are arranged linearly in the X direction and are arranged being displaced between stages in the Y direction.

C in FIG. 58 depicts a simplified form of a second modification example of the mesh conductors. The second modification example of the mesh conductors has diamond-shaped gap regions which are arranged linearly in diagonal directions.

D in FIG. 58 depicts a simplified form of a third modification example of the mesh conductors. The third modification example of the mesh conductors has non-rectangular circular or polygonal gap regions (octagonal gap regions in the case of D in FIG. 58) which are arranged linearly in the X direction and the Y direction.

E in FIG. 58 depicts a simplified form of a fourth modification example of the mesh conductors. The fourth modification example of the mesh conductors has non-rectangular circular or polygonal gap regions (octagonal gap regions in the case of E in FIG. 58) which are arranged linearly in the X direction and are arranged being displaced between stages in the Y direction.

F in FIG. 58 depicts a simplified form of a fifth modification example of the mesh conductors. The fifth modification example of the mesh conductors has non-rectangular circular or polygonal gap regions (octagonal gap regions in the case of F in FIG. 58) which are arranged linearly in diagonal directions.

Note that the shapes of the mesh conductors that can be applied to each configuration example of the conductor layers A and B are not limited to the modification examples depicted in FIG. 58, but it is sufficient if the shapes are mesh shapes.

### 8. Various Effects

<Enhancement of Degrees of Freedom of Layout Designing>

As mentioned above, in each configuration example of the conductor layers A and B, planar conductors or mesh conductors are adopted. Typically, mesh conductors (grid conductors) have regular wiring structures in the X direction and the Y direction. Therefore, only by designing a mesh conductor having a basic regular structure to be a regular structure unit (one pitch), a layout of wires can be designed simply, as compared with a case in which linear conductors are used, by arranging the basic regular structure repetitively in the X direction and the Y direction. In other words, in a case in which mesh conductors are used, the degree of freedom of layouts is enhanced as compared with a case in which linear conductors are used. Accordingly, man-hours, time, and costs required for layout designing can be reduced.

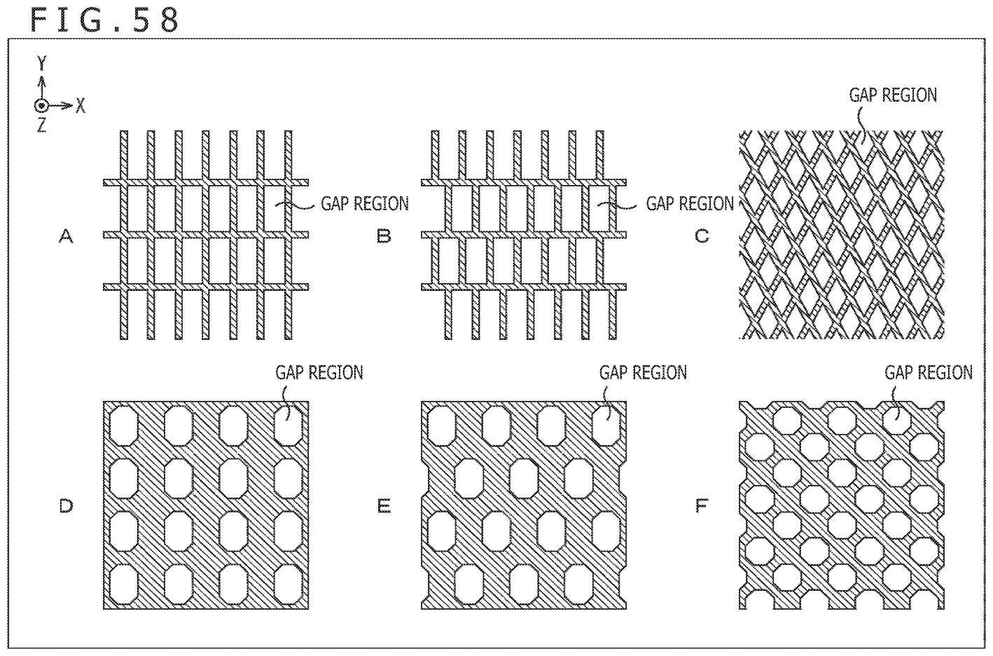

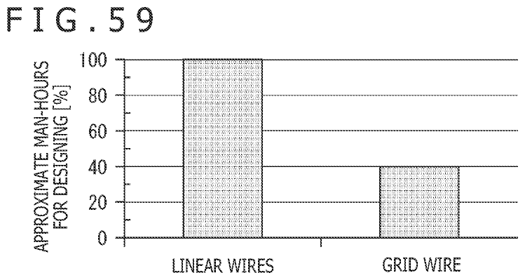

FIG. 59 is a figure depicting results of simulations of man-hours for designing in a case in which a layout of circuit wires that satisfies predetermined conditions is designed by using linear conductors, and man-hours for designing in a case in which a layout of circuit wires that satisfies the predetermined conditions is designed by using mesh conductors (grid conductors).

In the case of FIG. 59, if it is assumed that the man-hours for designing in a case in which linear conductors are used for the designing are 100%, the man-hours for designing when mesh conductors (grid conductors) are used for the designing are approximately 40%, and it can be known that man-hours for designing can be reduced significantly.

<Reduction of Voltage Drops (IR-Drop)>

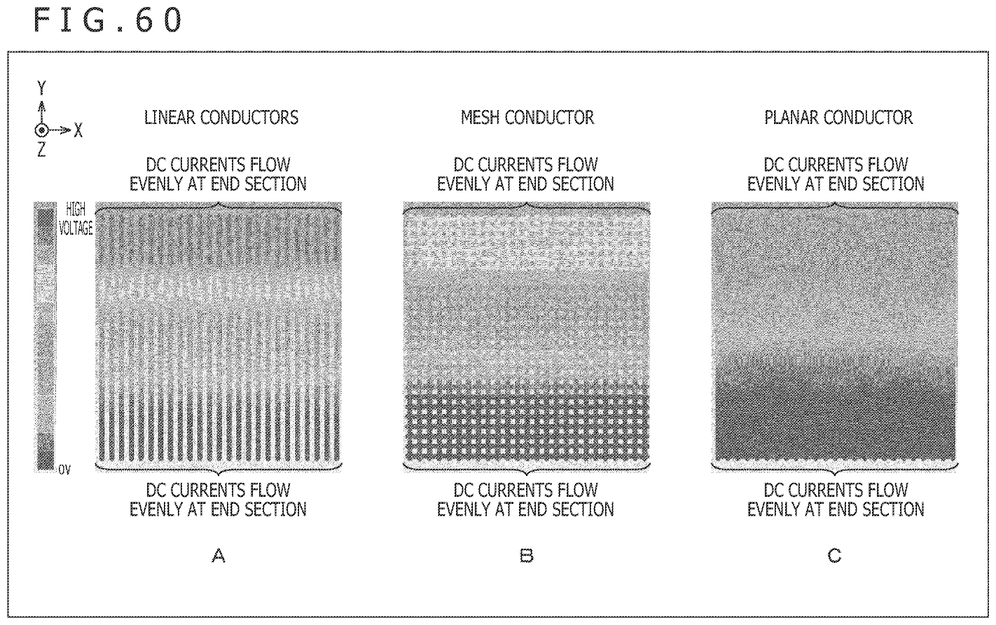

FIG. 60 is a figure depicting voltage changes in cases in which DC currents are caused to flow, in the Y direction under the same condition, through conductors that are arranged on the XY plane and made with the same material but have different shapes.

A, B, and C in FIG. 60 correspond to linear conductors, a mesh conductor, and a planar conductor, respectively, and gradations of colors represent voltages. It can be known from a comparison among A, B, and C in FIG. 60 that the linear conductors exhibit the largest voltage changes, the mesh conductor exhibits the second largest voltage changes, and the planar conductor exhibits the third largest voltage changes.

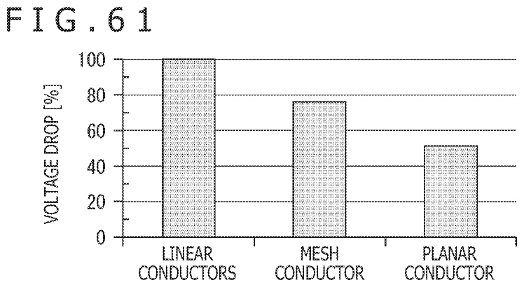

FIG. 61 is a figure depicting, in a graph, relative voltage drops of the mesh conductor and the planar conductor assuming that a voltage drop of the linear conductors depicted in A in FIG. 60 is 100%.

As is apparent also from FIG. 61, it can be known that, as compared with the linear conductors, the planar conductor and the mesh conductor can reduce voltage drops (IR-Drop) which can be fatal faults for driving of a semiconductor apparatus.

It should be noted however that it is known that planar conductors cannot be manufactured with current semiconductor board processing processes in many cases. Therefore, it is realistic to adopt configuration examples that use mesh conductors for both of the conductor layers A and B. It should be noted however that this does not hold true if it becomes possible to manufacture planar conductors as a result of the progress of semiconductor board processing processes. In some cases, planar conductors can be manufactured for uppermost layer metals and lowermost layer metals among metal layers.

<Reduction of Capacitive Noise>

It is considered that conductors (planar conductors or mesh conductors) forming the conductor layers A and B generate not only inductive noise but also capacitive noise to a Victim conductor loop including a signal line 132 and a control line 133.

Here, capacitive noise means a phenomenon in which, in a case in which voltages are applied to conductors forming the conductor layers A and B, voltages are generated to a signal line 132 and a control line 133 due to capacitive coupling between the conductors and the signal line 132 and the control line 133, and furthermore the applied voltages change, thereby generating voltage noise to the signal line 132 and the control line 133. The voltage noise becomes pixel signal noise.

The magnitude of capacitive noise is considered to be almost proportional to electrostatic capacitance and a voltage between the conductors forming the conductor layers A and B and wires such as a signal line 132 or a control line 133. Regarding the electrostatic capacitance, in a case in which the area size over which two conductors (one of them may be a conductor and the other of them may be a wire) overlap is S, the two conductors are arranged in parallel at an interval of d, and the space between the conductors is uniformly filled with a dielectric with a dielectric constant ε, the electrostatic capacitance C between the two conductors is ε*S/d. Accordingly, it can be known that, as the area size S over which the two conductors overlap increases, the capacitive noise increases.

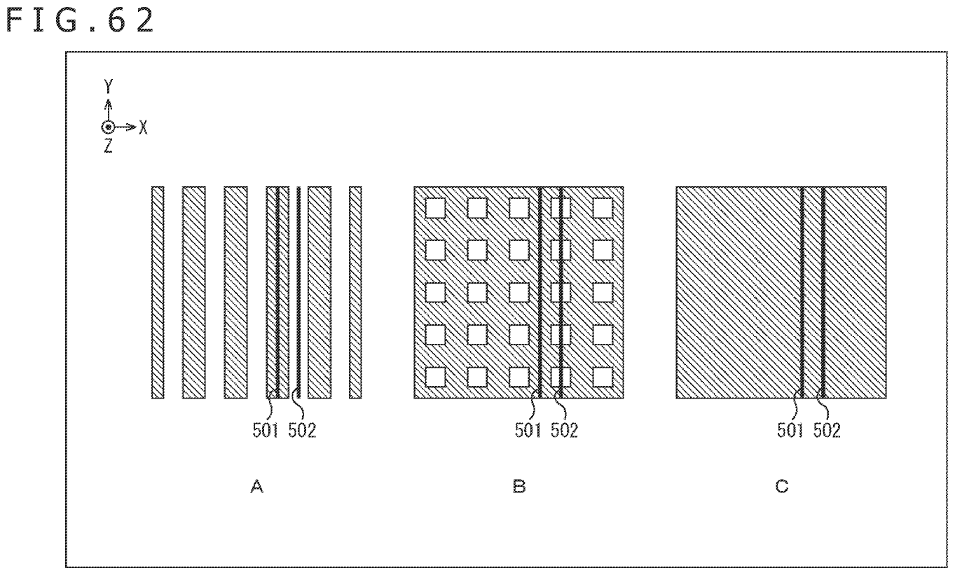

FIG. 62 is a figure for explaining differences between electrostatic capacitance of conductors that are arranged on the XY plane and made with the same material but have different shapes, and other conductors (wires).

A in FIG. 62 depicts linear conductors that are long in the Y direction, and wires 501 and 502 (corresponding to the signal line 132 and the control line 133) that are formed linearly in the Y direction at an interval from the linear conductors in the Z direction. It should be noted however that while the wire 501 entirely overlaps a conductor region of a linear conductor, the wire 502 entirely overlaps a gap region of linear conductors and does not have an area size over which the wire 502 overlaps a conductor region.

B in FIG. 62 depicts a mesh conductor, and wires 501 and 502 that are formed linearly in the Y direction at an interval from the mesh conductor in the Z direction. It should be noted however that while the wire 501 entirely overlaps a conductor region of the mesh conductor, substantially half of the wire 502 overlaps the conductor region of the mesh conductor.

C in FIG. 62 depicts a planar conductor, and wires 501 and 502 that are formed linearly in the Y direction at an interval from the planar conductor in the Z direction. It should be noted however that the wires 501 and 502 entirely overlap a conductor region of the planar conductor.

If differences between the electrostatic capacitance of the conductors (the linear conductors, the mesh conductor, and the planar conductor) in A, B, and C in FIG. 62 and the wire 501, and the electrostatic capacitance of the conductors (the linear conductors, the mesh conductor, and the planar conductor) and the wire 502 are compared with each other, the linear conductors produce the largest difference, the mesh conductor produces the second largest difference, and the planar conductor produces the third largest difference.

That is, the linear conductors produce a significant difference in electrostatic capacitance of the linear conductors and the wires due to a difference of the XY coordinates of the wires, and this means that the occurrence of capacitive noise also differs significantly. Therefore, there is a possibility that pixel signal noise which is highly visible in an image is generated.

In contrast, the differences between electrostatic capacitance of the conductors and the wires that are produced by the mesh conductor and the planar conductor due to differences of the XY coordinates of the wires are small as compared with the linear conductors, and so the occurrence of capacitive noise can be reduced more. Therefore, pixel signal noise due to capacitive noise can be suppressed.

<Reduction of Radioactive Noise>

As mentioned above, among the configuration examples of the conductor layers A and B, mesh conductors are used in configuration examples other than the first configuration example. The mesh conductors can be expected to provide an effect of reducing radioactive noise. It is assumed here that radioactive noise includes radioactive noise from the inside of the solid-state image pickup apparatus 100 to the outside (unnecessary radiation), and radioactive noise from the outside of the solid-state image pickup apparatus 100 to the inside (transferred noise).

The radioactive noise from the outside of the solid-state image pickup apparatus 100 to the inside can generate voltage noise and pixel signal noise in a signal line 132 and the like, and so in a case in which a configuration example using a mesh conductor for at least one of the conductor layers A and B is adopted, an effect of suppressing the voltage noise and pixel signal noise can be expected.

Because the conductor pitch of a mesh conductor influences the frequency band of radioactive noise that the mesh conductor is capable of reducing, in a case in which mesh conductors with different conductor pitches are used for the conductor layers A and B, it is possible to reduce radioactive noise of a wide frequency band as compared with the case in which mesh conductors with the same conductor frequency are used for the conductor layers A and B.

Note that the effects mentioned above are presented merely for illustrative purposes, effects are not limited to them, and there may be other effects.

### 9. Configuration Examples with Different Lead Sections

Meanwhile, for example, in a case in which the wiring layer 165A which is the conductor layer A or the wiring layer 165B which is the conductor layer B is connected to the pad 401 or 402, wire lead sections for connections with the pads 401 or 402 are provided as depicted in FIG. 42 to FIG. 44. The wire lead sections are typically formed with narrow wire widths according to the sizes of the pads.

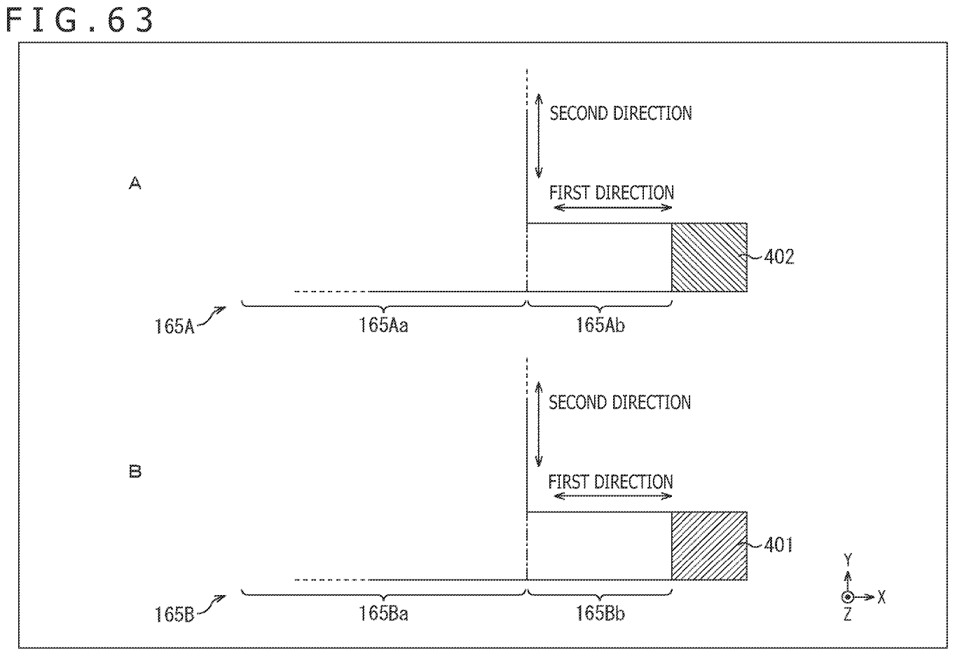

In view of this, for example, the wiring layer 165A (conductor layer A) is treated separately as a main conductor section 165Aa and a lead conductor section 165Ab for an explanation here as depicted in A in FIG. 63. The main conductor section 165Aa is a section whose main purpose is to block hot carrier light emissions from an active element group 167 and to hinder the occurrence of inductive noise. The main conductor section 165Aa has an area size larger than the lead conductor section 165Ab. The lead conductor section 165Ab is a section whose main purpose is to connect the main conductor section 165Aa and a pad 402 and to supply the main conductor section 165Aa with a predetermined voltage of GND, a negative power supply (Vss), or the like. At least one of the X-direction (first-direction) length (width) or the Y-direction (second-direction) length (width) of the lead conductor section 165Ab is shorter than (narrower than) the length (width) of the main conductor section 165Aa. A connecting section between the main conductor section 165Aa and the lead conductor section 165Ab represented by a dash-dotted line in A in FIG. 63 is referred to as a junction section.

Similarly, the wiring layer 165B (conductor layer B) is treated separately as a main conductor section 165Ba and a lead conductor section 165Bb for an explanation here as depicted in B in FIG. 63. The main conductor section 165Ba is a section whose main purpose is to block hot carrier light emissions from the active element group 167 and to hinder the occurrence of inductive noise. The main conductor section 165Ba has an area size larger than the lead conductor section 165Bb. The lead conductor section 165Bb is a section whose main purpose is to connect the main conductor section 165Ba and a pad 401 and to supply the main conductor section 165Ba with a predetermined voltage of a positive power supply (Vdd) or the like. At least one of the X-direction (first-direction) length (width) or the Y-direction (second-direction) length (width) of the lead conductor section 165Bb is shorter than (narrower than) the length (width) of the main conductor section 165Ba. A connecting section between the main conductor section 165Ba and the lead conductor section 165Bb represented by a dash-dotted line in B in FIG. 63 is referred to as a junction section.

Note that in a case in which the main conductor section 165Aa and the main conductor section 165Ba are referred to collectively, and in a case in which the lead conductor section 165Ab and the lead conductor section 165Bb are referred to collectively, without a distinction being made between the wiring layer 165A (conductor layer A) and the wiring layer 165B (conductor layer B), they are referred to as a main conductor section 165a and a lead conductor section 165b, respectively.

While it is presumed in the explanation given with reference to FIG. 63 that the lead conductor section 165Ab and the lead conductor section 165Bb are connected to the pads 401 and 402 for facilitating understanding, the lead conductor section 165Ab and the lead conductor section 165Bb need not be connected to the pads 401 and 402 necessarily, and it is sufficient if the lead conductor section 165Ab and the lead conductor section 165Bb are connected with other wires or electrodes.

In addition, while the pad 401 and the pad 402 have substantially the same shapes and are arranged at substantially the same positions in the example depicted in FIG. 63, this is not essential. For example, the pad 401 and the pad 402 may have mutually different shapes and may be arranged at mutually different positions. In addition, the pad 401 and the pad 402 may be formed with dimensions smaller than those in the one example depicted in FIG. 63. The pad 401 and the pad 402 may be formed not to contact each other at the wiring layer 165A. The pad 401 and the pad 402 may be formed not to contact with each other at the wiring layer 165B. Multiple pads 401 and pads 402 may be provided.

Furthermore, while Y-direction end-section positions of the main conductor section 165Aa and the lead conductor section 165Ab substantially coincide with each other in the example depicted in FIG. 63, this is not essential. For example, the main conductor section 165Aa and the lead conductor section 165Ab may be configured such that their end-section positions do not coincide with each other. Similarly, while Y-direction end-section positions of the main conductor section 165Ba and the lead conductor section 165Bb substantially coincide with each other in the example depicted in FIG. 63, this is not essential. For example, the main conductor section 165Ba and the lead conductor section 165Bb may be configured such that their end-section positions do not coincide with each other. The shapes and positions of the main conductor section 165a and the lead conductor section 165b, and their relations with pads 401 and 402 apply similarly to each configuration example explained below.

In the first to thirteenth configuration examples mentioned above, regarding the wiring layer 165A, both the main conductor section 165Aa and the lead conductor section 165Ab are formed with the same wiring patterns of planar conductors, mesh conductors, or the like, without a particular distinction being made between the main conductor section 165Aa and the lead conductor section 165Ab.

Regarding the wiring layer 165B also, both the main conductor section 165Ba and the lead conductor section 165Bb are formed with the same wiring patterns of planar conductors, mesh conductors, or the like, without a particular distinction being made between the main conductor section 165Ba and the lead conductor section 165Bb.

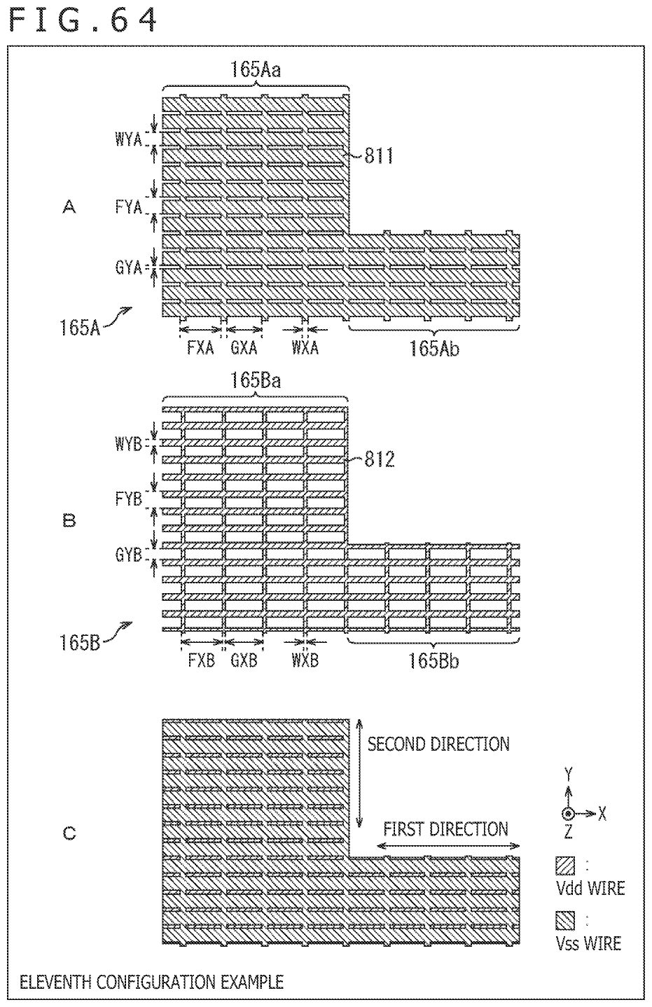

As an example of the first to thirteenth configuration example mentioned above, FIG. 64 depicts an example in which the eleventh configuration example depicted in FIG. 36 is applied to the wiring layer 165A and the wiring layer 165B by using different wiring patterns.

A in FIG. 64 depicts the conductor layer A (wiring layer 165A), and B in FIG. 64 depicts the conductor layer B (wiring layer 165B). In the coordinate system in FIG. 64, the X axis lies in the lateral direction, the Y axis lies in the longitudinal direction, and the Z axis lies in a direction perpendicular to the XY plane.

While the mesh conductor 311 in the conductor layer A depicted in A in FIG. 36 has a shape in which the X-direction conductor width WXA is wider than the gap width GXA in the example in the eleventh configuration example depicted in FIG. 36, a mesh conductor 811 in the conductor layer A in A in FIG. 64 has a shape in which the X-direction conductor width WXA is narrower than the gap width GXA. In addition, regarding the Y direction, while the mesh conductor 311 has a shape in which the conductor width WYA is narrower than the gap width GYA in the example depicted in A in FIG. 36, the mesh conductor 811 in the conductor layer A in A in FIG. 64 has a shape in which the conductor width WYA is wider than the gap width GYA. While the mesh conductor 311 in the conductor layer A has a shape in which the conductor width WYA and the conductor width WXA are substantially the same in the example depicted in A in FIG. 36, the mesh conductor 811 in the conductor layer A in A in FIG. 64 has a shape in which the conductor width WYA is wider than the conductor width WXA. Then, in both the main conductor section 165Aa and the lead conductor section 165Ab in the mesh conductor 811 in the conductor layer A in A in FIG. 64, regarding the X direction, the same pattern is arranged regularly at the conductor pitch FXA, and regarding the Y direction, the same pattern is arranged regularly at the conductor pitch FYA.

The conductor layer B has a shape in which the ratio of the X-direction gap width GXB to the conductor width WXB ((gap width GXB)/(conductor width WXB)) of a mesh conductor 812 in the conductor layer B in B in FIG. 64 is higher than the ratio of the X-direction gap width GXB to the conductor width WXB ((gap width GXB)/(conductor width WXB)) of the mesh conductor 312 in the conductor layer B depicted in B in FIG. 36. In other words, in the mesh conductor 812 in the conductor layer B in B in FIG. 64, the difference between the conductor width WXB and the gap width GXB is larger than that in the mesh conductor 312 in the conductor layer B depicted in B in FIG. 36. Regarding the Y direction, the ratio of the gap width GYB to the conductor width WYB ((gap width GYB)/(conductor width WYB)) of the mesh conductor 812 in the conductor layer B in B in FIG. 64 is lower than the ratio of the gap width GYB to the conductor width WYB ((gap width GYB)/(conductor width WYB)) of the mesh conductor 312 in the conductor layer B depicted in B in FIG. 36. While the mesh conductor 312 in the conductor layer B has a shape in which the conductor width WYB and the conductor width WXB are substantially the same in the example depicted in B in FIG. 36, the mesh conductor 812 in the conductor layer B in B in FIG. 64 has a shape in which the conductor width WYB is wider than the conductor width WXB. Then, in both the main conductor section 165Ba and the lead conductor section 165Bb in the mesh conductor 812 in the conductor layer B in B in FIG. 64, regarding the X direction, the same pattern is arranged regularly at the conductor pitch FXB, and regarding the Y direction, the same pattern is arranged regularly at the conductor pitch FYB.

C in FIG. 64 depicts a state of the conductor layers A and B depicted in A and B in FIG. 64, respectively, as seen from the side where the conductor layer A is located (the side where photodiodes 141 are located). C in FIG. 64 does not depict regions of the conductor layer B that overlap and are hidden by the conductor layer A.

As depicted in C in FIG. 64, because an active element group 167 is to be covered with at least one of the conductor layer A or the conductor layer B in the case of the eleventh configuration example, hot carrier light emissions from the active element group 167 can be blocked, and the occurrence of inductive noise can be suppressed.

In this manner, the first to thirteenth configuration examples mentioned above are examples in which the wiring layer 165A (conductor layer A) is formed with the same wiring pattern without a particular distinction being made between the main conductor section 165Aa and the lead conductor section 165Ab, and the wiring layer 165B (conductor layer B) also is formed with the same wiring pattern without a particular distinction being made between the main conductor section 165Ba and the lead conductor section 165Bb.

However, the lead conductor section 165b is formed to have an area size smaller than the main conductor section 165a, and so is a section where currents are concentrated. Accordingly, the lead conductor section 165b is desirably configured such that its wire resistance becomes low and currents are more easily diffused at the main conductor section 165a.

In view of this, in configuration examples explained hereinbelow, wiring patterns of the lead conductor section 165Ab in the wiring layer 165A (conductor layer A) are made different from wiring patterns of the main conductor section 165Aa, and also wiring patterns of the lead conductor section 165Bb in the wiring layer 165B (conductor layer B) are made different from wiring patterns of the main conductor section 165Ba.

### Fourteenth Configuration Example

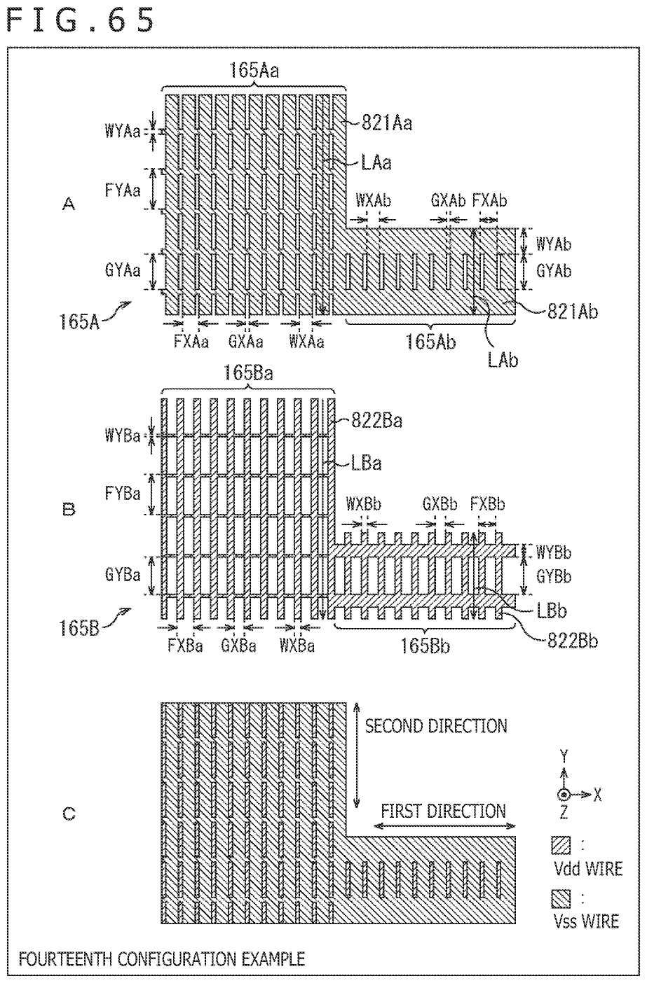

FIG. 65 depicts a fourteenth configuration example of the conductor layers A and B. Note that A in FIG. 65 depicts the conductor layer A, and B in FIG. 65 depicts the conductor layer B. In the coordinate system in FIG. 65, the X axis lies in the lateral direction, the Y axis lies in the longitudinal direction, and the Z axis lies in a direction perpendicular to the XY plane.

As depicted in A in FIG. 65, the conductor layer A in the fourteenth configuration example includes a mesh conductor 821Aa of the main conductor section 165Aa and a mesh conductor 821Ab of the lead conductor section 165Ab. The mesh conductor 821Aa and the mesh conductor 821Ab are wires (Vss wires) connected to GND or a negative power supply, for example.

Regarding the X direction, the mesh conductor 821Aa of the main conductor section 165Aa has a conductor width WXAa and a gap width GXAa and includes the same pattern regularly arranged at a conductor pitch FXAa. Regarding the Y direction, the mesh conductor 821Aa of the main conductor section 165Aa has a conductor width WYAa and a gap width GYAa and includes the same pattern regularly arranged at a conductor pitch FYAa. Accordingly, the mesh conductor 821Aa has a shape including a repetition pattern in which a predetermined basic pattern is arrayed repetitively at a conductor pitch in at least one of the X direction or the Y direction.

Regarding the X direction, the mesh conductor 821Ab of the lead conductor section 165Ab has a conductor width WXAb and a gap width GXAb, and includes the same pattern regularly arranged at a conductor pitch FXAb. Regarding the Y direction, the mesh conductor 821Ab of the lead conductor section 165Ab has a conductor width WYAb and a gap width GYAb. Accordingly, the mesh conductor 821Ab has a shape including a repetition pattern in which a predetermined basic pattern is arrayed repetitively at a conductor pitch in at least one of the X direction or the Y direction.

In addition, at least one of the conductor width WXA, the gap width GXA, the conductor width WYA, and the gap width GYA of the mesh conductor 821Aa of the main conductor section 165Aa has a value that is different from the value of the corresponding one of the conductor width WXA, the gap width GXA, the conductor width WYA, and the gap width GYA of the mesh conductor 821Ab of the lead conductor section 165Ab if the values are compared with each other, and the repetition pattern of the mesh conductor 821Ab of the lead conductor section 165Ab is a pattern that is different from the repetition pattern of the mesh conductor 821Aa of the main conductor section 165Aa.

If an entire Y-direction length LAa of the mesh conductor 821Aa of the main conductor section 165Aa and an entire Y-direction length LAb of the mesh conductor 821Ab of the lead conductor section 165Ab are compared with each other, the entire length LAa of the mesh conductor 821Aa is longer than the entire length LAb of the mesh conductor 821Ab. Accordingly, currents are more concentrated locally in the mesh conductor 821Ab of the lead conductor section 165Ab than in the mesh conductor 821Aa of the main conductor section 165Aa, and so voltage drops (particularly, IR-Drop) are larger in the mesh conductor 821Ab of the lead conductor section 165Ab.

Here, if the X direction toward the main conductor section 165Aa is defined as a first direction, the repetition pattern of the mesh conductor 821Ab of the lead conductor section 165Ab has a shape in which currents flow at least in the first direction, and the conductor width (wire width) WYAb in a second direction (Y direction) orthogonal to the first direction is formed larger than the second-direction conductor width (wire width) WYAa of the mesh conductor 821Aa of the main conductor section 165Aa. Thereby, the wire resistance of the mesh conductor 821Ab of the lead conductor section 165Ab, which is a current-concentrated portion, can be lowered, and so voltage drops can be ameliorated further. Note that while the conductor width WYAb is larger than the conductor width WYAa in the example used for the explanation, this is not essential. For example, the conductor width WXAb may be formed larger than the conductor width WXAa. Thereby, the wire resistance of the mesh conductor 821Ab can be lowered, and so voltage drops can be ameliorated further.

In addition, at least part of the mesh conductor 821Aa of the main conductor section 165Aa has a pattern (shape) in which currents flow more easily in the Y direction (second direction) than in the X direction (first direction). Specifically, by making at least either the wire widths (the conductor width WXAa and the conductor width WYAa) or the wire intervals (the gap width GXAa and the gap width GYAa) different from each other, the Y-direction wire resistance is formed lower than the X-direction wire resistance. Thereby, currents are diffused more easily in the Y direction in the main conductor section 165Aa having the entire length LAa longer than the entire length LAb of the mesh conductor 821Ab. Accordingly, electrode concentration around the junction section between the main conductor section 165Aa and the lead conductor section 165Ab can be relaxed, and inductive noise can be ameliorated further.

As depicted in B in FIG. 65, the conductor layer B in the fourteenth configuration example includes a mesh conductor 822Ba of the main conductor section 165Ba and a mesh conductor 822Bb of the lead conductor section 165Bb. The mesh conductor 822Ba and the mesh conductor 822Bb are wires (Vdd wires) connected to a positive power supply, for example.

Regarding the X direction, the mesh conductor 822Ba of the main conductor section 165Ba has a conductor width WXBa and a gap width GXBa and includes the same pattern regularly arranged at a conductor pitch FXBa. Regarding the Y direction, the mesh conductor 822Ba of the main conductor section 165Ba has a conductor width WYBa and a gap width GYBa and includes the same pattern regularly arranged at a conductor pitch FYBa. Accordingly, the mesh conductor 822Ba has a shape including a repetition pattern in which a predetermined basic pattern is arrayed repetitively at a conductor pitch in at least one of the X direction or the Y direction.

Regarding the X direction, the mesh conductor 822Bb of the lead conductor section 165Bb has a conductor width WXBb and a gap width GXBb, and includes the same pattern regularly arranged at a conductor pitch FXBb. Regarding the Y direction, the mesh conductor 822Bb of the lead conductor section 165Bb has a conductor width WYBb and a gap width GYBb. Accordingly, the mesh conductor 822Bb has a shape including a repetition pattern in which a predetermined basic pattern is arrayed repetitively at a conductor pitch in at least one of the X direction or the Y direction.

In addition, at least one of the conductor width WXB, the gap width GXB, the conductor width WYB, and the gap width GYB of the mesh conductor 822Ba of the main conductor section 165Ba has a value that is different from the value of the corresponding one of the conductor width WXB, the gap width GXB, the conductor width WYB, and the gap width GYB of the mesh conductor 822Bb of the lead conductor section 165Bb if the values are compared with each other, and the repetition pattern of the mesh conductor 822Bb of the lead conductor section 165Bb is a pattern that is different from the repetition pattern of the mesh conductor 822Ba of the main conductor section 165Ba.

If an entire Y-direction length LBa of the mesh conductor 822Ba of the main conductor section 165Ba and an entire Y-direction length LBb of the mesh conductor 822Bb of the lead conductor section 165Bb are compared with each other, the entire length LBa of the mesh conductor 822Ba is longer than the entire length LBb of the mesh conductor 822Bb. Accordingly, currents are more concentrated locally in the mesh conductor 822Bb of the lead conductor section 165Bb than in the mesh conductor 822Ba of the main conductor section 165Ba, and so voltage drops (particularly, IR-Drop) are larger in the mesh conductor 822Bb of the lead conductor section 165Bb.

Here, if the X direction toward the main conductor section 165Ba is defined as a first direction, the repetition pattern of the mesh conductor 822Bb of the lead conductor section 165Bb has a shape in which currents flow at least in the first direction, and the conductor width (wire width) WYBb in a second direction (Y direction) orthogonal to the first direction is formed larger than the second-direction conductor width (wire width) WYBa of the mesh conductor 822Ba of the main conductor section 165Ba. Thereby, the wire resistance of the mesh conductor 822Bb of the lead conductor section 165Bb, which is a current-concentrated portion, can be lowered, and so voltage drops can be ameliorated further. Note that while the conductor width WYBb is larger than the conductor width WYBa in the example used for the explanation, this is not essential. For example, the conductor width WXBb may be formed larger than the conductor width WXBa. Thereby, the wire resistance of the mesh conductor 822Bb can be lowered, and so voltage drops can be ameliorated further.

In addition, at least part of the mesh conductor 822Ba of the main conductor section 165Ba has a pattern (shape) in which currents flow more easily in the Y direction (second direction) than in the X direction (first direction). Specifically, by making at least either the wire widths (the conductor width WXBa and the conductor width WYBa) or the wire intervals (the gap width GXBa and the gap width GYBa) different from each other, the Y-direction wire resistance is formed lower than the X-direction wire resistance. Thereby, currents are diffused more easily in the Y direction in the main conductor section 165Ba having the entire length LBa longer than the entire length LBb of the mesh conductor 822Bb. Accordingly, electrode concentration around the junction section between the main conductor section 165Ba and the lead conductor section 165Bb can be relaxed, and inductive noise can be ameliorated further.

As mentioned above, according to the fourteenth configuration example, the repetition pattern of the mesh conductor 821Ab of the lead conductor section 165Ab in the wiring layer 165A (conductor layer A) is formed with a pattern that is different from the repetition pattern of the mesh conductor 821Aa of the main conductor section 165Aa, and the main conductor section 165Aa and the lead conductor section 165Ab are electrically connected. Thereby, the wire resistance of the lead conductor section 165Ab can be lowered, and voltage drops can be ameliorated further. Regarding the wiring layer 165B (conductor layer B) also, the repetition pattern of the mesh conductor 822Bb of the lead conductor section 165Bb is formed with a pattern that is different from the repetition pattern of the mesh conductor 822Ba of the main conductor section 165Ba, and the main conductor section 165Ba and the lead conductor section 165Bb are electrically connected. Thereby, the wire resistance of the lead conductor section 165Bb can be lowered, and voltage drops can be ameliorated further.

In addition, in the overlapping state of the conductor layer A and the conductor layer B as depicted in C in FIG. 65, at least one of the conductor layer A and the conductor layer B covers an active element group 167. That is, the main conductor section 165Aa of the wiring layer 165A and the main conductor section 165Ba of the wiring layer 165B form a light-blocking structure, and the lead conductor section 165Ab of the wiring layer 165A and the lead conductor section 165Bb of the wiring layer 165B form a light-blocking structure. Thereby, similarly to the first to thirteenth configuration examples mentioned above, hot carrier light emissions from the active element group 167 can be blocked in the fourteenth configuration example also.

### Modification Examples of Fourteenth Configuration Example

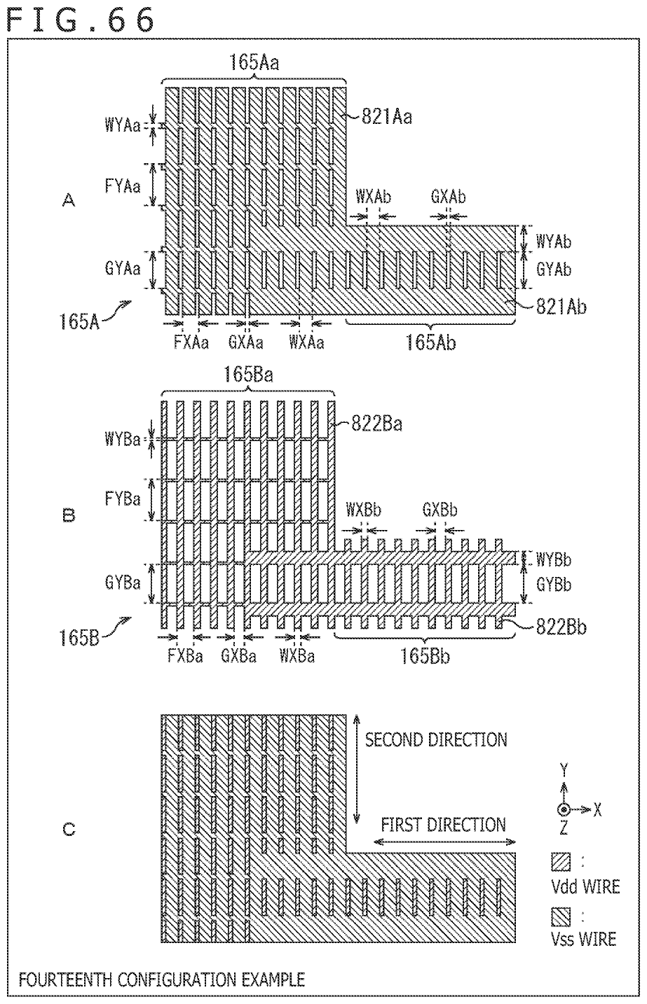

FIG. 66 to FIG. 68 depict first to third modification examples of the fourteenth configuration example. Note that A to C in FIG. 66 to FIG. 68 correspond to A to C in FIG. 65, respectively, and the same reference signs are given. Accordingly, explanations of common sections are omitted as appropriate, and differences are explained.

While in the fourteenth configuration example depicted in FIG. 65, the junction section between the main conductor section 165Aa and the lead conductor section 165Ab in the wiring layer 165A (conductor layer A) is arranged on an edge of a rectangle surrounding the outer circumference of the main conductor section 165Aa, this is not essential.

For example, as depicted in A in FIG. 66, the main conductor section 165Aa and the lead conductor section 165Ab may be connected such that the mesh conductor 821Ab of the lead conductor section 165Ab protrudes into the inside of the rectangle surrounding the outer circumference of the main conductor section 165Aa.

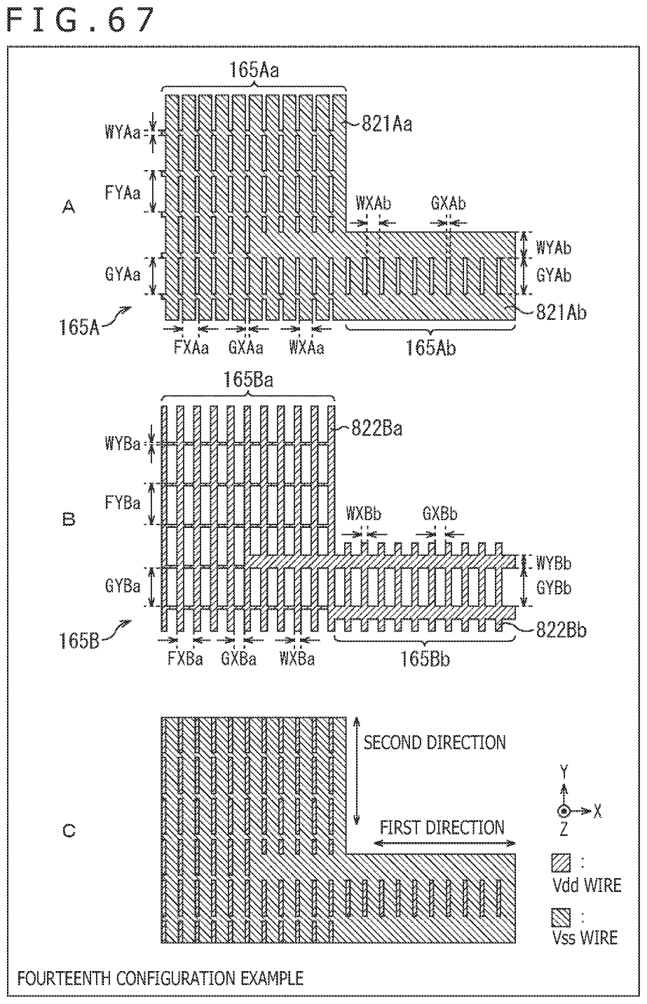

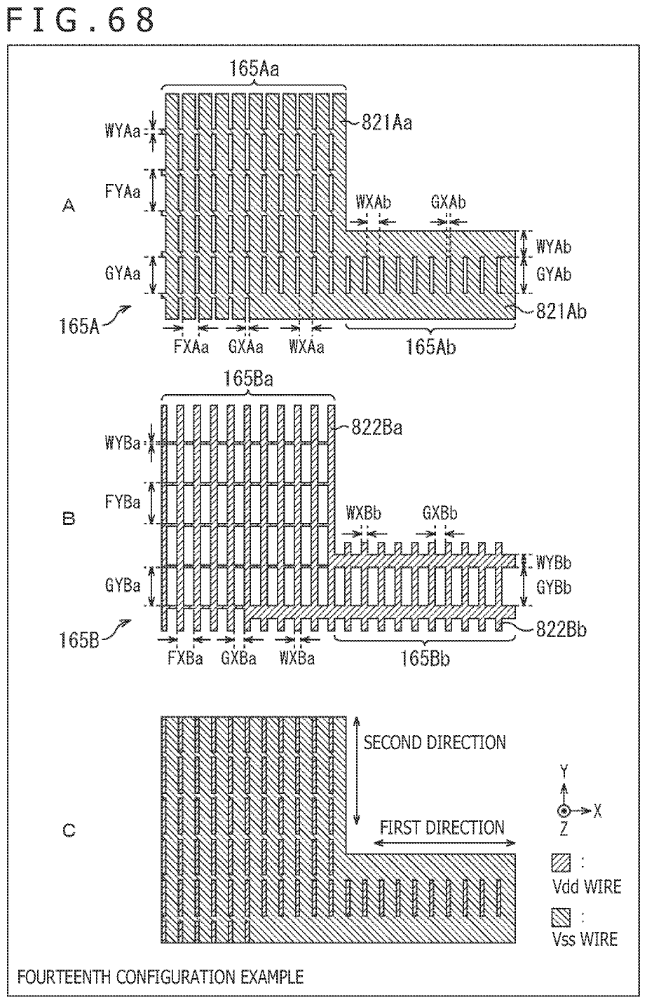

In addition, for example, as depicted in A in FIG. 67 and A in FIG. 68, the main conductor section 165Aa and the lead conductor section 165Ab may be connected such that only some wires in multiple wires with the conductor width WYAb extending toward the main conductor section 165Aa of the mesh conductor 821Ab of the lead conductor section 165Ab protrude into the inside of the rectangle surrounding the outer circumference of the main conductor section 165Aa. In the mesh conductor 821Ab of the lead conductor section 165Ab in A in FIG. 67, the upper wire in two wires with the conductor width WYAb extends to protrude into the inside of the rectangle surrounding the outer circumference of the main conductor section 165Aa, and in the mesh conductor 821Ab of the lead conductor section 165Ab in A in FIG. 68, the lower wire extends to protrude into the inside of the rectangle surrounding the outer circumference of the main conductor section 165Aa.

This similarly applies also to the wiring layer 165B (conductor layer B). That is, while in the fourteenth configuration example depicted in FIG. 65, the junction section between the main conductor section 165Ba and the lead conductor section 165Bb is arranged on an edge of a rectangle surrounding the outer circumference of the main conductor section 165Ba, this is not essential.

For example, as depicted in B in FIG. 66, the main conductor section 165Ba and the lead conductor section 165Bb may be connected such that the mesh conductor 822Bb of the lead conductor section 165Bb protrudes into the inside of the rectangle surrounding the outer circumference of the main conductor section 165Ba.

In addition, for example, as depicted in B in FIG. 67 and B in FIG. 68, the main conductor section 165Ba and the lead conductor section 165Bb may be connected such that only some wires in multiple wires with the conductor width WYBb extending toward the main conductor section 165Ba of the mesh conductor 822Bb of the lead conductor section 165Bb protrude into the inside of the rectangle surrounding the outer circumference of the main conductor section 165Ba. In the mesh conductor 822Bb of the lead conductor section 165Bb in B in FIG. 67, the upper wire in two wires with the conductor width WYBb extends to protrude into the inside of the rectangle surrounding the outer circumference of the main conductor section 165Ba, and in the mesh conductor 822Bb of the lead conductor section 165Bb in B in FIG. 68, the lower wire extends to protrude into the inside of the rectangle surrounding the outer circumference of the main conductor section 165Ba.

As in FIG. 66 to FIG. 68, the shape of a section connecting the main conductor section 165a and the lead conductor section 165b may be formed in a complicated manner.

While the main conductor section 165Aa and the lead conductor section 165Ab are connected such that the mesh conductor 821Ab of the lead conductor section 165Ab protrudes into the inside of the rectangle surrounding the outer circumference of the main conductor section 165Aa in the first to third modification examples of the fourteenth configuration example depicted in FIG. 66 to FIG. 68, the mesh conductor 821Aa of the main conductor section 165Aa may protrude out to the outside of the rectangle surrounding the outer circumference of the main conductor section 165Aa, and into the side where the lead conductor section 165Ab is located. In addition, the mesh conductor 822Ba of the main conductor section 165Ba may protrude out to the outside of the rectangle surrounding the outer circumference of the main conductor section 165Ba, and into the side where the lead conductor section 165Bb is located.

### Fifteenth Configuration Example

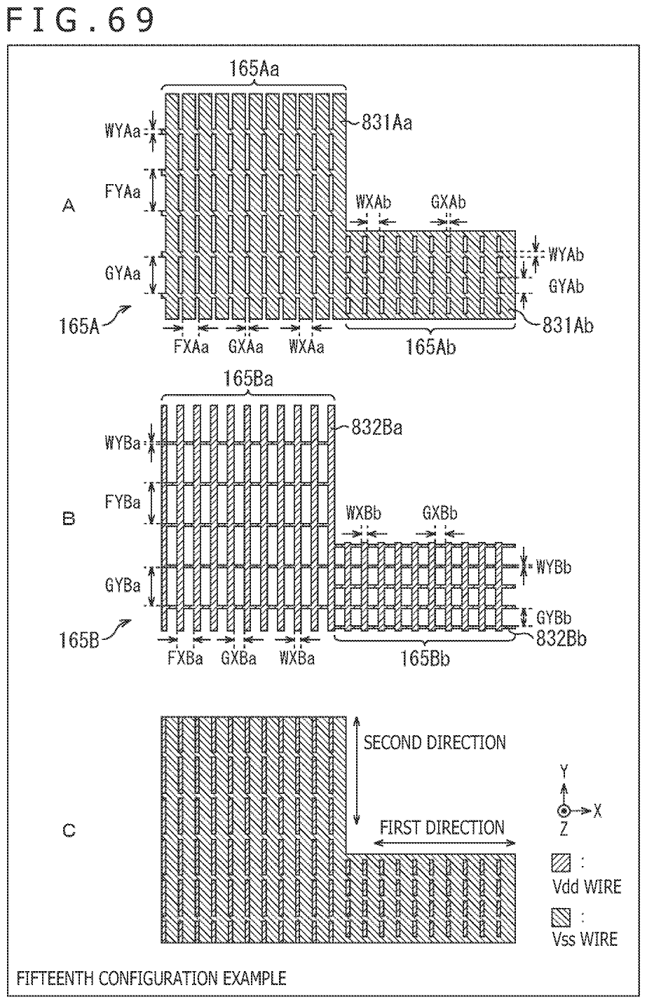

FIG. 69 depicts a fifteenth configuration example of the conductor layers A and B. Note that A in FIG. 69 depicts the conductor layer A, and B in FIG. 69 depicts the conductor layer B. In the coordinate system in FIG. 69, the X axis lies in the lateral direction, the Y axis lies in the longitudinal direction, and the Z axis lies in a direction perpendicular to the XY plane.

As depicted in A in FIG. 69, the conductor layer A in the fifteenth configuration example includes a mesh conductor 831Aa of the main conductor section 165Aa and a mesh conductor 831Ab of the lead conductor section 165Ab. The mesh conductor 831Aa and the mesh conductor 831Ab are wires (Vss wires) connected to GND or a negative power supply, for example.

The mesh conductor 831Aa of the main conductor section 165Aa is similar to the mesh conductor 821Aa of the main conductor section 165Aa in the fourteenth configuration example depicted in FIG. 65. On the other hand, the mesh conductor 831Ab of the lead conductor section 165Ab is different from the mesh conductor 821Ab of the lead conductor section 165Ab in the fourteenth configuration example depicted in FIG. 65.

Specifically, the Y-direction gap width GYAb of the mesh conductor 831Ab of the lead conductor section 165Ab is formed smaller than the Y-direction gap width GYAa of the mesh conductor 831Aa of the main conductor section 165Aa. In the fourteenth configuration example depicted in FIG. 65, the Y-direction gap width GYAb of the mesh conductor 821Ab of the lead conductor section 165Ab is the same as the Y-direction gap width GYAa of the mesh conductor 821Aa of the main conductor section 165Aa.

By forming the Y-direction gap width GYAb of the mesh conductor 831Ab of the lead conductor section 165Ab smaller than the Y-direction gap width GYAa of the mesh conductor 831Aa of the main conductor section 165Aa in this manner, the wire resistance of the mesh conductor 831Ab of the lead conductor section 165Ab, which is a current-concentrated portion, can be lowered, and so voltage drops can be ameliorated further. Note that while the gap width GYAb is smaller than the gap width GYAa in the example used for the explanation, this is not essential. For example, the gap width GXAb may be formed smaller than the gap width GXAa. Thereby, the wire resistance of the mesh conductor 831Ab can be lowered, and so voltage drops can be ameliorated further.

As depicted in B in FIG. 69, the conductor layer B in the fifteenth configuration example includes a mesh conductor 832Ba of the main conductor section 165Ba and a mesh conductor 832Bb of the lead conductor section 165Bb. The mesh conductor 832Ba and the mesh conductor 832Bb are wires (Vdd wires) connected to a positive power supply, for example.

The mesh conductor 832Ba of the main conductor section 165Ba is similar to the mesh conductor 822Ba of the main conductor section 165Ba in the fourteenth configuration example depicted in FIG. 65. On the other hand, the mesh conductor 832Bb of the lead conductor section 165Bb is different from the mesh conductor 822Bb of the lead conductor section 165Bb in the fourteenth configuration example depicted in FIG. 65.

Specifically, the Y-direction gap width GYBb of the mesh conductor 832Bb of the lead conductor section 165Bb is formed smaller than the Y-direction gap width GYBa of the mesh conductor 832Ba of the main conductor section 165Ba. In the fourteenth configuration example depicted in FIG. 65, the Y-direction gap width GYBb of the mesh conductor 822Bb of the lead conductor section 165Bb is the same as the second-direction gap width GYBa of the mesh conductor 822Ba of the main conductor section 165Ba.

By forming the Y-direction gap width GYBb of the mesh conductor 832Bb of the lead conductor section 165Bb smaller than the Y-direction gap width GYBa of the mesh conductor 832Ba of the main conductor section 165Ba in this manner, the wire resistance of the mesh conductor 832Bb of the lead conductor section 165Bb, which is a current-concentrated portion, can be lowered, and so voltage drops can be ameliorated further. Note that while the gap width GYBb is smaller than the gap width GYBa in the example used for the explanation, this is not essential. For example, the gap width GXBb may be formed smaller than the gap width GXBa. Thereby, the wire resistance of the mesh conductor 832Bb can be lowered, and so voltage drops can be ameliorated further.

In addition, in the overlapping state of the conductor layer A and the conductor layer B as depicted in C in FIG. 69, at least one of the conductor layer A and the conductor layer B covers an active element group 167. That is, the main conductor section 165Aa of the wiring layer 165A and the main conductor section 165Ba of the wiring layer 165B form a light-blocking structure, and the lead conductor section 165Ab of the wiring layer 165A and the lead conductor section 165Bb of the wiring layer 165B form a light-blocking structure. Thereby, hot carrier light emissions from the active element group 167 can be blocked in the fifteenth configuration example also.

### First Modification Example of Fifteenth Configuration Example

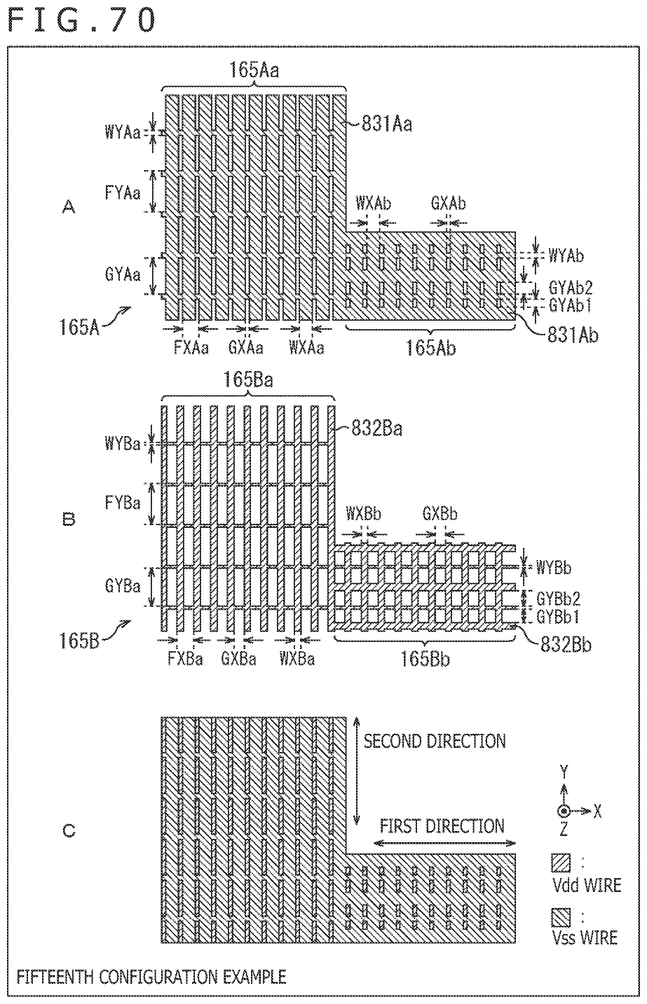

FIG. 70 depicts a first modification example of the fifteenth configuration example. Note that A in FIG. 70 depicts the conductor layer A, and B in FIG. 70 depicts the conductor layer B. C in FIG. 70 depicts a state of the conductor layers A and B depicted in A and B in FIG. 70, respectively, as seen from the side where the conductor layer A is located. In the coordinate system in FIG. 70, the X axis lies in the lateral direction, the Y axis lies in the longitudinal direction, and the Z axis lies in a direction perpendicular to the XY plane.

The first modification example of the fifteenth configuration example is different from the fifteenth configuration example depicted in FIG. 69 in that the Y-direction gap width GYAb of the lead conductor section 165Ab of the wiring layer 165A is not an entirely even width. Specifically, as depicted in A in FIG. 70, the mesh conductor 831Ab of the lead conductor section 165Ab of the wiring layer 165A has two types of gap width GYAb, a smaller gap width GYAb1 and a larger gap width GYAb2.

In addition, the first modification example of the fifteenth configuration example is different from the fifteenth configuration example depicted in FIG. 69 in that the Y-direction gap width GYBb of the lead conductor section 165Bb of the wiring layer 165B is not an entirely even width. Specifically, as depicted in B in FIG. 70, the mesh conductor 832Bb of the lead conductor section 165Bb of the wiring layer 165B has two types of gap width GYBb, a smaller gap width GYBb1 and a larger gap width GYBb2.

In the first modification example of the fifteenth configuration example also, in the overlapping state of the conductor layer A and the conductor layer B as depicted in C in FIG. 70, the lead conductor section 165Ab of the wiring layer 165A and the lead conductor section 165Bb of the wiring layer 165B form a light-blocking structure.

### Second Modification Example of Fifteenth Configuration Example

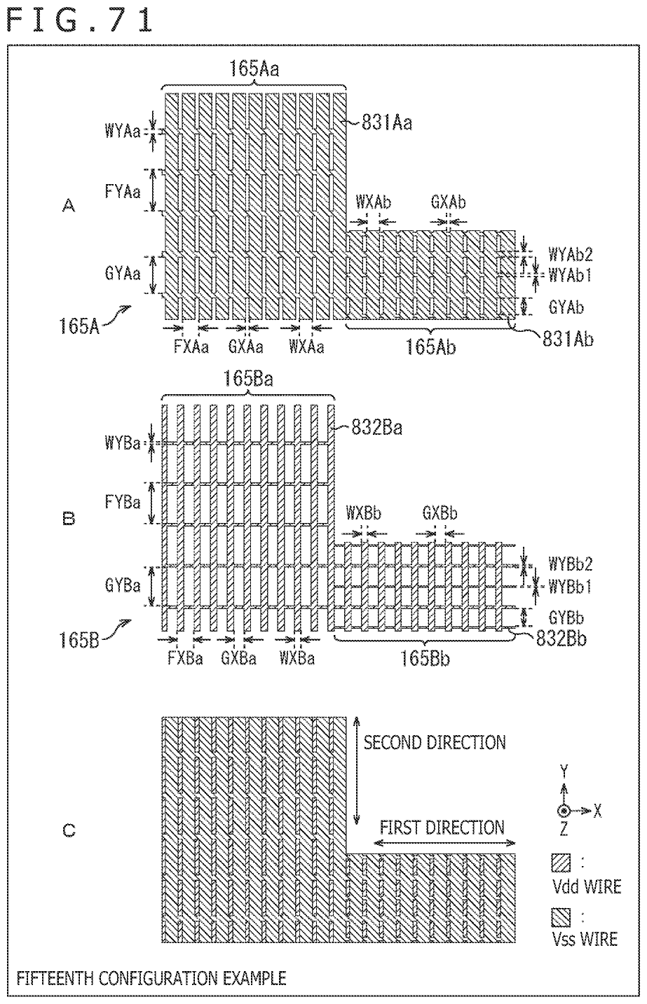

FIG. 71 depicts a second modification example of the fifteenth configuration example. Note that A in FIG. 71 depicts the conductor layer A, and B in FIG. 71 depicts the conductor layer B. C in FIG. 71 depicts a state of the conductor layers A and B depicted in A and B in FIG. 71, respectively, as seen from the side where the conductor layer A is located. In the coordinate system in FIG. 71, the X axis lies in the lateral direction, the Y axis lies in the longitudinal direction, and the Z axis lies in a direction perpendicular to the XY plane.

The second modification example of the fifteenth configuration example is different from the fifteenth configuration example depicted in FIG. 69 in that the Y-direction conductor width WYAb of the lead conductor section 165Ab of the wiring layer 165A is not an entirely even width. Specifically, as depicted in A in FIG. 71, the mesh conductor 831Ab of the lead conductor section 165Ab of the wiring layer 165A has two types of conductor width WYAb, a smaller conductor width WYAb1 and a larger conductor width WYAb2.

In addition, the second modification example of the fifteenth configuration example is different from the fifteenth configuration example depicted in FIG. 69 in that the Y-direction conductor width WYBb of the lead conductor section 165Bb of the wiring layer 165B is not an entirely even width. Specifically, as depicted in B in FIG. 71, the mesh conductor 832Bb of the lead conductor section 165Bb of the wiring layer 165B has two types of conductor width WYBb, a smaller conductor width WYBb1 and a larger conductor width WYBb2.

In the second modification example of the fifteenth configuration example also, in the overlapping state of the conductor layer A and the conductor layer B as depicted in C in FIG. 71, the lead conductor section 165Ab of the wiring layer 165A and the lead conductor section 165Bb of the wiring layer 165B form a light-blocking structure.

By making the gap width GYAb or conductor width WYAb of the lead conductor section 165Ab of the wiring layer 165A and the gap width GYBb or conductor width WYBb of the lead conductor section 165Bb of the wiring layer 165B non-uniform as in the first modification example and second modification example of the fifteenth configuration example, the degree of freedom of wiring can be increased. Although typically there are constraints related to the occupancy of conductor regions in each conductor layer, the wire resistances of the lead conductor sections 165Ab and 165Bb can be reduced as much as possible within the constraints of the occupancy by increasing the degree of freedom of wiring, and so voltage drops can be ameliorated further. Note that the gap width GYAb is not an entirely even width, the gap width GYBb is not an entirely even width, the conductor width WYAb is not entirely an even width, and the conductor width WYBb is not an entirely even width in the examples explained, but these are not essential. For example, in other possible configurations, the X-direction gap width GXAb, the X-direction gap width GXBb, the X-direction conductor width WXAb, or the X-direction conductor width WXBb may be made not an entirely even width. The degree of freedom of wiring can be increased in these cases also, and so voltage drops can be ameliorated further for a reason similar to that described above.

### Sixteenth Configuration Example

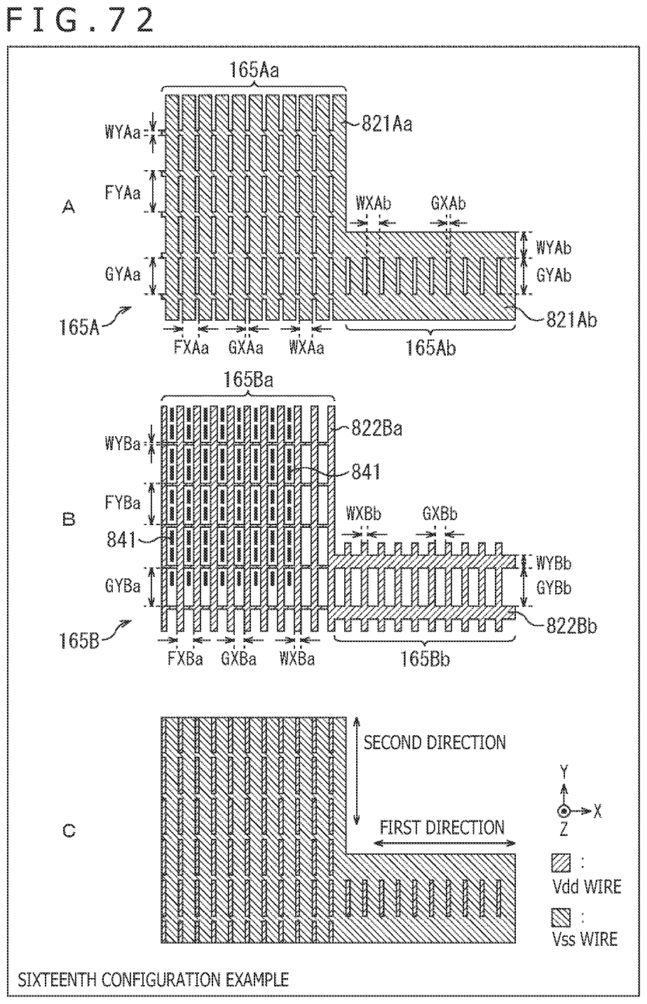

FIG. 72 depicts a sixteenth configuration example of the conductor layers A and B. Note that A in FIG. 72 depicts the conductor layer A, and B in FIG. 72 depicts the conductor layer B. In the coordinate system in FIG. 72, the X axis lies in the lateral direction, the Y axis lies in the longitudinal direction, and the Z axis lies in a direction perpendicular to the XY plane.

The conductor layer A in the sixteenth configuration example depicted in A in FIG. 72 is similar to the conductor layer A in the fourteenth configuration example depicted in FIG. 65, and so an explanation thereof is omitted.

The conductor layer B in the sixteenth configuration example depicted in B in FIG. 72 has a configuration in which relay conductors 841 are further added to the conductor layer B in the fourteenth configuration example depicted in FIG. 65. More specifically, the main conductor section 165Ba includes the mesh conductor 822Ba and multiple relay conductors 841, and the lead conductor section 165Bb includes the mesh conductor 822Bb similar to that in the fourteenth configuration example.

In the main conductor section 165Ba, the relay conductors 841 are arranged in non-conductor oblong rectangular gap regions in the mesh conductor 822Ba that are long in the Y direction. The relay conductors 841 are electrically insulated from the mesh conductor 822Ba and, for example, are connected to a Vss wire connected with the mesh conductor 821Aa in the conductor layer A. One or more relay conductors 841 are arranged in a gap region of the mesh conductor 822Ba. B in FIG. 72 depicts an example in which two relay conductor 841 in total are arranged in two rows×one column in a gap region of the mesh conductor 822Ba.

In B in FIG. 72, the relay conductors 841 are arranged only in some gap regions of the mesh conductor 822Ba in the entire region of the main conductor section 165Ba.

However, the relay conductors 841 may be arranged in gap regions in the entire region of the main conductor section 165Ba. In addition, while relay conductors 841 are not arranged in gap regions of the mesh conductor 822Bb of the lead conductor section 165Bb in the conductor layer B in the sixteenth configuration example, the relay conductors 841 may be arranged also in gap regions of the mesh conductor 822Bb.

### First Modification Example of Sixteenth Configuration Example

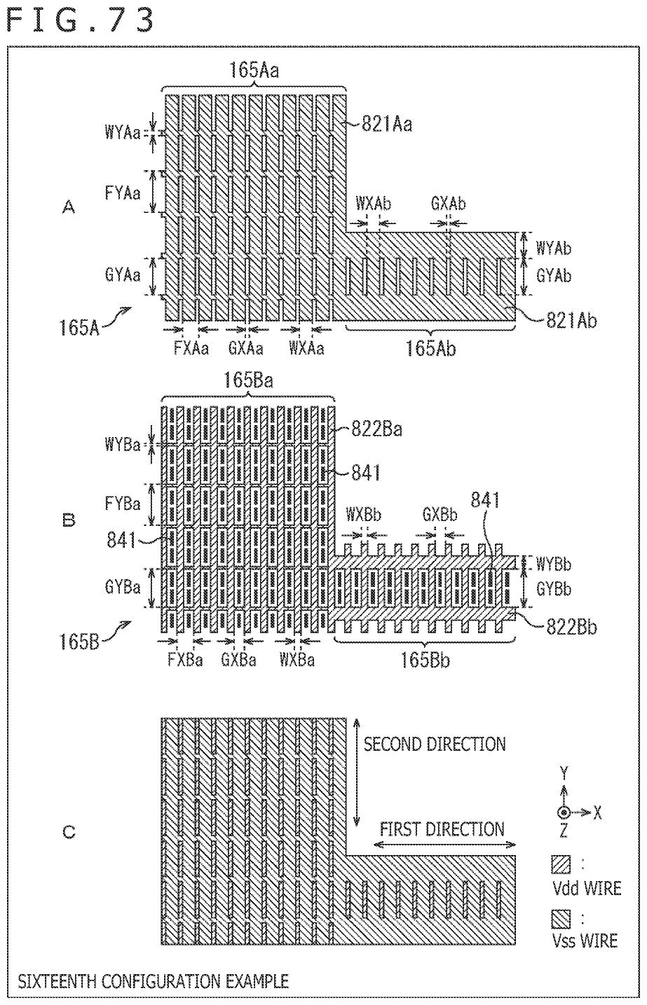

FIG. 73 depicts a first modification example of the sixteenth configuration example.

In the first modification example of the sixteenth configuration example in FIG. 73, the relay conductors 841 are arranged in gap regions in the entire region of the main conductor section 165Ba in the conductor layer B, and the relay conductors 841 are arranged also in gap regions of the mesh conductor 822Bb of the lead conductor section 165Bb. In other respects, the first modification example in FIG. 73 has a configuration similar to that in the sixteenth configuration example depicted in FIG. 72.

### Second Modification Example of Sixteenth Configuration Example

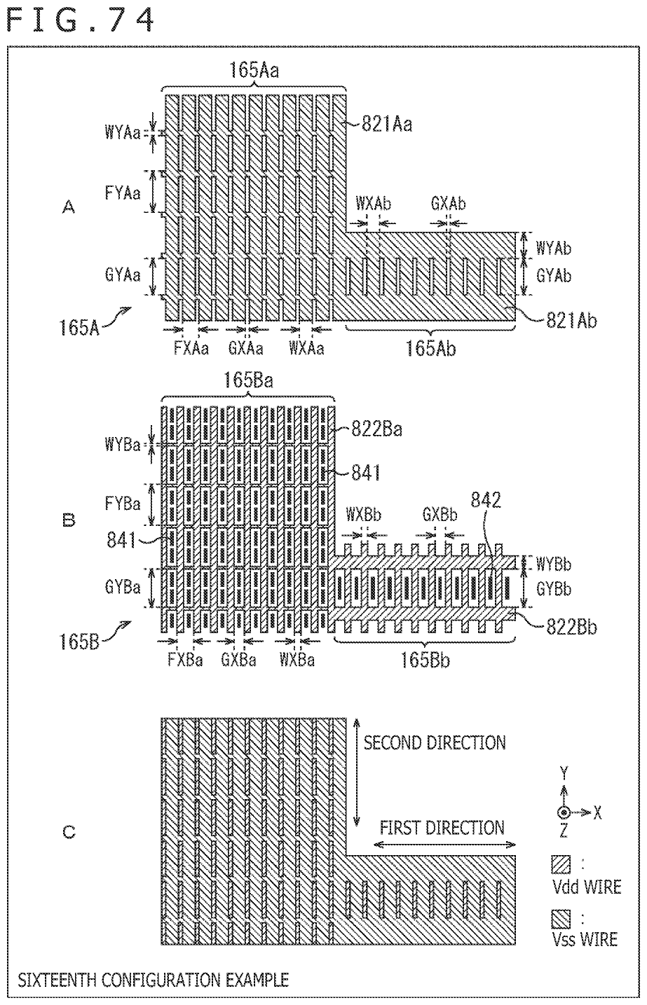

FIG. 74 depicts a second modification example of the sixteenth configuration example.

The second modification example of the sixteenth configuration example in FIG. 74 is similar to the first modification example in that the relay conductors 841 are arranged in gap regions in the entire region of the main conductor section 165Ba in the conductor layer B. On the other hand, the second modification example of the sixteenth configuration example is different from the first modification example in that relay conductors 842 different from the relay conductors 841 are arranged in gap regions of the mesh conductor 822Bb of the lead conductor section 165Bb. In other respects, the second modification example in FIG. 74 has a configuration similar to that in the sixteenth configuration example depicted in FIG. 72.

As in the second modification example, the numbers and shapes of the relay conductors 841 arranged in gap regions of the mesh conductor 822Ba of the main conductor section 165Ba in the conductor layer B and the relay conductors 842 arranged in gap regions of the mesh conductor 822Bb of the lead conductor section 165Bb may be different.

In a case in which the relay conductors 841 are not arranged in gap regions of the mesh conductor 822Bb of the lead conductor section 165Bb as in the conductor layer B in the sixteenth configuration example depicted in FIG. 72, the degree of freedom of wiring (the mesh conductor 822Bb) can be increased. Although typically there are constraints related to the occupancy of conductor regions in each conductor layer, the wire resistances of the lead conductor section 165Bb can be reduced as much as possible within the constraints of the occupancy by increasing the degree of freedom of wiring, and so voltage drops can be ameliorated further.

On the other hand, in a case in which the relay conductors 841, the relay conductors 842, or the like are arranged in gap regions of the mesh conductor 822Bb of the lead conductor section 165Bb, voltage drops can be ameliorated further in a case in which active elements such as MOS transistors or diodes are arranged in regions of the lead conductor section 165Bb or in an overlying or underlying layer at the same plane position as the lead conductor section 165Bb.

In addition, by making the numbers and shapes of the relay conductors 841 arranged in gap regions of the mesh conductor 822Ba of the main conductor section 165Ba in the conductor layer B and the relay conductors 842 arranged in gap regions of the mesh conductor 822Bb of the lead conductor section 165Bb different, it is possible to make full use of the occupancy of conductor regions of each conductor layer in the main conductor section 165Ba and the lead conductor section 165Bb, and so voltage drops can be ameliorated further by reducing wire resistances.

Note that the shapes of the relay conductors 841 can be any shapes, but desirably are circular or polygonal shapes which have symmetry like rotational symmetry, mirror symmetry, or the like. The relay conductors 841 can be arranged at the middle positions or any other positions in gap regions of the mesh conductor 822Ba. The relay conductors 841 may be connected to a conductor layer as a Vss wire other than the conductor layer A. The relay conductors 841 may be connected to a conductor layer as a Vss wire on a side closer to an active element group 167 than to the conductor layer B. The relay conductors 841 can be connected to a conductor layer other than the conductor layer A, or a conductor layer or the like on a side closer to an active element group 167 than to the conductor layer B, via conductor vias extending in the Z direction. This similarly applies also to the relay conductors 842.

While relay conductors 841 or 842 are arranged in gap regions of the mesh conductors 822Ba and 822Bb in the conductor layer B in the examples depicted in the sixteenth configuration example in FIG. 72 to FIG. 74, the same or different relay conductors may be arranged in gap regions of the mesh conductors 821Aa and 821Ab in the conductor layer A.

### Seventeenth Configuration Example

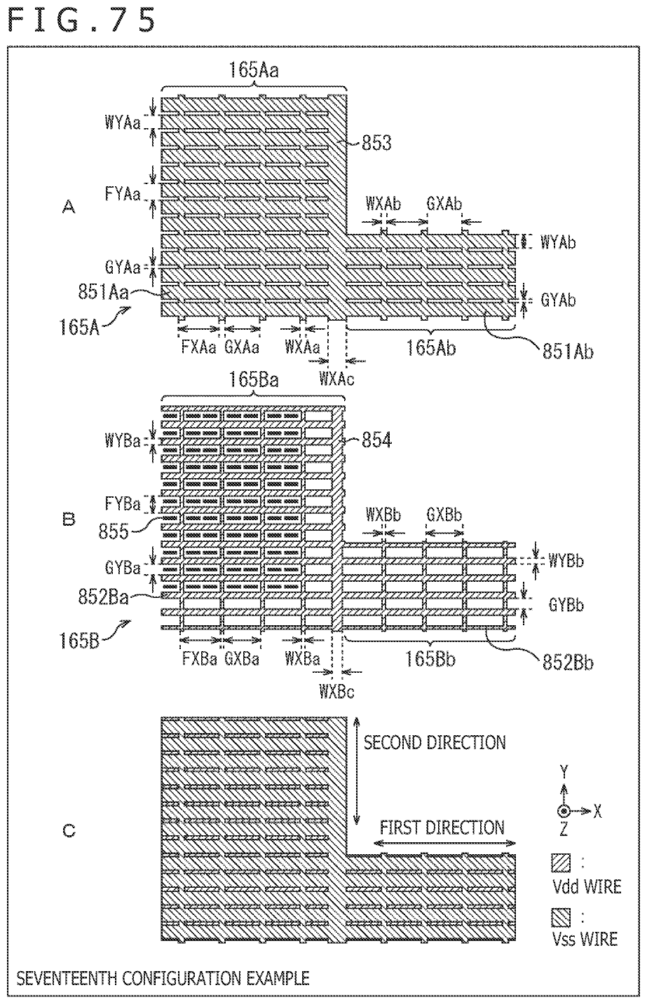

FIG. 75 depicts a seventeenth configuration example of the conductor layers A and B. Note that A in FIG. 75 depicts the conductor layer A, and B in FIG. 75 depicts the conductor layer B. In the coordinate system in FIG. 75, the X axis lies in the lateral direction, the Y axis lies in the longitudinal direction, and the Z axis lies in a direction perpendicular to the XY plane.

If the conductor layer A in the seventeenth configuration example depicted in A in FIG. 75 is compared with the conductor layer A in the fourteenth configuration example depicted in A in FIG. 65, the shape of a mesh conductor 851Aa of the main conductor section 165Aa and the shape of a mesh conductor 851Ab of the lead conductor section 165Ab are different.

In other words, while gap regions of the mesh conductor 821Aa in the fourteenth configuration example depicted in A in FIG. 65 have a longitudinally long oblong rectangular shape, gap regions of the mesh conductor 851Aa in the seventeenth configuration example depicted in A in FIG. 75 have a laterally long oblong rectangular shape. In addition, while gap regions of the mesh conductor 821Ab in A in FIG. 65 have a longitudinally long oblong rectangular shape, gap regions of the mesh conductor 851Ab in A in FIG. 75 have a laterally long oblong rectangular shape.

The mesh conductor 851Ab of the lead conductor section 165Ab in A in FIG. 75 and the mesh conductor 821Ab in the fourteenth configuration example in A in FIG. 65 have a commonality in that currents flow more easily in the X direction (first direction) toward the main conductor section 165Aa than in the Y direction (second direction) orthogonal to the X direction.

On the other hand, while the mesh conductor 851Aa of the main conductor section 165Aa in A in FIG. 75 has a shape in which currents flow more easily in the X direction than in the Y direction, the mesh conductor 821Aa of the main conductor section 165Aa in the fourteenth configuration example in A in FIG. 65 has a shape in which currents flow more easily in the Y direction.

That is, the conductor layer A in the seventeenth configuration example depicted in A in FIG. 75 is different from the conductor layer A in the fourteenth configuration example in A in FIG. 65 in terms of the direction in which currents flow more easily in the main conductor section 165Aa.

In addition, the main conductor section 165Aa in the conductor layer A in the seventeenth configuration example includes a reinforcement conductor 853 that reinforces the tendency of allowing currents to flow more easily in the Y direction than in the X direction. A conductor width WXAc of the reinforcement conductor 853 is desirably formed larger than one of or both the X-direction conductor width WXAa and Y-direction conductor width WYAa of the mesh conductor 851Aa. The conductor width WXAc of the reinforcement conductor 853 is formed larger than the smaller one of the X-direction conductor width WXAa and Y-direction conductor width WYAa of the mesh conductor 851Aa. Note that while the X-direction position where the reinforcement conductor 853 is formed is the position that is in the region of the main conductor section 165Aa and is closest to the lead conductor section 165Ab in the example in FIG. 75, it is sufficient if the position where the reinforcement conductor 853 is formed is a position near the junction section.

Because the mesh conductor 851Aa of the main conductor section 165Aa can be formed in a shape in which currents flow more easily in the X direction, the layout can be created with repetitions of a minimum basic pattern, and accordingly the degree of freedom of designing of the wiring layouts increases. In addition, voltage drops can be ameliorated further, depending on the arrangement of active elements such as MOS transistors or diodes.

Then, because the reinforcement conductor 853 that reinforces the tendency of allowing currents to flow more easily in the Y direction is provided, the currents are more easily diffused in the Y direction in the main conductor section 165Aa. Accordingly, the current concentration around the junction section between the main conductor section 165Aa and the lead conductor section 165Ab can be relaxed. In a case in which currents are concentrated locally, inductive noise worsens due to the concentrated portions, but because the current concentration can be relaxed, inductive noise can be ameliorated further.

If the conductor layer B in the seventeenth configuration example depicted in B in FIG. 75 is compared with the conductor layer B in the fourteenth configuration example depicted in B in FIG. 65, the shape of a mesh conductor 852Ba of the main conductor section 165Ba and the shape of a mesh conductor 852Bb of the lead conductor section 165Bb are different.

In other words, while gap regions of the mesh conductor 822Ba in the fourteenth configuration example depicted in B in FIG. 65 have a longitudinally long oblong rectangular shape, gap regions of the mesh conductor 852Ba in the seventeenth configuration example depicted in B in FIG. 75 have a laterally long oblong rectangular shape. In addition, while gap regions of the mesh conductor 822Bb in B in FIG. 65 have a longitudinally long oblong rectangular shape, gap regions of the mesh conductor 852Bb in B in FIG. 75 have a laterally long oblong rectangular shape.

The mesh conductor 852Bb of the lead conductor section 165Bb in B in FIG. 75 and the mesh conductor 822Bb in the fourteenth configuration example in B in FIG. 65 have a commonality in that currents flow more easily in the X direction (first direction) toward the main conductor section 165Ba than in the Y direction (second direction) orthogonal to the X direction.

On the other hand, while the mesh conductor 852Ba of the main conductor section 165Ba in B in FIG. 75 has a shape in which currents flow more easily in the X direction than in the Y direction, the mesh conductor 822Ba of the main conductor section 165Ba in the fourteenth configuration example in B in FIG. 65 has a shape in which currents flow more easily in the Y direction.

That is, the conductor layer B in the seventeenth configuration example depicted in B in FIG. 75 is different from the conductor layer B in the fourteenth configuration example in B in FIG. 65 in terms of the direction in which currents flow more easily in the main conductor section 165Ba.

In addition, the main conductor section 165Ba in the conductor layer B in the seventeenth configuration example includes a reinforcement conductor 854 that reinforces the tendency of allowing currents to flow more easily in the Y direction than in the X direction. A conductor width WXBc of the reinforcement conductor 854 is desirably formed larger than one of or both the X-direction conductor width WXBa and Y-direction conductor width WYBa of the mesh conductor 852Ba. The conductor width WXBc of the reinforcement conductor 854 is formed larger than the smaller one of the X-direction conductor width WXBa and Y-direction conductor width WYBa of the mesh conductor 852Ba. While the X-direction position where the reinforcement conductor 854 is formed is the position that is in the region of the main conductor section 165Ba and is closest to the lead conductor section 165Bb in the example in FIG. 75, it is sufficient if the position where the reinforcement conductor 854 is formed is a position near the junction section.

As depicted in C in FIG. 75, the reinforcement conductor 853 in the conductor layer A and the reinforcement conductor 854 in the conductor layer B are formed at overlapping positions. Because an active element group 167 is covered with at least one of the conductor layer A and the conductor layer B in the overlapping state of the conductor layer A and the conductor layer B, hot carrier light emissions from the active element group 167 can be blocked in the seventeenth configuration example also. Note that in a case in which it is not necessary to block hot carrier light emissions near the reinforcement conductor 853 or the reinforcement conductor 854, for example, the reinforcement conductor 853 and the reinforcement conductor 854 do not have to be formed at overlapping positions. In addition, depending on the current distribution in the main conductor section 165a, for example, at least one of the reinforcement conductor 853 and the reinforcement conductor 854 may not be provided.

Because the mesh conductor 852Ba of the main conductor section 165Ba can be formed in a shape in which currents flow more easily in the X direction, the layout can be created with repetitions of a minimum basic pattern, and accordingly the degree of freedom of designing of the wiring layouts increases. In addition, voltage drops can be ameliorated further, depending on the arrangement of active elements such as MOS transistors or diodes.

Then, because the reinforcement conductor 854 that reinforces the tendency of allowing currents to flow more easily in the Y direction is provided, the currents are more easily diffused in the second direction in the main conductor section 165Ba. Accordingly, the current concentration around the junction section between the main conductor section 165Ba and the lead conductor section 165Bb can be relaxed. In a case in which currents are concentrated locally, inductive noise worsens due to the concentrated portions, but because the current concentration can be relaxed, inductive noise can be ameliorated further.

Furthermore, the conductor layer B in the seventeenth configuration example depicted in B in FIG. 75 is different from the conductor layer B in the fourteenth configuration example in B in FIG. 65 in that relay conductors 855 are arranged in at least some gap regions of the mesh conductor 852Ba of the main conductor section 165Ba. The relay conductors 855 may or may not be arranged.

### First Modification Example of Seventeenth Configuration Example

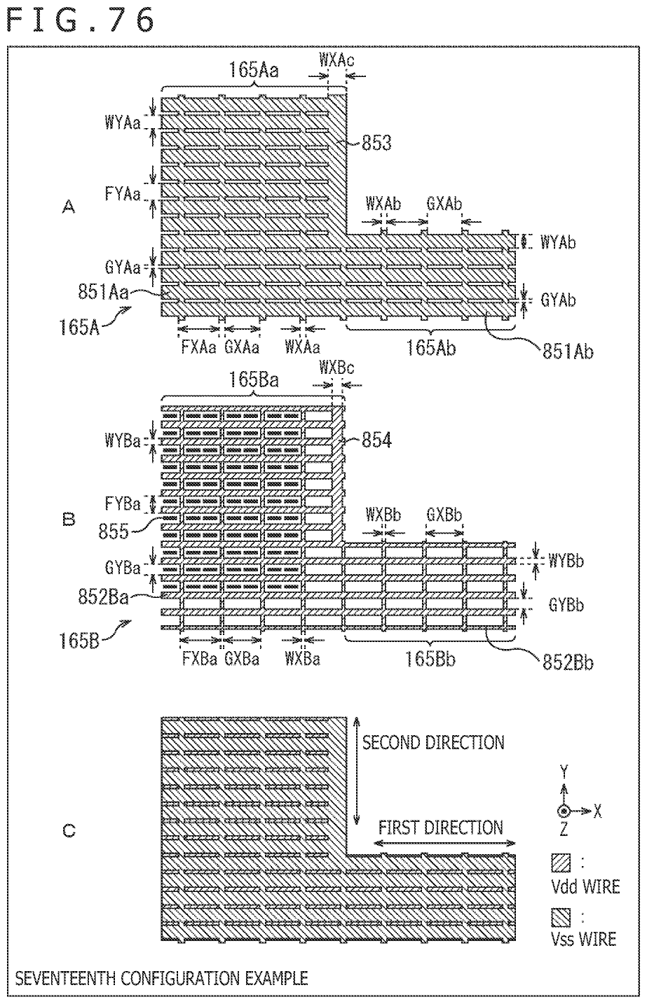

FIG. 76 depicts a first modification example of the seventeenth configuration example.

The conductor layer A depicted in A in FIG. 76 in the first modification example of the seventeenth configuration example is different from the conductor layer A in the seventeenth configuration example depicted in A in FIG. 75 in that the reinforcement conductor 853 is formed not over the entire Y-direction length but a partial Y-direction region of the main conductor section 165Aa. More specifically, in the first modification example in FIG. 76, the reinforcement conductor 853 in the conductor layer A is formed at Y-direction positions excluding the Y-direction position of the junction section. In other respects, the configuration of the conductor layer A in the first modification example is similar to that of the conductor layer A in the seventeenth configuration example depicted in A in FIG. 75.

Regarding the conductor layer B, similarly, the conductor layer B depicted in B in FIG. 76 is different from the conductor layer B in the seventeenth configuration example depicted in B in FIG. 75 in that the reinforcement conductor 854 is formed not over the entire Y-direction length but a partial Y-direction region of the main conductor section 165Ba. More specifically, in the first modification example in FIG. 76, the reinforcement conductor 854 in the conductor layer B is formed at Y-direction positions excluding the Y-direction position of the junction section. In other respects, the configuration of the conductor layer B in the first modification example is similar to that of the conductor layer B in the seventeenth configuration example depicted in A in FIG. 75.

### Second Modification Example of Seventeenth Configuration Example

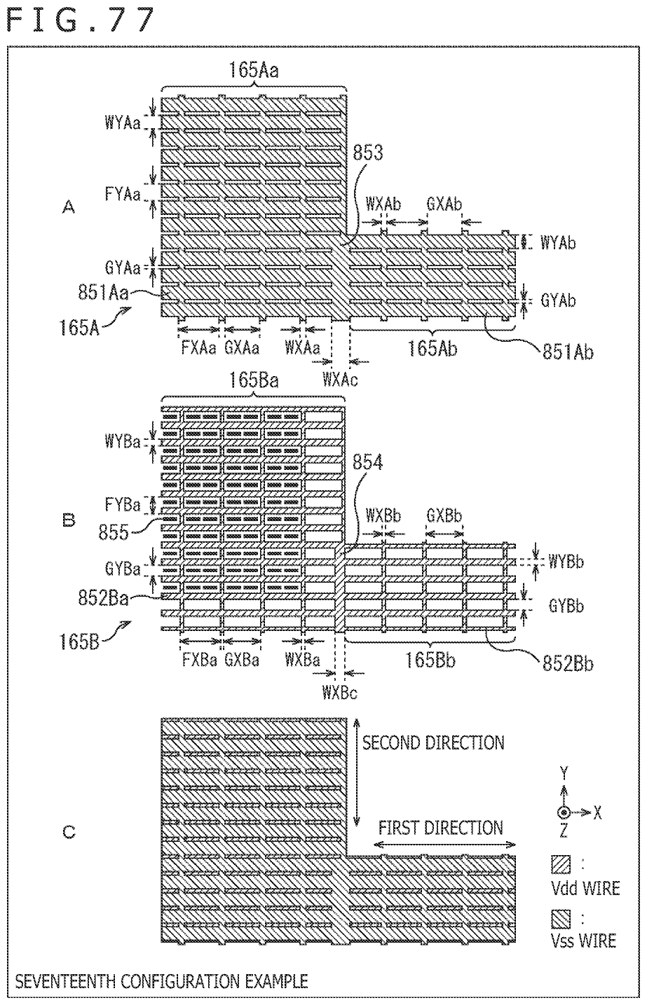

FIG. 77 depicts a second modification example of the seventeenth configuration example.

The conductor layer A depicted in A in FIG. 77 in the second modification example of the seventeenth configuration example is different from the conductor layer A in the seventeenth configuration example depicted in A in FIG. 75 in that the reinforcement conductor 853 is formed not over the entire Y-direction length but a partial Y-direction region of the main conductor section 165Aa. More specifically, in the second modification example in FIG. 77, the reinforcement conductor 853 in the conductor layer A is formed only at the Y-direction position of the junction section. In other respects, the configuration of the conductor layer A in the second modification example is similar to that of the conductor layer A in the seventeenth configuration example depicted in A in FIG. 75.

Regarding the conductor layer B, similarly, the conductor layer B depicted in B in FIG. 77 is different from the conductor layer B in the seventeenth configuration example depicted in B in FIG. 75 in that the reinforcement conductor 854 is formed not over the entire Y-direction length but a partial Y-direction region of the main conductor section 165Ba. More specifically, in the second modification example in FIG. 77, the reinforcement conductor 854 in the conductor layer B is formed only at the Y-direction position of the junction section. In other respects, the configuration of the conductor layer B in the second modification example is similar to that of the conductor layer B in the seventeenth configuration example depicted in A in FIG. 75.

As in the first modification example and second modification example of the seventeenth configuration example, the reinforcement conductor 853 in the conductor layer A and the reinforcement conductor 854 in the conductor layer B need not be formed over the entire Y-direction length of the main conductor section 165Aa necessarily but may be formed in a predetermined partial Y-direction region.

### Eighteenth Configuration Example

FIG. 78 depicts an eighteenth configuration example of the conductor layers A and B. Note that A in FIG. 78 depicts the conductor layer A, and B in FIG. 78 depicts the conductor layer B. C in FIG. 78 depicts a state of the conductor layers A and B depicted in A and B in FIG. 78, respectively, as seen from the side where the conductor layer A is located. In the coordinate system in FIG. 78, the X axis lies in the lateral direction, the Y axis lies in the longitudinal direction, and the Z axis lies in a direction perpendicular to the XY plane.

The eighteenth configuration example depicted in FIG. 78 has a configuration in which part of the seventeenth configuration example depicted in FIG. 75 is modified. Sections in FIG. 78 that have counterparts in FIG. 75 are given the same reference signs, and explanations of those sections are omitted as appropriate.

The conductor layer A in the eighteenth configuration example depicted in A in FIG. 78 and the seventeenth configuration example depicted in FIG. 75 have a commonality in that the conductor layer A includes the mesh conductor 851Aa with a shape in which currents flow more easily in the X direction and the reinforcement conductor 853 that reinforces the tendency of allowing currents to flow more easily in the Y direction.

On the other hand, the eighteenth configuration example is different from the seventeenth configuration example depicted in FIG. 75 in that the conductor layer A in the eighteenth configuration example further includes a reinforcement conductor 856 that reinforces the tendency of allowing currents to flow more easily in the X direction than in the Y direction. A conductor width WYAc of the reinforcement conductor 856 is desirably formed larger than one of or both the X-direction conductor width WXAa and Y-direction conductor width WYAa of the mesh conductor 851Aa. The conductor width WYAc of the reinforcement conductor 856 is formed larger than the smaller one of the X-direction conductor width WXAa and Y-direction conductor width WYAa of the mesh conductor 851Aa. In the region of the main conductor section 165Aa, multiple reinforcement conductors 856 may be arranged at predetermined Y-direction intervals, or one reinforcement conductor 856 may be arranged at a predetermined Y-direction position.

Because the reinforcement conductor 856 that reinforces the tendency of allowing currents to flow more easily in the X direction is provided, it becomes possible not only to allow currents to flow more easily in the Y direction due to the reinforcement conductor 853, but also to allow currents to flow more easily in the X direction, and the current concentration around the junction section between the main conductor section 165Aa and the lead conductor section 165Ab can be relaxed. In a case in which currents are concentrated locally, inductive noise worsens due to the concentrated portions, but because the current concentration can be relaxed, inductive noise can be ameliorated further.

The conductor layer B in the eighteenth configuration example depicted in B in FIG. 78 and the seventeenth configuration example depicted in FIG. 75 have a commonality in that the conductor layer B includes the mesh conductor 852Ba with a shape in which currents flow more easily in the X direction and the reinforcement conductor 854 that reinforces the tendency of allowing currents to flow more easily in the Y direction.

On the other hand, the eighteenth configuration example is different from the seventeenth configuration example depicted in FIG. 75 in that the conductor layer B in the eighteenth configuration example further includes a reinforcement conductor 857 that reinforces the tendency of allowing currents to flow more easily in the X direction than in the Y direction. A conductor width WYBc of the reinforcement conductor 857 is desirably formed larger than one of or both the X-direction conductor width WXBa and Y-direction conductor width WYBa of the mesh conductor 852Ba. The conductor width WYBc of the reinforcement conductor 857 is formed larger than the smaller one of the X-direction conductor width WXBa and Y-direction conductor width WYBa of the mesh conductor 852Ba. In the region of the main conductor section 165Ba, multiple reinforcement conductors 857 may be arranged at predetermined Y-direction intervals, or one reinforcement conductor 857 may be arranged at a predetermined Y-direction position.

As depicted in C in FIG. 78, the reinforcement conductor 856 in the conductor layer A and the reinforcement conductor 857 in the conductor layer B are formed at overlapping positions. Because an active element group 167 is covered with at least one of the conductor layer A and the conductor layer B in the overlapping state of the conductor layer A and the conductor layer B, hot carrier light emissions from the active element group 167 can be blocked in the eighteenth configuration example also. Note that in a case in which it is not necessary to block hot carrier light emissions near the reinforcement conductor 856 or the reinforcement conductor 857, for example, the reinforcement conductor 856 and the reinforcement conductor 857 do not have to be formed at overlapping positions. In addition, depending on the current distribution in the main conductor section 165a, for example, at least one of the reinforcement conductor 856 and the reinforcement conductor 857 may not be provided.

Because the reinforcement conductor 857 that reinforces the tendency of allowing currents to flow more easily in the X direction is provided, it becomes possible not only to allow currents to flow more easily in the Y direction due to the reinforcement conductor 854, but also to allow currents to flow more easily in the X direction, and the current concentration around the junction section between the main conductor section 165Ba and the lead conductor section 165Bb can be relaxed. In a case in which currents are concentrated locally, inductive noise worsens due to the concentrated portions, but because the current concentration can be relaxed, inductive noise can be ameliorated further.

The configuration depicted in the seventeenth configuration example in FIG. 75 includes the reinforcement conductors 853 and 854 that reinforce the tendency of allowing currents to flow more easily in the Y direction, and the configuration depicted in the eighteenth configuration example in FIG. 78 includes the reinforcement conductors 856 and 857 that reinforce the tendency of allowing currents to flow more easily in the X direction, in addition to the reinforcement conductors 853 and 854.

Although an illustration is omitted, in one possible configuration of a modification example of the seventeenth configuration example or eighteenth configuration example, the conductor layer A may not include the reinforcement conductor 853 but include the reinforcement conductor 856, and the conductor layer B may not include the reinforcement conductor 854 but include the reinforcement conductor 857. In other words, in one possible configuration, only the reinforcement conductors 856 and 857 may be included as reinforcement conductors.

Because the reinforcement conductor 856 that reinforces the tendency of allowing currents to flow more easily in the X direction is provided, even in a case in which the reinforcement conductor 853 is not included, it becomes possible to allow currents to diffuse more easily in the Y direction depending on the relation in terms of wire resistance, and the current concentration around the junction section between the main conductor section 165Aa and the lead conductor section 165Ab can be relaxed. In a case in which currents are concentrated locally, inductive noise worsens due to the concentrated portions, but because the current concentration can be relaxed, inductive noise can be ameliorated further.

Because the reinforcement conductor 857 that reinforces the tendency of allowing currents to flow more easily in the X direction is provided, even in a case in which the reinforcement conductor 854 is not included, it becomes possible to allow currents to diffuse more easily in the Y direction depending on the relation in terms of wire resistance, and the current concentration around the junction section between the main conductor section 165Ba and the lead conductor section 165Bb can be relaxed. In a case in which currents are concentrated locally, inductive noise worsens due to the concentrated portions, but because the current concentration can be relaxed, inductive noise can be ameliorated further.

### Nineteenth Configuration Example

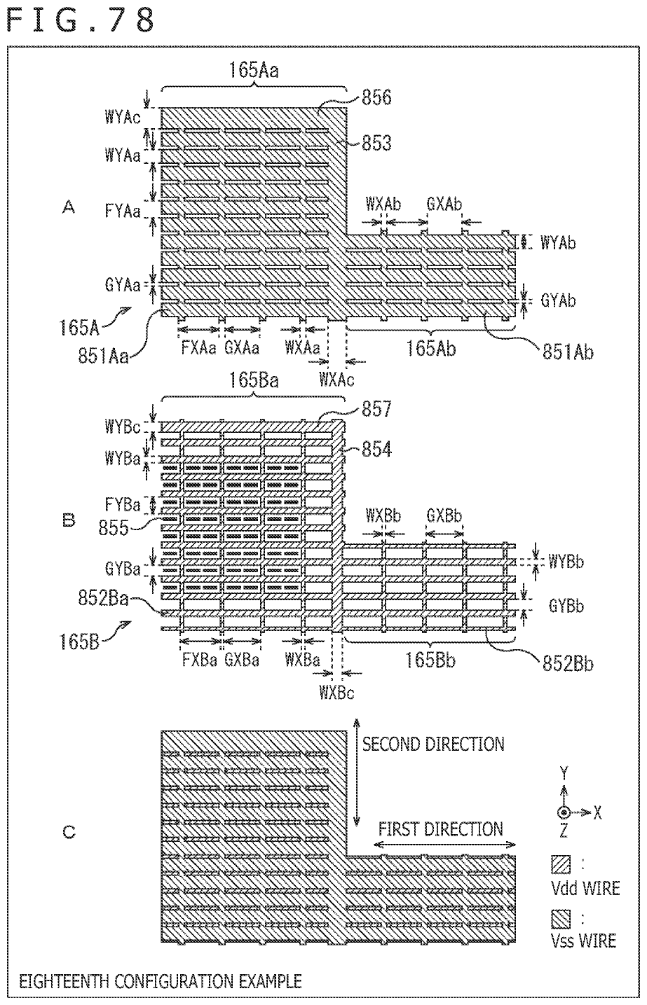

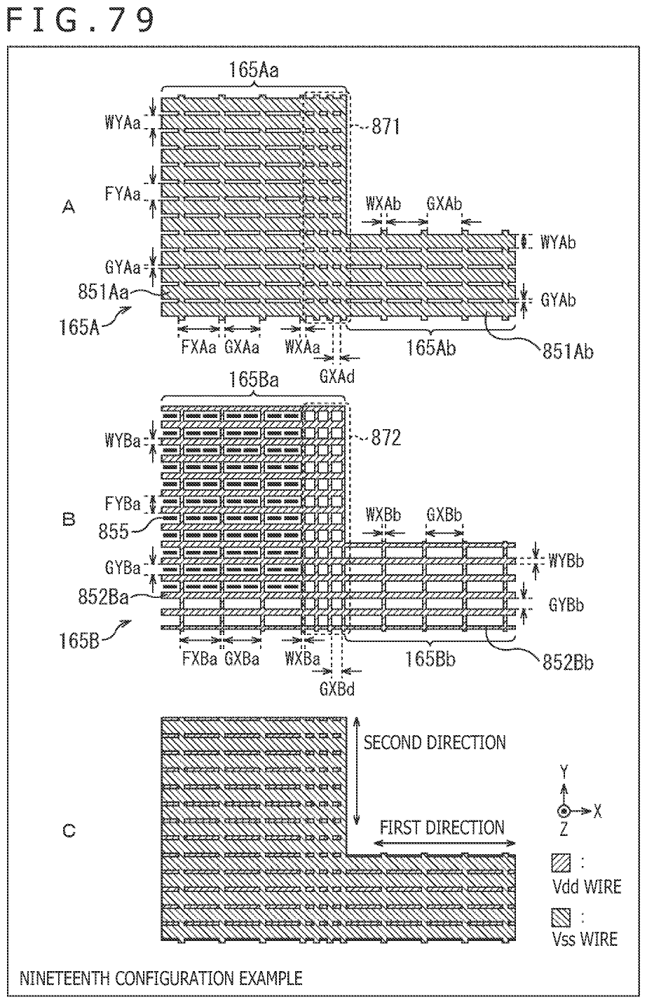

FIG. 79 depicts a nineteenth configuration example of the conductor layers A and B. Note that A in FIG. 79 depicts the conductor layer A, and B in FIG. 79 depicts the conductor layer B. C in FIG. 79 depicts a state of the conductor layers A and B depicted in A and B in FIG. 79, respectively, as seen from the side where the conductor layer A is located. In the coordinate system in FIG. 79, the X axis lies in the lateral direction, the Y axis lies in the longitudinal direction, and the Z axis lies in a direction perpendicular to the XY plane.

The nineteenth configuration example depicted in FIG. 79 has a configuration in which part of the seventeenth configuration example depicted in FIG. 75 is modified. Sections in FIG. 79 that have counterparts in FIG. 75 are given the same reference signs, and explanations of those sections are omitted as appropriate.

The conductor layer A in the nineteenth configuration example depicted in A in FIG. 79 is different in that the reinforcement conductor 853 in the seventeenth configuration example depicted in FIG. 75 is replaced with a reinforcement conductor 871, but has commonalities in other respects. The reinforcement conductor 871 includes multiple wires extending in the Y direction. The wires included in the reinforcement conductor 871 are arranged being separated from each other evenly by an X-direction gap width GXAd. The gap width GXAd is made smaller than the gap width GXAa of the mesh conductor 851Aa of the main conductor section 165Aa.

The conductor layer B in the nineteenth configuration example depicted in B in FIG. 79 is different in that the reinforcement conductor 854 in the seventeenth configuration example depicted in FIG. 75 is replaced with a reinforcement conductor 872, but has commonalities in other respects. The reinforcement conductor 872 includes multiple wires extending in the Y direction. The wires included in the reinforcement conductor 872 are arranged being separated from each other evenly by an X-direction gap width GXBd. The gap width GXBd is made smaller than the gap width GXBa of the mesh conductor 852Ba of the main conductor section 165Ba.

As depicted in C in FIG. 79, the reinforcement conductor 871 in the conductor layer A and the reinforcement conductor 872 in the conductor layer B are formed at overlapping positions. Because an active element group 167 is covered with at least one of the conductor layer A and the conductor layer B in the overlapping state of the conductor layer A and the conductor layer B, hot carrier light emissions from the active element group 167 can be blocked in the nineteenth configuration example also. Note that in a case in which it is not necessary to block hot carrier light emissions near the reinforcement conductor 871 or the reinforcement conductor 872, for example, the reinforcement conductor 871 and the reinforcement conductor 872 do not have to be formed at overlapping positions. In addition, depending on the current distribution in the main conductor section 165a, for example, at least one of the reinforcement conductor 871 and the reinforcement conductor 872 may not be provided.

### Modification Example of Nineteenth Configuration Example

FIG. 80 depicts a modification example of the nineteenth configuration example.

In the nineteenth configuration example depicted in FIG. 79, the multiple wires included in the reinforcement conductor 871 in the conductor layer A are arranged being separated from each other evenly by the X-direction gap width GXAd. The multiple wires included in the reinforcement conductor 872 in the conductor layer B also are arranged being separated from each other evenly by the X-direction gap width GXAd.

In contrast, in FIG. 80 depicting the modification example of the nineteenth configuration example, each pair of adjacent wires in the multiple wires included in the reinforcement conductor 871 in the conductor layer A are arranged being separated from each other by a different gap width GXAd. At least one of the gap widths GXAd is made smaller than the gap width GXAa of the mesh conductor 851Aa of the main conductor section 165Aa. Each pair of adjacent wires in the multiple wires included in the reinforcement conductor 872 in the conductor layer B are arranged being separated from each other by a different gap width GXBd. At least one of the gap widths GXBd is made smaller than the gap width GXBa of the mesh conductor 852Ba of the main conductor section 165Ba.

Note that while the multiple gap widths GXAd and gap widths GXBd are formed to become gradually shorter from the left side in the example in FIG. 80, this is not essential. The multiple gap widths GXAd and gap widths GXBd may be formed to become gradually shorter from the right side or may be random widths.

Except for that the gap widths GXAd and GXBd are not even widths but are modulated as mentioned above, the modification example of the nineteenth configuration example in FIG. 80 is similar to the nineteenth configuration example depicted in FIG. 79.

As in the nineteenth configuration example and the modification example thereof depicted in FIG. 79 and FIG. 80, the reinforcement conductor 871 in the conductor layer A and the reinforcement conductor 872 in the conductor layer B can include multiple wires that are arranged with the predetermined gap width GXAd or GXBd.

Because the reinforcement conductors 871 and 872 that reinforce the tendency of allowing currents to flow more easily in the Y direction are provided, currents are diffused more easily in the Y direction, and so the current concentration around the junction section can be relaxed. In a case in which currents are concentrated locally, inductive noise worsens due to the concentrated portions, but because the current concentration can be relaxed, inductive noise can be ameliorated further. While the configurations depicted in the nineteenth configuration example and the modification example thereof depicted in FIG. 79 and FIG. 80 include the reinforcement conductors 871 and 872 that at least include gap widths smaller than the X-direction gap width GXAa or gap width GXBa and reinforce the tendency of allowing currents to flow more easily in the Y direction, these are not essential. For example, although an illustration is omitted, a reinforcement conductor that at least includes a gap width smaller than the Y-direction gap width GYAa or gap width GYBa and reinforces the tendency of allowing currents to flow more easily in the X direction similarly to the eighteenth configuration example in FIG. 78 may be included in one possible configuration. In addition, in one possible configuration, a reinforcement conductor that reinforces the tendency of allowing currents to flow more easily in the X direction may be included, a reinforcement conductor that reinforces the tendency of allowing currents to flow more easily in the Y direction may be included, or both a reinforcement conductor that reinforces the tendency of allowing currents to flow more easily in the X direction and a reinforcement conductor that reinforces the tendency of allowing currents to flow more easily in the Y direction may be included. In these cases also, the current concentration can be relaxed depending on the relation in terms of wire resistance, and so inductive noise can be ameliorated further.

### Twentieth Configuration Example

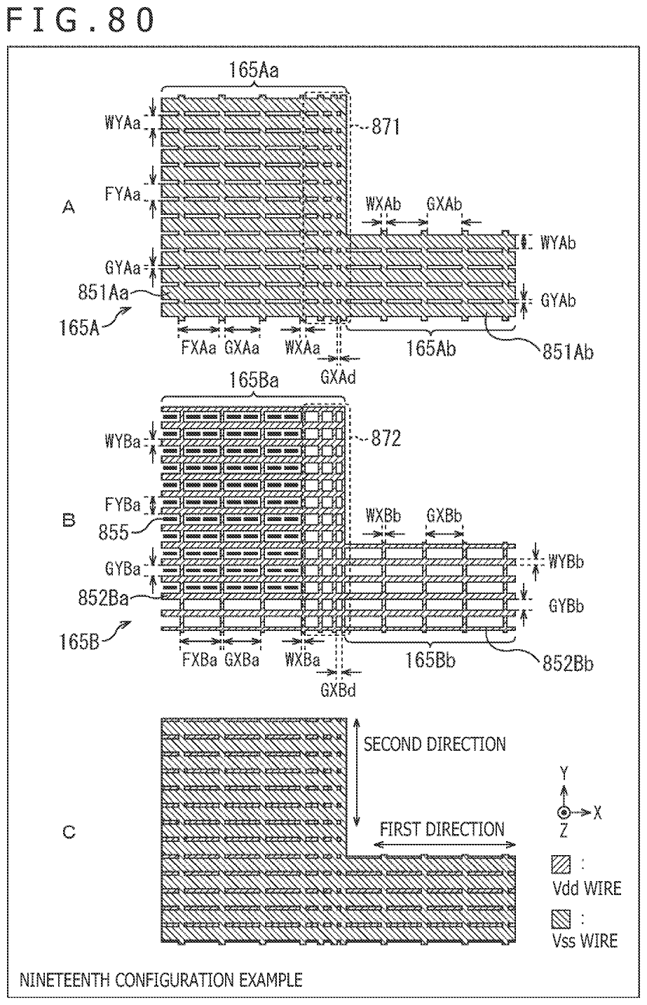

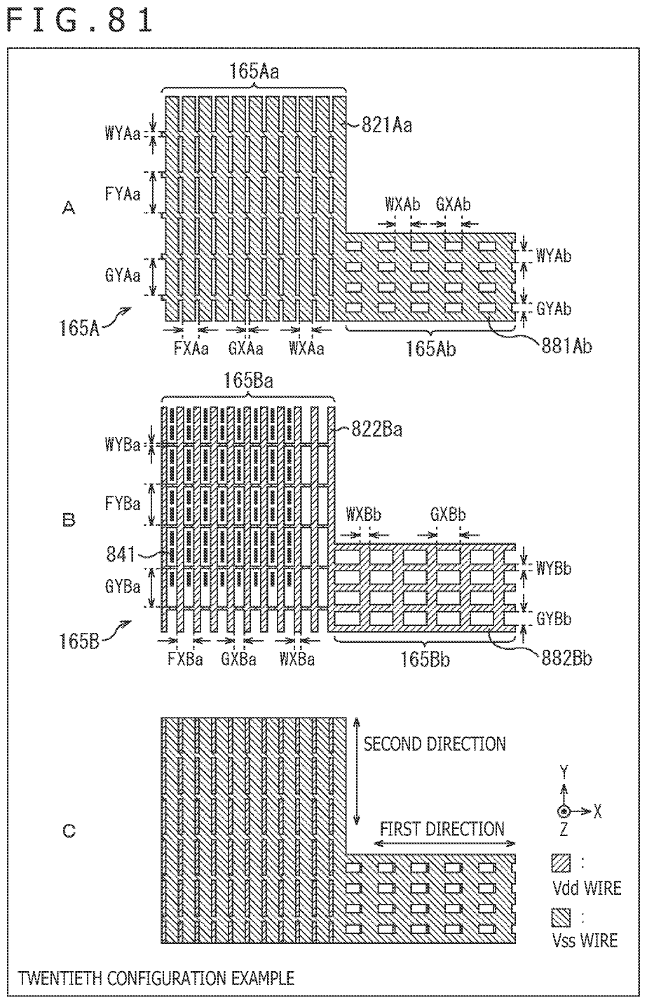

FIG. 81 depicts a twentieth configuration example of the conductor layers A and B. Note that A in FIG. 81 depicts the conductor layer A, and B in FIG. 81 depicts the conductor layer B. C in FIG. 81 depicts a state of the conductor layers A and B depicted in A and B in FIG. 81, respectively, as seen from the side where the conductor layer A is located. In the coordinate system in FIG. 81, the X axis lies in the lateral direction, the Y axis lies in the longitudinal direction, and the Z axis lies in a direction perpendicular to the XY plane.

The twentieth configuration example depicted in FIG. 81 has a configuration in which part of the sixteenth configuration example depicted in FIG. 72 is modified. Sections in FIG. 81 that have counterparts in FIG. 72 are given the same reference signs, and explanations of those sections are omitted as appropriate.

The conductor layer A in the twentieth configuration example depicted in A in FIG. 81 and the conductor layer A in the sixteenth configuration example depicted in FIG. 72 have a commonality in that the main conductor section 165Aa includes the mesh conductor 821Aa. On the other hand, the conductor layer A in the twentieth configuration example is different from the conductor layer A in the sixteenth configuration example depicted in FIG. 72 in that the lead conductor section 165Ab includes a mesh conductor 881Ab different from the mesh conductor 821Ab.

The conductor layer B in the twentieth configuration example depicted in B in FIG. 81 and the conductor layer B in the sixteenth configuration example depicted in FIG. 72 have a commonality in that the main conductor section 165Ba has the mesh conductor 822Ba, and the relay conductors 841 arranged in gap regions. The conductor layer B in the twentieth configuration example is different from the conductor layer B in the sixteenth configuration example depicted in FIG. 72 in that the lead conductor section 165Bb includes a mesh conductor 882Bb different from the mesh conductor 822Bb.

That is, the twentieth configuration example is different from the sixteenth configuration example depicted in FIG. 72 in terms of the shape of the repetition pattern of the lead conductor section 165b.

As depicted in C in FIG. 81, partial regions of the lead conductor section 165b are open regions in the overlapping state of the conductor layer A and the conductor layer B.

In this manner, it is not necessary to adopt a light-blocking structure in the entire regions of the conductor layer A and the conductor layer B, and light does not have to be blocked in regions where active elements such as MOS transistors or diodes are not arranged, for example.

While, in the configuration of the twentieth configuration example in FIG. 81, partial regions of the lead conductor section 165b in the conductor layer A and the conductor layer B are regions that do not block light, partial regions of the main conductor section 165a in the conductor layer A and the conductor layer B may be regions that do not block light, in one possible configuration. By not adopting a light-blocking structure for regions where it is not necessary to block light, the degree of freedom of designing of the wiring layouts increases further. Accordingly, wiring patterns that ameliorate inductive noise further and also ameliorate voltage drops further can be adopted.

### Twenty-First Configuration Example

In the examples in the fourteenth to twentieth configuration examples mentioned above, both of the conductor layers of the main conductor section 165a and the lead conductor section 165b connected therewith include mesh conductors.

However, the conductor layers of the lead conductor section 165b are not limited to mesh conductor, but may include planar conductors or linear conductors similarly to the main conductor section 165a.

In the following twenty-first to twenty-fourth configuration examples to be explained, the conductor layer of the lead conductor section 165b is formed with a planar conductor or linear conductors.

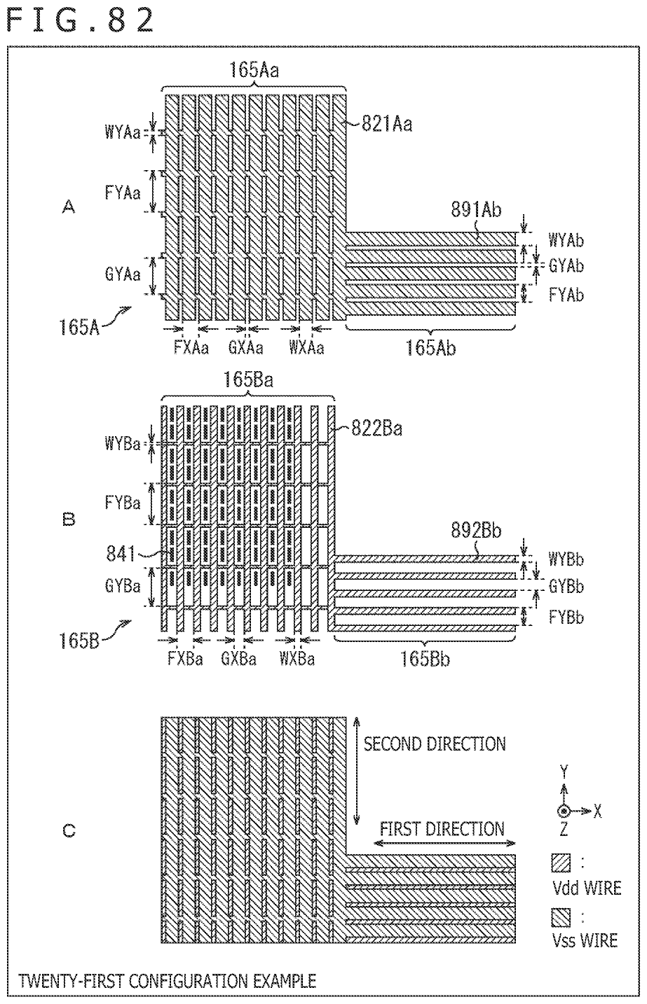

FIG. 82 depicts a twenty-first configuration example of the conductor layers A and B. Note that A in FIG. 82 depicts the conductor layer A, and B in FIG. 81 depicts the conductor layer B. C in FIG. 82 depicts a state of the conductor layers A and B depicted in A and B in FIG. 82, respectively, as seen from the side where the conductor layer A is located. In the coordinate system in FIG. 82, the X axis lies in the lateral direction, the Y axis lies in the longitudinal direction, and the Z axis lies in a direction perpendicular to the XY plane.

The twenty-first configuration example depicted in FIG. 82 has a configuration in which the conductor layer of the lead conductor section 165b in the sixteenth configuration example depicted in FIG. 72 is modified. Sections in FIG. 82 that have counterparts in FIG. 72 are given the same reference signs, and explanations of those sections are omitted as appropriate.

In the lead conductor section 165Ab in the conductor layer A in the twenty-first configuration example depicted in A in FIG. 82, instead of the mesh conductor 821Ab in the sixteenth configuration example, linear conductors 891Ab that are long in the X direction are arranged regularly at a Y-direction conductor pitch FYAb. The conductor pitch FYAb is equal to the sum of the Y-direction conductor width WYAb and the Y-direction gap width GYAb ((conductor pitch FYAb)=(Y-direction conductor width WYAb)+(Y-direction gap width GYAb)).

In the lead conductor section 165Bb in the conductor layer B in the twenty-first configuration example depicted in B in FIG. 82, instead of the mesh conductor 822Bb in the sixteenth configuration example, linear conductors 892Bb that are long in the X direction are arranged regularly at a Y-direction conductor pitch FYBb. The conductor pitch FYBb is equal to the sum of the Y-direction conductor width WYBb and the Y-direction gap width GYBb ((conductor pitch FYBb)=(Y-direction conductor width WYBb)+(Y-direction gap width GYBb)).

As depicted in C in FIG. 82, because an active element group 167 is covered with at least one of the conductor layer A and the conductor layer B in the overlapping state of the conductor layer A and the conductor layer B, hot carrier light emissions from the active element group 167 can be blocked in the twenty-first configuration example also.

### Twenty-Second Configuration Example

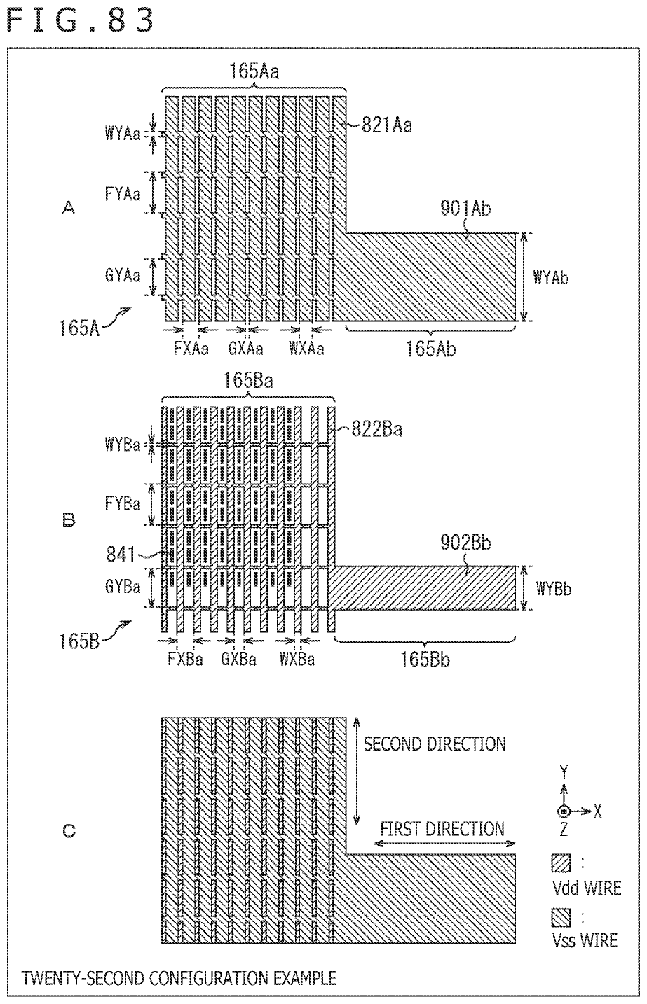

FIG. 83 depicts a twenty-second configuration example of the conductor layers A and B. Note that A in FIG. 83 depicts the conductor layer A, and B in FIG. 83 depicts the conductor layer B. C in FIG. 83 depicts a state of the conductor layers A and B depicted in A and B in FIG. 83, respectively, as seen from the side where the conductor layer A is located. In the coordinate system in FIG. 83, the X axis lies in the lateral direction, the Y axis lies in the longitudinal direction, and the Z axis lies in a direction perpendicular to the XY plane.

The twenty-second configuration example depicted in FIG. 83 has a configuration in which the conductor layer of the lead conductor section 165b in the sixteenth configuration example depicted in FIG. 72 is modified. Sections in FIG. 83 that have counterparts in FIG. 72 are given the same reference signs, and explanations of those sections are omitted as appropriate.

In the lead conductor section 165Ab in the conductor layer A in the twenty-second configuration example depicted in A in FIG. 83, a planar conductor 901Ab is arranged instead of the mesh conductor 821Ab in the sixteenth configuration example. The planar conductor 901Ab has the Y-direction conductor width WYAb.

In the lead conductor section 165Bb in the conductor layer B in the twenty-second configuration example depicted in B in FIG. 83, a planar conductor 902Bb is arranged instead of the mesh conductor 822Bb in the sixteenth configuration example. The planar conductor 902Bb has the Y-direction conductor width WYBb.

As depicted in C in FIG. 83, because an active element group 167 is covered with at least one of the conductor layer A and the conductor layer B in the overlapping state of the conductor layer A and the conductor layer B, hot carrier light emissions from the active element group 167 can be blocked in the twenty-second configuration example also.

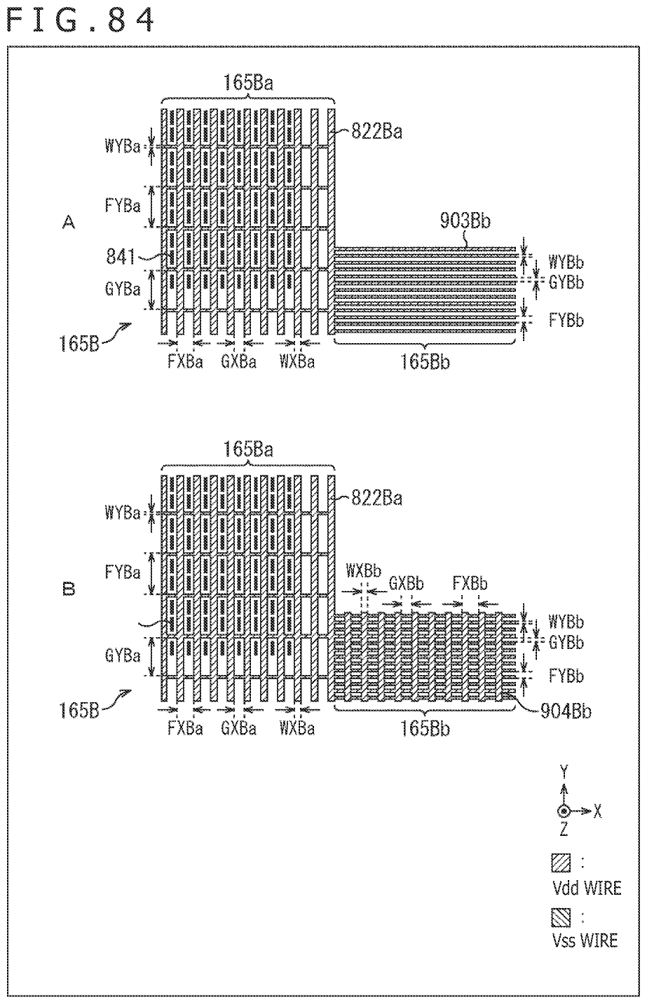

Note that, in the twenty-second configuration example, the conductor layer B in A or B in FIG. 84 may be adopted instead of the conductor layer B depicted in B in FIG. 83.

The conductor layer B depicted in A and B in FIG. 84 is different from the conductor layer B depicted in B in FIG. 83 only in terms of the lead conductor section 165b.

In the lead conductor section 165Bb in the conductor layer B in A in FIG. 84, instead of the planar conductor 901Ab depicted in B in FIG. 83, linear conductors 903Bb that are long in the X direction are arranged regularly at the Y-direction conductor pitch FYBb. Note that (conductor pitch FYBb)=(Y-direction conductor width WYBb)+(Y-direction gap width GYBb) is satisfied.

In the lead conductor section 165Bb in the conductor layer B in B in FIG. 84, a mesh conductor 904Bb is provided instead of the planar conductor 901Ab depicted in B in FIG. 83. Regarding the X direction, the mesh conductor 904Bb has the conductor width WXBb and the gap width GXBb and includes the same pattern regularly arranged at the conductor pitch FXBb. Regarding the Y direction, the mesh conductor 904Bb has the conductor width WYBb and the gap width GYBb and includes the same pattern regularly arranged at the conductor pitch FYBb. Accordingly, the mesh conductor 904Bb has a shape including a repetition pattern in which a predetermined basic pattern is arrayed repetitively at a conductor pitch in at least one of the X direction or the Y direction.

The plan view of the conductor layer B in A or B in FIG. 84 and the conductor layer A depicted in A in FIG. 83 in the overlapping state becomes similar to C in FIG. 83.

### Twenty-Third Configuration Example

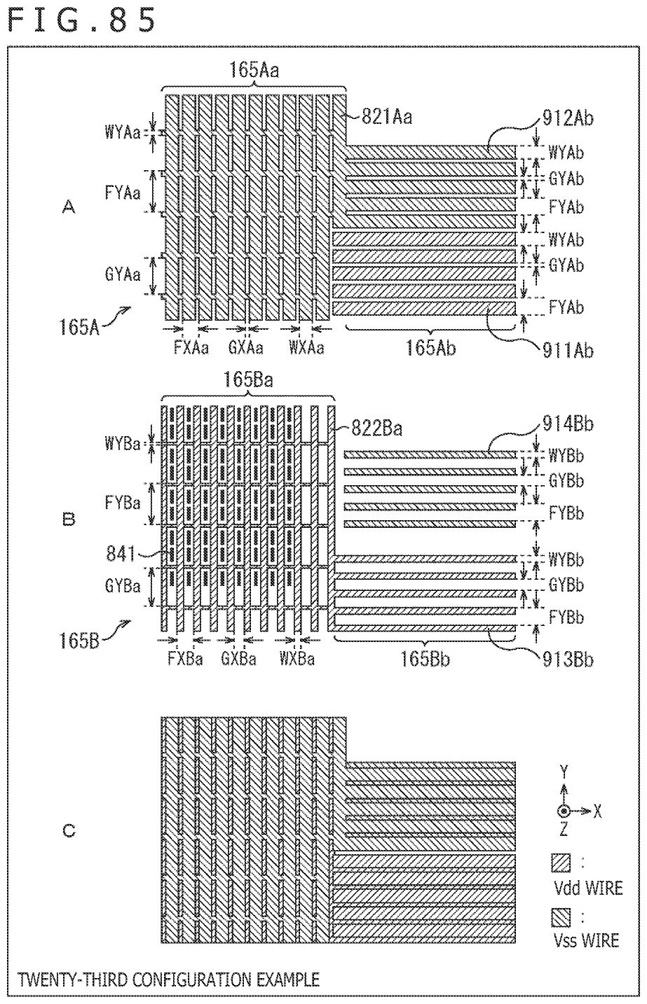

FIG. 85 depicts a twenty-third configuration example of the conductor layers A and B. Note that A in FIG. 85 depicts the conductor layer A, and B in FIG. 85 depicts the conductor layer B. C in FIG. 85 depicts a state of the conductor layers A and B depicted in A and B in FIG. 85, respectively, as seen from the side where the conductor layer A is located. In the coordinate system in FIG. 85, the X axis lies in the lateral direction, the Y axis lies in the longitudinal direction, and the Z axis lies in a direction perpendicular to the XY plane.

The twenty-third configuration example depicted in FIG. 85 has a configuration in which the conductor layer of the lead conductor section 165b in the sixteenth configuration example depicted in FIG. 72 is modified. Sections in FIG. 85 that have counterparts in FIG. 72 are given the same reference signs, and explanations of those sections are omitted as appropriate.

In the lead conductor section 165Ab in the conductor layer A in the twenty-third configuration example depicted in A in FIG. 85, instead of the mesh conductor 821Ab in the sixteenth configuration example, linear conductors 911Ab that are long in the X direction are arranged regularly at the Y-direction conductor pitch FYAb, and linear conductors 912Ab that are long in the X direction are arranged regularly at the Y-direction conductor pitch FYAb. The linear conductors 911Ab are wires (Vdd wires) connected to a positive power supply, for example. The linear conductors 912Ab are wires (Vss wires) connected to GND or a negative power supply, for example. The conductor pitch FYAb is equal to the sum of the Y-direction conductor width WYAb and the Y-direction gap width GYAb ((conductor pitch FYAb)=(conductor width WYAb)+(gap width GYAb)).

In the lead conductor section 165Bb in the conductor layer B in the twenty-third configuration example depicted in B in FIG. 85, instead of the mesh conductor 822Bb in the sixteenth configuration example, linear conductors 913Bb that are long in the X direction are arranged regularly at the Y-direction conductor pitch FYBb, and linear conductors 914Bb that are long in the X direction are arranged regularly at the Y-direction conductor pitch FYBb. The linear conductors 913Bb are wires (Vdd wires) connected to a positive power supply, for example. The linear conductors 914Bb are wires (Vss wires) connected to GND or a negative power supply, for example. The conductor pitch FYBb is equal to the sum of the Y-direction conductor width WYBb and the Y-direction gap width GYBb ((conductor pitch FYBb)=(conductor width WYBb)+(gap width GYBb)).

The linear conductors 912Ab of the lead conductor section 165Ab in the conductor layer A are electrically connected with the mesh conductor 821Aa of the main conductor section 165Aa and are electrically connected with the linear conductors 914Bb of the lead conductor section 165Bb in the conductor layer B via conductor vias extending in the Z direction, or the like, for example.

The linear conductors 913Bb of the lead conductor section 165Bb in the conductor layer B are electrically connected with the mesh conductor 822Ba of the main conductor section 165Ba and are electrically connected with the linear conductors 911Ab of the lead conductor section 165Ab in the conductor layer A via conductor vias extending in the Z direction, or the like, for example.

As depicted in C in FIG. 85, because an active element group 167 is covered with at least one of the conductor layer A and the conductor layer B in the overlapping state of the conductor layer A and the conductor layer B, hot carrier light emissions from the active element group 167 can be blocked in the twenty-first configuration example also.

While Vdd wires and Vss wires with different polarities are arranged such that they overlap in the same planar regions in the lead conductor section 165b in the fourteenth to twenty-second configuration examples mentioned above, Vdd wires and Vss wires with different polarities may be arranged being displaced from each other such that they are in different planar regions as in the twenty-third configuration example in FIG. 85, and both the conductor layer A and the conductor layer B may be used to transfer GND, a negative power supply, or a positive power supply.

Note that the linear conductors 911Ab of the lead conductor section 165Ab in the conductor layer A may not be electrically connected with the linear conductors 913Bb of the lead conductor section 165Bb in the conductor layer B, but may be dummy wires. The linear conductors 914Bb of the lead conductor section 165Bb in the conductor layer B may not be electrically connected with the linear conductors 912Ab of the lead conductor section 165Ab in the conductor layer A, but may be dummy wires.

Note that while one group of linear conductors 911Ab and one group of linear conductors 912Ab are arranged adjacent to each other in the one example depicted in FIG. 85, this is not essential. For example, multiple groups of linear conductors 911Ab and multiple groups of linear conductors 912Ab may be provided, and each group of linear conductors 911Ab and each group of linear conductors 912Ab may be arranged alternately.

In addition, while the linear conductors 911Ab including multiple linear conductors and the linear conductors 912Ab including multiple linear conductors are arranged adjacent to each other in the one example depicted in FIG. 85, this is not essential. For example, each linear conductor 911Ab and each linear conductor 912Ab may be arranged alternately.

In addition, while one group of linear conductors 913Bb and one group of linear conductors 914Bb are arranged adjacent to each other in the one example depicted in FIG. 85, this is not essential. For example, multiple groups of linear conductors 913Bb and multiple groups of linear conductors 914Bb may be provided, and each group of linear conductors 913Bb and each group of linear conductors 914Bb may be arranged alternately.

In addition, while the linear conductors 913Bb including multiple linear conductors and the linear conductors 914Bb including multiple linear conductors are arranged adjacent to each other in the one example depicted in FIG. 85, this is not essential. For example, each linear conductor 913Bb and each linear conductor 914Bb may be arranged alternately.

### Twenty-Fourth Configuration Example

FIG. 86 depicts a twenty-fourth configuration example of the conductor layers A and B. Note that A in FIG. 86 depicts the conductor layer A, and B in FIG. 86 depicts the conductor layer B. C in FIG. 86 depicts a state of the conductor layers A and B depicted in A and B in FIG. 86, respectively, as seen from the side where the conductor layer A is located. In the coordinate system in FIG. 86, the X axis lies in the lateral direction, the Y axis lies in the longitudinal direction, and the Z axis lies in a direction perpendicular to the XY plane.

The twenty-fourth configuration example depicted in FIG. 86 has a configuration in which the conductor layer of the lead conductor section 165b in the sixteenth configuration example depicted in FIG. 72 is modified. Sections in FIG. 86 that have counterparts in FIG. 72 are given the same reference signs, and explanations of those sections are omitted as appropriate.

In the lead conductor section 165Ab in the conductor layer A in the twenty-fourth configuration example depicted in A in FIG. 86, instead of the mesh conductor 821Ab in the sixteenth configuration example, linear conductors 921Ab that are long in the Y direction are arranged regularly at the X-direction conductor pitch FXAb, and linear conductors 922Ab that are long in the Y direction are arranged regularly at the X-direction conductor pitch FXAb. The linear conductors 921Ab are wires (Vdd wires) connected to a positive power supply, for example. The linear conductors 922Ab are wires (Vss wires) connected to GND or a negative power supply, for example. The conductor pitch FXAb is equal to the sum of the X-direction conductor width WXAb and the X-direction gap width GXAb ((conductor pitch FXAb)=(conductor width WXAb)+(gap width GXAb)).

In the lead conductor section 165Bb in the conductor layer B in the twenty-fourth configuration example depicted in B in FIG. 86, instead of the mesh conductor 822Bb in the sixteenth configuration example, linear conductors 923Bb that are long in the Y direction are arranged regularly at the X-direction conductor pitch FXBb, and linear conductors 924Bb that are long in the Y direction are arranged regularly at the X-direction conductor pitch FXBb. The linear conductors 923Bb are wires (Vdd wires) connected to a positive power supply, for example. The linear conductors 924Bb are wires (Vss wires) connected to GND or a negative power supply, for example. The conductor pitch FXBb is equal to the sum of the X-direction conductor width WXBb and the X-direction gap width GXBb ((conductor pitch FXBb)=(conductor width WXBb)+(gap width GXBb)).

The linear conductors 922Ab of the lead conductor section 165Ab in the conductor layer A are electrically connected with the linear conductors 924Bb of the lead conductor section 165Bb in the conductor layer B via conductor vias extending in the Z direction, or the like, for example, and electrically connected with the mesh conductor 821Aa of the main conductor section 165Aa via the linear conductors 924Bb.

That is, for example, GND or a negative power supply is transferred in the lead conductor section 165b alternately through the linear conductors 922Ab in the conductor layer A and the linear conductors 924Bb in the conductor layer B, and reaches the mesh conductor 821Aa of the main conductor section 165Aa.

The linear conductors 923Bb of the lead conductor section 165Bb in the conductor layer B are electrically connected with the linear conductors 921Ab of the lead conductor section 165Ab in the conductor layer A via conductor vias extending in the Z direction, or the like, for example, and are electrically connected with the mesh conductor 822Ba of the main conductor section 165Ba via the linear conductors 921Ab.

That is, for example, a positive power supply is transferred in the lead conductor section 165b alternately through the linear conductors 921Ab in the conductor layer A and the linear conductors 923Bb in the conductor layer B, and reaches the mesh conductor 822Ba of the main conductor section 165Ba.

As depicted in C in FIG. 86, because an active element group 167 is covered with at least one of the conductor layer A and the conductor layer B in the overlapping state of the conductor layer A and the conductor layer B, hot carrier light emissions from the active element group 167 can be blocked in the twenty-first configuration example also.

While Vdd wires and Vss wires with different polarities are arranged such that they overlap in the same planar regions in the lead conductor section 165b in the fourteenth to twenty-second configuration examples mentioned above, Vdd wires and Vss wires with different polarities may be arranged being displaced from each other such that they are in different planar regions as in the twenty-fourth configuration example in FIG. 86, and both the conductor layer A and the conductor layer B may be used to transfer GND, a negative power supply, or a positive power supply.

As in the twenty-first to twenty-fourth configuration examples depicted in FIG. 82 to FIG. 86 above, the conductor layer of the lead conductor section 165b is not limited to a mesh conductor, but may include a planar conductor or linear conductors. In addition, not only one layer of the conductor layers A and B, but the two layers, the conductor layers A and B, may be used.

With such a configuration, it is possible to achieve any of effects such as satisfying layout constraints of wires, further improving the degree of freedom of designing of the wiring layouts, further ameliorating inductive noise, further ameliorating voltage drops, and the like.

### Twenty-Fifth Configuration Example

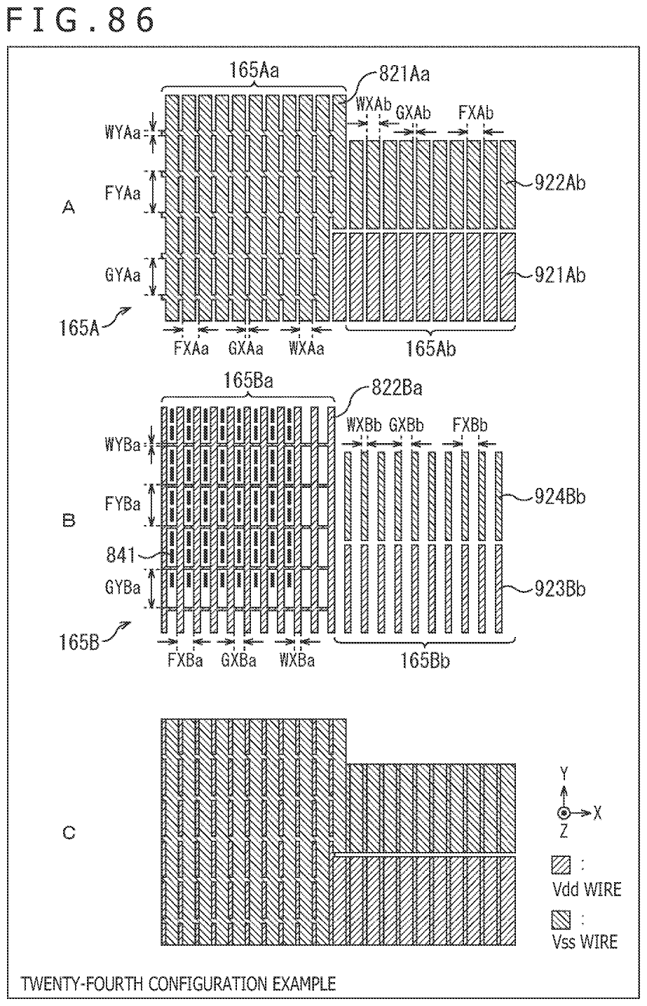

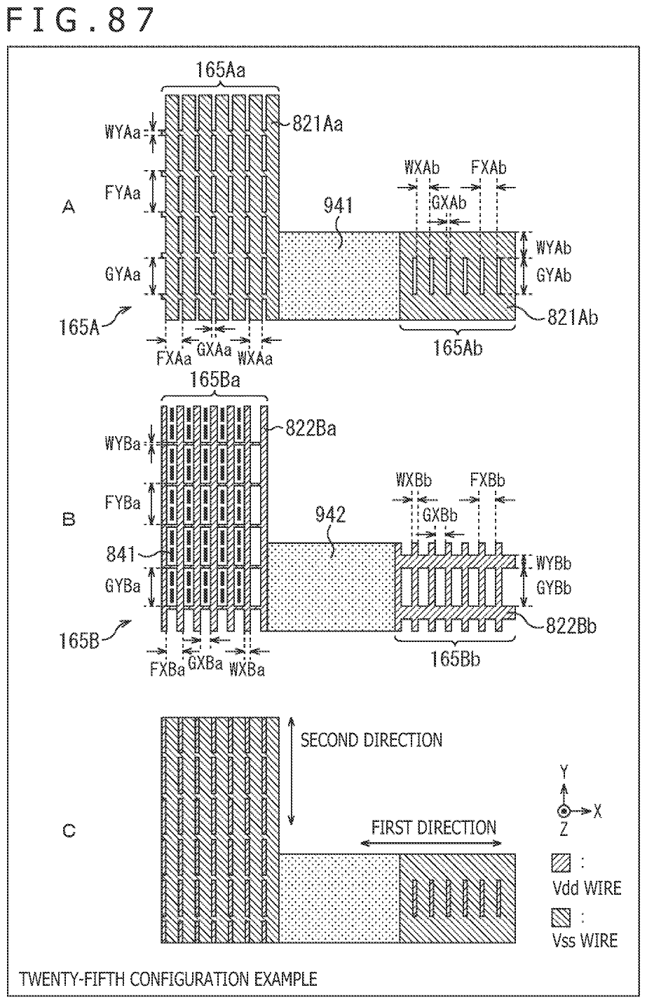

FIG. 87 depicts a twenty-fifth configuration example of the conductor layers A and B. Note that A in FIG. 87 depicts the conductor layer A, and B in FIG. 87 depicts the conductor layer B. C in FIG. 87 depicts a state of the conductor layers A and B depicted in A and B in FIG. 87, respectively, as seen from the side where the conductor layer A is located. In the coordinate system in FIG. 87, the X axis lies in the lateral direction, the Y axis lies in the longitudinal direction, and the Z axis lies in a direction perpendicular to the XY plane.

The twenty-fifth configuration example depicted in FIG. 87 has a configuration in which the sixteenth configuration example depicted in FIG. 72 has some additional elements. Sections in FIG. 86 that have counterparts in FIG. 72 are given the same reference signs, and explanations of those sections are omitted as appropriate.

In the conductor layer A in the twenty-fifth configuration example depicted in A in FIG. 87, a conductor 941 with a shape including, if desired, a repetition pattern that is different from the repetition pattern of the mesh conductor 821Aa of the main conductor section 165Aa and the repetition pattern of the mesh conductor 821Ab of the lead conductor section 165Ab in the sixteenth configuration example depicted in FIG. 72 is added between the mesh conductor 821Aa of the main conductor section 165Aa and the mesh conductor 821Ab of the lead conductor section 165Ab. Note that, in order to design the wiring layout efficiently, the conductor 941 desirably has a shape including a repetition pattern, but may have a shape not including a repetition pattern. Because the pattern of the conductor 941 can be of any shape, the conductor 941 is not specified particularly in A in FIG. 87, but the conductor 941 is represented by a plane. The conductor 941 is electrically connected with both the mesh conductor 821Aa and the mesh conductor 821Ab. In other words, the mesh conductor 821Aa of the main conductor section 165Aa and the mesh conductor 821Ab of the lead conductor section 165Ab are electrically connected via the conductor 941.

In the conductor layer B in the twenty-fifth configuration example depicted in B in FIG. 87, a conductor 942 with a shape including, if desired, a repetition pattern that is different from the repetition pattern of the mesh conductor 822Ba of the main conductor section 165Ba and the repetition pattern of the mesh conductor 822Bb of the lead conductor section 165Bb in the sixteenth configuration example depicted in FIG. 72 is added between the mesh conductor 822Ba of the main conductor section 165Ba and the mesh conductor 822Bb of the lead conductor section 165Bb. Note that, in order to design the wiring layout efficiently, the conductor 942 desirably has a shape including a repetition pattern, but may have a shape not including a repetition pattern. Because the pattern of the conductor 942 can be of any shape, the conductor 942 is not specified particularly in B in FIG. 87, but the conductor 942 is represented by a plane. The conductor 942 is electrically connected with both the mesh conductor 822Ba and the mesh conductor 822Bb. In other words, the mesh conductor 822Ba of the main conductor section 165Ba and the mesh conductor 822Bb of the lead conductor section 165Bb are electrically connected via the conductor 942.

According to the twenty-fifth configuration example, because the mesh conductor 821Aa of the main conductor section 165Aa and the mesh conductor 821Ab of the lead conductor section 165Ab are connected via the predetermined conductor 941 in the conductor layer A, the freedom of designing of the wiring layout can be improved further, and the degree of freedom near pads can be improved particularly.

In the conductor layer B also, because the mesh conductor 822Ba of the main conductor section 165Ba and the mesh conductor 822Bb of the lead conductor section 165Bb are connected via the predetermined conductor 942, the freedom of designing of the wiring layout can be improved further, and the degree of freedom near pads can be improved particularly.

### Twenty-Sixth Configuration Example

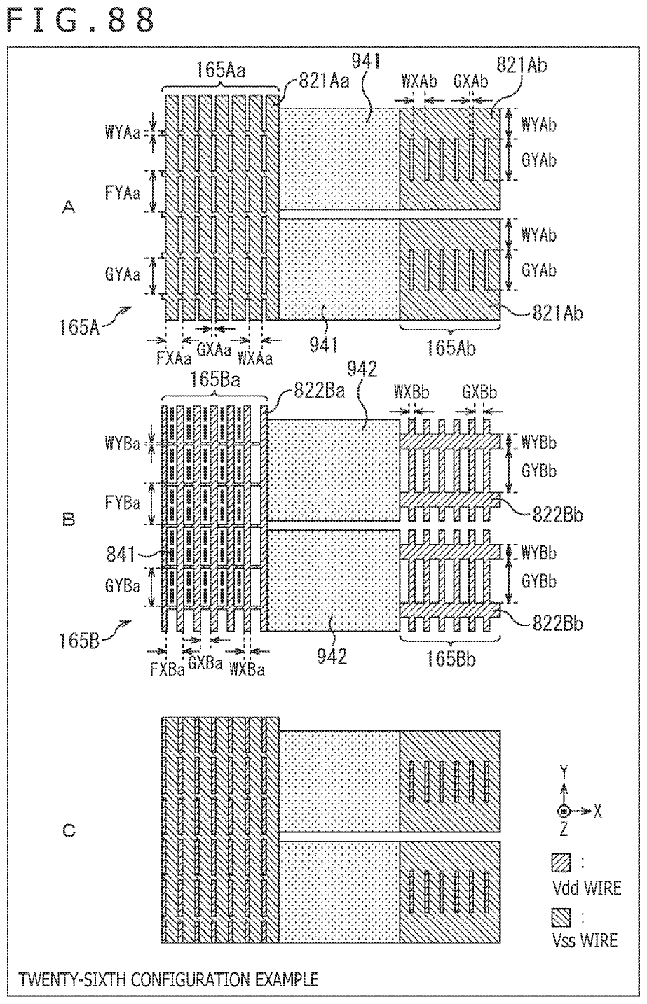

FIG. 88 depicts a twenty-sixth configuration example of the conductor layers A and B. Note that A in FIG. 88 depicts the conductor layer A, and B in FIG. 88 depicts the conductor layer B. C in FIG. 88 depicts a state of the conductor layers A and B depicted in A and B in FIG. 88, respectively, as seen from the side where the conductor layer A is located. In the coordinate system in FIG. 88, the X axis lies in the lateral direction, the Y axis lies in the longitudinal direction, and the Z axis lies in a direction perpendicular to the XY plane.

The twenty-sixth configuration example depicted in FIG. 88 has a configuration in which part of the twenty-fifth configuration example depicted in FIG. 87 is modified. Sections in FIG. 86 that have counterparts in FIG. 87 are given the same reference signs, and explanations of those sections are omitted as appropriate.

Regarding the main conductor section 165Aa, the conductor layer A in the twenty-sixth configuration example depicted in A in FIG. 88 includes the mesh conductor 821Aa similar to that in the twenty-fifth configuration example depicted in FIG. 87. In addition, regarding the lead conductor section 165Ab, the conductor layer A in the twenty-sixth configuration example includes multiple mesh conductors 821Ab and multiple conductors 941 similar to those in the twenty-fifth configuration example at a predetermined Y-direction interval. In other words, the conductor layer A in the twenty-sixth configuration example in A in FIG. 88 has a modified configuration in which multiple mesh conductors 821Ab and multiple conductors 941 of the lead conductor section 165Ab in the twenty-fifth configuration example depicted in FIG. 87 are provided at a predetermined Y-direction interval. Note that all of the multiple conductors 941 may be the same or may not be the same.

Regarding the main conductor section 165Ba, the conductor layer B in the twenty-sixth configuration example depicted in B in FIG. 88 includes the mesh conductor 822Ba similar to that in the twenty-fifth configuration example depicted in FIG. 87. In addition, regarding the lead conductor section 165Bb, the conductor layer B in the twenty-sixth configuration example includes multiple mesh conductors 822Bb and multiple conductors 942 similar to those in the twenty-fifth configuration example at a predetermined Y-direction interval. In other words, the conductor layer B in the twenty-sixth configuration example in B in FIG. 88 has a modified configuration in which multiple mesh conductors 822Bb and multiple conductors 942 of the lead conductor section 165Bb in the twenty-fifth configuration example depicted in FIG. 87 are provided at a predetermined Y-direction interval. Note that all of the multiple conductors 942 may be the same or may not be the same.

With such a configuration, it is possible to achieve any of effects such as satisfying layout constraints of wires, further improving the degree of freedom of designing of the wiring layouts, further ameliorating inductive noise, further ameliorating voltage drops, and the like.

### Twenty-Seventh Configuration Example

FIG. 89 depicts a twenty-seventh configuration example of the conductor layers A and B. Note that A in FIG. 89 depicts the conductor layer A, and B in FIG. 89 depicts the conductor layer B. C in FIG. 89 depicts a state of the conductor layers A and B depicted in A and B in FIG. 89, respectively, as seen from the side where the conductor layer A is located. In the coordinate system in FIG. 89, the X axis lies in the lateral direction, the Y axis lies in the longitudinal direction, and the Z axis lies in a direction perpendicular to the XY plane.

The twenty-seventh configuration example depicted in FIG. 89 has a configuration in which part of the twenty-sixth configuration example depicted in FIG. 88 is modified. Sections in FIG. 89 that have counterparts in FIG. 88 are given the same reference signs, and explanations of those sections are omitted as appropriate.

The main conductor section 165Aa in the conductor layer A in the twenty-seventh configuration example depicted in A in FIG. 89 includes the mesh conductor 821Aa similar to that in the twenty-sixth configuration example depicted in FIG. 88. The lead conductor section 165Ab in the conductor layer A in the twenty-seventh configuration example includes a mesh conductor 951Ab and a mesh conductor 952Ab. Both of the shapes of the mesh conductor 951Ab and the mesh conductor 952Ab include the X-direction conductor width WXAb and gap width GXAb, and the Y-direction conductor width WYAb and gap width GYAb. It should be noted however that the mesh conductor 952Ab is a wire (Vdd wire) connected to a positive power supply, for example, and the mesh conductor 951Ab is a wire (Vss wire) connected to GND or a negative power supply, for example.

A conductor 961 with a shape including, if desired, a repetition pattern that is different from the repetition pattern of the mesh conductor 821Aa of the main conductor section 165Aa and the repetition pattern of the mesh conductor 951Ab of the lead conductor section 165Ab is arranged between the mesh conductor 821Aa of the main conductor section 165Aa and the mesh conductor 951Ab of the lead conductor section 165Ab. A conductor 962 with a shape including, if desired, a repetition pattern that is different from the repetition pattern of the mesh conductor 821Aa of the main conductor section 165Aa and the repetition pattern of the mesh conductor 952Ab of the lead conductor section 165Ab is arranged between the mesh conductor 821Aa of the main conductor section 165Aa and the mesh conductor 952Ab of the lead conductor section 165Ab. Note that, in order to design the wiring layout efficiently, the conductor 961 or 962 desirably has a shape including a repetition pattern, but may have a shape not including a repetition pattern. Because the patterns of the conductors 961 and 962 can be of any shapes, the conductors 961 and 962 are not specified particularly in A in FIG. 89, but the conductors 961 and 962 are represented by planes.

The main conductor section 165Ba in the conductor layer B in the twenty-seventh configuration example depicted in B in FIG. 89 includes the mesh conductor 822Ba similar to that in the twenty-sixth configuration example depicted in FIG. 88. The lead conductor section 165Bb in the conductor layer B in the twenty-seventh configuration example includes a mesh conductor 953Bb and a mesh conductor 954Bb. Both of the shapes of the mesh conductor 953Bb and the mesh conductor 954Bb include the X-direction conductor width WXBb and gap width GXBb, and the Y-direction conductor width WYBb and gap width GYBb. It should be noted however that the mesh conductor 954Bb is a wire (Vdd wire) connected to a positive power supply, for example, and the mesh conductor 953Bb is a wire (Vss wire) connected to GND or a negative power supply, for example.

A conductor 963 with a shape including, if desired, a repetition pattern that is different from the repetition pattern of the mesh conductor 822Ba of the main conductor section 165Ba and the repetition pattern of the mesh conductor 953Bb of the lead conductor section 165Bb is arranged between the mesh conductor 822Ba of the main conductor section 165Ba and the mesh conductor 953Bb of the lead conductor section 165Bb. A conductor 964 with a shape including, if desired, a repetition pattern that is different from the repetition pattern of the mesh conductor 822Ba of the main conductor section 165Ba and the repetition pattern of the mesh conductor 954Bb of the lead conductor section 165Bb is arranged between the mesh conductor 822Ba of the main conductor section 165Ba and the mesh conductor 954Bb of the lead conductor section 165Bb. Note that, in order to design the wiring layout efficiently, the conductor 963 or 964 desirably has a shape including a repetition pattern, but may have a shape not including a repetition pattern. Because the patterns of the conductors 963 and 964 can be of any shapes, the conductors 963 and 964 are not specified particularly in B in FIG. 89, but the conductors 963 and 964 are represented by planes.

The conductor 961 in the conductor layer A is electrically connected with the mesh conductor 821Aa of the main conductor section 165Aa, and at least one of the mesh conductor 951Ab or the mesh conductor 953Bb of the lead conductor section 165b directly or indirectly via a conductor like at least part of the conductor 963, for example. In other words, the mesh conductor 821Aa of the main conductor section 165Aa, and at least one of the mesh conductor 951Ab or the mesh conductor 953Bb of the lead conductor section 165b are electrically connected via the conductor 961. In addition, the mesh conductor 951Ab of the lead conductor section 165Ab may be electrically connected with the mesh conductor 953Bb of the lead conductor section 165Bb in the conductor layer B via a conductor via extending in the Z direction, or the like, for example. The conductor 961 and the conductor 963 may also be electrically connected via a conductor via extending in the Z direction, or the like, for example.

The conductor 964 in the conductor layer B is electrically connected with the mesh conductor 822Ba of the main conductor section 165Ba, and at least one of the mesh conductor 952Ab or the mesh conductor 954Bb of the lead conductor section 165b directly or indirectly via a conductor like at least part of the conductor 962, for example. In other words, the mesh conductor 822Ba of the main conductor section 165Ba, and at least one of the mesh conductor 952Ab or the mesh conductor 954Bb of the lead conductor section 165b are electrically connected via the conductor 964. In addition, the mesh conductor 952Ab of the lead conductor section 165Ab may be electrically connected with the mesh conductor 954Bb of the lead conductor section 165Bb in the conductor layer B via a conductor via extending in the Z direction, or the like, for example. The conductor 962 and the conductor 964 may also be electrically connected via a conductor via extending in the Z direction, or the like, for example.

For example, in the twenty-sixth configuration example in FIG. 88 mentioned above, regarding the polarities of the conductor layer A and the conductor layer B at the same plane position in each of the main conductor section 165a and the lead conductor section 165b, the main conductor section 165Aa in the conductor layer A and the main conductor section 165Ba in the conductor layer B have different polarities between Vss wires and Vdd wires, and the lead conductor section 165Ab in the conductor layer A and the lead conductor section 165Bb in the conductor layer B also have different polarities.

In contrast, in the twenty-seventh configuration example in FIG. 89, regarding the polarities of the conductor layer A and the conductor layer B at the same plane position in each of the main conductor section 165a and the lead conductor section 165b, the main conductor section 165Aa in the conductor layer A and the main conductor section 165Ba in the conductor layer B have different polarities between Vss wires and Vdd wires, but the lead conductor section 165Ab in the conductor layer A and the lead conductor section 165Bb in the conductor layer B have the same polarity. In a case in which the upper and lower conductor layer A and conductor layer B are configured in such a polarity arrangement, the lead conductor section 165b including the electrically connected upper and lower conductor layer A and conductor layer B can be formed as a pad (electrode).

According to the twenty-seventh configuration example, it is possible to achieve any of effects such as satisfying layout constraints of wires, further improving the degree of freedom of designing of the wiring layouts, further ameliorating inductive noise, further ameliorating voltage drops, and the like.

### Twenty-Eighth Configuration Example

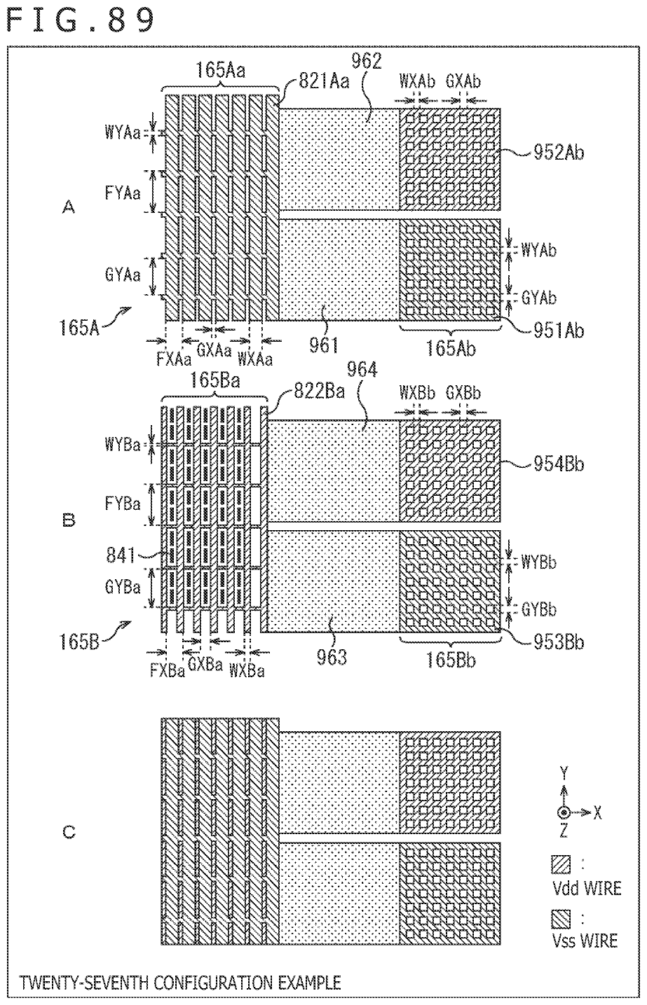

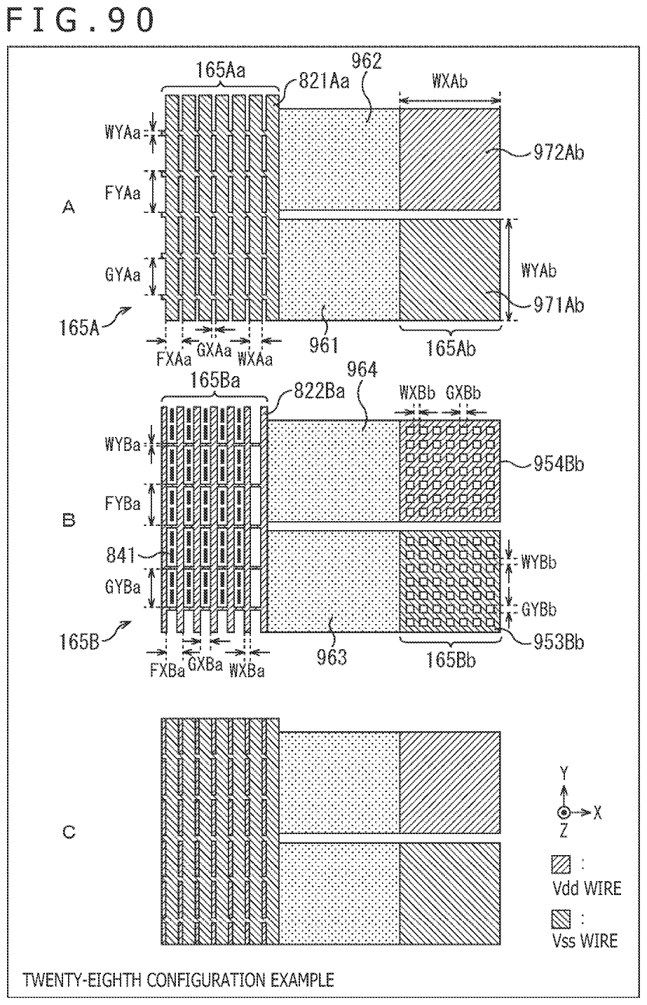

FIG. 90 depicts a twenty-eighth configuration example of the conductor layers A and B. Note that A in FIG. 90 depicts the conductor layer A, and B in FIG. 90 depicts the conductor layer B. C in FIG. 90 depicts a state of the conductor layers A and B depicted in A and B in FIG. 90, respectively, as seen from the side where the conductor layer A is located. In the coordinate system in FIG. 90, the X axis lies in the lateral direction, the Y axis lies in the longitudinal direction, and the Z axis lies in a direction perpendicular to the XY plane.

The twenty-eighth configuration example depicted in FIG. 90 has a configuration in which part of the twenty-seventh configuration example depicted in FIG. 89 is modified. Sections in FIG. 90 that have counterparts in FIG. 89 are given the same reference signs, and explanations of those sections are omitted as appropriate.

The twenty-eighth configuration example depicted in FIG. 90 and the twenty-seventh configuration example in FIG. 89 are different only in terms of the shape of the lead conductor section 165Ab in the conductor layer A and have commonalities in other respects.

Specifically, in the lead conductor section 165Ab in the conductor layer A in the twenty-seventh configuration example in FIG. 89, the mesh conductor 951Ab and the mesh conductor 952Ab having shapes with the X-direction conductor width WXAb and gap width GXAb, and the Y-direction conductor width WYAb and gap width GYAb are formed.

In contrast, in the lead conductor section 165Ab in the conductor layer A in the twenty-eighth configuration example in FIG. 90, a planar conductor 971Ab and a planar conductor 972Ab having shapes with the X-direction conductor width WXAb and the Y-direction conductor width WYAb are formed.

In other words, in the twenty-eighth configuration example in FIG. 90, in the lead conductor section 165Ab in the conductor layer A, the planar conductor 971Ab is provided instead of the mesh conductor 951Ab in the twenty-seventh configuration example in FIG. 89, and the planar conductor 972Ab is provided instead of the mesh conductor 952Ab in the twenty-seventh configuration example in FIG. 89.

Although the twenty-seventh configuration example depicted in FIG. 89 is an example in which the upper and lower conductor layer A and conductor layer B have the same shape of the lead conductor section 165b, they may have different shapes as in the twenty-eighth configuration example in FIG. 90.

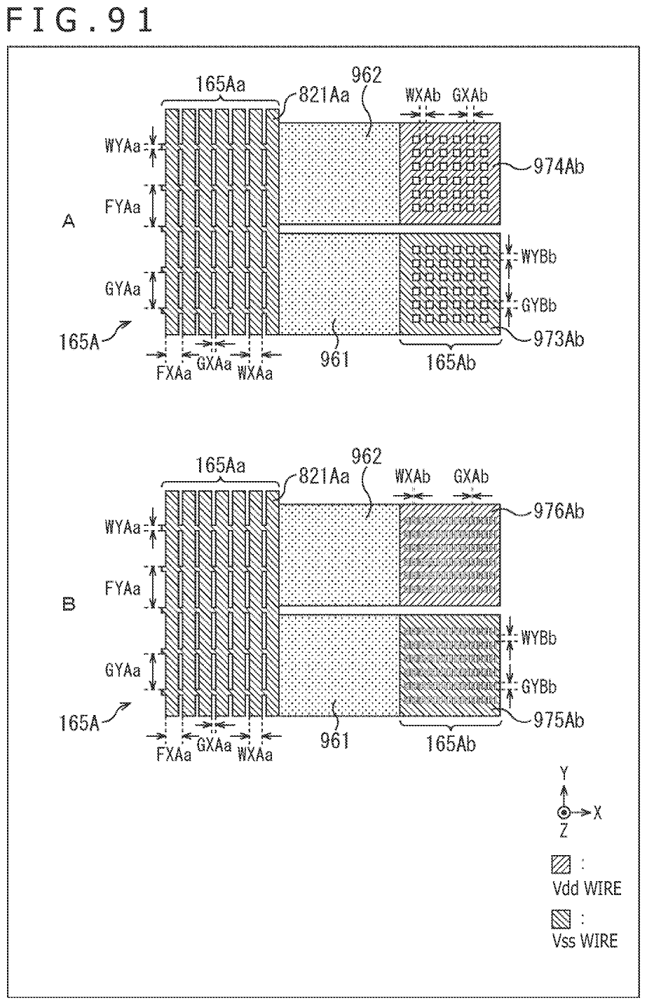

Moreover, while the shape of the lead conductor section 165Ab in the conductor layer A in the twenty-eighth configuration example in FIG. 90 is planar, in one possible configuration, even if mesh conductors are used in common like a mesh conductor 973Ab and a mesh conductor 974Ab of the lead conductor section 165Ab in the conductor layer A depicted in A in FIG. 91, a light-blocking structure may be formed with the mesh conductor 973Ab in the conductor layer A in A in FIG. 91 and the mesh conductor 953Bb in the conductor layer B in B in FIG. 90, and a light-blocking structure may be formed with the mesh conductor 974Ab in the conductor layer A in A in FIG. 91 and the mesh conductor 954Bb in the conductor layer B in B in FIG. 90. Furthermore, in one possible shape, the X-direction conductor width WXAb or gap width GXAb, and the Y-direction conductor width WYAb or gap width GYAb may be made substantially the same sizes as those of the mesh conductor 953Bb or mesh conductor 954Bb of the lead conductor section 165Bb in the conductor layer B.

Alternatively, in one possible shape, like a mesh conductor 975Ab and a mesh conductor 976Ab of the lead conductor section 165Ab in the conductor layer A depicted in B in FIG. 91, the X-direction conductor width WXAb or gap width GXAb may be made smaller than those of the mesh conductor 953Bb or mesh conductor 954Bb of the lead conductor section 165Bb in the conductor layer B in B in FIG. 90. Additionally, in one possible configuration, a light-blocking structure may be formed with the mesh conductor 975Ab in the conductor layer A in B in FIG. 91 and the mesh conductor 953Bb in the conductor layer B in B in FIG. 90, and a light-blocking structure may be formed with the mesh conductor 976Ab in the conductor layer A in B in FIG. 91 and the mesh conductor 954Bb in the conductor layer B in B in FIG. 90. Furthermore, although an illustration is omitted, in one possible shape, the Y-direction conductor width WYAb or gap width GYAb of the lead conductor section 165Ab in the conductor layer A may be made smaller than those of the mesh conductor 953Bb or mesh conductor 954Bb of the lead conductor section 165Bb in the conductor layer B, and, in one possible shape, the X-direction conductor width WXAb or gap width GXAb, and Y-direction conductor width WYAb or gap width GYAb of the lead conductor section 165Ab in the conductor layer A may be made larger than those of the mesh conductor 953Bb or mesh conductor 954Bb of the lead conductor section 165Bb in the conductor layer B.

A and B in FIG. 91 depict other configuration examples of the conductor layer A in the twenty-eighth configuration example in FIG. 90.

### Summary of Fourteenth to Twenty-Eighth Configuration Examples

In the fourteenth to twenty-eighth configuration examples depicted in FIG. 65 to FIG. 90, in both the conductor layer A and the conductor layer B, repetition patterns of the main conductor section 165a and the lead conductor section 165b include different patterns (shapes).

The conductor layer A (first conductor layer) includes the main conductor section 165Aa (first conductor section) including a conductor with a shape in which a planar, linear, or mesh repetition pattern (first basic pattern) is repeatedly arrayed on the same plane in the X direction or Y direction, and the lead conductor section 165Ab (fourth conductor section) including a conductor with a shape in which a planar, linear, or mesh repetition pattern (fourth basic pattern) is repeatedly arrayed on the same plane in the X direction or Y direction. Here, the repetition pattern of the conductor of the main conductor section 165Aa and the repetition pattern of the conductor of the lead conductor section 165Ab may have different shapes, and conductors with patterns different from the patterns of the conductor of the main conductor section 165Aa and the conductor of the lead conductor section 165Ab may be arranged between the conductor of the main conductor section 165Aa and the conductor of the lead conductor section 165Ab.

The conductor layer B (second conductor layer) includes the main conductor section 165Ba (second conductor section) including a conductor with a shape in which a planar, linear, or mesh repetition pattern (second basic pattern) is repeatedly arrayed on the same plane in the X direction or Y direction, and the lead conductor section 165Bb (third conductor section) including a conductor with a shape in which a planar, linear, or mesh repetition pattern (third basic pattern) is repeatedly arrayed on the same plane in the X direction or Y direction. Here, the repetition pattern of the conductor of the main conductor section 165Ba and the repetition pattern of the conductor of the lead conductor section 165Bb may have different shapes, and conductors with patterns different from the patterns of the conductor of the main conductor section 165Ba and the conductor of the lead conductor section 165Bb may be arranged between the conductor of the main conductor section 165Ba and the conductor of the lead conductor section 165Bb.

In each configuration example mentioned above, a conductor explained as being a wire (Vss wire) connected to GND or a negative power supply, for example, may be a wire (Vdd wire) connected to a positive power supply, for example, and a conductor explained as being a wire (Vdd wire) connected to a positive power supply, for example, may be a wire (Vss wire) connected to GND or a negative power supply, for example.

While the entire Y-direction length LAa of the conductor of the main conductor section 165Aa is longer than the entire Y-direction length LAb of the conductor of the lead conductor section 165Ab in the configuration in each configuration example mentioned above, the entire length LAa and the entire length LAb may be the same or substantially the same, or the entire length LAa may be shorter than the entire length LAb in one possible configuration.

Similarly, while the entire Y-direction length LBa of the main conductor section 165Ba is longer than the entire Y-direction length LBb of the lead conductor section 165Bb in the configurations, the entire length LBa and the entire length LBb may be the same or substantially the same, or the entire length LBa may be shorter than the entire length LBb in one possible configuration.

In configuration examples that are included in the configuration examples mentioned above, and in which repetition patterns that allow currents to flow more easily in the Y direction than in the X direction are used as examples of repetition patterns of the main conductor section 165Aa and the main conductor section 165Ba, repetition pattern examples that allow currents to flow more easily in the X direction may be used, and conversely in configuration examples in which repetition patterns that allow currents to flow more easily in the X direction than in the Y direction are used, repetition pattern examples that allow currents to flow more easily in the Y direction may be used. In addition, repetition pattern examples that allow currents to flow more easily in the X direction and the Y direction to the substantially same degrees may be used.

In each configuration example mentioned above, patterns of the conductors of the main conductor section 165Aa in the conductor layer A (wiring layer 165A) and the main conductor section 165Ba in the conductor layer B (wiring layer 165B) may have any configurations of the patterns explained in the first to thirteenth configuration examples. Note that while the conductor pitches, the conductor widths, and the gap widths are entirely even pitches and widths in the examples used for the explanations of some of the configuration examples mentioned above, these are not essential. For example, the conductor pitches, the conductor widths, and the gap widths may be uneven pitches and widths, and the conductor pitches, the conductor widths, and the gap widths may be modulated depending on positions, in other possible shapes. In addition, while the conductor pitches, the conductor widths, the gap widths, the wire shapes, the wire positions, the numbers of wires, and the like are substantially the same between Vdd wires and Vss wires in the examples used for the explanations of some of the configuration examples mentioned above, these are not essential. For example, Vdd wires and Vss wires may have different conductor pitches, may have different conductor widths, may have different gap widths, may have different wire shapes, may have different wire positions, may have wire positions that deviate from each other or are displaced from each other, or may have different numbers of wires.

### 10. Configuration Examples of Connections with Pads

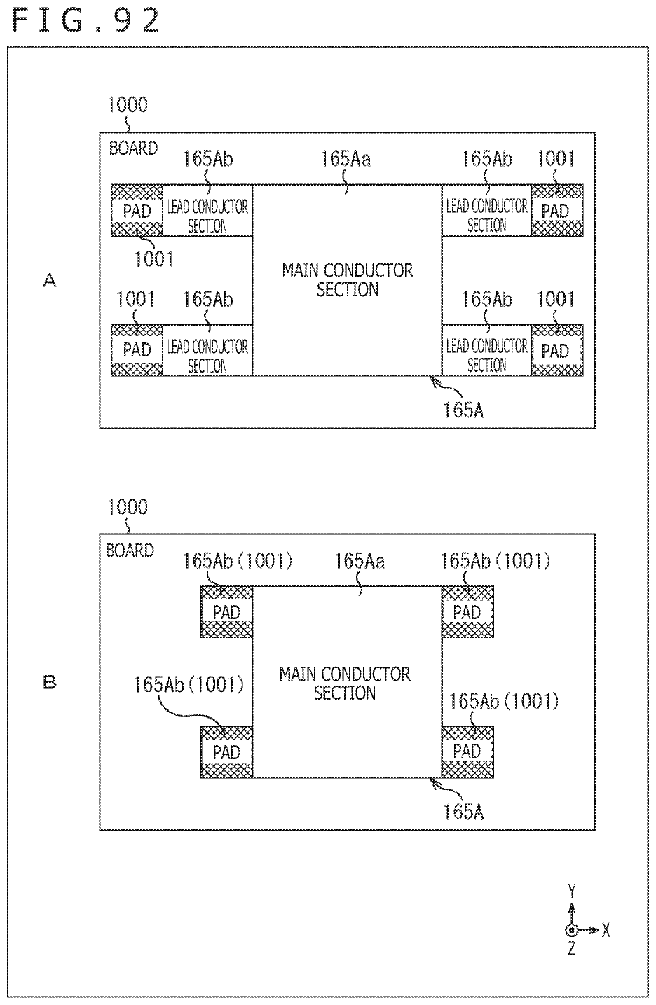

Next, relations between the conductor layers A and B, and pads are explained with reference to FIG. 92 to FIG. 108.

FIG. 92 is a plan view depicting the whole of the conductor layer A formed on a board.

As mentioned above, the conductor layer A (wiring layer 165A) includes the main conductor section 165Aa and the lead conductor sections 165Ab.

In a case in which pads are provided separately from the conductor layer A, as depicted in A in FIG. 92, the lead conductor sections 165Ab are provided at positions close to pads 1001, and connect the main conductor section 165Aa and the pads 1001. On the other hand, as depicted in B in FIG. 92, the pads 1001 include the lead conductor sections 165Ab in some cases.

In the main region of a board 1000, for example, in the middle region of the board, the main conductor section 165Aa is formed to have an area size larger than the lead conductor sections 165Ab, and blocks, off from light, active elements such as MOMS transistors or diodes formed in the region of the main conductor section 165Aa or on other layers that are located in the Z direction perpendicular to the plane of the region of the main conductor section 165Aa.

Note that FIG. 92 depicts one example of the arrangement and shape of the conductor layer A and the arrangement and shape of the conductor layer A are not limited to this example. Accordingly, the positions and area sizes of the main conductor section 165Aa, the lead conductor sections 165Ab, and the pads 1001 formed in the board 1000 can be any positions and area sizes, and an active element does not have to be formed in the regions of the main conductor section 165Aa and the lead conductor sections 165Ab or on other layers that are located in the Z direction perpendicular to the plane of the regions of the main conductor section 165Aa and the lead conductor sections 165Ab. The lead conductor sections 165Ab do not have to be provided at positions close to the pads 1001. In addition, the lead conductor sections 165Ab and the pads 1001 may be arranged, relative to the main conductor section 165Aa, not on edges on the X-direction sides in the four edges of the main conductor section 165Aa as in FIG. 92, but on edges on the Y-direction sides, or on edges on both the X-direction sides and the Y-direction sides. Furthermore, the number of the pads 1001 on each edge as in FIG. 92 may not be two, but one, or three or larger.

Although an example of the conductor layer A (wiring layer 165A) is depicted in FIG. 92, this similarly applies also to the conductor layer B (wiring layer 165B).

With such a configuration, it is possible to achieve any of effects such as satisfying layout constraints of wires, further improving the degree of freedom of designing of the wiring layouts, further ameliorating inductive noise, further ameliorating voltage drops, and the like.

Although a particular distinction between whether the pads 1001 are electrodes (Vdd electrodes) connected to a positive power supply or electrodes (Vss electrodes) connected to GND or a negative power supply, for example, is not made in FIG. 92, the arrangement of the pads 1001 in a case in which such a distinction is made is explained hereinbelow.

### Fourth Arrangement Example of Pads

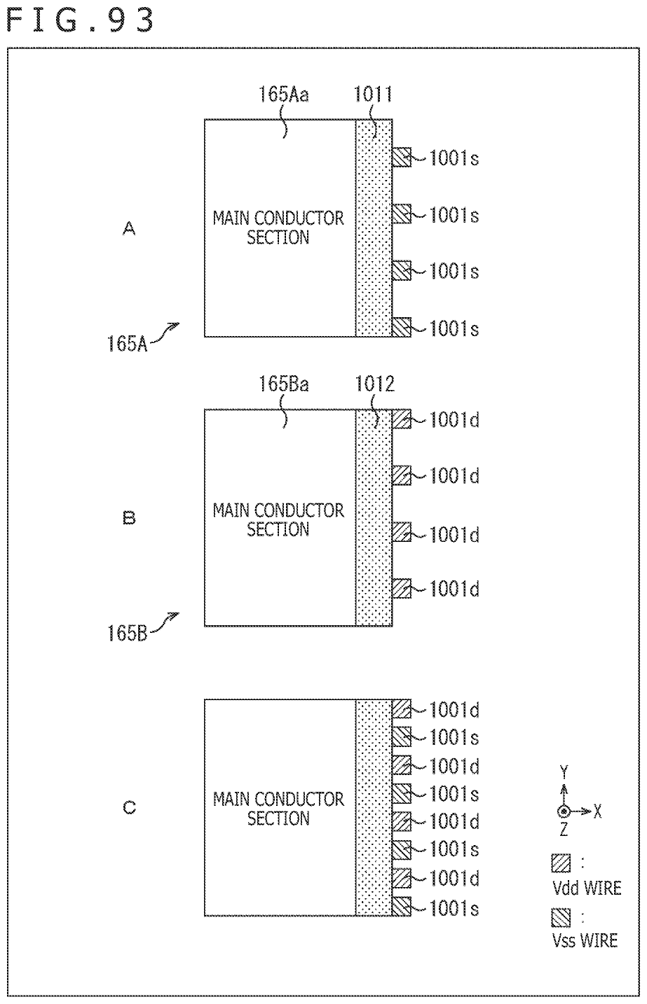

FIG. 93 depicts a fourth arrangement example of pads.

A in FIG. 93 is a plan view depicting an arrangement example of the conductor layer A (wiring layer 165A) and pads 1001s connected to the conductor layer A.

B in FIG. 93 is a plan view depicting an arrangement example of the conductor layer B (wiring layer 165B) and pads 1001d connected to the conductor layer B.

C in FIG. 93 is a plan view of the stacked state of the conductor layers A and B depicted in A and B in FIG. 93, respectively, and the pads 1001s and pads 1001d depicted in A and B in FIG. 93, respectively.

In FIG. 93, the pads 1001s represent pads 1001 to be supplied with GND or a negative power supply (Vss), for example, and the pads 1001d represent pads 1001 to be supplied with a positive power supply (Vdd), for example.

As depicted in A in FIG. 93, one predetermined edge of the rectangular main conductor section 165Aa is connected with multiple pads 1001s at predetermined intervals via a conductor 1011 with a shape including, if desired, a predetermined repetition pattern. For example, each pad 1001s may include the lead conductor section 165Ab as in the twenty-seventh configuration example depicted in FIG. 89, or the conductor 1011 may include the lead conductor section 165Ab. In addition, in a case in which the pads 1001s are the lead conductor sections 165Ab, the conductor 1011 may be omitted or may not be omitted.

As depicted in B in FIG. 93, one predetermined edge that belongs to the rectangular main conductor section 165Ba and is the counterpart of the edge along which the pads 1001s are arranged on the conductor layer A is connected with multiple pads 1001d at predetermined intervals via a conductor 1012 with a shape including, if desired, a predetermined repetition pattern. For example, each pad 1001d may include the lead conductor section 165Bb as in the twenty-seventh configuration example depicted in FIG. 89, or the conductor 1012 may include the lead conductor section 165Bb. In addition, in a case in which the pads 1001d are the lead conductor sections 165Bb, the conductor 1012 may be omitted or may not be omitted.

As depicted in C in FIG. 93, in the stacked state of the conductor layers A and B, the pads 1001s and the pads 1001d are arranged alternately in the Y direction. In this case, it is possible to effectively offset magnetic fields generated from the conductor layers A and B and induced electromotive forces based on the magnetic fields as has been explained with reference to FIG. 42 to FIG. 44, and so inductive noise can be ameliorated further. It should be noted however that because this arrangement is not symmetric in the Y direction, in a case in which pads 1001 are arranged over a wide range, that is, in a case in which the main conductor section 165Aa or 165Ba, the lead conductor section 165Ab or 165Bb, or the conductor 1011 or 1012 is long in the array direction of the pads 1001 (longer in the Y direction than in the X direction in FIG. 93), magnetic fields that cannot be offset fully remain and are accumulated as Victim conductor loops become large; as a result, induced electromotive forces increase, and inductive noise worsens in some possible cases.

### Fifth Arrangement Example of Pads

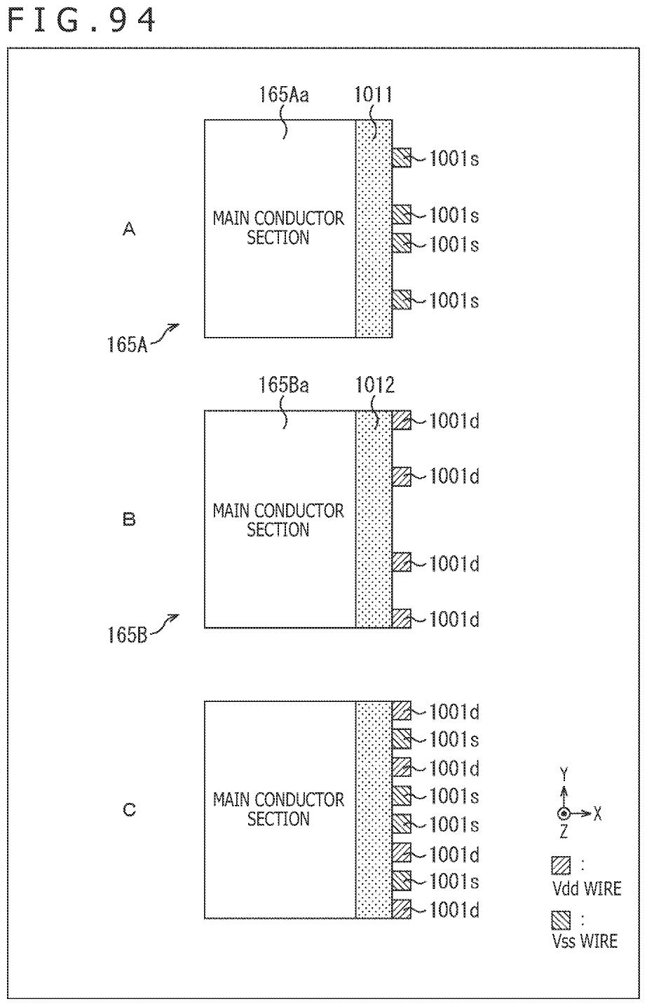

FIG. 94 depicts a fifth arrangement example of pads.

A in FIG. 94 is a plan view depicting an arrangement example of the conductor layer A (wiring layer 165A), and pads 1001s connected to the conductor layer A.

B in FIG. 94 is a plan view depicting an arrangement example of the conductor layer B (wiring layer 165B), and pads 1001d connected to the conductor layer B.

C in FIG. 94 is a plan view of the stacked state of the conductor layers A and B depicted in A and B in FIG. 94, respectively, and the pads 1001s and pads 1001d depicted in A and B in FIG. 94, respectively.

In FIG. 94, the pads 1001s represent pads 1001 to be supplied with GND or a negative power supply, for example, and the pads 1001d represent pads 1001 to be supplied with a positive power supply, for example.

As depicted in A in FIG. 94, one predetermined edge of the rectangular main conductor section 165Aa is connected with multiple pads 1001s at predetermined intervals via the conductor 1011 with a shape including, if desired, a predetermined repetition pattern. Each pad 1001s may include the lead conductor section 165Ab, or the conductor 1011 may include the lead conductor section 165Ab. In addition, in a case in which the pads 1001s are the lead conductor sections 165Ab, the conductor 1011 may be omitted or may not be omitted.

As depicted in B in FIG. 94, one predetermined edge that belongs to the rectangular main conductor section 165Ba and is the counterpart of the edge along which the pads 1001s are arranged on the conductor layer A is connected with multiple pads 1001d at predetermined intervals via the conductor 1012 with a shape including, if desired, a predetermined repetition pattern. Each pad 1001d may include the lead conductor section 165Bb, or the conductor 1012 may include the lead conductor section 165Bb. In addition, in a case in which the pads 1001d are the lead conductor sections 165Bb, the conductor 1012 may be omitted or may not be omitted.

As depicted in C in FIG. 94, in the stacked state of the conductor layers A and B, the arrangement of the pads 1001s and the pads 1001d is a mirror-symmetric arrangement in which two sets of pads 1001, each set of which includes four pads 1001s and pads 1001d that are next to each other in the Y direction, are arranged sequentially in the Y direction, with one set of the pads 1001 being arranged in an order, and the other set of the pads 1001 being arranged in the reversed order. In this case, as compared with the alternating arrangement depicted in FIG. 93, it is possible to more effectively offset magnetic fields generated from the conductor layers A and B, and induced electromotive forces based on the magnetic fields, and so inductive noise can be ameliorated further, depending on the layouts of elements other than the pads.

### Sixth Arrangement Example of Pads

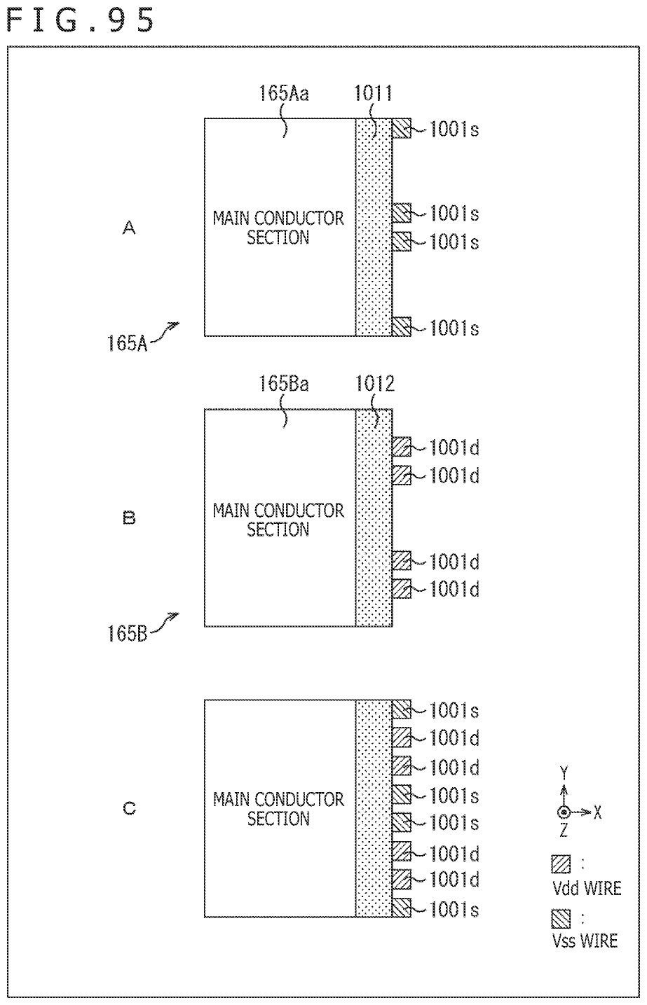

FIG. 95 depicts a sixth arrangement example of pads.

A in FIG. 95 is a plan view depicting an arrangement example of the conductor layer A (wiring layer 165A), and pads 1001s connected to the conductor layer A.

B in FIG. 95 is a plan view depicting an arrangement example of the conductor layer B (wiring layer 165B), and pads 1001d connected to the conductor layer B.

C in FIG. 95 is a plan view of the stacked state of the conductor layers A and B depicted in A and B in FIG. 95, respectively, and the pads 1001s and pads 1001d depicted in A and B in FIG. 95, respectively.

In FIG. 95, the pads 1001s represent pads 1001 to be supplied with GND or a negative power supply, for example, and the pads 1001d represent pads 1001 to be supplied with a positive power supply, for example.

As depicted in A in FIG. 95, one predetermined edge of the rectangular main conductor section 165Aa is connected with multiple pads 1001s at predetermined intervals via the conductor 1011 with a shape including, if desired, a predetermined repetition pattern. Each pad 1001s may include the lead conductor section 165Ab, or the conductor 1011 may include the lead conductor section 165Ab. In addition, in a case in which the pads 1001s are the lead conductor sections 165Ab, the conductor 1011 may be omitted or may not be omitted.

As depicted in B in FIG. 95, one predetermined edge that belongs to the rectangular main conductor section 165Ba and is the counterpart of the edge along which the pads 1001s are arranged on the conductor layer A is connected with multiple pads 1001d at predetermined intervals via the conductor 1012 with a shape including, if desired, a predetermined repetition pattern. Each pad 1001d may include the lead conductor section 165Bb, or the conductor 1012 may include the lead conductor section 165Bb. In addition, in a case in which the pads 1001d are the lead conductor sections 165Bb, the conductor 1012 may be omitted or may not be omitted.

As depicted in C in FIG. 95, in the stacked state of the conductor layers A and B, the arrangement of the pads 1001s and the pads 1001d is a mirror-symmetric arrangement in which two sets of pads 1001, each set of which includes four pads 1001s and pads 1001d that are next to each other in the Y direction, are arranged sequentially in the Y direction, with one set of the pads 1001 being arranged in an order, and the other set of the pads 1001 being arranged in the reversed order. Furthermore, four pads 1001s and pads 1001d included in each set also are arranged in a mirror-symmetric arrangement in which one set of two pads 1001 is arranged on one side of the center line of the four pads 1001s and pads 1001d in the Y direction in a reversed order in the Y direction as compared to the other set of two pads 1001 arranged on the other side of the center line of the four pads 1001s and pads 1001d in the Y direction. In the case of the configuration with the twofold mirror-symmetric arrangement in such a manner, as compared with the configuration with the one fold mirror-symmetric arrangement depicted in FIG. 94, the range within which residual magnetic fields are accumulated is narrow. Accordingly, induced electromotive forces are offset more effectively, and inductive noise can be ameliorated further, depending on the layouts of elements other than the pads.

### Seventh Arrangement Example of Pads

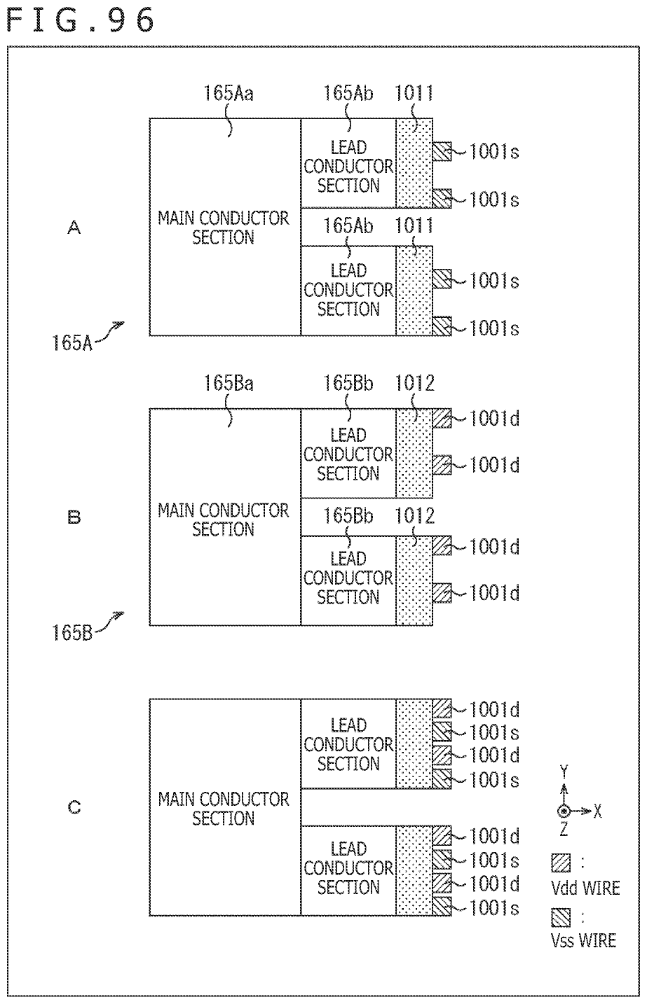

FIG. 96 depicts a seventh arrangement example of pads.

A in FIG. 96 is a plan view depicting an arrangement example of the conductor layer A (wiring layer 165A), and pads 1001s connected to the conductor layer A.

B in FIG. 96 is a plan view depicting an arrangement example of the conductor layer B (wiring layer 165B), and pads 1001d connected to the conductor layer B.

C in FIG. 96 is a plan view of the stacked state of the conductor layers A and B depicted in A and B in FIG. 96, respectively, and the pads 1001s and pads 1001d depicted in A and B in FIG. 96, respectively.

In FIG. 96, the pads 1001s represent pads 1001 to be supplied with GND or a negative power supply, for example, and the pads 1001d represent pads 1001 to be supplied with a positive power supply, for example.

As depicted in A in FIG. 96, one predetermined edge of the rectangular main conductor section 165Aa is connected with multiple lead conductor sections 165Ab, and an outer circumferential section of each lead conductor section 165Ab is connected with multiple pads 1001s at predetermined intervals via a conductor 1011 with a shape including, if desired, a predetermined repetition pattern. Each conductor 1011 may be omitted or may not be omitted. In addition, each conductor 1011 may be located between the main conductor section 165Aa and a lead conductor section 165Ab.

As depicted in B in FIG. 96, one predetermined edge of the rectangular main conductor section 165Ba is connected with multiple lead conductor sections 165Bb, and an outer circumferential section of each lead conductor section 165Bb is connected with multiple pads 1001d at predetermined intervals via a conductor 1012 with a shape including, if desired, a predetermined repetition pattern. Each conductor 1012 may be omitted or may not be omitted. In addition, each conductor 1012 may be located between the main conductor section 165Ba and a lead conductor section 165Bb.

As depicted in C in FIG. 96, in the stacked state of the conductor layers A and B, the pads 1001s and the pads 1001d are arranged alternately in the Y direction. In this case, it is possible to effectively offset magnetic fields generated from the conductor layers A and B, and induced electromotive forces based on the magnetic fields, and so inductive noise can be ameliorated further. It should be noted however that because this arrangement is not symmetric in the Y direction, in a case in which pads 1001 are arranged over a wide range, that is, in a case in which the main conductor section 165Aa or 165Ba, the lead conductor sections 165Ab or 165Bb, or the conductors 1011 or 1012 is/are long in the array direction of the pads 1001 (longer in the Y direction than in the X direction in FIG. 96), magnetic fields that cannot be offset fully remain and are accumulated as Victim conductor loops become large; as a result, induced electromotive forces increase, and inductive noise worsens, in some possible cases.

### Eighth Arrangement Example of Pads

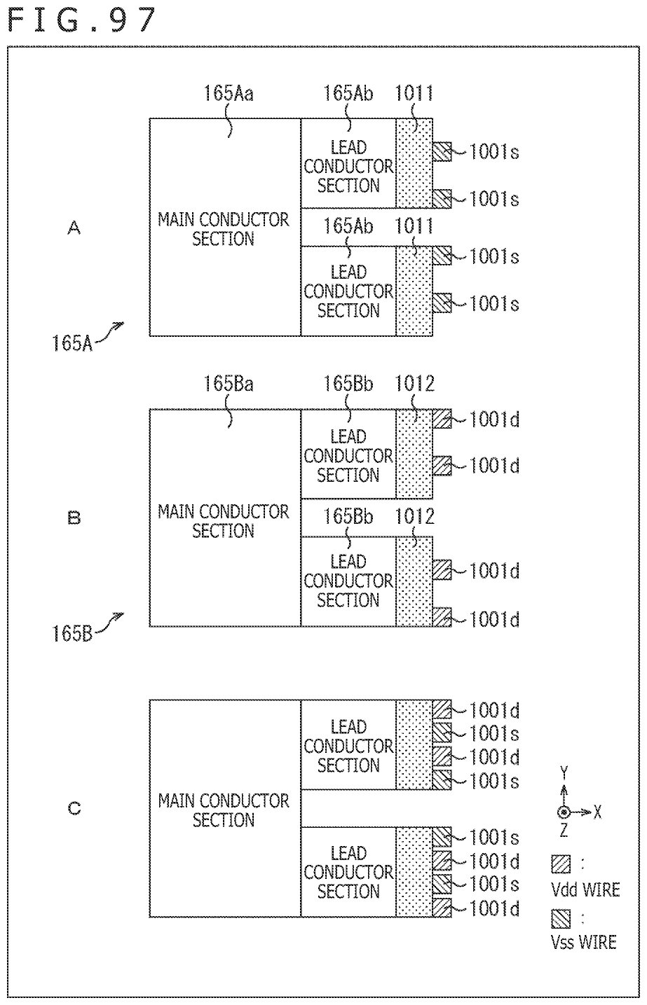

FIG. 97 depicts an eighth arrangement example of pads.

A in FIG. 97 is a plan view depicting an arrangement example of the conductor layer A (wiring layer 165A), and pads 1001s connected to the conductor layer A.

B in FIG. 97 is a plan view depicting an arrangement example of the conductor layer B (wiring layer 165B), and pads 1001d connected to the conductor layer B.

C in FIG. 97 is a plan view of the stacked state of the conductor layers A and B depicted in A and B in FIG. 97, respectively, and the pads 1001s and pads 1001d depicted in A and B in FIG. 97, respectively.

In FIG. 97, the pads 1001s represent pads 1001 to be supplied with GND or a negative power supply, for example, and the pads 1001d represent pads 1001 to be supplied with a positive power supply, for example.

As depicted in A in FIG. 97, one predetermined edge of the rectangular main conductor section 165Aa is connected with multiple lead conductor sections 165Ab, and an outer circumferential section of each lead conductor section 165Ab is connected with multiple pads 1001s at predetermined intervals via a conductor 1011 with a shape including, if desired, a predetermined repetition pattern. Each conductor 1011 may be omitted or may not be omitted. In addition, each conductor 1011 may be located between the main conductor section 165Aa and a lead conductor section 165Ab.

As depicted in B in FIG. 97, one predetermined edge of the rectangular main conductor section 165Ba is connected with multiple lead conductor sections 165Bb, and an outer circumferential section of each lead conductor section 165Bb is connected with multiple pads 1001d at predetermined intervals via a conductor 1012 with a shape including, if desired, a predetermined repetition pattern. Each conductor 1012 may be omitted or may not be omitted. In addition, each conductor 1012 may be located between the main conductor section 165Ba and a lead conductor section 165Bb.

As depicted in C in FIG. 97, in the stacked state of the conductor layers A and B, the arrangement of the pads 1001s and the pads 1001d is a mirror-symmetric arrangement in which two sets of pads 1001, each set of which includes four pads 1001s and pads 1001d that are next to each other in the Y direction, are arranged sequentially in the Y direction, with one set of the pads 1001 being arranged in an order, and the other set of the pads 1001 being arranged in the reversed order. In this case, as compared with the alternating arrangement depicted in FIG. 96, it is possible to more effectively offset magnetic fields generated from the conductor layers A and B, and induced electromotive forces based on the magnetic fields, and so inductive noise can be ameliorated further, depending on the layouts of elements other than the pads.

### Ninth Arrangement Example of Pads

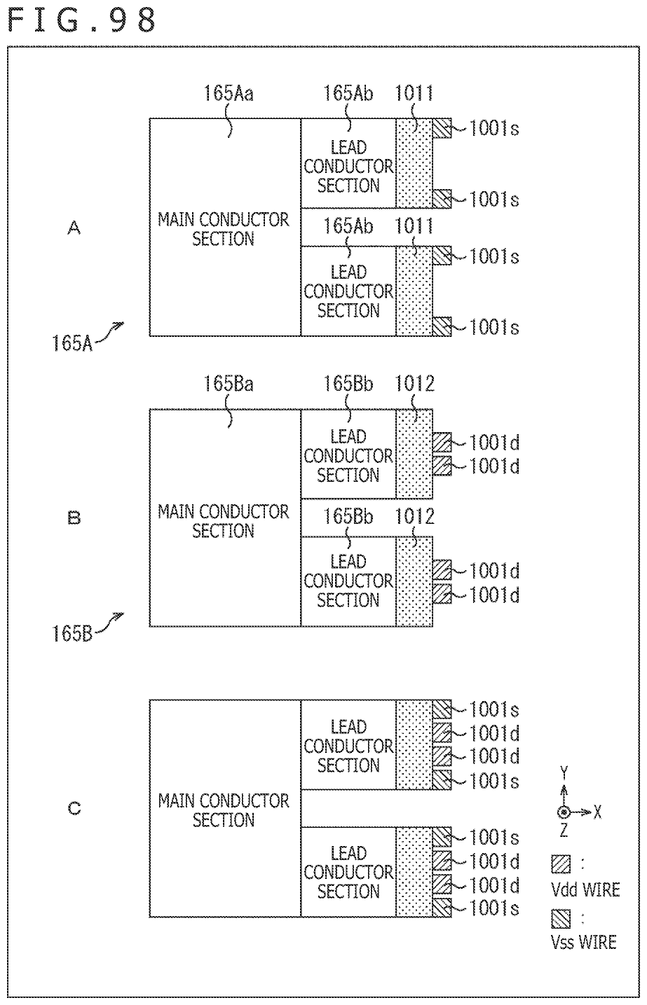

FIG. 98 depicts a ninth arrangement example of pads.

A in FIG. 98 is a plan view depicting an arrangement example of the conductor layer A (wiring layer 165A), and pads 1001s connected to the conductor layer A.

B in FIG. 98 is a plan view depicting an arrangement example of the conductor layer B (wiring layer 165B), and pads 1001d connected to the conductor layer B.

C in FIG. 98 is a plan view of the stacked state of the conductor layers A and B depicted in A and B in FIG. 98, respectively, and the pads 1001s and pads 1001d depicted in A and B in FIG. 98, respectively.

In FIG. 98, the pads 1001s represent pads 1001 to be supplied with GND or a negative power supply, for example, and the pads 1001d represent pads 1001 to be supplied with a positive power supply, for example.

As depicted in A in FIG. 98, one predetermined edge of the rectangular main conductor section 165Aa is connected with multiple lead conductor sections 165Ab, and an outer circumferential section of each lead conductor section 165Ab is connected with multiple pads 1001s at predetermined intervals via a conductor 1011 with a shape including, if desired, a predetermined repetition pattern. Each conductor 1011 may be omitted or may not be omitted. In addition, each conductor 1011 may be located between the main conductor section 165Aa and a lead conductor section 165Ab.

As depicted in B in FIG. 98, one predetermined edge of the rectangular main conductor section 165Ba is connected with multiple lead conductor sections 165Bb, and an outer circumferential section of each lead conductor section 165Bb is connected with multiple pads 1001d at predetermined intervals via a conductor 1012 with a shape including, if desired, a predetermined repetition pattern. Each conductor 1012 may be omitted or may not be omitted. In addition, each conductor 1012 may be located between the main conductor section 165Ba and a lead conductor section 165Bb.

As depicted in C in FIG. 98, in the stacked state of the conductor layers A and B, the arrangement of the pads 1001s and the pads 1001d is a mirror-symmetric arrangement in which two sets of pads 1001, each set of which includes four pads 1001s and pads 1001d that are next to each other in the Y direction, are arranged sequentially in the Y direction, with one set of the pads 1001 being arranged in an order, and the other set of the pads 1001 being arranged in the reversed order. Furthermore, four pads 1001s and pads 1001d included in each set also are arranged in a mirror-symmetric arrangement in which one set of two pads 1001 is arranged on one side of the center line of the four pads 1001s and pads 1001d in the Y direction in the reversed order in the Y direction as compared to the other set of two pads 1001 arranged on the other side of the center line of the four pads 1001s and pads 1001d in the Y direction. In the case of the configuration with the twofold mirror-symmetric arrangement in such a manner, as compared with the configuration with the one fold mirror-symmetric arrangement depicted in FIG. 97, the range within which residual magnetic fields are accumulated is narrow. Accordingly, induced electromotive forces are offset more effectively, and inductive noise can be ameliorated further, depending on the layouts of elements other than the pads.

### Tenth Arrangement Example of Pads

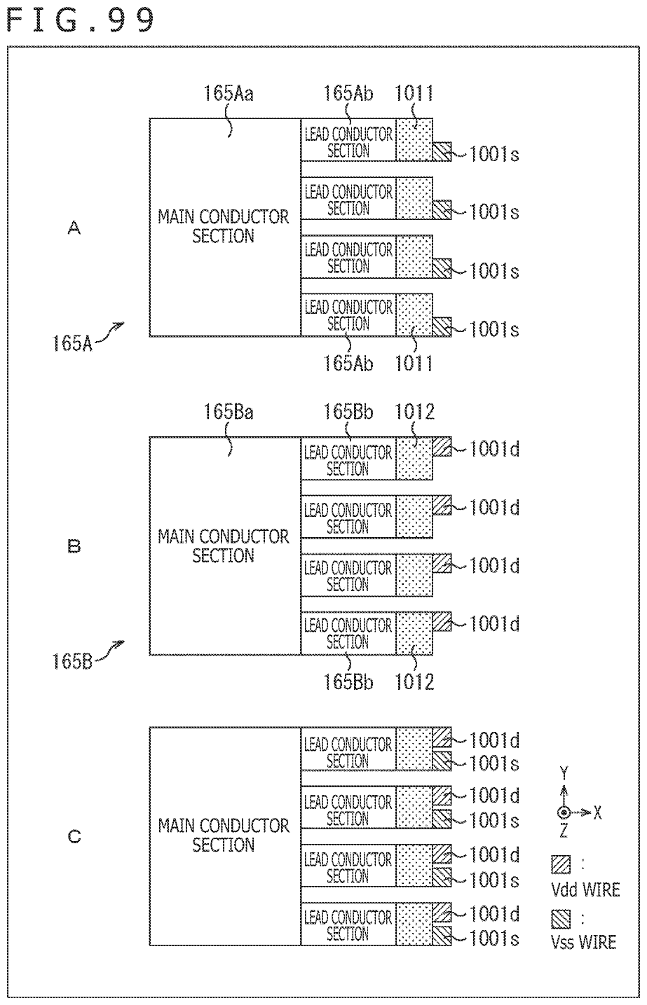

FIG. 99 depicts a tenth arrangement example of pads.

A in FIG. 99 is a plan view depicting an arrangement example of the conductor layer A (wiring layer 165A), and pads 1001s connected to the conductor layer A.

B in FIG. 99 is a plan view depicting an arrangement example of the conductor layer B (wiring layer 165B), and pads 1001d connected to the conductor layer B.

C in FIG. 99 is a plan view of the stacked state of the conductor layers A and B depicted in A and B in FIG. 99, respectively, and the pads 1001s and pads 1001d depicted in A and B in FIG. 99, respectively.

In FIG. 99, the pads 1001s represent pads 1001 to be supplied with GND or a negative power supply, for example, and the pads 1001d represent pads 1001 to be supplied with a positive power supply, for example.

As depicted in A in FIG. 99, one predetermined edge of the rectangular main conductor section 165Aa is connected with multiple lead conductor sections 165Ab, and an outer circumferential section of each lead conductor section 165Ab is connected with one pad 1001s via a conductor 1011 with a shape including, if desired, a predetermined repetition pattern. Each conductor 1011 may be omitted or may not be omitted. In addition, each conductor 1011 may be located between the main conductor section 165Aa and a lead conductor section 165Ab.

As depicted in B in FIG. 99, one predetermined edge of the rectangular main conductor section 165Ba is connected with multiple lead conductor sections 165Bb, and an outer circumferential section of each lead conductor section 165Bb is connected with one pad 1001d via a conductor 1012 with a shape including, if desired, a predetermined repetition pattern. Each conductor 1012 may be omitted or may not be omitted. In addition, each conductor 1012 may be located between the main conductor section 165Ba and a lead conductor section 165Bb.

As depicted in C in FIG. 99, in the stacked state of the conductor layers A and B, the pads 1001s and the pads 1001d are arranged alternately in the Y direction. In this case, it is possible to effectively offset magnetic fields generated from the conductor layers A and B, and induced electromotive forces based on the magnetic fields, and so inductive noise can be ameliorated further. It should be noted however that because this arrangement is not symmetric in the Y direction, in a case in which pads 1001 are arranged over a wide range, that is, in a case in which the main conductor section 165Aa or 165Ba, the lead conductor sections 165Ab or 165Bb, or the conductors 1011 or 1012 is/are long in the array direction of the pads 1001 (longer in the Y direction than in the X direction in FIG. 99), magnetic fields that cannot be offset fully remain and are accumulated as Victim conductor loops become large; as a result, induced electromotive forces increase, and inductive noise worsens, in some possible cases.

### Eleventh Arrangement Example of Pads

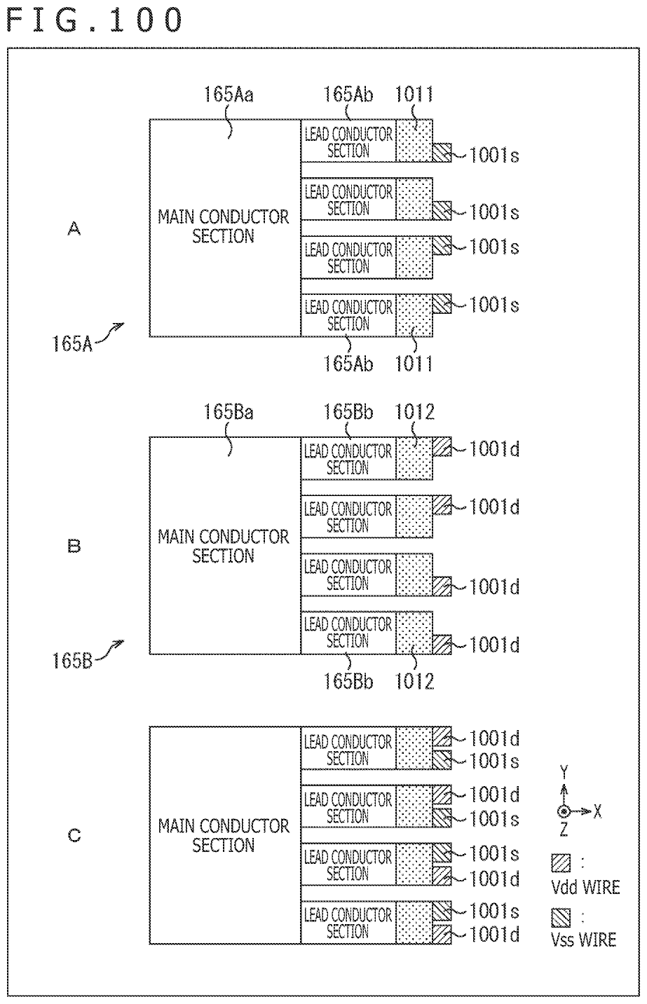

FIG. 100 depicts an eleventh arrangement example of pads.

A in FIG. 100 is a plan view depicting an arrangement example of the conductor layer A (wiring layer 165A), and pads 1001s connected to the conductor layer A.

B in FIG. 100 is a plan view depicting an arrangement example of the conductor layer B (wiring layer 165B), and pads 1001d connected to the conductor layer B.

C in FIG. 100 is a plan view of the stacked state of the conductor layers A and B depicted in A and B in FIG. 100, respectively, and the pads 1001s and pads 1001d depicted in A and B in FIG. 100, respectively.

In FIG. 100, the pads 1001s represent pads 1001 to be supplied with GND or a negative power supply, for example, and the pads 1001d represent pads 1001 to be supplied with a positive power supply, for example.

As depicted in A in FIG. 100, one predetermined edge of the rectangular main conductor section 165Aa is connected with multiple lead conductor sections 165Ab, and an outer circumferential section of each lead conductor section 165Ab is connected with one pad 1001s via a conductor 1011 with a shape including, if desired, a predetermined repetition pattern. Each conductor 1011 may be omitted or may not be omitted. In addition, each conductor 1011 may be located between the main conductor section 165Aa and a lead conductor section 165Ab.

As depicted in B in FIG. 100, one predetermined edge of the rectangular main conductor section 165Ba is connected with multiple lead conductor sections 165Bb, and an outer circumferential section of each lead conductor section 165Bb is connected with one pad 1001d via a conductor 1012 with a shape including, if desired, a predetermined repetition pattern. Each conductor 1012 may be omitted or may not be omitted. In addition, each conductor 1012 may be located between the main conductor section 165Ba and a lead conductor section 165Bb.

As depicted in C in FIG. 100, in the stacked state of the conductor layers A and B, the arrangement of the pads 1001s and the pads 1001d is a mirror-symmetric arrangement in which two sets of pads 1001, each set of which includes four pads 1001s and pads 1001d that are next to each other in the Y direction, are arranged sequentially in the Y direction, with one set of the pads 1001 being arranged in an order, and the other set of the pads 1001 being arranged in the reversed order. In this case, as compared with the alternating arrangement depicted in FIG. 99, it is possible to more effectively offset magnetic fields generated from the conductor layers A and B, and induced electromotive forces based on the magnetic fields, and so inductive noise can be ameliorated further, depending on the layouts of elements other than the pads.

### Twelfth Arrangement Example of Pads

FIG. 101 depicts a twelfth arrangement example of pads.

A in FIG. 101 is a plan view depicting an arrangement example of the conductor layer A (wiring layer 165A), and pads 1001s connected to the conductor layer A.

B in FIG. 101 is a plan view depicting an arrangement example of the conductor layer B (wiring layer 165B), and pads 1001d connected to the conductor layer B.

C in FIG. 101 is a plan view of the stacked state of the conductor layers A and B depicted in A and B in FIG. 101, respectively, and the pads 1001s and pads 1001d depicted in A and B in FIG. 101, respectively.

In FIG. 101, the pads 1001s represent pads 1001 to be supplied with GND or a negative power supply, for example, and the pads 1001d represent pads 1001 to be supplied with a positive power supply, for example.

As depicted in A in FIG. 101, one predetermined edge of the rectangular main conductor section 165Aa is connected with multiple lead conductor sections 165Ab, and an outer circumferential section of each lead conductor section 165Ab is connected with one pad 1001s via a conductor 1011 with a shape including, if desired, a predetermined repetition pattern. Each conductor 1011 may be omitted or may not be omitted. In addition, each conductor 1011 may be located between the main conductor section 165Aa and a lead conductor section 165Ab.

As depicted in B in FIG. 101, one predetermined edge of the rectangular main conductor section 165Ba is connected with multiple lead conductor sections 165Bb, and an outer circumferential section of each lead conductor section 165Bb is connected with one pad 1001d via a conductor 1012 with a shape including, if desired, a predetermined repetition pattern. Each conductor 1012 may be omitted or may not be omitted. In addition, each conductor 1012 may be located between the main conductor section 165Ba and a lead conductor section 165Bb.

As depicted in C in FIG. 101, in the stacked state of the conductor layers A and B, the arrangement of the pads 1001s and the pads 1001d is a mirror-symmetric arrangement in which two sets of pads 1001, each set of which includes four pads 1001s and pads 1001d that are next to each other in the Y direction, are arranged sequentially in the Y direction, with one set of the pads 1001 being arranged in an order, and the other set of the pads 1001 being arranged in the reversed order. Furthermore, four pads 1001s and pads 1001d included in each set also are arranged in a mirror-symmetric arrangement in which one set of two pads 1001 is arranged on one side of the center line of the four pads 1001s and pads 1001d in the Y direction in the reversed order in the Y direction as compared to the other set of two pads 1001 arranged on the other side of the center line of the four pads 1001s and pads 1001d in the Y direction. In the case of the configuration with the twofold mirror-symmetric arrangement in such a manner, as compared with the configuration with the one fold mirror-symmetric arrangement depicted in FIG. 100, the range within which residual magnetic fields are accumulated is narrow. Accordingly, induced electromotive forces are offset more effectively, and inductive noise can be ameliorated further, depending on the layouts of elements other than the pads.

### Thirteenth Arrangement Example of Pads

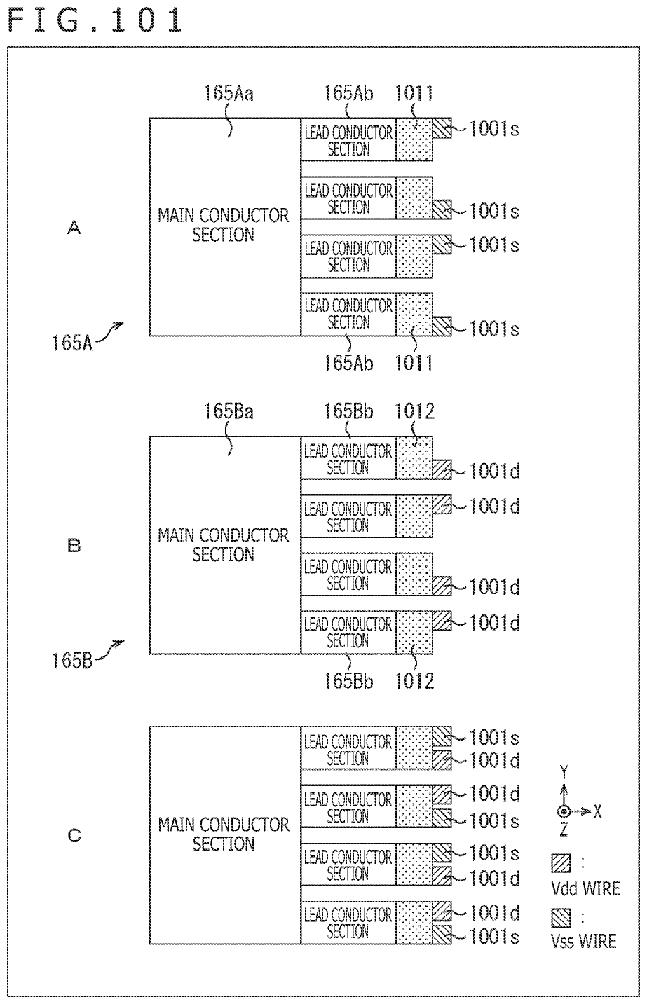

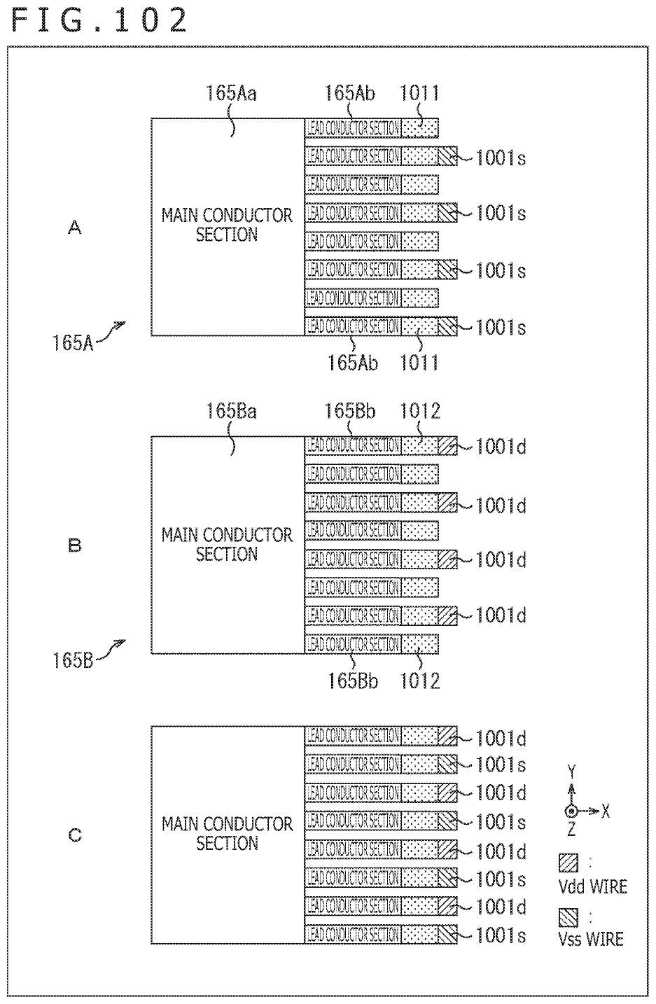

FIG. 102 depicts a thirteenth arrangement example of pads.

A in FIG. 102 is a plan view depicting an arrangement example of the conductor layer A (wiring layer 165A), and pads 1001s connected to the conductor layer A.

B in FIG. 102 is a plan view depicting an arrangement example of the conductor layer B (wiring layer 165B), and pads 1001d connected to the conductor layer B.

C in FIG. 102 is a plan view of the stacked state of the conductor layers A and B depicted in A and B in FIG. 102, respectively, and the pads 1001s and pads 1001d depicted in A and B in FIG. 102, respectively.

In FIG. 102, the pads 1001s represent pads 1001 to be supplied with GND or a negative power supply, for example, and the pads 1001d represent pads 1001 to be supplied with a positive power supply, for example.

As depicted in A in FIG. 102, one predetermined edge of the rectangular main conductor section 165Aa is connected with multiple lead conductor sections 165Ab, and an outer circumferential section of each lead conductor section 165Ab is connected with a conductor 1011 with a shape including, if desired, a predetermined repetition pattern. In addition, each of some of the multiple lead conductor sections 165Ab is connected with one pad 1001s via a conductor 1011. Each conductor 1011 may be omitted or may not be omitted. In addition, each conductor 1011 may be located between the main conductor section 165Aa and a lead conductor section 165Ab.

As depicted in B in FIG. 102, one predetermined edge of the rectangular main conductor section 165Ba is connected with multiple lead conductor sections 165Bb, and an outer circumferential section of each lead conductor section 165Bb is connected with a conductor 1012 with a shape including, if desired, a predetermined repetition pattern. In addition, one pad 1001d is arranged in each of some of the multiple lead conductor sections 165Bb via a conductor 1012. Each conductor 1012 may be omitted or may not be omitted. In addition, each conductor 1012 may be located between the main conductor section 165Ba and a lead conductor section 165Bb.

As depicted in C in FIG. 102, in the stacked state of the conductor layers A and B, the pads 1001s and the pads 1001d are arranged alternately in the Y direction. In this case, it is possible to effectively offset magnetic fields generated from the conductor layers A and B, and induced electromotive forces based on the magnetic fields, and so inductive noise can be ameliorated further. It should be noted however that because this arrangement is not symmetric in the Y direction, in a case in which pads 1001 are arranged over a wide range, that is, in a case in which the main conductor section 165Aa or 165Ba, the lead conductor sections 165Ab or 165Bb, or the conductors 1011 or 1012 is/are long in the array direction of the pads 1001 (longer in the Y direction than in the X direction in FIG. 102), magnetic fields that cannot be offset fully remain and are accumulated as Victim conductor loops become large; as a result, induced electromotive forces increase, and inductive noise worsens, in some possible cases.

### Fourteenth Arrangement Example of Pads

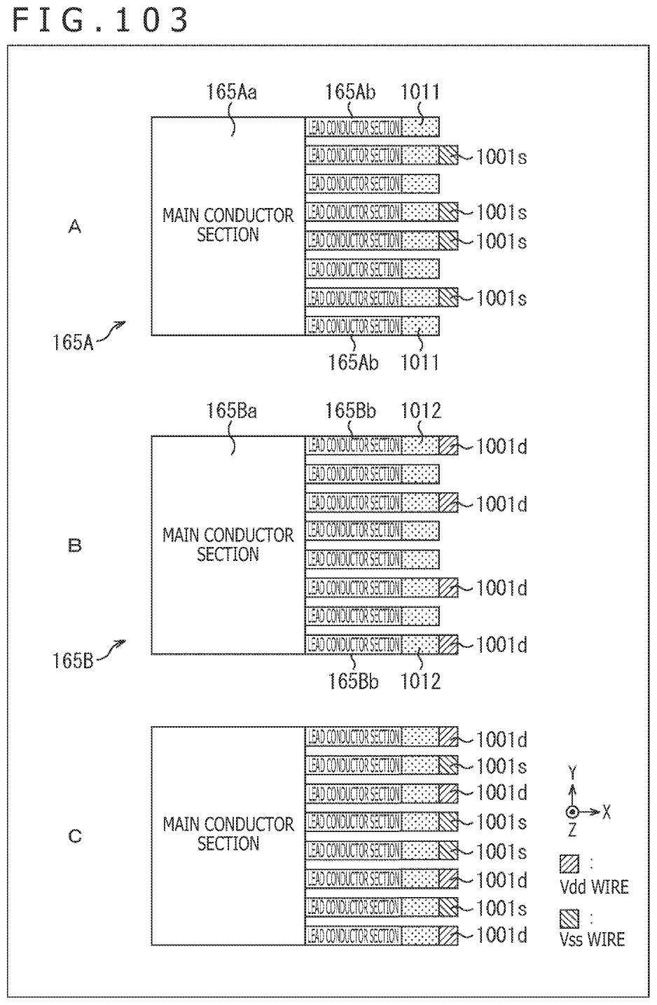

FIG. 103 depicts a fourteenth arrangement example of pads.

A in FIG. 103 is a plan view depicting an arrangement example of the conductor layer A (wiring layer 165A), and pads 1001s connected to the conductor layer A.

B in FIG. 103 is a plan view depicting an arrangement example of the conductor layer B (wiring layer 165B), and pads 1001d connected to the conductor layer B.

C in FIG. 103 is a plan view of the stacked state of the conductor layers A and B depicted in A and B in FIG. 103, respectively, and the pads 1001s and pads 1001d depicted in A and B in FIG. 103, respectively.

In FIG. 103, the pads 1001s represent pads 1001 to be supplied with GND or a negative power supply, for example, and the pads 1001d represent pads 1001 to be supplied with a positive power supply, for example.

As depicted in A in FIG. 103, one predetermined edge of the rectangular main conductor section 165Aa is connected with multiple lead conductor sections 165Ab, and an outer circumferential section of each lead conductor section 165Ab is connected with a conductor 1011 with a shape including, if desired, a predetermined repetition pattern. In addition, each of some of the multiple lead conductor sections 165Ab is connected with one pad 1001s via a conductor 1011. Each conductor 1011 may be omitted or may not be omitted. In addition, each conductor 1011 may be located between the main conductor section 165Aa and a lead conductor section 165Ab.

As depicted in B in FIG. 103, one predetermined edge of the rectangular main conductor section 165Ba is connected with multiple lead conductor sections 165Bb, and an outer circumferential section of each lead conductor section 165Bb is connected with a conductor 1012 with a shape including, if desired, a predetermined repetition pattern. In addition, one pad 1001d is arranged in each of some of the multiple lead conductor sections 165Bb via a conductor 1012. Each conductor 1012 may be omitted or may not be omitted. In addition, each conductor 1012 may be located between the main conductor section 165Ba and a lead conductor section 165Bb.

As depicted in C in FIG. 103, in the stacked state of the conductor layers A and B, the arrangement of the pads 1001s and the pads 1001d is a mirror-symmetric arrangement in which two sets of pads 1001, each set of which includes four pads 1001s and pads 1001d that are next to each other in the Y direction, are arranged sequentially in the Y direction, with one set of the pads 1001 being arranged in an order, and the other set of the pads 1001 being arranged in the reversed order. In this case, as compared with the alternating arrangement depicted in FIG. 102, it is possible to more effectively offset magnetic fields generated from the conductor layers A and B, and induced electromotive forces based on the magnetic fields, and so inductive noise can be ameliorated further, depending on the layouts of elements other than the pads.

### Fifteenth Arrangement Example of Pads

FIG. 104 depicts a fifteenth arrangement example of pads.

A in FIG. 104 is a plan view depicting an arrangement example of the conductor layer A (wiring layer 165A), and pads 1001s connected to the conductor layer A.

B in FIG. 104 is a plan view depicting an arrangement example of the conductor layer B (wiring layer 165B), and pads 1001d connected to the conductor layer B.

C in FIG. 104 is a plan view of the stacked state of the conductor layers A and B depicted in A and B in FIG. 104, respectively, and the pads 1001s and pads 1001d depicted in A and B in FIG. 104, respectively.

In FIG. 104, the pads 1001s represent pads 1001 to be supplied with GND or a negative power supply, for example, and the pads 1001d represent pads 1001 to be supplied with a positive power supply, for example.

As depicted in A in FIG. 104, one predetermined edge of the rectangular main conductor section 165Aa is connected with multiple lead conductor sections 165Ab, and an outer circumferential section of each lead conductor section 165Ab is connected with a conductor 1011 with a shape including, if desired, a predetermined repetition pattern. In addition, each of some of the multiple lead conductor sections 165Ab is connected with one pad 1001s via a conductor 1011. Each conductor 1011 may be omitted or may not be omitted. In addition, each conductor 1011 may be located between the main conductor section 165Aa and a lead conductor section 165Ab.

As depicted in B in FIG. 104, one predetermined edge of the rectangular main conductor section 165Ba is connected with multiple lead conductor sections 165Bb, and an outer circumferential section of each lead conductor section 165Bb is connected with a conductor 1012 with a shape including, if desired, a predetermined repetition pattern. In addition, one pad 1001d is arranged in each of some of the multiple lead conductor sections 165Bb via a conductor 1012. Each conductor 1012 may be omitted or may not be omitted. In addition, each conductor 1012 may be located between the main conductor section 165Ba and a lead conductor section 165Bb.

As depicted in C in FIG. 104, in the stacked state of the conductor layers A and B, the arrangement of the pads 1001s and the pads 1001d is a mirror-symmetric arrangement in which two sets of pads 1001, each set of which includes four pads 1001s and pads 1001d that are next to each other in the Y direction, are arranged sequentially in the Y direction, with one set of the pads 1001 being arranged in an order, and the other set of the pads 1001 being arranged in the reversed order. Furthermore, four pads 1001s and pads 1001d included in each set also are arranged in a mirror-symmetric arrangement in which one set of two pads 1001 is arranged on one side of the center line of the four pads 1001s and pads 1001d in the Y direction in the reversed order in the Y direction as compared to the other set of two pads 1001 arranged on the other side of the center line of the four pads 1001s and pads 1001d in the Y direction. In the case of the configuration with the twofold mirror-symmetric arrangement in such a manner, as compared with the configuration with the one fold mirror-symmetric arrangement depicted in FIG. 103, the range within which residual magnetic fields are accumulated is narrow. Accordingly, induced electromotive forces are offset more effectively, and inductive noise can be ameliorated further, depending on the layouts of elements other than the pads.

While, in the examples of the arrangement of pads explained with reference to FIG. 93 to FIG. 104, the total number of pads connected to one predetermined edge of the main conductor section 165a of the conductor layers A and B is eight, and the array of the eight pads 1001 that are next to each other in the Y direction is an alternating arrangement, a configuration with the one fold mirror-symmetric arrangement or a configuration with the twofold mirror-symmetric arrangement, the total number of pads may be any number other than eight, and the pads may be arrayed in an alternating arrangement, a configuration with the one fold mirror-symmetric arrangement or a configuration with the twofold mirror-symmetric arrangement. The number of pads to form one set in an alternating arrangement or a mirror-symmetric arrangement also is not limited to two or four as in the examples mentioned above, but may be any number.

In addition, the number of pads connected to one lead conductor section 165b also is not limited to one or two as in the examples depicted in FIG. 93 to FIG. 104, but may be three or larger.

Furthermore, while, in the examples depicted in FIG. 93 to FIG. 104, multiple pads 1001 are connected with only one predetermined edge of the main conductor section 165a of the rectangular conductor layers A and B for simplification of the explanation, the multiple pads 1001 may be connected to one edge other than the edge depicted in FIG. 93 to FIG. 104 or any two edges, three edges, or four edges.

While the total number of pads is eight in the examples explained, this is not essential. The number of pads may be increased, or the number of pads may be reduced.

Constituent elements depicted in pad arrangement examples may be omitted partially or entirely, may be changed partially or entirely, may be modified partially or entirely, may be replaced with other constituent elements partially or entirely, or may have other additional constituent elements partially or entirely. In addition, constituent elements depicted in pad arrangement examples may be divided into multiple constituent elements partially or entirely, may be separated into multiple constituent elements partially or entirely, or may achieve mutually different functionality or features with at least some of the multiple divided or separated constituent elements. Also, at least some of constituent elements depicted in pad arrangement examples may be combined as desired to form different pad arrangements. Further, at least some of constituent elements depicted in pad arrangement examples may be shifted as desired to form different pad arrangements. In addition, combinations of at least some of constituent elements depicted in pad arrangement examples may have additional coupling elements or relay elements to form different pad arrangements. Furthermore, combinations of at least some of constituent elements depicted in pad arrangement examples may have additional switching elements or switching functionality to form different pad arrangements.

### Sixteenth Arrangement Example of Pads

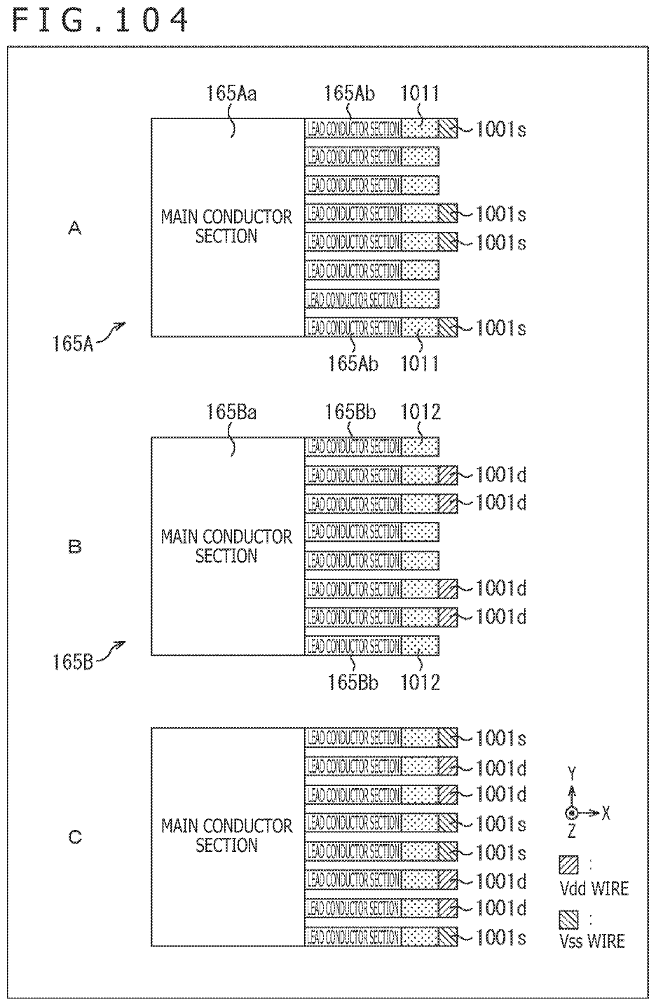

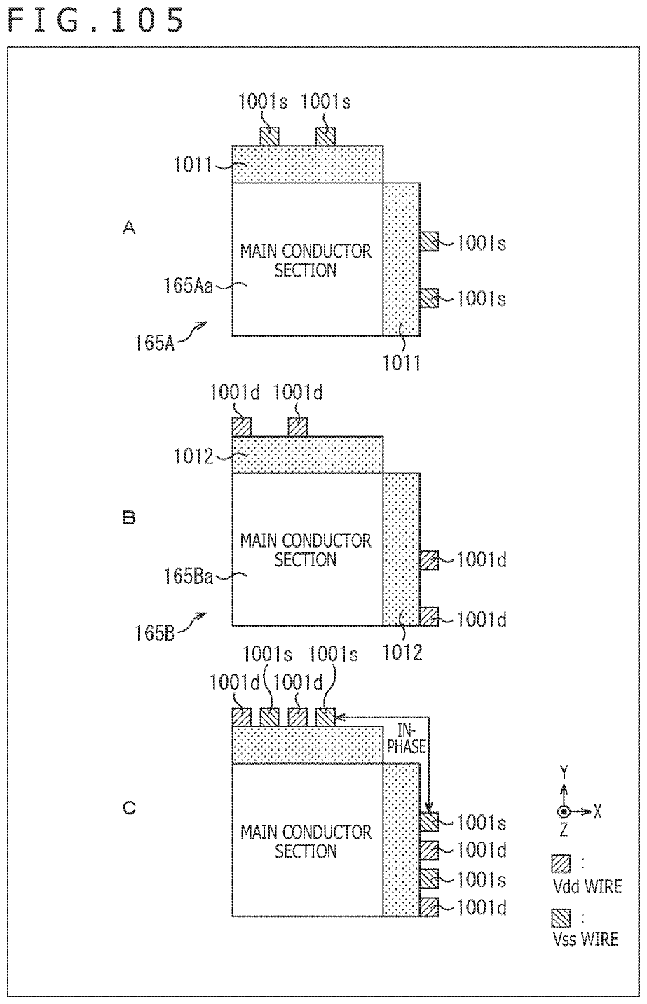

Next, orthogonal pad arrangement examples in a case in which multiple pads 1001 are arranged along two adjacent edges of the rectangular main conductor section 165a of the conductor layers A and B are explained with reference to FIG. 105 to FIG. 108.

FIG. 105 depicts a sixteenth arrangement example of pads.

A in FIG. 105 is a plan view depicting an arrangement example of the conductor layer A (wiring layer 165A), and pads 1001s connected to the conductor layer A.

B in FIG. 105 is a plan view depicting an arrangement example of the conductor layer B (wiring layer 165B), and pads 1001d connected to the conductor layer B.

C in FIG. 105 is a plan view of the stacked state of the conductor layers A and B depicted in A and B in FIG. 105, respectively, and the pads 1001s and pads 1001d depicted in A and B in FIG. 105, respectively.

In FIG. 105, the pads 1001s represent pads 1001 to be supplied with GND or a negative power supply, for example, and the pads 1001d represent pads 1001 to be supplied with a positive power supply, for example.

As depicted in A in FIG. 105, two adjacent edges of the rectangular main conductor section 165Aa are connected with multiple pads 1001s at predetermined intervals via the conductors 1011 each with a shape including, if desired, a predetermined repetition pattern. Each pad 1001s may include the lead conductor section 165Ab, or each conductor 1011 may include the lead conductor section 165Ab. In addition, in a case in which the pads 1001s are the lead conductor sections 165Ab, each conductor 1011 may be omitted or may not be omitted.

As depicted in B in FIG. 105, two adjacent edges of the rectangular main conductor section 165Ba are connected with multiple pads 1001d at predetermined intervals via the conductors 1012 each with a shape including, if desired, a predetermined repetition pattern. Each pad 1001d may include the lead conductor section 165Bb, or each conductor 1012 may include the lead conductor section 165Bb. In addition, in a case in which the pads 1001d are the lead conductor sections 165Bb, each conductor 1012 may be omitted or may not be omitted.

As depicted in C in FIG. 105, in the stacked state of the conductor layers A and B, the arrangement of the pads 1001s and the pads 1001d is an alternating arrangement in which the pad 1001s and the pad 1001d are arranged alternately along two adjacent edges of the rectangular main conductor section 165a. In addition, regarding polarities, both pads 1001 at end sections of the edges in the pads 1001s and pads 1001d that are arranged alternately along the two edges are pads 1001s connected to GND or a negative power supply. Because the polarities of the pads 1001 at the end sections closest to a corner section of the board 1000 in the multiple pads 1001 along the two edges including the alternately arranged pads 1001s and pads 1001d in this manner have the same phase, and are pads 1001s with a polarity that provides higher ESD (electrostatic discharge) resistance, the ESD resistance can be increased.

Note that if the ESD resistance is taken into consideration, regarding polarity, the pads 1001 at the end sections of the two edges including the alternately arranged pads 1001s and pads 1001d are preferably pads 1001s connected to GND or a negative power supply, for example, but may be pads 1001d connected to a positive power supply, for example.

### Seventeenth Arrangement Example of Pads

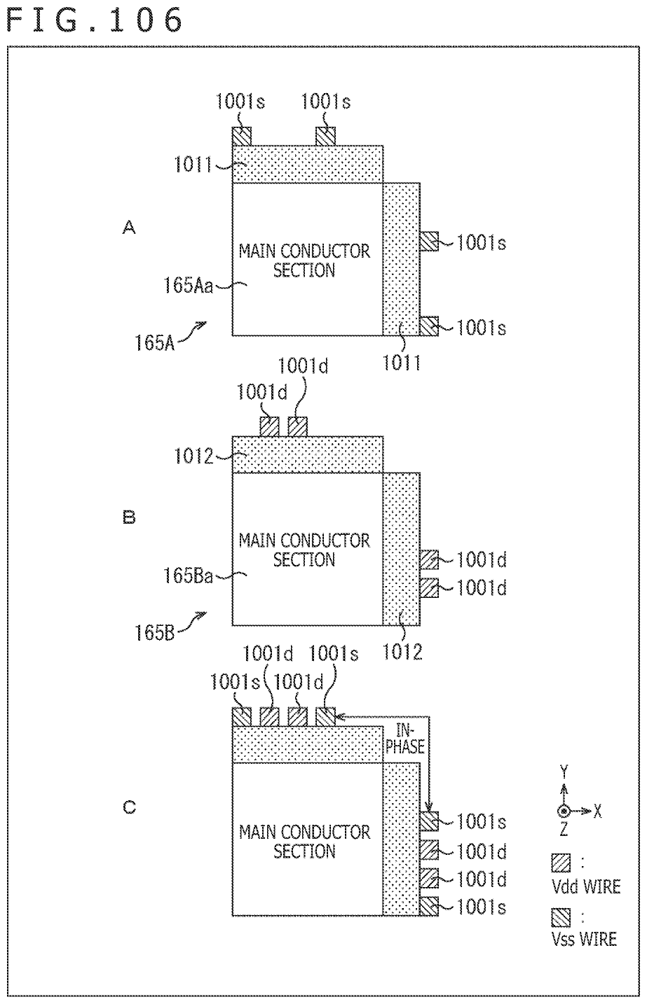

FIG. 106 depicts a seventeenth arrangement example of pads.

A in FIG. 106 is a plan view depicting an arrangement example of the conductor layer A (wiring layer 165A), and pads 1001s connected to the conductor layer A.

B in FIG. 106 is a plan view depicting an arrangement example of the conductor layer B (wiring layer 165B), and pads 1001d connected to the conductor layer B.

C in FIG. 106 is a plan view of the stacked state of the conductor layers A and B depicted in A and B in FIG. 106, respectively, and the pads 1001s and pads 1001d depicted in A and B in FIG. 106, respectively.

In FIG. 106, the pads 1001s represent pads 1001 to be supplied with GND or a negative power supply, for example, and the pads 1001d represent pads 1001 to be supplied with a positive power supply, for example.

As depicted in A in FIG. 106, two adjacent edges of the rectangular main conductor section 165Aa are connected with multiple pads 1001s at predetermined intervals via the conductors 1011 each with a shape including, if desired, a predetermined repetition pattern. Each pad 1001s may include the lead conductor section 165Ab, or each conductor 1011 may include the lead conductor section 165Ab. In addition, in a case in which the pads 1001s are the lead conductor sections 165Ab, each conductor 1011 may be omitted or may not be omitted.

As depicted in B in FIG. 106, two adjacent edges of the rectangular main conductor section 165Ba are connected with multiple pads 1001d at predetermined intervals via the conductors 1012 each with a shape including, if desired, a predetermined repetition pattern. Each pad 1001d may include the lead conductor section 165Bb, or each conductor 1012 may include the lead conductor section 165Bb. In addition, in a case in which the pads 1001d are the lead conductor sections 165Bb, each conductor 1012 may be omitted or may not be omitted.

As depicted in C in FIG. 106, in the stacked state of the conductor layers A and B, similarly to the pad arrangement example depicted in C in FIG. 95, the pad arrangement is a mirror-symmetric arrangement in which two sets of pads 1001, each set of which includes four pads 1001s and pads 1001d that are next to each other, are arranged sequentially in the Y direction, with one set of the pads 1001 being arranged in an order, and the other set of the pads 1001 being arranged in the reversed order. In addition, regarding polarities, both pads 1001 at end sections of the edges in the pads 1001s and pads 1001d that are arranged mirror-symmetrically along the two edges are pads 1001s connected to GND or a negative power supply. Because the polarities of the pads 1001 at the end sections closest to a corner section of the board 1000 in the multiple pads 1001 along the two edges including the mirror-symmetrically arranged pads 1001s and pads 1001d in this manner have the same phase, and are pads 1001s with a polarity that provides higher ESD resistance, the ESD resistance can be increased. In addition, by adopting the mirror-symmetric arrangement, the impedance difference and electric current difference between Vss wires and Vdd wires decrease, and so inductive noise can be ameliorated more than in the sixteenth arrangement example in FIG. 105.

Note that if the ESD resistance is taken into consideration, regarding polarity, the pads 1001 at the end sections of the two edges including the mirror-symmetrically arranged pads 1001s and pads 1001d are preferably pads 1001s connected to GND or a negative power supply, for example, but may be pads 1001d connected to a positive power supply, for example.

### Eighteenth Arrangement Example of Pads

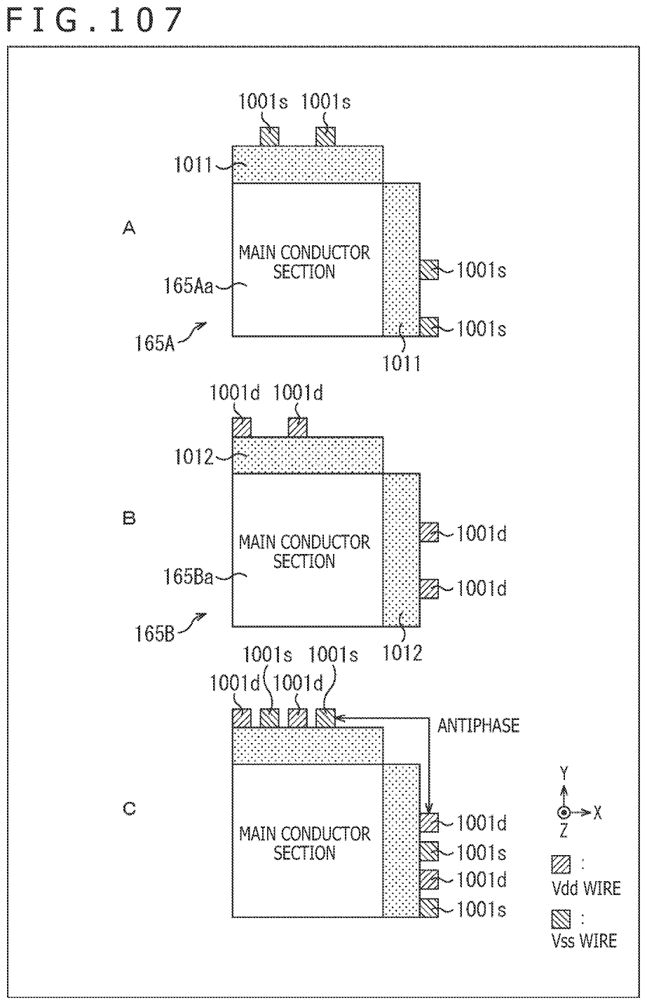

FIG. 107 depicts an eighteenth arrangement example of pads.

A in FIG. 107 is a plan view depicting an arrangement example of the conductor layer A (wiring layer 165A), and pads 1001s connected to the conductor layer A.

B in FIG. 107 is a plan view depicting an arrangement example of the conductor layer B (wiring layer 165B), and pads 1001d connected to the conductor layer B.

C in FIG. 107 is a plan view of the stacked state of the conductor layers A and B depicted in A and B in FIG. 107, respectively, and the pads 1001s and pads 1001d depicted in A and B in FIG. 107, respectively.

In FIG. 107, the pads 1001s represent pads 1001 to be supplied with GND or a negative power supply, for example, and the pads 1001d represent pads 1001 to be supplied with a positive power supply, for example.

As depicted in A in FIG. 107, two adjacent edges of the rectangular main conductor section 165Aa are connected with multiple pads 1001s at predetermined intervals via the conductors 1011 each with a shape including, if desired, a predetermined repetition pattern. Each pad 1001s may include the lead conductor section 165Ab, or each conductor 1011 may include the lead conductor section 165Ab. In addition, in a case in which the pads 1001s are the lead conductor sections 165Ab, each conductor 1011 may be omitted or may not be omitted.

As depicted in B in FIG. 107, two adjacent edges of the rectangular main conductor section 165Ba are connected with multiple pads 1001d at predetermined intervals via the conductors 1012 each with a shape including, if desired, a predetermined repetition pattern. Each pad 1001d may include the lead conductor section 165Bb, or each conductor 1012 may include the lead conductor section 165Bb. In addition, in a case in which the pads 1001d are the lead conductor sections 165Bb, each conductor 1012 may be omitted or may not be omitted.

As depicted in C in FIG. 107, in the stacked state of the conductor layers A and B, similarly to the pad arrangement example depicted in FIG. 105, the arrangement of the pads 1001s and the pads 1001d is an alternating arrangement in which the pad 1001s and the pad 1001d are arranged alternately. It should be noted however that this arrangement is different from the pad arrangement example depicted in FIG. 105 in that pads 1001 at end sections of two edges in the pads 1001s and the pads 1001d that are arranged along the edges are a pad 1001s and a pad 1001d which have mutually reverse phases. In this manner, because the polarities of the pads 1001 at the end sections closest to a corner section of the board 1000 in the multiple pads 1001 along two edges including alternately arranged pads 1001s and pads 1001d are reverse phases, the impedance difference and electric current difference between Vss wires and Vdd wires can be reduced further, and so inductive noise can be ameliorated more than in the seventeenth arrangement example in FIG. 106.

### Nineteenth Arrangement Example of Pads

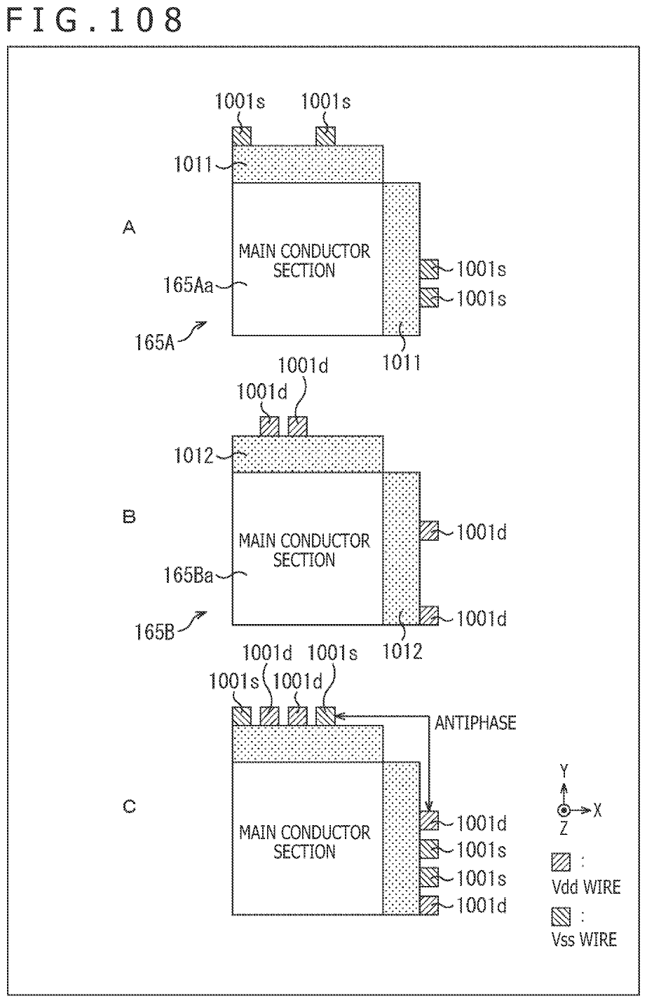

FIG. 108 depicts a nineteenth arrangement example of pads.

A in FIG. 108 is a plan view depicting an arrangement example of the conductor layer A (wiring layer 165A), and pads 1001s connected to the conductor layer A.

B in FIG. 108 is a plan view depicting an arrangement example of the conductor layer B (wiring layer 165B), and pads 1001d connected to the conductor layer B.

C in FIG. 108 is a plan view of the stacked state of the conductor layers A and B depicted in A and B in FIG. 108, respectively, and the pads 1001s and pads 1001d depicted in A and B in FIG. 108, respectively.

In FIG. 108, the pads 1001s represent pads 1001 to be supplied with GND or a negative power supply, for example, and the pads 1001d represent pads 1001 to be supplied with a positive power supply, for example.

As depicted in A in FIG. 108, two adjacent edges of the rectangular main conductor section 165Aa are connected with multiple pads 1001s at predetermined intervals via the conductors 1011 each with a shape including, if desired, a predetermined repetition pattern. Each pad 1001s may include the lead conductor section 165Ab, or each conductor 1011 may include the lead conductor section 165Ab. In addition, in a case in which the pads 1001s are the lead conductor sections 165Ab, each conductor 1011 may be omitted or may not be omitted.

As depicted in B in FIG. 108, two adjacent edges of the rectangular main conductor section 165Ba are connected with multiple pads 1001d at predetermined intervals via the conductors 1012 each with a shape including, if desired, a predetermined repetition pattern. Each pad 1001d may include the lead conductor section 165Bb, or each conductor 1012 may include the lead conductor section 165Bb. In addition, in a case in which the pads 1001d are the lead conductor sections 165Bb, each conductor 1012 may be omitted or may not be omitted.

As depicted in C in FIG. 108, in the stacked state of the conductor layers A and B, similarly to the pad arrangement example depicted in FIG. 106, the arrangement of the pads 1001s and the pads 1001d is an arrangement in which the pad 1001s and the pad 1001d are arranged mirror-symmetrically. It should be noted however that this arrangement is different from the pad arrangement example depicted in FIG. 106 in that pads 1001 at end sections of two edges in the pads 1001s and the pads 1001d that are arranged along the edges are a pad 1001s and a pad 1001d which have mutually reverse phases. In this manner, because the polarities of the pads 1001 at the end sections closest to a corner section of the board 1000 in the multiple pads 1001 along two edges including mirror-symmetrically arranged pads 1001s and pads 1001d are reverse phases, the impedance difference and electric current difference between Vss wires and Vdd wires can be reduced further, and so inductive noise can be ameliorated more than in the seventeenth arrangement example in FIG. 106.

While, in the examples explained in the sixteenth to nineteenth arrangement examples of pads explained with reference to FIG. 105 to FIG. 108, multiple pads 1001 are arranged along two adjacent edges of the rectangular main conductor section 165a via the conductors 1011 or 1012 at predetermined intervals, the number of edges along which pads 1001 are arranged is not limited to two, but may be three or four.

In addition, while, in the examples depicted in the sixteenth to nineteenth arrangement examples of pads explained with reference to FIG. 105 to FIG. 108, the alternating arrangement in FIG. 93, and the configuration with the twofold mirror-symmetric arrangement in FIG. 95 are adopted as modes of pads 1001 arranged along one edge, the configuration with the one fold mirror-symmetric arrangement in FIG. 94 may be adopted, and the polarities of pads 1001 at end sections closest to a corner section may be made the same phase or reverse phases, in one possible mode.

Furthermore, while the lead conductor section 165b is omitted in the modes in the sixteenth to nineteenth arrangement examples of pads explained with reference to FIG. 105 to FIG. 108, the alternating arrangement in FIG. 93, the configuration with the one fold mirror-symmetric arrangement in FIG. 94 or the configuration with the twofold mirror-symmetric arrangement in FIG. 95 may be adopted in a configuration including the lead conductor section 165b along an edge of the rectangular main conductor section 165Aa as in FIG. 96 to FIG. 104, and the polarities of pads 1001 at end sections closest to a corner section may be made the same phase or reverse phases, in one possible mode.

Note that the lead conductor sections 165Ab and 165Bb and the conductors 1011 and 1012 are desirably configured such that, for example, GND or a negative power supply is supplied from pads 1001s to the main conductor section 165Aa, and a positive power supply with the reverse polarity is supplied from pads 1001d to the main conductor section 165Ba, but this is not essential. In other words, the lead conductor sections 165Ab and 165Bb, and the conductors 1011 and 1012 are desirably configured such that GND or a negative power supply, for example, supplied from pads 1001, and a positive power supply with the reverse polarity are prevented from being completely short-circuited, but this is not essential. Note that while examples depicted in at least some of FIG. 92 to FIG. 108 include an example in which multiple pads 1001s are arranged, an example in which multiple pads 1001d are arranged, an example in which multiple conductors 1011 are arranged, an example in which multiple conductors 1012 are arranged, an example in which multiple lead conductor sections 165Ab are arranged, an example in which multiple lead conductor sections 165Bb are arranged, and the like, in each of the figures, all the pads 1001s may be the same, all the pads 1001s do not have to be the same, all the pads 1001d may be the same, all the pads 1001d do not have to be the same, all the conductors 1011 may be the same, all the conductors 1011 do not have to be the same, all the conductors 1012 may be the same, all the conductors 1012 do not have to be the same, all the lead conductor sections 165Ab may be the same, all the lead conductor sections 165Ab do not have to be the same, all the lead conductor sections 165Bb may be the same, and all the lead conductor sections 165Bb do not have to be the same. Note that desirably at least one of the following conditions is, but is not necessarily, satisfied: the total numbers of pads 1001s and pads 1001d that are directly or indirectly connected to the main conductor section 165a in the board 1000 are the same number or substantially the same numbers; the total numbers of pads 1001s and pads 1001d connected directly or indirectly to the main conductor section 165a along two predetermined adjacent edges of the board 1000 are the same number or substantially the same numbers; the total numbers of pads 1001s and pads 1001d that are connected directly or indirectly to the main conductor section 165a along two predetermined opposite edges of the board 1000 are the same number or substantially the same numbers; the total numbers of pads 1001s and pads 1001d that are connected directly or indirectly to the main conductor section 165a along one predetermined edge of the board 1000 are the same number or substantially the same numbers; the total numbers of pads 1001s and pads 1001d that are connected directly or indirectly to at least two lead conductor sections 165b along two predetermined adjacent edges of the board 1000 are the same number or substantially the same numbers; the total numbers of pads 1001s and pads 1001d that are connected directly or indirectly to at least two lead conductor sections 165b along two predetermined opposite edges of the board 1000 are the same number or substantially the same numbers; the total numbers of pads 1001s and pads 1001d that are connected directly or indirectly to at least one lead conductor section 165b along one predetermined edge of the board 1000 are the same number or substantially the same numbers; the total numbers of pads 1001s and pads 1001d connected directly or indirectly to at least two sets of conductors 1011 and 1012 along two predetermined adjacent edges of the board 1000 are the same number or substantially the same numbers; the total numbers of pads 1001s and pads 1001d that are connected directly or indirectly to at least two sets of conductors 1011 and 1012 along two predetermined opposite edges of the board 1000 are the same number or substantially the same numbers; and the total numbers of pads 1001s and pads 1001d that are connected directly or indirectly to at least one set of conductors 1011 and 1012 along one predetermined edge of the board 1000 are the same number or substantially the same numbers. For example, the total numbers of pads 1001s and pads 1001d described above do not have to be the same number, and the total numbers of pads 1001s and pads 1001d described above do not have to be substantially the same numbers.

### Board Arrangement Examples of Victim Conductor Loop and Aggressor Conductor Loops

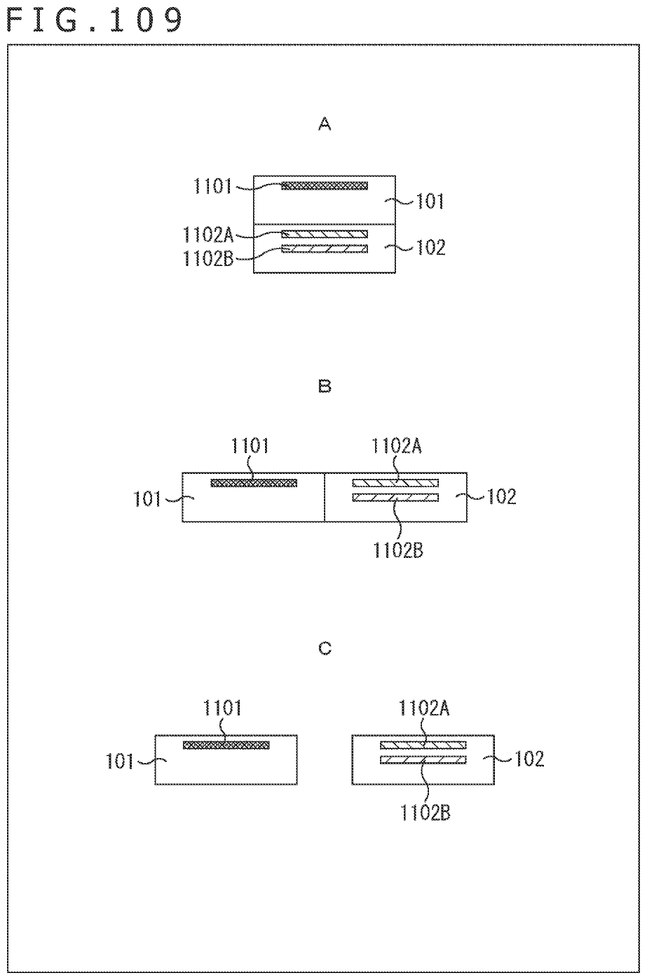

FIG. 109 depicts board arrangement examples of a Victim conductor loop and Aggressor conductor loops.

A in FIG. 109 is a cross-sectional view schematically depicting a board arrangement example of the Victim conductor loop and the Aggressor conductor loops mentioned thus far.

In the structure explained in each configuration example mentioned above, as depicted in A in FIG. 109, a Victim conductor loop 1101 is included in the first semiconductor board 101, Aggressor conductor loops 1102A and 1102B are included in the second semiconductor board 102, and the first semiconductor board 101 and the second semiconductor board 102 are stacked one on another.

However, in one possible structure, the first semiconductor board 101 and the second semiconductor board 102 may not be stacked one on another, and, as in B in FIG. 109, the first semiconductor board 101 and the second semiconductor board 102 may be arranged adjacent to each other, or, as in C in FIG. 109, the first semiconductor board 101 and the second semiconductor board 102 may be arranged on the same plane with a predetermined interval therebetween.

Furthermore, various types of arrangement configuration like the ones depicted in A to I in FIG. 110 can be adopted as the board arrangement of the Victim conductor loop and the Aggressor conductor loops.

A in FIG. 110 depicts a structure in which the Victim conductor loop 1101 is included in the first semiconductor board 101, the Aggressor conductor loops 1102A and 1102B are included in the second semiconductor board 102, a third semiconductor board 103 is inserted between the first semiconductor board 101 and the second semiconductor board 102, and the first semiconductor board 101 to the third semiconductor board 103 are stacked one on another.

B in FIG. 110 depicts a structure in which the Victim conductor loop 1101 is included in the first semiconductor board 101, the Aggressor conductor loop 1102A is included in the second semiconductor board 102, the Aggressor conductor loop 1102B is included in the third semiconductor board 103, and the first semiconductor board 101 to the third semiconductor board 103 are stacked one on another in this order.

C in FIG. 110 depicts a structure in which the Victim conductor loop 1101 is included in the first semiconductor board 101, the Aggressor conductor loops 1102A and 1102B are included in the second semiconductor board 102, a support board 104 is inserted between the first semiconductor board 101 and the second semiconductor board 102, and the first semiconductor board 101, the support board 104 and the second semiconductor board 102 are stacked one on another in this order. The support board 104 may be omitted, and the first semiconductor board 101 and the second semiconductor board 102 may be arranged with a predetermined gap therebetween.

D in FIG. 110 depicts a structure in which the Victim conductor loop 1101 is included in the first semiconductor board 101, the Aggressor conductor loops 1102A and 1102B are included in the second semiconductor board 102, and the first semiconductor board 101 and the second semiconductor board 102 are placed on the support board 104 and are arranged on the same plane with a predetermined interval therebetween. The support board 104 may be omitted, and the first semiconductor board 101 and the second semiconductor board 102 may be supported at another portion such that the first semiconductor board 101 and the second semiconductor board 102 are arranged on the same plane.

E in FIG. 110 depicts a structure in which the Victim conductor loop 1101 and the Aggressor conductor loop 1102A are included in the first semiconductor board 101, the Aggressor conductor loop 1102B is included in the second semiconductor board 102, and the first semiconductor board 101 and the second semiconductor board 102 are stacked one on another. Here, an XY-plane region that is in the first semiconductor board 101, and where the Victim conductor loop 1101 is formed at least partially overlaps an XY-plane region that is in the second semiconductor board 102, and where the Aggressor conductor loops 1102A and 1102B are formed.

F in FIG. 110 depicts a structure in which the Victim conductor loop 1101 is included in the first semiconductor board 101, the Aggressor conductor loops 1102A and 1102B are included in the second semiconductor board 102, and the first semiconductor board 101 and the second semiconductor board 102 are stacked one on another. Here, an XY-plane region that is in the first semiconductor board 101, and where the Victim conductor loop 1101 is formed may be a region that is completely different from or partially overlaps an XY-plane region that is in the second semiconductor board 102, and where the Aggressor conductor loops 1102A and 1102B are formed.

G in FIG. 110 depicts a structure in which the Victim conductor loop 1101 and the Aggressor conductor loop 1102A are included in the first semiconductor board 101, the Aggressor conductor loop 1102B is included in the second semiconductor board 102, and the first semiconductor board 101 and the second semiconductor board 102 are stacked one on another. Here, an XY-plane region that is in the first semiconductor board 101, and where the Victim conductor loop 1101 is formed is a region that is different from an XY-plane region where the Aggressor conductor loops 1102A and 1102B are formed.

H in FIG. 110 depicts a structure in which the Victim conductor loop 1101, and the Aggressor conductor loops 1102A and 1102B are included in one semiconductor board 105. It should be noted however that, in the one semiconductor board 105, an XY-plane region where the Victim conductor loop 1101 is formed at least partially overlaps an XY-plane region where the Aggressor conductor loops 1102A and 1102B are formed.

I in FIG. 110 depicts a structure in which the Victim conductor loop 1101, and the Aggressor conductor loops 1102A and 1102B are included in the one semiconductor board 105. It should be noted however that, in the one semiconductor board 105, an XY-plane region where the Victim conductor loop 1101 is formed is a region that is different from an XY-plane region where the Aggressor conductor loops 1102A and 1102B are formed.

The stacking orders of boards depicted in A to I in FIG. 110 may be reversed, and the positions of the Victim conductor loop 1101, and the Aggressor conductor loops 1102A and 1102B may be reversed vertically.

As mentioned above, there can be various types of structure in terms of the number and arrangement of semiconductor boards including the Victim conductor loop 1101, and the Aggressor conductor loops 1102A and 1102B, and whether or not of there is a support board.

The Aggressor conductor loops that generate magnetic flux to pass across the loop plane of the Victim conductor loop may be or may not be superimposed on the Victim conductor loop. Further, the Aggressor conductor loops may be formed in multiple semiconductor boards that are stacked on a semiconductor board in which the Victim conductor loop is formed, or may be formed in the semiconductor board in which the Victim conductor loop is formed.

Further, the Aggressor conductor loops may not be formed in a semiconductor board. Possible examples of boards in which the Aggressor conductor loops may be formed include various boards such as a printed board, a flexible printed board, an interposer board, a package board, an inorganic board, or an organic board, for example, and any board that includes a conductor or can form a conductor is sufficient. The Aggressor conductor loops may be present in a circuit other than a semiconductor board such as a package in which a semiconductor board is sealed in. Typically, the distances of the Aggressor conductor loops from the Victim conductor loop are the longest in a case in which the Aggressor conductor loops are formed in a semiconductor board, and are the second longest in a case in which the Aggressor conductor loops are formed in a package, and are the shortest in a case in which the Aggressor conductor loops are formed in a printed board, if these three cases are compared with each other. Because inductive noise and capacitive noise that can be generated to the Victim conductor loop increase more easily as the distances of the Aggressor conductor loops from the Victim conductor loop decrease, the present technology can provide a more significant effect as the distances of the Aggressor conductor loops from the Victim conductor loop decrease. Furthermore, the present technology can be applied not only to boards, but also to conductors themselves represented by conductive wires and conductive boards like bonding wires, leads, antenna lines, electric power lines, GND lines, coaxial lines, dummy lines, metal boards and the like.

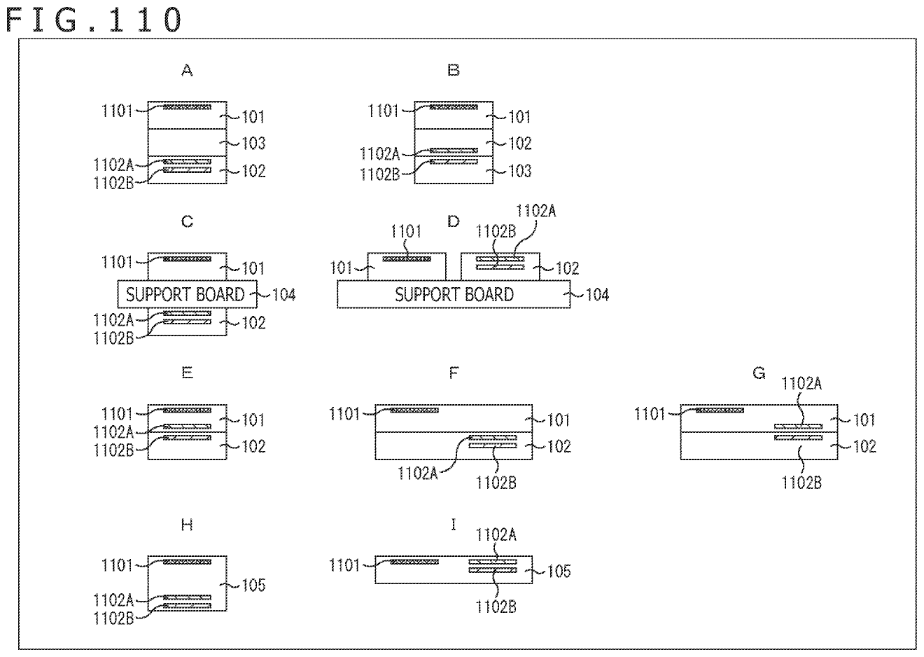

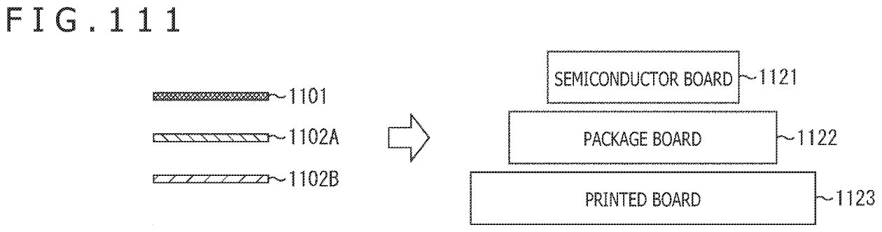

In an arrangement example explained next, as depicted in FIG. 111, a conductor 1101 (hereinafter, referred to as the Victim conductor loop 1101) which is at least part of the Victim conductor loop, and conductors 1102A and 1102B (hereinafter, referred to as the Aggressor conductor loops 1102A and 1102B) which are at least part of the Aggressor conductor loops are arranged in a structure in which three types of board which are a semiconductor board 1121, a package board 1122 and a printed board 1123 are stacked one on another. Note that, although an illustration is omitted, the Victim conductor loop or Aggressor conductor loops mentioned above at least include(s) conductors arranged in two or more boards in the semiconductor board 1121, the package board 1122 and the printed board 1123, in some cases. The semiconductor board 1121 can be replaced with any of a package board, an interposer board, a printed board, a flexible printed board, an inorganic board, an organic board, a board including a conductor and a board that can form a conductor. In addition, the package board 1122 can be replaced with any of a semiconductor board, an interposer board, a printed board, a flexible printed board, an inorganic board, an organic board, a board including a conductor and a board that can form a conductor. Furthermore, the printed board 1123 can be replaced with any of a semiconductor board, a package board, an interposer board, a flexible printed board, an inorganic board, an organic board, a board including a conductor and a board that can form a conductor.

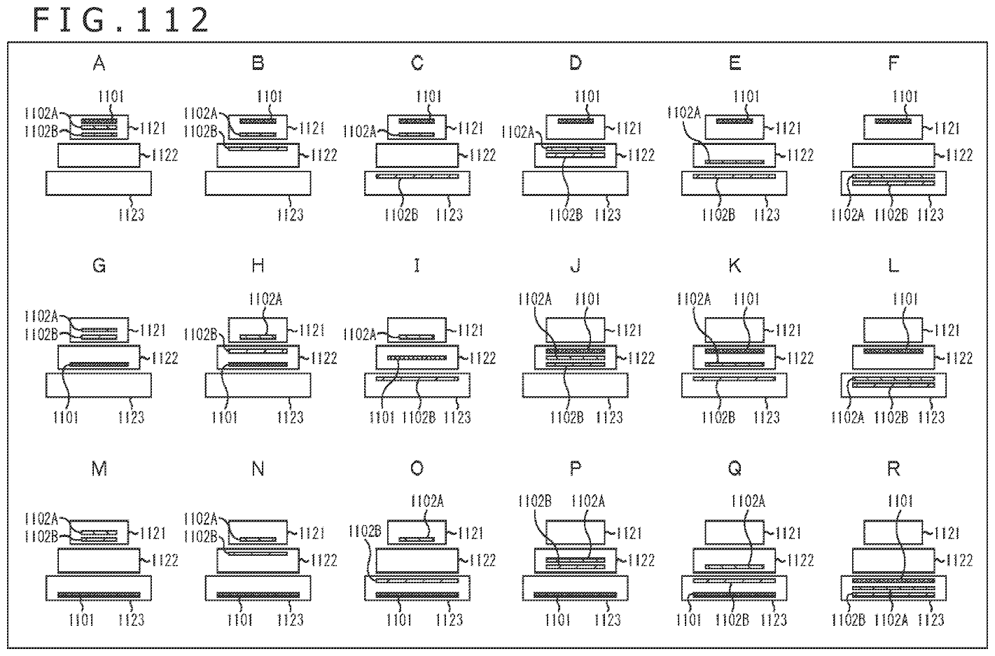

A to R in FIG. 112 depict arrangement examples of the Victim conductor loop and the Aggressor conductor loops in stacked structures in which the three types of board depicted in FIG. 111 are stacked one on another.

A in FIG. 112 depicts a schematic diagram of a stacked structure in which all of the Victim conductor loop 1101, and the Aggressor conductor loops 1102A and 1102B are included in the semiconductor board 1121. The package board 1122 and the printed board 1123 in which none of the Victim conductor loop 1101, and the Aggressor conductor loops 1102A and 1102B is formed may be omitted.

B in FIG. 112 depicts a schematic diagram of a stacked structure in which the Victim conductor loop 1101 and the Aggressor conductor loop 1102A are included in the semiconductor board 1121, and the Aggressor conductor loop 1102B is included in the package board 1122. The printed board 1123 in which none of the Victim conductor loop 1101, and the Aggressor conductor loops 1102A and 1102B is formed may be omitted.

C in FIG. 112 depicts a schematic diagram of a stacked structure in which the Victim conductor loop 1101 and the Aggressor conductor loop 1102A are included in the semiconductor board 1121, and the Aggressor conductor loop 1102B is included in the printed board 1123. The package board 1122 in which none of the Victim conductor loop 1101, and the Aggressor conductor loops 1102A and 1102B is formed may be omitted.

D in FIG. 112 depicts a schematic diagram of a stacked structure in which the Victim conductor loop 1101 is included in the semiconductor board 1121, and the Aggressor conductor loops 1102A and 1102B are included in the package board 1122. The printed board 1123 in which none of the Victim conductor loop 1101, and the Aggressor conductor loops 1102A and 1102B is formed may be omitted.

E in FIG. 112 depicts a schematic diagram of a stacked structure in which the Victim conductor loop 1101 is included in the semiconductor board 1121, the Aggressor conductor loop 1102A is included in the package board 1122, and the Aggressor conductor loop 1102B is included in the printed board 1123.

F in FIG. 112 depicts a schematic diagram of a stacked structure in which the Victim conductor loop 1101 is included in the semiconductor board 1121, and the Aggressor conductor loops 1102A and 1102B are included in the printed board 1123. The package board 1122 in which none of the Victim conductor loop 1101, and the Aggressor conductor loops 1102A and 1102B is formed may be omitted.

G in FIG. 112 depicts a schematic diagram of a stacked structure in which the Aggressor conductor loops 1102A and 1102B are included in the semiconductor board 1121, and the Victim conductor loop 1101 is included in the package board 1122. The printed board 1123 in which none of the Victim conductor loop 1101, and the Aggressor conductor loops 1102A and 1102B is formed may be omitted.

H in FIG. 112 depicts a schematic diagram of a stacked structure in which the Aggressor conductor loop 1102A is included in the semiconductor board 1121, and the Aggressor conductor loop 1102B and the Victim conductor loop 1101 are included in the package board 1122. The printed board 1123 in which none of the Victim conductor loop 1101, and the Aggressor conductor loops 1102A and 1102B is formed may be omitted.

I in FIG. 112 depicts a schematic diagram of a stacked structure in which the Aggressor conductor loop 1102A is included in the semiconductor board 1121, the Victim conductor loop 1101 is included in the package board 1122, and the Aggressor conductor loop 1102B is included in the printed board 1123.

J in FIG. 112 depicts a schematic diagram of a stacked structure in which all of the Victim conductor loop 1101, and the Aggressor conductor loops 1102A and 1102B are included in the package board 1122. The semiconductor board 1121 and the printed board 1123 in which none of the Victim conductor loop 1101, and the Aggressor conductor loops 1102A and 1102B is formed may be omitted.

K in FIG. 112 depicts a schematic diagram of a stacked structure in which the Victim conductor loop 1101 and the Aggressor conductor loop 1102A are included in the package board 1122, and the Aggressor conductor loop 1102B is included in the printed board 1123. The semiconductor board 1121 in which none of the Victim conductor loop 1101, and the Aggressor conductor loops 1102A and 1102B is formed may be omitted.

L in FIG. 112 depicts a schematic diagram of a stacked structure in which the Victim conductor loop 1101 is included in the package board 1122, and the Aggressor conductor loops 1102A and 1102B are included in the printed board 1123. The semiconductor board 1121 in which none of the Victim conductor loop 1101, and the Aggressor conductor loops 1102A and 1102B is formed may be omitted.

M in FIG. 112 depicts a schematic diagram of a stacked structure in which the Aggressor conductor loops 1102A and 1102B are included in the semiconductor board 1121, and the Victim conductor loop 1101 is included in the printed board 1123. The package board 1122 in which none of the Victim conductor loop 1101, and the Aggressor conductor loops 1102A and 1102B is formed may be omitted.

N in FIG. 112 depicts a schematic diagram of a stacked structure in which the Aggressor conductor loop 1102A is included in the semiconductor board 1121, the Aggressor conductor loop 1102B is included in the package board 1122, and the Victim conductor loop 1101 is included in the printed board 1123.

O in FIG. 112 depicts a schematic diagram of a stacked structure in which the Aggressor conductor loop 1102A is included in the semiconductor board 1121, and the Aggressor conductor loop 1102B and the Victim conductor loop 1101 are included in the printed board 1123. The package board 1122 in which none of the Victim conductor loop 1101, and the Aggressor conductor loops 1102A and 1102B is formed may be omitted.

P in FIG. 112 depicts a schematic diagram of a stacked structure in which the Aggressor conductor loops 1102A and 1102B are included in the package board 1122, and the Victim conductor loop 1101 is included in the printed board 1123. The semiconductor board 1121 in which none of the Victim conductor loop 1101, and the Aggressor conductor loops 1102A and 1102B is formed may be omitted.

Q in FIG. 112 depicts a schematic diagram of a stacked structure in which the Aggressor conductor loop 1102A is included in the package board 1122, and the Aggressor conductor loop 1102B and the Victim conductor loop 1101 are included in the printed board 1123. The semiconductor board 1121 in which none of the Victim conductor loop 1101, and the Aggressor conductor loops 1102A and 1102B is formed may be omitted.

R in FIG. 112 depicts a schematic diagram of a stacked structure in which all of the Victim conductor loop 1101, and the Aggressor conductor loops 1102A and 1102B are included in the printed board 1123. The semiconductor board 1121 and the package board 1122 in which none of the Victim conductor loop 1101, and the Aggressor conductor loops 1102A and 1102B is formed may be omitted.

The stacking orders of boards depicted in A to R in FIG. 112 may be reversed, and the positions of the Victim conductor loop 1101, the Aggressor conductor loops 1102A and the Aggressor conductor loop 1102B may be reversed vertically.

As mentioned above, the Victim conductor loop 1101, and the Aggressor conductor loops 1102A and 1102B can be formed in any regions of the semiconductor board 1121, the package board 1122 and the printed board 1123.

### Package Stacking Examples of First Semiconductor Board 101 and Second Semiconductor Board 102 Included in Solid-State Image Pickup Apparatus 100

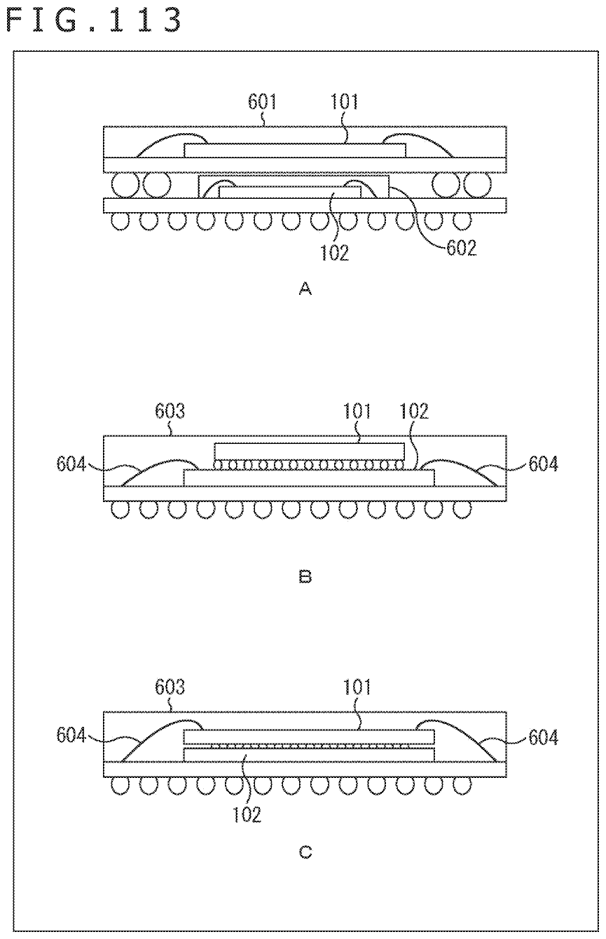

FIG. 113 is a figure depicting package stacking examples of the first semiconductor board 101 and the second semiconductor board 102 included in the solid-state image pickup apparatus 100.

The first semiconductor board 101 and the second semiconductor board 102 may be stacked one on another as a package in any manner.

For example, as depicted in A in FIG. 113, the first semiconductor board 101 and the second semiconductor board 102 are separately sealed in by using sealing materials, and a package 601 and a package 602 that are obtained as a result may be stacked one on another.

In addition, as depicted in B or C in FIG. 113, the first semiconductor board 101 and the second semiconductor board 102 may be sealed in by a sealing material in a state in which the first semiconductor board 101 and the second semiconductor board 102 are stacked one on another, to generate a package 603. In this case, bonding wires 604 may be connected to the second semiconductor board 102 as depicted in B in FIG. 113, or may be connected to the first semiconductor board 101 as depicted in C in FIG. 113.

In addition, the package may be of any mode. For example, the package may be a CSP (Chip Size Package) or a WL-CSP (Wafer Level Chip Size Package), or an interposer board or a rewiring layer may be used in the package. In addition, any form without packages may be adopted. For example, the semiconductor board may be implemented as a COB (Chip On Board). For example, the mode may be any of BGA (Ball Grid Array), COB (Chip On Board), COT (Chip On Tape), CSP (Chip Size Package/Chip Scale Package), DIMM (Dual In-line Memory Module), DIP (Dual In-line Package), FBGA (Fine-pitch Ball Grid Array), FLGA (Fine-pitch Land Grid Array), FQFP (Fine-pitch Quad Flat Package), HSIP (Single In-line Package with Heatsink), LCC (Leadless Chip Carrier), LFLGA (Low profile Fine pitch Land Grid Array), LGA (Land Grid Array), LQFP (Low-profile Quad Flat Package), MC-FBGA (Multi-Chip Fine-pitch Ball Grid Array), MCM (Multi-Chip Module), MCP (Multi-Chip Package), M-CSP (Molded Chip Size Package), MFP (Mini Flat Package), MQFP (Metric Quad Flat Package), MQUAD (Metal Quad), MSOP (Micro Small Outline Package), PGA (Pin Grid Array), PLCC (Plastic Leaded Chip Carrie), PLCC (Plastic Leadless Chip Carrie), QFI (Quad Flat I-leaded Package), QFJ (Quad Flat J-leaded Package), QFN (Quad Flat non-leaded Package), QFP (Quad Flat Package), QTCP (Quad Tape Carrier Package), QUIP (Quad In-line Package), SDIP (Shrink Dual In-line Package), SIMM (Single In-line Memory Module), SIP (Single In-line Package), S-MCP (Stacked Multi Chip Package), SNB (Small Outline Non-leaded Board), SOI (Small Outline I-leaded Package), SOJ (Small Outline J-leaded Package), SON (Small Outline Non-leaded Package), SOP (Small Outline Package), SSIP (Shrink Single In-line Package), SSOP (Shrink Small Outline Package), SZIP (Shrink Zigzag In-line Package), TAB (Tape-Automated Bonding), TCP (Tape Carrier Package), TQFP (Thin Quad Flat Package), TSOP (Thin Small Outline Package), TSSOP (Thin Shrink Small Outline Package), UCSP (Ultra Chip Scale Package), UTSOP (Ultra Thin Small Outline Package), VSO (Very Short Pitch Small Outline Package), VSOP (Very Small Outline Packag), WL-CSP (Wafer Level Chip Size Package), ZIP (Zigzag In-line Package), and pMCP (Micro Multi-Chip Package).

For example, the present technology can be applied to any sensor like a CCD (Charge-Coupled Device) image sensor, a CCD sensor, a CMOS sensor, a MOS sensor, an IR (Infrared) sensor, a UV (Ultraviolet) sensor, a ToF (Time of Flight) sensor, and a distance-measurement sensor, a circuit board, an apparatus, electronic equipment, and the like.

In addition, the present technology is suitable for a sensor, a circuit board, an apparatus, and electronic equipment in which some devices like transistors, diodes, and antennas are arrayed, and is particularly suitable for a sensor, a circuit board, an apparatus, and electronic equipment in which some devices are arrayed on substantially the same planes, but these are not essential.

For example, the present technology can also be applied to various types of memory sensor, memory circuit board, memory apparatus or electronic equipment including memories to which memory devices are related, various types of CCD sensor, CCD circuit board, CCD apparatus, and electronic equipment including CCD to which CCD is related, various types of CMOS sensor, CMOS circuit board, CMOS apparatus, and electronic equipment including CMOS to which CMOS is related, various types of MOS sensor, MOS circuit board, MOS apparatus, and electronic equipment including MOS to which MOS is related, various types of display sensor, display circuit board, display apparatus, and electronic equipment including displays to which luminescent devices are related, various types of laser sensor, laser circuit board, laser apparatus, and electronic equipment including lasers to which luminescent devices are related, various types of antenna sensor, antenna circuit board, antenna apparatus, and electronic equipment including antennas to which antenna devices are related, and the like. Among them, the present technology is suitable for a sensor, a circuit board, an apparatus, and electronic equipment including a Victim conductor loop with a variable loop path, a sensor, a circuit board, an apparatus, and electronic equipment including control lines or signal lines, a sensor, a circuit board, an apparatus, and electronic equipment including horizontal control lines or vertical signal lines, and the like, but these are not the sole examples.

### 11. Arrangement Examples of Conductive Shields

While it is explained in the configuration examples mentioned above that, by contriving configurations of the conductor layer A (wiring layer 165A) and the conductor layer B (wiring layer 165B), inductive noise can be reduced, inductive noise is ameliorated further by further providing conductive shields in configurations to be explained.

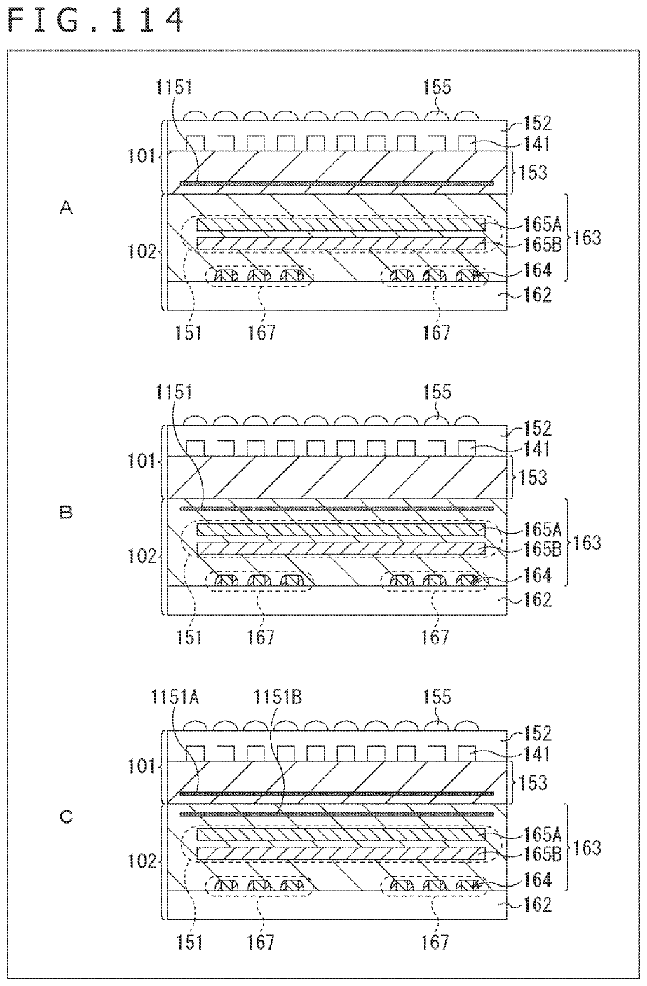

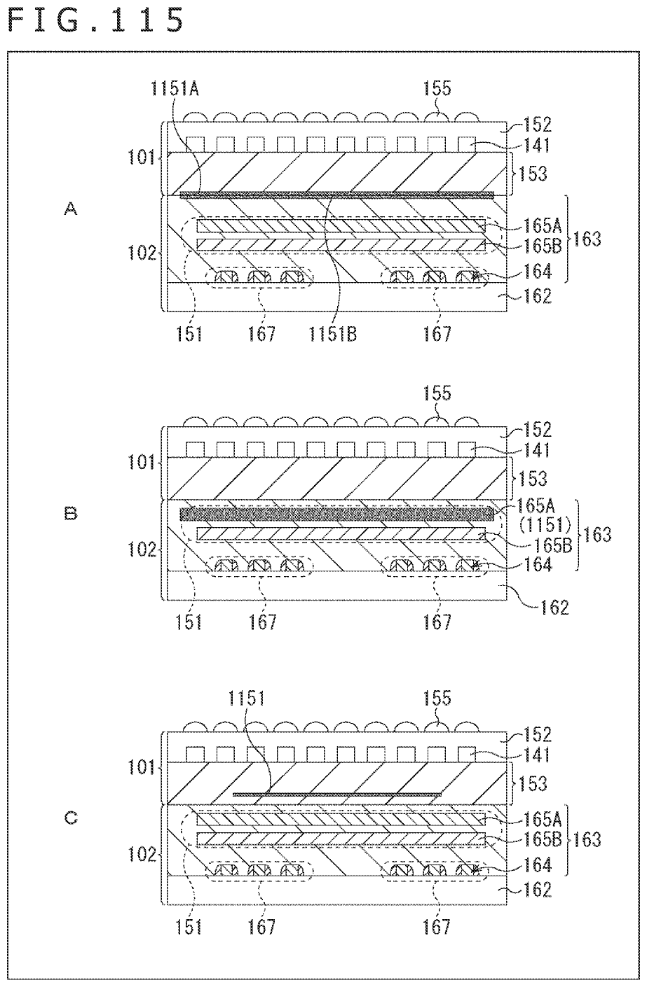

FIG. 114 and FIG. 115 are cross-sectional views depicting configuration examples in which conductive shields are provided to the solid-state image pickup apparatus 100 depicted in FIG. 6 in which the first semiconductor board 101 and the second semiconductor board 102 are stacked one on another.

Note that configurations other than the conductive shields in FIG. 114 and FIG. 115 are similar to those in the structure depicted in FIG. 6, and so explanations thereof are omitted as appropriate.

A in FIG. 114 is a cross-sectional view depicting a first configuration example in which a conductive shield is provided to the solid-state image pickup apparatus 100 depicted in FIG. 6.

In A in FIG. 114, a conductive shield 1151 is formed in the multi-layer wiring layer 153 of the first semiconductor board 101.

B in FIG. 114 is a cross-sectional view depicting a second configuration example in which a conductive shield is provided to the solid-state image pickup apparatus 100 depicted in FIG. 6.

In B in FIG. 114, the conductive shield 1151 is formed in the multi-layer wiring layer 163 of the second semiconductor board 102.

C in FIG. 114 is a cross-sectional view depicting a third configuration example in which conductive shields are provided to the solid-state image pickup apparatus 100 depicted in FIG. 6.

In C in FIG. 114, a conductive shield 1151 is formed in a multi-layer wiring layer of each of the first semiconductor board 101 and the second semiconductor board 102. More specifically, a conductive shield 1151A is formed in the multi-layer wiring layer 153 of the first semiconductor board 101, and a conductive shield 1151B is formed in the multi-layer wiring layer 163 of the second semiconductor board 102.

A in FIG. 115 is a cross-sectional view depicting a fourth configuration example in which conductive shields are provided to the solid-state image pickup apparatus 100 depicted in FIG. 6.

In A in FIG. 115, the conductive shield 1151 is formed in a multi-layer wiring layer of each of the first semiconductor board 101 and the second semiconductor board 102, and the conductive shields 1151 are joined. More specifically, the conductive shield 1151A is formed on a surface of the multi-layer wiring layer 153 of the first semiconductor board 101 at which the multi-layer wiring layer 153 is joined with the multi-layer wiring layer 163 of the second semiconductor board 102, the conductive shield 1151B is formed on a surface of the multi-layer wiring layer 163 of the second semiconductor board 102 at which the multi-layer wiring layer 163 is joined with the multi-layer wiring layer 153 of the first semiconductor board 101, and the conductive shields 1151A and 1151B are joined, for example, by a junction between the same type of metal such as a Cu—Cu junction, an Au—Au junction or an Al—Al junction, or by a junction between different types of metal such as a Cu—Au junction, a Cu—Al junction or an Au—Al junction.

Note that while C in FIG. 114, and A in FIG. 115 depict examples in which the planar regions of the conductive shields 1151A and 1151B coincide with each other, it is sufficient if the regions are at least partially superimposed one on another, and joined.

B in FIG. 115 is a cross-sectional view depicting a fifth configuration example in which a conductive shield is provided to the solid-state image pickup apparatus 100 depicted in FIG. 6.

In the configuration in B in FIG. 115, the wiring layer 165A, which is the conductor layer A, also has the functionality as the conductive shield 1151. Part of the wiring layer 165A may be the conductive shield 1151.

C in FIG. 115 is a cross-sectional view depicting a sixth configuration example in which a conductive shield is provided to the solid-state image pickup apparatus 100 depicted in FIG. 6.

In the sixth configuration example in C in FIG. 115, the conductive shield 1151 is formed in the multi-layer wiring layer 153 similarly to the first configuration example depicted in A in FIG. 114, but the planar region in which the conductive shield 1151 is formed is made smaller than the planar regions of the wiring layer 165A, which is the conductor layer A, and the wiring layer 165B, which is the conductor layer B.

As in the first configuration example in A in FIG. 114, the area size of the planar region where the conductive shield 1151 is formed is preferably equal to or larger than the area sizes of the planar regions of the wiring layer 165A, which is the conductor layer A, and the wiring layer 165B, which is the conductor layer B, but may be made smaller than them as in B in FIG. 115.

As in the first to sixth configuration examples in FIG. 114 and FIG. 115, inductive noise can be ameliorated further by providing the conductive shields 1151.

While wiring layers to be blocked off by the conductive shields 1151 are two layers, which are the wiring layers 165A and 165B, in the first to sixth configuration examples in FIG. 114 and FIG. 115, the number of wiring layers to be blocked off may be one.

Magnetic shields may be used instead of the conductive shields 1151 in the first to sixth configuration examples in FIG. 114 and FIG. 115. The magnetic shields may be electrically conductive or may not be electrically conductive. In a case in which the magnetic shields are electrically conductive, inductive noise and capacitive noise can be ameliorated further.

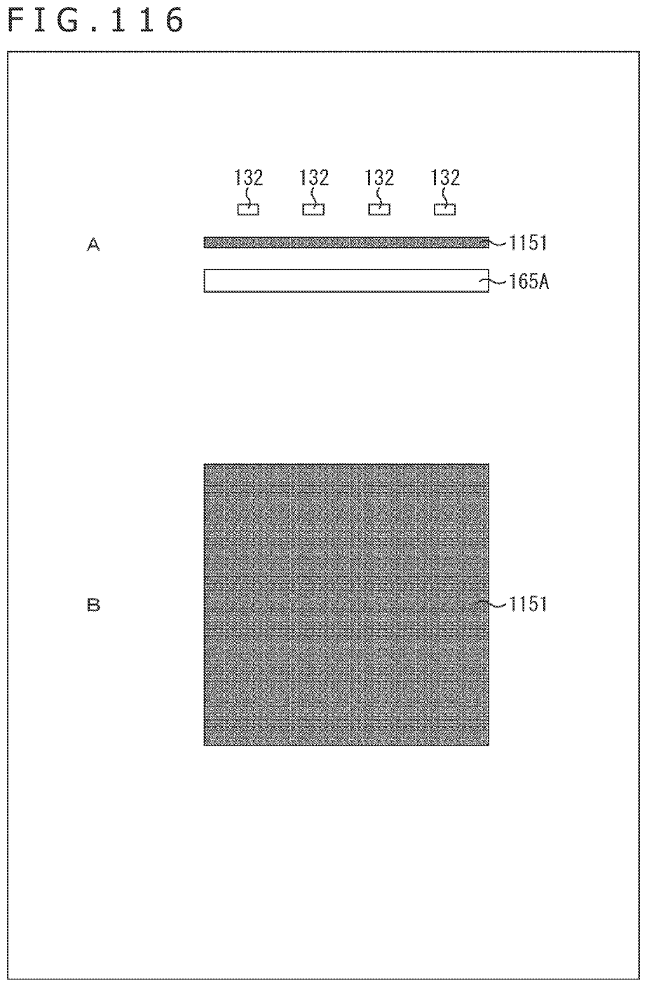

Next, the arrangement and planar shape of a conductive shield 1151 relative to signal lines 132 formed in the first semiconductor board 101 are explained with reference to FIG. 116 to FIG. 119.

FIG. 116 to FIG. 119 depict first to fourth configuration examples of the arrangement and planar shape of the conductive shield 1151 relative to the signal lines 132. The first to fourth configuration examples in FIG. 116 to FIG. 119 are the same in other respects than the planar shape of the conductive shield 1151.

A in FIG. 116 is a cross-sectional view depicting a positional relation in the Z direction among signal lines 132 through which analog pixel signals are transferred in the first semiconductor board 101, the conductive shield 1151 and the wiring layer 165A. B in FIG. 116 is a plan view depicting the planar shape of the conductive shield 1151.

As depicted in A in FIG. 116, the conductive shield 1151 is arranged between the signal lines 132 and the wiring layer 165A. As depicted in B in FIG. 116, the planar shape of the conductive shield 1151 can be formed like a sheet.

Alternatively, as in the second configuration example in A and B in FIG. 117, the planar shape of the conductive shield 1151 can be formed like straight lines, and each straight-line-like region can be superimposed on one of the signal lines 132 in a one-to-one correspondence.

Alternatively, as in the second configuration example in A and B in FIG. 117, each straight-line-like region of the conductive shield 1151 needs not correspond to one of the signal lines 132 in a one-to-one correspondence, and as in the third configuration example in A and B in FIG. 118, for example, the straight-line-like regions may be formed such that each straight-line-like region is superimposed on multiple signal lines 132. While each straight-line-like region of the conductive shield 1151 corresponds to two signal lines 132 in the planar shape in FIG. 118, each straight-line-like region may correspond to three or more signal lines 132 in the planar shape.

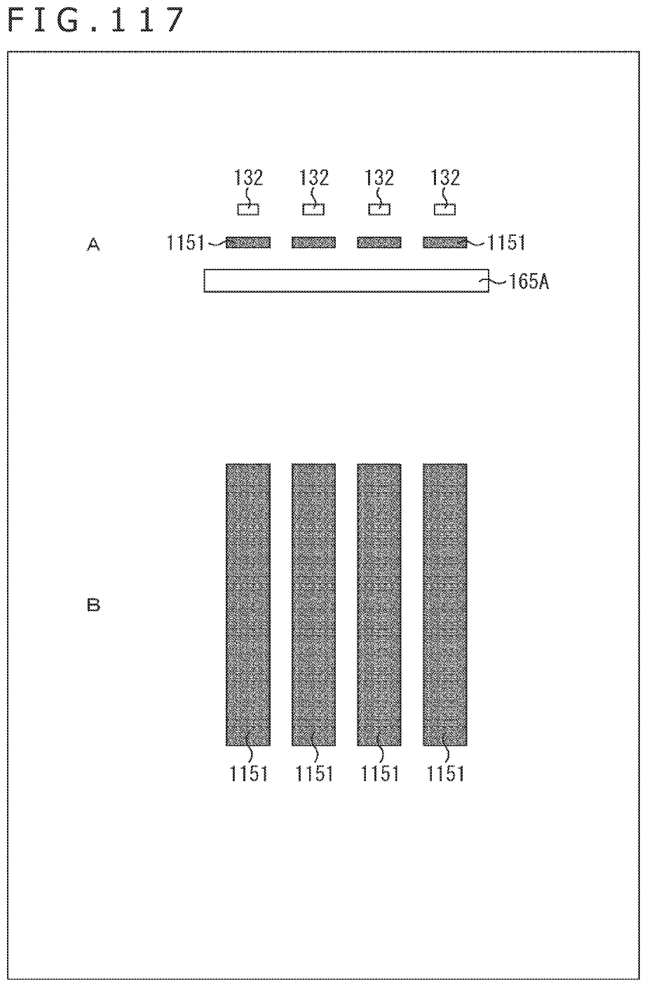

Alternatively, the planar shape of the conductive shield 1151 may not be formed like straight lines, but may be formed like a mesh as in the fourth configuration example in A and B in FIG. 119. The conductor widths, gap widths and conductor pitches of vertical conductors extending in the longitudinal direction (Y direction) of the mesh conductive shield 1151, and horizontal conductors extending in the lateral direction (X direction) of the mesh conductive shield 1151 may be mutually different or the same with each other.

While the conductive shield 1151 has one layer in the first to fourth configuration examples in FIG. 116 to FIG. 119, the conductive shield 1151 can also have two layers as depicted in C in FIG. 114 and A in FIG. 115. In addition, this similarly applies to cases in which the wiring layer 165A depicted in FIG. 116 to FIG. 119 is the wiring layer 165B.

While the conductive shield 1151 is formed at a position that is superimposed on all regions of the signal lines 132, the conductive shield 1151 may be formed at a position that is or is not superimposed on partial regions. It should be noted however that because noise is often propagated through signal lines, the conductive shield 1151 is preferably at a position that is superimposed on the signal lines 132.

While the formation position of the conductive shield 1151 relative to the signal lines 132 through which analog pixel signals are transferred in the first semiconductor board 101 is explained, the conductive shield 1151 may be formed relative not to the signal lines 132 for transferring pixel signals, but to signal lines for transferring other signals, or control lines, wires, conductors or GND. The conductive shield 1151 is preferably connected to GND or a negative power supply in order to allow noise to dissipate efficiently, but may be connected to another control line, another signal line, another conductor or another wire. Alternatively, the conductive shield 1151 does not have to be connected to another control line, another signal line, another conductor, another wire or the like.

By providing the conductive shield 1151, inductive noise and capacitive noise can be ameliorated further.

### 12. Configuration Examples in Case in which there are Three Conductor Layers

### Arrangement Example in Case in which there are Three Conductor Layers

The wiring patterns of the two conductor layers, the conductor layer A, which is the wiring layer 165A, and the conductor layer B, which is the wiring layer 165B, are explained in each configuration example mentioned above.

However, in some cases, a third conductor layer is arranged further near the two conductor layers, the wiring layer 165A (conductor layer A) and the wiring layer 165B (conductor layer B).

The third conductor layer is used, for example, as a wire for relaying GND or a negative power supply to a Vss wire of the conductor layer A, which is the wiring layer 165A, a wire for relaying a positive power supply to a Vdd wire of the conductor layer B, which is the wiring layer 165B, a reinforcement wire for reducing, as much as possible, voltage drops (IR-Drop) of the conductor layer A or the conductor layer B, or the like.

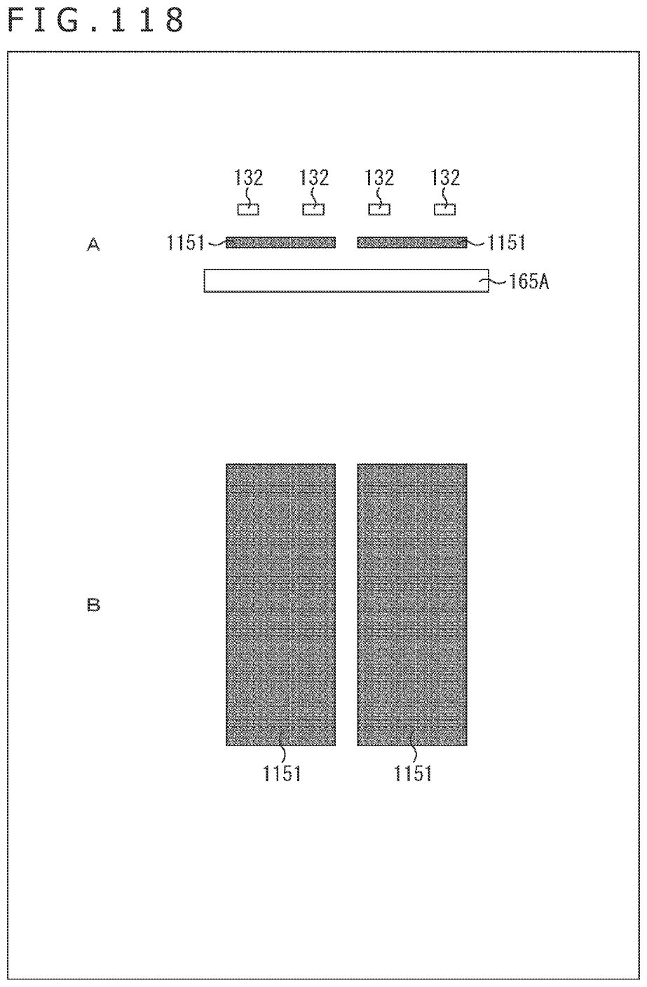

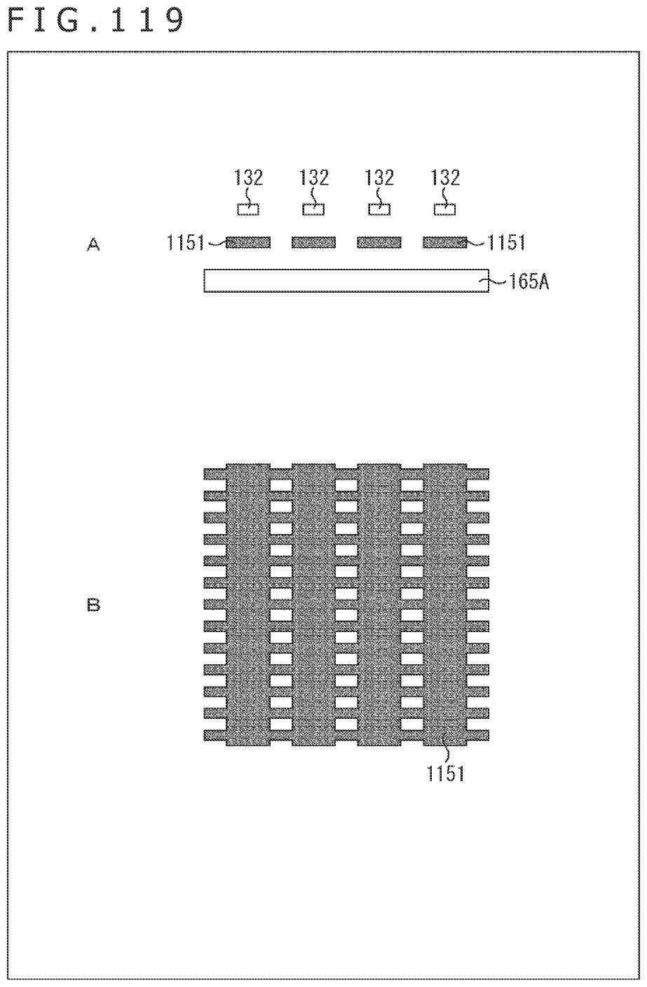

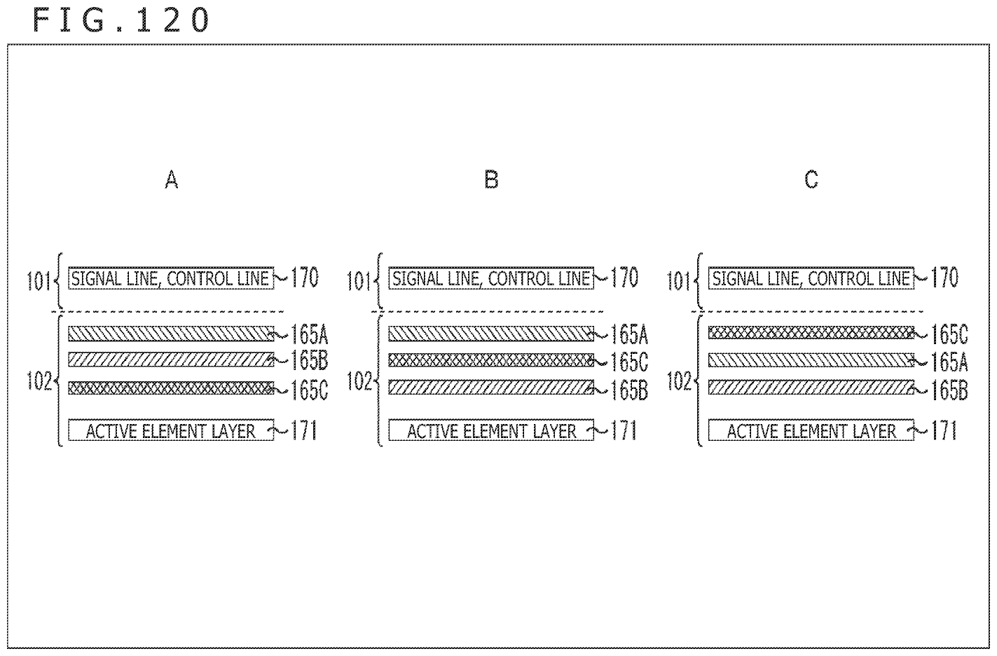

If the third conductor layer is referred to as a wiring layer 165C or a conductor layer C corresponding to the names of the wiring layers 165A and 165B, the conductor layer A and the conductor layer B in each configuration example mentioned above, the wiring layer 165C, which is a third conductor layer, is arranged relative to the wiring layers 165A and 165B in the positional relation in any of A to C in FIG. 120.

A to C in FIG. 120 are cross-sectional schematic diagrams depicting arrangement examples of the wiring layer 165C relative to the wiring layers 165A and 165B.

In the first semiconductor board 101, a wiring layer 170 (fourth conductor layer) including at least some of control lines 133 to control transistors of pixels 131, or at least some of signal lines 132 to transfer pixel signals is formed, and in the second semiconductor board 102, an active element layer 171 including active elements such as MOS transistors 164 is formed. The at least some of the control lines 133, or the at least some of the signal lines 132 may be included as at least part of a Victim conductor loop (the Victim conductor loop 11 or the Victim conductor loop 1101) mentioned before, but this is not essential.

As has been explained with reference to FIG. 6 and the like, the wiring layer 165A is arranged on the side of the wiring layer 170 of the first semiconductor board 101, and the wiring layer 165B is arranged on the side of the active element layer 171.

Relative to this arrangement of the wiring layers 165A and 165B, the wiring layer 165C (conductor layer C) is arranged between the wiring layer 165B and the active element layer 171 as depicted in A in FIG. 120, in some cases. In this case, the wiring layers are stacked in the order of the wiring layer 170, the wiring layer 165A, the wiring layer 165B, the wiring layer 165C and the active element layer 171 from the side of the first semiconductor board 101.

Alternatively, the wiring layer 165C (conductor layer C) is arranged between the wiring layer 165A and the wiring layer 165B as depicted in B in FIG. 120, in some cases. In this case, the wiring layers are stacked in the order of the wiring layer 170, the wiring layer 165A, the wiring layer 165C, the wiring layer 165B and the active element layer 171 from the side of the first semiconductor board 101.

Furthermore, the wiring layer 165C (conductor layer C) is arranged between the wiring layer 170 and the wiring layer 165A as depicted in C in FIG. 120, in some cases. In this case, the wiring layers are stacked in the order of the wiring layer 170, the wiring layer 165C, the wiring layer 165A, the wiring layer 165B and the active element layer 171 from the side of the first semiconductor board 101.

Note that FIG. 120 is a figure for explaining the positional relations of the three conductor layers, which are the wiring layers 165A to 165C, and the arrangement of the wiring layer 170 of the first semiconductor board 101 and the active element layer 171 of the second semiconductor board 102 may be reversed. In addition, the first semiconductor board 101 does not have to include either signal lines 132 or control lines 133. Even in a case in which the first semiconductor board 101 includes both signal lines 132 and control lines 133, it is sufficient if at least some of either signal lines 132 or control lines 133 are formed in the wiring layer 170. In addition, signal lines 132 or control lines 133 may not be included in the first semiconductor board 101 but in the second semiconductor board 102. In addition, at least some of signal lines 132 or control lines 133 may be included in the first semiconductor board 101 and the second semiconductor board 102 and, for example, may be included in at least part of both the first semiconductor board 101 and the second semiconductor board 102. In addition, at least any one wiring layer of the wiring layer 165A, the wiring layer 165B and the wiring layer 165C may be included not in the first semiconductor board 101, but in the second semiconductor board 102. In addition, the arrangement of the wiring layer 170 of the first semiconductor board 101, and the active element layer 171 of the second semiconductor board 102 may be omitted. In addition, the first semiconductor board 101 and the second semiconductor board 102 may be configured not as separate bodies, but integrally as one semiconductor board. In addition, the wiring layer 170 may be interpreted as the Victim conductor loop 1101, the wiring layer 165A may be interpreted as the Aggressor conductor loop 1102A, the wiring layer 165B may be interpreted as the Aggressor conductor loop 1102B, and the wiring layer 165C may be arranged at any position in the board arrangement examples depicted in FIG. 109 to FIG. 112. The positional relation among the three conductor layers, which are the wiring layers 165A to 165C, is desirably, but is not necessarily, the positional relation depicted in FIG. 120.

<Problem in Case in which there are Three Conductor Layers>

While, in the wiring layout proposed in each configuration example mentioned above, hot carrier light emissions from an active element group 167 are blocked, and inductive noise, capacitive noise or voltage drops is/are at least ameliorated in the two conductor layers, which are the conductor layer A (wiring layer 165A) and the conductor layer B (wiring layer 165B), inductive noise undesirably can worsen in some cases depending on the wiring layout of the third conductor layer.

FIG. 121 is a figure depicting one example of the wiring pattern of the wiring layer 165C.

A in FIG. 121 depicts the conductor layer C (wiring layer 165C), B in FIG. 121 depicts the conductor layer A (wiring layer 165A), and C in FIG. 121 depicts the conductor layer B (wiring layer 165B).

In addition, D in FIG. 121 is a plan view of the stacked state of the conductor layer A and the conductor layer C, E in FIG. 121 is a plan view of the stacked state of the conductor layer B and the conductor layer C, and F in FIG. 121 is a plan view of the stacked state of the conductor layer A and the conductor layer B.

In the coordinate system in FIG. 121, the X axis lies in the lateral direction, the Y axis lies in the longitudinal direction, and the Z axis lies in a direction perpendicular to the XY plane.

The eleventh configuration example using a mesh conductor with mutually different X-direction (first-direction) and Y-direction (second-direction) resistance values explained with reference to FIG. 36 is adopted for the conductor layer A (wiring layer 165A) and the conductor layer B (wiring layer 165B) in FIG. 121.

The conductor layer A in B in FIG. 121 includes a mesh conductor 1201. The mesh conductor 1201 has the X-direction conductor width WXA, gap width GXA, and conductor pitch FXA and has the Y-direction conductor width WYA, gap width GYA, and conductor pitch FYA. The mesh conductor 1201 is a conductor with a shape in which the basic pattern (first basic pattern) with the conductor pitch FXA and the conductor pitch FYA is arranged repetitively on the same plane. The mesh conductor 1201 is a wire (Vss wire) connected to GND or a negative power supply, for example.

The mesh conductor 1201 satisfies (conductor width WXA)>(conductor width WYA), and (gap width GYA)>(gap width GXA). Gap regions of the mesh conductor 1201 have shapes which are longer in the Y direction than in the X direction. The mesh conductor 1201 has mutually different X-direction and Y-direction resistance values, and the Y-direction resistance value is smaller than the X-direction resistance value. Accordingly, in the mesh conductor 1201, currents flow more easily in the Y direction than in the X direction.

The conductor layer B in C in FIG. 121 includes a mesh conductor 1202. The mesh conductor 1202 has the X-direction conductor width WXB, gap width GXB, and conductor pitch FXB and has the Y-direction conductor width WYB, gap width GYB, and conductor pitch FYB. The mesh conductor 1202 is a conductor with a shape in which the basic pattern (second basic pattern) with the conductor pitch FXB and the conductor pitch FYB is arranged repetitively on the same plane. The mesh conductor 1202 is a wire (Vdd wire) connected to a positive power supply, for example.

The mesh conductor 1202 satisfies (conductor width WXB)>(conductor width WYB), and (gap width GYB)>(gap width GXB). Gap regions of the mesh conductor 1202 have shapes which are longer in the Y direction than in the X direction. The mesh conductor 1202 has mutually different X-direction and Y-direction resistance values, and the Y-direction resistance value is smaller than the X-direction resistance value. Accordingly, in the mesh conductor 1202, currents flow more easily in the Y direction than in the X direction.

The mesh conductor 1201 in the conductor layer A and the mesh conductor 1202 in the conductor layer B form a differential structure. That is, as explained in the eleventh configuration example and the like, the current distribution in the mesh conductor 1201 in the conductor layer A and the current distribution in the mesh conductor 1202 in the conductor layer B are substantially even distributions and have mutually reverse characteristics. Here, being substantially even means that the differences are so small that they can be deemed to be even, and it is sufficient if at least the differences are 200%-differences or smaller, for example. More specifically, AC currents flow substantially evenly at end sections of the mesh conductor 1201 in the conductor layer A and the mesh conductor 1202 in the conductor layer B, and the directions of the electric currents in the mesh conductor 1201 and the mesh conductor 1202 are mutually opposite directions. As a result, a magnetic field generated by the current distribution in the mesh conductor 1201, and a magnetic field generated by the current distribution in the mesh conductor 1202 are offset effectively. Thereby, inductive noise can be suppressed.

In addition, as depicted in F in FIG. 121, there are no open regions due to the stacking of the conductor layer A and the conductor layer B, and so hot carrier light emissions from an active element group 167 can be blocked.

On the other hand, the conductor layer C in A in FIG. 121 is a conductor layer with a low sheet resistance that allows currents to flow more easily, and linear conductors 1211A that are long in the X direction, and linear conductors 1211B that are long in the X direction are arranged alternately regularly in the Y direction. The linear conductors 1211A are wires (Vss wires) connected to GND or a negative power supply, for example. The linear conductors 1211B are wires (Vdd wires) connected to a positive power supply, for example. For example, the linear conductors 1211A are connected to pads (not depicted) at an outer circumferential section of the semiconductor board and are electrically connected with the mesh conductor 1201 in the conductor layer A. The mesh conductor 1201 in the conductor layer A and the linear conductors 1211A in the conductor layer C may be electrically connected via conductor vias extending in the Z direction, or the like, for example. For example, the linear conductors 1211B are connected to pads (not depicted) at an outer circumferential section of the semiconductor board and are electrically connected with the mesh conductor 1202 in the conductor layer B. The mesh conductor 1202 in the conductor layer B, and the linear conductors 1211B in the conductor layer C may be electrically connected via conductor vias extending in the Z direction, or the like, for example.

The linear conductors 1211A have a Y-direction conductor width WYCA, the linear conductors 1211B have a Y-direction conductor width WYCB, and the conductor width WYCA of the linear conductors 1211A is larger than the conductor width WYCB of the linear conductors 1211B ((conductor width WYCA)>(conductor width WYCB)). There is a gap with a gap width GYC between each linear conductor 1211A and each linear conductor 1211B in the Y direction. Then, one linear conductor 1211A and linear conductor 1211B are arranged regularly in the Y direction at a conductor pitch FYC (=(conductor width WYCA)+(conductor width WYCB)+2×(gap width GYC)).

If a predetermined planar range (planar region) of the conductor layer C in which linear conductors 1211A and linear conductors 1211B are arranged regularly in the Y direction at the conductor pitch FYC is looked at, the sum total of the conductor widths WYCA of multiple linear conductors 1211A in the predetermined planar range, and the sum total of the conductor widths WYCB of multiple linear conductors 1211B in the predetermined planar range differ significantly because the conductor width WYCA of a linear conductor 1211A and the conductor width WYCB of a linear conductor 1211B are different. In this case, because the current distribution in the linear conductors 1211A and the current distribution in the linear conductors 1211B differ significantly, the occurrence of inductive noise cannot be suppressed, and inductive noise worsens. Specifically, because the X-direction resistance values of the linear conductors 1211A and the linear conductors 1211B differ significantly, the current distributions in the linear conductors 1211A and the linear conductors 1211B differ significantly, and the total amount of currents to flow through the linear conductors 1211A becomes larger than the total amount of currents to flow through the linear conductors 1211B. In addition, in accordance with the current preservation law (Kirchhoff's first law), the total amount of currents to flow through the mesh conductor 1202 becomes larger than the total amount of currents to flow through the mesh conductor 1201. Thereby, the current distributions in the mesh conductors 1201 and the mesh conductors 1202 differ significantly. Accordingly, the occurrence of inductive noise cannot be suppressed, and inductive noise worsens.

Accordingly, the effect of suppressing inductive noise in the two conductor layers, which are the conductor layer A and the conductor layer B, is undesirably reduced depending on the wiring layout of the conductor layer C.

In view of this, in the configurations explained hereinbelow, inductive noise is effectively reduced in a case in which there is a stacked structure of the three conductor layers, which are the wiring layers 165A to 165C. Note that the configuration example in FIG. 121 can be applied depending on the magnitude of inductive noise in some cases, and so the configuration example in FIG. 121 is not excluded.

### First Configuration Example of Three Conductor Layers

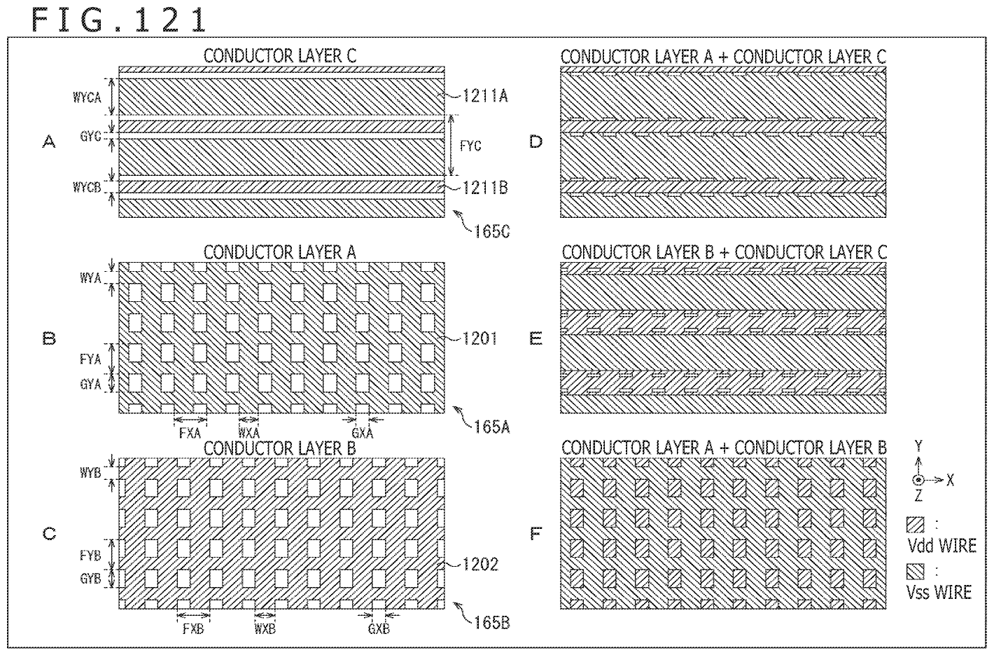

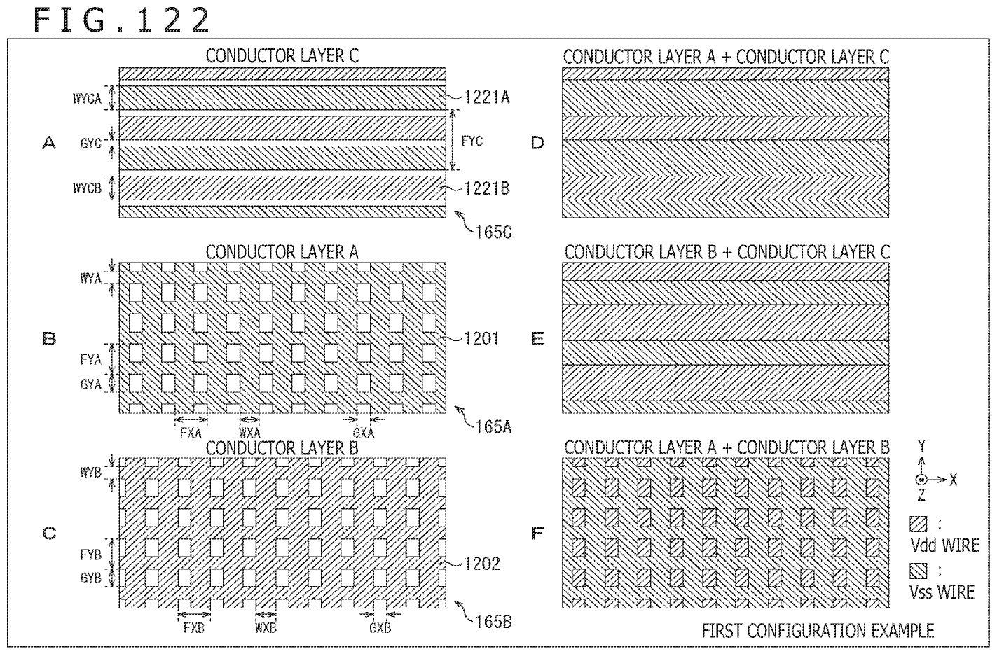

FIG. 122 depicts a first configuration example of three conductor layers.

A in FIG. 122 depicts the conductor layer C (wiring layer 165C), B in FIG. 122 depicts the conductor layer A (wiring layer 165A), and C in FIG. 122 depicts the conductor layer B (wiring layer 165B).

In addition, D in FIG. 122 is a plan view of the stacked state of the conductor layer A and the conductor layer C, E in FIG. 122 is a plan view of the stacked state of the conductor layer B and the conductor layer C, and F in FIG. 122 is a plan view of the stacked state of the conductor layer A and the conductor layer B.

The conductor layer A in B in FIG. 122 includes the mesh conductor 1201 which is the same as the one in FIG. 121. That is, the mesh conductor 1201 has the X-direction conductor width WXA, gap width GXA, and conductor pitch FXA and has the Y-direction conductor width WYA, gap width GYA, and conductor pitch FYA. The mesh conductor 1201 is a conductor with a shape in which the basic pattern (first basic pattern) with the conductor pitch FXA and the conductor pitch FYA is arranged repetitively on the same plane. The mesh conductor 1201 is a wire (Vss wire) connected to GND or a negative power supply, for example.

The conductor layer B in C in FIG. 122 includes the mesh conductor 1202 which is the same as the one in FIG. 121. That is, the mesh conductor 1202 has the X-direction conductor width WXB, gap width GXB, and conductor pitch FXB and has the Y-direction conductor width WYB, gap width GYB, and conductor pitch FYB. The mesh conductor 1202 is a conductor with a shape in which the basic pattern (second basic pattern) with the conductor pitch FXB and the conductor pitch FYB is arranged repetitively on the same plane. The mesh conductor 1202 is a wire (Vdd wire) connected to a positive power supply, for example. The conductor pitches of the mesh conductor 1201 and the mesh conductor 1202 are the same. That is, (conductor pitch FXA)=(conductor pitch FXB) and (conductor pitch FYA)=(conductor pitch FYB) are satisfied. Note that they may be substantially the same. Here, being substantially the same means that the differences are so small that they can be deemed to be the same, and it is sufficient if at least the differences are 200%-differences or smaller, for example.

The conductor layer C in A in FIG. 122 is a conductor layer with a low sheet resistance that allows currents to flow more easily, and linear conductors 1221A (third basic pattern) that are long in the X direction, and linear conductors 1221B (fourth basic pattern) that are long in the X direction are arranged alternately regularly in the Y direction.

The linear conductors 1221A are wires (Vss wires) connected to GND or a negative power supply, for example. The linear conductors 1221B are wires (Vdd wires) connected to a positive power supply, for example. The linear conductors 1221A and the linear conductors 1221B are differential conductors (differential structures) in which currents flow in mutually opposite directions. For example, the linear conductors 1221A are connected to pads (not depicted) at an outer circumferential section of the semiconductor board and are electrically connected with the mesh conductor 1201 in the conductor layer A. The mesh conductor 1201 in the conductor layer A and the linear conductors 1221A in the conductor layer C may be electrically connected via conductor vias extending in the Z direction, or the like, for example. For example, the linear conductors 1221B are connected to pads (not depicted) at an outer circumferential section of the semiconductor board and are electrically connected with the mesh conductor 1202 in the conductor layer B. The mesh conductor 1202 in the conductor layer B, and the linear conductors 1221B in the conductor layer C may be electrically connected via conductor vias extending in the Z direction, or the like, for example.

The linear conductors 1221A have the Y-direction conductor width WYCA, the linear conductors 1221B have the Y-direction conductor width WYCB, and the conductor width WYCA of the linear conductors 1221A and the conductor width WYCB of the linear conductors 1221B are the same ((conductor width WYCA)=(conductor width WYCB)). Note that the conductor width WYCA and the conductor width WYCB do not have to be the same, but may be substantially the same ((conductor width WYCA)(conductor width WYCB)). There is a gap with the gap width GYC between each linear conductor 1221A and each linear conductor 1221B in the Y direction.

Then, one linear conductor 1221A and linear conductor 1221B are arranged regularly in the Y direction at the conductor pitch FYC (=(conductor width WYCA)+(conductor width WYCB)+2×(gap width GYC)). The conductor pitch FYC of the linear conductors 1221A and the conductor pitch FYC of the linear conductors 1221B are the same or substantially the same.

In addition, the conductor pitch FYC, which is the repetition pitch of the linear conductors 1221A in the conductor layer C, is an integer multiple of the conductor pitch FYA, which is the Y-direction repetition pitch of the mesh conductors 1201 in the conductor layer A. FIG. 122 depicts an example in which the conductor pitch FYC is 200% of the conductor pitch FYA.

The conductor pitch FYC, which is the repetition pitch of the linear conductors 1221B in the conductor layer C, is an integer multiple of the conductor pitch FYB, which is the Y-direction repetition pitch of the mesh conductor 1202 in the conductor layer B. FIG. 122 depicts an example in which the conductor pitch FYC is 200% of the conductor pitch FYB.

Note that the conductor width WYCA, the conductor width WYCB and the gap width GYC can be designed to have any values.

If a predetermined planar range (planar region) of the conductor layer C in which linear conductors 1221A and linear conductors 1221B are arranged regularly in the Y direction at the conductor pitch FYC is looked at, the sum total of the conductor widths WYCA of multiple linear conductors 1221A in the predetermined planar range, and the sum total of the conductor widths WYCB of multiple linear conductors 1221B in the predetermined planar range become the same or substantially the same because the conductor width WYCA of a linear conductor 1221A and the conductor width WYCB of a linear conductor 1221B are the same or substantially the same. Thereby, the current distribution in the linear conductors 1221A and the current distribution in the linear conductors 1221B become the same or substantially the same, and so the occurrence of inductive noise can be suppressed.

In addition, for example, in a case in which the conductor layer C is arranged near the wiring layer 170 as depicted in C in FIG. 120, capacitive noise can occur due to capacitive coupling between the linear conductors 1221A and linear conductors 1221B in the conductor layer C, and signal lines 132 or control lines 133 in the wiring layer 170, but because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 122, the stacking of the conductor layers A and B forms a light-blocking structure, and needless to say, hot carrier light emissions from an active element group 167 can be blocked. In addition, as depicted in D and E in FIG. 122, the stacking of the conductor layers A and C, and the stacking of the conductor layers B and C also form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

Furthermore, in a case in which the mesh conductor 1201 in the conductor layer A, and the linear conductors 1221A in the conductor layer C are electrically connected, and the mesh conductor 1202 in the conductor layer B, and the linear conductors 1221B in the conductor layer C are electrically connected, the current amounts of the conductor layers A and B can be reduced, and so inductive noise from the conductor layers A and B, and voltage drops can be ameliorated further.

### Second Configuration Example of Three Conductor Layers

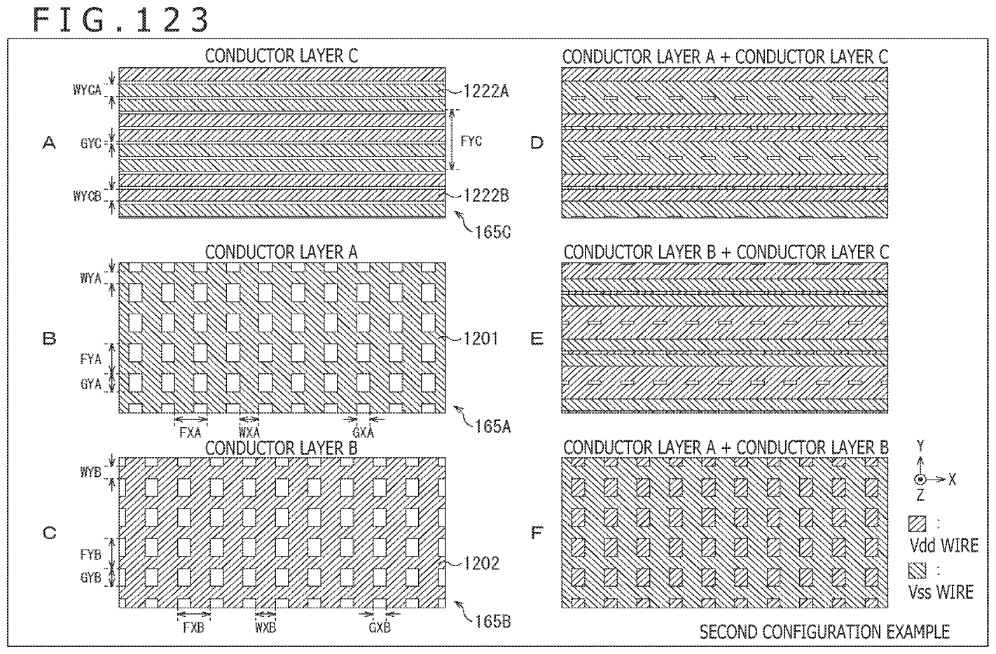

FIG. 123 depicts a second configuration example of three conductor layers.

A in FIG. 123 depicts the conductor layer C (wiring layer 165C), B in FIG. 123 depicts the conductor layer A (wiring layer 165A), and C in FIG. 123 depicts the conductor layer B (wiring layer 165B).

In addition, D in FIG. 123 is a plan view of the stacked state of the conductor layer A and the conductor layer C, E in FIG. 123 is a plan view of the stacked state of the conductor layer B and the conductor layer C, and F in FIG. 123 is a plan view of the stacked state of the conductor layer A and the conductor layer B.

The conductor layer A in B in FIG. 123 is the mesh conductor 1201 which is the same as the one in the first configuration example in FIG. 122, the conductor layer B in C in FIG. 123 is the mesh conductor 1202 which is the same as the one in the first configuration example in FIG. 122, and so explanations thereof are omitted.

In the conductor layer C in A in FIG. 123, pairs of linear conductors 1222A that are long in the X direction, and pairs of linear conductors 1222B that are long in the X direction are arranged regularly alternately in the Y direction.

The linear conductors 1222A are wires (Vss wires) connected to GND or a negative power supply, for example. The linear conductors 1222B are wires (Vdd wires) connected to a positive power supply, for example. The linear conductors 1222A and the linear conductors 1222B are differential conductors in which currents flow in mutually opposite directions. For example, the linear conductors 1222A are connected to pads (not depicted) at an outer circumferential section of the semiconductor board and are electrically connected with the mesh conductor 1201 in the conductor layer A. The mesh conductor 1201 in the conductor layer A and the linear conductors 1222A in the conductor layer C may be electrically connected via conductor vias extending in the Z direction, or the like, for example. For example, the linear conductors 1222B are connected to pads (not depicted) at an outer circumferential section of the semiconductor board and are electrically connected with the mesh conductor 1202 in the conductor layer B. The mesh conductor 1202 in the conductor layer B and the linear conductors 1222B in the conductor layer C may be electrically connected via conductor vias extending in the Z direction, or the like, for example.

The linear conductors 1222A have the Y-direction conductor width WYCA, the linear conductors 1222B have the Y-direction conductor width WYCB, and the conductor width WYCA of the linear conductors 1222A and the conductor width WYCB of the linear conductors 1222B are the same ((conductor width WYCA)=(conductor width WYCB)). Note that the conductor width WYCA and the conductor width WYCB do not have to be the same, but may be substantially the same ((conductor width WYCA)(conductor width WYCB)). Linear conductors 1222A, linear conductors 1222B or a linear conductor 1222A and a linear conductor 1222B that are adjacent to each other in the Y direction are separated by a gap with the gap width GYC.

Then, two linear conductors 1222A and two linear conductors 1222B are arranged regularly in the Y direction at the conductor pitch FYC (=2×(conductor width WYCA)+2×(conductor width WYCB)+4×(gap width GYC)). In other words, the conductor pitch FYC of two linear conductors 1222A and the conductor pitch FYC of two linear conductors 1222B are the same or substantially the same.

Note that the conductor width WYCA, the conductor width WYCB and the gap width GYC can be designed to have any values. In addition, while pairs of linear conductors 1222A and 1222B are arranged regularly in the example depicted in FIG. 123, this is not essential. Sets of linear conductors, each set of which includes three or more linear conductors, may be arranged regularly, for example. In addition, while the numbers of linear conductors 1222A and linear conductors 1222B that are arranged regularly in the example depicted in FIG. 123 are the same, this is not essential. The numbers of linear conductors 1222A and linear conductors 1222B that are arranged regularly may be different.

If a predetermined planar range (planar region) of the conductor layer C in which linear conductors 1222A and linear conductors 1222B are arranged regularly in the Y direction at the conductor pitch FYC is looked at, the sum total of the conductor widths WYCA of multiple linear conductors 1222A in the predetermined planar range, and the sum total of the conductor widths WYCB of multiple linear conductors 1222B in the predetermined planar range become the same or substantially the same because the conductor width WYCA of a linear conductor 1222A and the conductor width WYCB of a linear conductor 1222B are the same or substantially the same. Thereby, the current distribution in the linear conductors 1222A and the current distribution in the linear conductors 1222B become the same or substantially the same, and so the occurrence of inductive noise can be suppressed.

In addition, for example, in a case in which the conductor layer C is arranged near the wiring layer 170 as depicted in C in FIG. 120, capacitive noise can occur due to capacitive coupling between the linear conductors 1222A and linear conductors 1222B in the conductor layer C, and signal lines 132 or control lines 133 in the wiring layer 170, but because the linear conductors 1222A and the linear conductors 1222B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 123, the stacking of the conductor layers A and B forms a light-blocking structure, and hot carrier light emissions from an active element group 167 can be blocked. As depicted in D and E in FIG. 123, the stacking of the conductor layers A and C, and the stacking of the conductor layers B and C also maintain the light-blocking property of a certain range. Thereby, the light-blocking constraints of the conductor layers A and B can be relaxed. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

Furthermore, in a case in which the mesh conductor 1201 in the conductor layer A and the linear conductors 1222A in the conductor layer C are electrically connected, and the mesh conductor 1202 in the conductor layer B, and the linear conductors 1222B in the conductor layer C are electrically connected, the current amounts of the conductor layers A and B can be reduced, and so inductive noise from the conductor layers A and B, and voltage drops can be ameliorated further.

### Modification Examples of Second Configuration Example of Three Conductor Layers

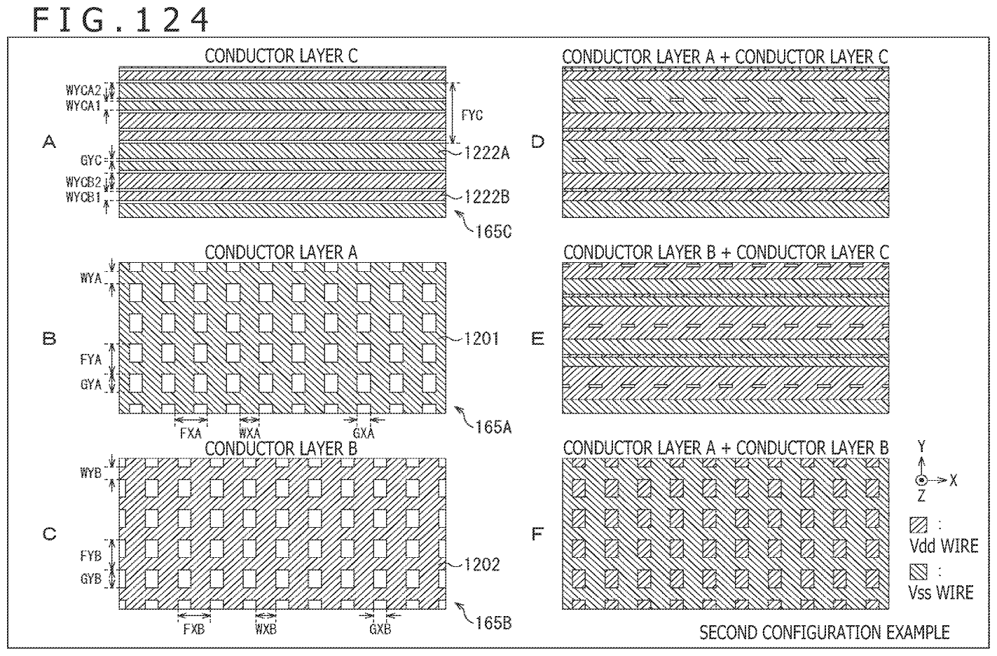

FIG. 124 depicts a first modification example of the second configuration example of three conductor layers.

A to F in FIG. 124 correspond to A to F in FIG. 123, respectively, explanations of common sections that are given the same reference signs are omitted as appropriate, and differences are explained.

In the second configuration example in FIG. 123, the Y-direction conductor widths WYCA of two linear conductors 1222A that are adjacent to each other in the Y direction in the conductor layer C are the same. In contrast, in the first modification example in FIG. 124, the conductor widths of two linear conductors 1222A adjacent to each other in the Y direction are a conductor width WYCA1 and a conductor width WYCA2 which are different from each other ((conductor width WYCA1)<(conductor width WYCA2)). Note that the conductor width WYCA1 and the conductor width WYCA2 can be designed to have any values.

Similarly, in the second configuration example in FIG. 123, the Y-direction conductor widths WYCB of two linear conductors 1222B that are adjacent to each other in the Y direction in the conductor layer C are the same. In contrast, in the first modification example in FIG. 124, the conductor widths of two linear conductors 1222B adjacent to each other in the Y direction are a conductor width WYCB1 and a conductor width WYCB2 which are different from each other ((conductor width WYCB1)<(conductor width WYCB2)). Note that the conductor width WYCB1 and the conductor width WYCB2 can be designed to have any values.

The first modification example in FIG. 124 is similar to the second configuration example in FIG. 123 in other respects than the differences in the conductor widths of the linear conductors 1222A and 1222B.

FIG. 125 depicts a second modification example of the second configuration example of three conductor layers.

A to F in FIG. 125 correspond to A to F in FIG. 123, respectively, explanations of common sections that are given the same reference signs are omitted as appropriate, and differences are explained.

The second modification example in FIG. 125 is different from the second configuration example in FIG. 123, but has a commonality with the first modification example in FIG. 124 in that the conductor widths of two linear conductors 1222A that are adjacent to each other in the Y direction in the conductor layer C are different from each other. In addition, the second modification example is different from the second configuration example in FIG. 123, but has a commonality with the first modification example in FIG. 124 in that the conductor widths of two linear conductors 1222B that are adjacent to each other in the Y direction are different from each other.

On the other hand, in the first modification example depicted in FIG. 124, the array of two linear conductors 1222A with different conductor widths is the same as the array of two linear conductors 1222B. Specifically, in a case in which two linear conductors 1222A are arrayed in the Y direction in the order of a linear conductor 1222A with a thinner conductor width (with the conductor width WYCA1), and a linear conductor 1222A with a thicker conductor width (with the conductor width WYCA2), two linear conductors 1222B also are arrayed in the Y direction in the order of a linear conductor 1222B with a thinner conductor width (with the conductor width WYCB1), and a linear conductor 1222B with a thicker conductor width (with the conductor width WYCB2).

In contrast, in the second modification example in FIG. 125, the array of two linear conductors 1222A with different conductor widths is different from the array of two linear conductors 1222B. Specifically, in a case in which two linear conductors 1222A are arrayed in the Y direction in the order of a linear conductor 1222A with a thinner conductor width (with the conductor width WYCA1), and a linear conductor 1222A with a thicker conductor width (with the conductor width WYCA2), two linear conductors 1222B are arrayed in the Y direction in the order of a linear conductor 1222B with a thicker conductor width (with the conductor width WYCB1), and a linear conductor 1222B with a thinner conductor width (with the conductor width WYCB2). In other words, a pair of two linear conductors 1222A with different conductor widths, and a pair of two linear conductors 1222B with different conductor widths are arranged mirror-symmetrically in the Y direction.

The second modification example in FIG. 125 is similar to the second configuration example in FIG. 123 in other respects than the differences in the conductor widths of the linear conductors 1222A and 1222B.

In the first modification example and the second modification example in FIG. 124 and FIG. 125 also, if a predetermined planar range (planar region) of the conductor layer C is looked at, the sum total of the conductor widths WYCA1 and WYCA2 of multiple linear conductors 1222A in the predetermined planar range, and the sum total of the conductor widths WYCB1 and WYCB2 of multiple linear conductors 1222B in the predetermined planar range become the same or substantially the same. Thereby, the current distribution in the linear conductors 1222A and the current distribution in the linear conductors 1222B become the same or substantially the same, and so the occurrence of inductive noise can be suppressed.

In the first modification example and the second modification example in FIG. 124 and FIG. 125 also, capacitive noise is ameliorated significantly, and the light-blocking constraints of the conductor layers A and B can be relaxed. In addition, the wire resistances can be lowered to ameliorate voltage drops. Furthermore, the degree of freedom of the layouts of the conductor layers A and B can be enhanced.

### Third Configuration Example of Three Conductor Layers

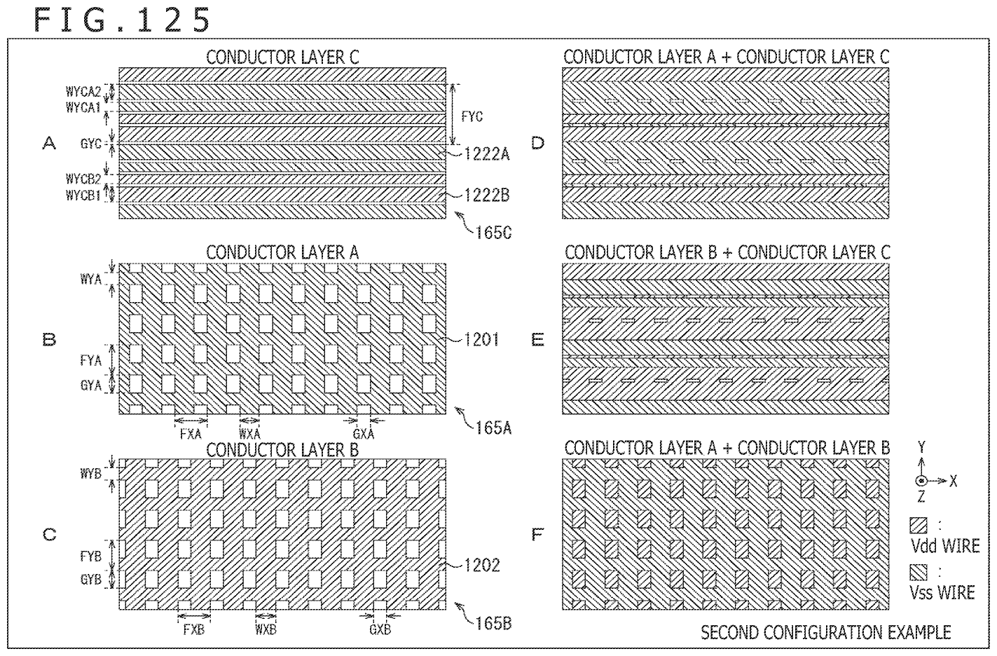

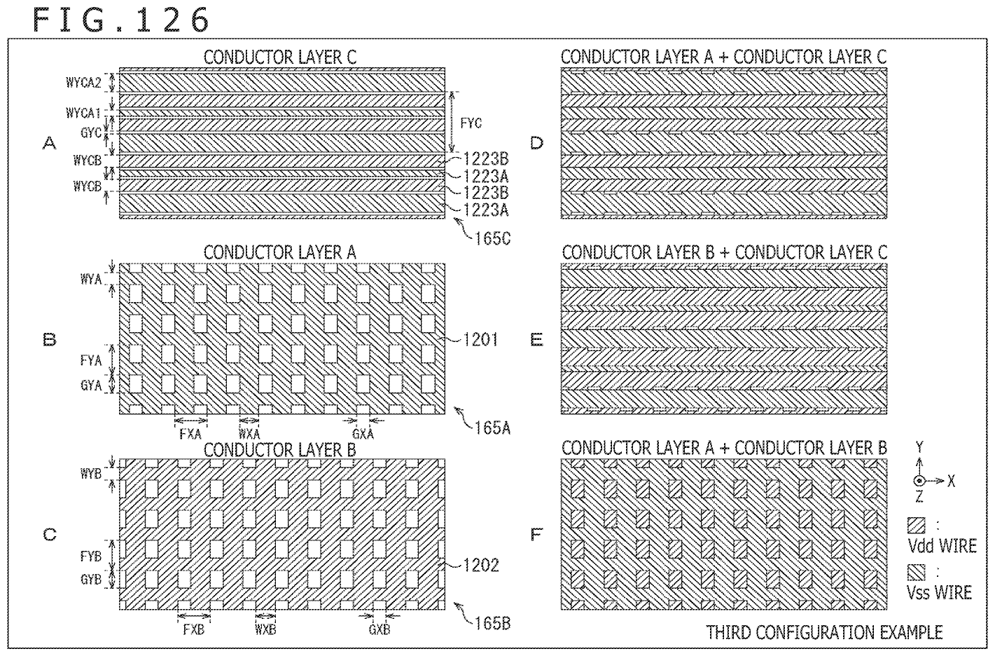

FIG. 126 depicts a third configuration example of three conductor layers.

A in FIG. 126 depicts the conductor layer C (wiring layer 165C), B in FIG. 126 depicts the conductor layer A (wiring layer 165A), and C in FIG. 126 depicts the conductor layer B (wiring layer 165B).

In addition, D in FIG. 126 is a plan view of the stacked state of the conductor layer A and the conductor layer C, E in FIG. 126 is a plan view of the stacked state of the conductor layer B and the conductor layer C, and F in FIG. 126 is a plan view of the stacked state of the conductor layer A and the conductor layer B.

The conductor layer A in B in FIG. 126 is the mesh conductor 1201 which is the same as the one in the first configuration example in FIG. 122, the conductor layer B in C in FIG. 126 is the mesh conductor 1202 which is the same as the one in the first configuration example in FIG. 122, and so explanations thereof are omitted.

The conductor layer C in A in FIG. 126 is similar to the first configuration example in FIG. 122 in that linear conductors 1223A that are long in the X direction, and linear conductors 1223B that are long in the X direction are arranged alternately regularly in the Y direction. It should be noted however that the conductor widths of the linear conductors 1221A that are arrayed sequentially in the Y direction are all the same conductor width WYCA in the first configuration example in FIG. 122.

In contrast, in the third configuration example in FIG. 126, while the linear conductors 1223A in the linear conductors 1223A and the linear conductors 1223B that are arranged alternately regularly in the Y direction include linear conductors 1223A with a different conductor width WYCA1 and conductor width WYCA2 that are arrayed alternately in the Y direction, the linear conductors 1223B include arrayed linear conductors 1223A with the same conductor width WYCB.

The third configuration example in FIG. 126 is similar to the first configuration example in FIG. 122 in other respects than the differences in the conductor widths of the linear conductors 1223A and 1223B.

That is, the linear conductors 1223A are wires (Vss wires) connected to GND or a negative power supply, for example. The linear conductors 1223B are wires (Vdd wires) connected to a positive power supply, for example. The linear conductors 1223A and the linear conductors 1223B are differential conductors in which currents flow in mutually opposite directions. For example, the linear conductors 1223A are connected to pads (not depicted) at an outer circumferential section of the semiconductor board and are electrically connected with the mesh conductor 1201 in the conductor layer A. The mesh conductor 1201 in the conductor layer A and the linear conductors 1223A in the conductor layer C may be electrically connected via conductor vias extending in the Z direction, or the like, for example. For example, the linear conductors 1223B are connected to pads (not depicted) at an outer circumferential section of the semiconductor board and are electrically connected with the mesh conductor 1202 in the conductor layer B. The mesh conductor 1202 in the conductor layer B and the linear conductors 1223B in the conductor layer C may be electrically connected via conductor vias extending in the Z direction, or the like, for example.

There is a gap with the gap width GYC between each linear conductor 1223A and each linear conductor 1223B that are adjacent to each other in the Y direction. Then, two linear conductors 1223A and two linear conductors 1223B are arranged regularly in the Y direction at the conductor pitch FYC (=(conductor width WYCA1)+(conductor width WYCA2)+2×(conductor width WYCB)+4×(gap width GYC)). Note that the conductor width WYCA1, the conductor width WYCA2, the conductor width WYCB and the gap width GYC can be designed to have any values. In addition, while pairs of linear conductors 1223A and 1223B are arranged regularly in the example depicted in FIG. 126, this is not essential. Sets of linear conductors, each set of which includes three or more linear conductors, may be arranged regularly, for example. In addition, while the numbers of linear conductors 1223A and linear conductors 1223B that are arranged regularly in the example depicted in FIG. 126 are the same, this is not essential. The numbers of linear conductors 1223A and linear conductors 1223B that are arranged regularly may be different.

If a predetermined planar range (planar region) of the conductor layer C in which linear conductors 1223A and linear conductors 1223B are arranged regularly in the Y direction at the conductor pitch FYC is looked at, the sum total of the conductor widths WYCA1 and WYCA2 of multiple linear conductors 1223A in the predetermined planar range, and the sum total of the conductor widths WYCB of multiple linear conductors 1223B in the predetermined planar range become the same or substantially the same. Thereby, the current distribution in the linear conductors 1223A and the current distribution in the linear conductors 1223B become the same or substantially the same, and so the occurrence of inductive noise can be suppressed.

In the third configuration example in FIG. 126 also, capacitive noise is ameliorated significantly, and the light-blocking constraints of the conductor layers A and B can be relaxed. In addition, the wire resistances can be lowered to ameliorate voltage drops. Furthermore, the degree of freedom of the layouts of the conductor layers A and B can be enhanced.

### Modification Example of Third Configuration Example of Three Conductor Layers

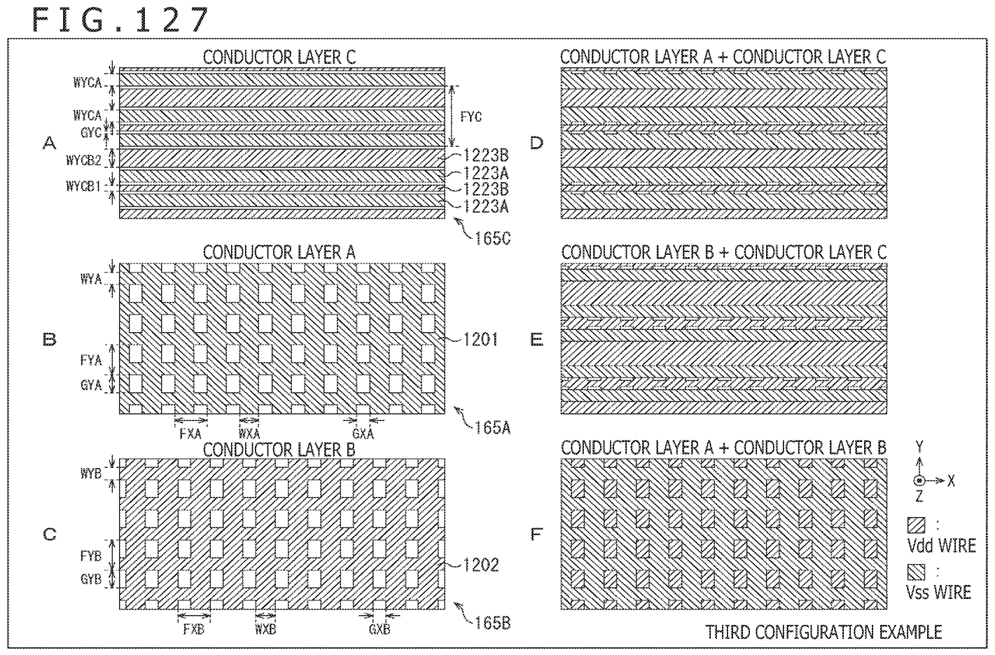

FIG. 127 depicts a modification example of the third configuration example of three conductor layers.

A to F in FIG. 127 correspond to A to F in FIG. 126, respectively, explanations of common sections that are given the same reference signs are omitted as appropriate, and differences are explained.

In the third configuration example in FIG. 126, there are two types of conductor width, the conductor width WYCA1 and the conductor width WYCA2, of the linear conductors 1223A in the linear conductors 1223A and the linear conductors 1223B that are arranged alternately regularly in the Y direction in the conductor layer C, and the linear conductors 1223B have the same conductor width WYCB.

In contrast, in the modification example of the third configuration example in FIG. 127, the linear conductors 1223A in the linear conductors 1223A and the linear conductors 1223B that are arranged alternately regularly in the Y direction in the conductor layer C have the same conductor width WYCA, and there are two types of conductor width, the conductor width WYCB1 and the conductor width WYCB2, of the linear conductors 1223B. In the modification example of the third configuration example in FIG. 127, regarding the linear conductors 1223B, the linear conductors 1223B with the different conductor width WYCB1 and conductor width WYCB2 are arrayed alternately in the Y direction.

The modification example of the third configuration example in FIG. 127 is similar to the third configuration example in FIG. 126 in other respects than the differences in the conductor widths of the linear conductors 1223A and 1223B.

If a predetermined planar range (planar region) of the conductor layer C in which linear conductors 1223A and linear conductors 1223B are arranged regularly in the Y direction at the conductor pitch FYC is looked at, the sum total of the conductor widths WYCA of multiple linear conductors 1223A in the predetermined planar range, and the sum total of the conductor widths WYCB1 and WYCB2 of multiple linear conductors 1223B in the predetermined planar range become the same or substantially the same. Thereby, the current distribution in the linear conductors 1223A and the current distribution in the linear conductors 1223B become the same or substantially the same, and so the occurrence of inductive noise can be suppressed.

In the modification example of the third configuration example in FIG. 127 also, capacitive noise is ameliorated significantly, and the light-blocking constraints of the conductor layers A and B can be relaxed. In addition, the wire resistances can be lowered to ameliorate voltage drops. Furthermore, the degree of freedom of the layouts of the conductor layers A and B can be enhanced.

### Fourth Configuration Example of Three Conductor Layers

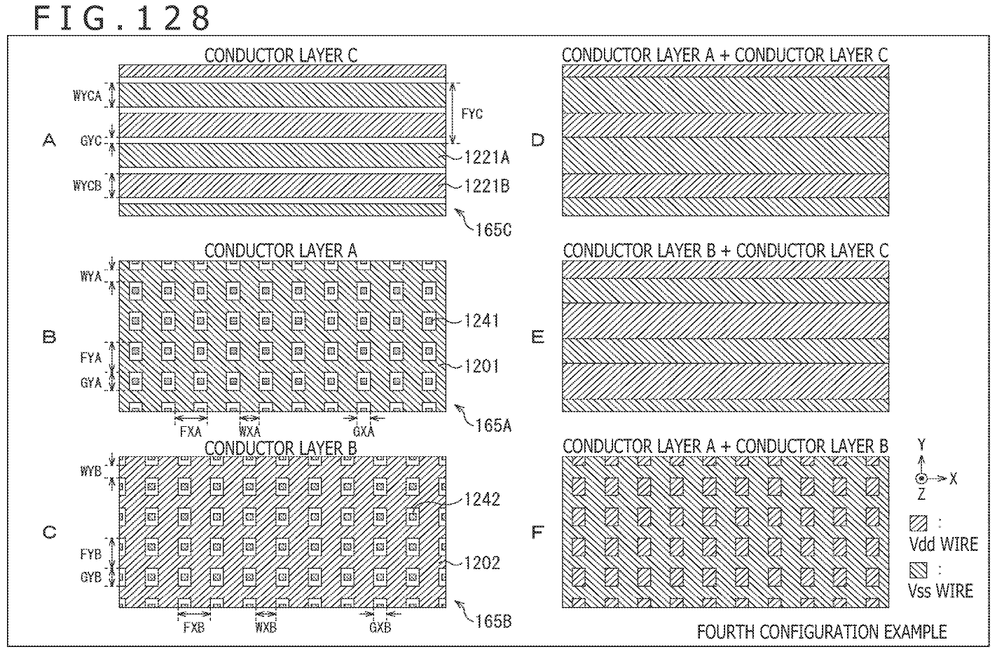

FIG. 128 depicts a fourth configuration example of three conductor layers.

A in FIG. 128 depicts the conductor layer C (wiring layer 165C), B in FIG. 128 depicts the conductor layer A (wiring layer 165A), and C in FIG. 128 depicts the conductor layer B (wiring layer 165B).

In addition, D in FIG. 128 is a plan view of the stacked state of the conductor layer A and the conductor layer C, E in FIG. 128 is a plan view of the stacked state of the conductor layer B and the conductor layer C, and F in FIG. 128 is a plan view of the stacked state of the conductor layer A and the conductor layer B.

Sections in the fourth configuration example in FIG. 128 that have counterparts in the first configuration example depicted in FIG. 122 are given the same reference signs, explanations of those sections are omitted as appropriate, and explanations are given with a focus on differences.

The conductor layer C in A in FIG. 128 is similar to the conductor layer C in the first configuration example depicted in FIG. 122. That is, in the conductor layer C, linear conductors 1221A that are long in the X direction, and linear conductors 1221B that are long in the X direction are arranged regularly alternately in the Y direction at the conductor pitch FYC.

The conductor layer A in B in FIG. 128 has the mesh conductor 1201 which is the same as the one in FIG. 121. In addition, the conductor layer A has relay conductors 1241 (first relay conductors) inside gaps of the mesh conductor 1201 that have the X-direction gap width GXA and the Y-direction gap width GYA. Each relay conductor 1241 is arranged in one of all the gaps of the mesh conductor 1201 in a one-to-one correspondence. The intervals between the relay conductors 1241, in other words, the pitches of the relay conductors 1241, also are the conductor pitches FXA and FYA.

The relay conductors 1241 are wires (Vdd wires) connected to a positive power supply, for example, and in the case of the stacking order depicted in C in FIG. 120, the relay conductors 1241 electrically connect the mesh conductor 1202 in the conductor layer B, and the linear conductors 1221B in the conductor layer C via conductor vias extending in the Z direction, or the like, for example. In other words, the mesh conductor 1202 in the conductor layer B, and the linear conductors 1221B in the conductor layer C are electrically connected via the relay conductors 1241 in the conductor layer A. In addition, in the case of the stacking order depicted in A in FIG. 120, for example, the relay conductors 1241 may electrically connect the mesh conductor 1202 in the conductor layer B, and a conductor in a conductor layer other than the conductor layers A to C via conductor vias extending in the Z direction, or the like, for example. In addition, in the case of the stacking order depicted in B in FIG. 120, for example, the relay conductors 1241 may electrically connect the linear conductors 1221B in the conductor layer C, and a conductor in a conductor layer other than the conductor layers A to C via conductor vias extending in the Z direction, or the like, for example. In addition, not all of the relay conductors 1241 have to be used for electrical connection, all of the relay conductors 1241 may be used for electrical connection, or some of the relay conductors 1241 may be used for electrical connection.

By providing the relay conductors 1241, it becomes possible to connect the mesh conductor 1202 and the linear conductors 1221B with substantially the shortest distance or with a short distance, to lead in a power supply, and voltage drops, energy loss, or inductive noise can be reduced.

The conductor layer B in C in FIG. 128 has the mesh conductor 1202 which is the same as the one in FIG. 121. In addition, the conductor layer B has relay conductors 1242 (second relay conductors) inside gaps of the mesh conductor 1202 that have the X-direction gap width GXB, and the Y-direction gap width GYB. Each relay conductor 1242 is arranged in one of all the gaps of the mesh conductor 1202 in a one-to-one correspondence. The intervals between the relay conductors 1242, in other words, the pitches of the relay conductors 1242, also are the conductor pitches FXB and FYB.

The relay conductors 1242 are wires (Vss wires) connected to GND or a negative power supply, for example, and in the case of the stacking order depicted in A in FIG. 120, the relay conductors 1242 electrically connect the mesh conductor 1201 in the conductor layer A and the linear conductors 1221A in the conductor layer C via conductor vias extending in the Z direction, or the like, for example. In other words, the mesh conductor 1201 in the conductor layer B, and the linear conductors 1221A in the conductor layer C are electrically connected via the relay conductors 1242 in the conductor layer B. In addition, in the case of the stacking order depicted in C in FIG. 120, for example, the relay conductors 1242 may electrically connect the mesh conductor 1201 in the conductor layer A and a conductor in a conductor layer other than the conductor layers A to C via conductor vias extending in the Z direction, or the like, for example. In addition, in the case of the stacking order depicted in B in FIG. 120, for example, the relay conductors 1242 may electrically connect the linear conductors 1221A in the conductor layer C and a conductor in a conductor layer other than the conductor layers A to C via conductor vias extending in the Z direction, or the like, for example. In addition, not all of the relay conductors 1242 have to be used for electrical connection, all of the relay conductors 1242 may be used for electrical connection, or some of the relay conductors 1242 may be used for electrical connection.

By providing the relay conductors 1242, it becomes possible to connect the mesh conductor 1201 and the linear conductors 1221A with substantially the shortest distance or with a short distance, and voltage drops, energy loss, or inductive noise can be reduced.

In addition, because the linear conductors 1221A and the linear conductors 1221B in A in FIG. 128 are conductors that are long in the X direction, the direction in which currents flow more easily is the X direction. In addition, the direction in which currents flow more easily in the mesh conductors 1201 and 1202 in B and C in FIG. 128 is the Y direction. Accordingly, the direction in which currents flow more easily in the conductor layer C and the direction in which currents flow more easily in the conductor layers A and B are substantially orthogonal and are different by approximately 90 degrees. Thereby, currents are diffused more easily (currents are less likely to be concentrated), and so inductive noise can be ameliorated further.

As depicted in F in FIG. 128, the stacking of the conductor layers A and B forms a light-blocking structure. In addition, as depicted in D and E in FIG. 128, the stacking of the conductor layers A and C, and the stacking of the conductor layers B and C also form light-blocking structures, and the light-blocking property is maintained. Thereby, hot carrier light emissions from an active element group 167 can be blocked. In addition, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. The degree of freedom of the layouts of the conductor layers A and B can be enhanced.

### Modification Examples of Fourth Configuration Example of Three Conductor Layers

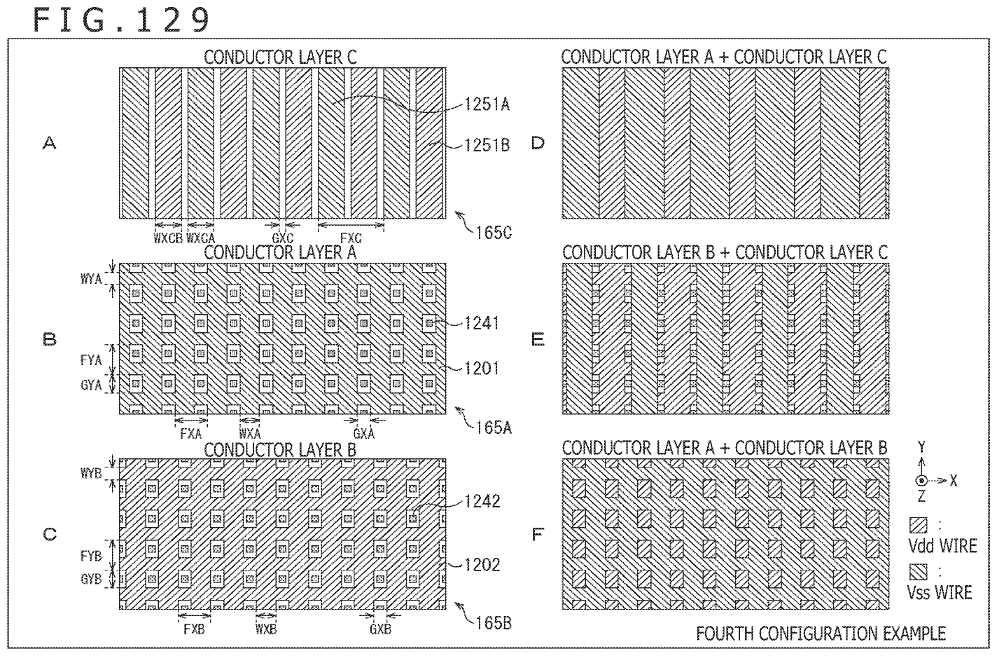

FIG. 129 depicts a first modification example of the fourth configuration example of three conductor layers.

A in FIG. 129 depicts the conductor layer C (wiring layer 165C), B in FIG. 129 depicts the conductor layer A (wiring layer 165A), and C in FIG. 129 depicts the conductor layer B (wiring layer 165B).

In addition, D in FIG. 129 is a plan view of the stacked state of the conductor layer A and the conductor layer C, E in FIG. 129 is a plan view of the stacked state of the conductor layer B and the conductor layer C, and F in FIG. 129 is a plan view of the stacked state of the conductor layer A and the conductor layer B.

Sections in FIG. 129 that have counterparts in the fourth configuration example depicted in FIG. 128 are given the same reference signs, explanations of those sections are omitted as appropriate, and explanations are given with a focus on differences.

In the first modification example of the fourth configuration example, only the configuration of the conductor layer C in A in FIG. 129 is different from that in FIG. 128.

In the conductor layer C in A in FIG. 128, linear conductors 1221A that are long in the X direction, and linear conductors 1221B that are long in the X direction are arranged regularly alternately in the Y direction at the conductor pitch FYC. In addition, the direction in which currents flow more easily in the conductor layer C and the direction in which currents flow more easily in the conductor layers A and B are substantially orthogonal and are different by approximately 90 degrees.

In contrast, in the conductor layer C in A in FIG. 129, linear conductors 1251A that are long in the Y direction, and linear conductors 1251B that are long in the Y direction are arranged regularly alternately in the X direction.

In addition, because the linear conductors 1251A and the linear conductors 1251B in A in FIG. 129 are conductors that are long in the Y direction, the direction in which currents flow more easily is the Y direction. In addition, the direction in which currents flow more easily in the mesh conductors 1201 and 1202 in B and C in FIG. 128 is the Y direction. Thereby, the direction in which currents flow more easily in the conductor layer C, and the direction in which currents flow more easily in the conductor layers A and B are the same or substantially the same. In this case, voltage drops can be ameliorated further, depending on the wiring layout. For two directions to be at approximately 90 degrees or to be substantially the same, it is sufficient if the difference between the directions is within such a range that the directions can be regarded as being at 90 degrees or the same angle, and it is defined here that two directions that are at approximately 90 degrees or substantially the same angle are at an angle that is within the range of 45 degrees below and above 90 degrees or zero degrees.

The linear conductors 1251A are wires (Vss wires) connected to GND or a negative power supply, for example. The linear conductors 1251B are wires (Vdd wires) connected to a positive power supply, for example. The linear conductors 1251A and the linear conductors 1251B are differential conductors in which currents flow in mutually opposite directions. For example, the linear conductors 1251A are connected to pads (not depicted) at an outer circumferential section of the semiconductor board and are electrically connected with the mesh conductor 1201 in the conductor layer A. The mesh conductor 1201 in the conductor layer A and the linear conductors 1251A in the conductor layer C may be electrically connected via conductor vias extending in the Z direction, or the like, for example. For example, the linear conductors 1251B are connected to pads (not depicted) at an outer circumferential section of the semiconductor board and are electrically connected with the mesh conductor 1202 in the conductor layer B. The mesh conductor 1202 in the conductor layer B and the linear conductors 1251B in the conductor layer C may be electrically connected via conductor vias extending in the Z direction, or the like, for example.

The linear conductors 1251A have an X-direction conductor width WXCA, the linear conductors 1251B have an X-direction conductor width WXCB, and the conductor width WXCA of the linear conductors 1251A and the conductor width WXCB of the linear conductors 1251B are the same or substantially the same ((conductor width WXCA)=(conductor width WXCB) or (conductor width WXCA)(conductor width WXCB)). There is a gap with a gap width GXC between each linear conductor 1251A and each linear conductor 1251B in the Y direction.

Then, one linear conductor 1251A and linear conductor 1251B are arranged regularly in the X direction at a conductor pitch FXC (=(conductor width WXCA)+(conductor width WXCB)+2×(gap width GXC)). In other words, the conductor pitch FXC of the linear conductors 1251A and the conductor pitch FXC of the linear conductors 1251B are the same or substantially the same.

In addition, the conductor pitch FXC, which is the repetition pitch of the linear conductors 1251A in the conductor layer C, is an integer multiple of the conductor pitch FXA, which is the X-direction repetition pitch of the mesh conductor 1201 in the conductor layer A. FIG. 129 depicts an example in which the conductor pitch FXC is 200% of the conductor pitch FYA.

The conductor pitch FXC, which is the repetition pitch of the linear conductors 1251B in the conductor layer C, is an integer multiple of the conductor pitch FXB, which is the X-direction repetition pitch of the mesh conductor 1202 in the conductor layer B. FIG. 129 depicts an example in which the conductor pitch FXC is 200% of the conductor pitch FXB.

Note that the conductor width WXCA, the conductor width WXCB and the gap width GXC can be designed to have any values.

If a predetermined planar range (planar region) of the conductor layer C in which linear conductors 1251A and the linear conductors 1251B are arranged regularly in the X direction at the conductor pitch FXC is looked at, the sum total of the conductor widths WXCA of multiple linear conductors 1251A in the predetermined planar range, and the sum total of the conductor widths WXCB of multiple linear conductors 1251B in the predetermined planar range become the same or substantially the same because the conductor width WXCA of a linear conductor 1251A and the conductor width WXCB of a linear conductor 1251B are the same or substantially the same. Thereby, the current distribution in the linear conductors 1251A and the current distribution in the linear conductors 1251B become the same or substantially the same, and so the occurrence of inductive noise can be suppressed.

In addition, for example, in a case in which the conductor layer C is arranged near the wiring layer 170 as depicted in C in FIG. 120, capacitive noise can occur due to capacitive coupling between the linear conductors 1251A and linear conductors 1251B in the conductor layer C, and signal lines 132 or control lines 133 in the wiring layer 170, but because the linear conductors 1251A and the linear conductors 1251B include repetitions of the same wiring patterns in the X direction, capacitive noise can be offset completely in the X direction. Capacitive noise can be ameliorated more significantly if the conductor layer C is closer to the wiring layer 170.

As depicted in F in FIG. 129, the stacking of the conductor layers A and B forms a light-blocking structure, and needless to say, hot carrier light emissions from an active element group 167 can be blocked. In addition, as depicted in D in FIG. 129, the stacking of the conductor layers A and C also forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

Furthermore, in a case in which the mesh conductor 1201 in the conductor layer A and the linear conductors 1251A in the conductor layer C are electrically connected, and the mesh conductor 1202 in the conductor layer B, and the linear conductors 1251B in the conductor layer C are electrically connected, the current amounts of the conductor layers A and B can be reduced, and so inductive noise from the conductor layers A and B, and voltage drops can be ameliorated further.

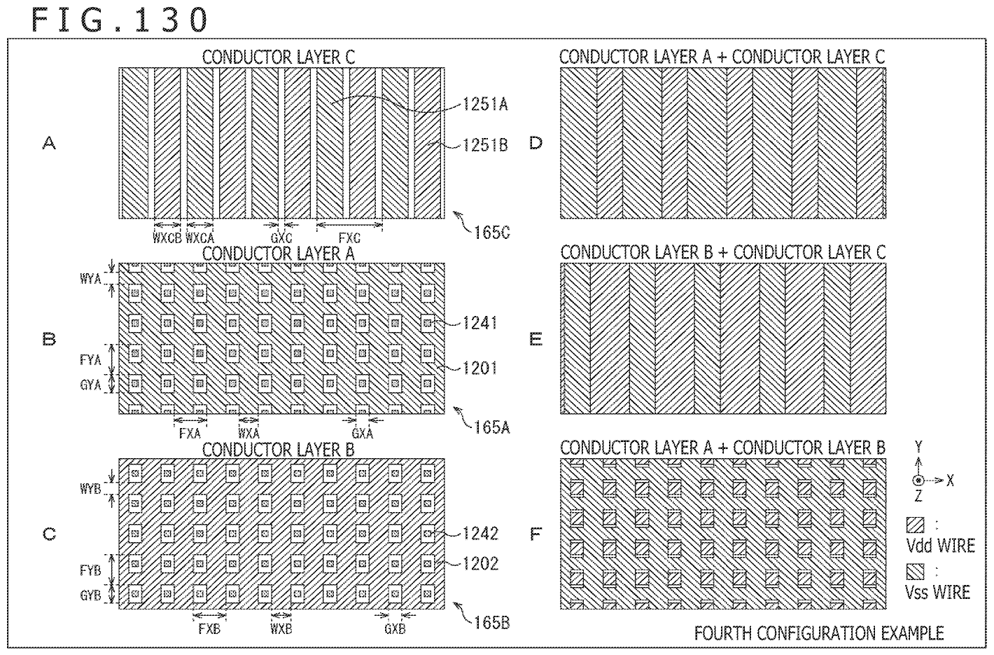

FIG. 130 depicts a second modification example of the fourth configuration example of three conductor layers.

A to F in FIG. 130 correspond to A to F in FIG. 129, respectively, explanations of common sections that are given the same reference signs are omitted as appropriate, and differences are explained.

In the first modification example in FIG. 129, regarding gap positions of the mesh conductor 1201 in the conductor layer A and the mesh conductor 1202 in the conductor layer B, the X-direction positions are different, and the Y-direction positions match.

On the other hand, in the second modification example in FIG. 130, regarding gap positions of the mesh conductor 1201 in the conductor layer A and the mesh conductor 1202 in the conductor layer B, the X-direction positions match, and the Y-direction positions are different.

In other words, if conductors that are in the mesh conductor 1201 in the conductor layer A and the mesh conductor 1202 in the conductor layer B, and lie in the direction which is the same or substantially the same as the direction (Y direction) in which signal lines 132 of the wiring layer 170 extend are compared between the mesh conductor 1201 in the conductor layer A and the mesh conductor 1202 in the conductor layer B, all the conductors overlap when seen in the stacking direction. The thus-formed conductor layer A and conductor layer B correspond to the sixth configuration example of the conductor layers A and B depicted in FIG. 27 and can significantly ameliorate inductive noise as depicted in the result of a simulation in C in FIG. 28.

If the positions of the relay conductors 1241 in the conductor layer A and the relay conductors 1242 in the conductor layer B are compared with each other, the X-direction positions are different, and the Y-direction positions match in the first modification example in FIG. 129. On the other hand, in the second modification example in FIG. 130, the X-direction positions match, and the Y-direction positions are different.

In the first modification example in FIG. 129, the stacking of the conductor layers A and B, and the stacking of the conductor layers A and C form light-blocking structures, and the light-blocking property is maintained. On the other hand, in the second modification example in FIG. 130, the stacking of the conductor layers A and C, and the stacking of the conductor layers B and C form light-blocking structures, and the light-blocking property is maintained.

The second modification example in FIG. 130 is similar to the first modification example in FIG. 129 in other respects than those mentioned above.

In the second modification example in FIG. 130 also, if a predetermined planar range (planar region) of the conductor layer C is looked at, the current distribution in the linear conductors 1251A and the current distribution in the linear conductors 1251B become the same or substantially the same, and so the occurrence of inductive noise can be suppressed.

In addition, because it is possible to completely offset capacitive noise in the X direction, capacitive noise can be ameliorated significantly. Because the stacking of the conductor layers A and C, and the stacking of the conductor layers B and C form light-blocking structures, the light-blocking constraints of the conductor layers A and B can be relaxed significantly. In addition, the wire resistances can be lowered to ameliorate voltage drops. Furthermore, the degree of freedom of the layouts of the conductor layers A and B can be enhanced.

### Fifth Configuration Example of Three Conductor Layers

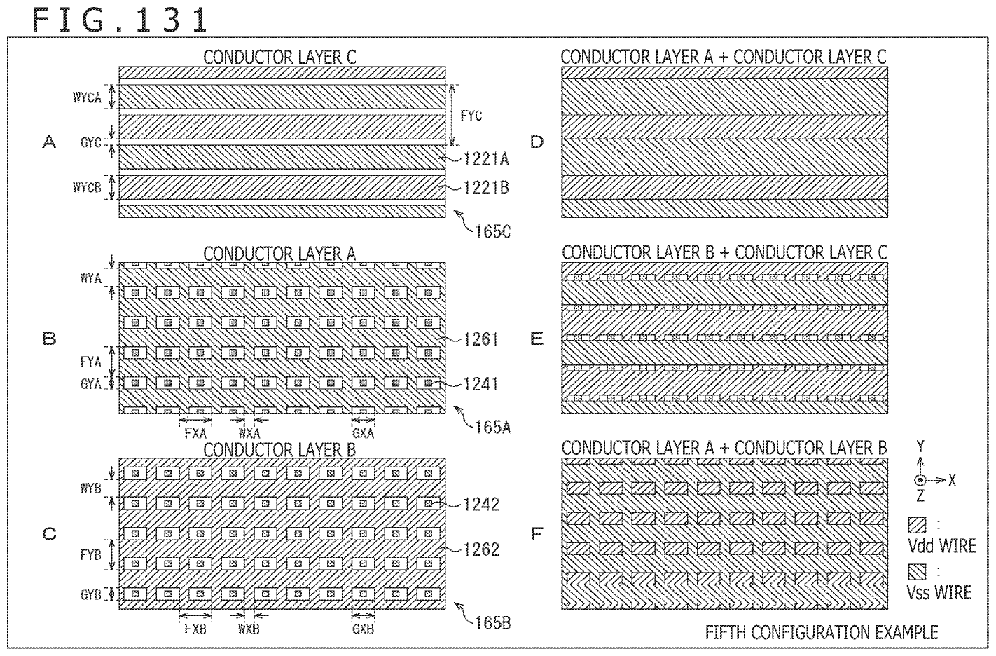

FIG. 131 depicts a fifth configuration example of three conductor layers.

A in FIG. 131 depicts the conductor layer C (wiring layer 165C), B in FIG. 131 depicts the conductor layer A (wiring layer 165A), and C in FIG. 131 depicts the conductor layer B (wiring layer 165B).

In addition, D in FIG. 131 is a plan view of the stacked state of the conductor layer A and the conductor layer C, E in FIG. 131 is a plan view of the stacked state of the conductor layer B and the conductor layer C, and F in FIG. 131 is a plan view of the stacked state of the conductor layer A and the conductor layer B.

Sections in the fifth configuration example in FIG. 131 that have counterparts in the fourth configuration example depicted in FIG. 128 are given the same reference signs, explanations of those sections are omitted as appropriate, and explanations are given with a focus on differences.

The conductor layer A in B in FIG. 131 includes a mesh conductor 1261. The mesh conductor 1261 is different from the mesh conductor 1201 in the fourth configuration example depicted in FIG. 128 in terms of the ratio between the X-direction gap width GXA and the Y-direction gap width GYA. Specifically, while the mesh conductor 1201 in the conductor layer A in the fourth configuration example depicted in FIG. 128 satisfies ((gap width GYA)/(gap width GXA))>1, the mesh conductor 1261 in the conductor layer A in the fifth configuration example in B in FIG. 131 satisfies ((gap width GYA)/(gap width GXA))<1.

In other words, while the mesh conductor 1201 in the conductor layer A in the fourth configuration example depicted in FIG. 128 is a conductor that satisfies (conductor width WXA)>(conductor width WYA), and (gap width GYA)>(gap width GXA), and allows currents to flow more easily in the Y direction, the mesh conductor 1261 in the conductor layer A in the fifth configuration example in B in FIG. 131 is a conductor that satisfies (conductor width WXA)<(conductor width WYA), and (gap width GYA)<(gap width GXA), and allows currents to flow more easily in the X direction.

Furthermore, in other words, while the direction in which currents flow more easily in the conductor layer C and the direction in which currents flow more easily in the conductor layers A and B are substantially orthogonal to each other and are different by approximately 90 degrees in the fourth configuration example depicted in FIG. 128, the direction in which currents flow more easily in the conductor layer C and the direction in which currents flow more easily in the conductor layers A and B are the same or substantially the same in the fifth configuration example in B in FIG. 131. In the case of the fifth configuration example in FIG. 131, voltage drops can be ameliorated further, depending on the wiring layout.

In the fourth configuration example depicted in FIG. 128, if gap positions of the mesh conductor 1201 in the conductor layer A and the mesh conductor 1202 in the conductor layer B are compared with each other, the X-direction positions are different, and the Y-direction positions match.

On the other hand, in the fifth configuration example in B in FIG. 131, the positions of gaps in the mesh conductor 1261 in the conductor layer A and the mesh conductor 1262 in the conductor layer B match in the X direction and are different in the Y direction.

In other words, if conductors that are in the mesh conductor 1261 in the conductor layer A and the mesh conductor 1262 in the conductor layer B, and lie in the direction which is the same or substantially the same as the direction (Y direction) in which signal lines 132 of the wiring layer 170 extend are compared between the mesh conductor 1261 in the conductor layer A and the mesh conductor 1262 in the conductor layer B, all the conductors overlap when seen in the stacking direction. The thus-formed conductor layer A and conductor layer B correspond to the sixth configuration example of the conductor layers A and B depicted in FIG. 27 and can significantly ameliorate inductive noise as depicted in the result of a simulation in C in FIG. 28.

The second modification example in FIG. 130 is similar to the fourth configuration example depicted in FIG. 128 in other respects than those mentioned above.

The conductor layer C in A in FIG. 131 is the same as the conductor layer C in the fourth configuration example depicted in FIG. 128. Accordingly, if a predetermined planar range (planar region) of the conductor layer C is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 131, the stacking of the conductor layers A and B forms a light-blocking structure, and needless to say, hot carrier light emissions from an active element group 167 can be blocked. In addition, as depicted in D in FIG. 131, the stacking of the conductor layers A and C also forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

Furthermore, in a case in which the mesh conductor 1261 in the conductor layer A and the linear conductors 1221A in the conductor layer C are electrically connected, and the mesh conductor 1262 in the conductor layer B, and the linear conductors 1221B in the conductor layer C are electrically connected, the current amounts of the conductor layers A and B can be reduced, and so inductive noise from the conductor layers A and B, and voltage drops can be ameliorated further.

### Sixth Configuration Example of Three Conductor Layers

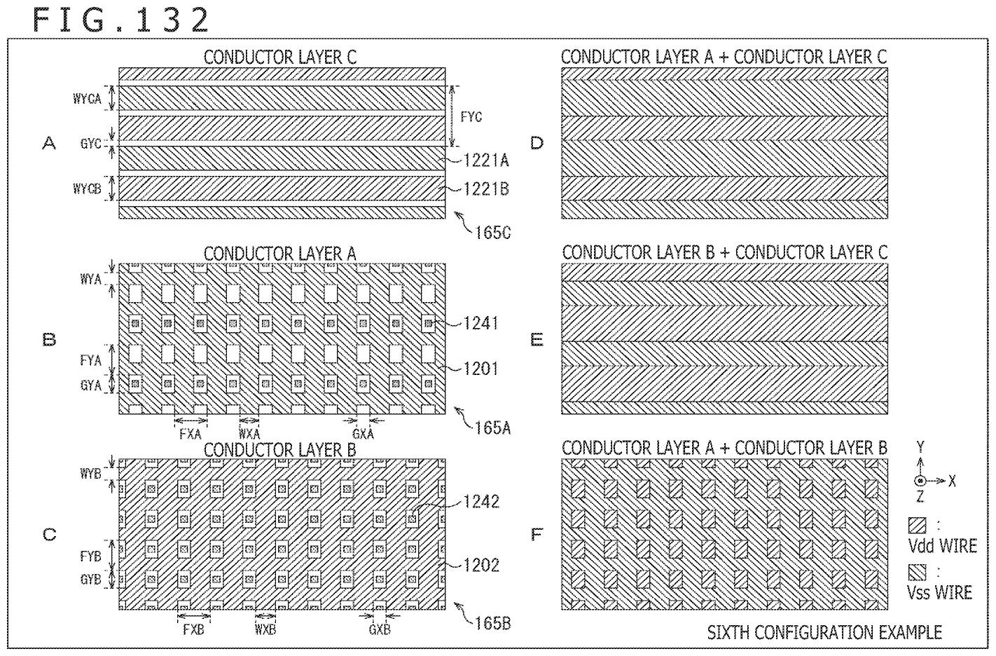

FIG. 132 depicts a sixth configuration example of three conductor layers.

A in FIG. 132 depicts the conductor layer C (wiring layer 165C), B in FIG. 132 depicts the conductor layer A (wiring layer 165A), and C in FIG. 132 depicts the conductor layer B (wiring layer 165B).

In addition, D in FIG. 132 is a plan view of the stacked state of the conductor layer A and the conductor layer C, E in FIG. 132 is a plan view of the stacked state of the conductor layer B and the conductor layer C, and F in FIG. 132 is a plan view of the stacked state of the conductor layer A and the conductor layer B.

Sections in the sixth configuration example in FIG. 132 that have counterparts in the fourth configuration example depicted in FIG. 128 are given the same reference signs, explanations of those sections are omitted as appropriate, and explanations are given with a focus on differences.

The sixth configuration example in FIG. 132 is a configuration which is obtained by omitting some of relay conductors 1241 in the conductor layer A in the fourth configuration example depicted in FIG. 128. Specifically, while the relay conductors 1241 are formed in all the gaps in a matrix of the mesh conductor 1201 in the fourth configuration example in FIG. 128, rows where relay conductors 1241 are formed, and rows where relay conductors 1241 are not formed are arranged alternately every other row in the Y direction in the sixth configuration example in FIG. 132. The relay conductors 1241 in the conductor layer A are positioned in the XY plane regions of the linear conductors 1221B in the conductor layer C.

In this manner, the relay conductors 1241 formed in gaps of the mesh conductor 1201 may be arranged in some of the gaps by arranging relay conductors 1241 in not all the gaps, but thinning out relay conductors 1241. Constraints such as the occupancy of wire regions in the conductor layer A can be followed, and the degree of freedom of designing of the wiring layout can be increased.

The sixth configuration example in FIG. 132 is similar to the fourth configuration example depicted in FIG. 128 in other respects than those mentioned above.

The conductor layer C in A in FIG. 132 is the same as the conductor layer C in the fourth configuration example depicted in FIG. 128. Accordingly, if a predetermined planar range (planar region) of the conductor layer C is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 132, the stacking of the conductor layers A and B forms a light-blocking structure, and needless to say, hot carrier light emissions from an active element group 167 can be blocked. In addition, as depicted in D and E in FIG. 132, the stacking of the conductor layers A and C, and the stacking of the conductor layers B and C also form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

By providing the relay conductors 1241 in the conductor layer A, it becomes possible to connect the mesh conductor 1202 and the linear conductors 1221B with substantially the shortest distance or with a short distance, to lead in a power supply, and voltage drops, energy loss, or inductive noise can be reduced.

By providing the relay conductors 1242 in the conductor layer B, it becomes possible to connect the mesh conductor 1201 and the linear conductors 1221A with substantially the shortest distance or with a short distance, and voltage drops, energy loss, or inductive noise can be reduced.

In the sixth configuration example in FIG. 132, the direction in which currents flow more easily in the conductor layer C and the direction in which currents flow more easily in the conductor layers A and B are substantially orthogonal and are different by approximately 90 degrees. Thereby, currents are diffused more easily (currents are less likely to be concentrated), and so inductive noise can be ameliorated further.

### Modification Example of Sixth Configuration Example of Three Conductor Layers

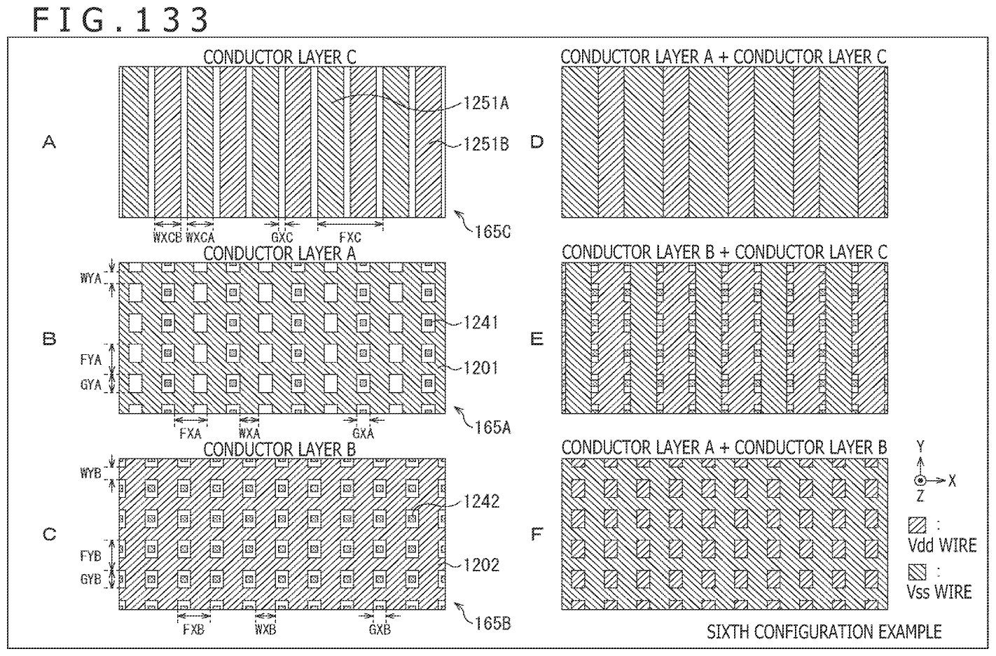

FIG. 133 depicts a modification example of the sixth configuration example of three conductor layers.

A in FIG. 133 depicts the conductor layer C (wiring layer 165C), B in FIG. 133 depicts the conductor layer A (wiring layer 165A), and C in FIG. 133 depicts the conductor layer B (wiring layer 165B).

In addition, D in FIG. 133 is a plan view of the stacked state of the conductor layer A and the conductor layer C, E in FIG. 133 is a plan view of the stacked state of the conductor layer B and the conductor layer C, and F in FIG. 133 is a plan view of the stacked state of the conductor layer A and the conductor layer B.

Sections in FIG. 133 that have counterparts in the sixth configuration example depicted in FIG. 132 are given the same reference signs, explanations of those sections are omitted as appropriate, and explanations are given with a focus on differences.

The modification example of the sixth configuration example is different from the sixth configuration example in FIG. 132 in terms of the configurations of the conductor layer A and the conductor layer C.

In the conductor layer C in A in FIG. 132, linear conductors 1221A that are long in the X direction, and linear conductors 1221B that are long in the X direction are arranged regularly alternately in the Y direction. Thereby, the direction in which currents flow more easily in the conductor layer C and the direction in which currents flow more easily in the conductor layers A and B are substantially orthogonal and are different by approximately 90 degrees.

In contrast, in the conductor layer C in A in FIG. 133, linear conductors 1251A that are long in the Y direction, and linear conductors 1251B that are long in the Y direction are arranged regularly alternately in the X direction. Thereby, the direction in which currents flow more easily in the conductor layer C, and the direction in which currents flow more easily in the conductor layers A and B are the same or substantially the same. In this case, voltage drops can be ameliorated further, depending on the wiring layout.

Next, in the conductor layer A in B in FIG. 132, rows where relay conductors 1241 are formed, and rows where relay conductors 1241 are not formed in gaps in a matrix of the mesh conductor 1201 are arranged alternately every other row in the Y direction.

In contrast, in the conductor layer A in B in FIG. 133, columns where relay conductors 1241 are formed, and columns where relay conductors 1241 are not formed in gaps in a matrix of the mesh conductor 1201 are arranged alternately every other column in the X direction. The relay conductors 1241 in the conductor layer A are positioned in the XY plane regions of the linear conductors 1251B in the conductor layer C.

The modification example of the sixth configuration example in FIG. 133 is similar to the sixth configuration example depicted in FIG. 132 in other respects than those mentioned above.

The conductor layer C in A in FIG. 133 is the same as the conductor layer C in the first modification example of the fourth configuration example depicted in FIG. 129. Accordingly, the current distribution in the linear conductors 1251A and the current distribution in the linear conductors 1251B become the same or substantially the same, and so the occurrence of inductive noise can be suppressed.

Because the linear conductors 1251A and the linear conductors 1251B include repetitions of the same wiring patterns in the X direction, capacitive noise can be offset completely in the X direction. Capacitive noise can be ameliorated more significantly if the conductor layer C is closer to the wiring layer 170.

As depicted in F in FIG. 133, the stacking of the conductor layers A and B forms a light-blocking structure, and needless to say, hot carrier light emissions from an active element group 167 can be blocked. In addition, as depicted in D in FIG. 133, the stacking of the conductor layers A and C also forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

Furthermore, in a case in which the mesh conductor 1201 in the conductor layer A and the linear conductors 1251A in the conductor layer C are electrically connected, and the mesh conductor 1202 in the conductor layer B, and the linear conductors 1251B in the conductor layer C are electrically connected, the current amounts of the conductor layers A and B can be reduced, and so inductive noise from the conductor layers A and B, and voltage drops can be ameliorated further.

Note that, while relay conductors 1241 in the conductor layer A are thinned out, and relay conductors 1242 in the conductor layer B are not thinned out in the configuration in the modification example of the sixth configuration example in FIG. 133, relay conductors 1241 in the conductor layer A may not be thinned out, and relay conductors 1242 in the conductor layer B may be thinned out in another possible configuration.

### Seventh Configuration Example of Three Conductor Layers

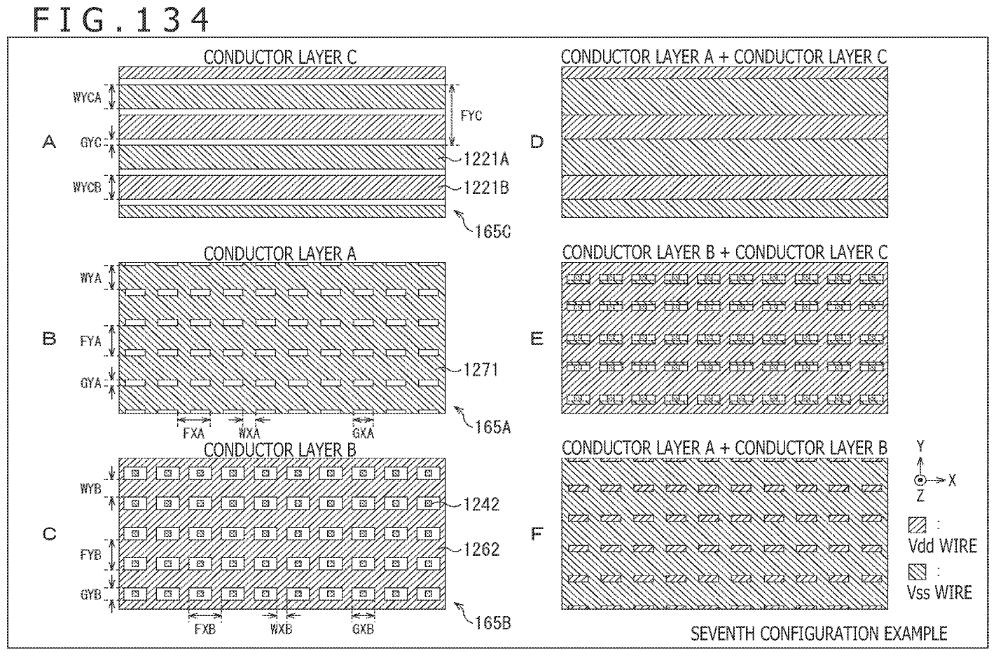

FIG. 134 depicts a seventh configuration example of three conductor layers.

A in FIG. 134 depicts the conductor layer C (wiring layer 165C), B in FIG. 134 depicts the conductor layer A (wiring layer 165A), and C in FIG. 134 depicts the conductor layer B (wiring layer 165B).

In addition, D in FIG. 134 is a plan view of the stacked state of the conductor layer A and the conductor layer C, E in FIG. 134 is a plan view of the stacked state of the conductor layer B and the conductor layer C, and F in FIG. 134 is a plan view of the stacked state of the conductor layer A and the conductor layer B.

Sections in the seventh configuration example in FIG. 134 that have counterparts in the fifth configuration example depicted in FIG. 131 are given the same reference signs, explanations of those sections are omitted as appropriate, and explanations are given with a focus on differences.

The seventh configuration example is different from the fifth configuration example in FIG. 131 only in terms of the configuration of the conductor layer A in B in FIG. 134. The conductor layers B and C in the seventh configuration example are similar to the conductor layers B and C in the fifth configuration example in FIG. 131.

The conductor layer A in B in FIG. 134 in the seventh configuration example has a mesh conductor 1271. In addition, the conductor layer A does not have relay conductors 1241 formed inside gaps of the mesh conductor 1271 that have the X-direction gap width GXA and the Y-direction gap width GYA.

In other words, the gap width GXA and gap width GYA of the mesh conductor 1271 in B in FIG. 134 are smaller than the gap width GXA and gap width GYA of the mesh conductor 1261 in B in FIG. 131, and the gaps are not sufficient for forming relay conductors 1241 therein.

The seventh configuration example in FIG. 134 is similar to the fifth configuration example depicted in FIG. 131 in other respects than those mentioned above.

The conductor layer C in A in FIG. 134 is the same as the conductor layer C in the fifth configuration example depicted in FIG. 131. Accordingly, if a predetermined planar range (planar region) of the conductor layer C is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 134, the stacking of the conductor layers A and B forms a light-blocking structure, and needless to say, hot carrier light emissions from an active element group 167 can be blocked. In addition, as depicted in D in FIG. 134, the stacking of the conductor layers A and C also forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

The seventh configuration example in FIG. 134 is particularly suitable for stacking orders that allow electrical connection between the three layers, the conductor layers A to C, specifically, the stacking order depicted in B in FIG. 120. In the case of the stacking order of the conductor layers A, C and B depicted in B in FIG. 120, the mesh conductor 1271 in the conductor layer A and the linear conductors 1221A in the conductor layer C can be connected by conductor vias in the Z direction in part of regions over which their planar regions overlap, and the mesh conductor 1262 and relay conductors 1242 in the conductor layer B can be connected with the linear conductors 1221B and 1221A in the conductor layer C by conductor vias in the Z direction between conductors with common current characteristics, and in part of regions over which their planar regions overlap.

### Eighth Configuration Example of Three Conductor Layers

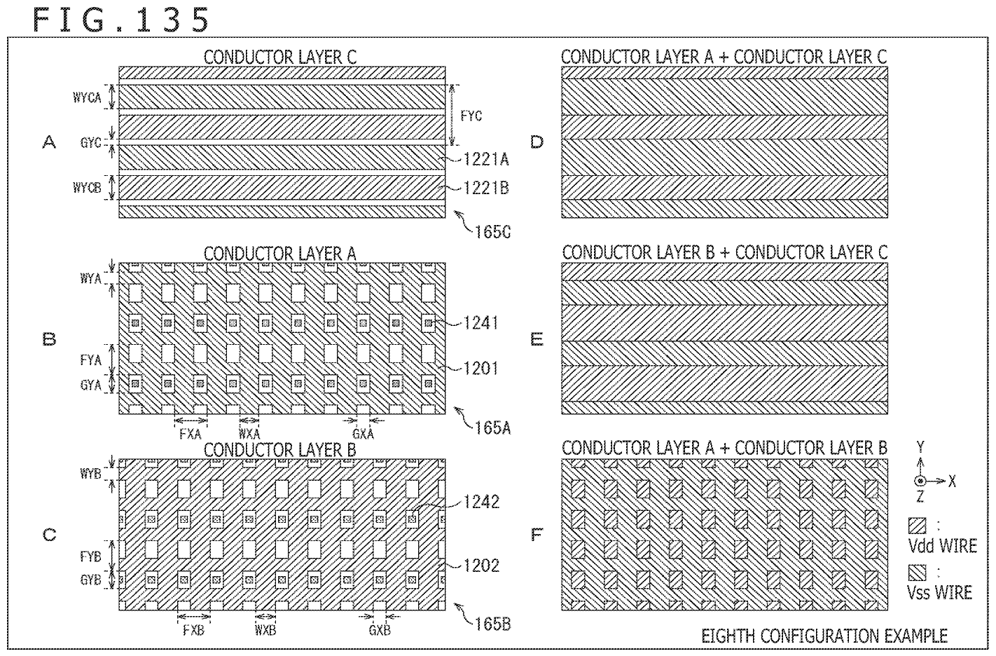

FIG. 135 depicts an eighth configuration example of three conductor layers.

A in FIG. 135 depicts the conductor layer C (wiring layer 165C), B in FIG. 135 depicts the conductor layer A (wiring layer 165A), and C in FIG. 135 depicts the conductor layer B (wiring layer 165B).

In addition, D in FIG. 135 is a plan view of the stacked state of the conductor layer A and the conductor layer C, E in FIG. 135 is a plan view of the stacked state of the conductor layer B and the conductor layer C, and F in FIG. 135 is a plan view of the stacked state of the conductor layer A and the conductor layer B.

The eighth configuration example in FIG. 135 has a configuration which is obtained by partially modifying the fourth configuration example depicted in FIG. 128, and the eighth configuration example in FIG. 135 is explained by comparing it with the fourth configuration example. Note that sections in FIG. 135 that have counterparts in FIG. 128 are given the same reference signs.

The conductor layer C in A in FIG. 135 is similar to the conductor layer C in the fourth configuration example depicted in A in FIG. 128. That is, in the conductor layer C, linear conductors 1221A that are long in the X direction, and linear conductors 1221B that are long in the X direction are arranged regularly alternately in the Y direction.

The conductor layer A in B in FIG. 128 has a configuration which is obtained by omitting some of relay conductors 1241 in the conductor layer A in the fourth configuration example depicted in FIG. 128. Specifically, while relay conductors 1241 are formed in all the gaps in a matrix of the mesh conductor 1201 in the fourth configuration example in FIG. 128, rows where relay conductors 1241 are formed, and rows where relay conductors 1241 are not formed are arranged alternately every other row in the Y direction in the eighth configuration example in FIG. 135.

Similarly, the conductor layer B in C in FIG. 128 also has a configuration which is obtained by omitting some of relay conductors 1242 in the conductor layer B in the fourth configuration example depicted in FIG. 128. Specifically, while relay conductors 1242 are formed in all the gaps in a matrix of the mesh conductor 1201 in the fourth configuration example in FIG. 128, rows where relay conductors 1242 are formed, and rows where relay conductors 1242 are not formed are arranged alternately every other row in the Y direction in the eighth configuration example in FIG. 135.

Accordingly, the eighth configuration example in FIG. 135 has a configuration in which, regarding the conductor layer A, relay conductors 1241 arranged in gaps in a matrix of the mesh conductor 1201 are thinned out every other row in the fourth configuration example depicted in FIG. 128, and, regarding the conductor layer B, relay conductors 1242 arranged in gaps in a matrix of the mesh conductor 1202 are thinned out every other row in the fourth configuration example depicted in FIG. 128.

The eighth configuration example in FIG. 135 is similar to the fourth configuration example depicted in FIG. 128 in other respects than those mentioned above.

If a predetermined planar range (planar region) of the conductor layer C in A in FIG. 135 is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 135, the stacking of the conductor layers A and B forms a light-blocking structure, and needless to say, hot carrier light emissions from an active element group 167 can be blocked. In addition, as depicted in D and E in FIG. 135, the stacking of the conductor layers A and C, and the stacking of the conductor layers B and C also form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

By providing the relay conductors 1241 in the conductor layer A, it becomes possible to connect the mesh conductor 1202 and the linear conductors 1221B with substantially the shortest distance or with a short distance, to lead in a power supply, and voltage drops, energy loss, or inductive noise can be reduced.

By providing the relay conductors 1242 in the conductor layer B, it becomes possible to connect the mesh conductor 1201 and the linear conductors 1221A with substantially the shortest distance or with a short distance, and voltage drops, energy loss, or inductive noise can be reduced.

In the eighth configuration example in FIG. 135, the direction in which currents flow more easily in the conductor layer C, and the direction in which currents flow more easily in the conductor layers A and B are substantially orthogonal, and are different by approximately 90 degrees. Thereby, currents are diffused more easily (currents are less likely to be concentrated), and so inductive noise can be ameliorated further.

### First Modification Example of Eighth Configuration Example of Three Conductor Layers

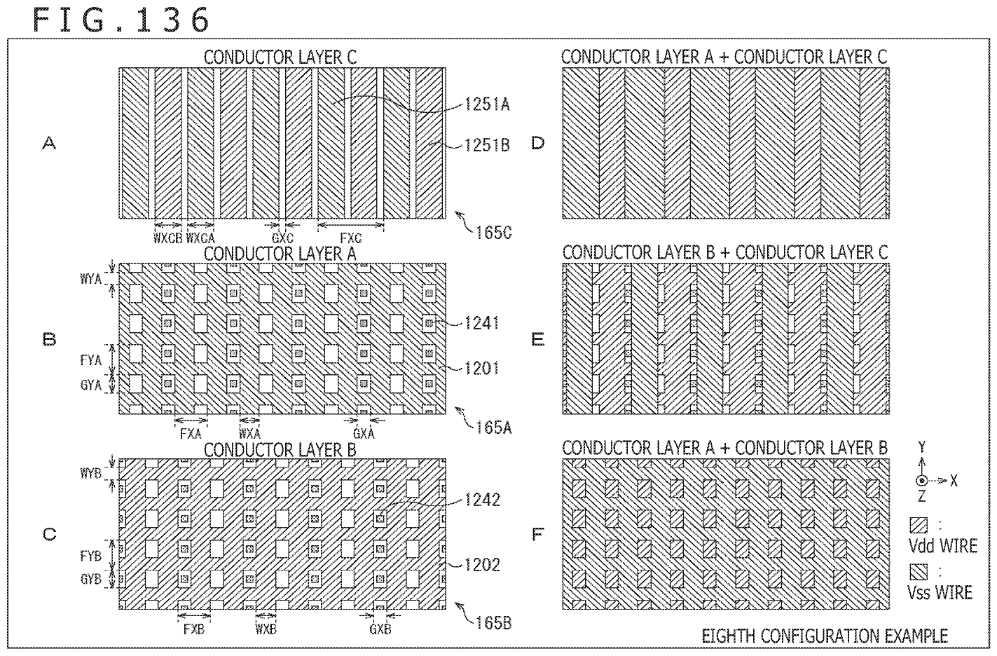

FIG. 136 depicts a first modification example of the eighth configuration example of three conductor layers.

A in FIG. 136 depicts the conductor layer C (wiring layer 165C), B in FIG. 136 depicts the conductor layer A (wiring layer 165A), and C in FIG. 136 depicts the conductor layer B (wiring layer 165B).

In addition, D in FIG. 136 is a plan view of the stacked state of the conductor layer A and the conductor layer C, E in FIG. 136 is a plan view of the stacked state of the conductor layer B and the conductor layer C, and F in FIG. 136 is a plan view of the stacked state of the conductor layer A and the conductor layer B.

Sections in FIG. 136 that have counterparts in the eighth configuration example depicted in FIG. 135 are given the same reference signs, explanations of those sections are omitted as appropriate, and explanations are given with a focus on differences.

The first modification example of the eighth configuration example is different from the eighth configuration example in FIG. 135 in terms of the configurations of the conductor layers A to C.

In the conductor layer C depicted in A in FIG. 135, linear conductors 1221A that are long in the X direction, and linear conductors 1221B that are long in the X direction are arranged regularly alternately in the Y direction. Thereby, the direction in which currents flow more easily in the conductor layer C and the direction in which currents flow more easily in the conductor layers A and B are substantially orthogonal and are different by approximately 90 degrees.

In contrast, in the conductor layer C in A in FIG. 136, linear conductors 1251A that are long in the Y direction, and linear conductors 1251B that are long in the Y direction are arranged regularly alternately in the X direction. Thereby, the direction in which currents flow more easily in the conductor layer C, and the direction in which currents flow more easily in the conductor layers A and B are the same or substantially the same. In this case, voltage drops can be ameliorated further, depending on the wiring layout.

Next, in the conductor layer A depicted in B in FIG. 135, rows where relay conductors 1241 are formed, and rows where relay conductors 1241 are not formed in gaps in a matrix of the mesh conductor 1201 are arranged alternately every other row in the Y direction.

In contrast, in the conductor layer A in B in FIG. 136, columns where relay conductors 1241 are formed, and columns where relay conductors 1241 are not formed in gaps in a matrix of the mesh conductor 1201 are arranged alternately every other column in the X direction. The relay conductors 1241 in the conductor layer A are positioned in the XY plane regions of the linear conductors 1251B in the conductor layer C.

In addition, in the conductor layer B depicted in C in FIG. 135, rows where relay conductors 1242 are formed, and rows where relay conductors 1242 are not formed in gaps in a matrix of the mesh conductor 1202 are arranged alternately every other row in the Y direction.

In contrast, in the conductor layer B in C in FIG. 136, columns where relay conductors 1242 are formed, and columns where relay conductors 1242 are not formed in gaps in a matrix of the mesh conductor 1202 are arranged alternately every other column in the X direction.

The first modification example of the eighth configuration example in FIG. 136 is similar to the eighth configuration example depicted in FIG. 135 in other respects than those mentioned above.

If a predetermined planar range (planar region) of the conductor layer C in A in FIG. 136 is looked at, the current distribution in the linear conductors 1251A and the current distribution in the linear conductors 1251B become the same or substantially the same, and so the occurrence of inductive noise can be suppressed.

Because the linear conductors 1251A and the linear conductors 1251B include repetitions of the same wiring patterns in the X direction, capacitive noise can be offset completely in the X direction. Capacitive noise can be ameliorated more significantly if the conductor layer C is closer to the wiring layer 170.

As depicted in F in FIG. 136, the stacking of the conductor layers A and B forms a light-blocking structure, and needless to say, hot carrier light emissions from an active element group 167 can be blocked. In addition, as depicted in D in FIG. 136, the stacking of the conductor layers A and C also forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

Furthermore, in a case in which the mesh conductor 1201 in the conductor layer A and the linear conductors 1251A in the conductor layer C are electrically connected, and the mesh conductor 1202 in the conductor layer B, and the linear conductors 1251B in the conductor layer C are electrically connected, the current amounts of the conductor layers A and B can be reduced, and so inductive noise from the conductor layers A and B, and voltage drops can be ameliorated further.

By providing the relay conductors 1241 in the conductor layer A, it becomes possible to connect the mesh conductor 1202 and the linear conductors 1251B with substantially the shortest distance or with a short distance, to lead in a power supply, and voltage drops, energy loss, or inductive noise can be reduced.

By providing the relay conductors 1242 in the conductor layer B, it becomes possible to connect the mesh conductor 1201 and the linear conductors 1251A with substantially the shortest distance or with a short distance, and voltage drops, energy loss, or inductive noise can be reduced.

### Second Modification Example of Eighth Configuration Example of Three Conductor Layers

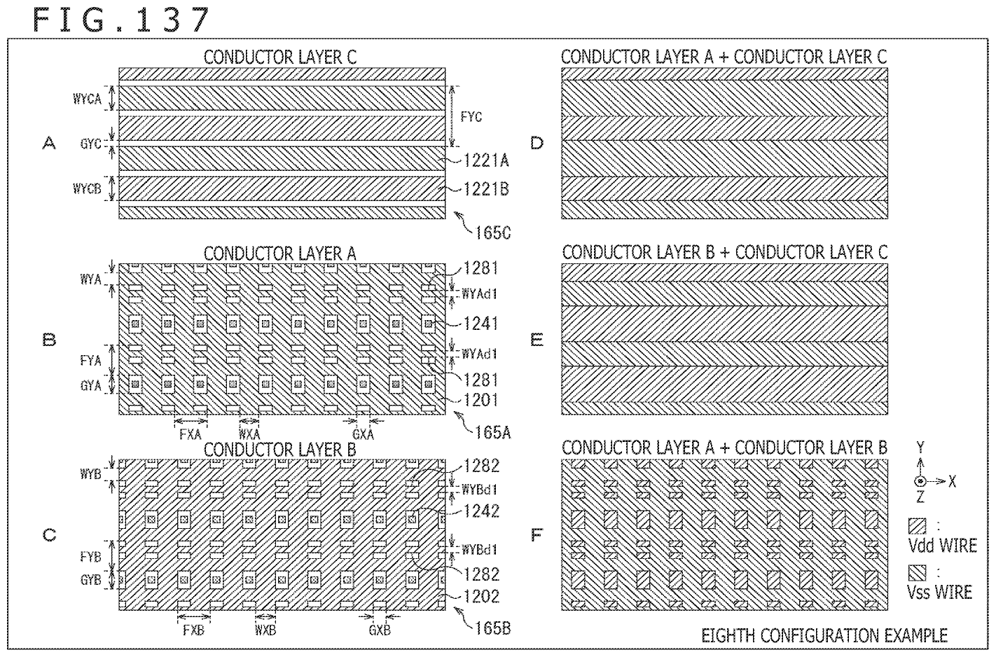

FIG. 137 depicts a second modification example of the eighth configuration example of three conductor layers.

A in FIG. 137 depicts the conductor layer C (wiring layer 165C), B in FIG. 137 depicts the conductor layer A (wiring layer 165A), and C in FIG. 137 depicts the conductor layer B (wiring layer 165B).

In addition, D in FIG. 137 is a plan view of the stacked state of the conductor layer A and the conductor layer C, E in FIG. 137 is a plan view of the stacked state of the conductor layer B and the conductor layer C, and F in FIG. 137 is a plan view of the stacked state of the conductor layer A and the conductor layer B.

Sections in FIG. 137 that have counterparts in the eighth configuration example depicted in FIG. 135 are given the same reference signs, explanations of those sections are omitted as appropriate, and explanations are given with a focus on differences.

The second modification example of the eighth configuration example is different from the eighth configuration example in FIG. 135 in terms of the configurations of the conductor layer A and the conductor layer B.

As compared with the eighth configuration example depicted in FIG. 135, the conductor layer A in B in FIG. 137 additionally has reinforcement conductors 1281 with a Y-direction conductor width WYAd1 in gaps that are in the mesh conductor 1201 and do not have relay conductors 1241 formed therein. The reinforcement conductors 1281 are linear conductors that have the X-direction conductor width which is equal to the gap width GXA and are long in the X direction.

As compared with the eighth configuration example depicted in FIG. 135, the conductor layer B in C in FIG. 137 additionally has reinforcement conductors 1282 with a Y-direction conductor width WYBd1 in gaps that are in the mesh conductor 1202 and do not have relay conductors 1242 formed therein. The reinforcement conductors 1282 are linear conductors that have the X-direction conductor width which is equal to the gap width GXB and are long in the X direction.

The second modification example of the eighth configuration example in FIG. 137 is similar to the eighth configuration example depicted in FIG. 135 in other respects than those mentioned above.

If a predetermined planar range (planar region) of the conductor layer C in A in FIG. 137 is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 137, the stacking of the conductor layers A and B forms a light-blocking structure, and needless to say, hot carrier light emissions from an active element group 167 can be blocked. In addition, as depicted in D and E in FIG. 137, the stacking of the conductor layers A and C, and the stacking of the conductor layers B and C also form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

By providing the relay conductors 1241 in the conductor layer A, it becomes possible to connect the mesh conductor 1202 and the linear conductors 1221B with substantially the shortest distance or with a short distance, to lead in a power supply, and voltage drops, energy loss, or inductive noise can be reduced.

By providing the relay conductors 1242 in the conductor layer B, it becomes possible to connect the mesh conductor 1201 and the linear conductors 1221A with substantially the shortest distance or with a short distance, and voltage drops, energy loss, or inductive noise can be reduced.

In the second modification example of the eighth configuration example in FIG. 137, the direction in which currents flow more easily in the conductor layer C and the direction in which currents flow more easily in the conductor layers A and B are substantially orthogonal and are different by approximately 90 degrees. Thereby, currents are diffused more easily (currents are less likely to be concentrated), and so inductive noise can be ameliorated further.

Because the reinforcement conductors 1281 that are long in the X direction are arranged at positions that are in the conductor layer A and are where the relay conductors 1241 are thinned out, the wire resistance can be lowered, and so voltage drops can be ameliorated further. Because voltage drops are ameliorated, inductive noise can be ameliorated also.

Because the reinforcement conductors 1282 that are long in the X direction are arranged at positions that are in the conductor layer B and are where the relay conductors 1242 are thinned out, the wire resistance can be lowered, and so voltage drops can be ameliorated further. Because voltage drops are ameliorated, inductive noise can be ameliorated also.

### Third Modification Example of Eighth Configuration Example of Three Conductor Layers

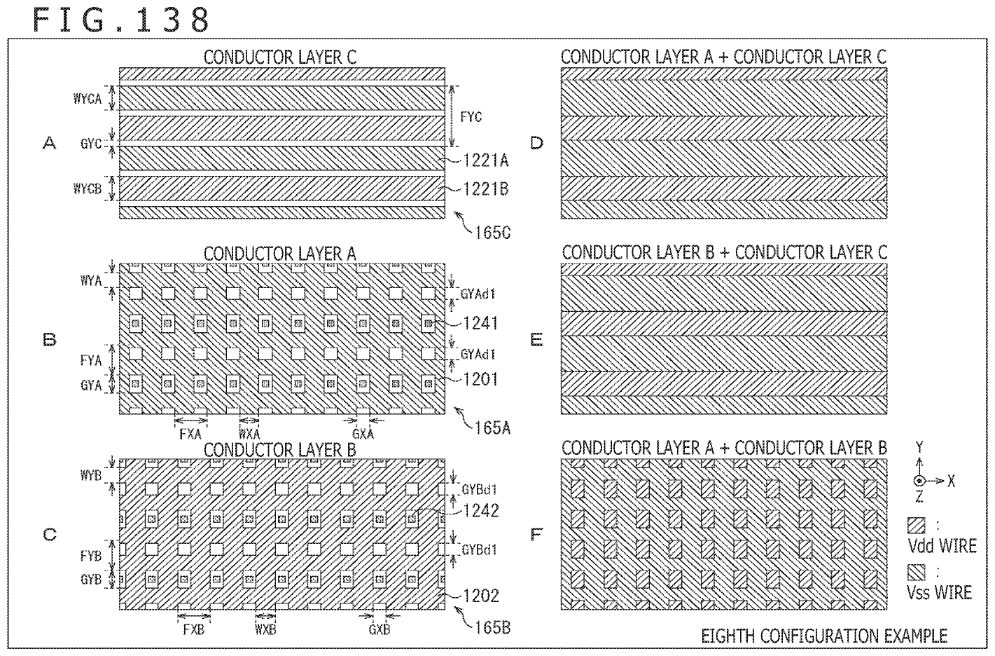

FIG. 138 depicts a third modification example of the eighth configuration example of three conductor layers.

A in FIG. 138 depicts the conductor layer C (wiring layer 165C), B in FIG. 138 depicts the conductor layer A (wiring layer 165A), and C in FIG. 138 depicts the conductor layer B (wiring layer 165B).

In addition, D in FIG. 138 is a plan view of the stacked state of the conductor layer A and the conductor layer C, E in FIG. 138 is a plan view of the stacked state of the conductor layer B and the conductor layer C, and F in FIG. 138 is a plan view of the stacked state of the conductor layer A and the conductor layer B.

Sections in FIG. 138 that have counterparts in the eighth configuration example depicted in FIG. 135 are given the same reference signs, explanations of those sections are omitted as appropriate, and explanations are given with a focus on differences.

The third modification example of the eighth configuration example is different from the eighth configuration example in FIG. 135 in terms of the configurations of the conductor layer A and the conductor layer B.

First, if the conductor layer A is looked at, gaps in a matrix of the mesh conductor 1201 in the eighth configuration example depicted in FIG. 135 have the common Y-direction gap width GYA. In other words, the Y-direction gap width GYA is the same for all the gaps in the matrix of the mesh conductor 1201.

In contrast, in the conductor layer A in B in FIG. 138, gaps in which relay conductors 1241 are formed have the Y-direction gap width GYA, and gaps in which relay conductors 1241 are not formed have a Y-direction gap width GYAd1 smaller than the gap width GYA ((gap width GYA)>(gap width GYAd1)).

Next, if the conductor layer B is looked at, gaps in a matrix of the mesh conductor 1202 in the eighth configuration example depicted in FIG. 135 have the common Y-direction gap width GYB. In other words, the Y-direction gap width GYB is the same for all the gaps in the matrix of the mesh conductor 1202.

In contrast, in the conductor layer A in B in FIG. 138, gaps in which relay conductors 1242 are formed have the Y-direction gap width GYB, and gaps in which relay conductors 1242 are not formed have a Y-direction gap width GYBd1 smaller than the gap width GYB ((gap width GYB)>(gap width GYBd1)).

The third modification example of the eighth configuration example in FIG. 138 is similar to the eighth configuration example depicted in FIG. 135 in other respects than those mentioned above.

If a predetermined planar range (planar region) of the conductor layer C in A in FIG. 138 is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 138, the stacking of the conductor layers A and B forms a light-blocking structure, and needless to say, hot carrier light emissions from an active element group 167 can be blocked. In addition, as depicted in D and E in FIG. 138, the stacking of the conductor layers A and C, and the stacking of the conductor layers B and C also form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

By providing the relay conductors 1241 in the conductor layer A, it becomes possible to connect the mesh conductor 1202 and the linear conductors 1221B with substantially the shortest distance or with a short distance, to lead in a power supply, and voltage drops, energy loss, or inductive noise can be reduced.

By providing the relay conductors 1242 in the conductor layer B, it becomes possible to connect the mesh conductor 1201 and the linear conductors 1221A with substantially the shortest distance or with a short distance, and voltage drops, energy loss, or inductive noise can be reduced.

In the third modification example of the eighth configuration example in FIG. 138, the direction in which currents flow more easily in the conductor layer C and the direction in which currents flow more easily in the conductor layers A and B are substantially orthogonal and are different by approximately 90 degrees. Thereby, currents are diffused more easily (currents are less likely to be concentrated), and so inductive noise can be ameliorated further.

Because the gap width GYAd1 of positions where relay conductors 1241 are thinned out in the conductor layer A is made smaller than the gap width GYA of positions where relay conductors 1241 are formed, the wire resistance can be lowered, and so voltage drops can be ameliorated further. Because voltage drops are ameliorated, inductive noise can be ameliorated also.

Because the gap width GYBd1 of positions where relay conductors 1242 are thinned out in the conductor layer B is made smaller than the gap width GYB of positions where relay conductors 1242 are formed, the wire resistance can be lowered, and so voltage drops can be ameliorated further. Because voltage drops are ameliorated, inductive noise can be ameliorated also.

Note that, in the third modification example of the eighth configuration example in FIG. 138, the gap width GYAd1 of positions where relay conductors 1241 are thinned out may be made smaller than the gap width GYA of positions where relay conductors 1241 are formed by making the Y-direction conductor width WYA of the mesh conductor 1201 in the conductor layer A thick, or the Y-direction conductor width WYA may be the same as that in the eighth configuration example in FIG. 135. This similarly applies also to the mesh conductor 1202 in the conductor layer B.

### Fourth Modification Example of Eighth Configuration Example of Three Conductor Layers

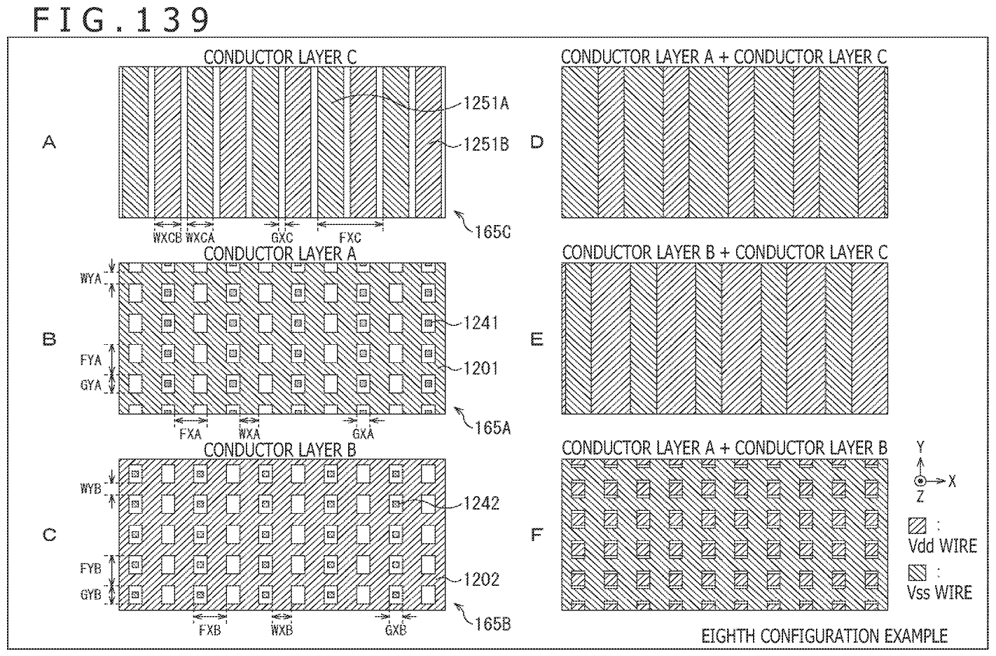

FIG. 139 depicts a fourth modification example of the eighth configuration example of three conductor layers.

A in FIG. 139 depicts the conductor layer C (wiring layer 165C), B in FIG. 139 depicts the conductor layer A (wiring layer 165A), and C in FIG. 139 depicts the conductor layer B (wiring layer 165B).

In addition, D in FIG. 139 is a plan view of the stacked state of the conductor layer A and the conductor layer C, E in FIG. 139 is a plan view of the stacked state of the conductor layer B and the conductor layer C, and F in FIG. 139 is a plan view of the stacked state of the conductor layer A and the conductor layer B.

The fourth modification example of the eighth configuration example in FIG. 139 has a configuration obtained by partially modifying the first modification example of the eighth configuration example in FIG. 136. Sections in FIG. 139 that have counterparts in FIG. 136 are given the same reference signs, explanations of those sections are omitted as appropriate, and explanations are given about differences.

In the first modification example in FIG. 136, if gap positions of the mesh conductor 1201 in the conductor layer A and the mesh conductor 1202 in the conductor layer B are compared with each other, the X-direction positions are different, and the Y-direction positions match.

On the other hand, in the fourth modification example in FIG. 139, if gap positions of the mesh conductor 1201 in the conductor layer A and the mesh conductor 1202 in the conductor layer B are compared with each other, the X-direction positions match, and the Y-direction positions are different.

The fourth modification example of the eighth configuration example in FIG. 139 is similar to the first modification example in FIG. 136 in other respects than those mentioned above. For example, they are also similar in that columns where relay conductors 1241 are formed, and columns where relay conductors 1241 are not formed in gaps in a matrix of the mesh conductor 1201 in the conductor layer A are arranged alternately every other column in the X direction, and columns where relay conductors 1242 are formed, and columns where relay conductors 1242 are not formed in gaps in a matrix of the mesh conductor 1202 in the conductor layer B are arranged alternately every other column in the X direction.

In addition, the fourth modification example of the eighth configuration example in FIG. 139 corresponds to a configuration obtained by thinning out relay conductors 1241 in every other column in the conductor layer A and thinning out relay conductors 1242 in every other column in the conductor layer B in the second modification example of the fourth configuration example depicted in FIG. 130.

If a predetermined planar range (planar region) of the conductor layer C in A in FIG. 139 is looked at, the current distribution in the linear conductors 1251A and the current distribution in the linear conductors 1251B become the same or substantially the same, and so the occurrence of inductive noise can be suppressed.

Because the linear conductors 1251A and the linear conductors 1251B include repetitions of the same wiring patterns in the X direction, capacitive noise can be offset completely in the X direction. Capacitive noise can be ameliorated more significantly if the conductor layer C is closer to the wiring layer 170.

As depicted in D and E in FIG. 139, the stacking of the conductor layers A and C, and the stacking of the conductor layers B and C form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

Furthermore, in a case in which the mesh conductor 1201 in the conductor layer A and the linear conductors 1251A in the conductor layer C are electrically connected, and the mesh conductor 1202 in the conductor layer B, and the linear conductors 1251B in the conductor layer C are electrically connected, the current amounts of the conductor layers A and B can be reduced, and so inductive noise from the conductor layers A and B, and voltage drops can be ameliorated further.

In the conductor layer C in A in FIG. 139, the direction in which currents flow more easily in the conductor layer C, and the direction in which currents flow more easily in the conductor layers A and B are the same or substantially the same. In this case, voltage drops can be ameliorated further, depending on the wiring layout.

By providing the relay conductors 1241 in the conductor layer A, it becomes possible to connect the mesh conductor 1202 and the linear conductors 1251B with substantially the shortest distance or with a short distance, to lead in a power supply, and voltage drops, energy loss, or inductive noise can be reduced.

By providing the relay conductors 1242 in the conductor layer B, it becomes possible to connect the mesh conductor 1201 and the linear conductors 1251A with substantially the shortest distance or with a short distance, and voltage drops, energy loss, or inductive noise can be reduced.

### Fifth Modification Example of Eighth Configuration Example of Three Conductor Layers

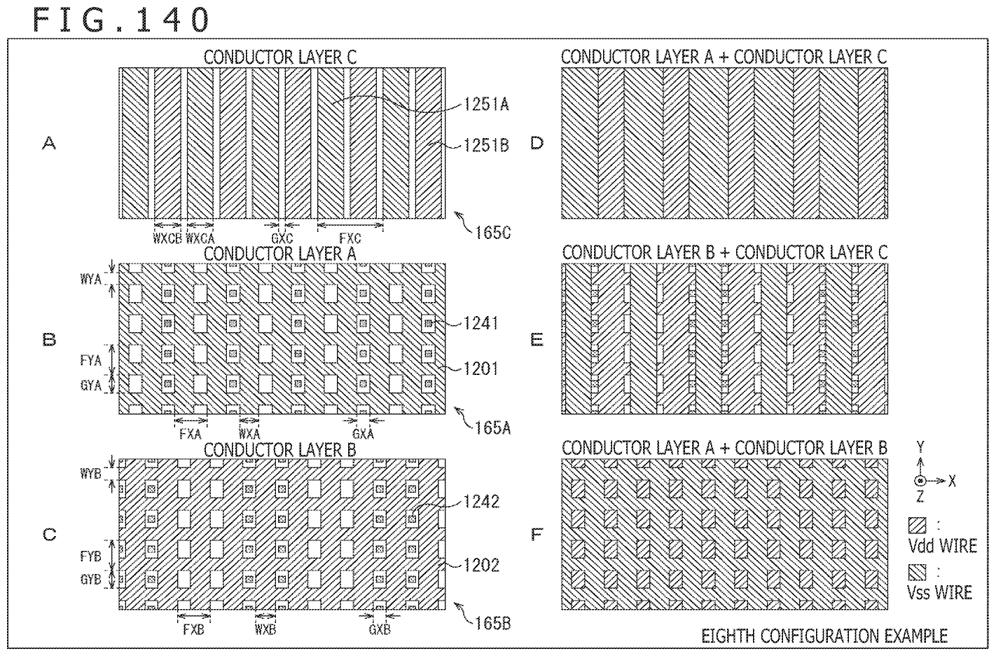

FIG. 140 depicts a fifth modification example of the eighth configuration example of three conductor layers.

A in FIG. 140 depicts the conductor layer C (wiring layer 165C), B in FIG. 140 depicts the conductor layer A (wiring layer 165A), and C in FIG. 140 depicts the conductor layer B (wiring layer 165B).

In addition, D in FIG. 140 is a plan view of the stacked state of the conductor layer A and the conductor layer C, E in FIG. 140 is a plan view of the stacked state of the conductor layer B and the conductor layer C, and F in FIG. 140 is a plan view of the stacked state of the conductor layer A and the conductor layer B.

The fifth modification example of the eighth configuration example in FIG. 140 has a configuration obtained by partially modifying the first modification example of the eighth configuration example depicted in FIG. 136. Sections in FIG. 140 that have counterparts in FIG. 136 are given the same reference signs, explanations of those sections are omitted as appropriate, and explanations are given about differences.

The fifth modification example of the eighth configuration example is different from the first modification example of the eighth configuration example in FIG. 136 only in terms of the configuration of the conductor layer B.

In the conductor layer B in the first modification example in FIG. 136, columns where relay conductors 1242 are formed, and columns where relay conductors 1242 are not formed in gaps in a matrix of the mesh conductor 1202 are arranged alternately every other column in the X direction. In other words, relay conductors 1241 are thinned out every other column.

In contrast, in the conductor layer B in FIG. 140, pairs of columns where relay conductors 1242 are formed, and pairs of columns where relay conductors 1242 are not formed in gaps in a matrix of the mesh conductor 1202 are arranged alternately in the X direction. In other words, pairs of columns of relay conductors 1241 are thinned out every other two columns.

The fifth modification example of the eighth configuration example in FIG. 140 is similar to the first modification example of the eighth configuration example in FIG. 136 in other respects than those mentioned above.

If a predetermined planar range (planar region) of the conductor layer C in A in FIG. 140 is looked at, the current distribution in the linear conductors 1251A and the current distribution in the linear conductors 1251B become the same or substantially the same, and so the occurrence of inductive noise can be suppressed.

Because the linear conductors 1251A and the linear conductors 1251B include repetitions of the same wiring patterns in the X direction, capacitive noise can be offset completely in the X direction. Capacitive noise can be ameliorated more significantly if the conductor layer C is closer to the wiring layer 170.

As depicted in F in FIG. 140, the stacking of the conductor layers A and B forms a light-blocking structure, and needless to say, hot carrier light emissions from an active element group 167 can be blocked. In addition, as depicted in D in FIG. 140, the stacking of the conductor layers A and C also forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

Furthermore, in a case in which the mesh conductor 1201 in the conductor layer A and the linear conductors 1251A in the conductor layer C are electrically connected, and the mesh conductor 1202 in the conductor layer B, and the linear conductors 1251B in the conductor layer C are electrically connected, the current amounts of the conductor layers A and B can be reduced, and so inductive noise from the conductor layers A and B, and voltage drops can be ameliorated further.

In the conductor layer C in A in FIG. 140, the direction in which currents flow more easily in the conductor layer C, and the direction in which currents flow more easily in the conductor layers A and B are the same or substantially the same. In this case, voltage drops can be ameliorated further, depending on the wiring layout.

By providing the relay conductors 1241 in the conductor layer A, it becomes possible to connect the mesh conductor 1202 and the linear conductors 1251B with substantially the shortest distance or with a short distance, to lead in a power supply, and voltage drops, energy loss, or inductive noise can be reduced.

By providing the relay conductors 1242 in the conductor layer B, it becomes possible to connect the mesh conductor 1201 and the linear conductors 1251A with substantially the shortest distance or with a short distance, and voltage drops, energy loss, or inductive noise can be reduced.

### Ninth Configuration Example of Three Conductor Layers

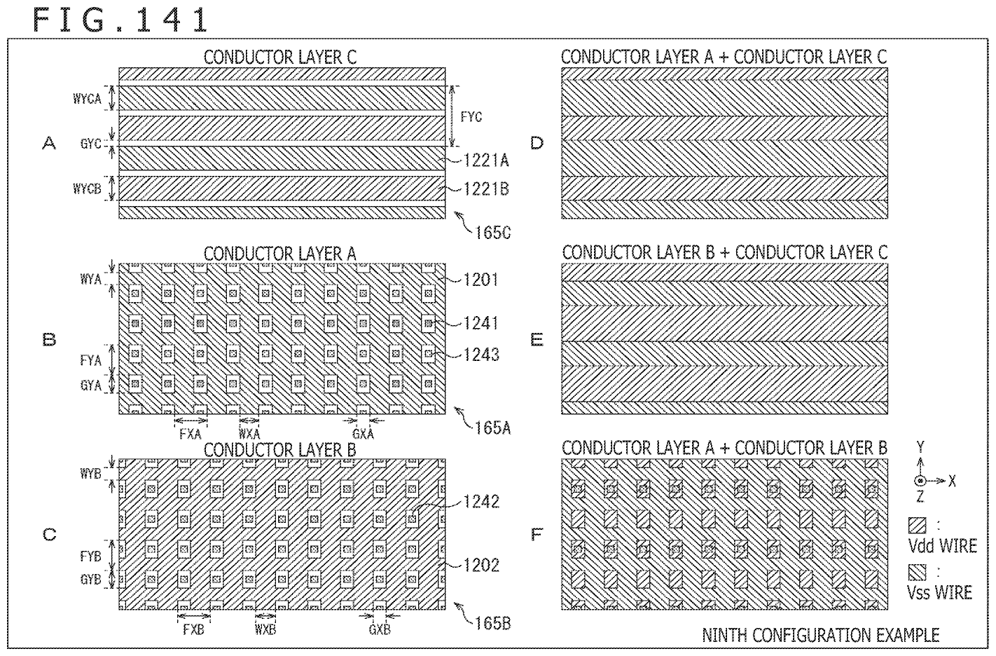

FIG. 141 depicts a ninth configuration example of three conductor layers.

A in FIG. 141 depicts the conductor layer C (wiring layer 165C), B in FIG. 141 depicts the conductor layer A (wiring layer 165A), and C in FIG. 141 depicts the conductor layer B (wiring layer 165B).

In addition, D in FIG. 141 is a plan view of the stacked state of the conductor layer A and the conductor layer C, E in FIG. 141 is a plan view of the stacked state of the conductor layer B and the conductor layer C, and F in FIG. 141 is a plan view of the stacked state of the conductor layer A and the conductor layer B.

The ninth configuration example in FIG. 141 has a configuration obtained by partially modifying the sixth configuration example in FIG. 132. Sections in FIG. 141 that have counterparts in FIG. 132 are given the same reference signs, explanations of those sections are omitted as appropriate, and explanations are given about differences.

The ninth configuration example is different from the sixth configuration example in FIG. 132 only in terms of the configuration of the conductor layer A.

In the conductor layer A in the sixth configuration example in FIG. 132, rows where relay conductors 1241 are formed, and rows where relay conductors 1241 are not formed in gaps in a matrix of the mesh conductor 1201 are arranged alternately every other row in the Y direction.

The conductor layer A in the ninth configuration example in FIG. 141 has a configuration in which relay conductors 1243 (third relay conductors) are additionally provided in gaps that are in rows in the conductor layer A and do not have relay conductors 1241 formed therein in the sixth configuration example in FIG. 132. The relay conductors 1243 are wires (Vss wires) connected to GND or a negative power supply, for example.

That is, the conductor layer A in the ninth configuration example in FIG. 141 has a configuration provided with the mesh conductor 1201 in which rows where relay conductors 1241 are formed, and columns where relay conductors 1243 are formed in gaps in a matrix of the mesh conductor 1201 are arranged alternately every other row in the Y direction.

For example, in the case of the stacking order of the conductor layers A to C in the ninth configuration example in FIG. 141 in which the conductor layer B, the conductor layer C and the conductor layer A are arranged in this order, and the conductor layer C is arranged at the middle, the relay conductors 1242 in the conductor layer B can be connected with the linear conductors 1221A in the conductor layer C by conductor vias in the Z direction, and the mesh conductor 1202 in the conductor layer B can be connected with the linear conductors 1221B in the conductor layer C by conductor vias in the Z direction. Also, the relay conductors 1241 in the conductor layer A can be connected with the linear conductors 1221B in the conductor layer C by conductor vias in the Z direction, and the relay conductors 1243 can be connected with the linear conductors 1221A in the conductor layer C by conductor vias in the Z direction. Further, the mesh conductor 1201 in the conductor layer A and the linear conductors 1221A in the conductor layer C can be connected by conductor vias in the Z direction. In addition, the relay conductors 1243 may be connected with conductors in a conductor layer other than the conductor layers A to C by conductor vias in the Z direction. Furthermore, not all of the relay conductors 1243 have to be used for electrical connection, all of the relay conductors 1243 may be used for electrical connection, or some of the relay conductors 1243 may be used for electrical connection.

By providing the relay conductors 1241 in the conductor layer A, it becomes possible to connect with the linear conductors 1221B with substantially the shortest distance or with a short distance, and voltage drops, energy loss, or inductive noise can be reduced.

By providing the relay conductors 1243 in the conductor layer A, it becomes possible to connect with the linear conductors 1221A with substantially the shortest distance or with a short distance, and voltage drops, energy loss, or inductive noise can be reduced.

By providing the relay conductors 1242 in the conductor layer B, it becomes possible to connect with the linear conductors 1221A with substantially the shortest distance or with a short distance, and voltage drops, energy loss, or inductive noise can be reduced.

The ninth configuration example in FIG. 141 is similar to the sixth configuration example in FIG. 132 in other respects than those mentioned above.

The conductor layer C in A in FIG. 141 is the same as the conductor layer C in the sixth configuration example in FIG. 132. Accordingly, if a predetermined planar range (planar region) of the conductor layer C is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 141, the stacking of the conductor layers A and B forms a light-blocking structure, and needless to say, hot carrier light emissions from an active element group 167 can be blocked. In addition, as depicted in D and E in FIG. 141, the stacking of the conductor layers A and C, and the stacking of the conductor layers B and C also form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

In the ninth configuration example in FIG. 141, the direction in which currents flow more easily in the conductor layer C and the direction in which currents flow more easily in the conductor layers A and B are substantially orthogonal and are different by approximately 90 degrees. Thereby, currents are diffused more easily (currents are less likely to be concentrated), and so inductive noise can be ameliorated further.

### First Modification Example of Ninth Configuration Example of Three Conductor Layers

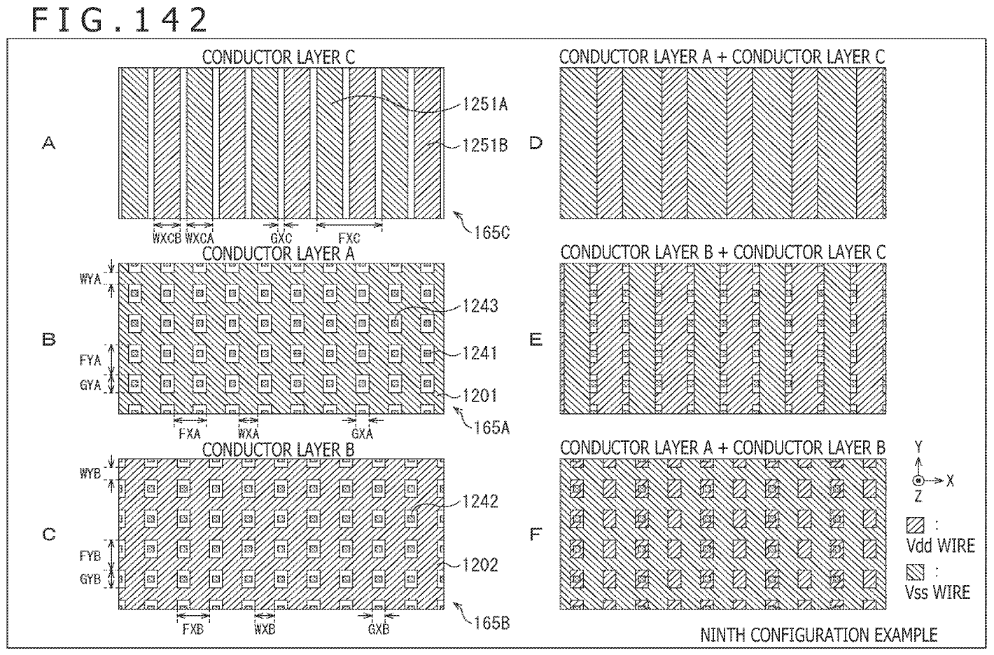

FIG. 142 depicts a first modification example of the ninth configuration example of three conductor layers.

A in FIG. 142 depicts the conductor layer C (wiring layer 165C), B in FIG. 142 depicts the conductor layer A (wiring layer 165A), and C in FIG. 142 depicts the conductor layer B (wiring layer 165B).

In addition, D in FIG. 142 is a plan view of the stacked state of the conductor layer A and the conductor layer C, E in FIG. 142 is a plan view of the stacked state of the conductor layer B and the conductor layer C, and F in FIG. 142 is a plan view of the stacked state of the conductor layer A and the conductor layer B.

The first modification example of the ninth configuration example has a configuration obtained by partially modifying the first modification example of the sixth configuration example in FIG. 133. Sections in FIG. 142 that have counterparts in FIG. 133 are given the same reference signs, explanations of those sections are omitted as appropriate, and explanations are given about differences.

The first modification example of the ninth configuration example is different from the first modification example of the sixth configuration example in FIG. 133 only in terms of the configuration of the conductor layer A.

In the conductor layer A in the first modification example of the sixth configuration example in FIG. 133, columns where relay conductors 1241 are formed, and columns where relay conductors 1241 are not formed in gaps in a matrix of the mesh conductor 1201 are arranged alternately every other column in the Y direction.

The conductor layer A in the first modification example of the ninth configuration example in FIG. 142 has a configuration in which relay conductors 1243 are additionally provided in gaps that are in columns in the conductor layer A and do not have relay conductors 1241 formed therein in the first modification example of the sixth configuration example in FIG. 133.

That is, the conductor layer A in the first modification example of the ninth configuration example in FIG. 142 has a configuration provided with the mesh conductor 1201 in which columns where relay conductors 1241 are formed, and columns where relay conductors 1243 are formed in gaps in a matrix of the mesh conductor 1201 are arranged alternately every other column in the X direction.

For example, in the case of the stacking order of the conductor layers A to C in the ninth configuration example in FIG. 142 in which the conductor layer B, the conductor layer C and the conductor layer A are arranged in this order, and the conductor layer C is arranged at the middle, the relay conductors 1242 in the conductor layer B can be connected with the linear conductors 1251A in the conductor layer C, and the mesh conductor 1202 in the conductor layer B can be connected with the linear conductors 1251B in the conductor layer C by conductor vias in the Z direction. In addition, the relay conductors 1241 in the conductor layer A can be connected with the linear conductors 1251B in the conductor layer C, and the relay conductors 1243 can be connected with the linear conductors 1251A in the conductor layer C. Furthermore, the mesh conductor 1201 in the conductor layer A and the linear conductors 1251A in the conductor layer C can be connected by conductor vias in the Z direction.

By providing the relay conductors 1241 in the conductor layer A, it becomes possible to connect with the linear conductors 1251B with substantially the shortest distance or with a short distance, and voltage drops, energy loss, or inductive noise can be reduced.

By providing the relay conductors 1243 in the conductor layer A, it becomes possible to connect with the linear conductors 1251A with substantially the shortest distance or with a short distance, and voltage drops, energy loss, or inductive noise can be reduced.

By providing the relay conductors 1242 in the conductor layer B, it becomes possible to connect with the linear conductors 1251A with substantially the shortest distance or with a short distance, and voltage drops, energy loss, or inductive noise can be reduced.

The first modification example of the ninth configuration example in FIG. 142 is similar to the first modification example of the sixth configuration example in FIG. 133 in other respects than those mentioned above.

The conductor layer C in A in FIG. 142 is the same as the conductor layer C in the sixth configuration example in FIG. 132. Accordingly, if a predetermined planar range (planar region) of the conductor layer C is looked at, the current distribution in the linear conductors 1251A and the current distribution in the linear conductors 1251B become the same or substantially the same, and so the occurrence of inductive noise can be suppressed.

Because the linear conductors 1251A and the linear conductors 1251B include repetitions of the same wiring patterns in the X direction, capacitive noise can be offset completely in the X direction. Capacitive noise can be ameliorated more significantly if the conductor layer C is closer to the wiring layer 170.

As depicted in F in FIG. 142, the stacking of the conductor layers A and B forms a light-blocking structure, and needless to say, hot carrier light emissions from an active element group 167 can be blocked. In addition, as depicted in D in FIG. 142, the stacking of the conductor layers A and C also forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

In the first modification example of the ninth configuration example in FIG. 142, the direction in which currents flow more easily in the conductor layer C, and the direction in which currents flow more easily in the conductor layers A and B are the same or substantially the same. In this case, voltage drops can be ameliorated further, depending on the wiring layout.

### Second Modification Example of Ninth Configuration Example of Three Conductor Layers

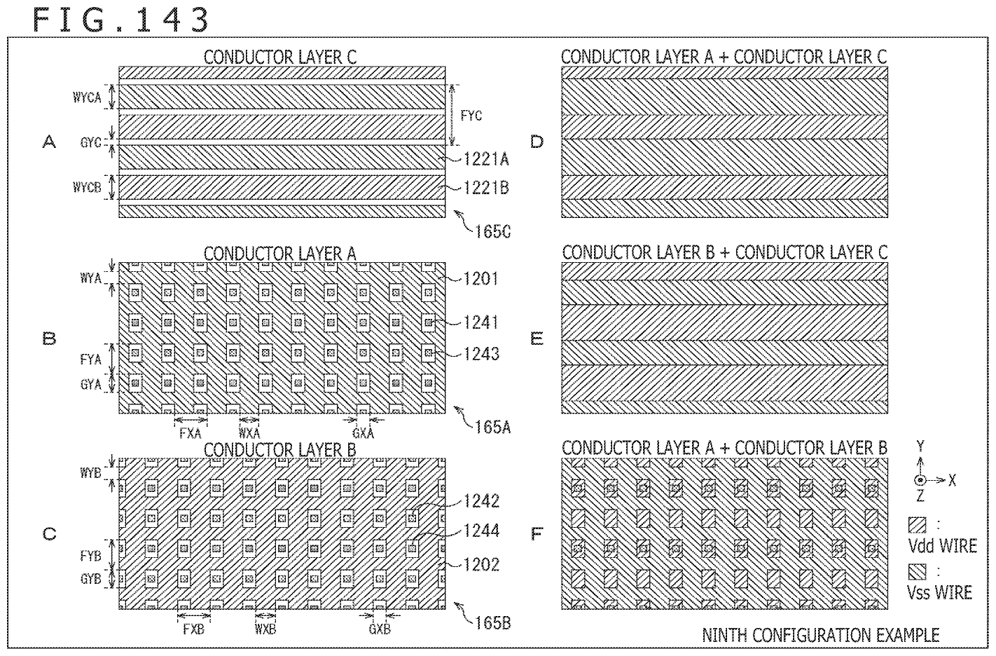

FIG. 143 depicts a second modification example of the ninth configuration example of three conductor layers.

A in FIG. 143 depicts the conductor layer C (wiring layer 165C), B in FIG. 143 depicts the conductor layer A (wiring layer 165A), and C in FIG. 143 depicts the conductor layer B (wiring layer 165B).

In addition, D in FIG. 143 is a plan view of the stacked state of the conductor layer A and the conductor layer C, E in FIG. 143 is a plan view of the stacked state of the conductor layer B and the conductor layer C, and F in FIG. 143 is a plan view of the stacked state of the conductor layer A and the conductor layer B.

The second modification example of the ninth configuration example has a configuration obtained by partially modifying the ninth configuration example in FIG. 141. Sections in FIG. 143 that have counterparts in FIG. 141 are given the same reference signs, explanations of those sections are omitted as appropriate, and explanations are given about differences.

The second modification example of the ninth configuration example is different from the ninth configuration example in FIG. 141 only in terms of the configuration of the conductor layer B.

The conductor layer B in the ninth configuration example in FIG. 141 has a configuration provided with the mesh conductor 1202 in which relay conductors 1242 are formed in all the gaps in a matrix of the mesh conductor 1202.

In contrast, in the second modification example of the ninth configuration example in FIG. 143, rows where relay conductors 1242 are formed, and rows where relay conductors 1244 (fourth relay conductors) are formed in gaps in the mesh conductor 1201 are arranged alternately every other row in the Y direction. The relay conductors 1244 are wires (Vdd wire) connected to a positive power supply, for example.

For example, in the case of the stacking order of the conductor layers A to C in the second modification example of the ninth configuration example in FIG. 143 in which the conductor layer B, the conductor layer A and the conductor layer C are arranged in this order, and the conductor layer A is arranged at the middle, the relay conductors 1242 in the conductor layer B are connected with the mesh conductor 1201 in the conductor layer A by conductor vias in the Z direction, and the relay conductors 1244 in the conductor layer B are connected with the mesh conductor 1202 in the conductor layer B via conductors in a conductor layer other than the conductor layers A to C. In addition, the mesh conductor 1202 in the conductor layer B can be connected with the relay conductors 1241 in the conductor layer A by conductor vias in the Z direction. The relay conductors 1241 in the conductor layer A can be connected with the linear conductors 1221B in the conductor layer C by conductor vias in the Z direction, and the relay conductors 1243 can be connected with the linear conductors 1221A in the conductor layer C by conductor vias in the Z direction. Furthermore, the mesh conductor 1201 in the conductor layer A can be connected with the linear conductors 1221A in the conductor layer C by conductor vias in the Z direction. Note that not all of the relay conductors 1244 have to be used for electrical connection, all of the relay conductors 1244 may be used for electrical connection, or some of the relay conductors 1244 may be used for electrical connection. In the second modification example of the ninth configuration example in FIG. 143, the shape of Vdd wires and the shape of Vss wires in the conductor layers A and B are the same or substantially the same although there is positional displacement. Accordingly, the layouts of the conductor layers A to C can be designed easily in some cases, and the Vdd wires and the Vss wires can be easily given a suitable current relation or voltage relation in some cases.

By providing the relay conductors 1241 in the conductor layer A, it becomes possible to connect with the linear conductors 1221B with substantially the shortest distance or with a short distance, and voltage drops, energy loss, or inductive noise can be reduced.

By providing the relay conductors 1243 in the conductor layer A, it becomes possible to connect with the linear conductors 1221A with substantially the shortest distance or with a short distance, and voltage drops, energy loss, or inductive noise can be reduced.

By providing the relay conductors 1242 in the conductor layer B, it becomes possible to connect with the linear conductors 1221A with substantially the shortest distance or with a short distance, and voltage drops, energy loss, or inductive noise can be reduced.

By providing the relay conductors 1244 in the conductor layer B, it becomes possible to connect with the linear conductors 1221B with substantially the shortest distance or with a short distance, and voltage drops, energy loss, or inductive noise can be reduced.

The second modification example of the ninth configuration example in FIG. 143 is similar to the ninth configuration example in FIG. 141 in other respects than those mentioned above.

The conductor layer C in A in FIG. 143 is the same as the conductor layer C in the ninth configuration example in FIG. 141. Accordingly, if a predetermined planar range (planar region) of the conductor layer C is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 143, the stacking of the conductor layers A and B forms a light-blocking structure, and needless to say, hot carrier light emissions from an active element group 167 can be blocked. In addition, as depicted in D and E in FIG. 143, the stacking of the conductor layers A and C, and the stacking of the conductor layers B and C also form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

In the ninth configuration example in FIG. 143, the direction in which currents flow more easily in the conductor layer C and the direction in which currents flow more easily in the conductor layers A and B are substantially orthogonal and are different by approximately 90 degrees. Thereby, currents are diffused more easily (currents are less likely to be concentrated), and so inductive noise can be ameliorated further.

### Third Modification Example of Ninth Configuration Example of Three Conductor Layers

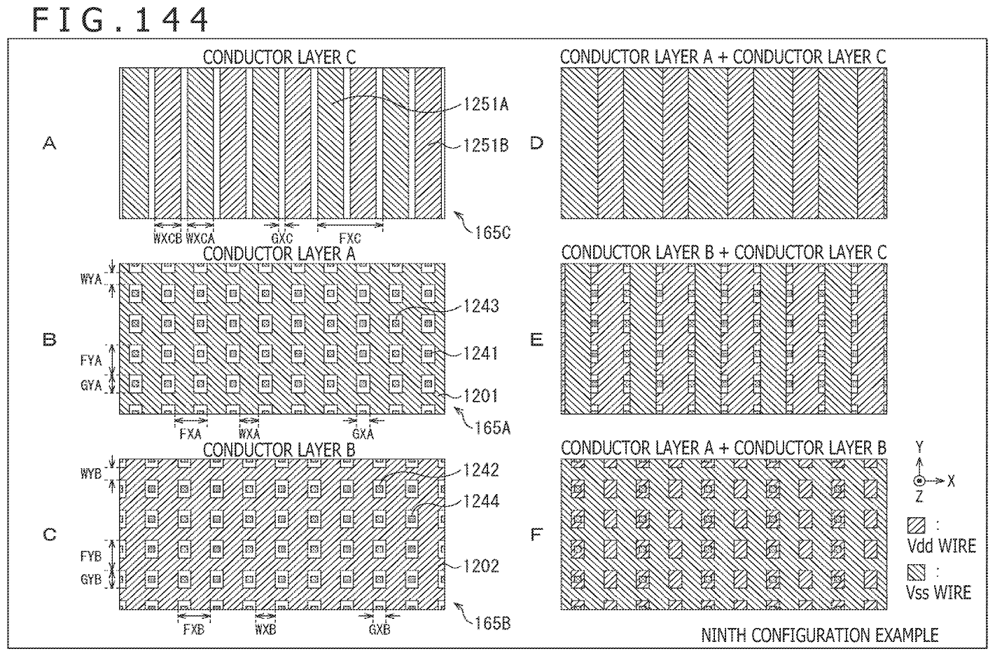

FIG. 144 depicts a third modification example of the ninth configuration example of three conductor layers.

A in FIG. 144 depicts the conductor layer C (wiring layer 165C), B in FIG. 144 depicts the conductor layer A (wiring layer 165A), and C in FIG. 144 depicts the conductor layer B (wiring layer 165B).

In addition, D in FIG. 144 is a plan view of the stacked state of the conductor layer A and the conductor layer C, E in FIG. 144 is a plan view of the stacked state of the conductor layer B and the conductor layer C, and F in FIG. 144 is a plan view of the stacked state of the conductor layer A and the conductor layer B.

The third modification example of the ninth configuration example has a configuration obtained by partially modifying the first modification example of the ninth configuration example in FIG. 142. Sections in FIG. 144 that have counterparts in FIG. 142 are given the same reference signs, explanations of those sections are omitted as appropriate, and explanations are given about differences.

The third modification example of the ninth configuration example is different from the first modification example of the ninth configuration example in FIG. 142 only in terms of the configuration of the conductor layer B.

The conductor layer B in the first modification example of the ninth configuration example in FIG. 142 has a configuration provided with the mesh conductor 1202 in which relay conductors 1242 are formed in all the gaps in a matrix of the mesh conductor 1202.

In contrast, the conductor layer B in the third modification example of the ninth configuration example in FIG. 144 has a configuration provided with the mesh conductor 1202 in which columns where relay conductors 1242 are formed, and columns where relay conductors 1244 are formed in gaps in a matrix of the mesh conductor 1202 are arranged alternately every other column in the X direction.

For example, in the case of the stacking order of the conductor layers A to C in the third modification example of the ninth configuration example in FIG. 144 in which the conductor layer B, the conductor layer A and the conductor layer C are arranged in this order, and the conductor layer A is arranged at the middle, the relay conductors 1242 in the conductor layer B are connected with the mesh conductor 1201 in the conductor layer A by conductor vias in the Z direction, and the relay conductors 1244 in the conductor layer B are connected with the mesh conductor 1202 in the conductor layer B via conductors in a conductor layer other than the conductor layers A to C. In addition, the mesh conductor 1202 in the conductor layer B can be connected with the relay conductors 1241 in the conductor layer A by conductor vias in the Z direction. The relay conductors 1241 in the conductor layer A can be connected with the linear conductors 1251B in the conductor layer C by conductor vias in the Z direction, and the relay conductors 1243 can be connected with the linear conductors 1251A in the conductor layer C by conductor vias in the Z direction. Furthermore, the mesh conductor 1201 in the conductor layer A can be connected with the linear conductors 1251A in the conductor layer C by conductor vias in the Z direction. In the third modification example of the ninth configuration example in FIG. 144, the shape of Vdd wires and the shape of Vss wires in the conductor layers A and B are the same or substantially the same although there is positional displacement. Accordingly, the layouts of the conductor layers A to C can be designed easily in some cases, and the Vdd wires and the Vss wires can be easily given a suitable current relation or voltage relation in some cases.

By providing the relay conductors 1241 in the conductor layer A, it becomes possible to connect with the linear conductors 1251B with substantially the shortest distance or with a short distance, and voltage drops, energy loss, or inductive noise can be reduced.

By providing the relay conductors 1243 in the conductor layer A, it becomes possible to connect with the linear conductors 1251A with substantially the shortest distance or with a short distance, and voltage drops, energy loss, or inductive noise can be reduced.

By providing the relay conductors 1242 in the conductor layer B, it becomes possible to connect with the linear conductors 1251A with substantially the shortest distance or with a short distance, and voltage drops, energy loss, or inductive noise can be reduced.

By providing the relay conductors 1244 in the conductor layer B, it becomes possible to connect with the linear conductors 1251B with substantially the shortest distance or with a short distance, and voltage drops, energy loss, or inductive noise can be reduced.

The third modification example of the ninth configuration example in FIG. 144 is similar to the first modification example of the ninth configuration example in FIG. 142 in other respects than those mentioned above.

The conductor layer C in A in FIG. 144 is the same as the conductor layer C in the first modification example of the ninth configuration example in FIG. 142. Accordingly, if a predetermined planar range (planar region) of the conductor layer C is looked at, the current distribution in the linear conductors 1251A and the current distribution in the linear conductors 1251B become the same or substantially the same, and so the occurrence of inductive noise can be suppressed.

Because the linear conductors 1251A and the linear conductors 1251B include repetitions of the same wiring patterns in the X direction, capacitive noise can be offset completely in the X direction. Capacitive noise can be ameliorated more significantly if the conductor layer C is closer to the wiring layer 170.

As depicted in F in FIG. 144, the stacking of the conductor layers A and B forms a light-blocking structure, and needless to say, hot carrier light emissions from an active element group 167 can be blocked. In addition, as depicted in D in FIG. 144, the stacking of the conductor layers A and C also forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

In the third modification example of the ninth configuration example in FIG. 144, the direction in which currents flow more easily in the conductor layer C, and the direction in which currents flow more easily in the conductor layers A and B are the same or substantially the same. In this case, voltage drops can be ameliorated further, depending on the wiring layout.

### Fourth Modification Example of Ninth Configuration Example of Three Conductor Layers

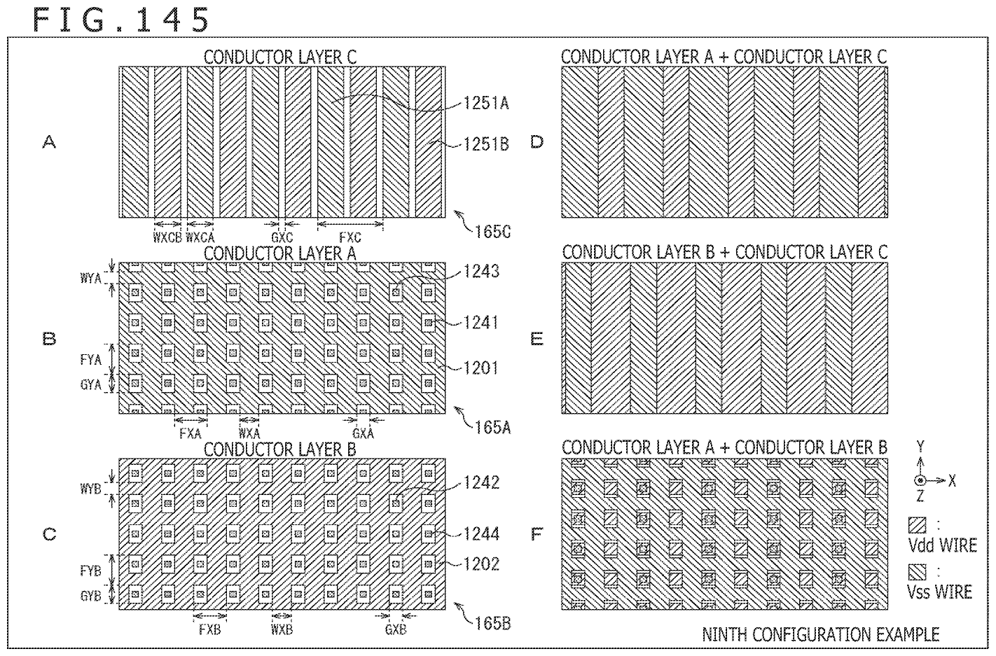

FIG. 145 depicts a fourth modification example of the ninth configuration example of three conductor layers.

A in FIG. 145 depicts the conductor layer C (wiring layer 165C), B in FIG. 145 depicts the conductor layer A (wiring layer 165A), and C in FIG. 145 depicts the conductor layer B (wiring layer 165B).

In addition, D in FIG. 145 is a plan view of the stacked state of the conductor layer A and the conductor layer C, E in FIG. 145 is a plan view of the stacked state of the conductor layer B and the conductor layer C, and F in FIG. 145 is a plan view of the stacked state of the conductor layer A and the conductor layer B.

The fourth modification example of the ninth configuration example has a configuration obtained by partially modifying the third modification example of the ninth configuration example in FIG. 144. Sections in FIG. 145 that have counterparts in FIG. 144 are given the same reference signs, explanations of those sections are omitted as appropriate, and explanations are given about differences.

In the third modification example in FIG. 144, if gap positions of the mesh conductor 1201 in the conductor layer A and the mesh conductor 1202 in the conductor layer B are compared with each other, the X-direction positions are different, and the Y-direction positions match.

On the other hand, in the fourth modification example in FIG. 145, if gap positions of the mesh conductor 1201 in the conductor layer A and the mesh conductor 1202 in the conductor layer B are compared with each other, the X-direction positions match, and the Y-direction positions are different.

In addition, for example, if the positions of the relay conductors 1241 in the conductor layer A and the relay conductors 1244 in the conductor layer B are compared with each other, the X-direction positions are different, and the Y-direction positions match in the third modification example in FIG. 144. On the other hand, in the fourth modification example in FIG. 145, the X-direction positions match, and the Y-direction positions are different.

In addition, for example, if the positions of the relay conductors 1243 in the conductor layer A, and the relay conductors 1242 in the conductor layer B are compared with each other, the X-direction positions are different, and the Y-direction positions match in the third modification example in FIG. 144. On the other hand, in the fourth modification example in FIG. 145, the X-direction positions match, and the Y-direction positions are different.

In the third modification example in FIG. 144, the stacking of the conductor layers A and B, and the stacking of the conductor layers A and C form light-blocking structures, and the light-blocking property is maintained. On the other hand, in the fourth modification example in FIG. 145, the stacking of the conductor layers A and C, and the stacking of the conductor layers B and C form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

In addition, for example, in the case of the stacking order of the conductor layers A to C in the fourth modification example of the ninth configuration example in FIG. 145 in which the conductor layer B, the conductor layer C and the conductor layer A are arranged in this order, and the conductor layer C is arranged at the middle, the relay conductors 1242 in the conductor layer B are connected with the linear conductors 1251A in the conductor layer C by conductor vias in the Z direction, and the relay conductors 1244 in the conductor layer B are connected with the linear conductors 1251B in the conductor layer C by conductor vias in the Z direction. In addition, the mesh conductor 1202 in the conductor layer B can be connected with the linear conductors 1251B in the conductor layer C by conductor vias in the Z direction. The relay conductors 1241 in the conductor layer A can be connected with the linear conductors 1251B in the conductor layer C by conductor vias in the Z direction, and the relay conductors 1243 can be connected with the linear conductors 1251A in the conductor layer C by conductor vias in the Z direction. In addition, the mesh conductor 1201 in the conductor layer A can be connected with the linear conductors 1251A in the conductor layer C by conductor vias in the Z direction. Furthermore, the relay conductors 1244 may be connected with conductors in a conductor layer other than the conductor layers A to C by conductor vias in the Z direction.

The fourth modification example in FIG. 145 is similar to the third modification example in FIG. 144 in other respects than those mentioned above.

If a predetermined planar range (planar region) of the conductor layer C in A in FIG. 145 is looked at, the current distribution in the linear conductors 1251A and the current distribution in the linear conductors 1251B become the same or substantially the same, and so the occurrence of inductive noise can be suppressed.

Because the linear conductors 1251A and the linear conductors 1251B include repetitions of the same wiring patterns in the X direction, capacitive noise can be offset completely in the X direction. Capacitive noise can be ameliorated more significantly if the conductor layer C is closer to the wiring layer 170.

In the fourth modification example of the ninth configuration example in FIG. 145, the direction in which currents flow more easily in the conductor layer C, and the direction in which currents flow more easily in the conductor layers A and B are the same or substantially the same. In this case, voltage drops can be ameliorated further, depending on the wiring layout.

By providing the relay conductors 1241 in the conductor layer A, it becomes possible to connect with the linear conductors 1251B with substantially the shortest distance or with a short distance, and voltage drops, energy loss, or inductive noise can be reduced.

By providing the relay conductors 1243 in the conductor layer A, it becomes possible to connect with the linear conductors 1251A with substantially the shortest distance or with a short distance, and voltage drops, energy loss, or inductive noise can be reduced.

By providing the relay conductors 1242 in the conductor layer B, it becomes possible to connect with the linear conductors 1251A with substantially the shortest distance or with a short distance, and voltage drops, energy loss, or inductive noise can be reduced.

By providing the relay conductors 1244 in the conductor layer B, it becomes possible to connect with the linear conductors 1251B with substantially the shortest distance or with a short distance, and voltage drops, energy loss, or inductive noise can be reduced.

### Tenth Configuration Example of Three Conductor Layers

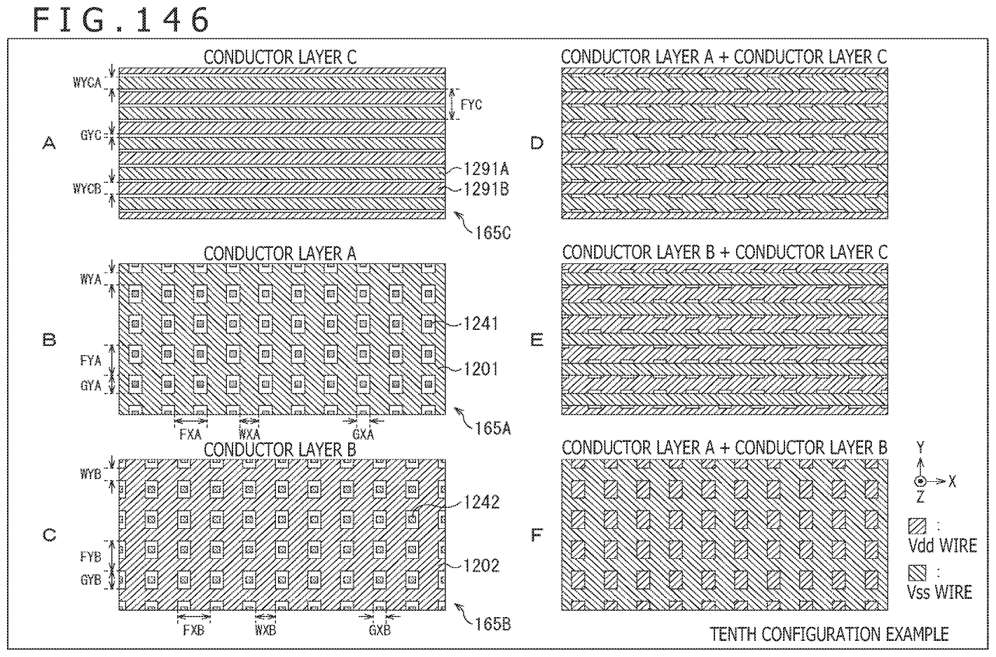

FIG. 146 depicts a tenth configuration example of three conductor layers.

A in FIG. 146 depicts the conductor layer C (wiring layer 165C), B in FIG. 146 depicts the conductor layer A (wiring layer 165A), and C in FIG. 146 depicts the conductor layer B (wiring layer 165B).

In addition, D in FIG. 146 is a plan view of the stacked state of the conductor layer A and the conductor layer C, E in FIG. 146 is a plan view of the stacked state of the conductor layer B and the conductor layer C, and F in FIG. 146 is a plan view of the stacked state of the conductor layer A and the conductor layer B.

The tenth configuration example has a configuration obtained by partially modifying the fourth configuration example in FIG. 128. Sections in FIG. 146 that have counterparts in FIG. 128 are given the same reference signs, explanations of those sections are omitted as appropriate, and explanations are given about differences.

The tenth configuration example is different from the fourth configuration example in FIG. 128 only in terms of the configuration of the conductor layer C.

In the conductor layer C in A in FIG. 146, linear conductors 1291A that are long in the X direction, and linear conductors 1291B that are long in the X direction are arranged regularly alternately in the Y direction. The linear conductors 1219A are wires (Vss wires) connected to GND or a negative power supply, for example. The linear conductors 1291B are wires (Vdd wires) connected to a positive power supply, for example.

In the fourth configuration example in FIG. 128, the conductor pitch FYC, which is the repetition pitch of the linear conductors 1221A in the conductor layer C in A in FIG. 128, is 200% of the conductor pitch FYA, which is the Y-direction repetition pitch of the mesh conductor 1201 in the conductor layer A in B in FIG. 128.

In contrast, the conductor pitch FYC, which is the repetition pitch of the linear conductors 1291A in the conductor layer C in A in FIG. 146, is 100% of the conductor pitch FYA, which is the Y-direction repetition pitch of the mesh conductor 1201 in the conductor layer A in B in FIG. 146.

Similarly, while, in the fourth configuration example in FIG. 128, the conductor pitch FYC of the linear conductors 1221B in the conductor layer C in A in FIG. 128 is 200% of the conductor pitch FYB of the mesh conductor 1202 in the conductor layer B in C in FIG. 128, the conductor pitch FYC of the linear conductors 1291B in the conductor layer C in A in FIG. 146 is 100% of the conductor pitch FYB of the mesh conductor 1202 in the conductor layer B in C in FIG. 146.

The tenth configuration example in FIG. 146 is similar to the fourth configuration example in FIG. 128 in other respects than those mentioned above.

If a predetermined planar range (planar region) of the conductor layer C in A in FIG. 146 is looked at, the current distribution in the linear conductors 1291A and the current distribution in the linear conductors 1291B become the same or substantially the same, and so the occurrence of inductive noise can be suppressed.

Because the linear conductors 1291A and the linear conductors 1291B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 146, the stacking of the conductor layers A and B forms a light-blocking structure, and needless to say, hot carrier light emissions from an active element group 167 can be blocked. In addition, as depicted in D and E in FIG. 132, the light-blocking property is maintained within a certain range also by the stacking of the conductor layers A and C, and the stacking of the conductor layers B and C. Thereby, the light-blocking constraints of the conductor layers A and B can be relaxed. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

In the tenth configuration example in FIG. 146, the direction in which currents flow more easily in the conductor layer C and the direction in which currents flow more easily in the conductor layers A and B are substantially orthogonal and are different by approximately 90 degrees. Thereby, currents are diffused more easily (currents are less likely to be concentrated), and so inductive noise can be ameliorated further.

By providing the relay conductors 1241 in the conductor layer A, it becomes possible to connect with the linear conductors 1291B with substantially the shortest distance or with a short distance, and voltage drops, energy loss, or inductive noise can be reduced.

By providing the relay conductors 1242 in the conductor layer B, it becomes possible to connect with the linear conductors 1291A with substantially the shortest distance or with a short distance, and voltage drops, energy loss, or inductive noise can be reduced.

### Modification Example of Tenth Configuration Example of Three Conductor Layers

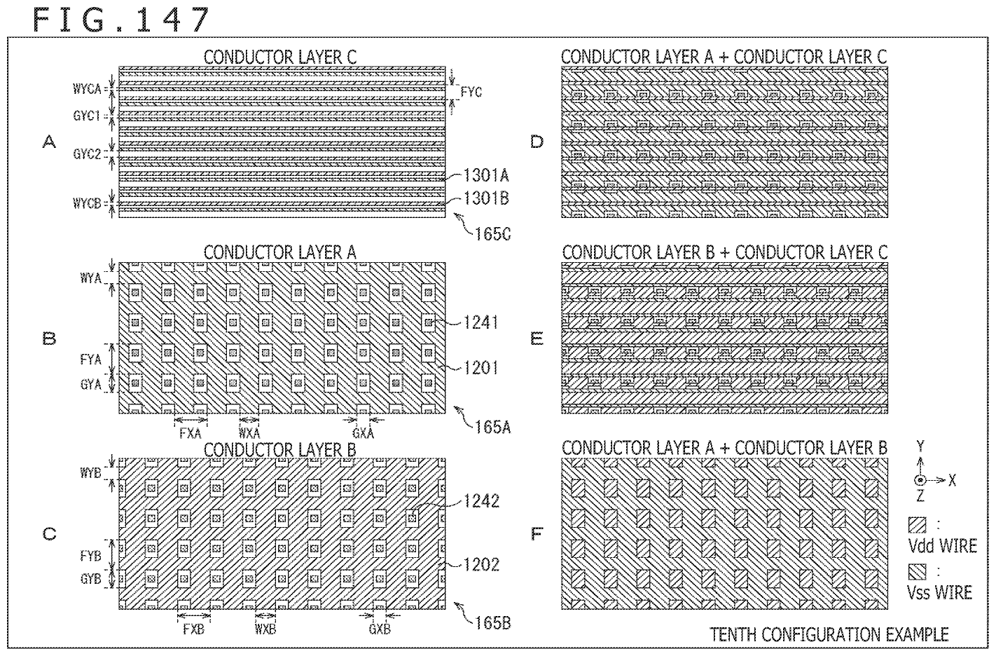

FIG. 147 depicts a modification example of the tenth configuration example of three conductor layers.

A in FIG. 147 depicts the conductor layer C (wiring layer 165C), B in FIG. 147 depicts the conductor layer A (wiring layer 165A), and C in FIG. 147 depicts the conductor layer B (wiring layer 165B).

In addition, D in FIG. 147 is a plan view of the stacked state of the conductor layer A and the conductor layer C, E in FIG. 147 is a plan view of the stacked state of the conductor layer B and the conductor layer C, and F in FIG. 147 is a plan view of the stacked state of the conductor layer A and the conductor layer B.

The modification example of the tenth configuration example has a configuration obtained by partially modifying the fourth configuration example in FIG. 128. Sections in FIG. 147 that have counterparts in FIG. 128 are given the same reference signs, explanations of those sections are omitted as appropriate, and explanations are given about differences.

The modification example of the tenth configuration example is different from the fourth configuration example in FIG. 128 only in terms of the configuration of the conductor layer C.

In the conductor layer C in A in FIG. 147, linear conductors 1301A that are long in the X direction, and linear conductors 1301B that are long in the X direction are arranged regularly alternately in the Y direction. The linear conductors 1301A are wires (Vss wires) connected to GND or a negative power supply, for example. The linear conductors 1301B are wires (Vdd wires) connected to a positive power supply, for example. The linear conductors 1301A and the linear conductors 1301B are arranged at intervals with alternating gap widths of a gap width GYC1 and a gap width GYC2.

In the fourth configuration example in FIG. 128, the conductor pitch FYC, which is the repetition pitch of the linear conductors 1221A in the conductor layer C in A in FIG. 128, is 200% of the conductor pitch FYA, which is the Y-direction repetition pitch of the mesh conductor 1201 in the conductor layer A in B in FIG. 128.

In contrast, the conductor pitch FYC, which is the repetition pitch of the linear conductors 1301A in the conductor layer C in A in FIG. 147, is (1/integer)-times the conductor pitch FYA, which is the Y-direction repetition pitch of the mesh conductor 1201 in the conductor layer A in B in FIG. 147. FIG. 147 depicts an example in which the conductor pitch FYC is ½ times the conductor pitch FYA.

Similarly, while, in the fourth configuration example in FIG. 128, the conductor pitch FYC of the linear conductors 1221B in the conductor layer C in A in FIG. 128 is 200% of the conductor pitch FYB of the mesh conductor 1202 in the conductor layer A in C in FIG. 128, the conductor pitch FYC of the linear conductors 1301B in the conductor layer C in A in FIG. 147 is (1/integer)-times the conductor pitch FYB of the mesh conductor 1202 in the conductor layer B in C in FIG. 147. FIG. 147 depicts an example in which the conductor pitch FYC is ½ times the conductor pitch FYB.

The modification example of the tenth configuration example in FIG. 147 is similar to the fourth configuration example in FIG. 128 in other respects than those mentioned above.

If a predetermined planar range (planar region) of the conductor layer C in A in FIG. 147 is looked at, the current distribution in the linear conductors 1301A and the current distribution in the linear conductors 1301B become the same or substantially the same, and so the occurrence of inductive noise can be suppressed.

Because the linear conductors 1301A and the linear conductors 1301B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 147, needless to say, due to the stacking of the conductor layers A and B, hot carrier light emissions from an active element group 167 can be blocked. In addition, as depicted in D and E in FIG. 132, the light-blocking property is maintained within a certain range also by the stacking of the conductor layers A and C, and the stacking of the conductor layers B and C. Thereby, the light-blocking constraints of the conductor layers A and B can be relaxed. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

In the modification example of the tenth configuration example in FIG. 147, the direction in which currents flow more easily in the conductor layer C and the direction in which currents flow more easily in the conductor layers A and B are substantially orthogonal and are different by approximately 90 degrees. Thereby, currents are diffused more easily (currents are less likely to be concentrated), and so inductive noise can be ameliorated further.

By providing the relay conductors 1241 in the conductor layer A, it becomes possible to connect with the linear conductors 1301B with substantially the shortest distance or with a short distance, and voltage drops, energy loss, or inductive noise can be reduced.

By providing the relay conductors 1242 in the conductor layer B, it becomes possible to connect with the linear conductors 1301A with substantially the shortest distance or with a short distance, and voltage drops, energy loss, or inductive noise can be reduced.

### Eleventh Configuration Example of Three Conductor Layers

The first to tenth configuration examples of three conductor layers mentioned above are explained by adopting the eleventh configuration example that uses mesh conductors with different X-direction and Y-direction resistance values as the configurations of the conductor layer A and the conductor layer B. In other words, the conductor layer A and the conductor layer B are explained by adopting configurations with the X-direction gap width GXA and the Y-direction gap width GYA which are different from each other, and the X-direction gap width GXB and the Y-direction gap width GYB which are different from each other, like the mesh conductors 1201 and 1202 in the fourth configuration example in FIG. 128, and the mesh conductors 1261 and 1602 in the fifth configuration example in FIG. 131.

However, the conductor layer A and the conductor layer B can adopt any of the first to thirteenth configuration examples of the conductor layers A and B explained with reference to FIG. 12 to FIG. 41.

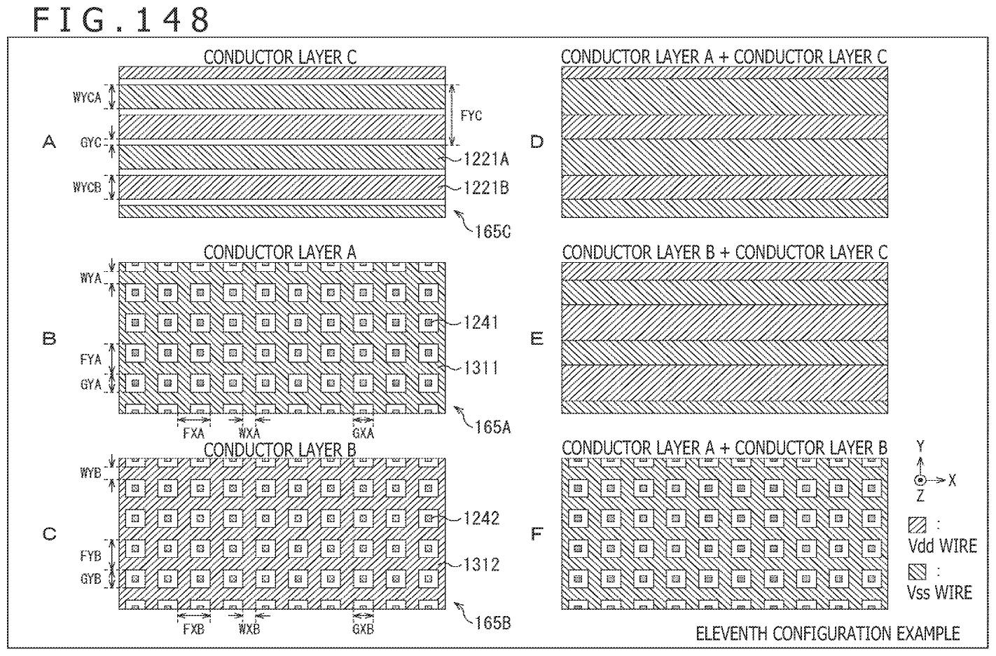

Next, configurations explained with reference to FIG. 148 to FIG. 152 adopt the configuration adopted in FIG. 122 and the like consistently for the conductor layer C (wiring layer 165C), and adopt mesh conductors with the same X-direction and Y-direction resistance values for the conductor layer A and the conductor layer B.

FIG. 148 depicts an eleventh configuration example of three conductor layers.

A in FIG. 148 depicts the conductor layer C (wiring layer 165C), B in FIG. 148 depicts the conductor layer A (wiring layer 165A), and C in FIG. 148 depicts the conductor layer B (wiring layer 165B).

In addition, D in FIG. 148 is a plan view of the stacked state of the conductor layer A and the conductor layer C, E in FIG. 148 is a plan view of the stacked state of the conductor layer B and the conductor layer C, and F in FIG. 148 is a plan view of the stacked state of the conductor layer A and the conductor layer B.

Sections in the eleventh configuration example in FIG. 148 that have counterparts in the fourth configuration example depicted in FIG. 128 are given the same reference signs, explanations of those sections are omitted as appropriate, and explanations are given with a focus on differences.

In the conductor layer C in A in FIG. 148, linear conductors 1221A that are long in the X direction, and linear conductors 1221B that are long in the X direction are arranged regularly alternately in the Y direction at the conductor pitch FYC.

The conductor layer A in B in FIG. 148 includes a mesh conductor 1311. The mesh conductor 1311 has the X-direction conductor width WXA, gap width GXA, and conductor pitch FXA and has the Y-direction conductor width WYA, gap width GYA, and conductor pitch FYA. Here, (conductor width WXA)=(conductor width WYA), (gap width GXA)=(gap width GYA), and (conductor pitch FXA)=(conductor pitch FYA) are satisfied. In addition, a relay conductor 1241 is arranged in each gap of the mesh conductor 1201. The intervals between the relay conductors 1241, in other words, the pitches of the relay conductors 1241, also are the conductor pitches FXA and FYA. The mesh conductor 1311 is a wire (Vss wire) connected to GND or a negative power supply, for example.

The conductor layer B in C in FIG. 128 includes a mesh conductor 1312. The mesh conductor 1312 has the X-direction conductor width WXB, gap width GXB, and conductor pitch FXB and has the Y-direction conductor width WYB, gap width GYB, and conductor pitch FYB. Here, (conductor width WXB)=(conductor width WYB), (gap width GXB)=(gap width GYB), and (conductor pitch FXB)=(conductor pitch FYB) are satisfied. In addition, a relay conductor 1242 is arranged in each gap of the mesh conductor 1312. The intervals between the relay conductors 1242, in other words, the pitches of the relay conductors 1242, also are the conductor pitches FXB and FYB. The mesh conductor 1312 is a wire (Vdd wire) connected to a positive power supply, for example.

As depicted in B and C in FIG. 148, the plane positions of the relay conductors 1241 formed in the conductor layer A and the plane positions of the relay conductors 1242 formed in the conductor layer B are the same. In other words, the mesh conductor 1311 in the conductor layer A and the mesh conductor 1312 in the conductor layer B entirely overlap each other as seen in the stacking direction. The thus-formed conductor layer A and conductor layer B correspond to the second configuration example of the conductor layers A and B depicted in FIG. 15 and can significantly ameliorate inductive noise as depicted in the result of a simulation in FIG. 17.

Accordingly, this is suitable for the stacking order in which, as depicted in B in FIG. 120, the conductor layer C (wiring layer 165C) is arranged between the conductor layer A (wiring layer 165A) and the conductor layer B (wiring layer 165B), the mesh conductor 1311 in the conductor layer A and the linear conductors 1221A in the conductor layer C are connected by conductor vias in the Z direction, and the mesh conductor 1312 in the conductor layer B and the linear conductors 1221B in the conductor layer C are connected by conductor vias in the Z direction.

If a predetermined planar range (planar region) of the conductor layer C is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B in the conductor layer C include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 148, while the stacking of the conductor layer A and the conductor layer B does not form a light-blocking structure, as depicted in D and E in FIG. 148, the stacking of the conductor layers A and C, and the stacking of the conductor layers B and C form light-blocking structures, and the light-blocking property is maintained. Thereby, hot carrier light emissions from an active element group 167 can be blocked. In addition, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. The degree of freedom of the layouts of the conductor layers A and B can be enhanced.

### Twelfth Configuration Example of Three Conductor Layers

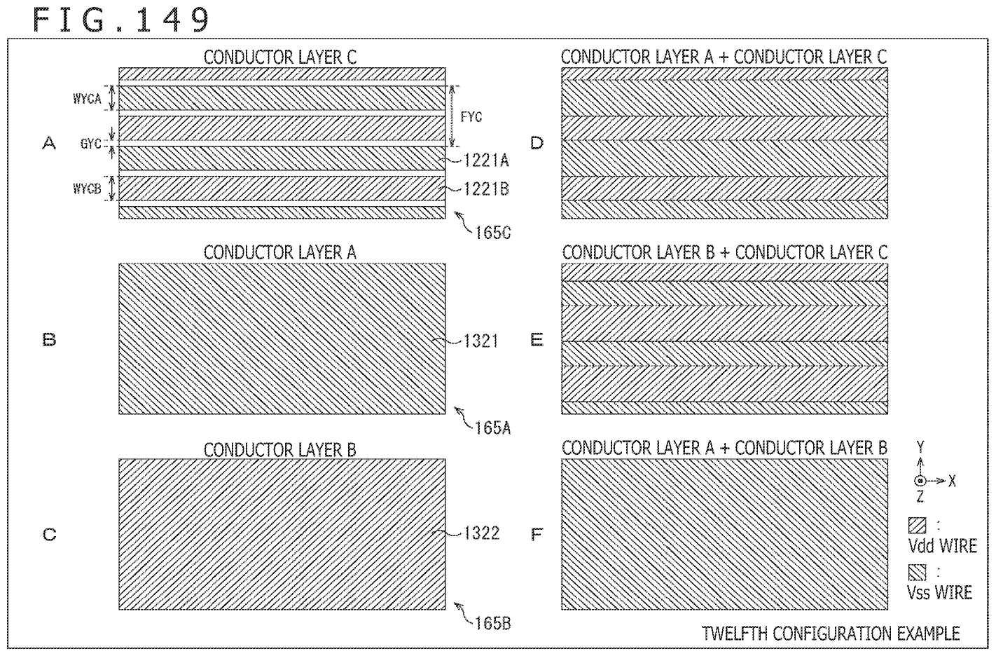

FIG. 149 depicts a twelfth configuration example of three conductor layers.

A in FIG. 149 depicts the conductor layer C (wiring layer 165C), B in FIG. 149 depicts the conductor layer A (wiring layer 165A), and C in FIG. 149 depicts the conductor layer B (wiring layer 165B).

In addition, D in FIG. 149 is a plan view of the stacked state of the conductor layer A and the conductor layer C, E in FIG. 149 is a plan view of the stacked state of the conductor layer B and the conductor layer C, and F in FIG. 149 is a plan view of the stacked state of the conductor layer A and the conductor layer B.

Sections in the twelfth configuration example in FIG. 149 that have counterparts in the fourth configuration example depicted in FIG. 128 are given the same reference signs, explanations of those sections are omitted as appropriate, and explanations are given with a focus on differences.

In the conductor layer C in A in FIG. 149, linear conductors 1221A that are long in the X direction, and linear conductors 1221B that are long in the X direction are arranged regularly alternately in the Y direction at the conductor pitch FYC.

The conductor layer A in B in FIG. 149 includes a planar conductor 1321. The planar conductor 1321 is a wire (Vss wire) connected to GND or a negative power supply, for example.

The conductor layer B in C in FIG. 149 includes a planar conductor 1322. The planar conductor 1322 is a wire (Vdd wire) connected to a positive power supply, for example.

If a predetermined planar range (planar region) of the conductor layer C is looked at, the current distribution in the linear conductors 1221A and the current distribution in the linear conductors 1221B become the same or substantially the same, and so the occurrence of inductive noise can be suppressed.

Because the linear conductors 1222A and the linear conductors 1222B include repetitions of the same wiring patterns in the Y direction, capacitive noise can be offset completely in the Y direction. Capacitive noise can be ameliorated more significantly if the conductor layer C is closer to the wiring layer 170.

As depicted in F in FIG. 149, the stacking of the conductor layers A and B forms a light-blocking structure, and hot carrier light emissions from an active element group 167 can be blocked. As depicted in D and E in FIG. 149, the stacking of the conductor layers A and C, and the stacking of the conductor layers B and C also form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

The twelfth configuration example of three conductor layers is suitable for the stacking order as depicted in B in FIG. 120 in which the conductor layer C (wiring layer 165C) is arranged between the conductor layer A (wiring layer 165A) and the conductor layer B (wiring layer 165B), the planar conductor 1321 in the conductor layer A and the linear conductors 1221A in the conductor layer C are connected by conductor vias in the Z direction, and the planar conductor 1322 in the conductor layer B and the linear conductors 1221B in the conductor layer C are connected by conductor vias in the Z direction.

### Modification Examples of Twelfth Configuration Example of Three Conductor Layers

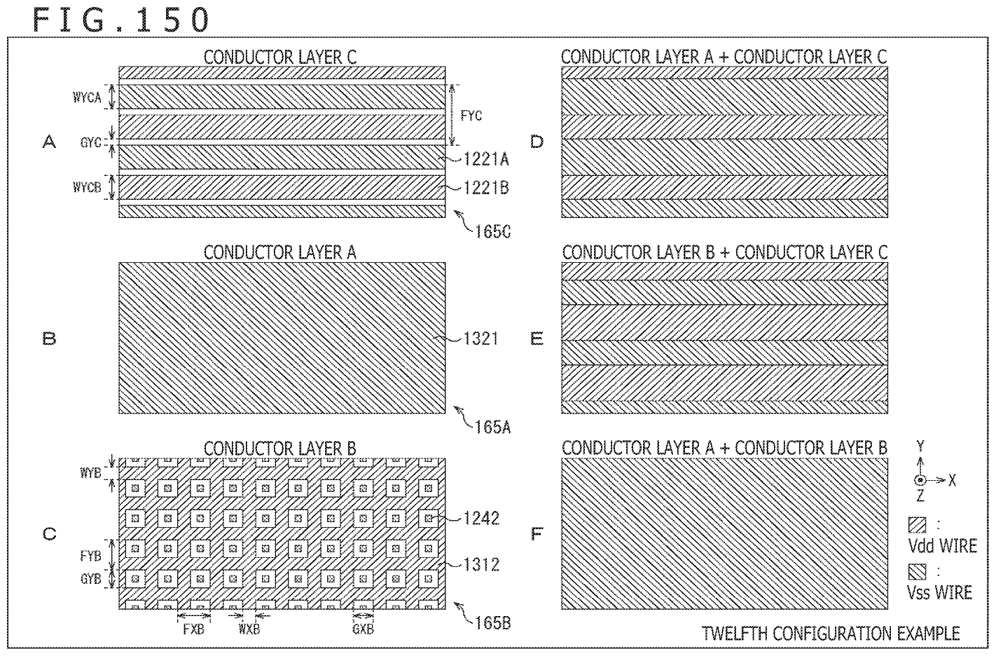

FIG. 150 depicts a first modification example of the twelfth configuration example of three conductor layers.

A in FIG. 150 depicts the conductor layer C (wiring layer 165C), B in FIG. 150 depicts the conductor layer A (wiring layer 165A), and C in FIG. 150 depicts the conductor layer B (wiring layer 165B).

In addition, D in FIG. 150 is a plan view of the stacked state of the conductor layer A and the conductor layer C, E in FIG. 150 is a plan view of the stacked state of the conductor layer B and the conductor layer C, and F in FIG. 150 is a plan view of the stacked state of the conductor layer A and the conductor layer B.

Sections in FIG. 150 that have counterparts in the eleventh and twelfth configuration examples depicted in FIG. 148 and FIG. 149 are given the same reference signs, explanations of those sections are omitted as appropriate, and explanations are given with a focus on differences.

In the first modification example of the twelfth configuration example, only the configuration of the conductor layer B in C in FIG. 150 is different from that in FIG. 149.

The conductor layer B in C in FIG. 150 includes the mesh conductor 1312, and relay conductors 1242 formed in gaps of the mesh conductors 1312.

In the configuration in the twelfth configuration example depicted in FIG. 149, the conductor layer A has the planar conductor 1321 instead of the mesh conductor 1311 and the relay conductors 1241 in the eleventh configuration example of three conductor layers depicted in FIG. 148, and the conductor layer B has the planar conductor 1322 instead of the mesh conductor 1312 and the relay conductors 1242 in the eleventh configuration example of three conductor layers depicted in FIG. 148.

In contrast, in the configuration in the first modification example of the twelfth configuration example depicted in FIG. 150, the conductor layer A has the planar conductor 1321 instead of the mesh conductor 1311 and the relay conductors 1241 in the eleventh configuration example of three conductor layers depicted in FIG. 148, and the conductor layer B includes the mesh conductor 1312 and the relay conductors 1242 which are the same as the ones in the eleventh configuration example of three conductor layers depicted in FIG. 148.

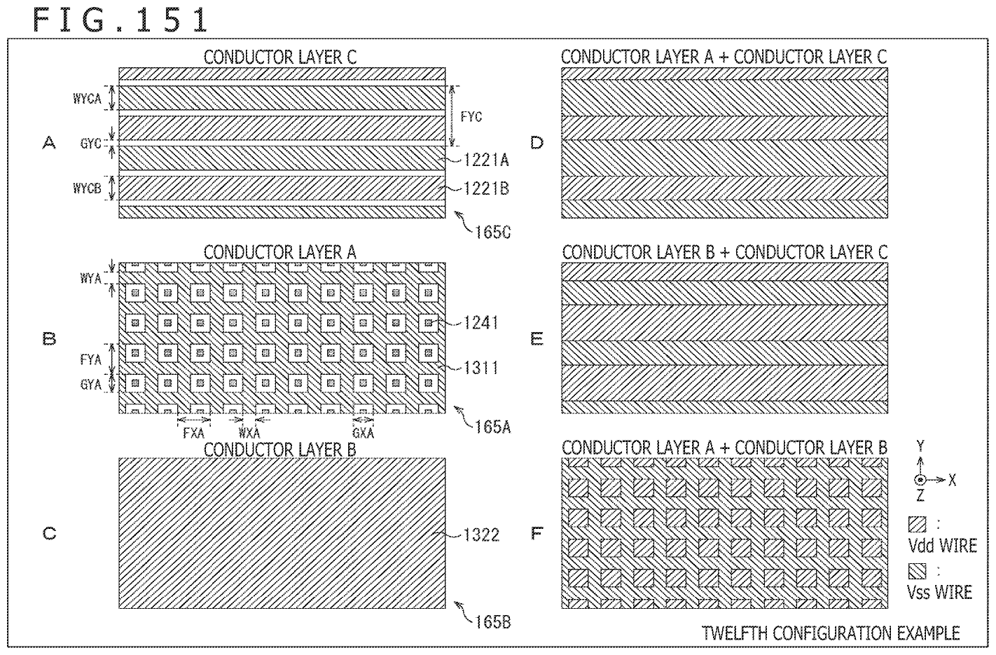

FIG. 151 depicts a second modification example of the twelfth configuration example of three conductor layers.

A in FIG. 151 depicts the conductor layer C (wiring layer 165C), B in FIG. 151 depicts the conductor layer A (wiring layer 165A), and C in FIG. 151 depicts the conductor layer B (wiring layer 165B).

In addition, D in FIG. 151 is a plan view of the stacked state of the conductor layer A and the conductor layer C, E in FIG. 151 is a plan view of the stacked state of the conductor layer B and the conductor layer C, and F in FIG. 151 is a plan view of the stacked state of the conductor layer A and the conductor layer B.

Sections in FIG. 151 that have counterparts in the eleventh and twelfth configuration examples depicted in FIG. 148 and FIG. 149 are given the same reference signs, explanations of those sections are omitted as appropriate, and explanations are given with a focus on differences.

In the second modification example of the twelfth configuration example, only the configuration of the conductor layer A in B in FIG. 151 is different from that in FIG. 149.

In the configuration in the twelfth configuration example depicted in FIG. 149, the conductor layer A has the planar conductor 1321 instead of the mesh conductor 1311 and the relay conductors 1241 in the eleventh configuration example of three conductor layers depicted in FIG. 148, and the conductor layer B has the planar conductor 1322 instead of the mesh conductor 1312 and the relay conductors 1242 in the eleventh configuration example of three conductor layers depicted in FIG. 148.

In contrast, in the configuration in the second modification example of the twelfth configuration example depicted in FIG. 151, the conductor layer A has the mesh conductor 1311 and the relay conductors 1241 which are the same as the ones in the eleventh configuration example of three conductor layers depicted in FIG. 148, and the conductor layer B has the planar conductor 1322 instead of the mesh conductor 1312 and the relay conductors 1242 in the eleventh configuration example of three conductor layers depicted in FIG. 148.

In the first modification example and the second modification example also, action and effects similar to those in the twelfth configuration example depicted in FIG. 149 are attained.

That is, if a predetermined planar range (planar region) of the conductor layer C is looked at, the current distribution in the linear conductors 1221A and the current distribution in the linear conductors 1221B become the same or substantially the same, and so the occurrence of inductive noise can be suppressed.

Because the linear conductors 1222A and the linear conductors 1222B include repetitions of the same wiring patterns in the Y direction, capacitive noise can be offset completely in the Y direction. Capacitive noise can be ameliorated more significantly if the conductor layer C is closer to the wiring layer 170.

The stacking of the conductor layers A and B forms a light-blocking structure, and needless to say, hot carrier light emissions from an active element group 167 can be blocked. In addition, the stacking of the conductor layers A and C, and the stacking of the conductor layers B and C also form light-blocking structures, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

The first modification example in FIG. 150 is particularly suitable for stacking orders that allow electrical connection between the three layers, the conductor layers A to C, specifically, the stacking orders depicted in A and B in FIG. 120. For example, in the case of the stacking order of the conductor layers A, B, and C depicted in A in FIG. 120, the planar conductor 1321 in the conductor layer A and the relay conductor 1242 in the conductor layer B can be connected, and the mesh conductor 1312 and relay conductors 1242 in the conductor layer B can be connected with the linear conductors 1221B and 1221A in the conductor layer C by conductor vias in the Z direction between conductors with common current characteristics, and in part of regions over which their planar regions overlap.

The second modification example in FIG. 151 is particularly suitable for stacking orders that allow electrical connection between the three layers, the conductor layers A to C, specifically, the stacking orders depicted in B and C in FIG. 120. For example, in the case of the stacking order of the conductor layers A, C and B depicted in B in FIG. 120, the mesh conductor 1311 and relay conductors 1241 in the conductor layer A can be connected with the linear conductors 1221A and 1221B in the conductor layer C by conductor vias in the Z direction between conductors with common current characteristics, and in part of regions over which their planar regions overlap, and the planar conductor 1322 in the conductor layer B and the linear conductors 1221B in the conductor layer C can be connected.

### Thirteenth Configuration Example of Three Conductor Layers

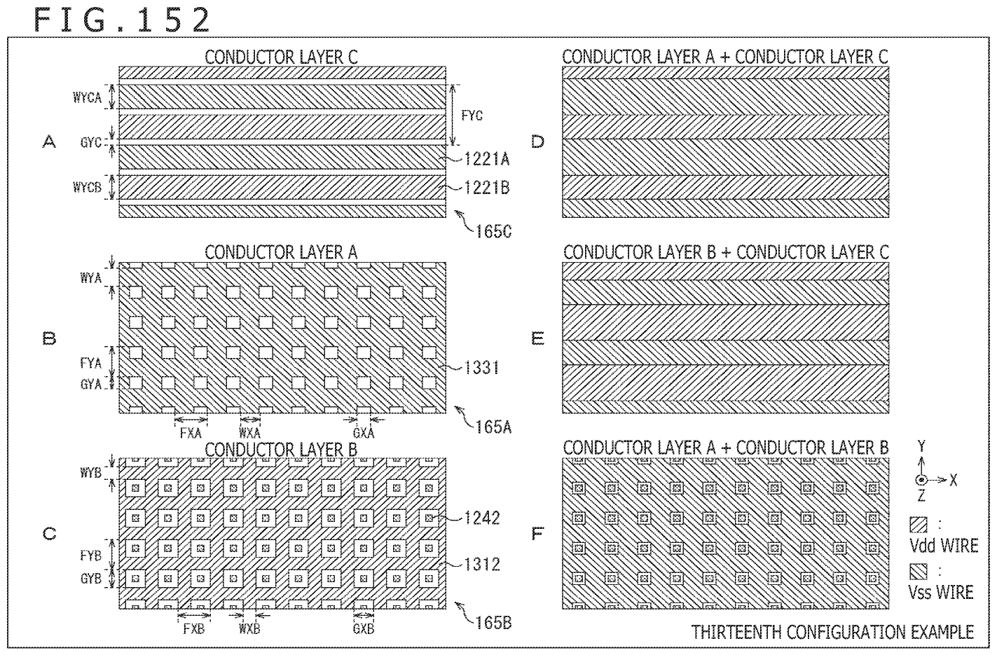

FIG. 152 depicts a thirteenth configuration example of three conductor layers.

A in FIG. 152 depicts the conductor layer C (wiring layer 165C), B in FIG. 152 depicts the conductor layer A (wiring layer 165A), and C in FIG. 152 depicts the conductor layer B (wiring layer 165B).

In addition, D in FIG. 152 is a plan view of the stacked state of the conductor layer A and the conductor layer C, E in FIG. 152 is a plan view of the stacked state of the conductor layer B and the conductor layer C, and F in FIG. 152 is a plan view of the stacked state of the conductor layer A and the conductor layer B.

Sections in the twelfth configuration example in FIG. 152 that have counterparts in the eleventh configuration example depicted in FIG. 148 are given the same reference signs, explanations of those sections are omitted as appropriate, and explanations are given with a focus on differences.

In the thirteenth configuration example, only the configuration of the conductor layer A in B in FIG. 152 is different from that in FIG. 148.

The conductor layer A in B in FIG. 152 includes a mesh conductor 1331. The mesh conductor 1331 is a wire (Vss wire) connected to GND or a negative power supply, for example. The mesh conductor 1331 has the X-direction conductor width WXA, gap width GXA, and conductor pitch FXA and has the Y-direction conductor width WYA, gap width GYA, and conductor pitch FYA. Here, (conductor width WXA)=(conductor width WYA), (gap width GXA)=(gap width GYA), and (conductor pitch FXA)=(conductor pitch FYA) are satisfied. It should be noted however that the gap width GXA and gap width GYA of gaps of the mesh conductor 1331 are smaller than the gap width GXB and gap width GYB of gaps of the mesh conductor 1312 in the conductor layer B ((gap width GXA)=(gap width GYA)<(gap width GXB)=(gap width GYB)). In addition, relay conductors are not formed in the gaps of the mesh conductor 1331.

The thirteenth configuration example in FIG. 152 is similar to the eleventh configuration example in FIG. 148 in other respects than those mentioned above.

If a predetermined planar range (planar region) of the conductor layer C in A in FIG. 152 is looked at, the current distribution in the linear conductors 1221A and the current distribution in the linear conductors 1221B become the same or substantially the same, and so the occurrence of inductive noise can be suppressed.

Because the linear conductors 1221A and the linear conductors 1221B include repetitions of the same wiring patterns in the Y direction, capacitive noise can be offset completely in the Y direction. Capacitive noise can be ameliorated more significantly if the conductor layer C is closer to the wiring layer 170.

As depicted in D and E in FIG. 152, each of the stacking of the conductor layers A and C, and the stacking of the conductor layers B and C forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

By providing the relay conductors 1242 in the conductor layer B, it becomes possible to connect with the linear conductors 1221A with substantially the shortest distance or with a short distance, and voltage drops, energy loss, or inductive noise can be reduced.

The thirteenth configuration example in FIG. 152 is particularly suitable for stacking orders that allow electrical connection between the three layers, the conductor layers A to C, specifically, the stacking order depicted in B in FIG. 120. For example, in the case of the stacking order of the conductor layers A, C, and B depicted in B in FIG. 120, the mesh conductor 1331 in the conductor layer A and the linear conductors 1221A in the conductor layer C can be connected by conductor vias in the Z direction, and the mesh conductor 1312 and relay conductors 1242 in the conductor layer B can be connected with the linear conductors 1221B and 1221A in the conductor layer C by conductor vias in the Z direction between conductors with common current characteristics, and in part of regions over which their planar regions overlap.

### Fourteenth Configuration Example of Three Conductor Layers

The first to thirteenth configuration examples of three conductor layers mentioned above are explained by adopting, as the configuration of the conductor layer C, a configuration that uses linear conductors that are long in the X direction or linear conductors that are long in the Y direction, which form so-called vertical stripe or horizontal stripe wiring patterns.

However, the patterns of the conductor layer C are not limited to vertical stripe or horizontal stripe wiring patterns.

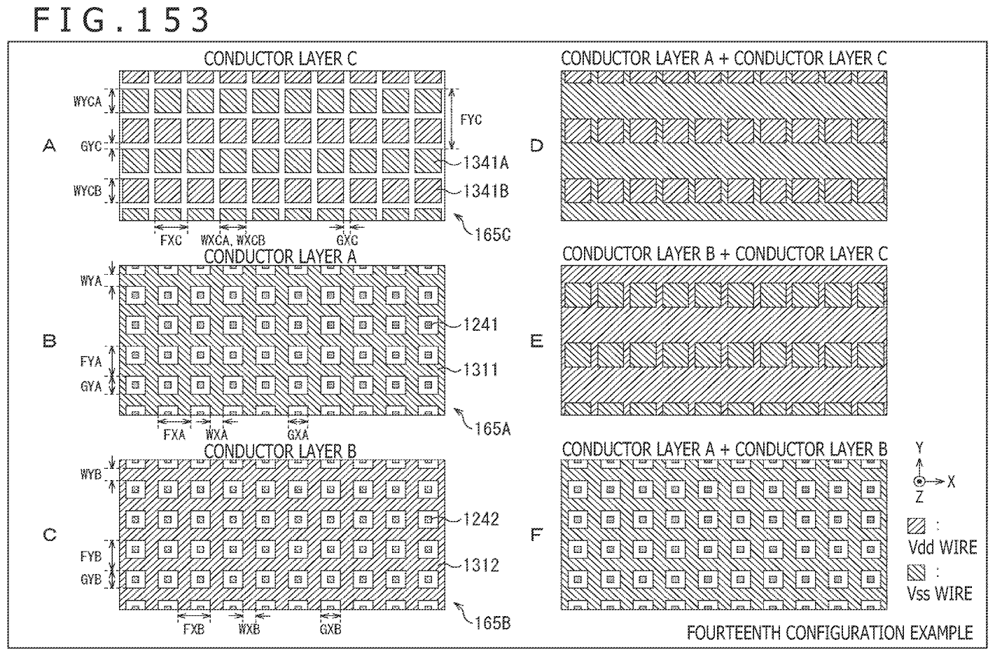

In the following cases explained with FIG. 153 to FIG. 163, the conductor layer C has configurations other than vertical stripe or horizontal stripe wiring patterns.

FIG. 153 depicts a fourteenth configuration example of three conductor layers.

A in FIG. 153 depicts the conductor layer C (wiring layer 165C), B in FIG. 153 depicts the conductor layer A (wiring layer 165A), and C in FIG. 153 depicts the conductor layer B (wiring layer 165B).

In addition, D in FIG. 153 is a plan view of the stacked state of the conductor layer A and the conductor layer C, E in FIG. 153 is a plan view of the stacked state of the conductor layer B and the conductor layer C, and F in FIG. 153 is a plan view of the stacked state of the conductor layer A and the conductor layer B.

Sections in the fourteenth configuration example in FIG. 153 that have counterparts in the eleventh configuration example depicted in FIG. 148 are given the same reference signs, explanations of those sections are omitted as appropriate, and explanations are given with a focus on differences.

In the fourteenth configuration example, only the configuration of the conductor layer C in A in FIG. 153 is different from that in FIG. 148.

The conductor layer C in A in FIG. 153 includes multiple rectangular conductors 1341A and 1341B that are arranged repetitively on the same plane at predetermined repetition pitches. The rectangular conductors 1341A are wires (Vss wires) connected to GND or a negative power supply, for example. The rectangular conductors 1341B are wires (Vdd wires) connected to a positive power supply, for example.

Specifically, rows where rectangular conductors 1341A are arranged repetitively at the gap width GXC in the X direction, and rows where rectangular conductors 1341B are arranged repetitively at the gap width GXC in the X direction are arranged alternately regularly in the Y direction. The rectangular conductors 1341A and 1341B are arranged repetitively at the conductor pitch FXC in the X direction and are arranged repetitively at the conductor pitch FYC in the Y direction. There is a gap with the gap width GYC between a rectangular conductor 1341A and a rectangular conductor 1341B in the Y direction. The rectangular conductors 1341A have the X-direction conductor width WXCA and the Y-direction conductor width WYCA, and the rectangular conductors 1341B have the X-direction conductor width WXCB, and the Y-direction conductor width WYCB. Here, the conductor widths WXCA, WYCA, WXCB and WYCB are the same ((conductor width WXCA)=(conductor width WYCA)=(conductor width WXCB)=(conductor width WYCB)).

The fourteenth configuration example in FIG. 153 is similar to the eleventh configuration example in FIG. 148 in other respects than those mentioned above.

If a predetermined planar range (planar region) of the conductor layer C in A in FIG. 153 is looked at, the current distribution in the rectangular conductors 1341A and the current distribution in the rectangular conductors 1341B become the same or substantially the same, and so the occurrence of inductive noise can be suppressed.

Because the rectangular conductors 1341A and the rectangular conductors 1341B include repetitions of the same wiring patterns in the Y direction, capacitive noise can be offset completely in the Y direction. Capacitive noise can be ameliorated more significantly if the conductor layer C is closer to the wiring layer 170.

As depicted in D and E in FIG. 153, each of the stacking of the conductor layers A and C, and the stacking of the conductor layers B and C forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

By providing the relay conductors 1241 in the conductor layer A, it becomes possible to connect with the rectangular conductors 1341B with substantially the shortest distance or with a short distance, and voltage drops, energy loss, or inductive noise can be reduced.

By providing the relay conductors 1242 in the conductor layer B, it becomes possible to connect with the rectangular conductors 1341A with substantially the shortest distance or with a short distance, and voltage drops, energy loss, or inductive noise can be reduced.

### Modification Examples of Fourteenth Configuration Example of Three Conductor Layers

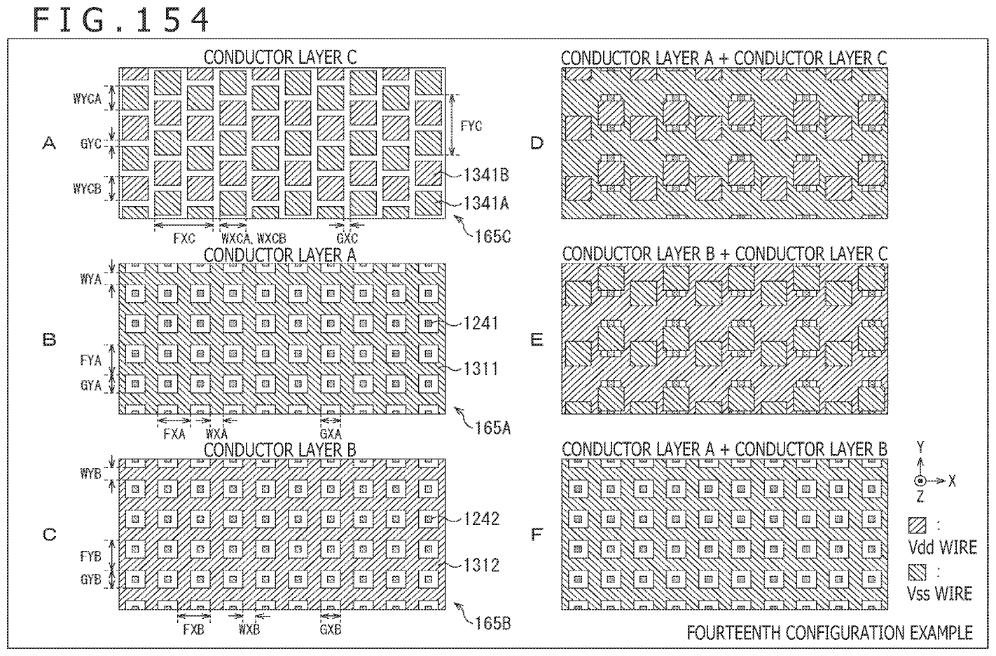

FIG. 154 depicts a first modification example of the fourteenth configuration example of three conductor layers.

A in FIG. 154 depicts the conductor layer C (wiring layer 165C), B in FIG. 154 depicts the conductor layer A (wiring layer 165A), and C in FIG. 154 depicts the conductor layer B (wiring layer 165B).

In addition, D in FIG. 154 is a plan view of the stacked state of the conductor layer A and the conductor layer C, E in FIG. 154 is a plan view of the stacked state of the conductor layer B and the conductor layer C, and F in FIG. 154 is a plan view of the stacked state of the conductor layer A and the conductor layer B.

Sections in FIG. 154 that have counterparts in the fourteenth configuration example depicted in FIG. 153 are given the same reference signs, explanations of those sections are omitted as appropriate, and explanations are given with a focus on differences.

The first modification example of the fourteenth configuration example is different from the configuration example in FIG. 153 only in terms of the configuration of the conductor layer C in A in FIG. 154, and is similar to the configuration example in FIG. 153 in terms of the configurations of the conductor layers A and B.

The conductor layer C in A in FIG. 154 has a commonality with the conductor layer C in FIG. 153 in that they both include multiple rectangular conductors 1341A and 1341B that are arranged repetitively on the same plane at predetermined repetition pitches, but is different in that adjacent columns are arranged being displaced relative to each other by ¼ of the Y-direction conductor pitch FYC. The conductor pitch FXC, which is the X-direction repetition pitch, includes a pair of columns.

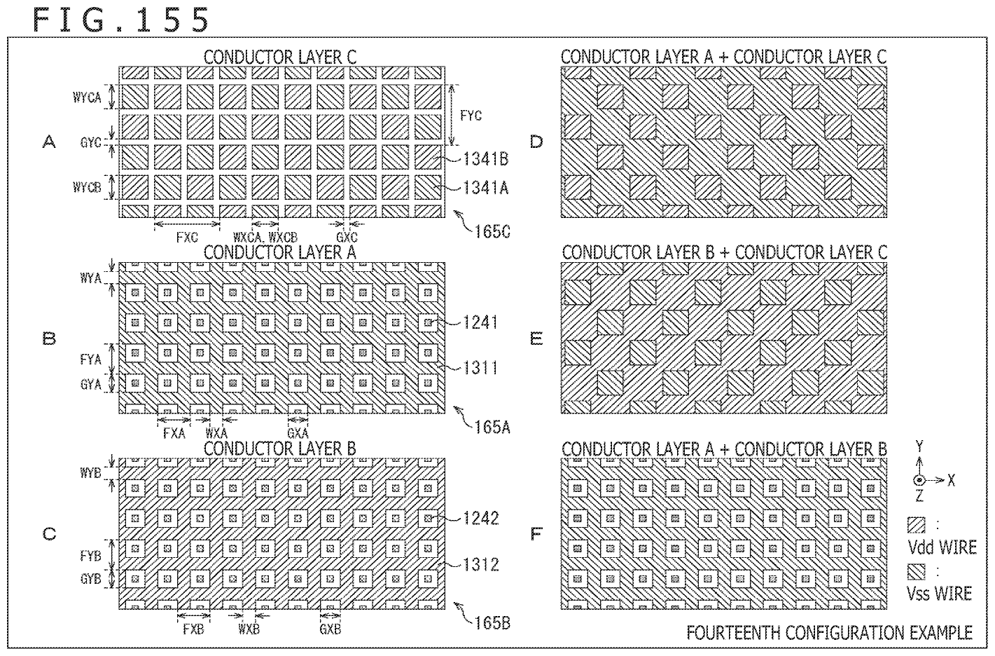

FIG. 155 depicts a second modification example of the fourteenth configuration example of three conductor layers.

A in FIG. 155 depicts the conductor layer C (wiring layer 165C), B in FIG. 155 depicts the conductor layer A (wiring layer 165A), and C in FIG. 155 depicts the conductor layer B (wiring layer 165B).

In addition, D in FIG. 155 is a plan view of the stacked state of the conductor layer A and the conductor layer C, E in FIG. 155 is a plan view of the stacked state of the conductor layer B and the conductor layer C, and F in FIG. 155 is a plan view of the stacked state of the conductor layer A and the conductor layer B.

Sections in FIG. 155 that have counterparts in the fourteenth configuration example depicted in FIG. 153 are given the same reference signs, explanations of those sections are omitted as appropriate, and explanations are given with a focus on differences.

The second modification example of the fourteenth configuration example is different from the configuration example in FIG. 149 only in terms of the configuration of the conductor layer C in A in FIG. 155, and is similar to the configuration example in FIG. 149 in terms of the configurations of the conductor layers A and B.

The conductor layer C in A in FIG. 155 has a commonality with the conductor layer C in FIG. 149 in that they both include multiple rectangular conductors 1341A and 1341B that are arranged repetitively on the same plane at predetermined repetition pitches, but is different in that adjacent columns are arranged being displaced relative to each other by ½ of the Y-direction conductor pitch FYC. The conductor pitch FXC, which is the X-direction repetition pitch, includes a pair of columns. Note that the amount of Y-direction displacement between adjacent columns of the rectangular conductors 1341A and 1341B can be designed to have any values.

In the first modification example and second modification example of the fourteenth configuration example in FIG. 154 and FIG. 155, if a predetermined planar range (planar region) of the conductor layer C is looked at, the current distribution in the rectangular conductors 1341A and the current distribution in the rectangular conductors 1341B become the same or substantially the same, and so the occurrence of inductive noise can be suppressed.

In addition, in the first modification example and second modification example of the fourteenth configuration example, because the rectangular conductors 1341A and the rectangular conductors 1341B include repetitions of the same wiring patterns in the Y direction, capacitive noise can be offset completely in the Y direction. Capacitive noise can be ameliorated more significantly if the conductor layer C is closer to the wiring layer 170.

In the second modification example of the fourteenth configuration example in FIG. 155, furthermore, because the rectangular conductors 1341A and the rectangular conductors 1341B include repetitions of the same wiring patterns in the X direction, capacitive noise can be offset completely in the X direction. Capacitive noise can be ameliorated more significantly if the conductor layer C is closer to the wiring layer 170.

In the first modification example of the fourteenth configuration example in FIG. 154, due to the stacking of the conductor layers A and B, the stacking of the conductor layers A and C, and the stacking of the conductor layers B and C, the light-blocking property is maintained in a certain range. Thereby, the light-blocking constraints of the conductor layers A and B can be relaxed slightly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

In the second modification example of the fourteenth configuration example in FIG. 155, each of the stacking of the conductor layers A and C, and the stacking of the conductor layers B and C forms a light-blocking structure, and the light-blocking property is maintained. Thereby, the light-blocking constraints of the conductor layers A and B can be relaxed significantly. Accordingly, it is possible to make full use of the conductor area sizes of the conductor layers A and B, and it is possible to lower the wire resistances to further ameliorate voltage drops. In addition, the degree of freedom of the layouts of the conductor layers A and B can be enhanced.

By providing the relay conductors 1241 in the conductor layer A, it becomes possible to connect with the rectangular conductors 1341B with substantially the shortest distance or with a short distance, and voltage drops, energy loss, or inductive noise can be reduced.

By providing the relay conductors 1242 in the conductor layer B, it becomes possible to connect with the rectangular conductors 1341A with substantially the shortest distance or with a short distance, and voltage drops, energy loss, or inductive noise can be reduced.

### Other Modification Examples of Fourteenth Configuration Example of Three Conductor Layers

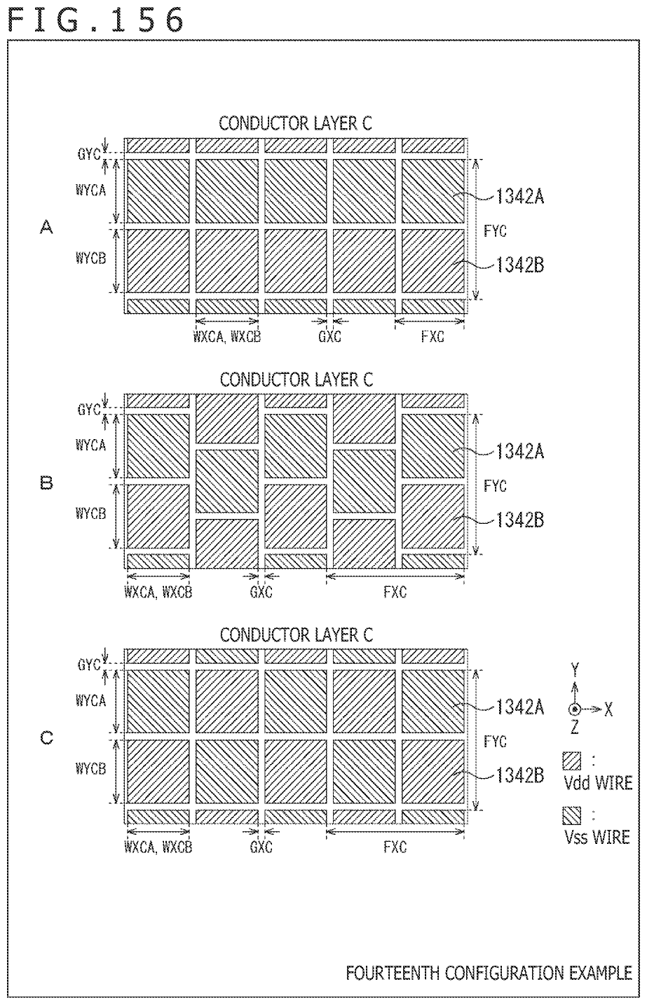

Hereinbelow, other modification examples of the fourteenth configuration example of three conductor layers depicted in FIG. 153 are explained with reference to FIG. 156 to FIG. 163.

Note that, similarly to the first and second modification examples in FIG. 154 and FIG. 155, modification examples of the fourteenth configuration example have modified configurations of only the conductor layer C, and so only the configurations of the conductor layer C are depicted in FIG. 156 to FIG. 163. In addition, the configurations of the conductor layer C are explained with reference to FIG. 156 to FIG. 163 in comparison with the conductor layer C in the fourteenth configuration example depicted in A in FIG. 153.

A in FIG. 156 depicts the conductor layer C in a third modification example of the fourteenth configuration example of three conductor layers.

The conductor layer C in A in FIG. 156 includes multiple rectangular conductors 1342A and 1342B that are arranged repetitively on the same plane at predetermined repetition pitches. The rectangular conductors 1342A are wires (Vss wires) connected to GND or a negative power supply, for example. The rectangular conductors 1342B are wires (Vdd wires) connected to a positive power supply, for example.

A difference of the conductor layer C in A in FIG. 156 from the conductor layer C in A in FIG. 153 lies in the conductor sizes of the rectangular conductors 1342A and 1342B, that is, the conductor widths WXCA, WYCA, WXCB and WYCB. Note that the conductor widths WXCA, WYCA, WXCB and WYCB are the same ((conductor width WXCA)=(conductor width WYCA)=(conductor width WXCB)=(conductor width WYCB)).

The conductor layer C in A in FIG. 156 can completely offset capacitive noise in the Y direction. Capacitive noise can be ameliorated more significantly if the conductor layer C is closer to the wiring layer 170.

In addition, by making the conductor sizes of the rectangular conductors 1342A and 1342B larger than those in the fourteenth configuration example depicted in A in FIG. 153, the wire resistances can be lowered further.

B in FIG. 156 depicts the conductor layer C in a fourth modification example of the fourteenth configuration example of three conductor layers.

The conductor layer C in B in FIG. 156 has a commonality with the conductor layer C in A in FIG. 156 in that they both include multiple rectangular conductors 1342A and 1342B that are arranged repetitively on the same plane at predetermined repetition pitches, but is different in that adjacent columns are arranged being displaced relative to each other by ¼ of the Y-direction conductor pitch FYC. The conductor pitch FXC, which is the X-direction repetition pitch, includes a pair of columns.

The conductor layer C in B in FIG. 156 can completely offset capacitive noise in the Y direction. Capacitive noise can be ameliorated more significantly if the conductor layer C is closer to the wiring layer 170.

C in FIG. 156 depicts the conductor layer C in a fifth modification example of the fourteenth configuration example of three conductor layers.

The conductor layer C in C in FIG. 156 has a commonality with the conductor layer C in A in FIG. 156 in that they both include multiple rectangular conductors 1342A and 1342B that are arranged repetitively on the same plane at predetermined repetition pitches, but is different in that adjacent columns are arranged being displaced relative to each other by ½ of the Y-direction conductor pitch FYC. It can also be said that adjacent rows are arranged being displaced relative to each other by ½ of the X-direction conductor pitch FXC. The X-direction conductor pitch FXC includes a pair of columns, and the Y-direction conductor pitch FYC includes a pair of rows. Note that the amount of Y-direction displacement between adjacent columns of the rectangular conductors 1342A and 1342B can be designed to have any values.

The conductor layer C in C in FIG. 156 can completely offset capacitive noise in the Y direction. Capacitive noise can be ameliorated more significantly if the conductor layer C is closer to the wiring layer 170.

Furthermore, the conductor layer C in C in FIG. 156 can completely offset capacitive noise in the X direction. Capacitive noise can be ameliorated more significantly if the conductor layer C is closer to the wiring layer 170.

A in FIG. 157 depicts the conductor layer C in a sixth modification example of the fourteenth configuration example of three conductor layers.

The conductor layer C in A in FIG. 157 includes multiple rectangular conductors 1343A and 1343B that are arranged repetitively on the same plane at predetermined repetition pitches. The rectangular conductors 1343A are wires (Vss wires) connected to GND or a negative power supply, for example. The rectangular conductors 1343B are wires (Vdd wires) connected to a positive power supply, for example.

A difference of the conductor layer C in A in FIG. 157 from the conductor layer C in A in FIG. 153 lies in the conductor sizes of the rectangular conductors 1343A and 1343B, specifically, the conductor widths WXCA and WXCB. Note that the rectangular conductors 1343A and 1343B are oblong rectangles, (conductor width WXCA)>(conductor width WYCA), and (conductor width WXCB)>(conductor width WYCB). In addition, the conductor width WXCA and the conductor width WXCB are equal to each other, and the conductor width WYCA and the conductor width WYCB are equal to each other ((conductor width WXCA)=(conductor width WXCB), and (conductor width WYCA)=(conductor width WYCB)).

The conductor layer C in A in FIG. 157 can completely offset capacitive noise in the Y direction. Capacitive noise can be ameliorated more significantly if the conductor layer C is closer to the wiring layer 170.

B in FIG. 157 depicts the conductor layer C in a seventh modification example of the fourteenth configuration example of three conductor layers.

The conductor layer C in B in FIG. 157 has a commonality with the conductor layer C in A in FIG. 157 in that they both include multiple rectangular conductors 1343A and 1343B that are arranged repetitively on the same plane at predetermined repetition pitches, but is different in that adjacent rows are arranged being displaced relative to each other by ½ of the X-direction conductor pitch FXC. The conductor pitch FYC, which is the Y-direction repetition pitch, includes two rows. Note that the amount of X-direction displacement between adjacent rows of the rectangular conductors 1343A and 1343B can be designed to have any values.

Because the rectangular conductors 1343A and the rectangular conductors 1343B in the conductor layer C in B in FIG. 157 do not include repetitions of the same wiring patterns in the Y direction, there are X positions where capacitive noise cannot be offset completely in the Y direction.

In view of this, in the case of the displacement by ½ of the X-direction conductor pitch FXC, the conductor layer C can be configured like the conductor layer C in C in FIG. 157.

C in FIG. 157 depicts the conductor layer C in an eighth modification example of the fourteenth configuration example of three conductor layers.

The conductor layer C in C in FIG. 157 includes pairs of rows of rectangular conductors 1343A and 1343B, each pair of which includes a row of rectangular conductors 1343A and a row of rectangular conductors 1343B that are adjacent to each other in the Y direction, and the pairs of rows of rectangular conductors 1343A and 1343B are arranged being displaced relative to each other by ½ of the X-direction conductor pitch FXC and are arranged repetitively on the same plane at predetermined repetition pitches.

The conductor layer C in C in FIG. 157 can completely offset capacitive noise in the Y direction. Capacitive noise can be ameliorated more significantly if the conductor layer C is closer to the wiring layer 170.

Note that the amount of X-direction displacement between pairs of rows of rectangular conductors 1343A and 1343B, each pair of which includes an adjacent row of rectangular conductors 1343A and row of rectangular conductors 1343B, can be designed to have any values. In addition, the X-direction displacement between pairs of rows of rectangular conductors 1343A and 1343B, each pair of which includes a row of rectangular conductors 1343A and a row of rectangular conductors 1343B, may be not displacement between pairs of adjacent rows of rectangular conductors, but displacement between pairs of non-adjacent rows of rectangular conductors. In addition, the X-direction displacement between pairs of rows of rectangular conductors 1343A and 1343B, each pair of which includes a row of rectangular conductors 1343A and a row of rectangular conductors 1343B, can completely offset capacitive noise in the Y direction as long as the sum total of the Y-direction conductor widths of rectangular conductors 1343A and the sum total of the Y-direction conductor widths of rectangular conductors 1343B are the same in a case in which a predetermined planar range (planar region) is looked at. Accordingly, the sets of rows of rectangular conductors 1343A and 1343B need not be pairs of rows. In other words, sets of rows of rectangular conductors 1343A and 1343B, each set of which includes two or more rows of rectangular conductors 1343A and 1343B that are adjacent to or not adjacent to each other, may be displaced in the X direction by a displacement amount designed to have a value, and it is suitable if the sum total of the Y-direction conductor widths of rectangular conductors 1343A and the sum total of the Y-direction conductor widths of rectangular conductors 1343B are the same or substantially the same in a case in which a predetermined planar range (planar region) is looked at, but this is not essential.

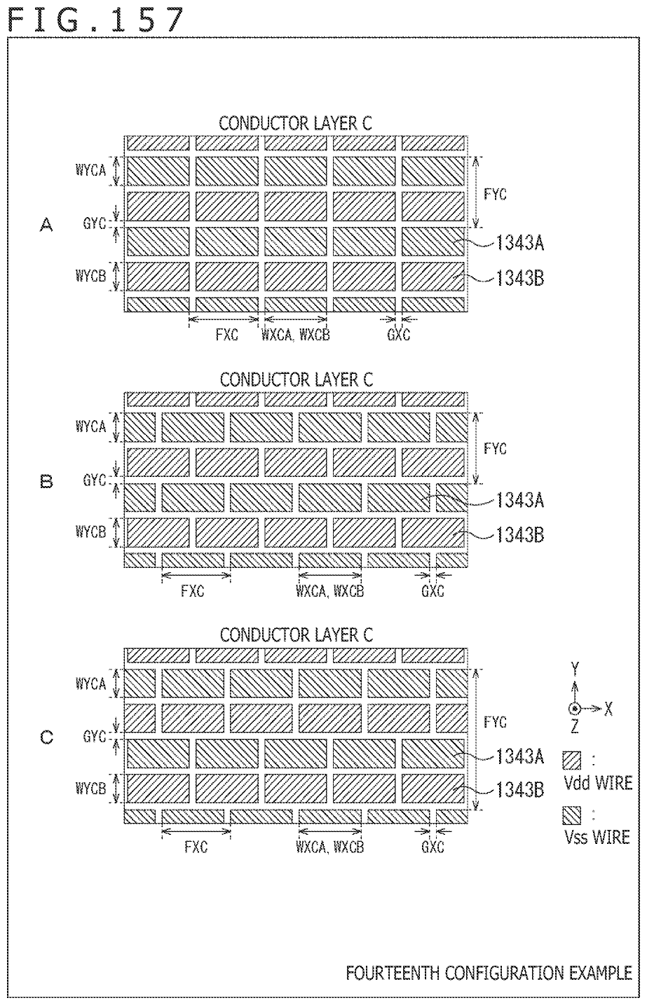

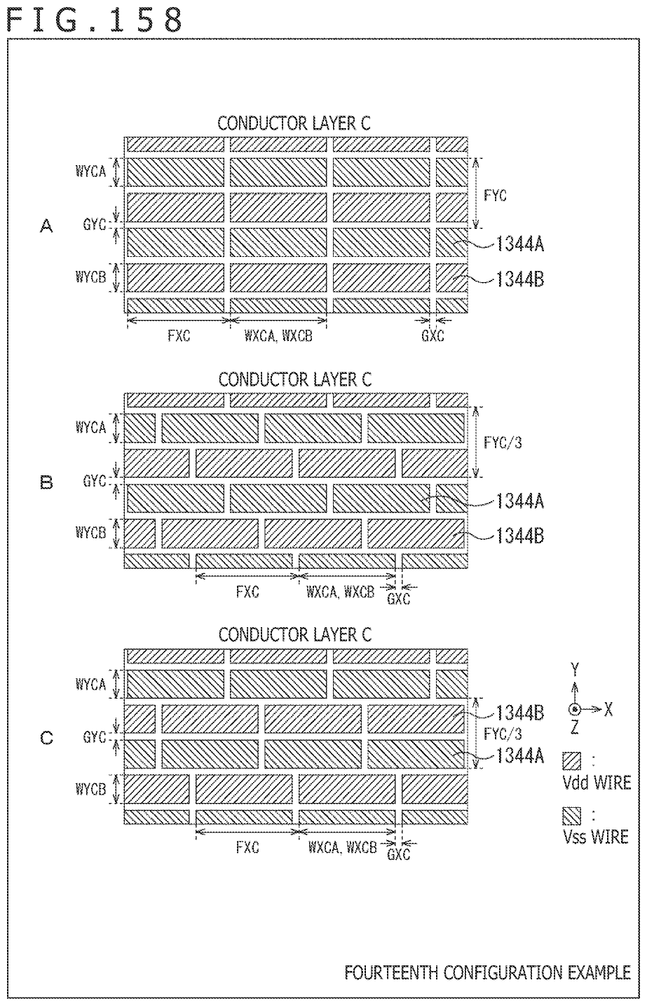

A in FIG. 158 depicts the conductor layer C in a ninth modification example of the fourteenth configuration example of three conductor layers.

The conductor layer C in A in FIG. 158 includes multiple rectangular conductors 1344A and 1344B that are arranged repetitively on the same plane at predetermined repetition pitches. The rectangular conductors 1344A are wires (Vss wires) connected to GND or a negative power supply, for example. The rectangular conductors 1344B are wires (Vdd wires) connected to a positive power supply, for example.

A difference of the conductor layer C in A in FIG. 158 from the conductor layer C in A in FIG. 157 lies in the conductor sizes of the rectangular conductors 1344A and 1344B, specifically, the conductor widths WXCA and WXCB. The conductor widths WXCA and WXCB of the rectangular conductors 1344A and 1344B in A in FIG. 158 are larger than the conductor widths WXCA and WXCB of the rectangular conductors 1343A and 1343B in A in FIG. 157.

Note that the rectangular conductors 1344A and 1344B are oblong rectangles, (conductor width WXCA)>(conductor width WYCA), and (conductor width WXCB)>(conductor width WYCB). In addition, the conductor width WXCA and the conductor width WXCB are equal to each other, and the conductor width WYCA and the conductor width WYCB are equal to each other ((conductor width WXCA)=(conductor width WXCB), and (conductor width WYCA)=(conductor width WYCB)).

The conductor layer C in A in FIG. 158 can completely offset capacitive noise in the Y direction. Capacitive noise can be ameliorated more significantly if the conductor layer C is closer to the wiring layer 170.

B in FIG. 158 depicts the conductor layer C in a tenth modification example of the fourteenth configuration example of three conductor layers.

The conductor layer C in B in FIG. 158 has a commonality with the conductor layer C in A in FIG. 158 in that they both include multiple rectangular conductors 1344A and 1344B that are arranged repetitively on the same plane at predetermined repetition pitches, but is different in that adjacent rows are arranged being displaced relative to each other by ⅓ of the X-direction conductor pitch FXC. The conductor pitch FYC, which is the Y-direction repetition pitch, includes a set of six rows.

The conductor layer C in B in FIG. 158 can completely offset capacitive noise in the Y direction. Capacitive noise can be ameliorated more significantly if the conductor layer C is closer to the wiring layer 170.

C in FIG. 158 depicts the conductor layer C in an eleventh modification example of the fourteenth configuration example of three conductor layers.

The conductor layer C in C in FIG. 158 includes pairs of rows of rectangular conductors 1344A and 1344B, each pair of which includes a row of rectangular conductors 1344A and a row of rectangular conductors 1344B that are adjacent to each other in the Y direction, and the pairs of rows of rectangular conductors 1344A and 1344B are arranged being displaced relative to each other by ⅓ of the X-direction conductor pitch FXC and are arranged repetitively on the same plane at predetermined repetition pitches.

The conductor layer C in C in FIG. 158 can completely offset capacitive noise in the Y direction. Capacitive noise can be ameliorated more significantly if the conductor layer C is closer to the wiring layer 170.

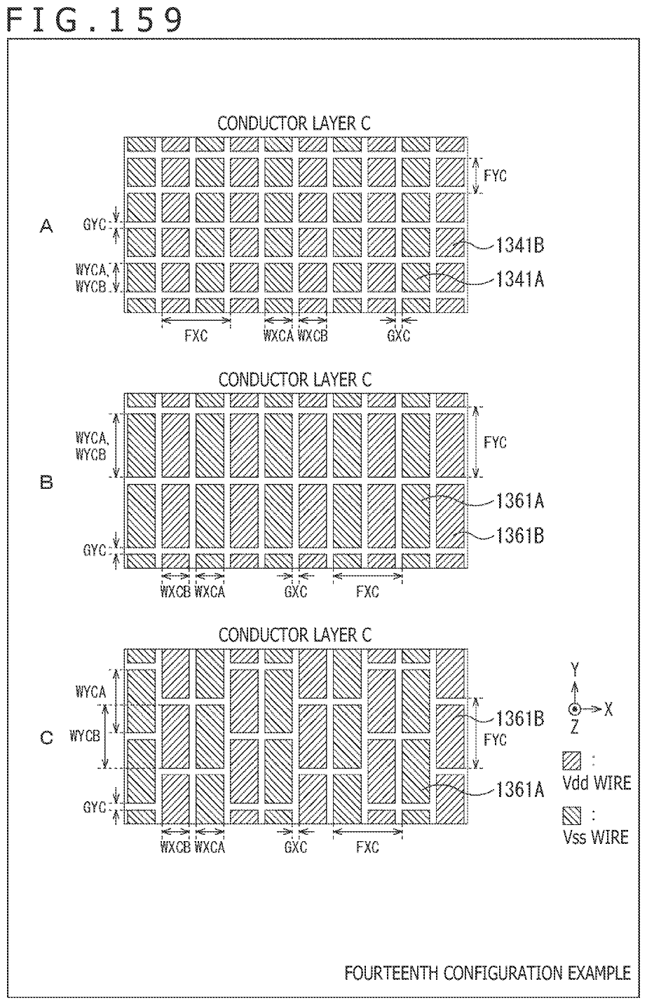

A in FIG. 159 depicts the conductor layer C in a twelfth modification example of the fourteenth configuration example of three conductor layers.

The conductor layer C in A in FIG. 159 includes multiple rectangular conductors 1341A and 1341B that are arranged repetitively on the same plane at predetermined repetition pitches.

A difference of the conductor layer C in A in FIG. 159 from the conductor layer C in A in FIG. 153 lies in the array directions of the rectangular conductors 1341A and 1341B. Specifically, the conductor layer C in A in FIG. 153 includes rectangular conductors 1341A and 1341B each of which is arranged repetitively in the X direction at the conductor pitch FXC, and the rectangular conductors 1341A and 1341B are arranged alternately regularly in the Y direction. In contrast, the conductor layer C in A in FIG. 159 includes rectangular conductors 1341A and 1341B each of which is arranged repetitively in the Y direction at the conductor pitch FYC, and the rectangular conductors 1341A and 1341B are arranged alternately regularly in the X direction.

The conductor layer C in A in FIG. 159 can completely offset capacitive noise in the X direction. Capacitive noise can be ameliorated more significantly if the conductor layer C is closer to the wiring layer 170.

B in FIG. 159 depicts the conductor layer C in a thirteenth modification example of the fourteenth configuration example of three conductor layers.

The conductor layer C in B in FIG. 159 includes multiple rectangular conductors 1361A and 1361B that are arranged repetitively on the same plane at predetermined repetition pitches. The rectangular conductors 1361A are wires (Vss wires) connected to GND or a negative power supply, for example. The rectangular conductors 1361B are wires (Vdd wires) connected to a positive power supply, for example.

A difference of the conductor layer C in B in FIG. 159 from the conductor layer C in A in FIG. 159 lies in the conductor sizes of the rectangular conductors 1361A and 1361B, specifically, the conductor widths WYCA and WYCB. Note that the rectangular conductors 1361A and 1361B are oblong rectangles, (conductor width WXCA)<(conductor width WYCA), and (conductor width WXCB)<(conductor width WYCB). In addition, the conductor width WXCA and the conductor width WXCB are equal to each other, and the conductor width WYCA and the conductor width WYCB are equal to each other ((conductor width WXCA)=(conductor width WXCB), and (conductor width WYCA)=(conductor width WYCB)).

The conductor layer C in B in FIG. 159 can completely offset capacitive noise in the X direction. Capacitive noise can be ameliorated more significantly if the conductor layer C is closer to the wiring layer 170.

Note that, although an illustration is omitted, adjacent columns of rectangular conductors 1361A and 1361B are displaced relative to each other by ½ of the Y-direction conductor pitch FYC and are arranged repetitively on the same plane at predetermined repetition pitches in one possible configuration, and adjacent columns of rectangular conductors 1361A and 1361B are displaced relative to each other by ⅓ of the Y-direction conductor pitch FYC in another possible configuration. In addition, the amount of Y-direction displacement between adjacent columns of the rectangular conductors 1361A and 1361B can be designed to have any values. In addition, sets of columns of rectangular conductors 1361A and 1361B, each set of which includes two or more columns of rectangular conductors 1361A and 1361B that are adjacent to or not adjacent to each other, may be displaced in the Y direction by a displacement amount designed to have a value, and it is suitable if the sum total of the X-direction conductor widths of rectangular conductors 1361A and the sum total of the X-direction conductor widths of rectangular conductors 1361B are the same or substantially the same in a case in which a predetermined planar range (planar region) is looked at, but this is not essential.

C in FIG. 159 depicts the conductor layer C in a fourteenth modification example of the fourteenth configuration example of three conductor layers.

The conductor layer C in C in FIG. 159 includes pairs of columns of rectangular conductors 1361A and 1361B, each pair of which includes a column of rectangular conductors 1361A and a column of rectangular conductors 1361B that are adjacent to each other in the X direction, and the pairs of columns of rectangular conductors 1361A and 1361B are arranged being displaced relative to each other by ½ of the Y-direction conductor pitch FYC and are arranged repetitively on the same plane at predetermined repetition pitches.

The conductor layer C in C in FIG. 159 can completely offset capacitive noise in the X direction. Capacitive noise can be ameliorated more significantly if the conductor layer C is closer to the wiring layer 170.

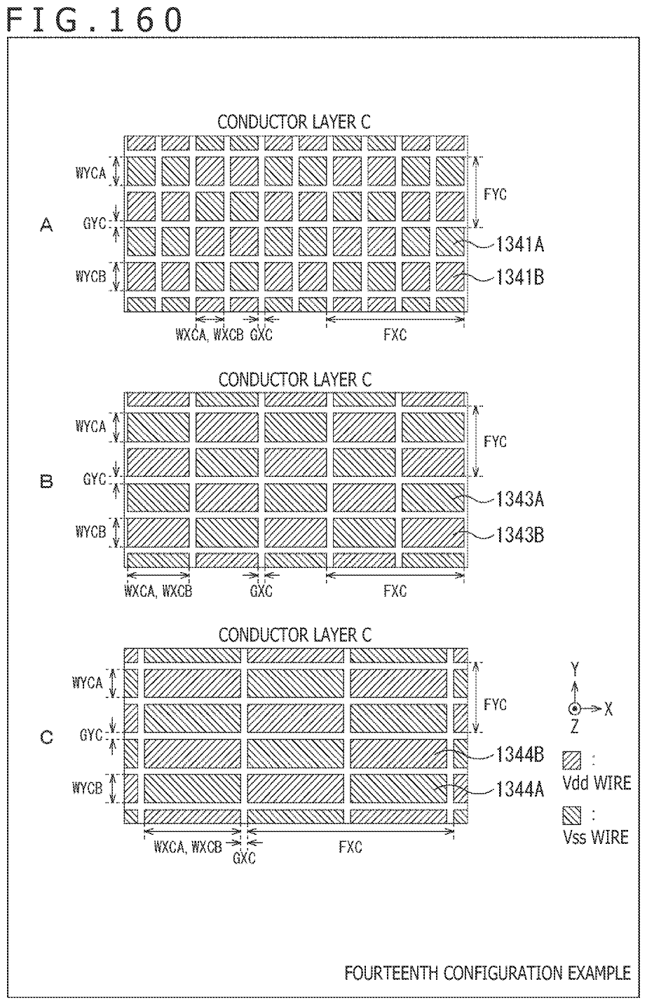

A in FIG. 160 depicts the conductor layer C in a fifteenth modification example of the fourteenth configuration example of three conductor layers.

The conductor layer C in A in FIG. 160 includes pairs of rectangular conductors 1341A and pairs of rectangular conductors 1341B that are arranged on the same plane at predetermined repetition pitches in the X direction and the Y direction. The gap between adjacent rectangular conductors 1341A, the gap between adjacent rectangular conductors 1341B, and the gap between adjacent rectangular conductors 1341A and 1341B have the X-direction gap width GXC and the Y-direction gap width GYC. The pairs of rectangular conductors 1341A and the pairs of rectangular conductors 1341B are arranged repetitively at the conductor pitch FXC in the X direction and are arranged repetitively at the conductor pitch FYC in the Y direction.

B in FIG. 160 depicts the conductor layer C in a sixteenth modification example of the fourteenth configuration example of three conductor layers.

The conductor layer C in B in FIG. 160 has a commonality with the conductor layer C in A in FIG. 157 in that they both include multiple rectangular conductors 1343A and 1343B that are arranged repetitively on the same plane at predetermined repetition pitches, but is different in that adjacent columns are arranged being displaced relative to each other by ½ of the Y-direction conductor pitch FYC. It can also be said that adjacent rows are arranged being displaced relative to each other by ½ of the X-direction conductor pitch FXC. The X-direction conductor pitch FXC includes a pair of columns, and the Y-direction conductor pitch FYC includes a pair of rows.

C in FIG. 160 depicts the conductor layer C in a seventeenth modification example of the fourteenth configuration example of three conductor layers.

The conductor layer C in C in FIG. 160 has a commonality with the conductor layer C in A in FIG. 158 in that they both include multiple rectangular conductors 1344A and 1344B that are arranged repetitively on the same plane at predetermined repetition pitches, but is different in that adjacent columns are arranged being displaced relative to each other by ½ of the Y-direction conductor pitch FYC. It can also be said that adjacent rows are arranged being displaced relative to each other by ½ of the X-direction conductor pitch FXC. The X-direction conductor pitch FXC includes a pair of columns, and the Y-direction conductor pitch FYC includes a pair of rows. The conductor layer C in B in FIG. 160, and the conductor layer C in C in FIG. 160 are different only in terms of the X-direction conductor widths WXCA and WXCB.

The conductor layer C in A to C in FIG. 160 can completely offset capacitive noise in both the X direction and the Y direction. Capacitive noise can be ameliorated more significantly if the conductor layer C is closer to the wiring layer 170.

A in FIG. 161 depicts the conductor layer C in an eighteenth modification example of the fourteenth configuration example of three conductor layers.

The conductor layer C in A in FIG. 161 has a commonality with the conductor layer C in A in FIG. 156 in that they both include pairs of rectangular conductors 1341A and pairs of rectangular conductors 1341B that are arranged on the same plane at predetermined repetition pitches in the X direction and the Y direction, but is different in that pairs of columns are arranged being displaced relative to each other by ¼ of the Y-direction conductor pitch FYC.

B in FIG. 161 depicts the conductor layer C in a nineteenth modification example of the fourteenth configuration example of three conductor layers.

The conductor layer C in B in FIG. 161 has a commonality with the conductor layer C in A in FIG. 157 in that they both include multiple rectangular conductors 1343A and 1343B that are arranged repetitively on the same plane at predetermined repetition pitches, but is different in that adjacent columns are arranged being displaced relative to each other by ¼ of the Y-direction conductor pitch FYC.

C in FIG. 161 depicts the conductor layer C in a twentieth modification example of the fourteenth configuration example of three conductor layers.

The conductor layer C in C in FIG. 161 includes conductors 1381A and 1381B that are arranged on the same plane at a predetermined repetition pitch in the Y direction. The conductors 1381A are wires (Vss wires) connected to GND or a negative power supply, for example. The conductors 1381B are wires (Vdd wires) connected to a positive power supply, for example.

Each conductor 1381A has a shape obtained by connecting all the rectangular conductors 1343A arrayed in the X direction in B in FIG. 161 along the shortest path. Each conductor 1381B has a shape obtained by connecting all the rectangular conductors 1343B arrayed in the X direction in B in FIG. 161 along the shortest path. The gap width GXC and the gap width GYC in C in FIG. 161 correspond to the X-direction and Y-direction minimum widths between adjacent conductors. Note that each conductor 1381A or conductor 1381B does not have to have a shape obtained by connecting all the rectangular conductors arrayed in the X direction in B in FIG. 161 along the shortest path, but may have a meandered shape or a winding shape, for example.

The conductor layer C in A to C in FIG. 161 can completely offset capacitive noise in the Y direction and can partially offset capacitive noise in the X direction. Capacitive noise can be ameliorated more significantly if the conductor layer C is closer to the wiring layer 170.

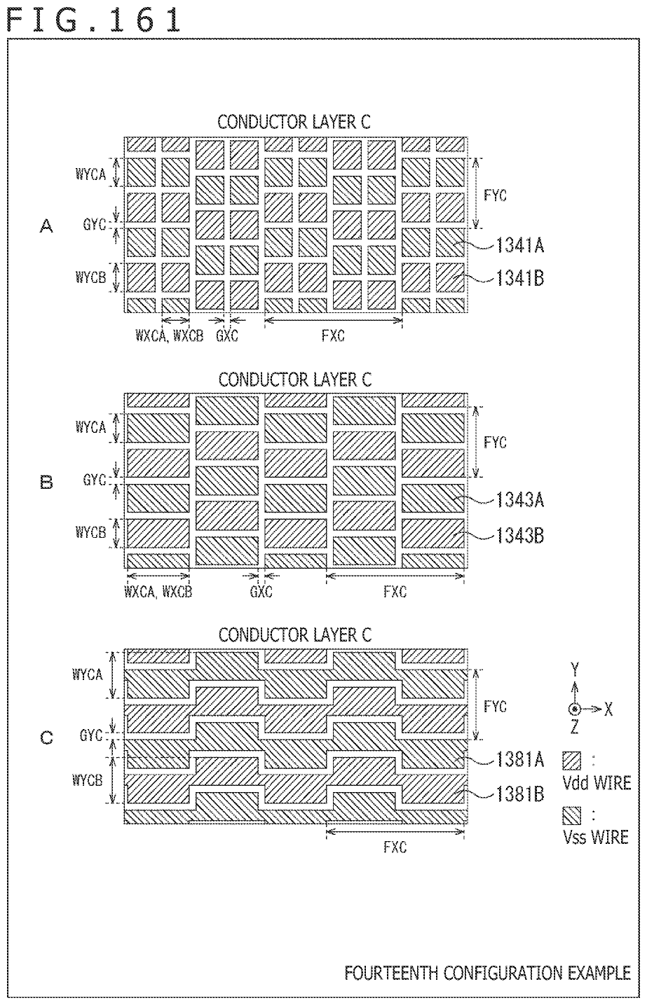

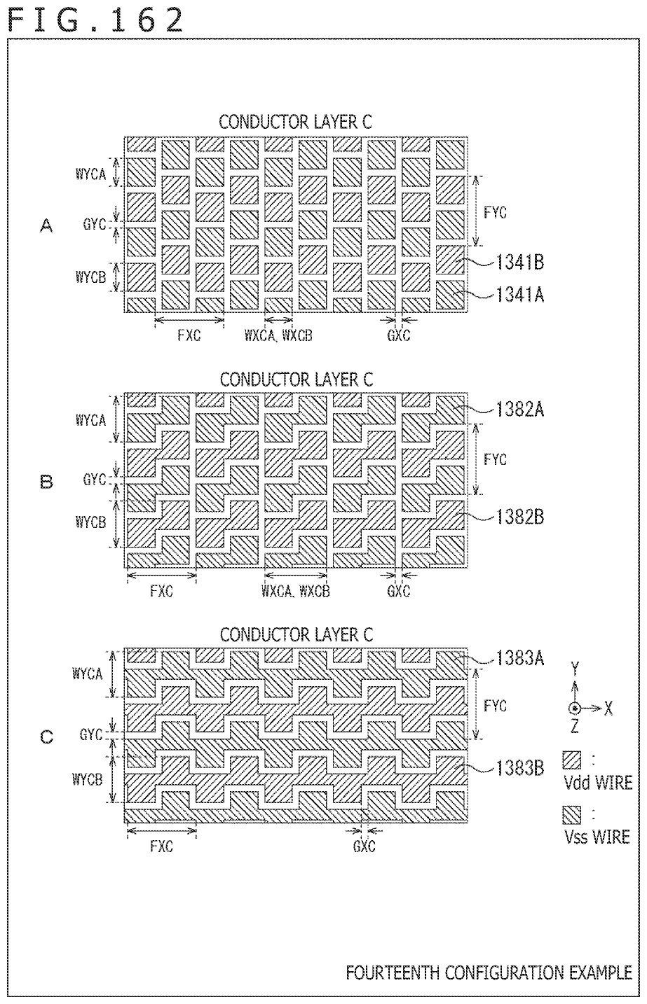

A in FIG. 162 depicts the conductor layer C in a twenty-first modification example of the fourteenth configuration example of three conductor layers.

The conductor layer C in A in FIG. 162 has a commonality with the conductor layer C in A in FIG. 153 in that they both include multiple rectangular conductors 1341A and 1341B that are arranged repetitively on the same plane at predetermined repetition pitches, but is different in that adjacent columns are arranged being displaced relative to each other by ¼ of the Y-direction conductor pitch FYC.

B in FIG. 162 depicts the conductor layer C in a twenty-second modification example of the fourteenth configuration example of three conductor layers.

The conductor layer C in B in FIG. 162 includes conductors 1382A and 1382B that are arranged regularly on the same plane at the X-direction conductor pitch FXC, and the Y-direction conductor pitch FYC. The conductors 1382A are wires (Vss wires) connected to GND or a negative power supply, for example. The conductors 1382B are wires (Vdd wires) connected to a positive power supply, for example. The conductors 1382A have the X-direction conductor width WXCA and the Y-direction conductor width WYCA, and the conductors 1382B have the X-direction conductor width WXCB, and the Y-direction conductor width WYCB. The gap width GXC and the gap width GYC in B in FIG. 162 correspond to the X-direction and Y-direction minimum widths between adjacent conductors.

Each conductor 1382A has a shape obtained by connecting two rectangular conductors 1341A that are arrayed in the X direction in A in FIG. 162 along the shortest path. Each conductor 1382B has a shape obtained by connecting two rectangular conductors 1341B that are arrayed in the X direction in A in FIG. 162 along the shortest path. Note that each conductor 1382A or conductor 1382B does not have to have a shape obtained by connecting rectangular conductors along the shortest path, but it is sufficient if each conductor 1382A or conductor 1382B has a shape obtained by electrically connecting two or more rectangular conductors that are arrayed in the X direction in A in FIG. 162.

C in FIG. 162 depicts the conductor layer C in a twenty-third modification example of the fourteenth configuration example of three conductor layers.

The conductor layer C in C in FIG. 162 includes conductors 1383A and 1383B that are arranged on the same plane at a predetermined repetition pitch in the Y direction. The conductors 1383A are wires (Vss wires) connected to GND or a negative power supply, for example. The conductors 1383B are wires (Vdd wires) connected to a positive power supply, for example. The conductors 1383A have the Y-direction conductor width WYCA, and the conductors 1382B have the Y-direction conductor width WYCB. The gap width GXC and the gap width GYC in C in FIG. 162 correspond to the X-direction and Y-direction minimum widths between adjacent conductors.

Each conductor 1383A has a shape obtained by connecting all the rectangular conductors 1341A arrayed in the X direction in A in FIG. 162 along the shortest path. Each conductor 1383B has a shape obtained by connecting all the rectangular conductors 1341B arrayed in the X direction in A in FIG. 162 along the shortest path. Note that each conductor 1383A or conductor 1383B does not have to have a shape obtained by connecting all the rectangular conductors arrayed in the X direction in A in FIG. 162 along the shortest path, but may have a meandered shape or a winding shape, for example.

The conductor layer C in A to C in FIG. 162 can completely offset capacitive noise in the Y direction and can partially offset capacitive noise in the X direction. Capacitive noise can be ameliorated more significantly if the conductor layer C is closer to the wiring layer 170.

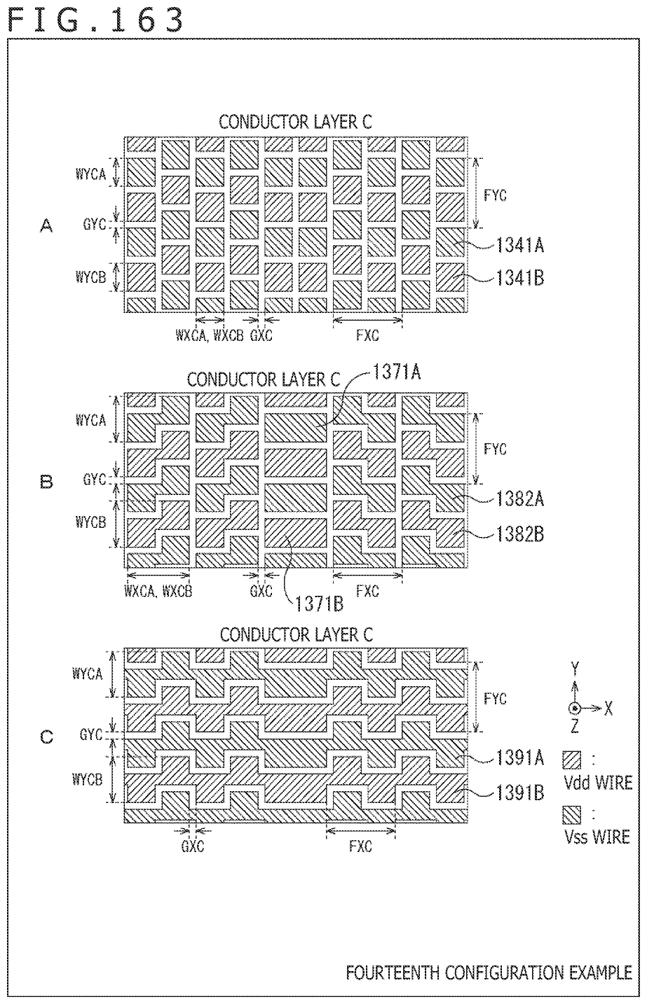

A in FIG. 163 depicts the conductor layer C in a twenty-fourth modification example of the fourteenth configuration example of three conductor layers.

The conductor layer C in A in FIG. 163 has a commonality with the conductor layer C in A in FIG. 153 in that they both include rectangular conductors 1341A and 1341B that are arranged repetitively on the same plane at predetermined repetition pitches, but is different in that regions where adjacent columns are arranged being displaced relative to each other by ¼ of the Y-direction conductor pitch FYC, and regions where adjacent columns are arranged not being displaced relative to each other are mixedly present. The conductor layer C in A in FIG. 163 has a configuration in which, with the X-direction center of two rectangular conductors 1341A and 1341B whose positions are not displaced relative to each other in the Y direction as the reference point, rectangular conductors 1341A and 1341B are arranged repetitively at the conductor pitch FXC in an order until the reference point, and then in the reversed order after the reference point in the X direction.

B in FIG. 163 depicts the conductor layer C in a twenty-fifth modification example of the fourteenth configuration example of three conductor layers.

The conductor layer C in B in FIG. 163 includes rectangular conductors 1371A and 1371B that are arranged therein, and conductors 1382A and 1382B that are arranged repetitively on the same plane at a predetermined repetition pitch.

The conductor layer C in B in FIG. 163 has a configuration in which the conductors 1382A and 1382B are arranged in an order until the X-direction center of the rectangular conductors 1371A and 1371B, and then in the reversed order after the X-direction center, and the conductors 1382A and 1382B are arranged repetitively in the X direction at the conductor pitch FXC.

C in FIG. 163 depicts the conductor layer C in a twenty-sixth modification example of the fourteenth configuration example of three conductor layers.

The conductor layer C in C in FIG. 163 includes conductors 1391A and 1391B that are arranged on the same plane at a predetermined repetition pitch in the Y direction. The conductors 1391A are wires (Vss wires) connected to GND or a negative power supply, for example. The conductors 1391B are wires (Vdd wires) connected to a positive power supply, for example. The conductors 1391A have the Y-direction conductor width WYCA, and the conductors 1391B have the Y-direction conductor width WYCB. The gap width GXC and the gap width GYC in C in FIG. 163 correspond to the X-direction and Y-direction minimum widths between adjacent conductors.

Each conductor 1391A has a shape obtained by connecting all the rectangular conductors 1371A and conductors 1382A arrayed in the X direction in B in FIG. 163 along the shortest path. Each conductor 1391B has a shape obtained by connecting all the rectangular conductors 1371B and conductors 1382B arrayed in the X direction in B in FIG. 163 along the shortest path. Note that each conductor 1391A or conductor 1391B does not have to have a shape obtained by connecting all the rectangular conductors arrayed in the X direction in B in FIG. 163 along the shortest path, but may have a meandered shape or a winding shape, for example.

The conductor layer C in C in FIG. 163 has a configuration in which the same region unit as that of the conductor layer C in B in FIG. 163 is arranged repetitively at the conductor pitch FXC, one region unit being arranged in an order, and then the next region unit being arranged in the reversed order in the X direction.

The conductor layer C in A to C in FIG. 163 has a conductor arrangement which is mirror-symmetric in the X direction.

The conductor layer C in A to C in FIG. 163 can completely offset capacitive noise in the Y direction and can partially offset capacitive noise in the X direction. Capacitive noise can be ameliorated more significantly if the conductor layer C is closer to the wiring layer 170. While some specific examples are mentioned above, the first to fourteenth configuration examples and modification examples thereof (FIG. 122 to FIG. 163) are particularly suitable for a stacking order in which the three layers, the conductor layers A to C, can be electrically connected via conductor vias extending in the Z direction, or the like. Specifically, the configuration examples and modification examples thereof that are depicted in FIG. 122 to FIG. 127, FIG. 134, FIG. 148, FIG. 149, and FIG. 152 to FIG. 163 are suitable for the stacking order depicted in B in FIG. 120. In addition, the configuration example and modification examples thereof depicted in FIG. 150 are suitable for the stacking orders depicted in A and B in FIG. 120. In addition, the configuration examples and modification examples thereof depicted in FIG. 129, FIG. 131, FIG. 133, FIG. 135 to FIG. 138, FIG. 140, FIG. 142 to FIG. 144, FIG. 146, FIG. 147, and FIG. 151 are suitable for the stacking orders depicted in B and C in FIG. 120. In addition, the configuration examples and modification examples thereof depicted in FIG. 128, FIG. 130, FIG. 132, FIG. 139, FIG. 141 and FIG. 145 are suitable for the stacking orders depicted in A to C in FIG. 120.

### Other Modification Examples of Three Conductor Layers

In each configuration example mentioned above, a conductor explained as being a wire (Vss wire) connected to GND or a negative power supply, for example, may be a wire (Vdd wire) connected to a positive power supply, for example, and a conductor explained as being a wire (Vdd wire) connected to a positive power supply, for example, may be a wire (Vss wire) connected to GND or a negative power supply, for example. The voltage to be used as Vdd or Vss may be GND and a power supply, and may be two types of power supply with different voltages. The voltage to be used as Vdd or Vss desirably has two different polarities, but this is not essential. The numbers and total area sizes of conductor vias extending in the Z direction between the conductor layers A, B and C, and connecting the conductor layers A, B and C are desirably the same between the conductor vias for Vdd and the conductor vias for Vss in a predetermined planar range (planar region), but this is not essential. In a case in which relay conductors that are arranged in gaps are thinned out, they may be thinned out in manners other than those in the examples mentioned above, and may be thinned out randomly, for example.

While it is assumed that the conductor layer C is a conductor layer with a low sheet resistance that allows currents to flow more easily, the conductor layer C may be a conductor layer with a high sheet resistance that allows currents to flow less easily. The conductor layer C is desirably, but is not limited to be, not a conductor layer which is the hardest for currents to flow through in the circuit board, the semiconductor board and the electronic equipment. The conductor layer C is desirably, but is not limited to be, a conductor layer which is the easiest for currents to flow through in the circuit board, the semiconductor board and the electronic equipment. The conductor layer C is desirably, but not limited to be, a conductor layer that allows currents to flow more easily than at least one of the conductor layer A and the conductor layer B does. The conductor layer C is desirably, but is not limited to be, a conductor layer which is the second easiest, next to the conductor layer A, for currents to flow through in the circuit board, the semiconductor board and the electronic equipment. The conductor layer C is desirably, but is not limited to be, a conductor layer which is the second easiest, next to the conductor layer B, for currents to flow through in the circuit board, the semiconductor board and the electronic equipment. For example, the conductor layer C may be a conductor layer which is the hardest for currents to flow through in the first semiconductor board 101 or the second semiconductor board 102. For example, the conductor layer C may be a conductor layer which is the easiest for currents to flow through in the first semiconductor board 101 or the second semiconductor board 102. For example, the conductor layer C may be a conductor layer which is the second easiest for currents to flow through in the first semiconductor board 101 or the second semiconductor board 102. For example, the conductor layer C may be a conductor layer which is the third easiest for currents to flow through in the first semiconductor board 101 or the second semiconductor board 102. For example, the conductor layer C may be a conductor layer which is the second easiest, next to the conductor layer A, for currents to flow through in the first semiconductor board 101 or the second semiconductor board 102. For example, the conductor layer C may be a conductor layer which is the second easiest, next to the conductor layer B, for currents to flow through in the first semiconductor board 101 or the second semiconductor board 102.

Note that it may be considered that a conductor layer which is easier for currents to flow through in the circuit board, the semiconductor board and the electronic equipment mentioned above is any one of a conductor layer which is easier for currents to flow through in the circuit board, a conductor layer which is easier for currents to flow through in the semiconductor board, and a conductor layer which is easier for currents to flow through in the electronic equipment. In addition, it may be considered that a conductor layer which is harder for currents to flow through in the circuit board, the semiconductor board and the electronic equipment mentioned above is any one of a conductor layer which is harder for currents to flow through in the circuit board, a conductor layer which is harder for currents to flow through in the semiconductor board, and a conductor layer which is harder for currents to flow through in the electronic equipment. In addition, the conductor layer which is easier for currents to flow through mentioned above can instead be expressed as a conductor layer with a low sheet resistance, and the conductor layer which is harder for currents to flow through mentioned above can instead be expressed as a conductor layer with a high sheet resistance.

As conductor materials to be used for the conductor layer C, metals such as copper, aluminum, tungsten, chromium, nickel, tantalum, molybdenum, titanium, gold, silver or iron, or mixtures, compounds or alloys at least containing any of the metals are used mainly. In addition, semiconductors such as silicon, germanium, compound semiconductors or organic semiconductors may be contained. Further, insulators such as cotton, paper, polyethylene, polyvinyl chloride, natural rubber, polyester, epoxy resin, melamine resin, phenolic resin, polyurethane, synthetic resin, mica, asbestos, glass fiber or porcelain may be contained. Furthermore, the conductor layer C may be an uppermost layer metal or a lowermost layer metal, that is, an uppermost or lowermost conductor layer, or a conductor layer that is used for a junction between the same type of metal such as a Cu—Cu junction, an Au—Au junction or an Al—Al junction, or a junction between different types of metal such as a Cu—Au junction, a Cu—Al junction or an Au—Al junction.

The planar arrangement of each conductor layer of the conductor layers A to C may be reversed in the X direction or may be reversed in the Y direction. In addition, the planar arrangement may be rotated by a predetermined angle clockwise (e.g., 90 degrees) or may be rotated by a predetermined angle counterclockwise (e.g., −90 degrees). In addition, while the conductor pitches, the conductor widths and the gap widths are entirely even pitches and widths in the examples used for the explanations of some of the configuration examples mentioned above, these are not essential. For example, the conductor pitches, the conductor widths and the gap widths may be uneven pitches and widths, and the conductor pitches, the conductor widths and the gap widths may be modulated depending on positions, in other possible shapes. In addition, while the conductor pitches, the conductor widths, the gap widths, the wire shapes, the wire positions, the numbers of wires and the like are substantially the same between Vdd wires and Vss wires in the examples used for the explanations of some of the configuration examples mentioned above, these are not essential. For example, Vdd wires and Vss wires may have different conductor pitches, may have different conductor widths, may have different gap widths, may have different wire shapes, may have different wire positions, may have wire positions that deviate from each other or are displaced from each other, or may have different numbers of wires.

### 13. Application Examples

The technology according to the present disclosure is not limited by the explanations of the embodiments, and modification examples or application examples thereof that are described above, but can be implemented in various modified manners. Constituent elements in the embodiments, and modification examples or application examples thereof that are described above may be omitted partially, may be changed partially or entirely, may be modified partially or entirely, may be replaced with other constituent elements partially, or may have other additional constituent elements partially or entirely. In addition, constituent elements in the embodiments, and modification examples or application examples thereof that are described above may be divided into multiple constituent elements partially or entirely, may be separated into multiple constituent elements partially or entirely, or may achieve different functionality or features with at least some of the multiple divided or separated constituent elements. Also, at least some of constituent elements in the embodiments, and modification examples or application examples thereof that are described above may be combined to form different embodiments. Further, at least some of constituent elements in the embodiments, and modification examples or application examples thereof that are described above may be shifted to form different embodiments. Moreover, combinations of at least some of constituent elements in the embodiments, and modification examples or application examples thereof that are described above may have additional coupling elements or relay elements to form different embodiments. Furthermore, combinations of at least some of constituent elements in the embodiments, and modification examples or application examples thereof that are described above may have additional switching elements or switching functionality to form different embodiments.

It is assumed that each conductor that forms the conductor layer A or B that can be an Aggressor conductor loop in the solid-state image pickup apparatus 100, which is the present embodiment, is a Vdd wire or a Vss wire. That is, currents flow in the mutually opposite directions in at least some regions in the conductor layers A and B. When a current flows from the upper side to the lower side in figures in the conductor layer A at a certain time, a current flows from the lower side to the upper side in the figures in the conductor layer B. Note that the magnitudes of currents are desirably the same with each other. Note that conductors that form the conductor layers A and B are included in the second semiconductor board in the examples used for the explanations, but this is not essential. For example, they may be included in the first semiconductor board, and may be partially or entirely included in a constituent element other than the second semiconductor board.

Signals to flow through the conductor layers A and B may be any signals other than Vdd or Vss as long as the signals are differential signals whose directions of electric currents change over time. That is, it is sufficient if signals that flow through the conductor layers A and B are any signals whose currents I change over time t (a minute current change that occurs in infinitesimal time dt is dI). Note that even if DC currents basically flow through the conductor layers A and B, the currents I are changing over time t in a case in which there are rising of the currents, time transients of the currents, falling of the currents or the like.

For example, the magnitude of a current flowing through the conductor layer A and the magnitude of a current flowing through the conductor layer B may not be the same with each other. Conversely, the magnitude of a current flowing through the conductor layer A and the magnitude of a current flowing through the conductor layer B may be made the same with each other (currents that change over time are caused to flow through the conductor layers A and B at substantially the same timing). Typically, the magnitude of an induced electromotive force that occurs to a Victim conductor loop can be reduced more in a case in which currents that change over time flow through the conductor layers A and B at substantially the same timing, than in a case in which the magnitude of a current flowing through the conductor layer A and the magnitude of a current flowing through the conductor layer B are not the same with each other. On the other hand, signals to flow through the conductor layers A and B may not be differential signals. For example, conductors that form the conductor layers A and B may both be Vdd wires, may both be Vss wires, may both be GND wires, may both be the same type of signal line, may be different types of signal line or may be another combination. In addition, conductors that form the conductor layers A and B may be conductors not connected to power supplies or signal sources. Although the effect of allowing suppression of inductive noise deteriorates in these cases, other effects of the invention can be attained.

In addition, frequency signals with predetermined frequencies like clock signals, for example, may be caused to flow through the conductor layers A and B. In addition, AC power supply currents, for example, may be caused to flow through the conductor layers A and B. In addition, the same frequency signals, for example, may be caused to flow through the conductor layers A and B. In addition, signals including multiple frequency components may be caused to flow through the conductor layers A and B. On the other hand, DC signals whose currents I do not change at all over time t may be caused to flow. Although the effect of allowing suppression of inductive noise cannot be attained in this case, other effects of the invention can be attained. On the other hand, signals may be made not caused to flow. Although the effect of inductive noise suppression, capacitive noise suppression and voltage drop (IR-Drop) reduction cannot be attained in this case, other effects of the invention are attained.

### 14. Displacement Configuration Examples of Mesh Conductor

### First Displacement Configuration Example of Mesh Conductor

Meanwhile, several configuration examples adopting mesh conductors for the conductor layer A and the conductor layer B mentioned above have been proposed.

For example, the second configuration example depicted in FIG. 15 depicts the conductor layer A including the mesh conductor 216, and the conductor layer B including the mesh conductor 217. The fourth configuration example depicted in FIG. 25 depicts the conductor layer A including the mesh conductor 231, and the conductor layer B including the mesh conductor 232.

In addition, relay conductors are arranged in gap regions of mesh conductors in proposed configuration examples.

For example, the eighth configuration example depicted in FIG. 32 depicts the conductor layer A including the mesh conductor 271, and the conductor layer B including the mesh conductor 272, and the relay conductors 302. The relay conductors 302 are non-mesh conductors arranged in non-conductor gap regions of the mesh conductor 272. The number of the relay conductors arranged in gap regions of the mesh conductor is not limited to one. For example, the number of relay conductors arranged in a conductor layer is larger than one like the relay conductors 306 in the conductor layer B in FIG. 40, in some cases.

Furthermore, for example, as in the fourth configuration example of three conductor layers depicted in FIG. 128, each of the conductor layer A and the conductor layer B has relay conductors in some cases.

Wiring patterns of mesh conductors including repetitions at the same positions in the X and Y directions like the ones mentioned above are disadvantageous in one aspect in terms of capacitive noise.

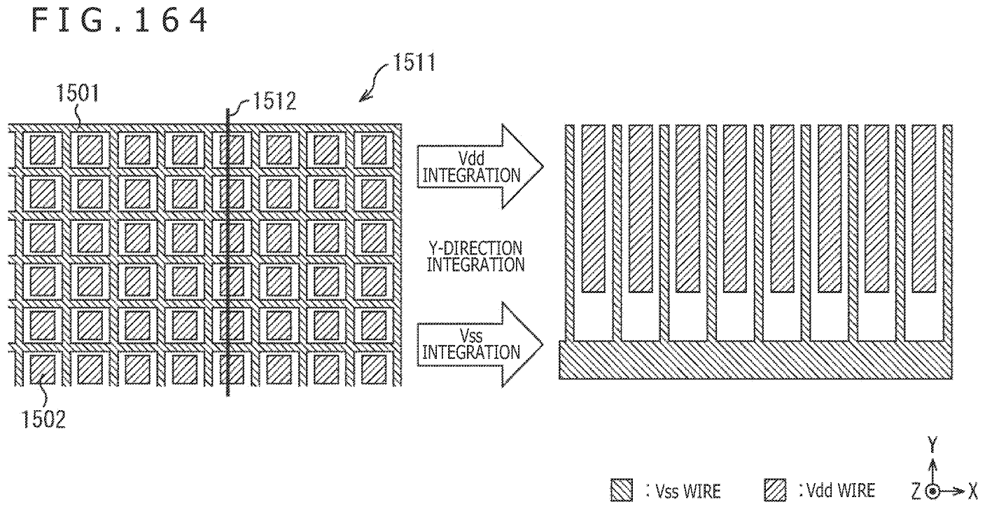

Specifically, for example, the left side in FIG. 164 depicts a conductor layer 1511 including a mesh conductor 1501, and relay conductors 1502 arranged in gap regions of the mesh conductor 1501. The mesh conductor 1501 is a wire (Vss wire) connected to GND or a negative power supply, for example. The relay conductors 1502 are wires (Vdd wire) connected to a positive power supply, for example.

A wire 1512 that is included as part of a Victim conductor loop is arranged on a layer above or below the conductor layer 1511 including the mesh conductor 1501 and the relay conductors 1502. The wire 1512 corresponds to a signal line 132 or a control line 133 of the solid-state image pickup apparatus 100 for example.

Signal lines 132 are placed such that the signal lines 132 become longer in the Y direction than in the X direction, and the multiple signal lines 132 are arranged regularly at a predetermined pitch width (e.g., one for each pixel) in the pixel array 121. Each signal line 132 transfers a signal when selected by a select transistor 145 of a corresponding pixel 131. Control lines 133 are placed such that the control lines 133 become longer in the X direction than in the Y direction, and the multiple control lines 133 are arranged regularly at a predetermined pitch width (e.g., one for each pixel) in the pixel array 121. Each control line 133 transfers a signal when selected by the vertical scanning unit 123.

If Vdd wires and Vss wires are separately integrated along sections that correspond to linear conductors like the wire 1512 long in the Y direction, and are influenced by the mesh conductor 1501 and the relay conductors 1502 of the conductor layer 1511, that is, if the Vdd wires and Vss wires are separately integrated along straight lines in the Y direction that overlap the wire 1512, the total electric charge amount due to Vdd, and the total electric charge amount due to Vss mutually differ significantly as depicted on the right side in FIG. 164. The difference between the capacitance on the positive side due to the Vdd wires, and the capacitance on the negative side due to the Vss wires generates capacitive noise.

As explained with reference to FIG. 62 and the like, capacitive noise means a phenomenon in which, in a case in which voltages are applied to conductors forming the conductor layers, voltages are generated to wires due to capacitive coupling between the conductors and the wires, and furthermore the applied voltages change, thereby generating voltage noise to the wires. The voltage noise becomes pixel signal noise.

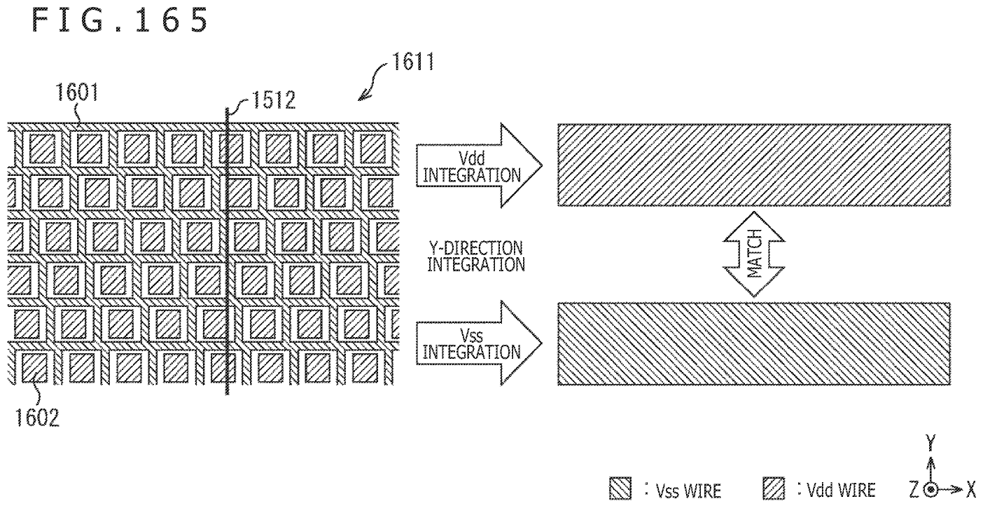

In contrast, the present inventors contrived conductor layers for which a predetermined displacement amount is set in a direction orthogonal to the longitudinal direction of the wire 1512 included as part of a Victim conductor loop, as in a conductor layer 1611 on the left side in FIG. 165.

The conductor layer 1611 includes a mesh conductor 1601, and relay conductors 1602 that are arranged in gap regions of the mesh conductor 1601. The mesh conductor 1601 is a wire (Vss wire) connected to GND or a negative power supply, for example. The relay conductors 1602 are wires (Vdd wire) connected to a positive power supply, for example.

In a case in which a predetermined displacement amount is provided in a direction orthogonal to the longitudinal direction of the wire 1512 in this manner, if Vdd wires and Vss wires are separately integrated along straight lines extending in the Y direction, the total electric charge amount due to Vdd, and the total electric charge amount due to Vss can be made substantially the same as depicted on the right side in FIG. 165. In addition, the polarities of voltages of the mesh conductor 1601 and the relay conductors 1602 are opposite (reverse polarities) between Vdd and Vss. Accordingly, the conductor layer 1611 can offset capacitive noise in the wire 1512, which is a Victim conductor. In a case in which Vdd wires and Vss wires integrated in the Y direction match, capacitive noise can be offset completely.

In configuration examples explained hereinbelow, capacitive noise is reduced, preferably offset completely, in a conductor layer of a mesh conductor by providing a predetermined displacement amount in a direction orthogonal to the longitudinal direction of a Victim conductor.

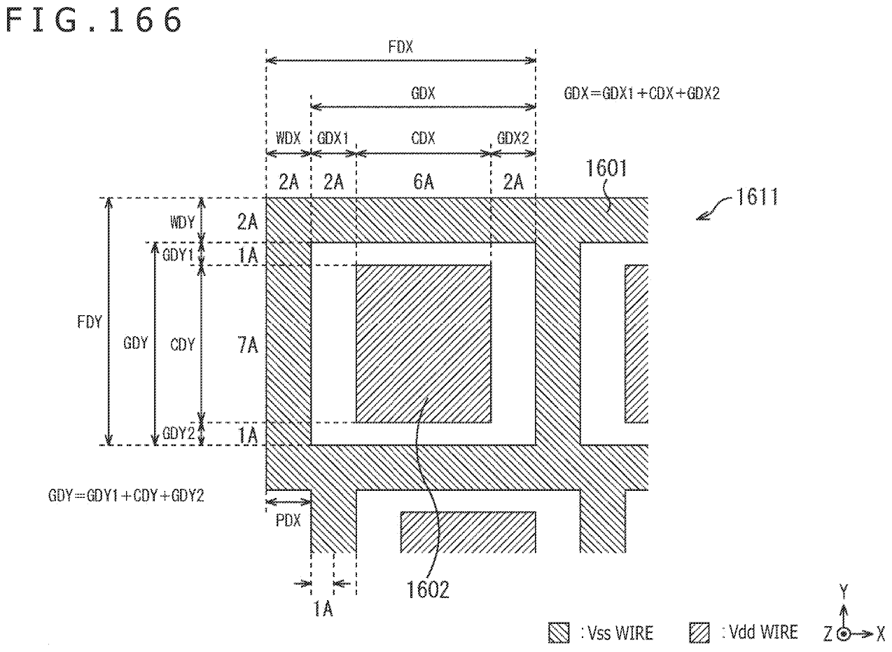

First, with reference to FIG. 166, the conductor widths and gap widths of the mesh conductor 1601 and the relay conductors 1602 included in the conductor layer 1611 as a first configuration example (a first displacement configuration example of a mesh conductor) of a mesh conductor provided with a displacement amount are explained.

Regarding the X direction, the mesh conductor 1601 has a conductor width WDX and a gap width GDX, and includes a repetition pattern with the conductor width WDX and the gap width GDX arranged at a pitch width FDX (=(conductor width WDX)+(gap width GDX)). In addition, regarding the Y direction, the mesh conductor 1601 has a conductor width WDY and a gap width GDY, and includes a repetition pattern with the conductor width WDY and the gap width GDY arranged at a pitch width FDY (=(conductor width WDY)+(gap width GDY)). It should be noted however that in the mesh conductor 1601, after every repetition of the Y-direction pitch width FDY, the conductor arrangement of the X-direction conductor width WDX and gap width GDX is displaced in the X direction by a predetermined displacement amount PDX. This X-direction displacement amount PDX for each pitch width FDY is also referred to as a pitch displacement PDX hereinafter.

The relay conductors 1602 are arranged in gap regions of the mesh conductor 1601 that have the X-direction gap width GDX, and the Y-direction gap width GDY. Each relay conductor 1602 is a rectangle with an X-direction conductor width CDX and a Y-direction conductor width CDY. The rectangle is a longitudinally long oblong rectangle with the Y-direction conductor width CDY larger than the X-direction conductor width CDX (CDY>CDX).

One X-direction end surface of each relay conductor 1602 is separated from the mesh conductor 1601 by a first gap width GDX1, and the other X-direction end surface is separated from the mesh conductor 1601 by a second gap width GDX2. The X-direction gap width GDX of the mesh conductor 1601 is equal to the total of the X-direction conductor width CDX, first gap width GDX1 and second gap width GDX2 of the relay conductor 1602. That is, GDX=CDX+GDX1+GDX2 is satisfied.

One Y-direction end surface of each relay conductor 1602 is separated from the mesh conductor 1601 by a first gap width GDY1, and the other Y-direction end surface is separated from the mesh conductor 1601 by a second gap width GDY2. The Y-direction gap width GDY of the mesh conductor 1601 is equal to the total of the Y-direction conductor width CDY, first gap width GDY1 and second gap width GDY2 of the relay conductor 1602. That is, GDY=CDY+GDY1+GDY2 is satisfied.

Here, the size relations between the conductor widths and gaps of the mesh conductor 1601 and the relay conductors 1602 are defined as follows.

As depicted in FIG. 166, assuming that A is a real number, the X-direction conductor width WDX and Y-direction conductor width WDY of the mesh conductor 1601 are widths which are equal to 2A. In other words, it is assumed that ½ of the X-direction conductor width WDX and Y-direction conductor width WDY of the mesh conductor 1601 is the real number A. In addition, it is assumed that the X-direction first gap width GDX1 and second gap width GDX2 also are 2A.

The X-direction conductor width CDX of each relay conductor 1602 is set to 6A, and the Y-direction conductor width CDY of each relay conductor 1602 is set to 7A. The Y-direction first gap width GDY1 and second gap width GDY2 are set to 1A.

Accordingly, if represented by using the real number A, the pitch width FDX (=(conductor width WDX)+(gap width GDX)) corresponds to 12A, and the pitch width FDY (=(conductor width WDY)+(gap width GDY)) corresponds to 11A.

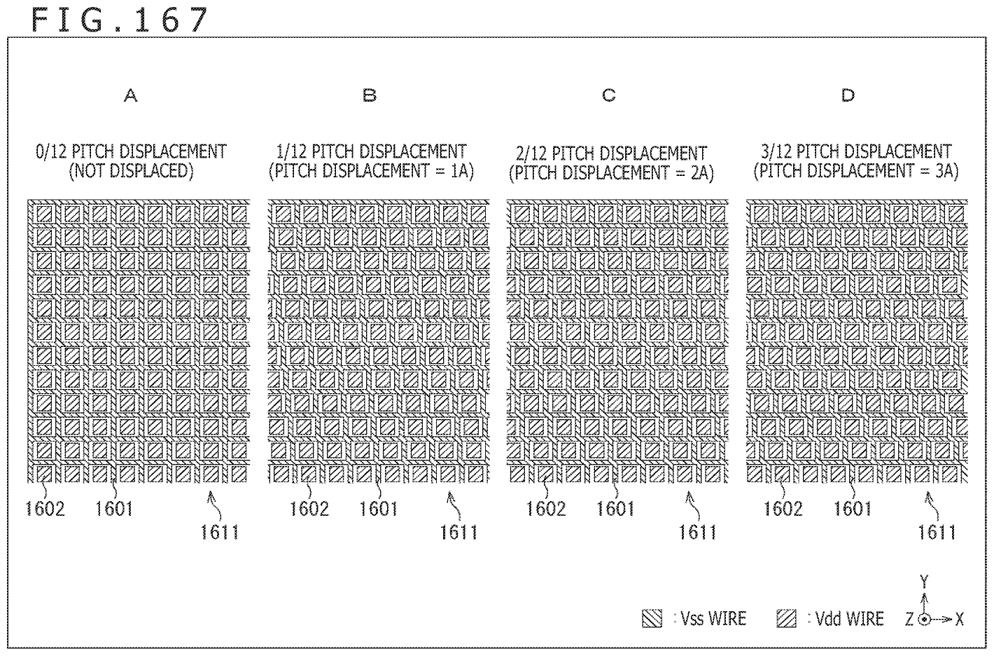

FIG. 167 and FIG. 168 are plan views of the conductor layer 1611 with the pitch displacement PDX set to various values.

A in FIG. 167 is a plan view of the conductor layer 1611 with the pitch displacement PDX set to zero. Note that the conductor layer 1611 with the pitch displacement PDX set to zero corresponds to the mesh conductor 1501 in FIG. 164.

B in FIG. 167 is a plan view of the conductor layer 1611 with the X-direction pitch displacement PDX set to 1A, that is, 1/12 of the X-direction repetition pitch (pitch width FDX).

C in FIG. 167 is a plan view of the conductor layer 1611 with the pitch displacement PDX set to 2A, that is, 2/12 of the X-direction repetition pitch (pitch width FDX).

D in FIG. 167 is a plan view of the conductor layer 1611 with the pitch displacement PDX set to 3A, that is, 3/12 of the X-direction repetition pitch (pitch width FDX).

A in FIG. 168 is a plan view of the conductor layer 1611 with the pitch displacement PDX set to 4A, that is, 4/12 of the X-direction repetition pitch (pitch width FDX).

B in FIG. 168 is a plan view of the conductor layer 1611 with the pitch displacement PDX set to 5A, that is, 5/12 of the X-direction repetition pitch (pitch width FDX).

C in FIG. 168 is a plan view of the conductor layer 1611 with the pitch displacement PDX set to 6A, that is, 6/12 of the X-direction repetition pitch (pitch width FDX).

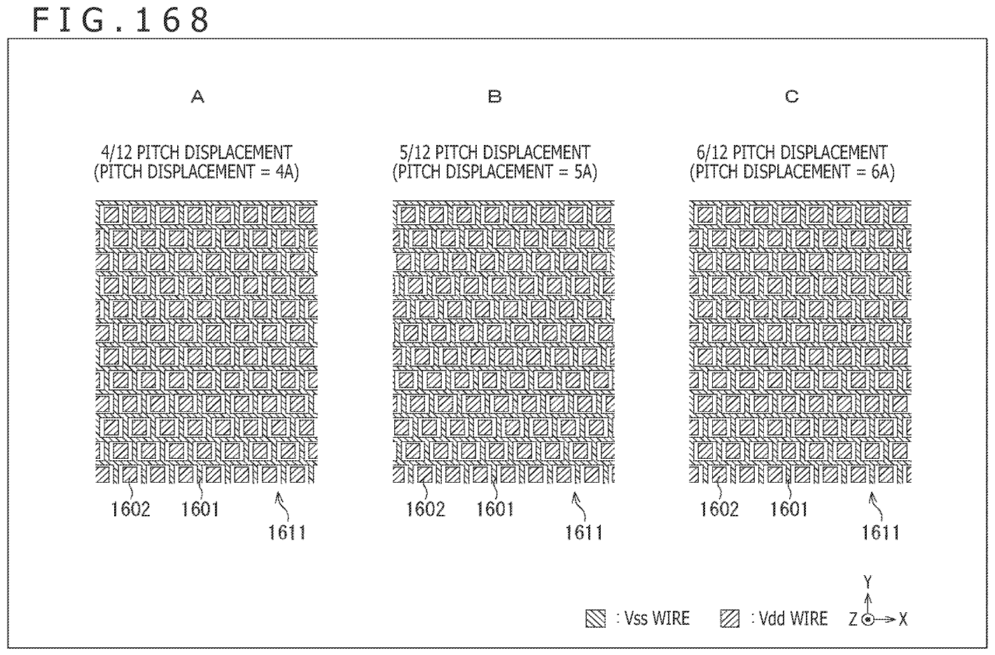

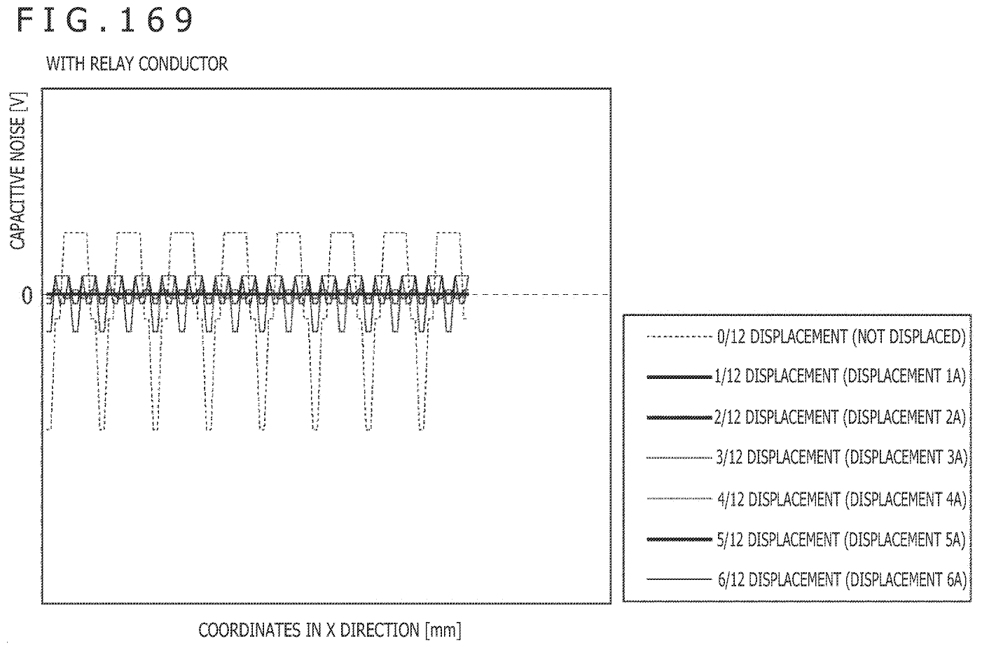

FIG. 169 is a graph depicting theoretical values of capacitive noise of the conductor layer 1611 with the pitch displacement PDX set to various values as in FIG. 167 and FIG. 168.

The horizontal axis in FIG. 169 represents a coordinate depicting X-direction positions of the conductor layer 1611, and the vertical axis in FIG. 169 represents capacitive noise of Vdd wires and Vss wires at each X position. Note that it is assumed that the absolute values of an applied voltage of the Vdd wires (Vdd applied voltage), and an applied voltage of the Vss wires (Vss applied voltage) are the same. For example, in one possible case, the Vdd applied voltage is +1 V, and the Vss applied voltage is −1 V.

As depicted in FIG. 169, in a case in which the pitch displacement PDX is set to predetermined values, the change amount of capacitive noise becomes zero, and the absolute value of capacitive noise becomes zero. More specifically, in a case in which the pitch displacement PDX is set to 1/12, 2/12 or 5/12 of the X-direction repetition pitch, the change amount of capacitive noise becomes zero, and the absolute value of capacitive noise becomes zero.

In the case of the other values of the pitch displacement PDX, specifically, in a case in which the pitch displacement PDX is set to 3/12, 4/12 or 6/12 of the X-direction repetition pitch, the change amount and absolute value of capacitive noise do not become zero, but the change amount of capacitive noise can be made smaller than in a case in which the pitch displacement PDX is set to zero, that is, there is no pitch displacement.

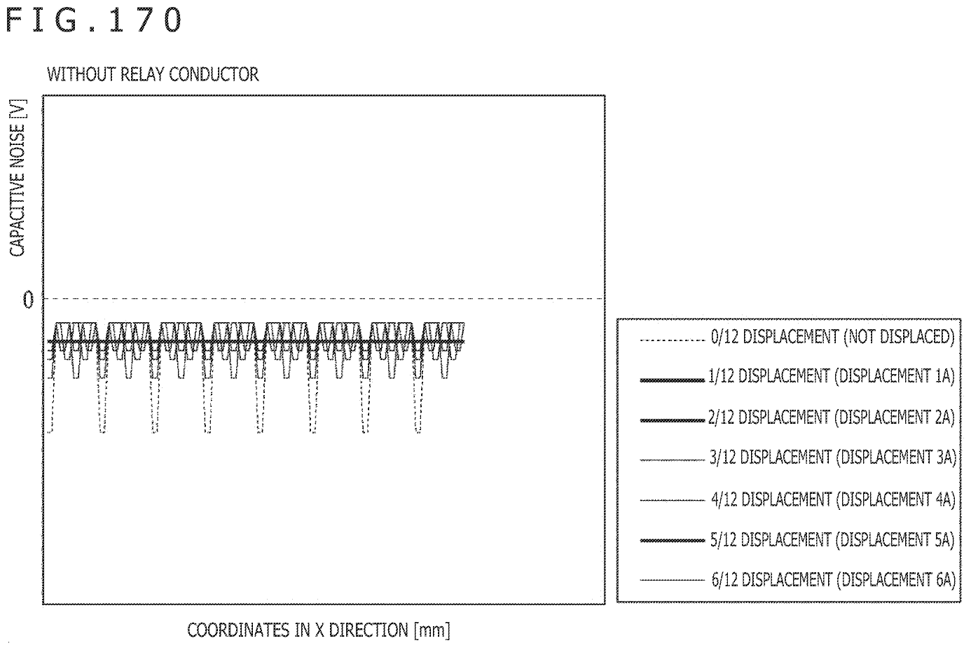

FIG. 170 is a graph depicting theoretical values of capacitive noise in a case in which the pitch displacement PDX is set to various values in the conductor layer 1611 from which relay conductors 1602 are omitted. Although an illustration of the conductor layer 1611 from which relay conductors 1602 are omitted is omitted, the conductor layer 1611 corresponds to one from which relay conductors 1602 are removed from each conductor layer 1611 in FIG. 167 and FIG. 168.

While the absolute value of capacitive noise does not become zero in a case in which there are no relay conductors 1602 as depicted in FIG. 170, the change amount of capacitive noise becomes zero in a case in which the pitch displacement PDX is set to predetermined values. The displacement amounts that make the change amount of capacitive noise zero are the same as those in a case in which there are relay conductors 1602. That is, in a case in which the pitch displacement PDX is set to 1/12, 2/12 or 5/12 of the X-direction repetition pitch, the change amount of capacitive noise becomes zero. In the case of the other values of the pitch displacement PDX, specifically, in a case in which the pitch displacement PDX is set to 3/12, 4/12 or 6/12 of the X-direction repetition pitch, the change amount of capacitive noise does not become zero, but the change amount of capacitive noise can be made smaller than in a case in which the pitch displacement PDX is set to zero, that is, there is no pitch displacement.

According to the graphs in FIG. 169 and FIG. 170, the change amount of capacitive noise becomes zero when the following conditions are satisfied.

First, as a premise, the pitch displacement PDX is set to a value that is different from the X-direction pitch width FDX (=12A) of the mesh conductor 1601.

In a case in which the pitch displacement PDX is 2A, that is, in a case in which the pitch displacement PDX is the same as the X-direction conductor width WDX of the mesh conductor 1601, the change amount of capacitive noise becomes zero. In addition, in a case in which the pitch displacement PDX is 1A, and in a case in which the pitch displacement PDX is 5A also, the change amount of capacitive noise becomes zero.

In a case in which the pitch displacement PDX is 1A or 5A, the change amount of capacitive noise becomes zero in a set of twelve rows. In contrast, in a case in which the pitch displacement PDX is 2A, the change amount of capacitive noise becomes zero in a set of six rows. In a case in which the pitch displacement PDX is equal to the conductor width WDX of the mesh conductor 1601, the change amount of capacitive noise can be made zero with a smaller number of rows, and so the degree of freedom of wiring layout can be increased.

In a case in which the pitch displacement PDX is different from 3/12 (=3A) of the X-direction repetition pitch of the mesh conductor 1601, in other words, in a case in which the pitch displacement PDX is not (pitch width FDX (=12A))/4, the change amount of capacitive noise becomes zero.

In a case in which the pitch displacement PDX is different from 4/12 (=4A) of the X-direction repetition pitch of the mesh conductor 1601, in other words, in a case in which the pitch displacement PDX is not (pitch width FDX (=12A))/3, the change amount of capacitive noise becomes zero.

In a case in which the pitch displacement PDX is different from 6/12 (=6A) of the X-direction repetition pitch of the mesh conductor 1601, in other words, in a case in which the pitch displacement PDX is not (pitch width FDX (=12A))/2, the change amount of capacitive noise becomes zero.

In a case in which there are relay conductors 1602, not only the change amount of capacitive noise becomes zero, but also the absolute value of capacitive noise can be made zero. In a case in which there are no relay conductors 1602, the change amount of capacitive noise becomes zero, but the absolute value of capacitive noise does not become zero.

In addition, a more significant capacitive-noise amelioration effect can be attained in a case in which there are relay conductors 1602 than in a case in which there are no relay conductors 1602.

While the pitch displacement PDX is changed in the positive direction along the X axis until the pitch displacement PDX becomes 6A, which is half of the pitch width FDX (=12A), in the examples explained with reference to FIG. 167 to FIG. 170, this similarly applies also to the case in which the pitch displacement PDX is changed in the negative direction along the X axis. More specifically, capacitive noise in cases in which the pitch displacement PDX is changed to 1A, 2A, 3A, 4A, 5A, and 6A in the negative direction along the X axis is similar to the theoretical values of the capacitive noise in cases in which the pitch displacement PDX is changed to 1A, 2A, 3A, 4A, 5A, and 6A in the positive direction along the X axis in FIG. 169 and FIG. 170, respectively.

In addition, capacitive noise in cases in which the pitch displacement PDX is changed to 7A, 8A, 9A, 10A, and 11A in the positive direction along the X axis is similar to the theoretical values of the capacitive noise in cases in which the pitch displacement PDX is changed to 5A, 4A, 3A, 2A, and 1A in the negative direction along the X axis in FIG. 169 and FIG. 170, respectively. In other words, capacitive noise in cases in which the pitch displacement PDX is changed to 7A, 8A, 9A, 10A, and 11A in the positive direction along the X axis is similar to the theoretical values of the capacitive noise in cases in which the pitch displacement PDX is changed to 5A, 4A, 3A, 2A, and 1A in the positive direction along the X axis, respectively.

Moreover, capacitive noise in cases in which the pitch displacement PDX is changed to 13A, 14A, 15A, 16A, 17A, and 18A in the positive direction along the X axis is similar to the theoretical values of the capacitive noise in cases in which the pitch displacement PDX is changed to 1A, 2A, 3A, 4A, 5A, and 6A in the positive direction along the X axis in FIG. 169 and FIG. 170. This similarly applies also to the cases of displacement by 13A, 14A, 15A, 16A, 17A, and 18A in the negative direction along the X axis.

According to the conductor layer 1611 above which is the first displacement configuration example of a mesh conductor, by providing the X-direction pitch displacement PDX, the change amount of capacitive noise can be made smaller than in a case in which the pitch displacement PDX is set to zero, that is, in a case in which there is no pitch displacement. Then, in addition, for example, in a case in which the pitch displacement PDX satisfies a predetermined condition such as a case in which the pitch displacement PDX is set to the same value as the X-direction conductor width WDX of the mesh conductor 1601, the change amount of capacitive noise can be made zero.

Furthermore, in a case in which relay conductors 1602 are provided in gap regions of the mesh conductor 1601, the absolute value of capacitive noise can also be made zero in a case in which the change amount of capacitive noise is zero.

In a case in which the following three conditions are satisfied, both the change amount and absolute value of capacitive noise can be made zero, that is, the capacitive noise can be offset completely. Hereinafter, these conditions are referred to as the first to third conditions of complete offsetting.

(area size of Vdd conductor in predetermined range)=(area size of Vss conductor in predetermined range)

(conductor width CDX)×(conductor width CDY)={(conductor width CDY)+(first gap width GDY1)+(second gap width GDY2)}×(conductor width WDX)+{(conductor width CDX)+(first gap width GDX1)+(second gap width GDX2)}×(conductor width WDY)+(conductor width WDX)×(conductor width WDY) 1.

(conductor width CDY)×{(minimum number of rows)−{(conductor width WDX)+(first gap width GDX1)+(second gap width GDX2)}/(conductor width WDX)}=(conductor width WDY)×(minimum number of rows)+(conductor width CDY)+(first gap width GDY1)+(second gap width GDY2) 2.

(pitch displacement PDX)×(number of offset rows)=(integer N)×{(conductor width WDX)+(first gap width GDX1)+(conductor width CDX)+(second gap width GDX2)} 3.

The first condition of complete offsetting means that the conductor area size of mesh conductor 1601 in a predetermined range, and the conductor area size of relay conductors 1602 in the predetermined range match, but they do not have match in a strict sense, and may be substantially the same. Being substantially the same means that the conductor area sizes are within such a predetermined range (errors) that they can be regarded as being the same. The minimum number of rows in the second condition represents the minimum number of rows of the mesh conductor 1601 that can completely offset capacitive noise in a case in which the pitch displacement PDX equals the conductor width WDX. Although there are some exceptions, there is a condition under which capacitive noise can be offset completely in a case in which the number of rows of the mesh conductor 1601 is an integer multiple of the minimum number of rows. Because the second condition can be modified to “(minimum number of rows)={(first gap width GDY1)+(second gap width GDY2)+(conductor width CDY)+(conductor width CDY)×{(conductor width WDX)+(first gap width GDX1)+(second gap width GDX2)}/(conductor width WDX)}/{(conductor width CDY)−(conductor width WDY)},” the minimum number of rows can be computed, and because the left side of the mathematical formula (minimum number of rows) is an integer value, the right side of the mathematical formula also becomes an integer value. Note that the second condition is a mathematical formula derived on the basis of the fact that capacitive noise can be offset completely in a case in which the sum total of the Y-direction conductor lengths of the mesh conductor 1601 in a predetermined range, and the sum total of the Y-direction conductor lengths of the relay conductors 1602 in the predetermined range match. That is, irrespective of the minimum number of rows, the sum total of the Y-direction conductor lengths of the mesh conductor 1601 in the predetermined range, and the sum total of the Y-direction conductor lengths of the relay conductors 1602 in the predetermined range are desirably the same or substantially the same. The number of offset rows in the third condition represents the number of rows of the mesh conductor 1601 that can completely offset the capacitive noise. The integer N in the third condition represents a condition under which capacitive noise can be offset completely. Although there are some exceptions, the number of offset rows is an integer, and there is a condition under which capacitive noise can be offset completely in a case in which “(pitch displacement PDX)×(number of offset rows)” equals an integer multiple (N times) of “(conductor width WDX)+(first gap width GDX1)+(conductor width CDX)+(second gap width GDX2),” that is, an integer multiple (N times) of the pitch width FDX. In other words, the sum total of the pitch displacement PDX of the number of offset rows ((pitch displacement PDX)×(number of offset rows)), and an integer multiple (N times) of the pitch width FDX are desirably the same or substantially the same. In addition, while there can be some exceptions, there is a condition under which capacitive noise can be offset completely in a case in which the number of offset rows is an integer multiple of the minimum number of rows. In addition, if the number of rows of the mesh conductor 1601 is a number of rows that further equals an integer multiple of the number of offset rows, capacitive noise can be offset completely. Note that while it is considered that at least the first condition needs to be satisfied in order to completely offset capacitive noise, at least part of capacitive noise can be offset also in some cases in a case in which at least one of the second condition or the third condition in the first to third conditions is satisfied, and so only at least some of the first to third conditions may be satisfied. In addition, in that case, the minimum number of rows or the number of offset rows may be interpreted as the number of rows of the mesh conductor 1601.

By providing at least some amount of the pitch displacement PDX, the capacitive-noise amelioration effect can be increased even in a case in which the change amount of capacitive noise is not zero.

Note that while it is assumed that the absolute values of a Vdd applied voltage and a Vss applied voltage are the same in the first displacement configuration example mentioned above, they do not have to be the same necessarily. For example, the Vdd applied voltage may be a positive power supply (+1 V), and the Vss applied voltage may be GND (0 V). Even in a case in which the absolute values of the Vdd applied voltage and the Vss applied voltage are not the same, at least part of capacitive noise is offset by providing the X-direction pitch displacement PDX, and so the capacitive-noise amelioration effect is obtained. In addition, even in a case in which the Vdd applied voltage and the Vss applied voltage are not the same, capacitive noise is offset completely in some cases if, for example, Vdd conductors and Vss conductors have different directions of electric currents (particularly, substantially opposite directions), and capacitive noise generated by a voltage change of a voltage drop (IR-Drop) has reverse polarities between the Vdd conductors and the Vss conductors.

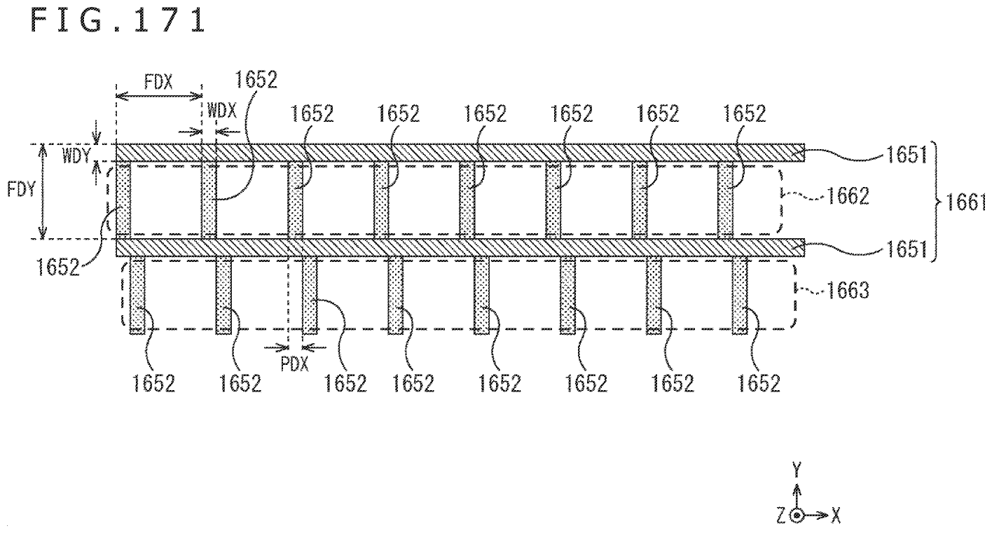

The mesh conductor 1601 having the X-direction pitch displacement PDX is defined with reference to FIG. 171.

The mesh conductor 1601 can be divided into multiple conductors 1651 that are placed in the X direction, and multiple conductors 1652 that are placed in the Y direction between pairs of adjacent conductors 1651.

The mesh conductor 1601 includes a first conductor group 1661 including two or more conductors 1651 that are arranged at the pitch width FDY (first pitch width) in the Y direction (first direction) and have the conductor width WDY (first conductor width), and a second conductor group 1662 including two or more conductors 1652 that are arranged at the pitch width FDX (second pitch width) in the X direction (second direction) orthogonal to the Y direction and have the conductor width WDX (second conductor width).

In addition, the mesh conductor 1601 includes a first shifted body group 1663 including conductors 1652 that are arranged at positions that are shifted in the Y direction by an amount which is 100% of the pitch width FDY, and are shifted in the X direction by an amount which is 100% of the pitch displacement PDX (third pitch width), from the positions of at least some (e.g., all) of two or more conductors 1652 included in the second conductor group 1662. Here, the pitch displacement PDX and the pitch width FDX are different from each other.

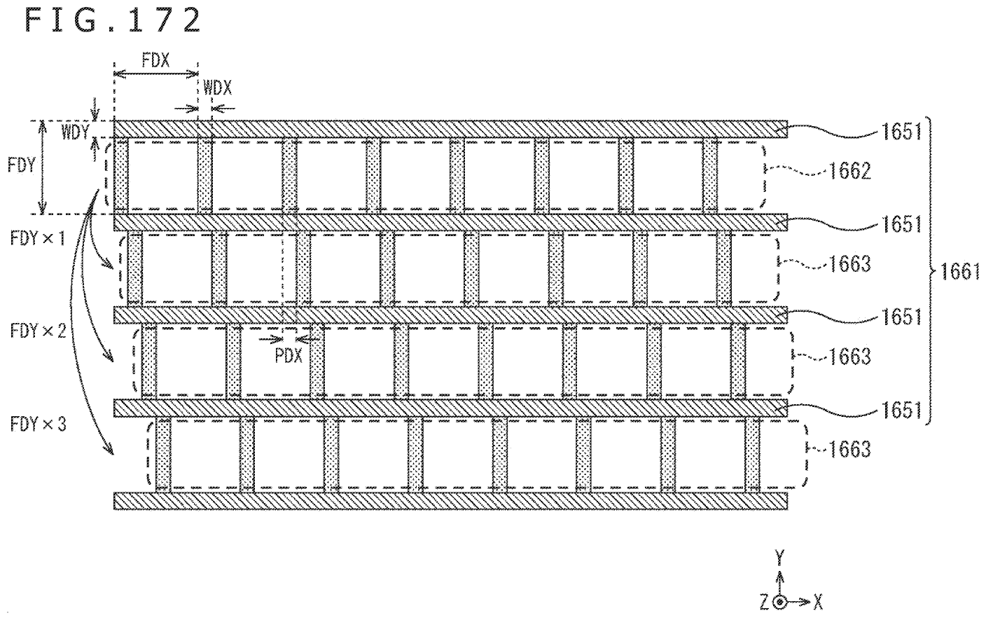

Furthermore, in a case in which the mesh conductor 1601 further includes an M-th shifted body group 1663 (M=2, 3, 4, 5, . . . , L (L is an integer which is equal to or larger than two)) including conductors 1652 that are arranged at positions that are shifted in the Y direction by an amount which is M*100% of the pitch width FDY, and are shifted in the X direction by an amount which is M*100% of the pitch displacement PDX (third pitch width), from the positions of at least some (e.g., all) of two or more conductors 1652 included in the second conductor group 1662, the mesh conductor 1601 becomes like the one depicted in FIG. 172.

By giving the mesh conductor 1601 a configuration provided with the pitch displacement PDX different from the pitch width FDX as in FIG. 171 and FIG. 172, the capacitive noise generated to wires (conductors) arranged at positions that are superimposed on at least part of the mesh conductor 1601 as seen in the Z direction orthogonal to the X direction and the Y direction can be reduced, and preferably can be offset completely.

Examples of the wires include signal lines 132, control lines 133 and the like of the solid-state image pickup apparatus 100 as explained with reference to FIG. 164 and FIG. 165, for example.

### Modification Examples of First Displacement Configuration Example of Mesh Conductor

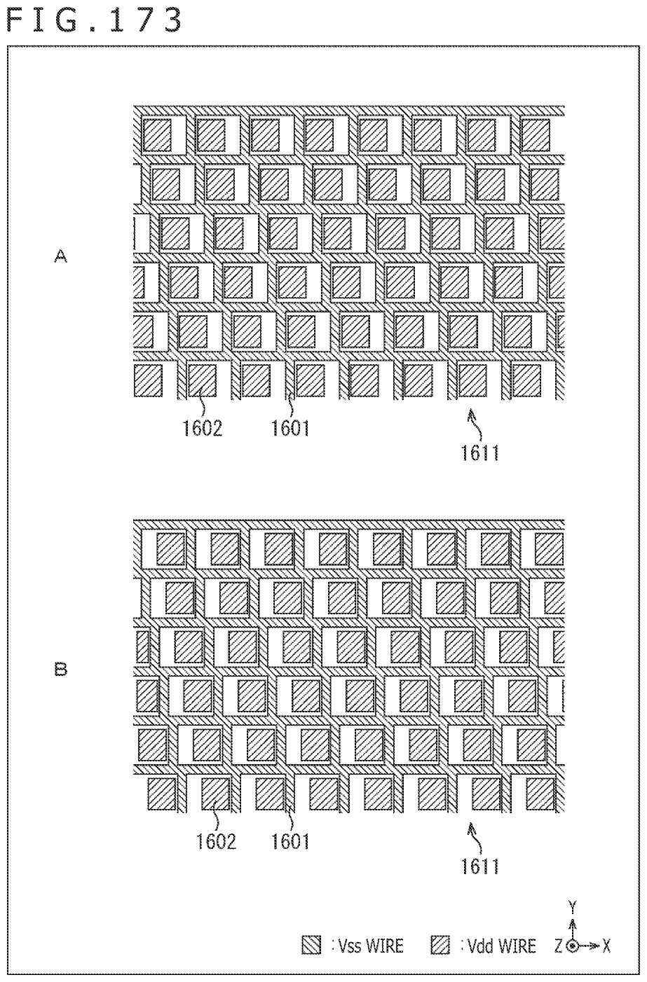

FIG. 173 to FIG. 181 depict various types of modification example of the first displacement configuration example of a mesh conductor.

Note that it is assumed in FIG. 173 to FIG. 181 that the pitch displacement PDX is set to 2A, that is, set equal to the conductor width WDX of the mesh conductor 1601. In addition, for simplification, in the explanations of the various types of modification example in FIG. 173 to FIG. 181, the first displacement configuration example of a mesh conductor depicted in FIG. 167 and FIG. 168 is referred to as a pitch-displacement basic configuration example, and only differences from the pitch-displacement basic configuration example are explained.

A in FIG. 173 is a plan view depicting a first modification example of the first displacement configuration example of a mesh conductor.

As compared with the pitch-displacement basic configuration example, the first modification example in A in FIG. 173 is different in that the arrangement of relay conductors 1602 is shifted leftward in gap regions. While (first gap width GDX1)=(second gap width GDX2) is satisfied in the pitch-displacement basic configuration example, (first gap width GDX1)<(second gap width GDX2) is satisfied in the first modification example.

B in FIG. 173 is a plan view depicting a second modification example of the first displacement configuration example of a mesh conductor.

As compared with the pitch-displacement basic configuration example, the second modification example in B in FIG. 173 is different in that the arrangement of relay conductors 1602 is shifted rightward in gap regions. While (first gap width GDX1)=(second gap width GDX2) is satisfied in the pitch-displacement basic configuration example, (first gap width GDX1)>(second gap width GDX2) is satisfied in the second modification example.

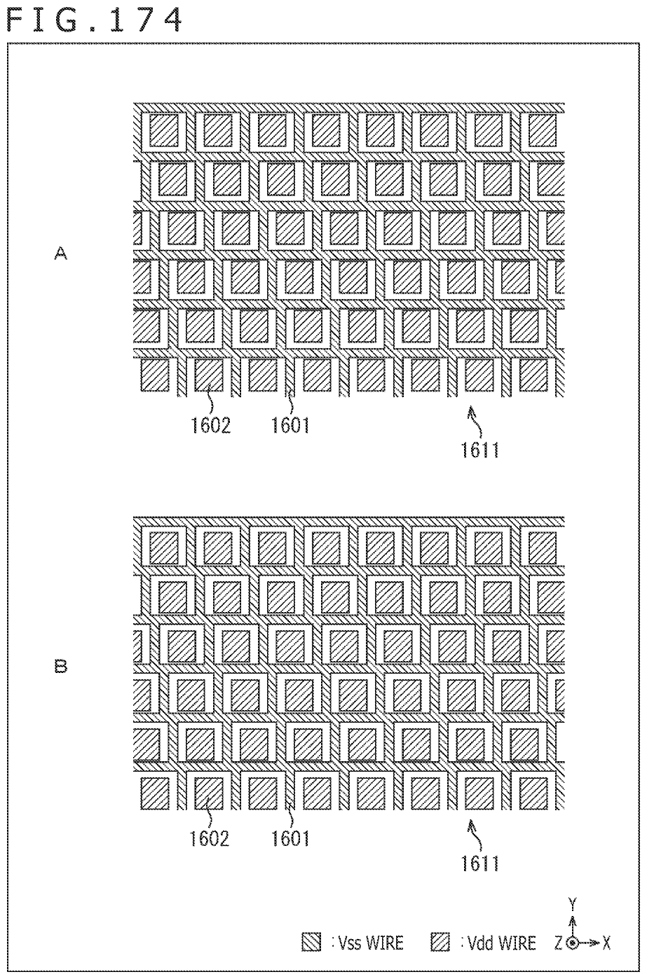

A in FIG. 174 is a plan view depicting a third modification example of the first displacement configuration example of a mesh conductor.

As compared with the pitch-displacement basic configuration example, the third modification example in A in FIG. 174 is different in that the arrangement of relay conductors 1602 is shifted upward in gap regions. While (first gap width GDY1)=(second gap width GDY2) is satisfied in the pitch-displacement basic configuration example, (first gap width GDY1)<(second gap width GDY2) is satisfied in the third modification example.

B in FIG. 174 is a plan view depicting a fourth modification example of the first displacement configuration example of a mesh conductor.

As compared with the pitch-displacement basic configuration example, the fourth modification example in B in FIG. 174 is different in that the arrangement of relay conductors 1602 is shifted downward in gap regions. While (first gap width GDY1)=(second gap width GDY2) is satisfied in the pitch-displacement basic configuration example, (first gap width GDY1)>(second gap width GDY2) is satisfied in the fourth modification example.

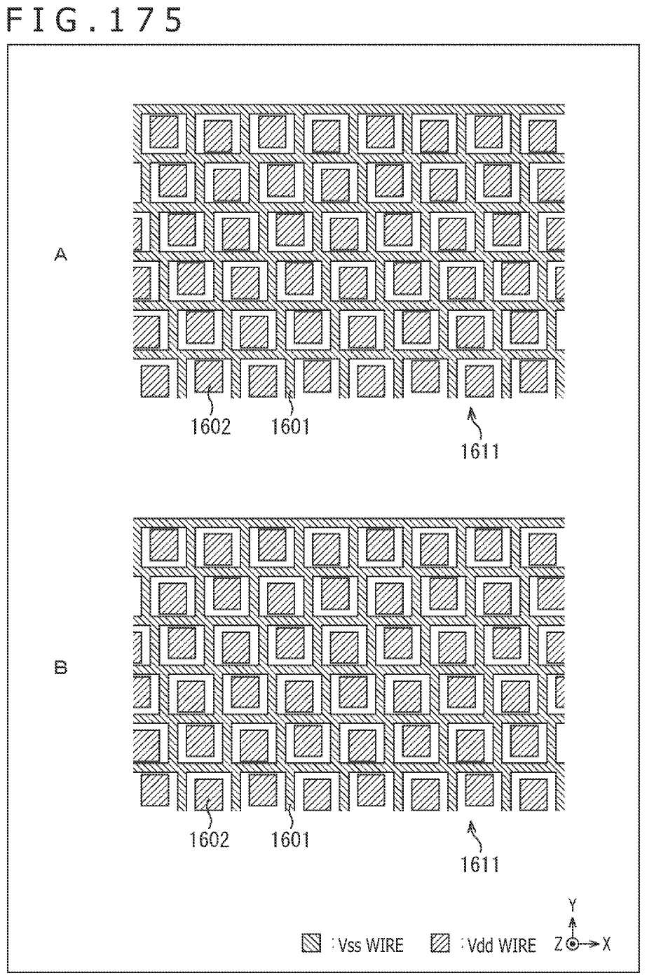

A in FIG. 175 is a plan view depicting a fifth modification example of the first displacement configuration example of a mesh conductor.

As compared with the pitch-displacement basic configuration example, the fifth modification example in A in FIG. 175 is different in that the arrangement of relay conductors 1602 is modified to an arrangement in which the relay conductors 1602 are shifted upward and downward alternately every other column. The size relations between (first gap width GDY1) and (second gap width GDY2) in the upwardly and downwardly shifted arrangement are similar to those in the third modification example and the fourth modification example.

B in FIG. 175 is a plan view depicting a sixth modification example of the first displacement configuration example of a mesh conductor.

As compared with the pitch-displacement basic configuration example, the sixth modification example in B in FIG. 175 is different in that the arrangement of relay conductors 1602 is modified to an arrangement in which the relay conductors 1602 are shifted upward and downward alternately every other row and every other column. The size relations between (first gap width GDY1) and (second gap width GDY2) in the upwardly and downwardly shifted arrangement are similar to those in the third modification example and the fourth modification example.

Note that, although an illustration is omitted, similarly, an arrangement in which relay conductors 1602 are shifted rightward and leftward alternately every other column, and an arrangement in which the relay conductors 1602 are shifted rightward and leftward alternately every other row and every other column also are possible.

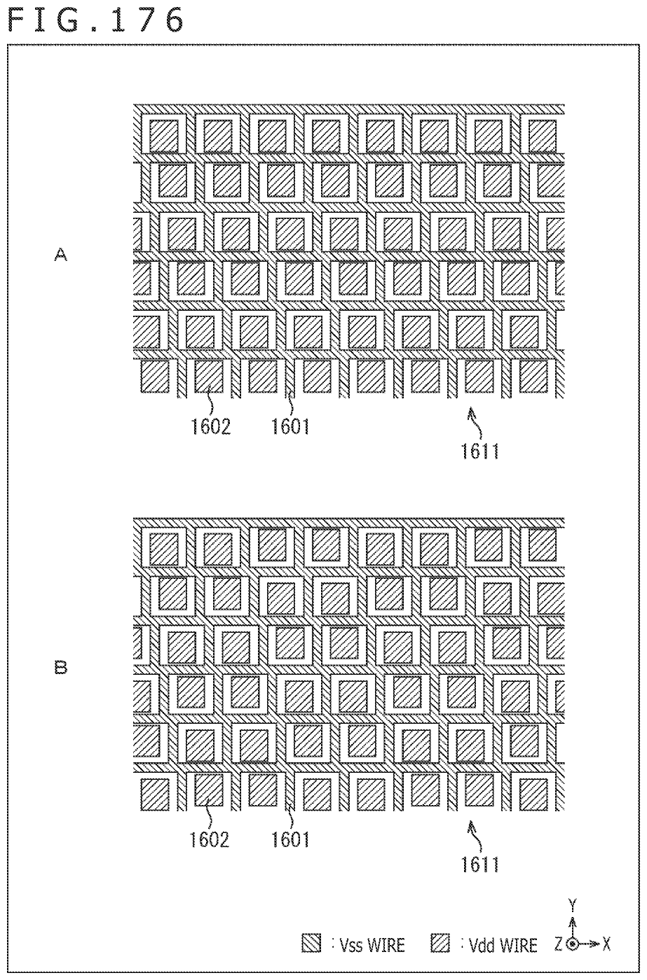

A in FIG. 176 is a plan view depicting a seventh modification example of the first displacement configuration example of a mesh conductor.

As compared with the pitch-displacement basic configuration example, the seventh modification example in A in FIG. 176 is different in that pairs of rows, each pair of which includes the relay conductors 1602 that are shifted inward, are arranged repetitively in the Y direction. The size relations between (first gap width GDY1) and (second gap width GDY2) in the upwardly and downwardly shifted arrangement are similar to those in the third modification example and the fourth modification example.

B in FIG. 176 is a plan view depicting an eighth modification example of the first displacement configuration example of a mesh conductor.

As compared with the pitch-displacement basic configuration example, the eighth modification example in B in FIG. 176 is different in that pairs of rows, each pair of which includes the relay conductors 1602 that are shifted inward and outward every other two columns and every other two rows, are arranged repetitively in the Y direction. The size relations between (first gap width GDY1) and (second gap width GDY2) in the upwardly and downwardly shifted arrangement are similar to those in the third modification example and the fourth modification example.

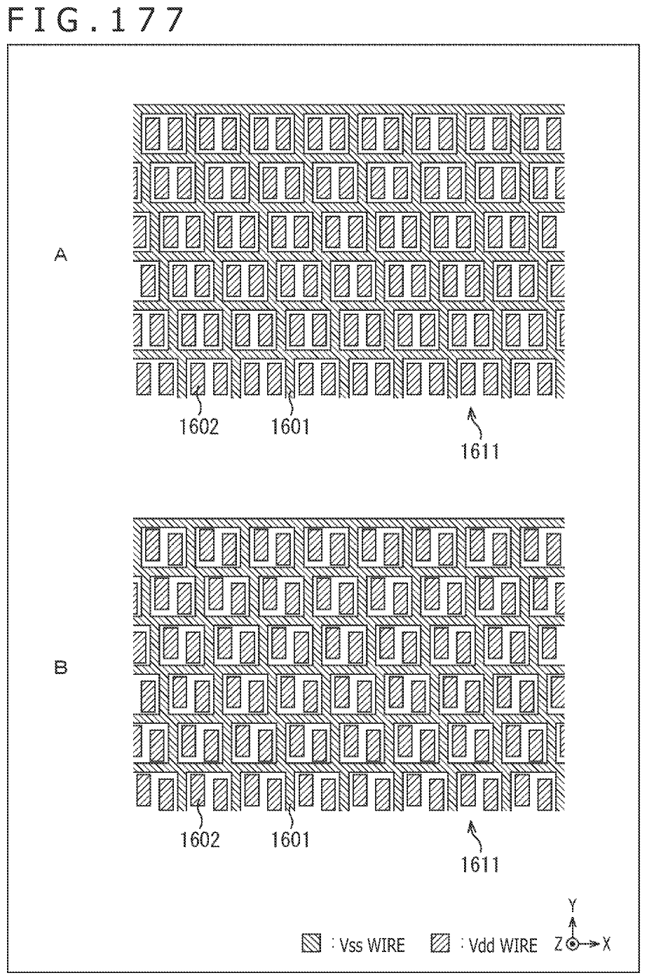

A in FIG. 177 is a plan view depicting a ninth modification example of the first displacement configuration example of a mesh conductor.

As compared with the pitch-displacement basic configuration example, the ninth modification example in A in FIG. 177 is different in that it has a configuration in which each relay conductor 1602 is separated into two evenly in the leftward/rightward direction. The two separated relay conductors 1602 are arranged mirror-symmetrically in the separation direction (X direction).

B in FIG. 177 is a plan view depicting a tenth modification example of the first displacement configuration example of a mesh conductor.

As compared with the pitch-displacement basic configuration example, the tenth modification example in B in FIG. 177 is different in that it has a configuration in which each relay conductor 1602 is separated into two in the leftward/rightward direction, and the two separated relay conductors 1602 are arranged mutually differently in the upward/downward direction (Y direction).

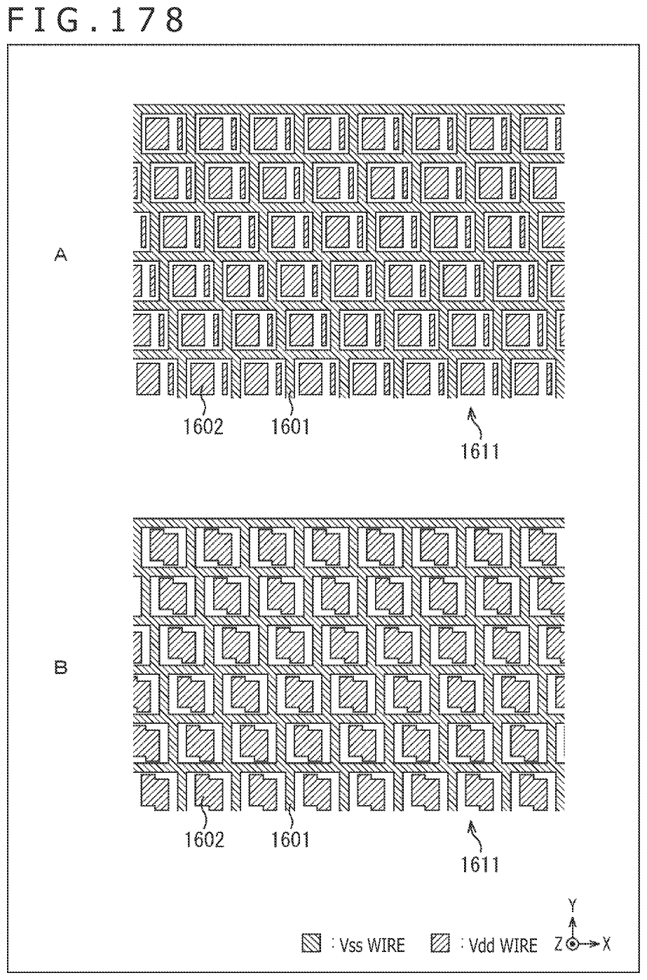

A in FIG. 178 is a plan view depicting an eleventh modification example of the first displacement configuration example of a mesh conductor.

As compared with the pitch-displacement basic configuration example, the eleventh modification example in A in FIG. 178 is different in that it has a configuration in which each relay conductor 1602 is separated into two unevenly in the leftward/rightward direction. While the left one of the two separated relay conductors 1602 is larger than the right one in the configuration in the eleventh modification example in A in FIG. 178, the right one may be larger than the left one in another possible configuration. In addition, each relay conductor may be separated into two unevenly in the upward/downward direction in another possible configuration.

B in FIG. 178 is a plan view depicting a twelfth modification example of the first displacement configuration example of a mesh conductor.

As compared with the pitch-displacement basic configuration example, the twelfth modification example in B in FIG. 178 is different in that it has a configuration in which each relay conductor 1602 is divided into two, but are not separated, in the leftward/rightward direction, and the two divided relay conductors 1602 are displaced in the upward/downward direction. While the left one in the two divided left relay conductor and right relay conductor that are displaced in the upward/downward direction is displaced in the upward direction, and the right one is displaced in the downward direction in the configuration in the twelfth modification example in B in FIG. 178, the right one may be displaced in the upward direction, and the left one may be displaced in the downward direction in another possible configuration. In addition, relay conductors 1602 may be displaced in the leftward/rightward direction from the center in the upward/downward direction in another possible configuration.

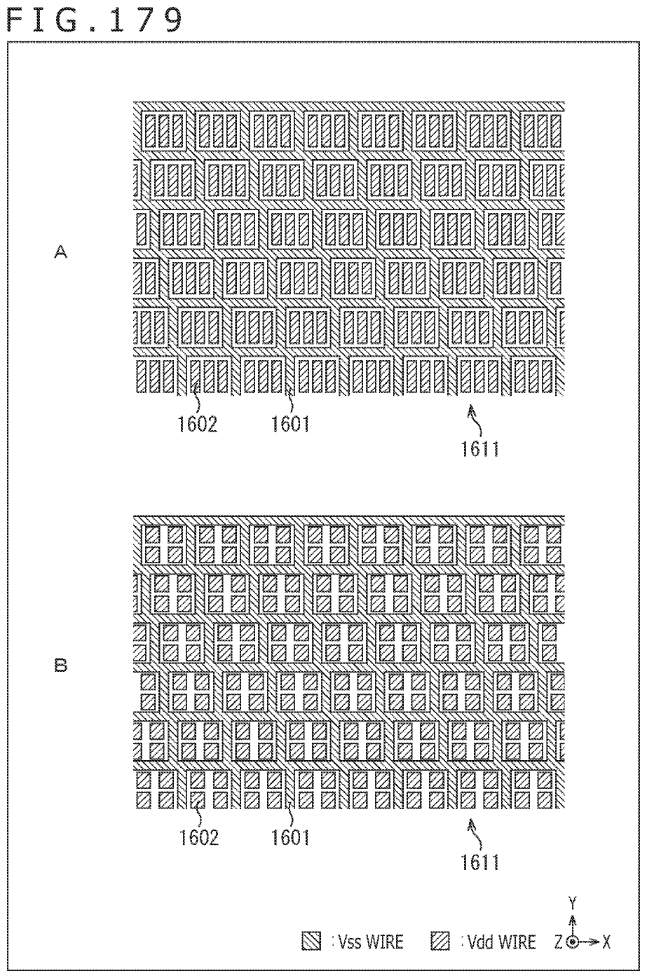

A in FIG. 179 is a plan view depicting a thirteenth modification example of the first displacement configuration example of a mesh conductor.

As compared with the pitch-displacement basic configuration example, the thirteenth modification example in A in FIG. 179 is different in that it has a configuration in which each relay conductor 1602 is separated into three evenly in the leftward/rightward direction.

Note that, although an illustration is omitted, besides such a configuration in which each relay conductor 1602 is separated evenly into three in the leftward/rightward direction, configurations similar to those in FIG. 177 and FIG. 178 related to configurations in which each relay conductor 1602 is separated into two also are possible. For example, other possible configurations include a configuration in which each relay conductor 1602 is separated into three evenly in the upward/downward direction; a configuration in which each relay conductor 1602 is separated into three unevenly in the leftward/rightward direction; a configuration in which each relay conductor 1602 is separated into three unevenly in the upward/downward direction; a configuration in which each relay conductor 1602 is separated into three evenly in the leftward/rightward direction, and the separated relay conductors 1602 are displaced in the upward/downward direction; a configuration in which each relay conductor 1602 is separated into three evenly in the upward/downward direction, and the separated relay conductors 1602 are displaced in the leftward/rightward direction; a configuration in which each relay conductor is not separated, but divided into three, and the divided relay conductors 1602 are displaced in the upward/downward direction; a configuration in which each relay conductor is not separated, but divided into three, and the divided relay conductors 1602 are displaced in the leftward/rightward direction; and the like.

B in FIG. 179 is a plan view depicting a fourteenth modification example of the first displacement configuration example of a mesh conductor.

As compared with the pitch-displacement basic configuration example, the fourteenth modification example in B in FIG. 179 is different in that it has a configuration in which each relay conductor 1602 is separated into four evenly in the upward/downward and leftward/rightward directions.

Possible configurations of the configuration in which each relay conductor 1602 is separated into four also include a configuration in which each relay conductor 1602 is separated unevenly; a configuration in which four separated relay conductors 1602 are displaced in at least one of the upward/downward direction or the leftward/rightward direction; a configuration in which each relay conductor is not separated, but divided, and the divided relay conductors 1602 are displaced; and the like.

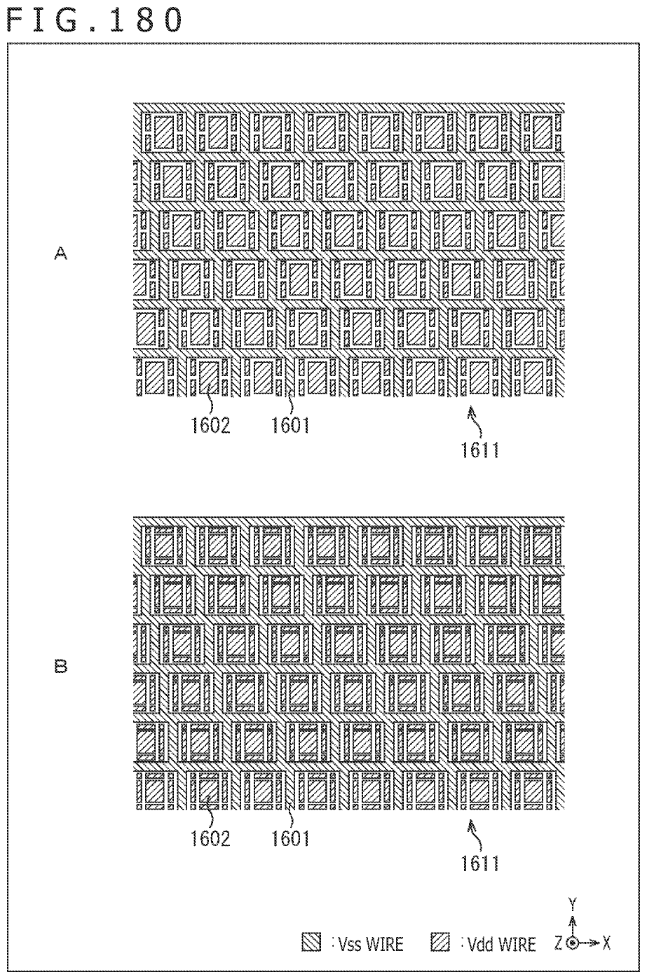

While each relay conductor 1602 is separated into two, three or four in the configuration examples explained with reference to FIG. 177 to FIG. 179, each relay conductor 1602 can be separated into any number of relay conductors such as five or more separated relay conductors. Each relay conductor 1602 is separated into five and nine in examples explained with reference to FIG. 180.

A in FIG. 180 is a plan view depicting a fifteenth modification example of the first displacement configuration example of a mesh conductor.

As compared with the pitch-displacement basic configuration example, the fifteenth modification example in A in FIG. 180 is different in that it has a configuration in which each relay conductor 1602 is separated into five. While the one middle region in the five separated regions is large in the example in A in FIG. 180, such a size relation and arrangement relation among the five regions are examples, and these are not the sole examples.

B in FIG. 180 is a plan view depicting a sixteenth modification example of the first displacement configuration example of a mesh conductor.

As compared with the pitch-displacement basic configuration example, the sixteenth modification example in B in FIG. 180 is different in that it has a configuration in which each relay conductor 1602 is separated into nine. While the one middle region in the nine separated regions is large in the example in B in FIG. 180, such a size relation and arrangement relation among the nine regions also are examples, and these are not the sole examples.

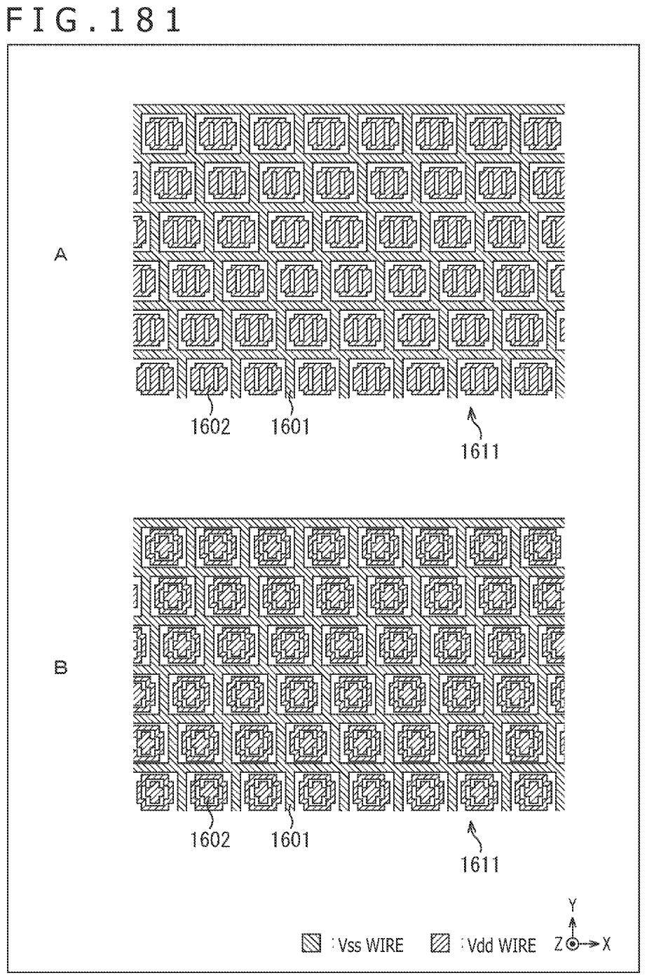

A in FIG. 181 is a plan view depicting a seventeenth modification example of the first displacement configuration example of a mesh conductor.

As compared with the pitch-displacement basic configuration example, the seventeenth modification example in A in FIG. 181 is different in that it has a configuration in which each relay conductor 1602 has one or more gaps (holes) therein. The number, positions and shapes of the gaps are not limited to those in this example.

B in FIG. 181 is a plan view depicting an eighteenth modification example of the first displacement configuration example of a mesh conductor.

As compared with the pitch-displacement basic configuration example, the eighteenth modification example in B in FIG. 181 is different in that it has a configuration in which each relay conductor 1602 includes an outer conductor surrounding an inner conductor. The number, positions and shapes of the conductors are not limited to those in this example.

As explained with reference to FIG. 173 to FIG. 181, relay conductors 1602 need not be arranged at the middles of gap regions of the mesh conductor 1601. Relay conductors 1602 may be arranged in an imbalanced manner in the X direction or the Y direction, for example, and multiple relay conductors 1602 may be arranged. In addition, relay conductors 1602 may be asymmetric in the X direction or the Y direction, may be symmetric in the X direction or the Y direction, and may be rotation-symmetric. Note that, regarding theoretical values of capacitive noise in each of the modification examples in FIG. 173 to FIG. 181, the change amount of capacitive noise is zero, and the absolute value of capacitive noise is zero, similarly to the case in which the pitch displacement PDX is 2A in the first displacement configuration example.

Note that no matter what type of shape relay conductors 1602 have or no matter how the relay conductors 1602 are arranged, the relay conductors 1602 are formed such that at least the first condition of complete offsetting mentioned above is satisfied.

In the first modification example to the eighteenth modification example depicted in FIG. 173 to FIG. 181, for example, the degree of freedom of designing, the degree of freedom of arrangement of other conductors, or some elements or objects inside gap regions are enhanced.

In addition, relay conductors 1602 may not be conductors to electrically connect another conductor layer and still another conductor layer, but may be non-mesh conductors which are conductors to not electrically connect another conductor layer and still another conductor layer. It should be noted however that relay conductors 1602 are desirably not non-mesh bodies to not electrically connect other conductor layers, but conductors to electrically relay other conductor layers. In a case in which they are relay conductors 1602, the degree of freedom of wiring layout for leading in a power supply is enhanced. In addition, voltage drops can be ameliorated further, depending on the arrangement of active elements such as MOS transistors or diodes. Furthermore, the presence of relay conductors 1602 ameliorates inductive noise, and the arrangement of the multiple relay conductors 1602 (separated arrangement, divided arrangement) further ameliorates the inductive noise, in some cases.

### Second Displacement Configuration Example of Mesh Conductor

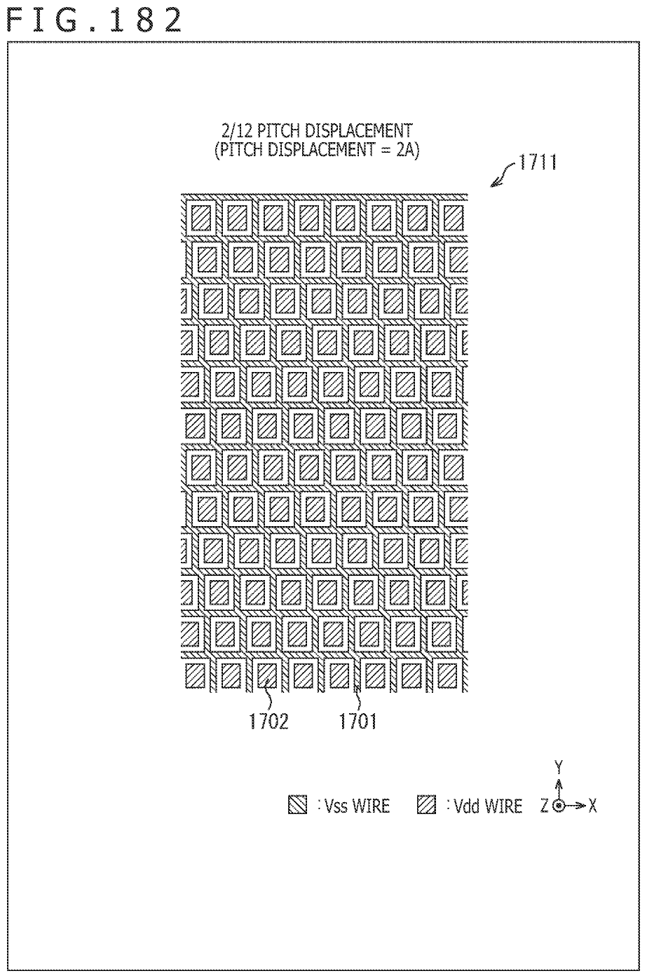

FIG. 182 is a plan view depicting a second displacement configuration example of a mesh conductor.

The second displacement configuration example of a mesh conductor depicts that the change amount of capacitive noise can be made zero even in a case in which some of the dimensions of the mesh conductor or relay conductors are modified.

A conductor layer 1711 in FIG. 182 includes a mesh conductor 1701 and relay conductors 1702.

The conductor layer 1711 in FIG. 182 has the dimensions of the Y-direction conductor width CDY, first gap width GDY1 and second gap width GDY2 of the relay conductors 1702 which are modified to have different values from those in the first displacement configuration example mentioned above.

Specifically, as depicted in FIG. 166, assuming that ½ of the X-direction conductor width WDX, and Y-direction conductor width WDY of the mesh conductor 1601 is the real number A, in the first displacement configuration example mentioned above, the Y-direction conductor width CDY of the relay conductors 1702 is set to 7A, and the first gap width GDY1 and the second gap width GDY2 are set to 1A.

In contrast, in the second displacement configuration example in FIG. 182, the Y-direction conductor width CDY of the relay conductors 1702 is set to 8A, and the first gap width GDY1 and the second gap width GDY2 are set to 2A.

In other words, while the Y-direction gap width GDY of the mesh conductor 1601 is 9A in the first displacement configuration example mentioned above, the gap width GDY is increased to 12A in the second displacement configuration example.

In the second displacement configuration example, the dimensions of other conductor widths and gap widths are similar to those in the first displacement configuration example. In the second displacement configuration example also, at least the first condition of complete offsetting mentioned above is satisfied.

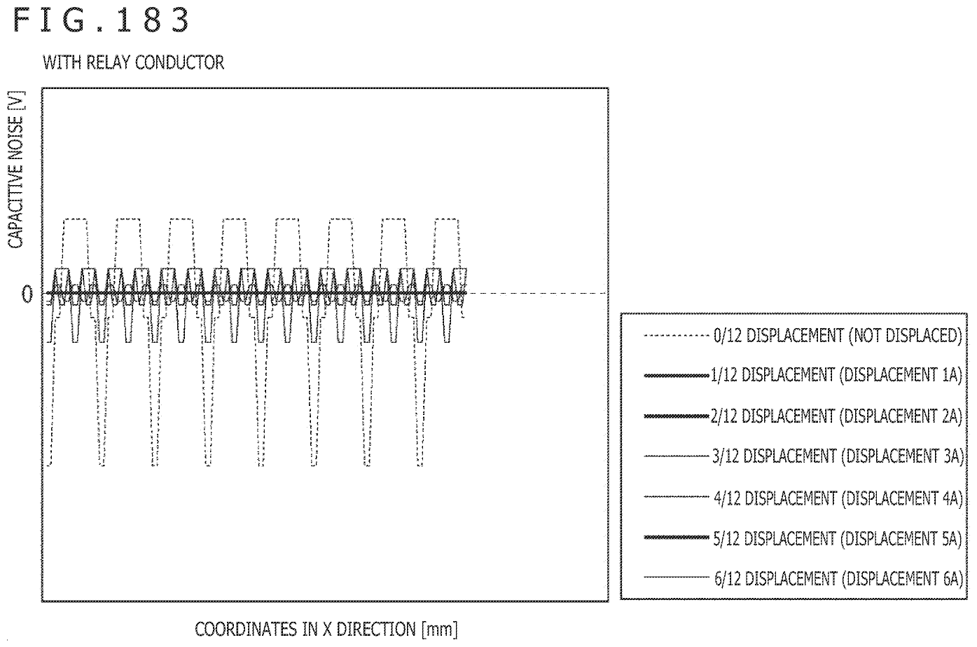

FIG. 183 is a graph depicting theoretical values of capacitive noise of the conductor layer 1711 with the pitch displacement PDX set to various values in the second displacement configuration example, similarly to the first displacement configuration example.

Because the horizontal axis and vertical axis in the graph in FIG. 183 are similar to those in FIG. 169, explanations thereof are omitted. Note that the graph in FIG. 183 also is depicted at the same scale as that of the graph in FIG. 169.

As depicted in FIG. 183, in the second displacement configuration example also, in a case in which the pitch displacement PDX is set to predetermined values, the change amount of capacitive noise becomes zero, and the absolute value of capacitive noise becomes zero. More specifically, in a case in which the pitch displacement PDX is set to 1/12, 2/12 or 5/12 of the X-direction repetition pitch, the change amount of capacitive noise becomes zero, and the absolute value of capacitive noise becomes zero.

In the case of the other values of the pitch displacement PDX, specifically, in a case in which the pitch displacement PDX is set to 3/12, 4/12 or 6/12 of the X-direction repetition pitch, the change amount and absolute value of capacitive noise do not become zero, but the change amount of capacitive noise can be made smaller than in a case in which the pitch displacement PDX is set to zero, that is, there is no pitch displacement.

In the second displacement configuration example in which the Y-direction dimension is increased, the capacitive noise in the case in which is represented by a broken line FIG. 183, and in which the pitch displacement PDX is set to zero, that is, there is no pitch displacement, worsens as compared with capacitive noise in a case in which there is no pitch displacement in the first displacement configuration example. It can be known from this that setting the pitch displacement PDX increases the amelioration effect.

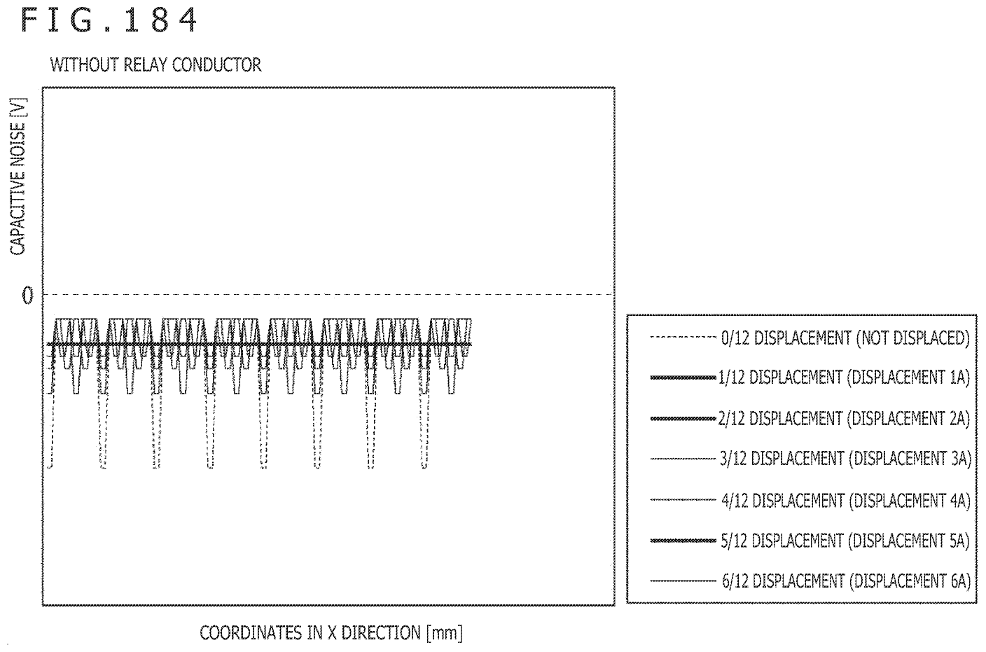

FIG. 184 is a graph depicting theoretical values of capacitive noise in a case in which there are no relay conductors 1702 in the second displacement configuration example.

Because the horizontal axis and vertical axis in the graph in FIG. 184 are similar to those in FIG. 169, explanations thereof are omitted. Note that the graph in FIG. 184 also is depicted at the same scale as that of the graph in FIG. 169.

While the absolute value of capacitive noise does not become zero in a case in which there are no relay conductors 1602 as depicted in FIG. 184, the change amount of capacitive noise becomes zero in a case in which the pitch displacement PDX is set to predetermined values. The displacement amounts that make the change amount of capacitive noise zero are the same as those in a case in which there are relay conductors 1602. That is, in a case in which the pitch displacement PDX is set to 1/12, 2/12 or 5/12 of the X-direction repetition pitch, the change amount of capacitive noise becomes zero.

According to the graphs in FIG. 183 and FIG. 184, a condition under which the change amount of capacitive noise becomes zero in the second displacement configuration example is similar to that in the first displacement configuration example.

That is, the pitch displacement PDX is set to a value that is different from the X-direction pitch width FDX (=12A) of the mesh conductor 1701.

In a case in which the pitch displacement PDX is 2A, that is, in a case in which the pitch displacement PDX is the same as the X-direction conductor width WDX of the mesh conductor 1701, the change amount of capacitive noise becomes zero. In addition, in a case in which the pitch displacement PDX is 1A, and in a case in which the pitch displacement PDX is 5A also, the change amount of capacitive noise becomes zero.

In a case in which the pitch displacement PDX is 1A or 5A, the change amount of capacitive noise becomes zero in a set of twelve rows. In contrast, in a case in which the pitch displacement PDX is 2A, the change amount of capacitive noise becomes zero in a set of six rows. In a case in which the pitch displacement PDX is equal to the conductor width WDX of the mesh conductor 1701, the change amount of capacitive noise can be made zero with a smaller number of rows, and so the degree of freedom of wiring layout can be increased.

In a case in which the pitch displacement PDX is different from 3/12 (=3A) of the X-direction repetition pitch of the mesh conductor 1701, in other words, in a case in which the pitch displacement PDX is not (pitch width FDX (=12A))/4, the change amount of capacitive noise becomes zero.

In a case in which the pitch displacement PDX is different from 4/12 (=4A) of the X-direction repetition pitch of the mesh conductor 1701, in other words, in a case in which the pitch displacement PDX is not (pitch width FDX (=12A))/3, the change amount of capacitive noise becomes zero.

In a case in which the pitch displacement PDX is different from 6/12 (=6A) of the X-direction repetition pitch of the mesh conductor 1701, in other words, in a case in which the pitch displacement PDX is not (pitch width FDX (=12A))/2, the change amount of capacitive noise becomes zero.

In a case in which there are relay conductors 1702, not only the change amount of capacitive noise becomes zero, but also the absolute value of capacitive noise can be made zero. In a case in which there are no relay conductors 1702, the change amount of capacitive noise becomes zero, but the absolute value of capacitive noise does not become zero.

In addition, a more significant capacitive-noise amelioration effect can be attained in a case in which there are relay conductors 1702 than in a case in which there are no relay conductors 1702.

### Third Displacement Configuration Example of Mesh Conductor

In the first and second displacement configuration examples mentioned above, the condition of the pitch displacement PDX under which the change amount of capacitive noise becomes zero is the same for a case in which there are relay conductors, and for a case in which there are no relay conductors.

Next, an example in which the condition of the pitch displacement PDX under which the change amount of capacitive noise becomes zero is different between a case in which there are relay conductors and a case in which there are no relay conductors is depicted as a third displacement configuration example.

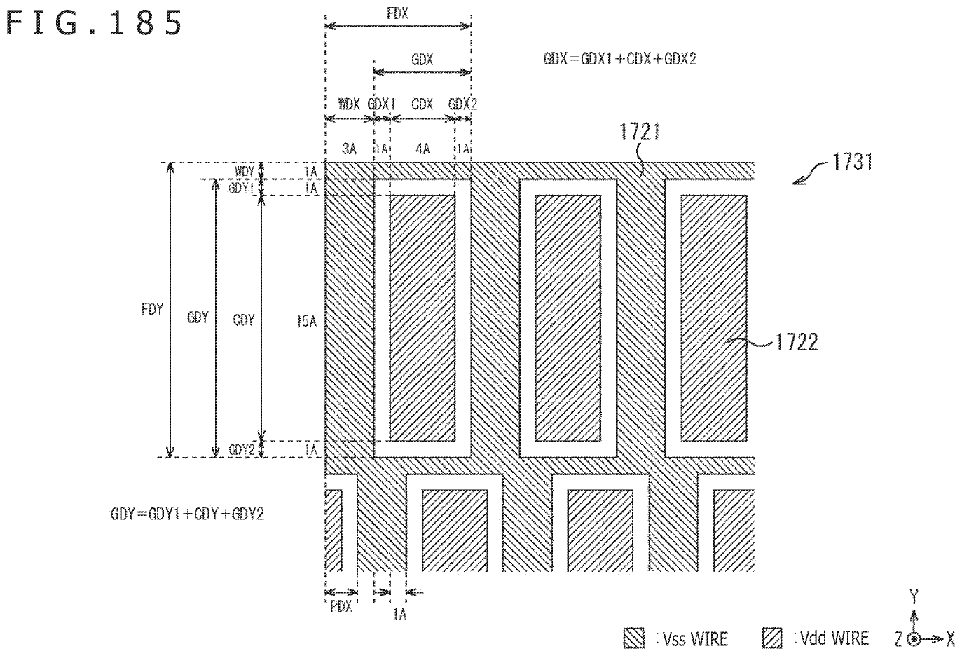

FIG. 185 is a plan view for explaining conductor widths and gap widths of a conductor layer as the third displacement configuration example of a mesh conductor.

A conductor layer 1731 in FIG. 185 includes a mesh conductor 1721 and relay conductors 1722.

Assuming that A is a real number, the mesh conductor 1721 has the conductor width WDX set to 3A and the conductor width WDY set to 1A. Gap regions of the mesh conductor 1721 are formed to have the gap width GDX set to 6A and the gap width GDY set to 17A.

Each relay conductor 1722 arranged in a gap region of the mesh conductor 1721 is a rectangle with the conductor width CDX set to 4A and the conductor width CDY set to 15A. The rectangle is a longitudinally long oblong rectangle with the Y-direction conductor width CDY larger than the X-direction conductor width CDX (CDY>CDX). Both the X-direction first gap width GDX1 and second gap width GDX2 between the mesh conductor 1721 and each relay conductor 1722 are set to 1A. In addition, both the Y-direction first gap width GDY1 and second gap width GDY2 are set to 1A.

Accordingly, if represented by using the real number A, the pitch width FDX (=(conductor width WDX)+(gap width GDX)) corresponds to 9A, and the pitch width FDY (=(conductor width WDY)+(gap width GDY)) corresponds to 18A. In the third displacement configuration example, the real number A is equal to ⅓ of the X-direction conductor width WDX of the mesh conductor 1721.

In the third displacement configuration example also, at least the first condition of complete offsetting mentioned above is satisfied.

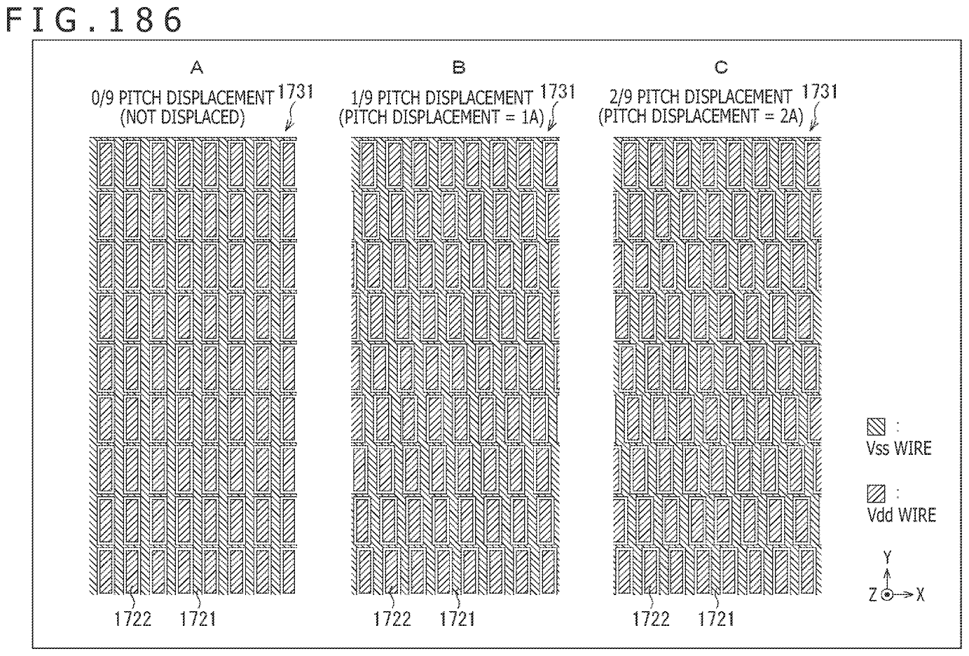

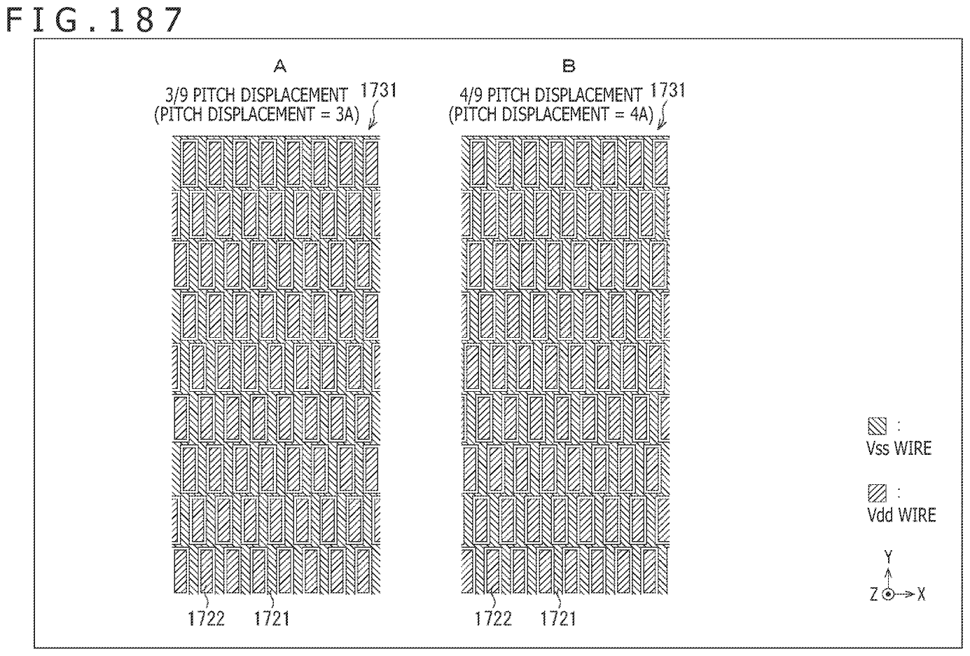

FIG. 186 and FIG. 187 are plan views in which the pitch displacement PDX is set to various values in the conductor layer 1731 as the third displacement configuration example of a mesh conductor.

A in FIG. 186 is a plan view of the conductor layer 1731 with the pitch displacement PDX set to zero.

B in FIG. 186 is a plan view of the conductor layer 1731 with the X-direction pitch displacement PDX set to 1A, that is, 1/9 of the X-direction repetition pitch (pitch width FDX).

C in FIG. 186 is a plan view of the conductor layer 1731 with the pitch displacement PDX set to 2A, that is, 2/9 of the X-direction repetition pitch (pitch width FDX).

A in FIG. 187 is a plan view of the conductor layer 1731 with the pitch displacement PDX set to 3A, that is, 3/9 of the X-direction repetition pitch (pitch width FDX).

B in FIG. 187 is a plan view of the conductor layer 1731 with the pitch displacement PDX set to 4A, that is, 4/9 of the X-direction repetition pitch (pitch width FDX).

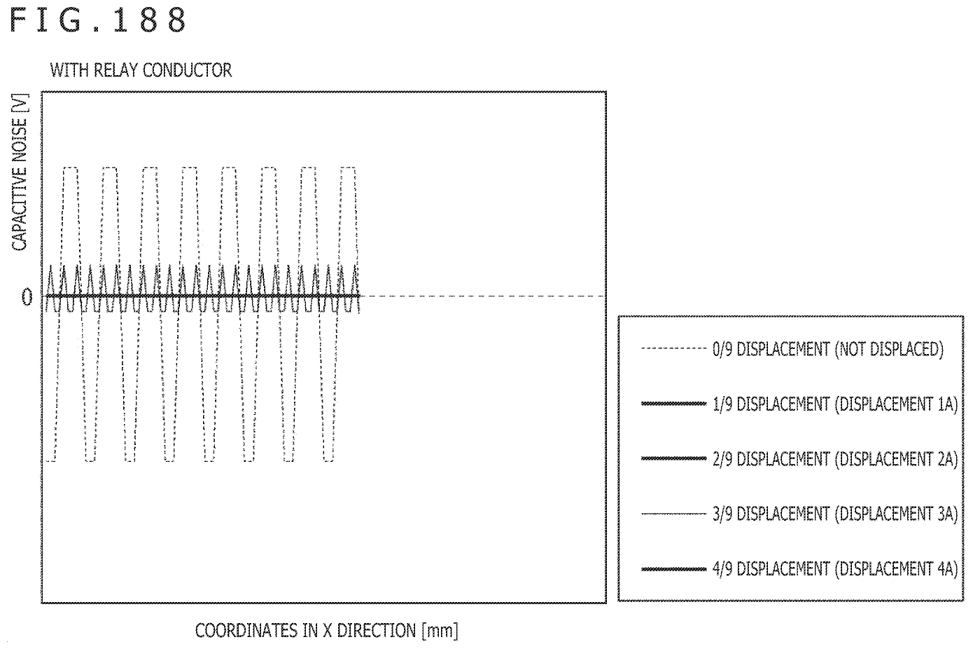

FIG. 188 is a graph depicting theoretical values of capacitive noise of the conductor layer 1731 with the pitch displacement PDX set to various values as in FIG. 186 and FIG. 187.

Because the horizontal axis and vertical axis in the graph in FIG. 188 are similar to those in FIG. 169, explanations thereof are omitted. Note that the graph in FIG. 188 also is depicted at the same scale as that of the graph in FIG. 169. It is assumed that conditions of a Vdd applied voltage and a Vss applied voltage also are similar.

As depicted in FIG. 188, in a case in which the pitch displacement PDX is set to predetermined values, the change amount of capacitive noise becomes zero, and the absolute value of capacitive noise becomes zero. More specifically, in a case in which the pitch displacement PDX is set to 1/9, 2/9 or 4/9 of the X-direction repetition pitch, the change amount of capacitive noise becomes zero, and the absolute value of capacitive noise becomes zero. In a case in which the pitch displacement PDX is set to 1/9 (=1A), 2/9 (=2A) or 4/9 (=4A) of the X-direction repetition pitch, the change amount of capacitive noise becomes zero in a set of nine rows.

In the case of the other value of the pitch displacement PDX, specifically, in a case in which the pitch displacement PDX is set to 3/9 of the X-direction repetition pitch, the change amount and absolute value of capacitive noise do not become zero, but the change amount of capacitive noise can be made smaller than in a case in which the pitch displacement PDX is set to zero, that is, there is no pitch displacement.

According to what is mentioned above, in the third displacement configuration example including relay conductors 1722, the change amount of capacitive noise can be made zero in the case of the following condition.

First, as a premise, the pitch displacement PDX is set to a value that is different from the X-direction pitch width FDX (=9A) of the mesh conductor 1721.

In a case in which the pitch displacement PDX is 1A, 2A or 4A, the change amount of capacitive noise becomes zero in a set of nine rows. In addition, in a case in which the pitch displacement PDX is different from 3/9 (=3A) of the X-direction repetition pitch of the mesh conductor 1721, in other words, in a case in which the pitch displacement PDX is not (pitch width FDX (=9A))/3, the change amount of capacitive noise becomes zero.

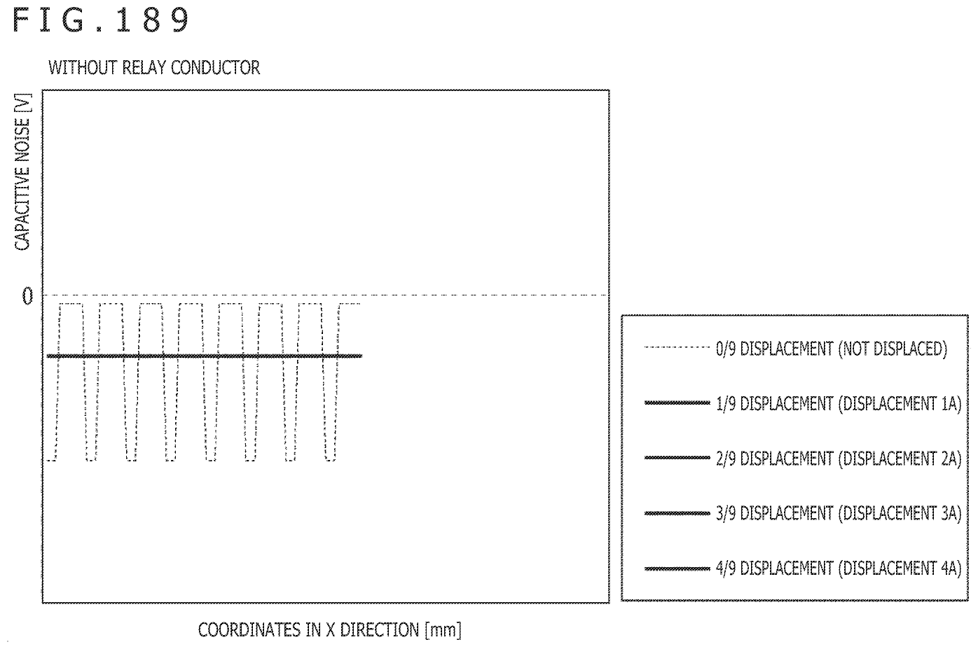

FIG. 189 is a graph depicting theoretical values of capacitive noise in a case in which the pitch displacement PDX is set to various values in the conductor layer 1731 from which relay conductors 1722 are omitted. Although an illustration of the conductor layer 1731 from which relay conductors 1722 are omitted is omitted, the conductor layer 1731 corresponds to one from which relay conductors 1722 are removed from each conductor layer 1731 in FIG. 186 and FIG. 187.

While the absolute value of capacitive noise does not become zero in a case in which there are no relay conductors 1722 as depicted in FIG. 189, the change amount of capacitive noise becomes zero in a case in which the pitch displacement PDX is set to predetermined values. The displacement amounts that make the change amount of capacitive noise zero are different from those in a case in which there are relay conductors 1722. Specifically, in a case in which the pitch displacement PDX is set to 1/9, 2/9, 3/9, or 4/9 of the X-direction repetition pitch, the change amount of capacitive noise becomes zero. In a case in which the pitch displacement PDX is set to 1/9 (=1A), 2/9 (=2A), or 4/9 (=4A) of the X-direction repetition pitch, the change amount of capacitive noise becomes zero in a set of nine rows. In a case in which the pitch displacement PDX is set to 3/9 (=3A) of the X-direction repetition pitch, the change amount of capacitive noise becomes zero in a set of three rows.

According to what is mentioned above, in the third displacement configuration example not including relay conductors 1722, the change amount of capacitive noise can be made zero in the case of the following condition.

First, as a premise, the pitch displacement PDX is set to a value that is different from the X-direction pitch width FDX (=9A) of the mesh conductor 1721.

In a case in which the pitch displacement PDX is 1A, 2A or 4A, the change amount of capacitive noise becomes zero in a set of nine rows. In addition, in a case in which the pitch displacement PDX is the same as 3/9 (=3A) of the X-direction repetition pitch of the mesh conductor 1721, the change amount of capacitive noise becomes zero in a set of three rows.

Accordingly, in a case in which the pitch displacement PDX is set to be the same as (conductor width WDX)=3A of the mesh conductor 1721 in the third displacement configuration example, the change amount of capacitive noise does not become zero in a case in which there are relay conductors 1722, but the change amount of capacitive noise becomes zero in a case in which there are no relay conductors 1722. That is, in the third displacement configuration example, the condition of the pitch displacement PDX under which the change amount of capacitive noise becomes zero is different between a case in which there are relay conductors 1722 and a case in which there are no relay conductors 1722.

In a case in which, regarding the mesh conductor 1721, an integer multiple of the conductor width WDX, and the pitch width FDX match, and the pitch displacement PDX, and the conductor width WDX match due to the shape relation between the conductor section and gap regions of the mesh conductor 1721, capacitive noise is dispersed evenly, and so the change amount of capacitive noise can be made zero when there are no relay conductors 1722.

### Fourth Displacement Configuration Example of Mesh Conductor

Relay conductors have longitudinally long shapes which are longer in the Y direction than in the X direction in the examples explained in the first to third displacement configuration examples mentioned above.

Relay conductors have laterally long shapes which are shorter in the Y direction than in the X direction in an example depicted next as a fourth displacement configuration example.

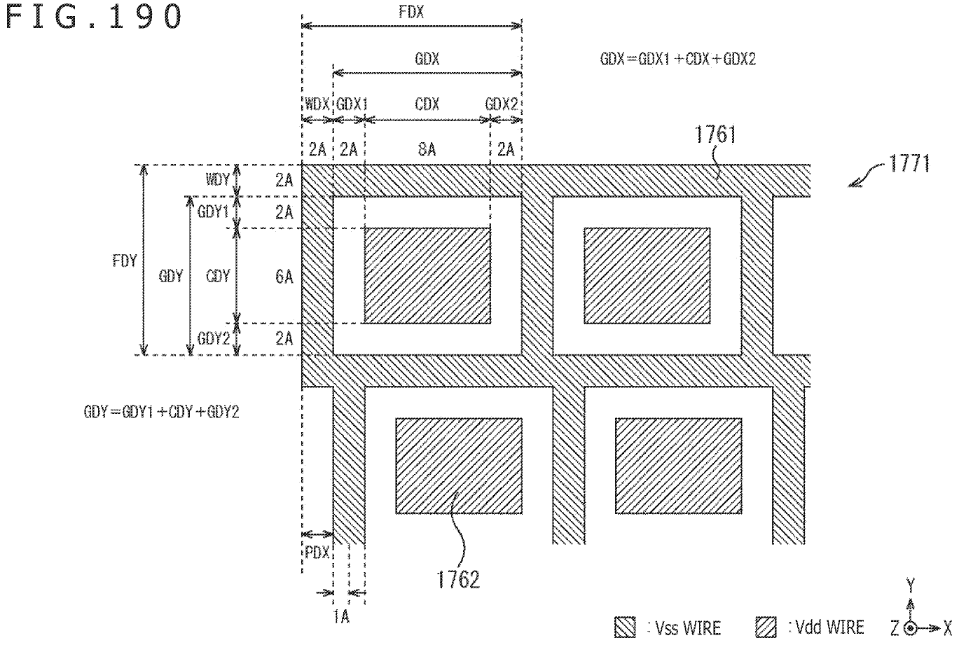

FIG. 190 is a plan view for explaining conductor widths and gap widths of a conductor layer as the fourth displacement configuration example of a mesh conductor.

A conductor layer 1771 in FIG. 190 includes a mesh conductor 1761 and relay conductors 1762.

Assuming that A is a real number, the mesh conductor 1761 has the conductor width WDX set to 2A and the conductor width WDY set to 2A. Gap regions of the mesh conductor 1761 are formed to have the gap width GDX set to 12A and the gap width GDY set to 10A.

Each relay conductor 1762 arranged in a gap region of the mesh conductor 1761 is a rectangle with the conductor width CDX set to 8A and the conductor width CDY set to 6A. The rectangle is a laterally long oblong rectangle with the X-direction conductor width CDX larger than the Y-direction conductor width CDY (CDX>CDY). Both the X-direction first gap width GDX1 and second gap width GDX2 between the mesh conductor 1761 and each relay conductor 1762 are set to 2A. In addition, both the Y-direction first gap width GDY1 and second gap width GDY2 are set to 2A.

Accordingly, if represented by using the real number A, the pitch width FDX (=(conductor width WDX)+(gap width GDX)) corresponds to 14A, and the pitch width FDY (=(conductor width WDY)+(gap width GDY)) corresponds to 12A. In the fourth displacement configuration example, the real number A is equal to ½ of the X-direction conductor width WDX of the mesh conductor 1761.

In the fourth displacement configuration example also, at least the first condition of complete offsetting mentioned above is satisfied.

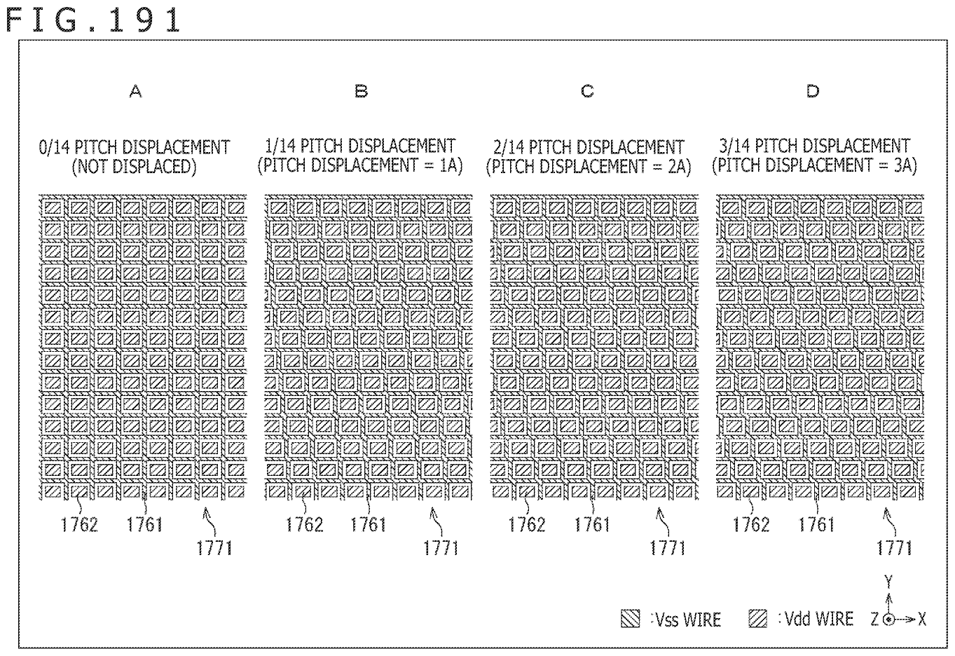

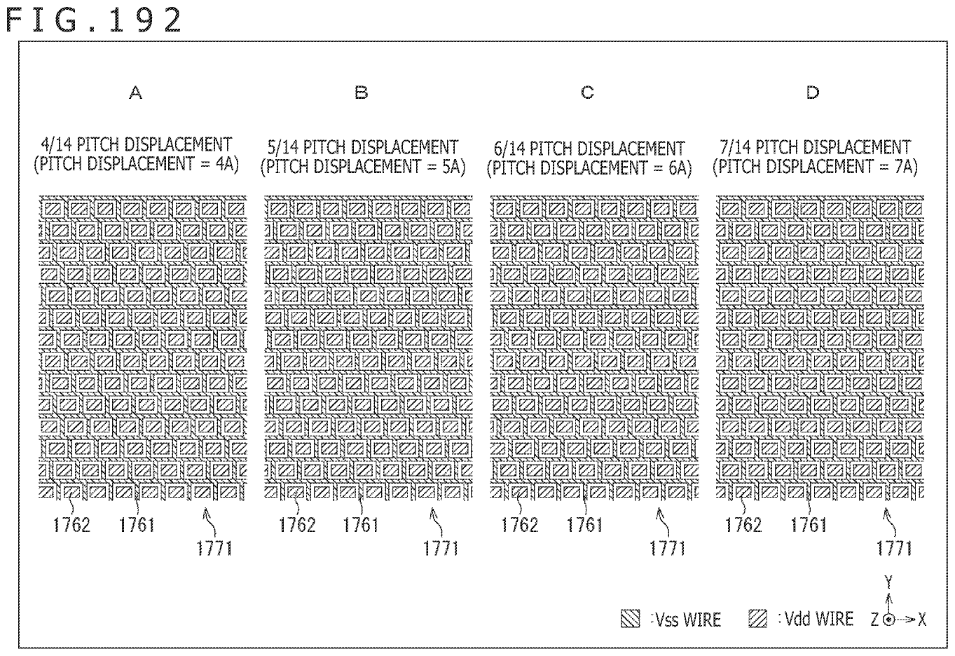

FIG. 191 and FIG. 192 are plan views in which the pitch displacement PDX is set to various values in the conductor layer 1771 as the fourth displacement configuration example of a mesh conductor.

A in FIG. 191 is a plan view of the conductor layer 1771 with the pitch displacement PDX set to zero.

B in FIG. 191 is a plan view of the conductor layer 1771 with the X-direction pitch displacement PDX set to 1A, that is, 1/14 of the X-direction repetition pitch (pitch width FDX).

C in FIG. 191 is a plan view of the conductor layer 1771 with the pitch displacement PDX set to 2A, that is, 2/14 of the X-direction repetition pitch (pitch width FDX).

D in FIG. 191 is a plan view of the conductor layer 1771 with the pitch displacement PDX set to 3A, that is, 3/14 of the X-direction repetition pitch (pitch width FDX).

A in FIG. 192 is a plan view of the conductor layer 1771 with the pitch displacement PDX set to 4A, that is, 4/14 of the X-direction repetition pitch (pitch width FDX).

B in FIG. 192 is a plan view of the conductor layer 1771 with the pitch displacement PDX set to 5A, that is, 5/14 of the X-direction repetition pitch (pitch width FDX).

C in FIG. 192 is a plan view of the conductor layer 1771 with the pitch displacement PDX set to 6A, that is, 6/14 of the X-direction repetition pitch (pitch width FDX).

D in FIG. 192 is a plan view of the conductor layer 1771 with the pitch displacement PDX set to 7A, that is, 7/14 of the X-direction repetition pitch (pitch width FDX).

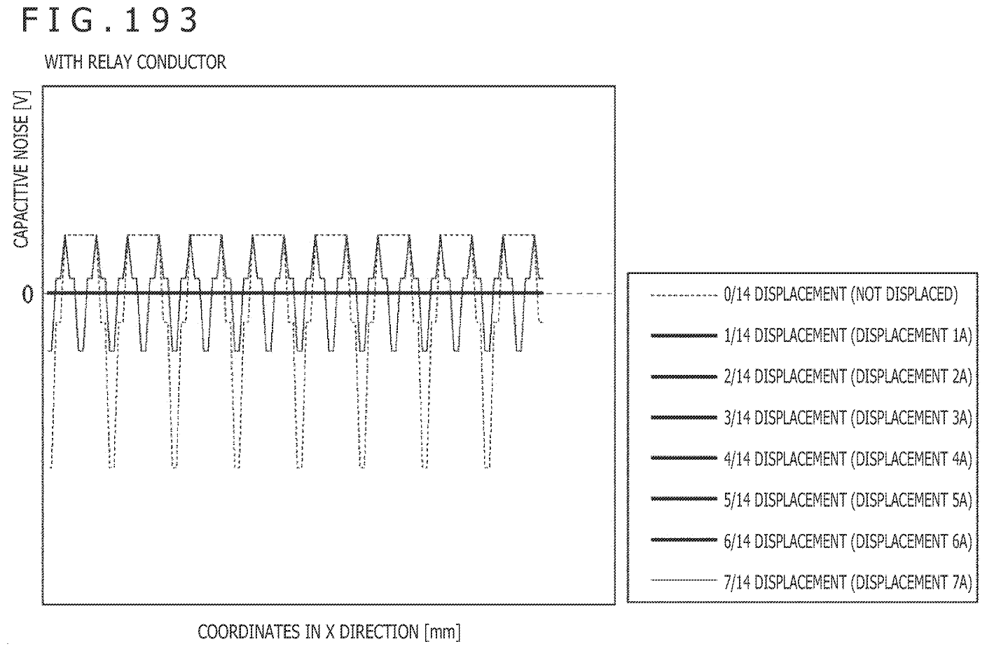

FIG. 193 is a graph depicting theoretical values of capacitive noise of the conductor layer 1771 with the pitch displacement PDX set to various values as in FIG. 191 and FIG. 192.

Because the horizontal axis and vertical axis in the graph in FIG. 193 are similar to those in FIG. 169, explanations thereof are omitted. Note that the graph in FIG. 169 also is depicted at the same scale as that of the graph in FIG. 193. It is assumed that conditions of a Vdd applied voltage and a Vss applied voltage also are similar.

As depicted in FIG. 193, in a case in which the pitch displacement PDX is set to predetermined values, the change amount of capacitive noise becomes zero, and the absolute value of capacitive noise becomes zero. More specifically, in a case in which the pitch displacement PDX is set to 1/14, 2/14, 3/14, 4/14, 5/14, or 6/14 of the X-direction repetition pitch, the change amount of capacitive noise becomes zero, and the absolute value of capacitive noise becomes zero.

In a case in which the pitch displacement PDX is set to 1/14 (=1A), 3/14 (=3A), or 5/14 (=5A) of the X-direction repetition pitch, the change amount of capacitive noise becomes zero and becomes the absolute value of capacitive noise in a set of fourteen rows.

In a case in which the pitch displacement PDX is set to 2/14 (=2A), 4/14 (=4A), or 6/14 (=6A) of the X-direction repetition pitch, the change amount of capacitive noise becomes zero and becomes the absolute value of capacitive noise in a set of seven rows. This means that, in addition to a case in which the pitch displacement PDX is equal to the conductor width WDX of the mesh conductor 1721, in a case in which the pitch displacement PDX is equal to an integer multiple of the conductor width WDX also, the change amount of capacitive noise becomes zero and becomes the absolute value of capacitive noise with a small number of rows. In a case in which an integer multiple of the conductor width WDX does not match (pitch width FDX (=14A))/3, and (pitch width FDX (=14A))/4, in a case in which the pitch displacement PDX is equal to an integer multiple of the conductor width WDX also, the change amount of capacitive noise becomes zero and becomes the absolute value of capacitive noise with a small number of rows.

In the case of the other value of the pitch displacement PDX, specifically, in a case in which the pitch displacement PDX is set to 7/14 of the X-direction repetition pitch, the change amount and absolute value of capacitive noise do not become zero, but the change amount of capacitive noise can be made smaller than in a case in which the pitch displacement PDX is set to zero, that is, there is no pitch displacement.

According to what is mentioned above, in the fourth displacement configuration example including relay conductors 1762, the change amount of capacitive noise can be made zero in the case of the following condition.

First, as a premise, the pitch displacement PDX is set to a value that is different from the X-direction pitch width FDX (=14A) of the mesh conductor 1761.

In a case in which the pitch displacement PDX is 2A, that is, in a case in which the pitch displacement PDX is the same as the X-direction conductor width WDX of the mesh conductor 1761, the change amount and absolute value of capacitive noise become zero. In addition, in a case in which the pitch displacement PDX is 1A, 3A, 4A, 5A, or 6A also, the change amount and absolute value of capacitive noise become zero.

Putting it in the other way around, in a case in which the pitch displacement PDX is different from 7/14 (=7A) of the X-direction repetition pitch of the mesh conductor 1761, in other words, in a case in which the pitch displacement PDX is not (pitch width FDX (=14A))/2, the change amount and absolute value of capacitive noise become zero.

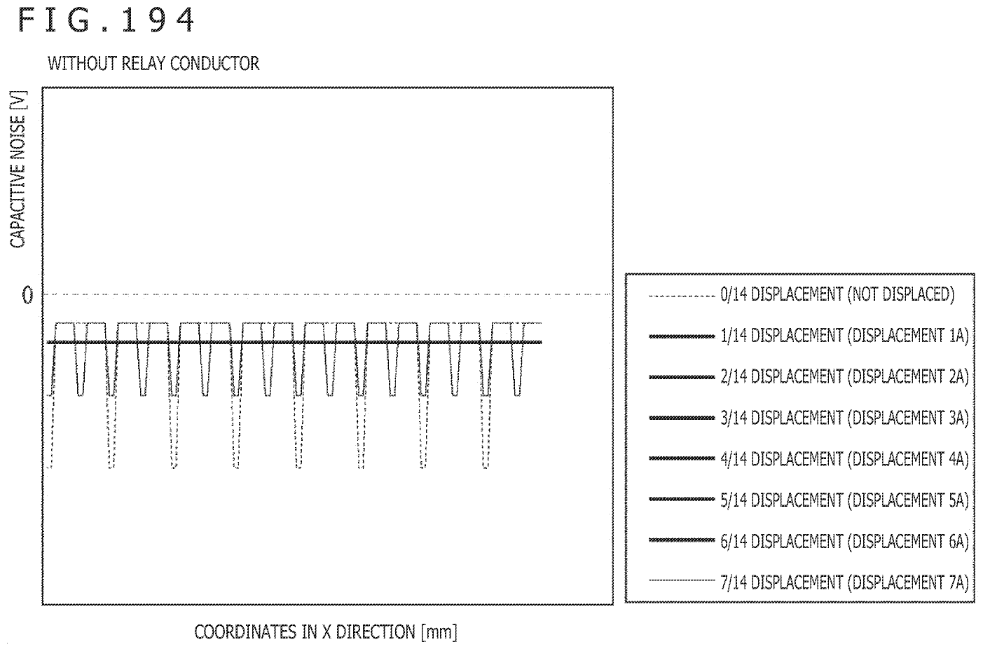

FIG. 194 is a graph depicting theoretical values of capacitive noise in a case in which the pitch displacement PDX is set to various values in the conductor layer 1771 from which relay conductors 1762 are omitted. Although an illustration of the conductor layer 1771 from which relay conductors 1762 are omitted is omitted, the conductor layer 1771 corresponds to one from which relay conductors 1762 are removed from each conductor layer 1771 in FIG. 191 and FIG. 192.

As depicted in FIG. 194, in a case in which there are no relay conductors 1762 also, the displacement amounts that make the change amount of capacitive noise zero are the same as those in a case in which there are relay conductors 1762. It should be noted however that the absolute value of capacitive noise does not become zero.

According to what is mentioned above, in the fourth displacement configuration example not including relay conductors 1762, the change amount of capacitive noise can be made zero in the case of the following condition.

First, as a premise, the pitch displacement PDX is set to a value that is different from the X-direction pitch width FDX (=14A) of the mesh conductor 1761.

In a case in which the pitch displacement PDX is 2A, that is, in a case in which the pitch displacement PDX is the same as the X-direction conductor width WDX of the mesh conductor 1761, the change amount of capacitive noise becomes zero. In addition, in a case in which the pitch displacement PDX is 1A, 3A, 4A, 5A, or 6A also, the change amount of capacitive noise becomes zero.

Putting it in the other way around, in a case in which the pitch displacement PDX is different from 7/14 (=7A) of the X-direction repetition pitch of the mesh conductor 1761, in other words, in a case in which the pitch displacement PDX is not (pitch width FDX (=14A))/2, the change amount of capacitive noise becomes zero.

### Fifth Displacement Configuration Example of Mesh Conductor

The X-direction conductor width WDX of the mesh conductor is large in an example depicted next as a fifth displacement configuration example.

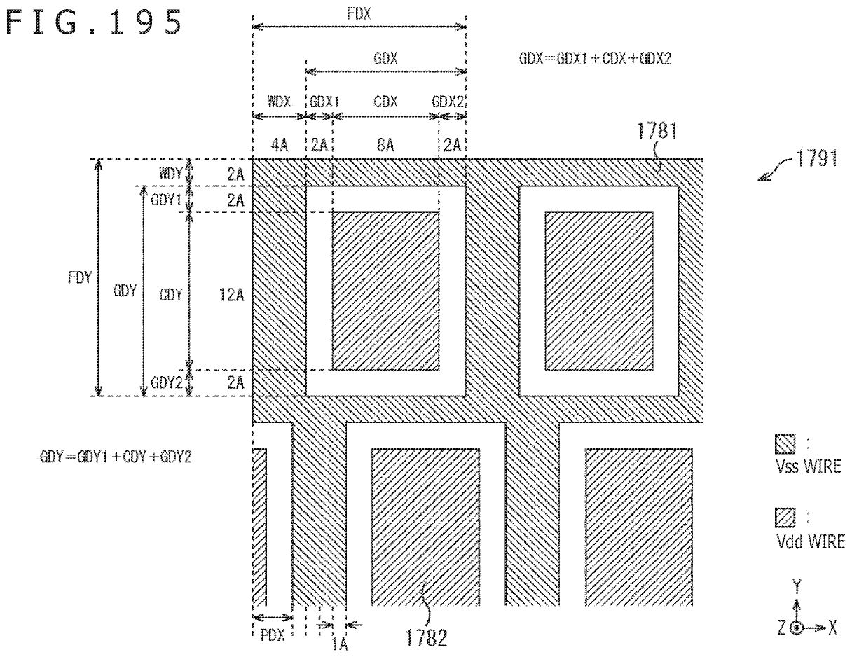

FIG. 195 is a plan view for explaining conductor widths and gap widths of a conductor layer as the fifth displacement configuration example of a mesh conductor.

A conductor layer 1791 in FIG. 195 includes a mesh conductor 1781 and relay conductors 1782.

Assuming that A is a real number, the mesh conductor 1781 has the conductor width WDX set to 4A and the conductor width WDY set to 2A. Gap regions of the mesh conductor 1781 are formed to have the gap width GDX set to 12A and the gap width GDY set to 16A.

Each relay conductor 1782 arranged in a gap region of the mesh conductor 1781 is a rectangle with the conductor width CDX set to 8A and the conductor width CDY set to 12A. The rectangle is a longitudinally long oblong rectangle with the Y-direction conductor width CDY larger than the X-direction conductor width CDX (CDY>CDX). Both the X-direction first gap width GDX1 and second gap width GDX2 between the mesh conductor 1781 and each relay conductor 1782 are set to 2A. In addition, both the Y-direction first gap width GDY1 and second gap width GDY2 are set to 2A.

Accordingly, if represented by using the real number A, the pitch width FDX (=(conductor width WDX)+(gap width GDX)) corresponds to 16A, and the pitch width FDY (=(conductor width WDY)+(gap width GDY)) corresponds to 18A. In the fifth displacement configuration example, the real number A is equal to ¼ of the X-direction conductor width WDX of the mesh conductor 1781.

In the fifth displacement configuration example also, at least the first condition of complete offsetting mentioned above is satisfied.

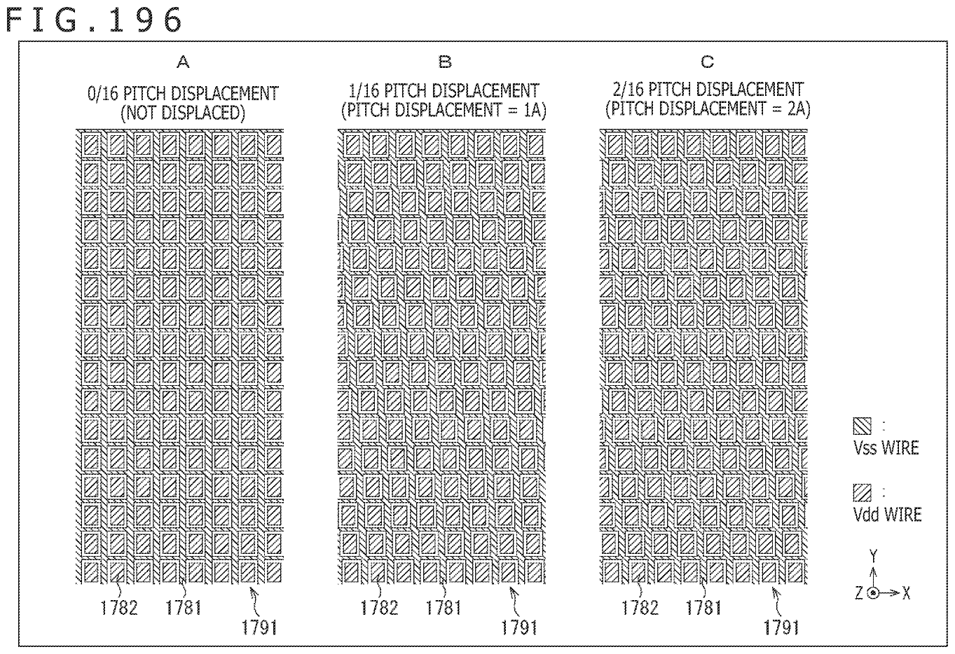

FIG. 196 to FIG. 198 are plan views in which the pitch displacement PDX is set to various values in the conductor layer 1791 as the fifth displacement configuration example of a mesh conductor.

A in FIG. 196 is a plan view of the conductor layer 1791 with the pitch displacement PDX set to zero.

B in FIG. 196 is a plan view of the conductor layer 1791 with the X-direction pitch displacement PDX set to 1A, that is, 1/16 of the X-direction repetition pitch (pitch width FDX).

C in FIG. 196 is a plan view of the conductor layer 1791 with the pitch displacement PDX set to 2A, that is, 2/16 of the X-direction repetition pitch (pitch width FDX).

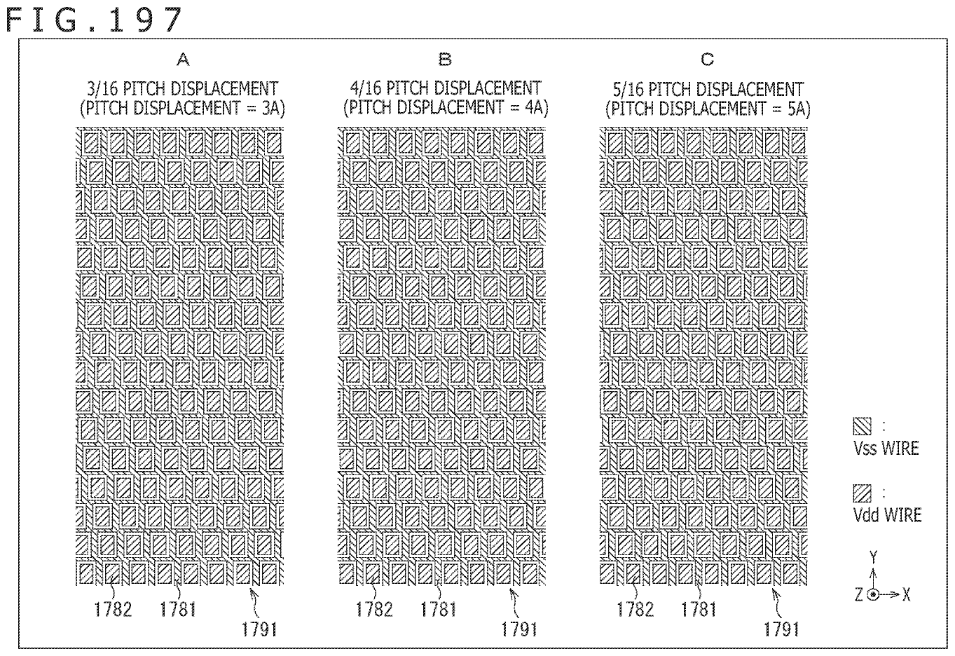

A in FIG. 197 is a plan view of the conductor layer 1791 with the pitch displacement PDX set to 3A, that is, 3/16 of the X-direction repetition pitch (pitch width FDX).

B in FIG. 197 is a plan view of the conductor layer 1791 with the pitch displacement PDX set to 4A, that is, 4/16 of the X-direction repetition pitch (pitch width FDX).

C in FIG. 197 is a plan view of the conductor layer 1791 with the pitch displacement PDX set to 5A, that is, 5/16 of the X-direction repetition pitch (pitch width FDX).

A in FIG. 198 is a plan view of the conductor layer 1791 with the pitch displacement PDX set to 6A, that is, 6/16 of the X-direction repetition pitch (pitch width FDX).

B in FIG. 198 is a plan view of the conductor layer 1791 with the pitch displacement PDX set to 7A, that is, 7/16 of the X-direction repetition pitch (pitch width FDX).

C in FIG. 198 is a plan view of the conductor layer 1791 with the pitch displacement PDX set to 8A, that is, 8/16 of the X-direction repetition pitch (pitch width FDX).

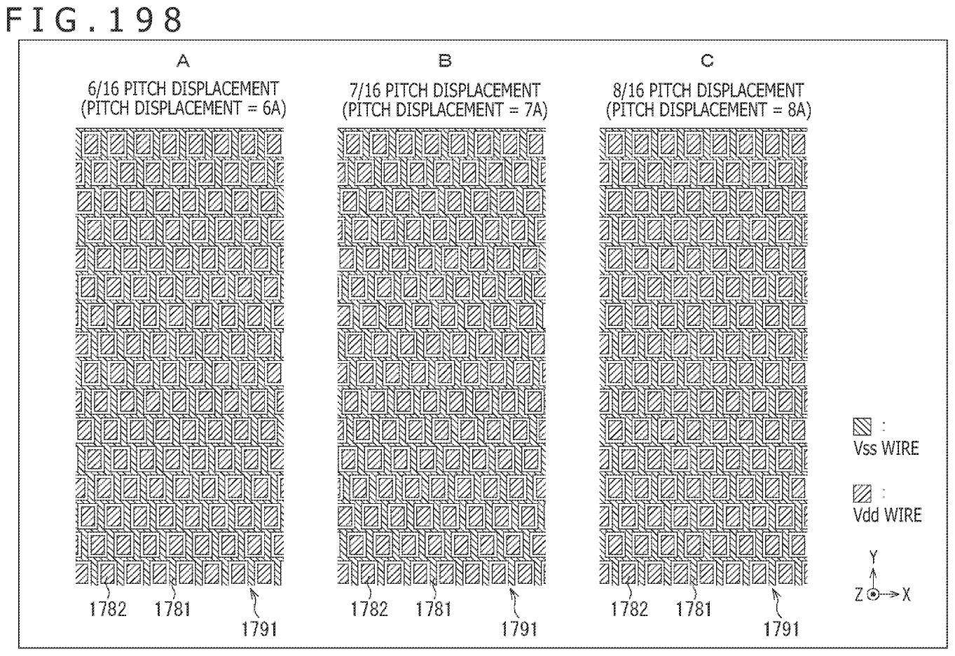

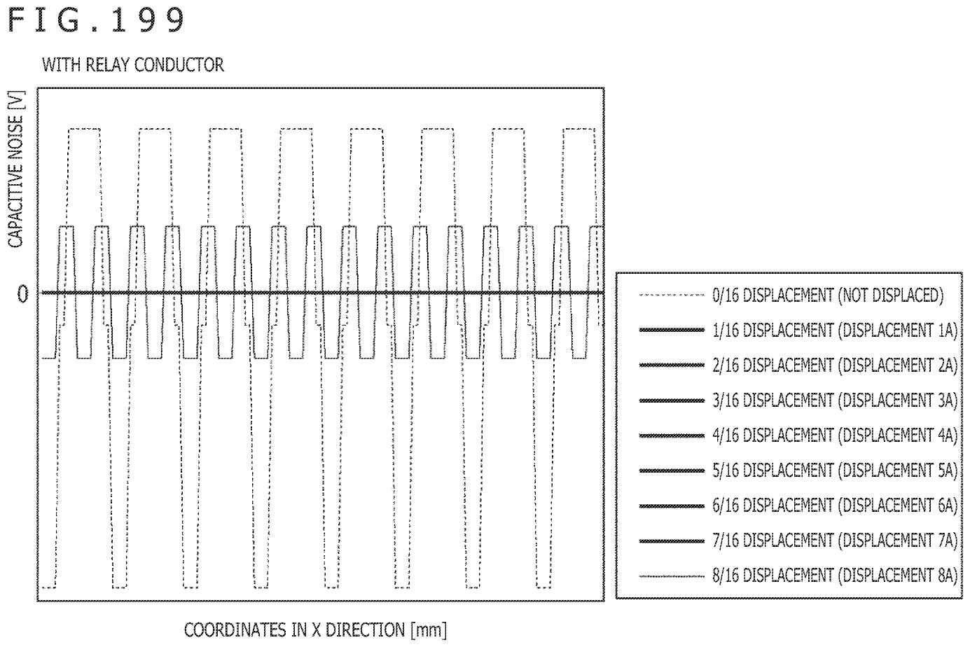

FIG. 199 is a graph depicting theoretical values of capacitive noise of the conductor layer 1771 with the pitch displacement PDX set to various values as in FIG. 196 to FIG. 198.

Because the horizontal axis and vertical axis in the graph in FIG. 199 are similar to those in FIG. 169, explanations thereof are omitted. Note that the graph in FIG. 199 also is depicted at the same scale as that of the graph in FIG. 169. It is assumed that conditions of a Vdd applied voltage and a Vss applied voltage also are similar.

As depicted in FIG. 199, in a case in which the pitch displacement PDX is set to predetermined values, the change amount of capacitive noise becomes zero, and the absolute value of capacitive noise becomes zero. More specifically, in a case in which the pitch displacement PDX is set to 1/16 (=1A), 2/16 (=2A), 3/16 (=3A), 4/16 (=4A), 5/16 (=5A), 6/16 (=6A), or 7/16 (=7A) of the X-direction repetition pitch, the change amount of capacitive noise becomes zero, and the absolute value of capacitive noise becomes zero.

Putting it in the other way around, in a case in which the pitch displacement PDX is different from 8/16 (=8A) of the X-direction repetition pitch of the mesh conductor 1781, in other words, in a case in which the pitch displacement PDX is not (pitch width FDX (=16A))/2, the change amount and absolute value of capacitive noise become zero.

In a case in which the pitch displacement PDX is set to 1/16 (=1A), 3/16 (=3A), 5/16 (=5A), or 7/16 (=7A) of the X-direction repetition pitch, the change amount of capacitive noise becomes zero and becomes the absolute value of capacitive noise in a set of sixteen rows.

In a case in which the pitch displacement PDX is set to 2/16 (=2A) or 6/16 (=6A) of the X-direction repetition pitch, the change amount of capacitive noise becomes zero and becomes the absolute value of capacitive noise in a set of eight rows.

In a case in which the pitch displacement PDX is set to 4/16 (=4A) of the X-direction repetition pitch, the change amount of capacitive noise becomes zero and becomes the absolute value of capacitive noise in a set of four rows.

In the case of the other value of the pitch displacement PDX, specifically, in a case in which the pitch displacement PDX is set to 8/16 of the X-direction repetition pitch, the change amount and absolute value of capacitive noise do not become zero, but the change amount of capacitive noise can be made smaller than in a case in which the pitch displacement PDX is set to zero, that is, there is no pitch displacement.

According to what is mentioned above, in the fifth displacement configuration example including relay conductors 1762, the change amount of capacitive noise can be made zero in the case of the following condition.

First, as a premise, the pitch displacement PDX is set to a value that is different from the X-direction pitch width FDX (=16A) of the mesh conductor 1781.

In a case in which the pitch displacement PDX is 4A, that is, in a case in which the pitch displacement PDX is the same as the X-direction conductor width WDX of the mesh conductor 1781, the change amount and absolute value of capacitive noise become zero.

In addition, in a case in which the pitch displacement PDX is 2A or 6A also, the change amount and absolute value of capacitive noise become zero. In a case in which the pitch displacement PDX is set to 2A, the pitch displacement PDX is equal to 100% of half of the conductor width WDX. In a case in which the pitch displacement PDX is set to 6A, the pitch displacement PDX is equal to 300% of half of the conductor width WDX. Moreover, in a case in which the pitch displacement PDX is set to 4A, the pitch displacement PDX is equal to 200% of half of the conductor width WDX.

In a case in which the X-direction conductor width WDX of the mesh conductor is set narrow as in the fourth displacement configuration example mentioned above, the change amount of capacitive noise becomes zero, and the absolute value of capacitive noise in a case in which the pitch displacement PDX is equal to an integer multiple of the conductor width WDX of the mesh conductor 1721.

In contrast, in a case in which the X-direction conductor width WDX of the mesh conductor is set wide, the change amount of capacitive noise becomes zero, and the absolute value of capacitive noise in a case in which the pitch displacement PDX is equal to an integer multiple of half of the conductor width WDX of the mesh conductor 1721.

In this manner, in a case in which the pitch displacement PDX is equal not only to an integer multiple of the conductor width WDX, but also to an integer multiple of half of the conductor width WDX, the change amount and absolute value of capacitive noise become zero, in some cases.

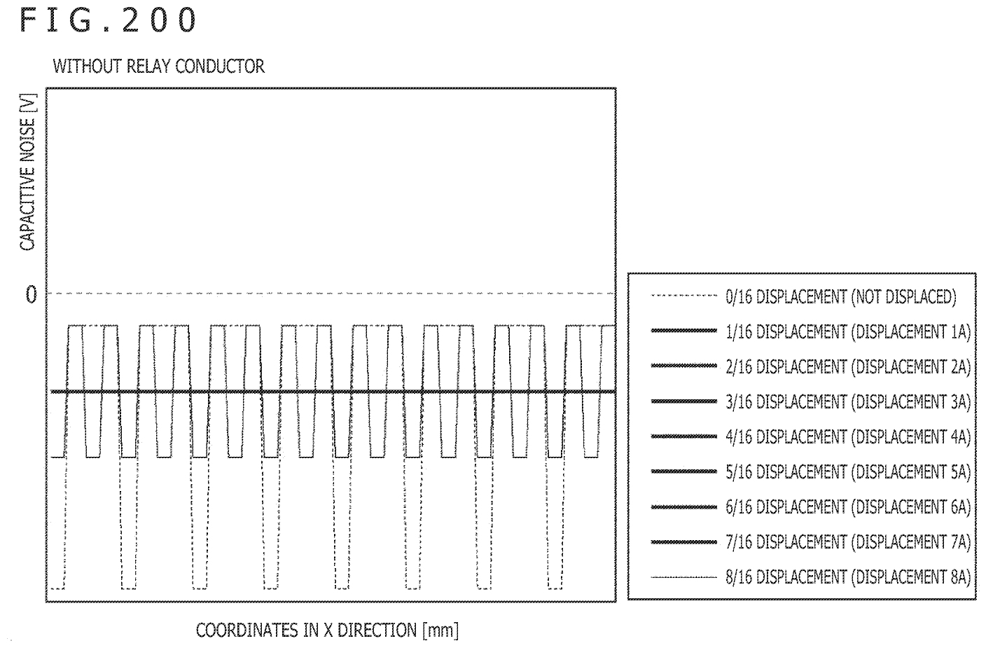

FIG. 200 is a graph depicting theoretical values of capacitive noise in a case in which the pitch displacement PDX is set to various values in the conductor layer 1791 from which relay conductors 1782 are omitted. Although an illustration of the conductor layer 1791 from which relay conductors 1782 are omitted is omitted, the conductor layer 1791 corresponds to one from which relay conductors 1782 are removed from each conductor layer 1791 in FIG. 196 to FIG. 198.

As depicted in FIG. 200, in a case in which there are no relay conductors 1782 also, the displacement amounts that make the change amount of capacitive noise zero are the same as those in a case in which there are relay conductors 1782. It should be noted however that the absolute value of capacitive noise does not become zero.

### Sixth Displacement Configuration Example of Mesh Conductor

In the examples explained in the first to fifth displacement configuration example mentioned above, if attention is paid to the relation between the X-direction conductor width WDX and gap width GDX of the mesh conductor, the gap width GDX is larger than the conductor width WDX ((gap width GDX)>(conductor width WDX)).

In the example explained in the next sixth displacement configuration example, the gap width GDX is smaller than the conductor width WDX ((gap width GDX)<(conductor width WDX)).

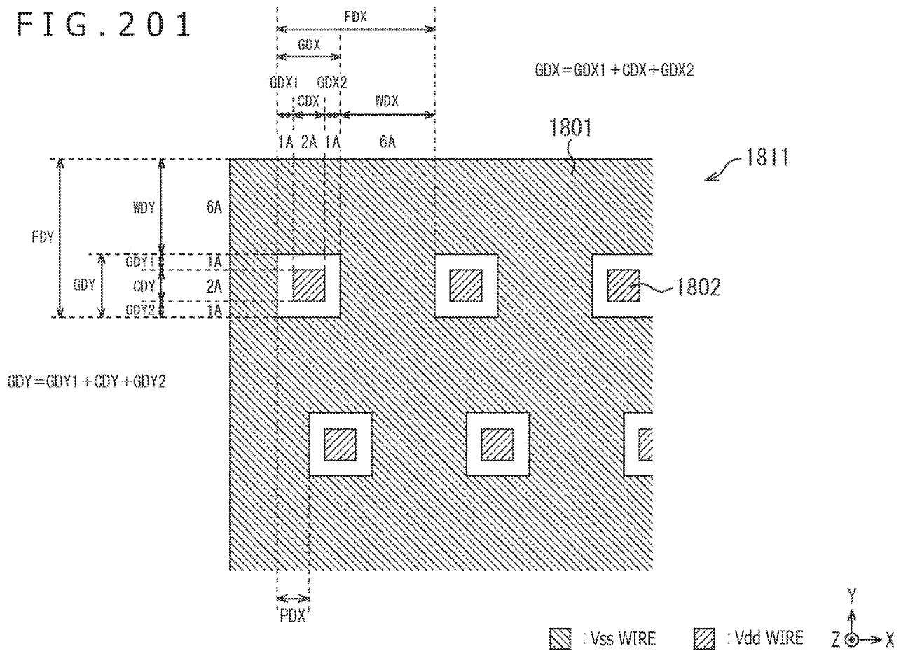

FIG. 201 is a plan view for explaining conductor widths and gap widths of a conductor layer as the sixth displacement configuration example of a mesh conductor.

A conductor layer 1811 in FIG. 201 includes a mesh conductor 1801 and relay conductors 1802.

Assuming that A is a real number, the mesh conductor 1801 has the conductor width WDX set to 6A and the conductor width WDY set to 6A. Gap regions of the mesh conductor 1801 are formed to have the gap width GDX set to 4A and the gap width GDY set to 4A. Accordingly, the conductor width WDX (=6A) is set larger than the gap width GDX (=4A).

Each relay conductor 1802 arranged in a gap region of the mesh conductor 1801 is a rectangle with the conductor width CDX set to 2A and the conductor width CDY set to 2A. The rectangle is a square having the same X-direction conductor width CDX and Y-direction conductor width CDY (CDY=CDX). Both the X-direction first gap width GDX1 and second gap width GDX2 between the mesh conductor 1801 and each relay conductor 1802 are set to 1A. In addition, both the Y-direction first gap width GDY1 and second gap width GDY2 are set to 1A.

Accordingly, if represented by using the real number A, the pitch width FDX (=(conductor width WDX)+(gap width GDX)) corresponds to 10A, and the pitch width FDY (=(conductor width WDY)+(gap width GDY)) corresponds to 10A.

In the sixth displacement configuration example, if the conductor area size of mesh conductor 1801, and the conductor area size of relay conductors 1802 in a predetermined range are compared with each other, the conductor area size of mesh conductor 1801 is larger, and the first condition of complete offsetting mentioned above is not satisfied.

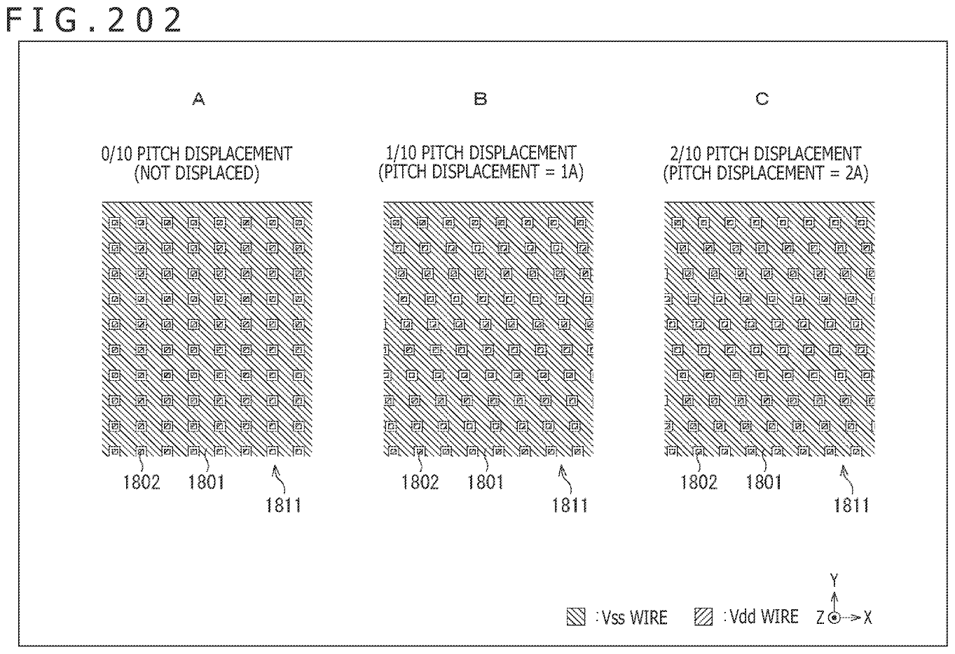

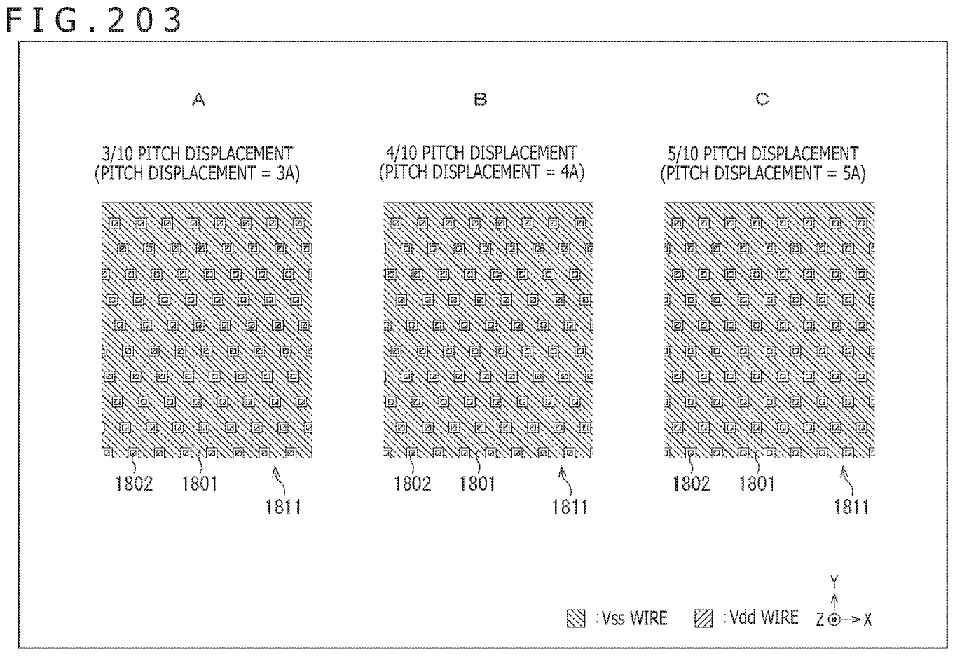

FIG. 202 and FIG. 203 are plan views in which the pitch displacement PDX is set to various values in the conductor layer 1811 as the sixth displacement configuration example of a mesh conductor.

A in FIG. 202 is a plan view of the conductor layer 1811 with the pitch displacement PDX set to zero.

B in FIG. 202 is a plan view of the conductor layer 1811 with the X-direction pitch displacement PDX set to 1A, that is, 1/10 of the X-direction repetition pitch (pitch width FDX).

C in FIG. 202 is a plan view of the conductor layer 1811 with the pitch displacement PDX set to 2A, that is, 2/10 of the X-direction repetition pitch (pitch width FDX).

A in FIG. 203 is a plan view of the conductor layer 1811 with the pitch displacement PDX set to 3A, that is, 3/10 of the X-direction repetition pitch (pitch width FDX).

B in FIG. 203 is a plan view of the conductor layer 1811 with the pitch displacement PDX set to 4A, that is, 4/10 of the X-direction repetition pitch (pitch width FDX).

C in FIG. 203 is a plan view of the conductor layer 1811 with the pitch displacement PDX set to 5A, that is, 5/10 of the X-direction repetition pitch (pitch width FDX).

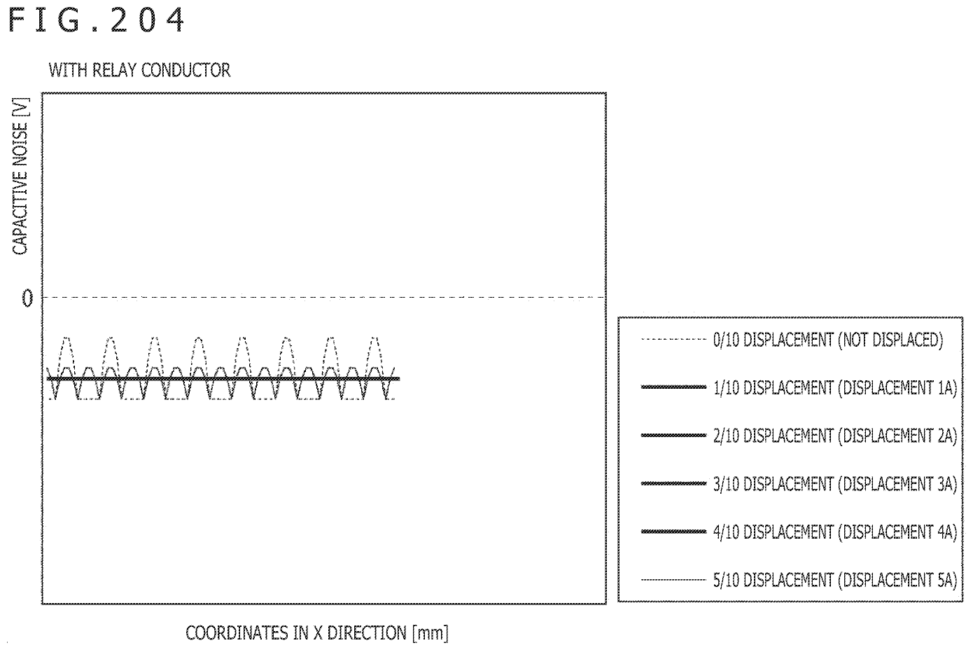

FIG. 204 is a graph depicting theoretical values of capacitive noise of the conductor layer 1811 with the pitch displacement PDX set to various values as in FIG. 202 and FIG. 203.

Because the horizontal axis and vertical axis in the graph in FIG. 204 are similar to those in FIG. 169, explanations thereof are omitted. Note that the graph in FIG. 204 also is depicted at the same scale as that of the graph in FIG. 169. It is assumed that conditions of a Vdd applied voltage and a Vss applied voltage also are similar.

As depicted in FIG. 204, in a case in which the pitch displacement PDX is set to predetermined values, the change amount of capacitive noise becomes zero. More specifically, in a case in which the pitch displacement PDX is set to 1/10 (=1A), 2/10 (=2A), 3/10 (=3A) or 4/10 (=4A) of the X-direction repetition pitch, the change amount of capacitive noise becomes zero. Note that the absolute value of capacitive noise does not become zero.

Putting it in the other way around, in a case in which the pitch displacement PDX is different from 5/10 (=5A) of the X-direction repetition pitch of the mesh conductor 1801, in other words, in a case in which the pitch displacement PDX is not (pitch width FDX (=10A))/2, the change amount of capacitive noise becomes zero.

In a case in which the pitch displacement PDX is set to 1/10 (=1A) or 3/10 (=3A) of the X-direction repetition pitch, the change amount of capacitive noise becomes zero in a set of ten rows.

In a case in which the pitch displacement PDX is set to 2/10 (=2A) or 4/10 (=4A) of the X-direction repetition pitch, the change amount of capacitive noise becomes zero in a set of five rows.

In the case of the other value of the pitch displacement PDX, specifically, in a case in which the pitch displacement PDX is set to 5/10 of the X-direction repetition pitch, the change amount of capacitive noise does not become zero, but the change amount of capacitive noise can be made smaller than in a case in which the pitch displacement PDX is set to zero, that is, there is no pitch displacement.

According to what is mentioned above, in the sixth displacement configuration example including relay conductors 1802, the change amount of capacitive noise can be made zero in the case of the following condition.

First, as a premise, the pitch displacement PDX is set to a value that is different from the X-direction pitch width FDX (=10A) of the mesh conductor 1801.

In a case in which the pitch displacement PDX is 4A, that is, in a case in which the pitch displacement PDX is the same as the X-direction gap width GDX of the mesh conductor 1801, the change amount of capacitive noise becomes zero. In addition, in a case in which the pitch displacement PDX is 1A, 2A or 3A also, the change amount of capacitive noise becomes zero.

Although not included in the graph in FIG. 204, in a case in which the pitch displacement PDX is 8A, which is 200% of the gap width GDX (=4A), the pitch width FDX is 10A, and 8/10=(10−2)/10 is satisfied. Accordingly, this is equivalent to the case in which the pitch displacement PDX is 2A, and so the change amount of capacitive noise becomes zero. In addition, in a case in which the pitch displacement PDX is 12A, which is 300% of the gap width GDX (=4A), the pitch width FDX is 10A, and 12/10=(10+2)/10 is satisfied. Accordingly, this is equivalent to the case in which the pitch displacement PDX is 2A, and so the change amount of capacitive noise becomes zero.

Accordingly, the conductor layer 1811 having the mesh conductor 1801 with the gap width GDX larger than the conductor width WDX can make the change amount of capacitive noise zero when the pitch displacement PDX is an integer multiple of the gap width GDX. It should be noted however that in a case in which the pitch displacement PDX is 1A or 3A also, the change amount of capacitive noise becomes zero, and so the pitch displacement PDX is not limited to an integer multiple of the gap width GDX.

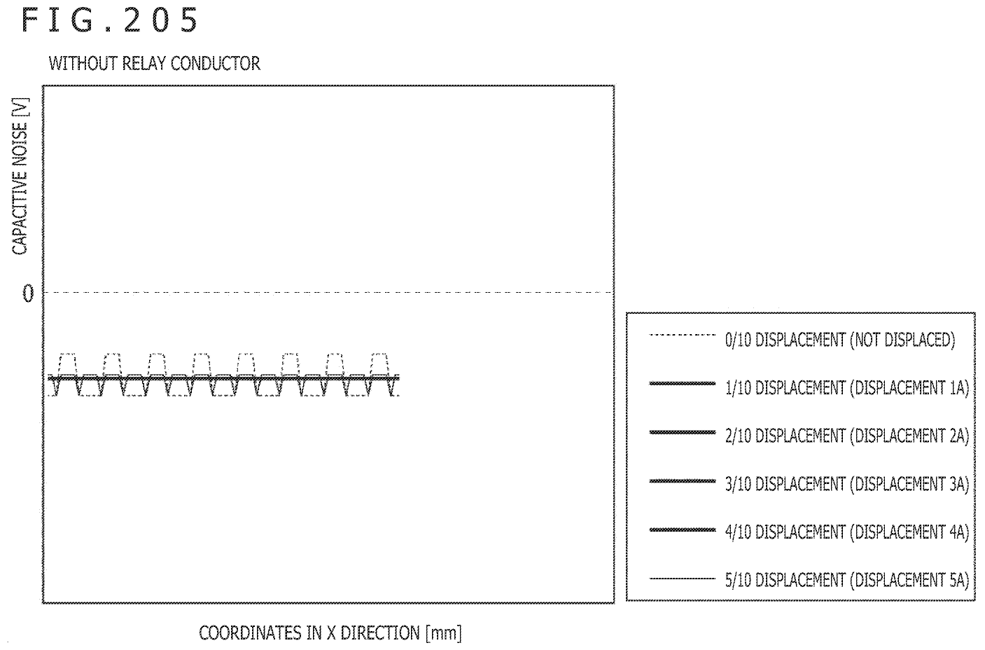

FIG. 205 is a graph depicting theoretical values of capacitive noise in a case in which the pitch displacement PDX is set to various values in the conductor layer 1811 from which relay conductors 1802 are omitted. Although an illustration of the conductor layer 1811 from which relay conductors 1802 are omitted is omitted, the conductor layer 1811 corresponds to one from which relay conductors 1802 are removed from each conductor layer 1811 in FIG. 202 and FIG. 203.

As depicted in FIG. 205, in a case in which there are no relay conductors 1802 also, the displacement amounts that make the change amount of capacitive noise zero are the same as those in a case in which there are relay conductors 1802. It should be noted however that the absolute value of capacitive noise does not become zero.

### Seventh Displacement Configuration Example of Mesh Conductor

The X-direction conductor width WDX and gap width GDX of the mesh conductor are equal to each other ((conductor width WDX)=(gap width GDX)) in an example depicted next as a seventh displacement configuration example.

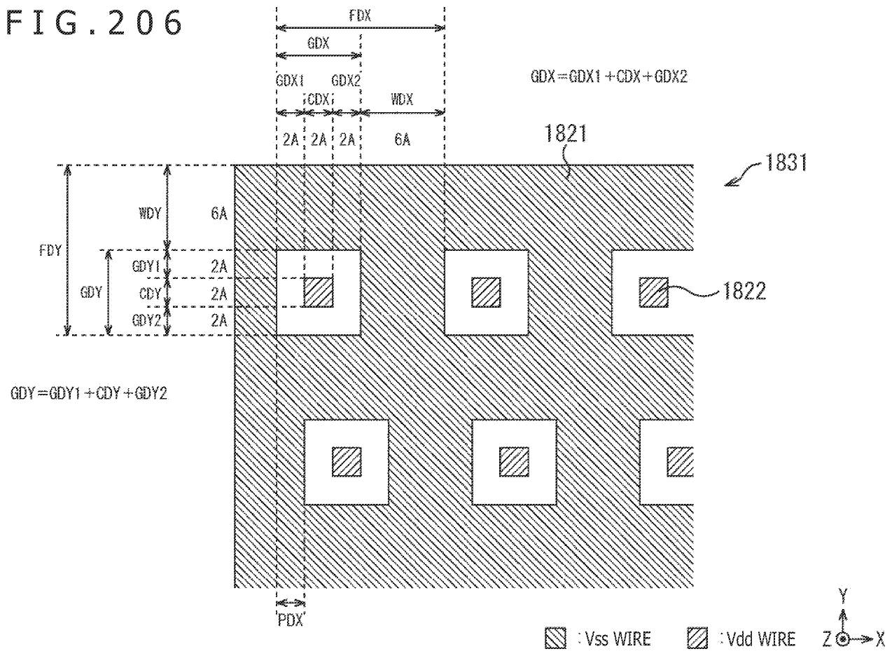

FIG. 206 is a plan view for explaining conductor widths and gap widths of a conductor layer as the seventh displacement configuration example of a mesh conductor.

A conductor layer 1831 in FIG. 206 includes a mesh conductor 1821 and relay conductors 1822.

Assuming that A is a real number, the mesh conductor 1821 has the conductor width WDX set to 6A and the conductor width WDY set to 6A. Gap regions of the mesh conductor 1821 are formed to have the gap width GDX set to 6A and the gap width GDY set to 6A. Accordingly, the conductor width WDX (=6A) and the gap width GDX (=6A) are set equal to each other.

Each relay conductor 1822 arranged in a gap region of the mesh conductor 1821 is a rectangle with the conductor width CDX set to 2A and the conductor width CDY set to 2A. The rectangle is a square having the same X-direction conductor width CDX and Y-direction conductor width CDY (CDY=CDX). Both the X-direction first gap width GDX1 and second gap width GDX2 between the mesh conductor 1821 and each relay conductor 1822 are set to 2A. In addition, both the Y-direction first gap width GDY1 and second gap width GDY2 are set to 2A.

Accordingly, if represented by using the real number A, the pitch width FDX (=(conductor width WDX)+(gap width GDX)) corresponds to 12A, and the pitch width FDY (=(conductor width WDY)+(gap width GDY)) corresponds to 12A.

In the seventh displacement configuration example, if the conductor area size of mesh conductor 1801, and the conductor area size of relay conductors 1802 in a predetermined range are compared with each other, the conductor area size of mesh conductor 1801 is larger, and the first condition of complete offsetting mentioned above is not satisfied.

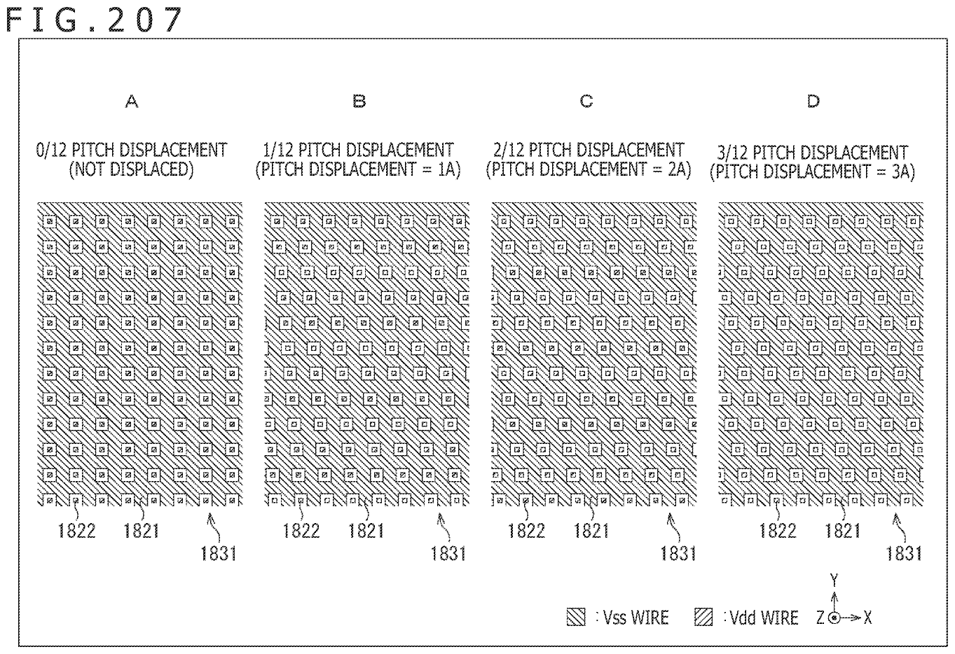

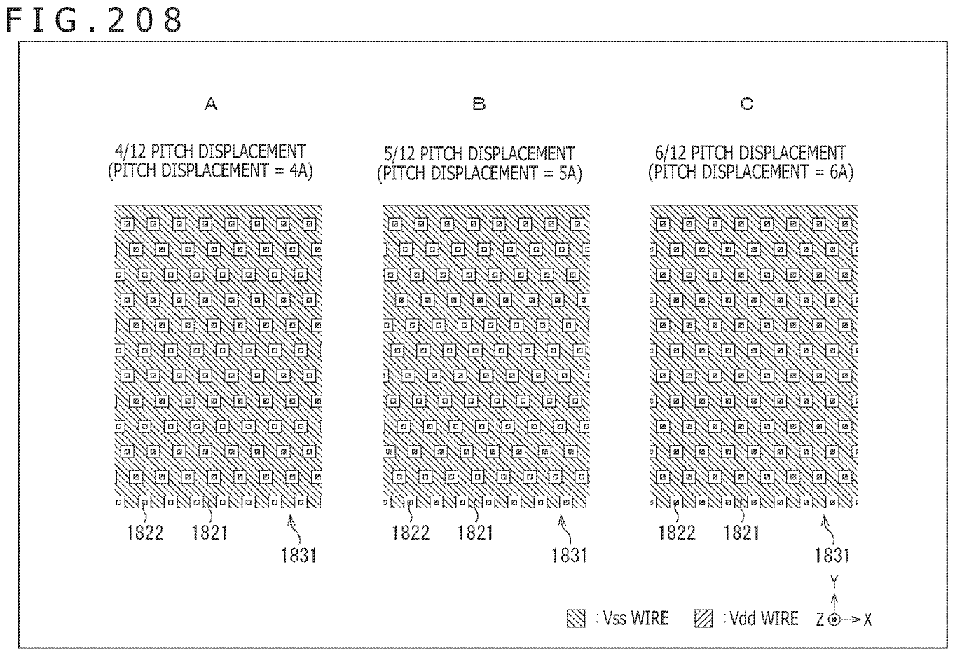

FIG. 207 and FIG. 208 are plan views in which the pitch displacement PDX is set to various values in the conductor layer 1831 as the seventh displacement configuration example of a mesh conductor.

A in FIG. 207 is a plan view of the conductor layer 1831 with the pitch displacement PDX set to zero.

B in FIG. 207 is a plan view of the conductor layer 1831 with the X-direction pitch displacement PDX set to 1A, that is, 1/12 of the X-direction repetition pitch (pitch width FDX).

C in FIG. 207 is a plan view of the conductor layer 1831 with the pitch displacement PDX set to 2A, that is, 2/12 of the X-direction repetition pitch (pitch width FDX).

D in FIG. 207 is a plan view of the conductor layer 1831 with the pitch displacement PDX set to 3A, that is, 3/12 of the X-direction repetition pitch (pitch width FDX).

A in FIG. 208 is a plan view of the conductor layer 1831 with the pitch displacement PDX set to 4A, that is, 4/12 of the X-direction repetition pitch (pitch width FDX).

B in FIG. 208 is a plan view of the conductor layer 1831 with the pitch displacement PDX set to 5A, that is, 5/12 of the X-direction repetition pitch (pitch width FDX).

C in FIG. 208 is a plan view of the conductor layer 1831 with the pitch displacement PDX set to 6A, that is, 6/12 of the X-direction repetition pitch (pitch width FDX).

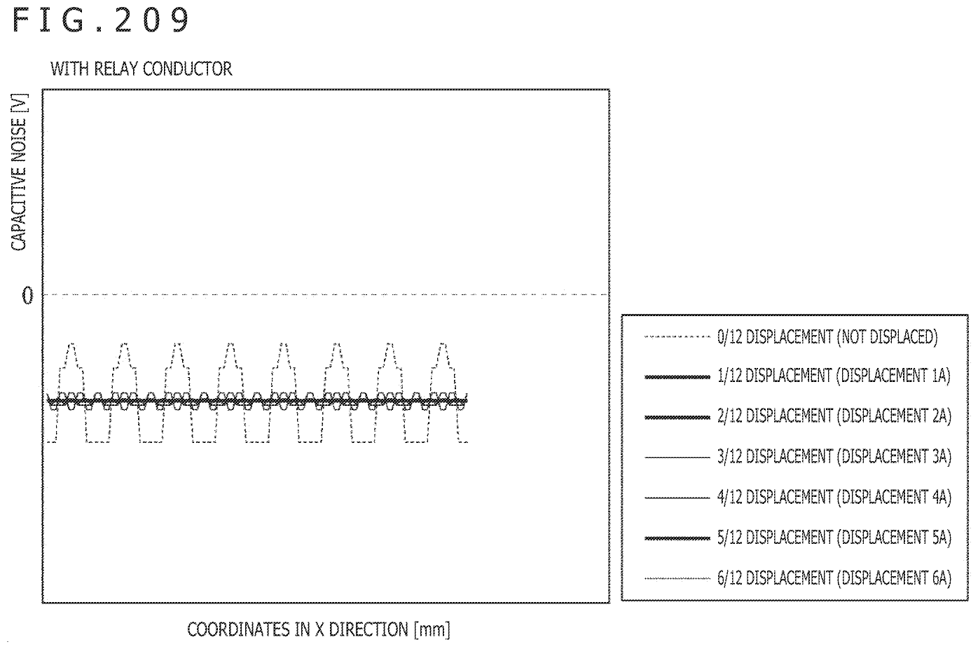

FIG. 209 is a graph depicting theoretical values of capacitive noise of the conductor layer 1831 with the pitch displacement PDX set to various values as in FIG. 207 and FIG. 208.

Because the horizontal axis and vertical axis in the graph in FIG. 209 are similar to those in FIG. 169, explanations thereof are omitted. Note that the graph in FIG. 209 also is depicted at the same scale as that of the graph in FIG. 169. It is assumed that conditions of a Vdd applied voltage and a Vss applied voltage also are similar.

As depicted in FIG. 209, in a case in which the pitch displacement PDX is set to predetermined values, the change amount of capacitive noise becomes zero. More specifically, in a case in which the pitch displacement PDX is set to 1/12 (=1A), 2/12 (=2A) or 5/12 (=5A) of the X-direction repetition pitch, the change amount of capacitive noise becomes zero. Note that the absolute value of capacitive noise does not become zero.

Putting it in the other way around, in a case in which the pitch displacement PDX is different from 3/12 (=3A), 4/12 (=4A) and 6/12 (=6A) of the X-direction repetition pitch of the mesh conductor 1821, in other words, in a case in which the pitch displacement PDX is neither (pitch width FDX (=12A))/4, (pitch width FDX (=12A))/3 nor (pitch width FDX (=12A))/2, the change amount of capacitive noise becomes zero.

In a case in which the pitch displacement PDX is set to 1/12 (=1A) or 5/12 (=5A) of the X-direction repetition pitch, the change amount of capacitive noise becomes zero in a set of twelve rows.

In a case in which the pitch displacement PDX is set to 2/12 (=2A) of the X-direction repetition pitch, the change amount of capacitive noise becomes zero in a set of six rows. The mesh conductor 1821 with the equal X-direction conductor width WDX and gap width GDX can make the change amount of capacitive noise zero with a smaller number of rows in a case in which the pitch displacement PDX is the same as the X-direction conductor width CDX (=2A) of the relay conductors 1822. In a case in which the pitch displacement PDX is the same as the X-direction conductor width WDX (=6A) of the mesh conductor 1821, the change amount of capacitive noise does not become zero.

In a case in which the pitch displacement PDX is set to 3/12 (=3A), 4/12 (=4A) or 6/12 (=6A) of the X-direction repetition pitch of the mesh conductor 1821, the change amount of capacitive noise does not become zero, but the change amount of capacitive noise can be made smaller than in a case in which the pitch displacement PDX is set to zero, that is, there is no pitch displacement.

According to what is mentioned above, in the seventh displacement configuration example including relay conductors 1822, the change amount of capacitive noise can be made zero in the case of the following condition.

First, as a premise, the pitch displacement PDX is set to a value that is different from the X-direction pitch width FDX (=12A) of the mesh conductor 1821.

In a case in which the pitch displacement PDX is 2A, that is, in a case in which the pitch displacement PDX is the same as the X-direction conductor width CDX of the relay conductors 1822, the change amount of capacitive noise becomes zero. In addition, in a case in which the pitch displacement PDX is 1A or 5A also, the change amount of capacitive noise becomes zero.

In a case in which the pitch displacement PDX is different from 3/12 (=3A) of the X-direction repetition pitch of the mesh conductor 1821, in other words, in a case in which the pitch displacement PDX is not (pitch width FDX (=12A))/4, the change amount of capacitive noise becomes zero.

In a case in which the pitch displacement PDX is different from 4/12 (=4A) of the X-direction repetition pitch of the mesh conductor 1821, in other words, in a case in which the pitch displacement PDX is not (pitch width FDX (=12A))/3, the change amount of capacitive noise becomes zero.

In a case in which the pitch displacement PDX is different from 6/12 (=6A) of the X-direction repetition pitch of the mesh conductor 1821, in other words, in a case in which the pitch displacement PDX is not (pitch width FDX (=12A))/2, the change amount of capacitive noise becomes zero.

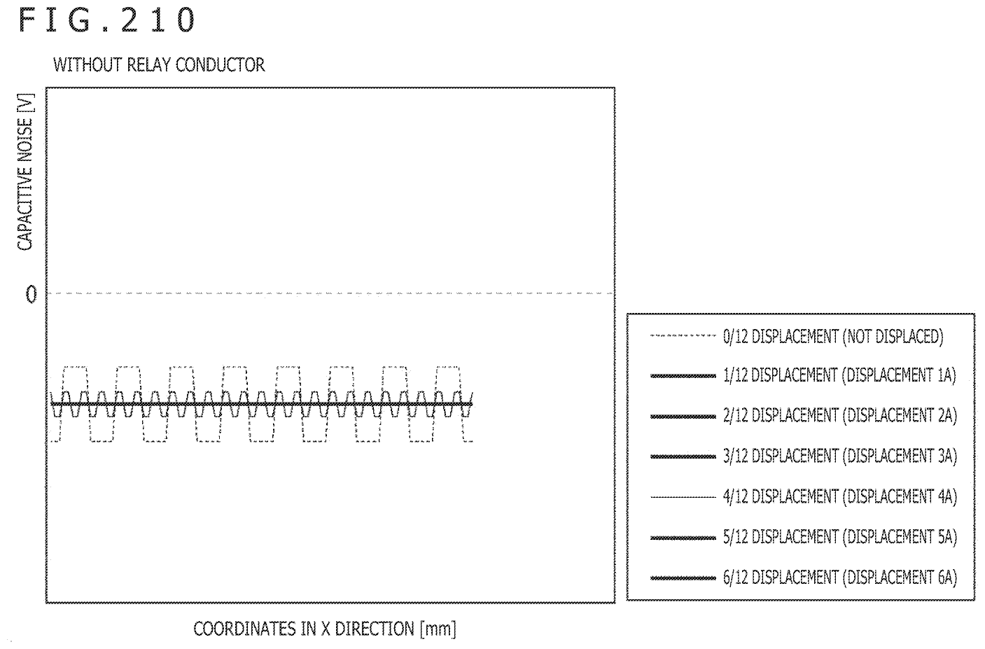

FIG. 210 is a graph depicting theoretical values of capacitive noise in a case in which the pitch displacement PDX is set to various values in the conductor layer 1831 from which relay conductors 1822 are omitted. Although an illustration of the conductor layer 1831 from which relay conductors 1822 are omitted is omitted, the conductor layer 1831 corresponds to one from which relay conductors 1822 are removed from each conductor layer 1831 in FIG. 207 and FIG. 208.

In a case in which there are no relay conductors 1822 also, as depicted in FIG. 210, in a case in which the pitch displacement PDX is set to predetermined values, the change amount of capacitive noise becomes zero. It should be noted however that the displacement amounts that make the change amount of capacitive noise zero are different from those in a case in which there are relay conductors 1822. Specifically, in a case in which the pitch displacement PDX is set to 1/12, 2/12, 3/12, 5/12 or 6/12 of the X-direction repetition pitch, the change amount of capacitive noise becomes zero.

In a case in which the pitch displacement PDX is set to 3/12 (=3A) of the X-direction repetition pitch, the change amount of capacitive noise becomes zero in a set of four rows. In a case in which the pitch displacement PDX is set to 2/12 (=2A) of the X-direction repetition pitch, the change amount of capacitive noise becomes zero in a set of six rows.

In a case in which the pitch displacement PDX is set to 6/12 (=6A) of the X-direction repetition pitch, the change amount of capacitive noise becomes zero in a set of two rows.

According to what is mentioned above, in the seventh displacement configuration example not including relay conductors 1822, the change amount of capacitive noise can be made zero in the case of the following condition.

First, as a premise, the pitch displacement PDX is set to a value that is different from the X-direction pitch width FDX (=12A) of the mesh conductor 1821.

In a case in which the pitch displacement PDX is 1/12 (=1A), 2/12 (=2A), 3/12 (=3A), 5/12 (=5A), or 6/12 (=6A) of the X-direction repetition pitch of the mesh conductor 1821, the change amount of capacitive noise becomes zero. It can be said in another way that 1/12 (=1A), 2/12 (=2A), 3/12 (=3A), and 6/12 (=6A) of the X-direction repetition pitch of the mesh conductor 1821 are equivalent to the pitch displacement PDX which is equal to (pitch width FDX (=12A))/12, (pitch width FDX (=12A))/6, (pitch width FDX (=12A))/4, and (pitch width FDX (=12A))/2, respectively. Accordingly, in a case in which the pitch displacement PDX is (pitch width FDX)/(even integer), the change amount of capacitive noise becomes zero. It is suitable if the pitch displacement PDX is (pitch width FDX (=12A))/2, in which case the pitch displacement PDX is set to 6/12 (=6A) of the X-direction repetition pitch, because the change amount of capacitive noise becomes zero with the smallest number of rows, but this is not essential.

In addition, in a case in which the pitch displacement PDX is different from 4/12 (=4A) of the X-direction repetition pitch of the mesh conductor 1821, in other words, in a case in which the pitch displacement PDX is not (pitch width FDX (=12A))/3, the change amount of capacitive noise becomes zero.

Accordingly, in the seventh displacement configuration example, the condition of the pitch displacement PDX under which the change amount of capacitive noise becomes zero is different between a case in which there are relay conductors 1822 and a case in which there are no relay conductors 1822.

In a case in which an integer multiple of an even number of the pitch displacement PDX matches the pitch width FDX due to the shape relation between the conductor section and gap regions of the mesh conductor 1821, capacitive noise is dispersed evenly, and so the change amount of capacitive noise can be made zero when there are no relay conductors 1822.

### Modification Example of Displacement Configuration Example of Mesh Conductor

In other possible configurations, at least one of the first to seventh displacement configuration examples of the mesh conductor mentioned above may be modified as mentioned below.

For example, the Y-direction conductor width WDY of the mesh conductor may be made larger than the gap width GDY ((conductor width WDY)>(gap width GDY)), or the X-direction conductor width WDX may be made larger than the gap width GDX ((conductor width WDX)>(gap width GDX)). This case is advantageous in terms of the light-blocking property and conductor occupancy.

In contrast, for example, the Y-direction conductor width WDY of the mesh conductor may be made the same as or smaller than the gap width GDY ((conductor width WDY)(gap width GDY)), or the X-direction conductor width WDX may be made the same as or smaller than the gap width GDX ((conductor width WDX)(gap width GDX)). This case is advantageous in terms of the capability to offset capacitive noise.

While the displacement is in the positive direction along the X axis in the examples used for the explanations of the displacement configuration examples of the mesh conductor mentioned above, the displacement may be in the negative direction along the X axis. In addition, the displacement in the positive direction along the X axis, and the displacement in the negative direction along the X axis may be combined in other possible configurations, for example by alternately repeating the displacement of one row or multiple rows in the positive direction along the X axis, and the displacement of one row or multiple rows in the negative direction along the X axis.

A conductor layer having any of the displacement configurations of a mesh conductor mentioned above is particularly suitable in a case in which the conductor layer is a conductor layer close to a Victim conductor, but this is not essential. While, in the examples explained, a conductor layer having any of the displacement configurations of a mesh conductor is applied to the mesh conductor in the conductor layer A (wiring layer 165A) or the conductor layer B (wiring layer 165B) mentioned above, the conductor layer can be applied also to conductor layers other than the conductor layer A or B. For example, the conductor layer may be applied to the conductor layer C (wiring layer 165C), or may be applied to any conductor layer of a circuit board, a semiconductor board or electronic equipment. In addition, two or more conductor layers having any of the displacement configurations of a mesh conductor may be included. In that case, the pitch displacement amounts of the two conductor layers are desirably mutually the same or substantially the same in terms of inductive noise, but the pitch displacement amounts may be made mutually different. In addition, two or more conductor layers having mesh conductors may be included, mesh conductors of some conductor layers may be provided with pitch displacement, and mesh conductors of the other conductor layers may not be provided with pitch displacement. In addition, one conductor layer may include multiple mesh conductors having mutually different pitch displacement amounts, and both mesh conductors provided with pitch displacement, and mesh conductors not provided with pitch displacement may be included.

The pitches (wire pitches), widths (wire widths), gap widths, and pitch displacement of wires as mesh conductors or relay conductors may be modulated depending on positions, in one possible structure. For example, the wire pitches, wire widths, gap widths and pitch displacement may gradually increase according to X-direction or Y-direction distances in one possible structure, and may gradually decrease according to X-direction or Y-direction distances, in another possible structure. Furthermore, structures in which the wire pitches, wire widths, gap widths and pitch displacement gradually increase according to X-direction or Y-direction distances, and structures in which the wire pitches, wire widths, gap widths and pitch displacement gradually decrease according to X-direction or Y-direction distances may be combined or alternately arranged, in another possible structure.

At least some conductors of mesh conductors or relay conductors may be separated into multiple conductors, or, as B in FIG. 178, may have shapes that are obtained by coupling multiple unseparated, but divided shapes. In addition, at least some of the mesh conductors may have cut and separated shapes.

A mesh conductor is explained as a wire (Vss wire) connected to GND or a negative power supply, and relay conductors are explained as wires (Vdd wires) connected to a positive power supply in the displacement configuration examples of a mesh conductor mentioned above. In addition, the absolute values of a Vdd applied voltage and a Vss applied voltage are the same in the examples explained.

However, the Vdd applied voltage and the Vss applied voltage may be replaced with each other. That is, a mesh conductor may be a wire (Vdd wire) connected to a positive power supply, and relay conductors may be wires (Vss wires) connected to GND or a negative power supply. In addition, the absolute values of the Vdd applied voltage and the Vss applied voltage may not be the same. For example, for example, the Vdd applied voltage may be a positive power supply (e.g., +1 V), and the Vss applied voltage may be GND (0 V).

The voltage applied to a mesh conductor, and the voltage applied to relay conductors are not limited to those in the example described above, but may be other power supplies, and it is sufficient if the voltage applied to the mesh conductor, and the voltage applied to the relay conductors are some two types of power supply. In this case, the polarities of the two types of power supply are desirably mutually different, but this is not essential.

The planar arrangement of conductor layers having a displacement configuration of a mesh conductor may be reversed in the X direction or may be reversed in the Y direction. In addition, the planar arrangement may be rotated by a predetermined angle clockwise (e.g., 90 degrees) or may be rotated by a predetermined angle counterclockwise (e.g., −90 degrees).

While the effect of ameliorating capacitive noise due to pitch displacement of a mesh conductor is depicted in the present disclosure, mesh conductors and relay conductors without pitch displacement are not excluded. As mentioned above, for conductor layers without pitch displacement also, both the presence and absence of relay conductors can be applied to the mesh conductor in the conductor layer A (wiring layer 165A) or the conductor layer B (wiring layer 165B).

For example, relay conductors may have any type of shape such as circular shapes, polygonal shapes, symmetric shapes, asymmetric shapes, star-like shapes or radial shapes, and may have complicated shapes. In addition, conductors that are used as relay conductors in the displacement configurations of a mesh conductor mentioned above may be conductors that do not electrically relay between other conductor layers, and it is sufficient if the relay conductors are non-mesh conductors (non-mesh conductors) arranged in gap regions of a mesh conductor. The non-mesh conductors including relay conductors may be arranged in all of the gap regions of the mesh conductor or may be arranged only in some predetermined gap regions.

### 15. Configuration Examples of Three Power Supplies

Next, configuration examples of a conductor layer (wiring layer 165) in a case in which the solid-state image pickup apparatus 100 has three power supplies are explained.

In various types of configuration examples mentioned above, in both the cases of the two layers including the conductor layers A and B (wiring layers 165A and 165B), and the three layers including the conductor layers A to C (wiring layers 165A to 165C), it is explained that there are two power supplies to be supplied to the wiring layers, which are Vdd to be used as a positive power supply, for example, and Vss to be used as GND or a negative power supply, for example.

However, the solid-state image pickup apparatus 100 is controlled by three power supplies which are a first power supply Vdd, a second power supply Vss1 and a third power supply Vss2, for example, in some cases.

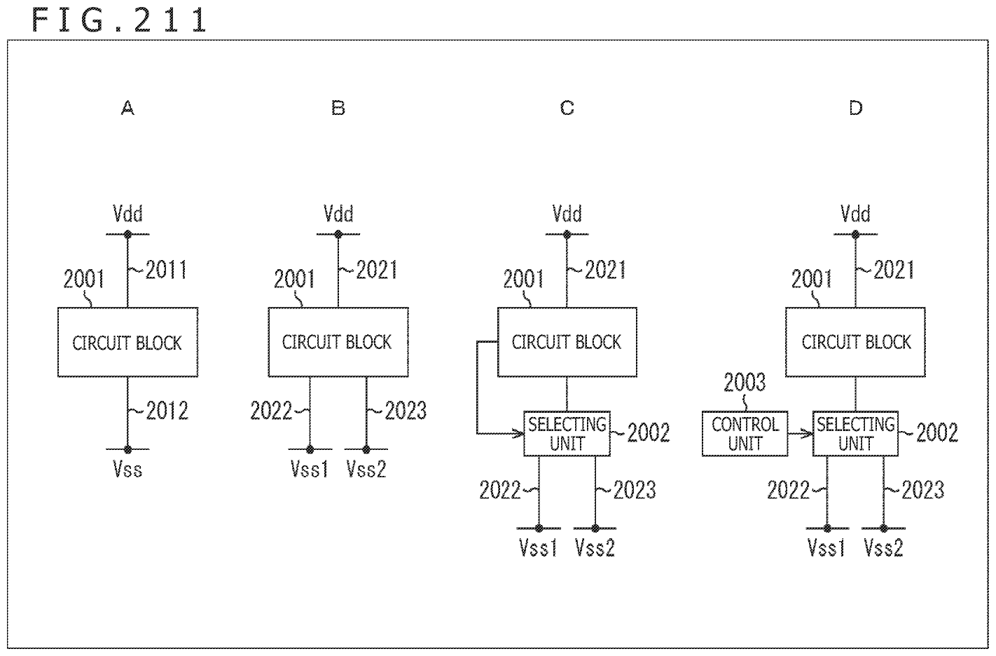

FIG. 211 depicts conceptual diagrams depicting cases in which the solid-state image pickup apparatus 100 has two power supplies and three power supplies.

A in FIG. 211 is a conceptual diagram of a case in which the solid-state image pickup apparatus 100 explained thus far is controlled by two power supplies.

A circuit block 2001 included in the solid-state image pickup apparatus 100 is supplied with a power supply Vdd via a wire 2011, and is supplied with a power supply Vss via a wire 2012. The circuit block 2001 is a circuit block in which an active element group 167 is formed, and corresponds to the circuit blocks 202 to 204 in FIG. 7, or the like, for example. The wires 2011 and 2012 correspond to wires (conductors) included in the conductor layers A and B in the case of two layers or the conductor layers A to C in the case of three layers in various types of configuration example mentioned above. It should be noted however that the wires 2011 and 2012 may include conductors of other conductor layers, and may include conductors of a configuration different from wires (conductors) explained in various types of configuration example mentioned above.

B in FIG. 211 is a conceptual diagram of a first configuration example of a case in which the solid-state image pickup apparatus 100 is controlled by three power supplies.

In the first configuration example of the case in which the solid-state image pickup apparatus 100 is controlled by three power supplies, the first power supply Vdd is supplied to the circuit block 2001 via a wire 2021, the second power supply Vss1 is supplied to the circuit block 2001 via a wire 2022, and the third power supply Vss2 is supplied to the circuit block 2001 via a wire 2023. The second power supply Vss1 and the third power supply Vss2 may be always supplied to the circuit block 2001 via the wires 2022 and 2023 in one possible configuration, and the circuit block 2001 may internally control connection with the wires 2022 and 2023, and select any one of the second power supply Vss1 or the third power supply Vss2 according to an operation mode or the like.

C in FIG. 211 is a conceptual diagram of a second configuration example of a case in which the solid-state image pickup apparatus 100 is controlled by three power supplies.

In the second configuration example of the case in which the solid-state image pickup apparatus 100 is controlled by three power supplies, a selecting unit 2002 is provided separately from the circuit block 2001. The selecting unit 2002 selects at least one of the second power supply Vss1 or the third power supply Vss2 according to an operation mode or the like, under the control of the circuit block 2001. In other words, the selecting unit 2002 selects at least one of a first path including the first power supply Vdd, the wire 2021, the circuit block 2001, the wire 2022, and the second power supply Vss1, or a second path including the first power supply Vdd, the wire 2021, the circuit block 2001, the wire 2023, and the third power supply Vss2.

D in FIG. 211 is a conceptual diagram of a third configuration example of a case in which the solid-state image pickup apparatus 100 is controlled by three power supplies.

In the third configuration example of the case in which the solid-state image pickup apparatus 100 is controlled by three power supplies, a control unit 2003 that controls selection of the second power supply Vss1 and the third power supply Vss2 also is provided separately from the circuit block 2001. The control unit 2003 determines to select the second power supply Vss1 and the third power supply Vss2, and commands the selecting unit 2002, and the selecting unit 2002 selects at least one of the second power supply Vss1 or the third power supply Vss2 on the basis of the command of the control unit 2003.

In all the configurations of three power supplies in B to D in FIG. 211, the circuit block 2001 is electrically connected to the first power supply Vdd via the wire 2021, is electrically connected to the second power supply Vss1 via the wire 2022, and is electrically connected to the third power supply Vss2 via the wire 2023.

Note that, in a case in which the second power supply Vss1 and the third power supply Vss2 are selected for operation in the configurations of three power supplies in B to D in FIG. 211, any one of the second power supply Vss1 or the third power supply Vss2 may be selected one at a time in one possible configuration, or the second power supply Vss1 and the third power supply Vss2 may be selected simultaneously in another possible configuration.

Regarding the magnitude relation between power supply voltages of the three power supplies, the first power supply Vdd is higher than the second power supply Vss1, and the first power supply Vdd is higher than the third power supply Vss2. The second power supply Vss1 and the third power supply Vss2 may be the same, or the second power supply Vss1 is higher than the third power supply Vss2. That is, (first power supply Vdd)>(second power supply Vss1), (first power supply Vdd)>(third power supply Vss2), and (second power supply Vss1)≥(third power supply Vss2). The total power consumption when the solid-state image pickup apparatus 100 selected the second power supply Vss1 is the same as or higher than the total power consumption when the third power supply Vss2 is selected. In addition, the total current amount when the solid-state image pickup apparatus 100 selected the second power supply Vss1 is the same as or higher than the total current amount when the third power supply Vss2 is selected. In these cases, “(total number of pads (Vdd pads) electrically connected with first power supply Vdd)(total number of pads (Vss2 pads) electrically connected with third power supply Vss2),” and “(total number of pads (Vss1 pads) electrically connected with second power supply Vss1)≥(total number of pads (Vss2 pads) electrically connected with third power supply Vss2)” can be satisfied. That is, because there are less constraints due to total power consumption and total current amounts, the total number of pads electrically connected with the third power supply Vss2 can be made smaller than the total number of pads electrically connected with the first power supply Vdd or the second power supply Vss1. Furthermore, “(total number of pads electrically connected with first power supply Vdd)(total number of pads electrically connected with second power supply Vss1)” may be satisfied. Note that details of the pad arrangement in the case of three power supplies are not explained because it is sufficient if the pad arrangement examples in the case of two power supplies mentioned above are applied. For example, it is sufficient if Vdd pads, Vss1 pads and Vss2 pads are placed in the alternating arrangement or mirror-symmetric arrangement mentioned above along one edge, two edges, three edges or four edges.

For example, the first power supply Vdd may be a power supply with 0 V or higher, and may be a fixed voltage or a variable voltage. For example, the second power supply Vss1 and the third power supply Vss2 are GND or negative power supplies. More specifically, for example, the second power supply Vss1 is GND (ground), and the third power supply Vss2 is a negative power supply in one possible configuration that can be adopted, and the second power supply Vss1 is a first negative power supply voltage, and the third power supply Vss2 is a second negative power supply voltage different from the first negative power supply voltage in another possible configuration that can be adopted. In the present embodiment, it is assumed that the first power supply Vdd, the second power supply Vss1 and the third power supply Vss2 are for distinguishing between power supply voltage levels supplied to the circuit block 2001, and also include GND (ground). In addition, both the second power supply Vss1 and the third power supply Vss2 may be GND, and may be negative power supplies with the same voltage. In other words, the first power supply Vdd, the second power supply Vss1 and the third power supply Vss2 may be three power supplies including two systems with the second power supply Vss1 and the third power supply Vss2 being the same power supply voltage, or three power supplies including three systems with the second power supply Vss1 and the third power supply Vss2 being different power supply voltages.

Note that, hereinbelow, a conductor connected to the first power supply Vdd is also referred to as a Vdd conductor, a conductor connected to the second power supply Vss1 is also referred to as a Vss1 conductor, and a conductor connected to the third power supply Vss2 is also referred to as a Vss2 conductor.

In addition, in another possible configuration that can be adopted, the combination of three power supplies includes two power supply voltages which are equal to or higher than 0. For example, the combination of three power supplies may be a first power supply Vdd1, a second power supply Vdd2 and a third power supply Vss. The configuration of the first power supply Vdd, the second power supply Vss1 and the third power supply Vss2 explained below can be applied to the configuration of the first power supply Vdd1, the second power supply Vdd2 and the third power supply Vss with appropriate replacement, and so an explanation of the latter configuration is omitted. In the case of the configuration of the first power supply Vdd1, the second power supply Vdd2 and the third power supply Vss, any one of the first power supply Vdd1 or the second power supply Vdd2 is selected one at a time, or the first power supply Vdd1 and the second power supply Vdd2 are selected simultaneously, and the third power supply Vss serves as an element to be used in common.

### First Configuration Example of Three Power Supplies

A configuration example of a wiring layer in a case in which the solid-state image pickup apparatus 100 is controlled by three power supplies is explained hereinafter. In a configuration example explained first, wires of three power supplies are arranged in two wiring layers (wiring layers 165A and 165B) in multiple wiring layers forming the multi-layer wiring layer 163, and in a configuration example explained next, wires of three power supplies are arranged in three wiring layers (wiring layers 165A to 165C). Similarly to the examples mentioned above, the wiring layer 165A is referred to as the conductor layer A, the wiring layer 165B is referred to as the conductor layer B, and the wiring layer 165C is referred to as the conductor layer C in the following explanation.

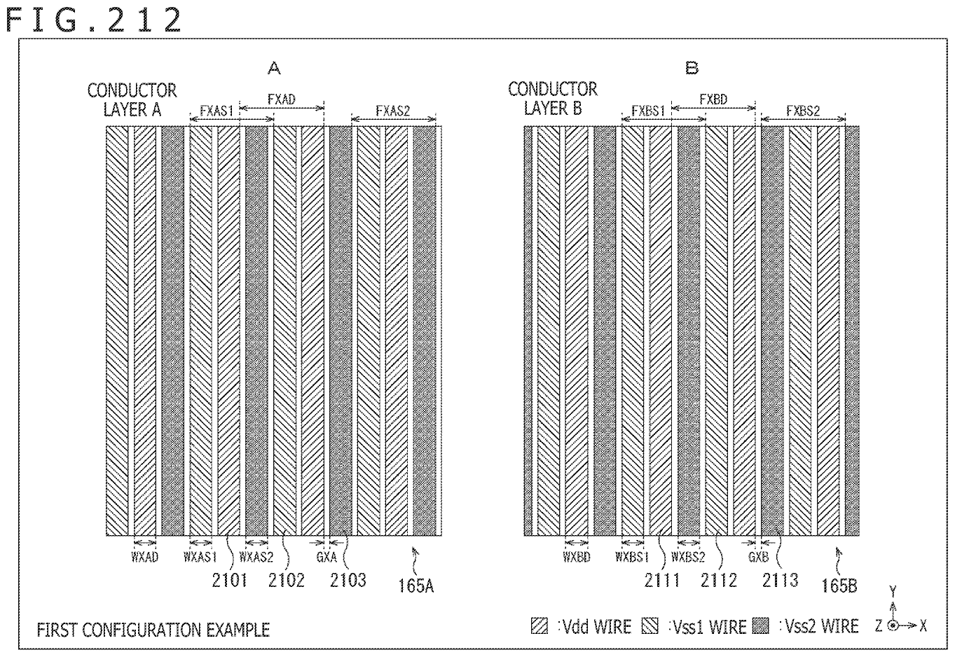

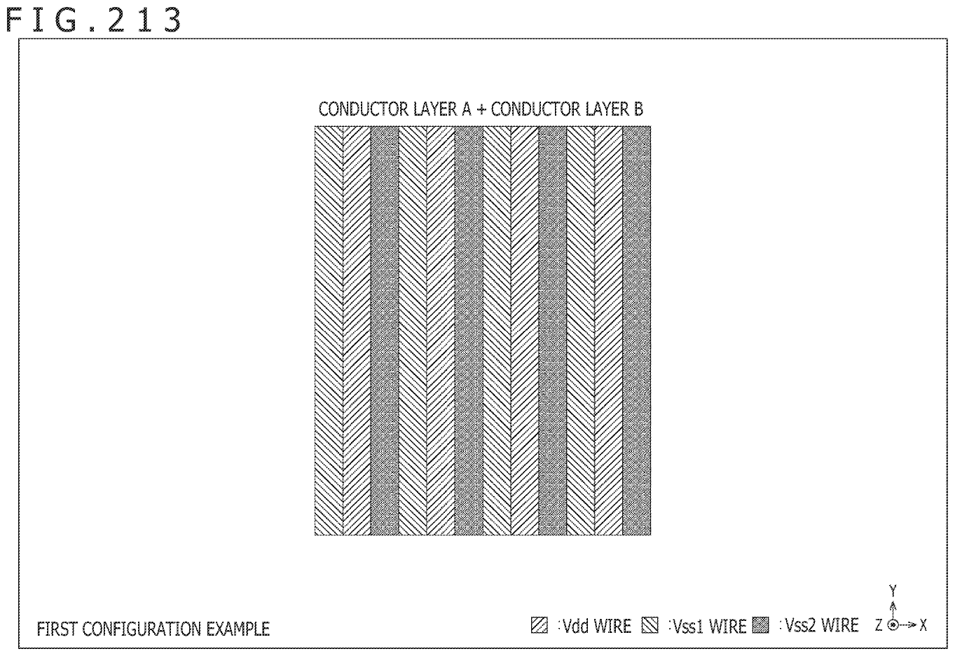

FIG. 212 and FIG. 213 depict a first configuration example of three power supplies.

In the coordinate systems in both FIG. 212 and FIG. 213, the X axis lies in the lateral direction, the Y axis lies in the longitudinal direction, and the Z axis lies in a direction perpendicular to the XY plane.

A in FIG. 212 depicts a plan view of the conductor layer A (wiring layer 165A), and B in FIG. 212 depicts a plan view of the conductor layer B (wiring layer 165B). Note that FIG. 212 may be regarded as depicting the entire region of each conductor layer or may be regarded as depicting a partial region of each conductor layer.

The conductor layer A in A in FIG. 212 includes three linear conductors 2101 to 2103 that are long in the Y direction, and arranged in the X direction in a predetermined order, and sets of the three linear conductors 2101 to 2103 are arranged regularly in the X direction.

The linear conductors 2101 are wires (Vdd wires) connected to the first power supply Vdd. The linear conductors 2102 are wires (Vss1 wires) connected to the second power supply Vss1. The linear conductors 2103 are wires (Vss2 wires) connected to the third power supply Vss2.

Accordingly, while the three linear conductors 2101 to 2103 are arranged in the positive direction along the X axis in the order of a Vdd wire, a Vss2 wire and a Vss1 wire in A in FIG. 212, the order of arrangement of the three linear conductors 2101 to 2103 is not limited to this example, but can be any order.

The linear conductors 2101 have the X-direction conductor width WXAD, the linear conductors 2102 have the X-direction conductor width WXAS1, and the linear conductors 2103 have the X-direction conductor width WXAS2. For example, the conductor width WXAD of the linear conductors 2101, the conductor width WXAS1 of the linear conductors 2102, and the conductor width WXAS2 of the linear conductors 2103 are the same ((conductor width WXAD)=(conductor width WXAS1)=(conductor width WXAS2)). In addition, there is a gap with the gap width GXA between two adjacent ones of the linear conductors 2101 to 2103.

The linear conductors 2101 are arranged regularly in the X direction at a conductor pitch FXAD, and the linear conductors 2102 are arranged regularly in the X direction at a conductor pitch FXAS1. Similarly, the linear conductors 2103 are arranged regularly in the X direction at a conductor pitch FXAS2. For example, the conductor pitch FXAD, the conductor pitch FXAS1 and the conductor pitch FXAS2 are the same ((conductor pitch FXAD)=(conductor pitch FXAS1)=(conductor pitch FXAS2)).

Accordingly, in a rectangular region in a predetermined range of the conductor layer A, the sum total of the X-direction conductor widths WXAD of linear conductors 2101 connected to the first power supply Vdd, the sum total of the X-direction conductor widths WXAS1 of linear conductors 2102 connected to the second power supply Vss1, and the sum total of the X-direction conductor widths WXAS2 of linear conductors 2103 connected to the third power supply Vss2 become the same. In addition, in a rectangular region in a predetermined range of the conductor layer A, the conductor area size of linear conductors 2101 connected to the first power supply Vdd, the conductor area size of linear conductors 2102 connected to the second power supply Vss1, and the conductor area size of linear conductors 2103 connected to the third power supply Vss2 become the same.

The conductor layer B in B in FIG. 212 includes three linear conductors 2111 to 2113 that are long in the Y direction, and arranged in the X direction in a predetermined order, and sets of the three linear conductors 2111 to 2113 are arranged regularly in the X direction.

The linear conductors 2111 are wires (Vdd wires) connected to the first power supply Vdd. The linear conductors 2112 are wires (Vss1 wires) connected to the second power supply Vss1. The linear conductors 2113 are wires (Vss2 wires) connected to the third power supply Vss2.

Accordingly, while the three linear conductors 2111 to 2113 are arranged in the positive direction along the X axis in the order of a Vdd wire, a Vss2 wire and a Vss1 wire in B in FIG. 212, the order of arrangement of the three linear conductors 2101 to 2103 is not limited to this example, but can be any order.

The linear conductors 2111 have an X-direction conductor width WXBD, the linear conductors 2112 have an X-direction conductor width WXBS1, and the linear conductors 2113 have an X-direction conductor width WXBS2. For example, the conductor width WXBD of the linear conductors 2111, the conductor width WXBS1 of the linear conductors 2112, and the conductor width WXBS2 of the linear conductors 2113 are the same ((conductor width WXBD)=(conductor width WXBS1)=(conductor width WXBS2)). There is a gap with the gap width GXB between two adjacent ones of the linear conductors 2111 to 2113.

Then, the linear conductors 2111 are arranged regularly in the X direction at a conductor pitch FXBD. The linear conductors 2112 are arranged regularly in the X direction at a conductor pitch FXBS1, and the linear conductors 2113 are arranged regularly in the X direction at a conductor pitch FXBS2. For example, the conductor pitch FXBD, the conductor pitch FXBS1 and the conductor pitch FXBS2 are the same ((conductor pitch FXBD)=(conductor pitch FXBS1)=(conductor pitch FXBS2)).

Accordingly, in a rectangular region in a predetermined range of the conductor layer B, the sum total of the X-direction conductor widths WXBD of linear conductors 2111 connected to the first power supply Vdd, the sum total of the X-direction conductor widths WXBS1 of linear conductors 2112 connected to the second power supply Vss1, and the sum total of the X-direction conductor widths WXBS2 of linear conductors 2113 connected to the third power supply Vss2 are the same. In addition, in a rectangular region in a predetermined range of the conductor layer B, the conductor area size of linear conductors 2111 connected to the first power supply Vdd, the conductor area size of linear conductors 2112 connected to the second power supply Vss1, and the conductor area size of linear conductors 2113 connected to the third power supply Vss2 are the same.

Next, if the linear conductors 2101 and the linear conductors 2111 connected to the same first power supply Vdd in the conductor layer A and the conductor layer B are compared with each other, the conductor width WXAD and the conductor width WXBD are the same, and the conductor pitch FXAD and the conductor pitch FXBD are the same. It should be noted however that the X-direction positions of the linear conductors 2101 and the linear conductors 2111 are different. The amount of displacement between the X-direction positions of the linear conductors 2101 and the linear conductors 2111 is equal to or larger than the X-direction gap widths GXA and GXB, and is equal to or smaller than the X-direction conductor widths WXAD and WXBD, and it is more suitable if it is larger than the X-direction gap widths GXA and GXB, and is smaller than the X-direction conductor widths WXAD and WXBD.

In addition, if the linear conductors 2102 and the linear conductors 2112 connected to the second power supply Vss1 are compared with each other, the conductor width WXAS1 and the conductor width WXBS1 are the same, and the conductor pitch FXAS1 and the conductor pitch FXBS1 also are the same. It should be noted however that the X-direction positions of the linear conductors 2102 and the linear conductors 2112 are different. The amount of displacement between the X-direction positions of the linear conductors 2102 and the linear conductors 2112 also is equal to or larger than the X-direction gap widths GXA and GXB, and is equal to or smaller than the X-direction conductor widths WXAS1 and WXBS1, and it is more suitable if it is larger than the X-direction gap widths GXA and GXB, and is smaller than the X-direction conductor widths WXAS1 and WXBS1.

Furthermore, if the linear conductors 2103 and the linear conductors 2113 connected to the third power supply Vss2 are compared with each other, the conductor width WXAS2 and the conductor width WXBS2 are the same, and the conductor pitch FXAS2 and the conductor pitch FXBS2 also are the same. It should be noted however that the X-direction positions of the linear conductors 2103 and the linear conductors 2113 are different. The amount of displacement between the X-direction positions of the linear conductors 2103 and the linear conductors 2113 also is equal to or larger than the X-direction gap widths GXA and GXB, and is equal to or smaller than the X-direction conductor widths WXAS2 and WXBS2, and it is more suitable if it is larger than the X-direction gap widths GXA and GXB, and is smaller than the X-direction conductor widths WXAS2 and WXBS2.

FIG. 213 is a plan view depicting the stacked state of the conductor layer A in A in FIG. 212, and the conductor layer B in B in FIG. 212.

In a case in which there are the suitable relations mentioned above between the amount of displacement between the X-direction positions of the linear conductors in the conductor layer A and the conductor layer B, and the X-direction conductor widths and gap widths, a light-blocking structure can be formed by the stacking of the conductor layer A and the conductor layer B as depicted in FIG. 213, and hot carrier light emissions can be blocked.

In addition, in a case in which there are the suitable relations mentioned above between the amount of displacement between the X-direction positions of the linear conductors in the conductor layer A and the conductor layer B, and the X-direction gap widths and conductor widths, linear conductors that are in the conductor layers A and B, and connected to the same power supplies may be electrically connected via conductor vias extending in the Z direction, or the like in predetermined partial regions where the positions of the linear conductors overlap. While it is desirable in terms of voltage drops (IR-Drop) if linear conductors connected to the same power supplies are electrically connected, this is not essential, and they do not have to be connected.

In addition, in a case in which any one of the second power supply Vss1 or the third power supply Vss2 is selected by the selecting unit 2002 in FIG. 211 or the like, for example, both of the conductor layers A and B form differential structures. Specifically, in a case in which the second power supply Vss1 is selected, the current distribution in the linear conductors 2101 connected to the first power supply Vdd and the current distribution in the linear conductors 2102 connected to the second power supply Vss1 become substantially even distributions and have mutually reverse characteristics in the conductor layer A, and in a case in which the third power supply Vss2 is selected, the current distribution in the linear conductors 2101 connected to the first power supply Vdd and the current distribution in the linear conductors 2103 connected to the third power supply Vss2 become substantially even distributions and have mutually reverse characteristics. In addition, in the conductor layer B, in a case in which the second power supply Vss1 is selected, the current distribution in the linear conductors 2111 connected to the first power supply Vdd and the current distribution in the linear conductors 2112 connected to the second power supply Vss1 become substantially even distributions and have mutually reverse characteristics, and in a case in which the third power supply Vss2 is selected, the current distribution in the linear conductors 2111 connected to the first power supply Vdd and the current distribution in the linear conductors 2113 connected to the third power supply Vss2 become substantially even distributions and have mutually reverse characteristics. Here, being substantially even means that the differences are so small that they can be deemed to be even, and it is sufficient if at least the differences are 200%-differences or smaller, for example. Thereby, inductive noise can be suppressed more than in non-differential structures. In addition, symmetric structures allow easy noise designing.

### First Modification Example of First Configuration Example of Three Power Supplies

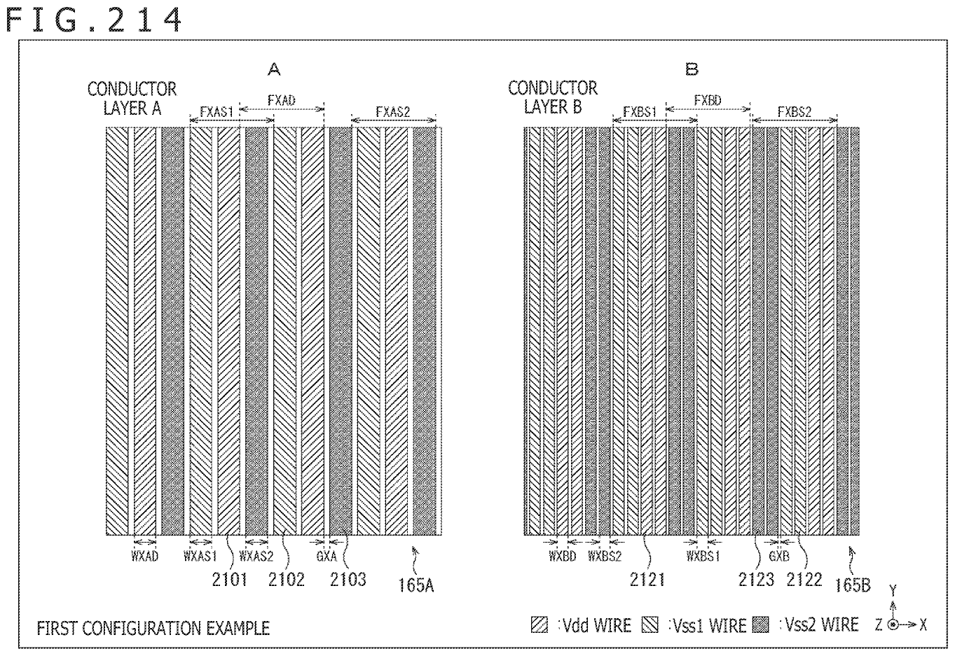

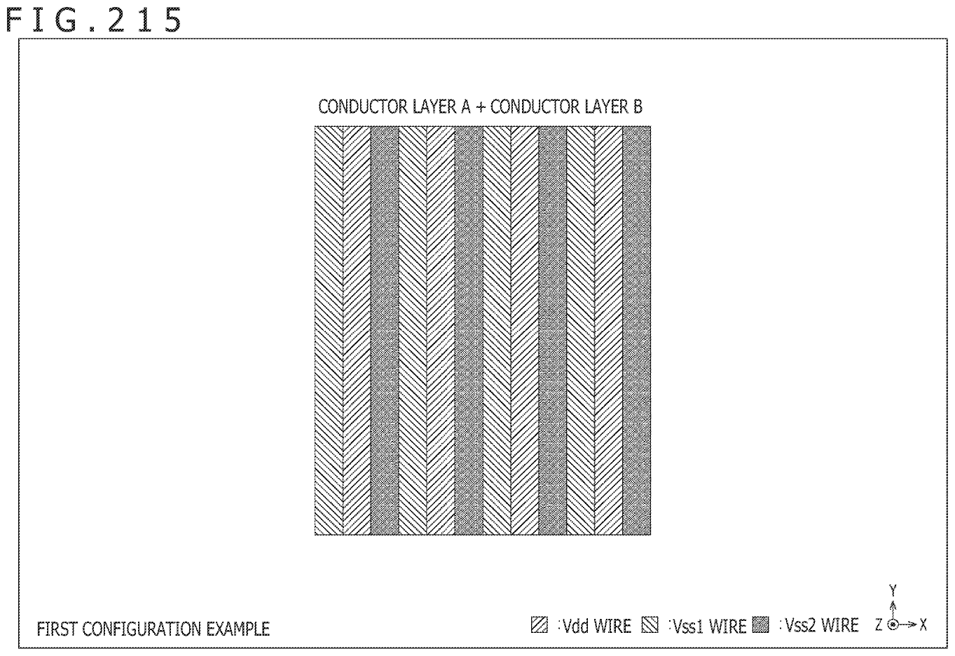

FIG. 214 and FIG. 215 depict a first modification example of the first configuration example of three power supplies.

In the coordinate systems in both FIG. 214 and FIG. 215, the X axis lies in the lateral direction, the Y axis lies in the longitudinal direction, and the Z axis lies in a direction perpendicular to the XY plane.

A in FIG. 214 depicts a plan view of the conductor layer A, and B in FIG. 214 depicts a plan view of the conductor layer B. Note that FIG. 214 may be regarded as depicting the entire region of each conductor layer or may be regarded as depicting a partial region of each conductor layer.

The conductor layer A in A in FIG. 214 is the same as the conductor layer A in the first configuration example depicted in A in FIG. 212, and so an explanation thereof is omitted.

The conductor layer B in B in FIG. 214 includes linear conductors 2121 to 2123 that are long in the Y direction, and pairs of linear conductors 2121, pairs of linear conductors 2122, and pairs of linear conductors 2123 are arranged next to each other in the X direction in a predetermined order. In addition, the pairs of the linear conductors 2121 to 2123 are arranged regularly in the X direction.

In other words, the conductor layer B in the second configuration example has a configuration in which the linear conductors 2111 to 2113, which are Vdd wires, Vss2 wires and Vss1 wires, in the conductor layer B in the first configuration example are replaced with the pairs of the linear conductors 2121 to 2123 which are arranged regularly in the X direction.

The linear conductors 2121 are wires (Vdd wires) connected to the first power supply Vdd. The linear conductors 2122 are wires (Vss1 wires) connected to the second power supply Vss1. The linear conductors 2123 are wires (Vss2 wires) connected to the third power supply Vss2.

Accordingly, while pairs of linear conductors 2121 to 2123 are arranged in the positive direction along the X axis in the order of a Vdd wire, a Vss2 wire and a Vss1 wire in B in FIG. 214, the order of arrangement of the pairs of linear conductors 2121 to 2123 is not limited to this example, but can be any order.

The linear conductors 2121 have the X-direction conductor width WXBD, the linear conductors 2122 have the X-direction conductor width WXBS1, and the linear conductors 2123 have the X-direction conductor width WXBS2. For example, the conductor width WXBD of the linear conductors 2121, the conductor width WXBS1 of the linear conductors 2122, and the conductor width WXBS2 of the linear conductors 2123 are the same ((conductor width WXBD)=(conductor width WXBS1)=(conductor width WXBS2)). There is a gap with the gap width GXB between two adjacent ones of the linear conductors 2121 to 2123.

Then, the pairs of the linear conductors 2121 are arranged regularly in the X direction at the conductor pitch FXBD. The pairs of the linear conductors 2122 are arranged regularly in the X direction at the conductor pitch FXBS1, and the pairs of the linear conductors 2123 are arranged regularly in the X direction at the conductor pitch FXBS2. For example, the conductor pitch FXBD, the conductor pitch FXBS1 and the conductor pitch FXBS2 are the same ((conductor pitch FXBD)=(conductor pitch FXBS1)=(conductor pitch FXBS2)).

Accordingly, in a rectangular region in a predetermined range of the conductor layer B, the sum total of the X-direction conductor widths WXBD of linear conductors 2121 connected to the first power supply Vdd, the sum total of the X-direction conductor widths WXBS1 of linear conductors 2122 connected to the second power supply Vss1, and the sum total of the X-direction conductor widths WXBS2 of linear conductors 2123 connected to the third power supply Vss2 are the same. In addition, in a rectangular region in a predetermined range of the conductor layer B, the conductor area size of linear conductors 2121 connected to the first power supply Vdd, the conductor area size of linear conductors 2122 connected to the second power supply Vss1, and the conductor area size of linear conductors 2123 connected to the third power supply Vss2 are the same.

In a case in which any one of the second power supply Vss1 or the third power supply Vss2 is selected in the conductor layer B, the conductor layer B forms a differential structure. Accordingly, inductive noise can be suppressed more than in non-differential structures, and this allows easier noise designing.

FIG. 215 is a plan view depicting the stacked state of the conductor layer A in A in FIG. 214, and the conductor layer B in B in FIG. 214.

By setting the amount of displacement between the X-direction positions of the linear conductors in the conductor layer A and the conductor layer B, and the X-direction conductor widths and gap widths such that they satisfy a predetermined condition, a light-blocking structure can be formed with the conductor layer A and the conductor layer B in the stacked state as depicted in FIG. 215, and hot carrier light emissions can be blocked.

Linear conductors that are in the conductor layers A and B, and connected to the same power supplies may be electrically connected via conductor vias extending in the Z direction, or the like in predetermined partial regions where the positions of the linear conductors overlap. While it is desirable in terms of voltage drops if linear conductors connected to the same power supplies are electrically connected, this is not essential, and they do not have to be connected.

In the configuration in the first modification example of the first configuration example depicted in FIG. 214, the linear conductors 2111 to 2113, which are Vdd wires, Vss2 wires and Vss1 wires, in the conductor layer B in the conductor layers A and B in the first configuration example of three power supplies depicted in FIG. 212 are replaced with the pairs of the linear conductors 2121 to 2123 which are arranged regularly in the X direction.

However, instead of the regular arrangement of the pairs of linear conductors 2121 to 2123, there may be a regular arrangement of sets each including a predetermined number of, three or more, linear conductors 2121 to 2123.

In addition, for example, in another possible configuration, the linear conductors 2101 to 2103, which are Vdd wires, Vss2 wires and Vss1 wires, in the conductor layer A in the conductor layers A and B in the first configuration example of three power supplies depicted in FIG. 212 are replaced with the pairs of the linear conductors 2121 to 2123 which are arranged regularly in the X direction.

Alternatively, it is also possible to adopt a configuration in which Vdd wires, Vss2 wires and Vss1 wires in both of the conductor layers A and B are replaced with a predetermined number of, two or more, linear conductors 2121 to 2123 which are arranged regularly in the X direction. In this case, the conductor widths, conductor pitches and gap widths of the linear conductors 2121 to 2123 in the conductor layer A may be the same as or different from the conductor widths, conductor pitches and gap widths of the linear conductors 2121 to 2123 in the conductor layer B. The conductor layer A and the conductor layer B may be the same in terms of any one or two of the conductor widths, conductor pitches and gap widths, and may be different in terms of the other one(s).

### Second Modification Example of First Configuration Example of Three Power Supplies

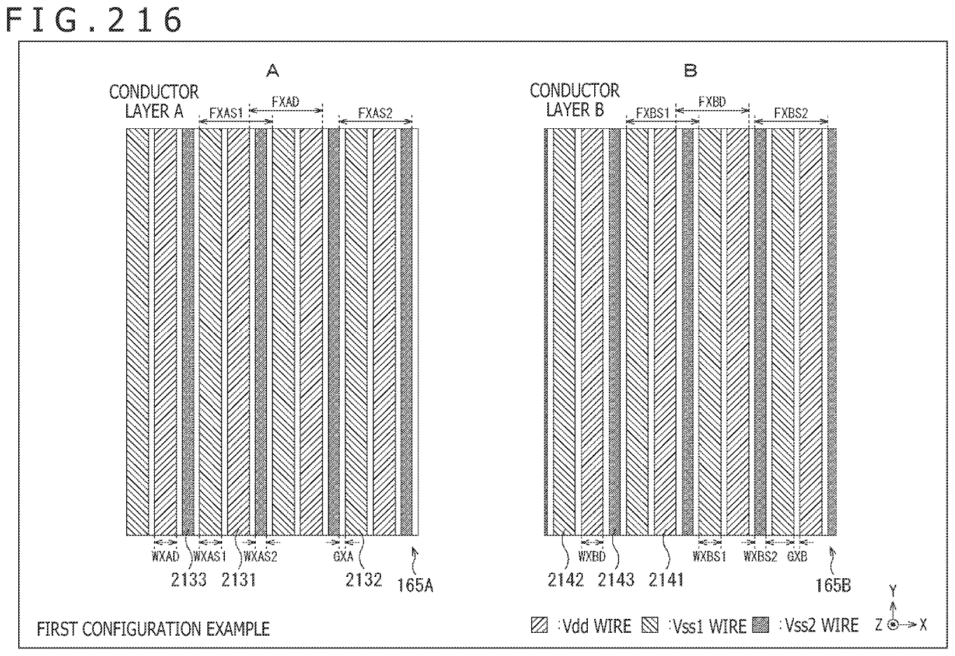

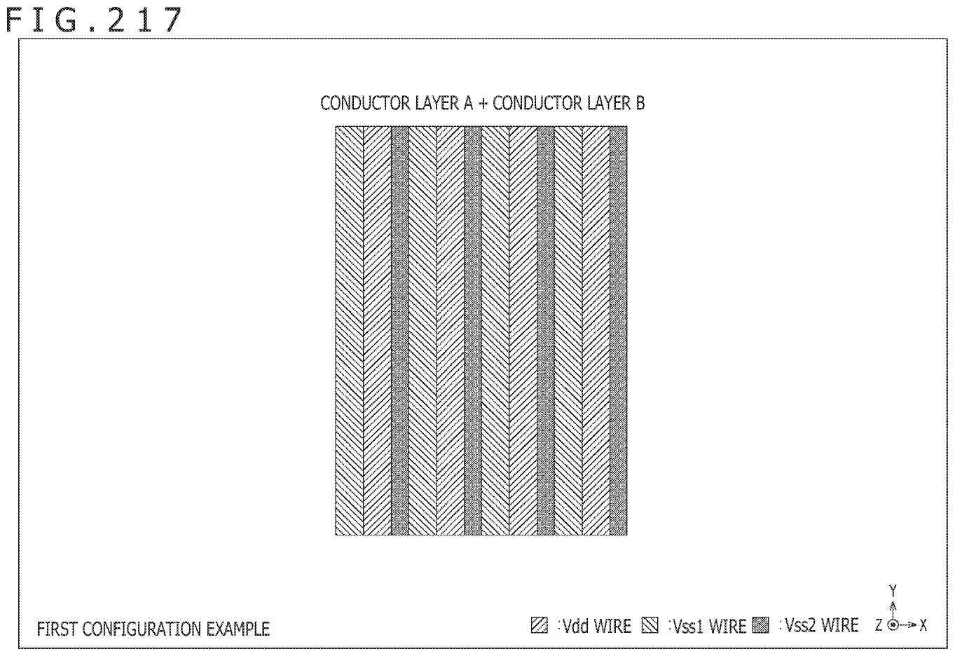

FIG. 216 and FIG. 217 depict a second modification example of the first configuration example of three power supplies.

In the coordinate systems in both FIG. 216 and FIG. 217, the X axis lies in the lateral direction, the Y axis lies in the longitudinal direction, and the Z axis lies in a direction perpendicular to the XY plane.

A in FIG. 216 depicts a plan view of the conductor layer A, and B in FIG. 216 depicts a plan view of the conductor layer B. Note that FIG. 216 may be regarded as depicting the entire region of each conductor layer or may be regarded as depicting a partial region of each conductor layer.

While the conductor layer A in the first configuration example depicted in A in FIG. 212 has a configuration in which three conductors, a Vdd conductor, a Vss1 conductor and a Vss2 conductor, that are arranged regularly in the X direction have the same conductor width, the conductor layer A in the second modification example in A in FIG. 216 has a configuration in which, while a Vdd conductor and a Vss1 conductor have the same conductor width, the conductor width of a Vss2 conductor is made smaller than the conductor width of the Vdd conductor and the Vss1 conductor ((conductor width WXAD)=(conductor width WXAS1)>(conductor width WXAS2)).

Specifically, the conductor layer A in A in FIG. 216 includes three linear conductors 2131 to 2133 that are long in the Y direction, and arranged in the X direction in a predetermined order, and sets of the three linear conductors 2131 to 2133 are arranged regularly in the X direction.

The linear conductors 2131 are wires (Vdd wires) connected to the first power supply Vdd. The linear conductors 2132 are wires (Vss1 wires) connected to the second power supply Vss1. The linear conductors 2133 are wires (Vss2 wires) connected to the third power supply Vss2.

The linear conductors 2131 have the X-direction conductor width WXAD, the linear conductors 2132 have the X-direction conductor width WXAS1, and the linear conductors 2133 have the X-direction conductor width WXAS2. For example, the conductor width WXAD of the linear conductors 2131, and the conductor width WXAS1 of the linear conductors 2132 are the same ((conductor width WXAD)=(conductor width WXAS1)), and the conductor width WXAS2 of the linear conductors 2133 is made smaller than the conductor width WXAD of the linear conductors 2131, and the conductor width WXAS1 of the linear conductors 2132 ((conductor width WXAD)=(conductor width WXAS1)>(conductor width WXAS2)). In addition, there is a gap with the gap width GXA between two adjacent ones of the linear conductors 2131 to 2133.

The linear conductors 2131 are arranged regularly in the X direction at the conductor pitch FXAD, and the linear conductors 2132 are arranged regularly in the X direction at the conductor pitch FXAS1. Similarly, the linear conductors 2133 are arranged regularly in the X direction at the conductor pitch FXAS2. For example, the conductor pitch FXAD, the conductor pitch FXAS1 and the conductor pitch FXAS2 are the same ((conductor pitch FXAD)=(conductor pitch FXAS1)=(conductor pitch FXAS2)).

Accordingly, in a rectangular region in a predetermined range of the conductor layer A, the sum total of the X-direction conductor widths WXAD of linear conductors 2131 connected to the first power supply Vdd, and the sum total of the X-direction conductor widths WXAS1 of linear conductors 2132 connected to the second power supply Vss1 are the same. Then, the sum total of the X-direction conductor widths WXAS2 of linear conductors 2133 connected to the third power supply Vss2 is smaller than the sum total of the X-direction conductor widths WXAS1 of linear conductors 2132 connected to the second power supply Vss1.

In addition, in a rectangular region in a predetermined range of the conductor layer A, the conductor area size of linear conductors 2131 connected to the first power supply Vdd, and the conductor area size of linear conductors 2132 connected to the second power supply Vss1 are the same. Then, the conductor area size of linear conductors 2133 connected to the third power supply Vss2 is smaller than the conductor area size of linear conductors 2132 connected to the second power supply Vss1.

Similarly to the conductor layer A in the second modification example, the conductor layer B in the second modification example in B in FIG. 216 also has a configuration in which Vdd conductors and Vss1 conductors have the same conductor width, and the conductor width of Vss2 conductors is made smaller than the conductor width of the Vdd conductors and the Vss1 conductors.

Specifically, the conductor layer B in B in FIG. 216 includes three linear conductors 2141 to 2143 that are long in the Y direction, and arranged in the X direction in a predetermined order, and sets of the three linear conductors 2141 to 2143 are arranged regularly in the X direction.

The linear conductors 2141 are wires (Vdd wires) connected to the first power supply Vdd. The linear conductors 2142 are wires (Vss1 wires) connected to the second power supply Vss1. The linear conductors 2143 are wires (Vss2 wires) connected to the third power supply Vss2.

The linear conductors 2141 have the X-direction conductor width WXBD, the linear conductors 2142 have the X-direction conductor width WXBS1, and the linear conductors 2143 have the X-direction conductor width WXBS2. For example, the conductor width WXBD of the linear conductors 2141, and the conductor width WXBS1 of the linear conductors 2142 are the same ((conductor width WXBD)=(conductor width WXBS1)), and the conductor width WXBS2 of the linear conductors 2143 is made smaller than the conductor width WXBD of the linear conductors 2141, and the conductor width WXBS1 of the linear conductors 2142 ((conductor width WXBD)=(conductor width WXBS1)>(conductor width WXBS2)). In addition, there is a gap with the gap width GXB between two adjacent ones of the linear conductors 2141 to 2143.

The linear conductors 2141 are arranged regularly in the X direction at the conductor pitch FXBD, and the linear conductors 2142 are arranged regularly in the X direction at the conductor pitch FXBS1. Similarly, the linear conductors 2143 are arranged regularly in the X direction at the conductor pitch FXBS2. For example, the conductor pitch FXBD, the conductor pitch FXBS1 and the conductor pitch FXBS2 are the same ((conductor pitch FXBD)=(conductor pitch FXBS1)=(conductor pitch FXBS2)).

Accordingly, in a rectangular region in a predetermined range of the conductor layer B, the sum total of the X-direction conductor widths WXBD of linear conductors 2141 connected to the first power supply Vdd, and the sum total of the X-direction conductor widths WXBS1 of linear conductors 2142 connected to the second power supply Vss1 are the same. Then, the sum total of the X-direction conductor widths WXBS2 of linear conductors 2143 connected to the third power supply Vss2 is smaller than the sum total of the X-direction conductor widths WXBS1 of linear conductors 2142 connected to the second power supply Vss1.

In addition, in a rectangular region in a predetermined range of the conductor layer B, the conductor area size of linear conductors 2141 connected to the first power supply Vdd, and the conductor area size of linear conductors 2142 connected to the second power supply Vss1 are the same. Then, the conductor area size of linear conductors 2143 connected to the third power supply Vss2 is smaller than the conductor area size of linear conductors 2142 connected to the second power supply Vss1.

FIG. 217 is a plan view depicting the stacked state of the conductor layer A in A in FIG. 216, and the conductor layer B in B in FIG. 216.

By setting the amount of displacement between the X-direction positions of the linear conductors in the conductor layer A and the conductor layer B, and the X-direction conductor widths and gap widths such that they satisfy a predetermined condition, a light-blocking structure can be formed with the conductor layer A and the conductor layer B in the stacked state as depicted in FIG. 217, and hot carrier light emissions can be blocked.

Linear conductors that are in the conductor layers A and B, and connected to the same power supplies may be electrically connected via conductor vias extending in the Z direction, or the like in predetermined partial regions where the positions of the linear conductors overlap. While it is desirable in terms of voltage drops if linear conductors connected to the same power supplies are electrically connected, this is not essential, and they do not have to be connected.

In the thus-configured conductor layer A and conductor layer B in the second modification example of the first configuration example of three power supplies, because the sum total of the X-direction conductor widths of Vss2 conductors is smaller than the sum total of the X-direction conductor widths of Vss1 conductors, in a case in which the total current amount when the third power supply Vss2 is selected is smaller than the total current amount when the second power supply Vss1 is selected, the total amount of currents to flow through the Vss2 conductors is smaller than the total amount of currents to flow through the Vss1 conductors, and voltage drops are less likely to occur in the Vss2 conductors than in the Vss1 conductors. Thereby, the conductor resistance of the Vss2 conductors can be made higher than the conductor resistance of the Vss1 conductors if voltage drops are within a range that satisfies the tolerated level. Because if the conductor width WXAS2 of Vss2 conductors is made smaller, Vdd conductors and Vss1 conductors can be arranged densely, this leads to amelioration of voltage drops of the Vdd conductors and the Vss1 conductors, if voltage drops are compared on the premise that the wire region has the same area size. In addition, because the area size of an Aggressor loop that generates a magnetic field becomes smaller as conductor pitches become smaller, the inductive noise also can be ameliorated as explained with reference to FIG. 46 to FIG. 57.

### Third Modification Example of First Configuration Example of Three Power Supplies

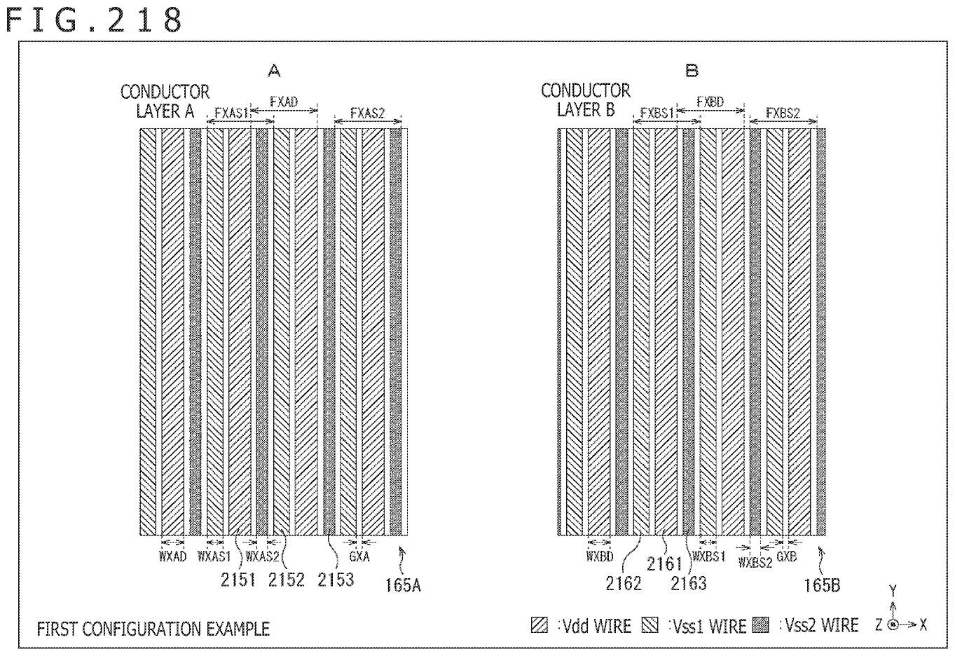

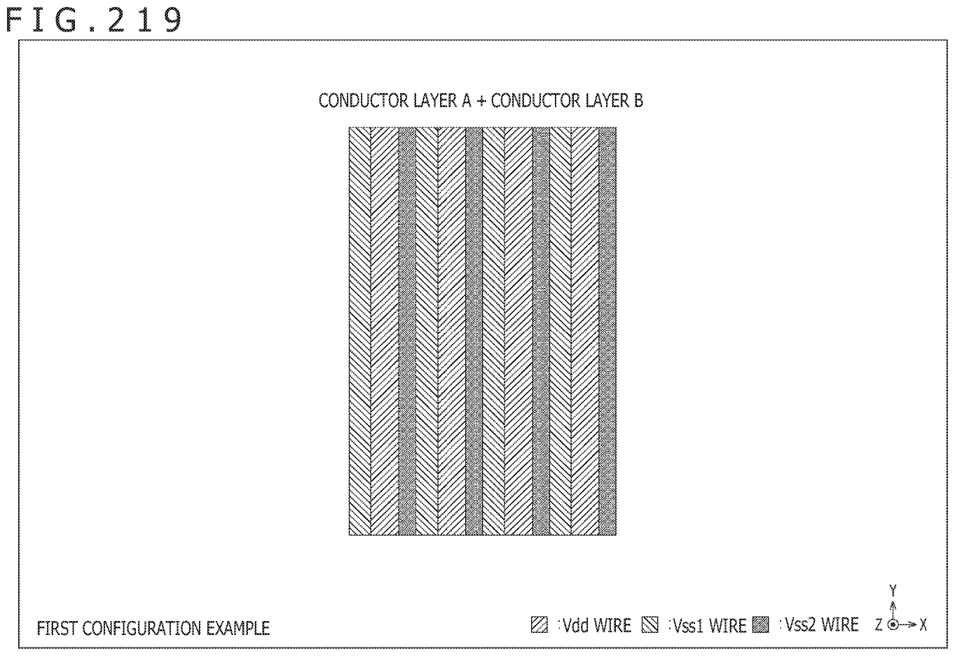

FIG. 218 and FIG. 219 depict a third modification example of the first configuration example of three power supplies.

In the coordinate systems in both FIG. 218 and FIG. 219, the X axis lies in the lateral direction, the Y axis lies in the longitudinal direction, and the Z axis lies in a direction perpendicular to the XY plane.

A in FIG. 218 depicts a plan view of the conductor layer A, and B in FIG. 218 depicts a plan view of the conductor layer B. Note that FIG. 218 may be regarded as depicting the entire region of each conductor layer or may be regarded as depicting a partial region of each conductor layer.

While the conductor layer A in the first configuration example depicted in A in FIG. 212 has a configuration in which three conductors, a Vdd conductor, a Vss1 conductor and a Vss2 conductor, that are arranged regularly in the X direction have the same conductor width, the conductor layer A in the third modification example in A in FIG. 218 has a configuration in which the conductor width of the Vss1 conductor is made smaller than the conductor width of the Vdd conductor, and furthermore the conductor width of the Vss2 conductor is made smaller than the conductor width of the Vss1 conductor ((conductor width WXAD)>(conductor width WXAS1)>(conductor width WXAS2)).

Specifically, the conductor layer A in A in FIG. 218 includes three linear conductors 2151 to 2153 that are long in the Y direction, and arranged in the X direction in a predetermined order, and sets of the three linear conductors 2151 to 2153 are arranged regularly in the X direction.

The linear conductors 2151 are wires (Vdd wires) connected to the first power supply Vdd. The linear conductors 2152 are wires (Vss1 wires) connected to the second power supply Vss1. The linear conductors 2153 are wires (Vss2 wires) connected to the third power supply Vss2.

The linear conductors 2151 have the X-direction conductor width WXAD, the linear conductors 2152 have the X-direction conductor width WXAS1, and the linear conductors 2153 have the X-direction conductor width WXAS2. The conductor width WXAD of the linear conductors 2151 is made larger than the conductor width WXAS1 of the linear conductors 2152 ((conductor width WXAD)>(conductor width WXAS1)), and the conductor width WXAS2 of the linear conductors 2153 is made smaller than the conductor width WXAS1 of the linear conductors 2152 ((conductor width WXAS1)>(conductor width WXAS2)). In addition, there is a gap with the gap width GXA between two adjacent ones of the linear conductors 2151 to 2153.

The linear conductors 2151 are arranged regularly in the X direction at the conductor pitch FXAD, and the linear conductors 2152 are arranged regularly in the X direction at the conductor pitch FXAS1. Similarly, the linear conductors 2153 are arranged regularly in the X direction at the conductor pitch FXAS2. For example, the conductor pitch FXAD, the conductor pitch FXAS1 and the conductor pitch FXAS2 are the same ((conductor pitch FXAD)=(conductor pitch FXAS1)=(conductor pitch FXAS2)).

Accordingly, in a rectangular region in a predetermined range of the conductor layer A, the sum total of the X-direction conductor widths WXAS1 of linear conductors 2152 connected to the second power supply Vss1 is smaller than the sum total of the X-direction conductor widths WXAD of linear conductors 2151 connected to the first power supply Vdd. Then, the sum total of the X-direction conductor widths WXAS2 of linear conductors 2153 connected to the third power supply Vss2 is smaller than the sum total of the X-direction conductor widths WXAS1 of linear conductors 2152 connected to the second power supply Vss1.

In a rectangular region in a predetermined range of the conductor layer A, the conductor area size of linear conductors 2152 connected to the second power supply Vss1 is smaller than the conductor area size of linear conductors 2151 connected to the first power supply Vdd. Then, the conductor area size of linear conductors 2153 connected to the third power supply Vss2 is smaller than the conductor area size of linear conductors 2152 connected to the second power supply Vss1. That is, the Vdd conductors, the Vss1 conductors and the Vss2 conductors in the conductor layer A have mutually different conductor area sizes.

Similarly to the conductor layer A in the third modification example, the conductor layer B in the third modification example in B in FIG. 218 also has a configuration in which the conductor width of the Vss1 conductors is made smaller than the conductor width of the Vdd conductors, and the conductor width of the Vss2 conductors is made smaller than the conductor width of the Vss1 conductors ((conductor width WXBD)>(conductor width WXBS1)>(conductor width WXBS2)).

Specifically, the conductor layer B in B in FIG. 218 includes three linear conductors 2161 to 2163 that are long in the Y direction, and arranged in the X direction in a predetermined order, and sets of the three linear conductors 2161 to 2163 are arranged regularly in the X direction.

The linear conductors 2161 are wires (Vdd wires) connected to the first power supply Vdd. The linear conductors 2162 are wires (Vss1 wires) connected to the second power supply Vss1. The linear conductors 2163 are wires (Vss2 wires) connected to the third power supply Vss2.

The linear conductors 2161 have the X-direction conductor width WXBD, the linear conductors 2162 have the X-direction conductor width WXBS1, and the linear conductors 2163 have the X-direction conductor width WXAB2. The conductor width WXBD of the linear conductors 2161 is made larger than the conductor width WXBS1 of the linear conductors 2162 ((conductor width WXBD)>(conductor width WXBS1)), and the conductor width WXBS2 of the linear conductors 2163 is made smaller than the conductor width WXBS1 of the linear conductors 2162 ((conductor width WXBS1)>(conductor width WXBS2)). In addition, there is a gap with the gap width GXB between two adjacent ones of the linear conductors 2161 to 2163.

The linear conductors 2161 are arranged regularly in the X direction at the conductor pitch FXBD, and the linear conductors 2162 are arranged regularly in the X direction at the conductor pitch FXBS1. Similarly, the linear conductors 2163 are arranged regularly in the X direction at the conductor pitch FXBS2. For example, the conductor pitch FXBD, the conductor pitch FXBS1 and the conductor pitch FXBS2 are the same ((conductor pitch FXBD)=(conductor pitch FXBS1)=(conductor pitch FXBS2)).

Accordingly, in a rectangular region in a predetermined range of the conductor layer B, the sum total of the X-direction conductor widths WXBS1 of linear conductors 2162 connected to the second power supply Vss1 is smaller than the sum total of the X-direction conductor widths WXBD of linear conductors 2161 connected to the first power supply Vdd. Then, the sum total of the X-direction conductor widths WXBS2 of linear conductors 2163 connected to the third power supply Vss2 is smaller than the sum total of the X-direction conductor widths WXBS1 of linear conductors 2162 connected to the second power supply Vss1.

In addition, in a rectangular region in a predetermined range of the conductor layer B, the conductor area size of linear conductors 2162 connected to the second power supply Vss1 is smaller than the conductor area size of linear conductors 2161 connected to the first power supply Vdd. Then, the conductor area size of linear conductors 2163 connected to the third power supply Vss2 is smaller than the conductor area size of linear conductors 2162 connected to the second power supply Vss1. That is, the Vdd conductors, the Vss1 conductors, and the Vss2 conductors of the conductor layer B have mutually different conductor area sizes.

FIG. 219 is a plan view depicting the stacked state of the conductor layer A in A in FIG. 218, and the conductor layer B in B in FIG. 218.

By setting the amount of displacement between the X-direction positions of the linear conductors in the conductor layer A and the conductor layer B, and the X-direction conductor widths and gap widths such that they satisfy a predetermined condition, a light-blocking structure can be formed with the conductor layer A and the conductor layer B in the stacked state as depicted in FIG. 219, and hot carrier light emissions can be blocked.

Linear conductors that are in the conductor layers A and B, and connected to the same power supplies may be electrically connected via conductor vias extending in the Z direction, or the like in predetermined partial regions where the positions of the linear conductors overlap. While it is desirable in terms of voltage drops if linear conductors connected to the same power supplies are electrically connected, this is not essential, and they do not have to be connected.

In the thus-configured conductor layer A and conductor layer B in the third modification example of the first configuration example of three power supplies, because the sum total of the X-direction conductor widths of Vss2 conductors is smaller than the sum total of the X-direction conductor widths of Vss1 conductors, in a case in which the total current amount when the third power supply Vss2 is selected is smaller than the total current amount when the second power supply Vss1 is selected, the total amount of currents to flow through the Vss2 conductors is smaller than the total amount of currents to flow through the Vss1 conductors, and voltage drops are less likely to occur in the Vss2 conductors than in the Vss1 conductors. Thereby, the conductor resistance of the Vss2 conductors can be made higher than the conductor resistance of the Vss1 conductors if voltage drops are within a range that satisfies the tolerated level.

In a configuration in which the second power supply Vss1 and the third power supply Vss2 are switched selectively, the Vdd conductors are elements to be used in common. By making voltage drops less likely to occur in the Vdd conductors to be used in common than in the Vss1 conductors and the Vss2 conductors, voltage drops can be ameliorated for both the combination of the Vdd conductors and the Vss1 conductors, and the combination of the Vdd conductors and the Vss2 conductors in some cases. In addition, because conductors are arranged more densely in the third modification example than in the second modification example, voltage drops and inductive noise can be ameliorated further in some cases.

### Fourth Modification Example of First Configuration Example of Three Power Supplies

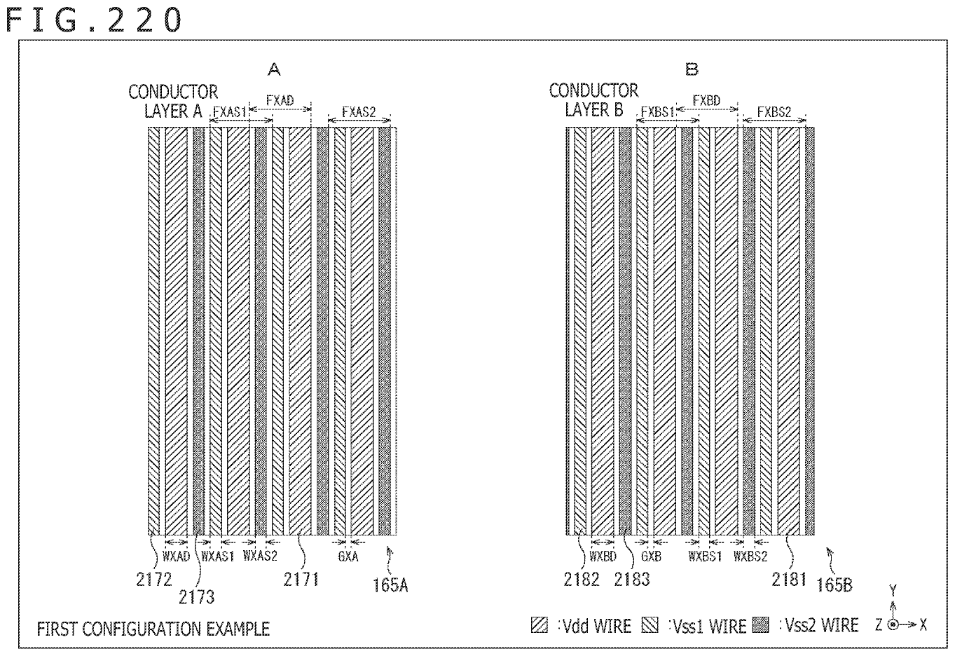

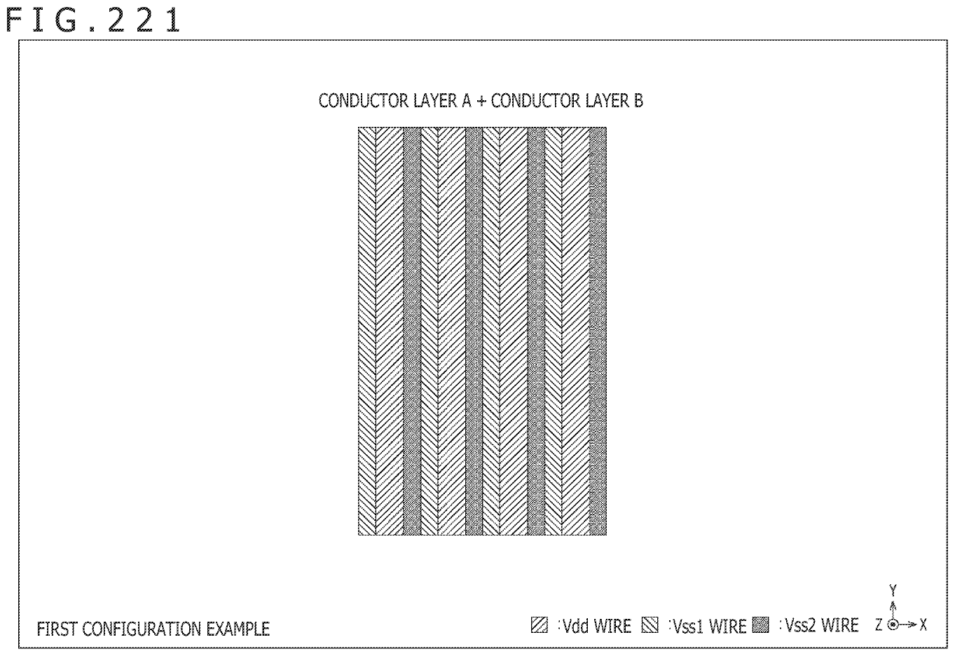

FIG. 220 and FIG. 221 depict a fourth modification example of the first configuration example of three power supplies.

In the coordinate systems in both FIG. 220 and FIG. 221, the X axis lies in the lateral direction, the Y axis lies in the longitudinal direction, and the Z axis lies in a direction perpendicular to the XY plane.

A in FIG. 220 depicts a plan view of the conductor layer A, and B in FIG. 220 depicts a plan view of the conductor layer B. Note that FIG. 220 may be regarded as depicting the entire region of each conductor layer or may be regarded as depicting a partial region of each conductor layer.

While the conductor layer A in the first configuration example depicted in A in FIG. 220 has a configuration in which three conductors, a Vdd conductor, a Vss1 conductor and a Vss2 conductor, that are arranged regularly in the X direction have the same conductor width, the conductor layer A in the fourth modification example in A in FIG. 220 has a configuration in which the conductor widths of the Vss1 conductor and the Vss2 conductor are made smaller than the conductor width of the Vdd conductor, and the conductor widths of the Vss1 conductor and the Vss2 conductor are made the same ((conductor width WXAD)>(conductor width WXAS1)=(conductor width WXAS2)).

Specifically, the conductor layer A in A in FIG. 220 includes three linear conductors 2171 to 2173 that are long in the Y direction, and arranged in the X direction in a predetermined order, and sets of the three linear conductors 2171 to 2173 are arranged regularly in the X direction.

The linear conductors 2171 are wires (Vdd wires) connected to the first power supply Vdd. The linear conductors 2172 are wires (Vss1 wires) connected to the second power supply Vss1. The linear conductors 2173 are wires (Vss2 wires) connected to the third power supply Vss2.

The linear conductors 2171 have the X-direction conductor width WXAD, the linear conductors 2172 have the X-direction conductor width WXAS1, and the linear conductors 2173 have the X-direction conductor width WXAS2. The conductor width WXAD of the linear conductors 2171 is larger than both the conductor width WXAS1 of the linear conductors 2172, and the conductor width WXAS2 of the linear conductors 2173, and, for example, the conductor width WXAS1 of the linear conductors 2172, and the conductor width WXAS2 of the linear conductors 2173 are the same ((conductor width WXAD)>(conductor width WXAS1)=(conductor width WXAS2)). In addition, there is a gap with the gap width GXA between two adjacent ones of the linear conductors 2171 to 2173.

The linear conductors 2171 are arranged regularly in the X direction at the conductor pitch FXAD, and the linear conductors 2172 are arranged regularly in the X direction at the conductor pitch FXAS1. Similarly, the linear conductors 2173 are arranged regularly in the X direction at the conductor pitch FXAS2. For example, the conductor pitch FXAD, the conductor pitch FXAS1 and the conductor pitch FXAS2 are the same ((conductor pitch FXAD)=(conductor pitch FXAS1)=(conductor pitch FXAS2)).

Accordingly, in a rectangular region in a predetermined range of the conductor layer A, each of the sum total of the X-direction conductor widths WXAS1 of linear conductors 2172 connected to the second power supply Vss1, and the sum total of the X-direction conductor widths WXAS2 of linear conductors 2173 connected to the third power supply Vss2 is smaller than the sum total of the X-direction conductor widths WXAD of linear conductors 2171 connected to the first power supply Vdd. Then, the sum total of the X-direction conductor widths WXAS1 of linear conductors 2172 connected to the second power supply Vss1, and the sum total of the X-direction conductor widths WXAS2 of linear conductors 2173 connected to the third power supply Vss2 are equal to each other.

In addition, in a rectangular region in a predetermined range of the conductor layer A, each of the conductor area size of linear conductors 2172 connected to the second power supply Vss1, and the conductor area size of linear conductors 2173 connected to the third power supply Vss2 is smaller than the conductor area size of linear conductors 2171 connected to the first power supply Vdd. Then, the conductor area size of linear conductors 2172 connected to the second power supply Vss1, and the conductor area size of linear conductors 2173 connected to the third power supply Vss2 are equal to each other.

Similarly to the conductor layer A in the fourth modification example, the conductor layer B in the fourth modification example in B in FIG. 220 also has a configuration in which the conductor widths of the Vss1 conductors and the Vss2 conductors are made smaller than the conductor width of the Vdd conductors, and the conductor widths of the Vss1 conductors and the Vss2 conductors are made the same ((conductor width WXBD)>(conductor width WXBS1)=(conductor width WXBS2)).

Specifically, the conductor layer B in B in FIG. 220 includes three linear conductors 2181 to 2183 that are long in the Y direction, and arranged in the X direction in a predetermined order, and sets of the three linear conductors 2181 to 2183 are arranged regularly in the X direction.

The linear conductors 2181 are wires (Vdd wires) connected to the first power supply Vdd. The linear conductors 2182 are wires (Vss1 wires) connected to the second power supply Vss1. The linear conductors 2183 are wires (Vss2 wires) connected to the third power supply Vss2.

The linear conductors 2181 have the X-direction conductor width WXBD, the linear conductors 2182 have the X-direction conductor width WXBS1, and the linear conductors 2183 have the X-direction conductor width WXAB2. The conductor width WXBD of the linear conductors 2181 is larger than both the conductor width WXBS1 of the linear conductors 2182, and the conductor width WXBS2 of the linear conductors 2183, and, for example, the conductor width WXBS1 of the linear conductors 2182, and the conductor width WXBS2 of the linear conductors 2183 are the same ((conductor width WXBD)>(conductor width WXBS1)=(conductor width WXBS2)). In addition, there is a gap with the gap width GXB between two adjacent ones of the linear conductors 2181 to 2183.

The linear conductors 2181 are arranged regularly in the X direction at the conductor pitch FXBD, and the linear conductors 2182 are arranged regularly in the X direction at the conductor pitch FXBS1. Similarly, the linear conductors 2183 are arranged regularly in the X direction at the conductor pitch FXBS2. The conductor pitch FXBD, the conductor pitch FXBS1 and the conductor pitch FXBS2 are the same ((conductor pitch FXBD)=(conductor pitch FXBS1)=(conductor pitch FXBS2)).

Accordingly, in a rectangular region in a predetermined range of the conductor layer B, each of the sum total of the X-direction conductor widths WXBS1 of linear conductors 2182 connected to the second power supply Vss1, and the sum total of the X-direction conductor widths WXBS2 of linear conductors 2183 connected to the third power supply Vss2 is smaller than the sum total of the X-direction conductor widths WXBD of linear conductors 2181 connected to the first power supply Vdd. Then, the sum total of the X-direction conductor widths WXBS1 of linear conductors 2182 connected to the second power supply Vss1, and the sum total of the X-direction conductor widths WXBS2 of linear conductors 2183 connected to the third power supply Vss2 are equal to each other.

In addition, in a rectangular region in a predetermined range of the conductor layer B, each of the conductor area size of linear conductors 2182 connected to the second power supply Vss1, and the conductor area size of linear conductors 2183 connected to the third power supply Vss2 is smaller than the conductor area size of linear conductors 2181 connected to the first power supply Vdd. Then, the conductor area size of linear conductors 2182 connected to the second power supply Vss1, and the conductor area size of linear conductors 2183 connected to the third power supply Vss2 are equal to each other.

FIG. 221 is a plan view depicting the stacked state of the conductor layer A in A in FIG. 220, and the conductor layer B in B in FIG. 220.

By setting the amount of displacement between the X-direction positions of the linear conductors in the conductor layer A and the conductor layer B, and the X-direction conductor widths and gap widths such that they satisfy a predetermined condition, a light-blocking structure can be formed with the conductor layer A and the conductor layer B in the stacked state as depicted in FIG. 221, and hot carrier light emissions can be blocked.

Linear conductors that are in the conductor layers A and B, and connected to the same power supplies may be electrically connected via conductor vias extending in the Z direction, or the like in predetermined partial regions where the positions of the linear conductors overlap. While it is desirable in terms of voltage drops if linear conductors connected to the same power supplies are electrically connected, this is not essential, and they do not have to be connected.

In the thus-configured conductor layer A and conductor layer B in the fourth modification example of the first configuration example of three power supplies, the structural difference between the combination of the Vdd conductors and the Vss1 conductors, and the combination of the Vdd conductors and the Vss2 conductors can be made small in a configuration in which the second power supply Vss1 and the third power supply Vss2 are switched selectively. Thereby, for example, in a case in which the second power supply Vss1 and the third power supply Vss2 have the same power supply voltage, differences in voltage drops, and differences in inductive noise can be made small. In addition, because conductors are arranged more densely in the fourth modification example than in the third modification example, voltage drops and inductive noise can be ameliorated further in some cases.

While the conductor layer A and the conductor layer B form a light-blocking structure in the examples explained in the first configuration example of three power supplies mentioned above, and the first modification example to fourth modification example thereof, the conductor layer A and the conductor layer B in the stacked state need not necessarily form a light-blocking structure. For example, the X-direction gap width may be larger than the X-direction positional displacement in one possible configuration, the X-direction positional displacement may be larger than X-direction conductor widths in another possible configuration, and the X-direction positional displacement may be zero or a value close to zero. Note that depending on the configurations of linear conductors in the conductor layer A and the conductor layer B, the conductor layer A and the conductor layer B in the stacked state form a light-blocking structure even if the X-direction positional displacement is made larger than X-direction conductor widths, in some cases. In addition, either one of the conductor layer A and the conductor layer B may not be provided in one possible configuration, and either the conductor layer A or the conductor layer B may have a conductor arrangement other than the configurations mentioned above. Even in a case in which the conductor layer A and the conductor layer B in the stacked state do not form a light-blocking structure, voltage drops and inductive noise can be ameliorated.

### Second Configuration Example of Three Power Supplies

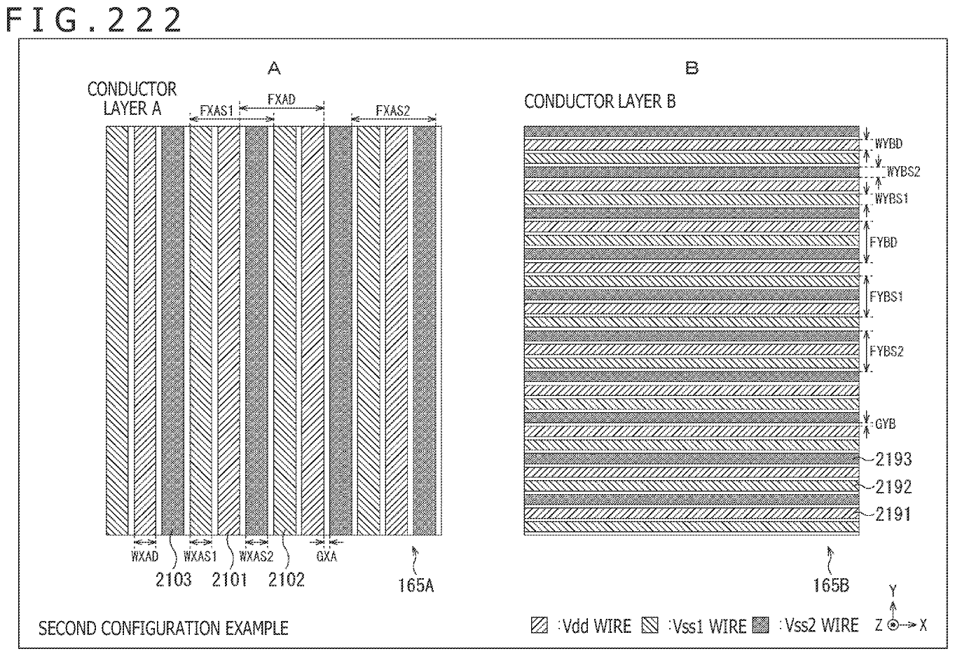

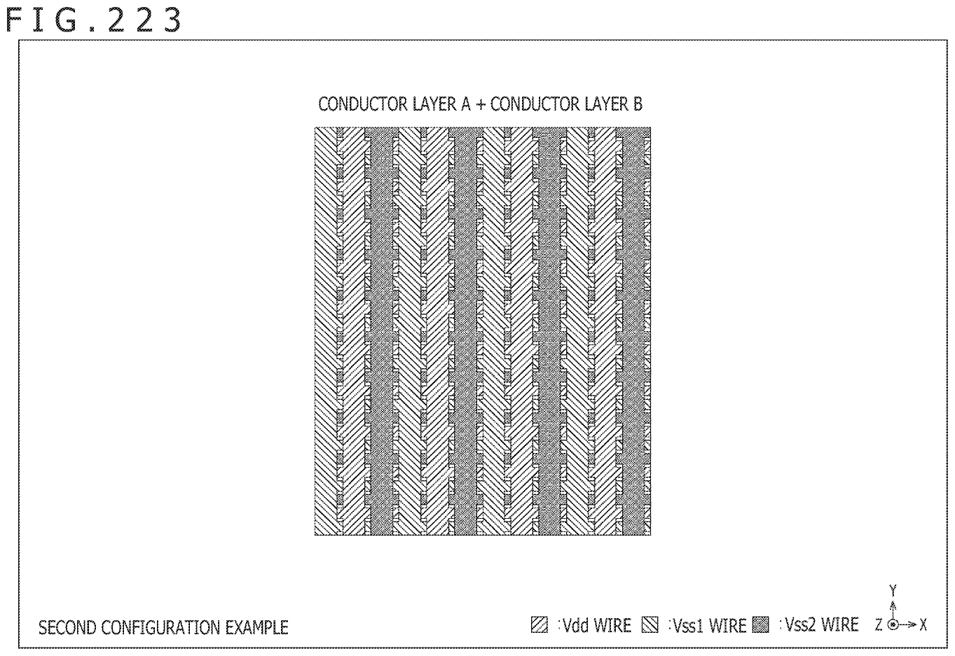

FIG. 222 and FIG. 223 depict a second configuration example of three power supplies.

In the coordinate systems in both FIG. 222 and FIG. 223, the X axis lies in the lateral direction, the Y axis lies in the longitudinal direction, and the Z axis lies in a direction perpendicular to the XY plane.

A in FIG. 222 depicts a plan view of the conductor layer A, and B in FIG. 222 depicts a plan view of the conductor layer B. Note that FIG. 222 may be regarded as depicting the entire region of each conductor layer or may be regarded as depicting a partial region of each conductor layer.

While the repetition directions of linear conductors in the conductor layer A and the conductor layer B are the same and are the X direction in the first configuration example and modification examples thereof mentioned above, the repetition direction of linear conductor in the conductor layer A and the repetition direction of linear conductor in the conductor layer B are orthogonal directions and are the X direction and the Y direction in the configuration in the second configuration example.

The conductor layer A in A in FIG. 222 is the same as the conductor layer A in the first configuration example depicted in A in FIG. 212, and so an explanation thereof is omitted. The repetition direction of the linear conductors 2101 to 2103 in the conductor layer A that are long in the Y direction is the X direction.

In contrast, the repetition direction of linear conductors in the conductor layer B in B in FIG. 222 is the Y direction orthogonal to the X direction, which is the repetition direction of the conductor layer A.

Specifically, the conductor layer B includes three linear conductors 2191 to 2193 that are long in the X direction, and arranged in the Y direction in a predetermined order, and sets of the three linear conductors 2191 to 2193 are arranged regularly in the Y direction.

The linear conductors 2191 are wires (Vdd wires) connected to the first power supply Vdd. The linear conductors 2192 are wires (Vss1 wires) connected to the second power supply Vss1. The linear conductors 2193 are wires (Vss2 wires) connected to the third power supply Vss2.

Accordingly, while the three linear conductors 2191 to 2193 are arranged in the positive direction along the Y axis in the order of a Vdd wire, a Vss2 wire and a Vss1 wire in B in FIG. 222, the order of arrangement of the three linear conductors 2191 to 2193 is not limited to this example, but can be any order.

The linear conductors 2191 have a Y-direction conductor width WYBD, the linear conductors 2192 have a Y-direction conductor width WYBS1, and the linear conductors 2193 have a Y-direction conductor width WYBS2. For example, the conductor width WYBD of the linear conductors 2191, the conductor width WYBS1 of the linear conductors 2192, and the conductor width WYBS2 of the linear conductors 2193 are the same ((conductor width WYBD)=(conductor width WYBS1)=(conductor width WYBS2)). There is a gap with the gap width GYB between two adjacent ones of the linear conductors 2191 to 2193.

Then, the linear conductors 2191 are arranged regularly in the Y direction at a conductor pitch FYBD. The linear conductors 2192 are arranged regularly in the Y direction at a conductor pitch FYBS1, and the linear conductors 2193 are arranged regularly in the Y direction at a conductor pitch FYBS2. For example, the conductor pitch FYBD, the conductor pitch FYBS1 and the conductor pitch FYBS2 are the same ((conductor pitch FYBD)=(conductor pitch FYBS1)=(conductor pitch FYBS2)).

Accordingly, in a rectangular region in a predetermined range of the conductor layer B, the sum total of the Y-direction conductor widths WYBD of linear conductors 2191 connected to the first power supply Vdd, the sum total of the Y-direction conductor widths WYBS1 of linear conductors 2192 connected to the second power supply Vss1, and the sum total of the Y-direction conductor widths WYBS2 of linear conductors 2193 connected to the third power supply Vss2 are the same.

In addition, in a rectangular region in a predetermined range of the conductor layer B, the conductor area size of linear conductors 2191 connected to the first power supply Vdd, the conductor area size of linear conductors 2192 connected to the second power supply Vss1, and the conductor area size of linear conductors 2193 connected to the third power supply Vss2 are the same.

FIG. 223 is a plan view depicting the stacked state of the conductor layer A in A in FIG. 222, and the conductor layer B in B in FIG. 222.

As depicted in FIG. 223, the stacking of the conductor layer A and the conductor layer B in the second configuration example, that is, the stacking of the conductor layer A having a regular arrangement of the linear conductors 2101 to 2103 that are long in the Y direction, and the conductor layer B having a regular arrangement of the linear conductors 2191 to 2193 that are long in the X direction cannot realize a full light-blocking structure, but can provide a certain degree of light-blocking property.

Linear conductors that are in the conductor layers A and B, and connected to the same power supplies may be electrically connected via conductor vias extending in the Z direction, or the like in predetermined partial regions where the positions of the linear conductors overlap. While it is desirable in terms of voltage drops if linear conductors connected to the same power supplies are electrically connected, this is not essential, and they do not have to be connected.

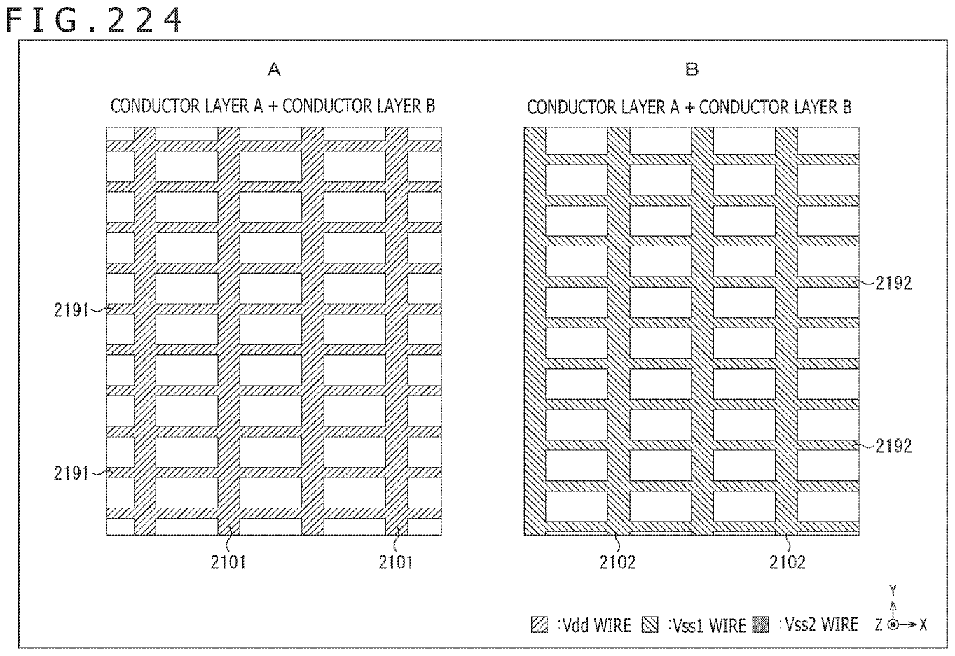

A in FIG. 224 is a plan view depicting the stacked state of only the linear conductors 2101 and the linear conductors 2191, which are Vdd conductors in the conductor layer A and the conductor layer B.

B in FIG. 224 is a plan view depicting the stacked state of only the linear conductors 2102 and the linear conductors 2192, which are Vss1 conductors in the conductor layer A and the conductor layer B.

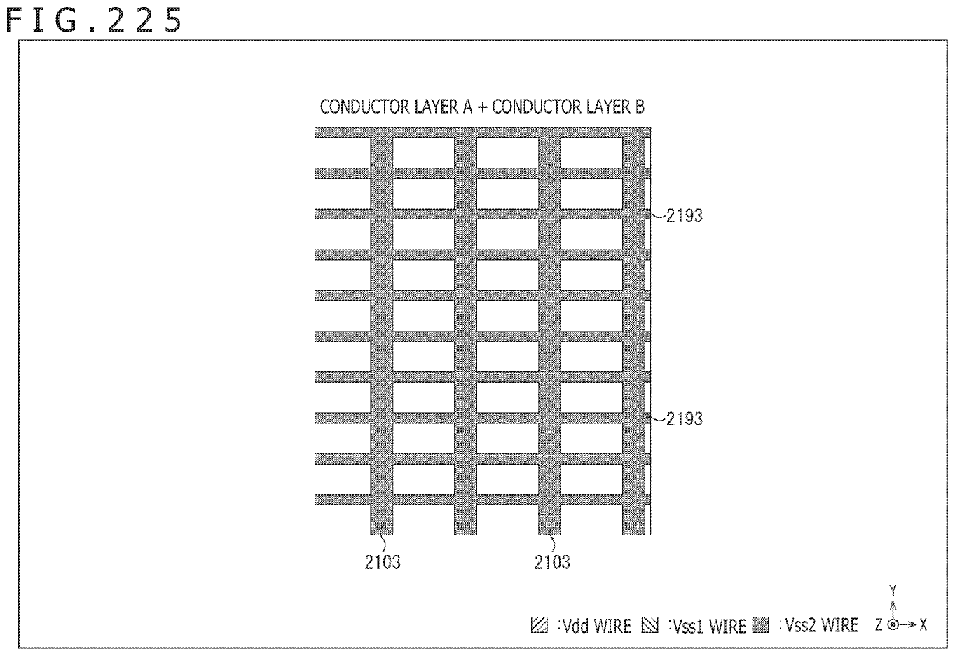

FIG. 225 is a plan view depicting the stacked state of only the linear conductors 2103 and the linear conductors 2193, which are Vss2 conductors in the conductor layer A and the conductor layer B.

In a case in which linear conductors that are in the conductor layers A and B and are connected to the same power supplies are electrically connected by conductor vias in the Z direction, or the like, a mesh structure of three power supplies of the Vdd conductors, the Vss1 conductors and the Vss2 conductors can be realized by the two layers, the conductor layer A and the conductor layer B, as depicted in FIG. 224 and FIG. 225. For example, in a case in which three power supplies are realized by using conductor layers of mesh conductors as in the fourth configuration example of the conductor layers A and B depicted in FIG. 25, three conductor layers are necessary. Accordingly, the second configuration example of three power supplies makes it possible to enhance the degree of freedom of layouts of wires with a small number of stacked layers.

By realizing a mesh structure of three power supplies with the two layers, the conductor layer A and the conductor layer B, currents are more easily diffused in the X direction, and so inductive noise can be ameliorated. In addition, depending on the pad arrangement, the conductor resistances as seen from pad ends can be reduced, and so voltage drops can be ameliorated.

According to the second configuration example of three power supplies mentioned above, if the linear conductors 2101 and the linear conductors 2191 that are connected to the same first power supply Vdd in the conductor layer A and the conductor layer B are compared with each other, the conductor width WXAD and the conductor width WYBD are different, but the conductor width WXAD and the conductor width WYBD may be made the same in one possible configuration. Similarly, the conductor pitch FXAD and the conductor pitch FYBD also are different, but the conductor pitch FXAD and the conductor pitch FYBD may be made the same in one possible configuration.

### First Modification Example of Second Configuration Example of Three Power Supplies

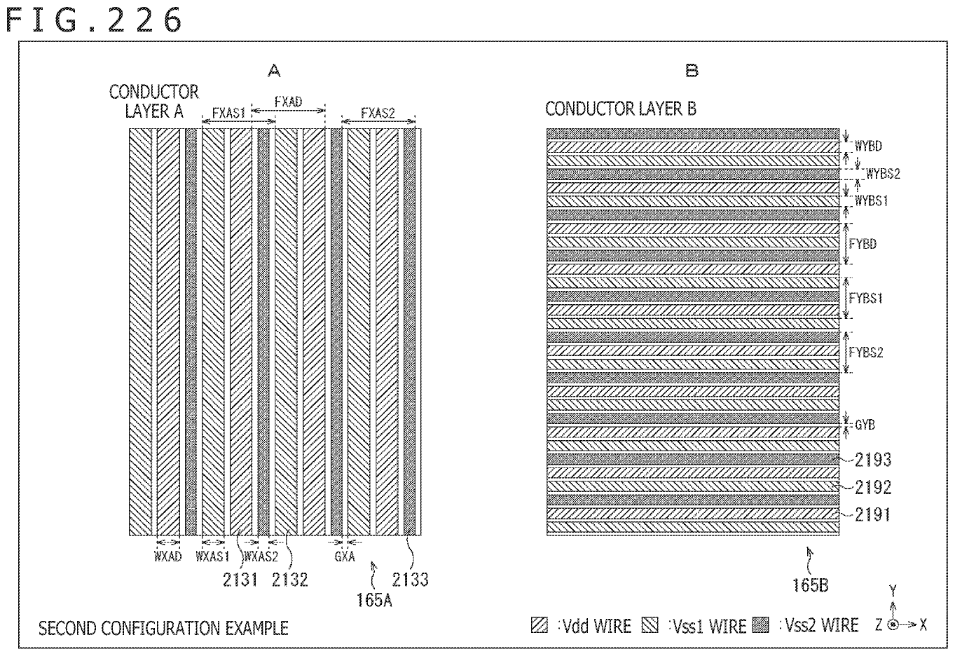

FIG. 226 depicts a first modification example of the second configuration example of three power supplies.

In the coordinate system in FIG. 226, the X axis lies in the lateral direction, the Y axis lies in the longitudinal direction, and the Z axis lies in a direction perpendicular to the XY plane.

A in FIG. 226 depicts a plan view of the conductor layer A, and B in FIG. 226 depicts a plan view of the conductor layer B. Note that FIG. 226 may be regarded as depicting the entire region of each conductor layer or may be regarded as depicting a partial region of each conductor layer. Regarding the first modification example of the second configuration example, a plan view depicting the stacked state of the conductor layer A and the conductor layer B is omitted.

The conductor layer A in A in FIG. 226 is the same as the conductor layer A in the second modification example of the first configuration example depicted in A in FIG. 216. In other words, while the conductor layer A in the second configuration example depicted in A in FIG. 222 has a configuration in which the Vdd conductor, the Vss1 conductor and the Vss2 conductor have the same conductor width, the conductor layer A in the first modification example in FIG. 226 has a configuration in which a Vdd conductor and a Vss1 conductor have the same conductor width, the conductor width of a Vss2 conductor is set smaller than the conductor width of the Vdd conductor and the Vss1 conductor ((conductor width WXAD)=(conductor width WXAS1)>(conductor width WXAS2)). Thereby, in the first modification example, the X-direction conductor pitch FXAD, conductor pitch FXAS1 and conductor pitch FXAS2 are made smaller than those in the second configuration example.

The conductor layer B in B in FIG. 226 is the same as the conductor layer B in the second configuration example depicted in B in FIG. 222, and so an explanation thereof is omitted.

### Second Modification Example of Second Configuration Example of Three Power Supplies

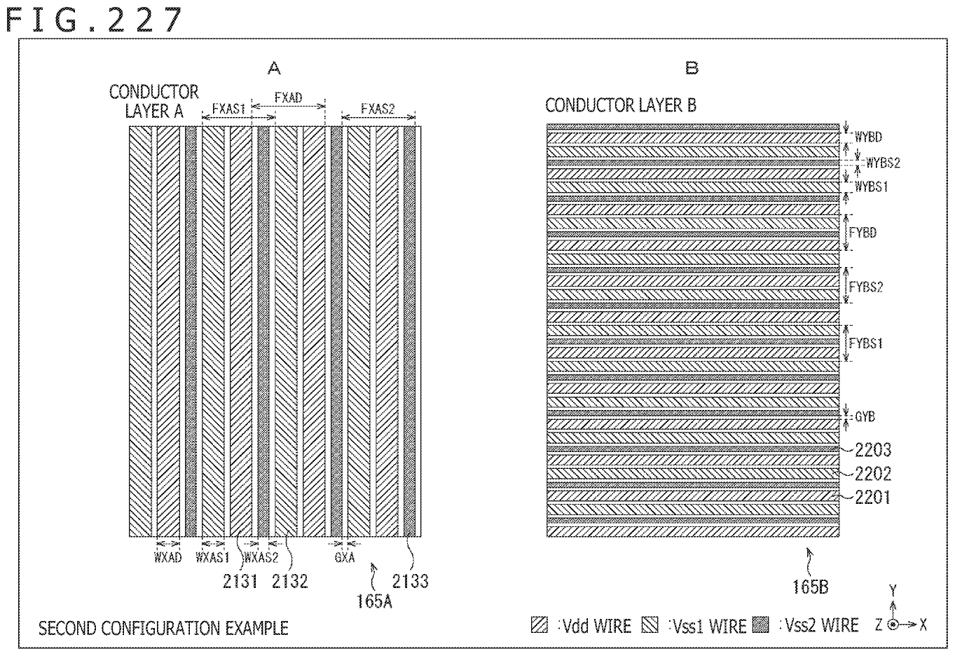

FIG. 227 depicts a second modification example of the second configuration example of three power supplies.

In the coordinate system in FIG. 227, the X axis lies in the lateral direction, the Y axis lies in the longitudinal direction, and the Z axis lies in a direction perpendicular to the XY plane.

A in FIG. 227 depicts a plan view of the conductor layer A, and B in FIG. 227 depicts a plan view of the conductor layer B. Note that FIG. 227 may be regarded as depicting the entire region of each conductor layer or may be regarded as depicting a partial region of each conductor layer. Regarding the second modification example of the second configuration example, a plan view depicting the stacked state of the conductor layer A and the conductor layer B is omitted.

The conductor layer A in A in FIG. 227 is the same as the conductor layer A in the first modification example of the second configuration example depicted in A in FIG. 226. That is, the conductor layer A has a configuration in which the conductor width of the Vss2 conductors is set smaller than the conductor widths of the Vdd conductors and the Vss1 conductors formed with the same conductor width ((conductor width WXAD)=(conductor width WXAS1)>(conductor width WXAS2)).

The conductor layer B in B in FIG. 227 has a configuration in which the conductor width of the Vss2 conductors connected to the third power supply Vss2 is made smaller as compared with that in the conductor layer B in the first modification example of the second configuration example depicted in B in FIG. 226.

Specifically, the conductor layer B includes three linear conductors 2201 to 2203 that are long in the X direction, and arranged in the Y direction in a predetermined order, and sets of the three linear conductors 2201 to 2203 are arranged regularly in the Y direction.

The linear conductors 2201 are wires (Vdd wires) connected to the first power supply Vdd. The linear conductors 2202 are wires (Vss1 wires) connected to the second power supply Vss1. The linear conductors 2203 are wires (Vss2 wires) connected to the third power supply Vss2.

The linear conductors 2201 have the Y-direction conductor width WYBD, the linear conductors 2202 have the Y-direction conductor width WYBS1, and the linear conductors 2203 have the Y-direction conductor width WYBS2. For example, the conductor width WYBD of the linear conductors 2201, and the conductor width WYBS1 of the linear conductors 2202 are the same, and the conductor width WYBS2 of the linear conductors 2203 is made smaller than the conductor width WYBD of the linear conductors 2201, and the conductor width WYBS1 of the linear conductors 2202 ((conductor width WYBD)=(conductor width WYBS1)>(conductor width WYBS2)). There is a gap with the gap width GYB between two adjacent ones of the linear conductors 2201 to 2203.

Then, the linear conductors 2201 are arranged regularly in the Y direction at the conductor pitch FYBD. The linear conductors 2202 are arranged regularly in the Y direction at the conductor pitch FYBS1, and the linear conductors 2203 are arranged regularly in the Y direction at the conductor pitch FYBS2. For example, the conductor pitch FYBD, the conductor pitch FYBS1, and the conductor pitch FYBS2 are the same ((conductor pitch FYBD)=(conductor pitch FYBS1)=(conductor pitch FYBS2)). In the second modification example, the Y-direction conductor pitch FYBD, conductor pitch FYBS1, and conductor pitch FYBS2 are made smaller than those in the second configuration example depicted in FIG. 222.

The conductor width WXBS2 of the Vss2 conductors in the conductor layer A may be made smaller, and the X-direction conductor pitches (the conductor pitch FXAD, the conductor pitch FXAS1 and the conductor pitch FXAS2) may be made smaller as compared with those of the second configuration example in one possible configuration as in the first modification example depicted in FIG. 226. Not only that in the conductor layer A, but also the conductor width WYBS2 of the Vss2 conductors in the conductor layer B may be made smaller, and both the X-direction conductor pitches of the conductor layer A and the Y-direction conductor pitches (the conductor pitch FYBD, the conductor pitch FYBS1 and the conductor pitch FYBS2) of the conductor layer B may be made smaller in one possible configuration as in the second modification example depicted in FIG. 227. By making the conductor pitches smaller, inductive noise can be ameliorated, and voltage drops also can be ameliorated in some cases.

While the conductor width of only the Vss2 conductors is made smaller than the conductor width of the Vdd conductors in both the conductor layer A and the conductor layer B in the first modification example and the second modification example, the conductor widths of both the Vss1 conductors and the Vss2 conductors may be made smaller than the conductor width of the Vdd conductors in one possible configuration. The conductor widths of the Vss1 conductors and the Vss2 conductors in that case may be the same with each other or may be mutually different.

In order to make the current distributions in the Vdd conductors, the Vss1 conductors and the Vss2 conductors the same between the conductor layer A and the conductor layer B, the ratios among the conductor widths of the Vdd conductors, the Vss1 conductors and the Vss2 conductors are desirably made the same between the conductor layer A and the conductor layer B, but may be made different therebetween. For example, as the sheet resistance of the conductor layer B increases to be higher than, like equal to or higher than 200%, equal to or higher than 300%, equal to or higher than 400% . . . of, the sheet resistance of the conductor layer A, a larger difference between the ratios of the conductor widths of the conductor layer A and the conductor layer B can be tolerated.

### Third Configuration Example of Three Power Supplies

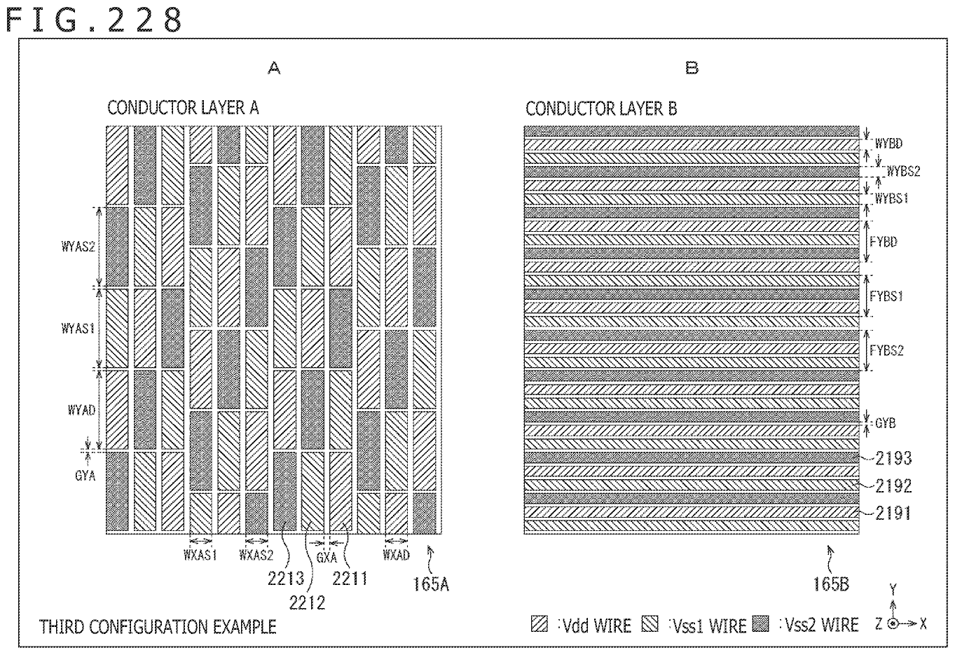

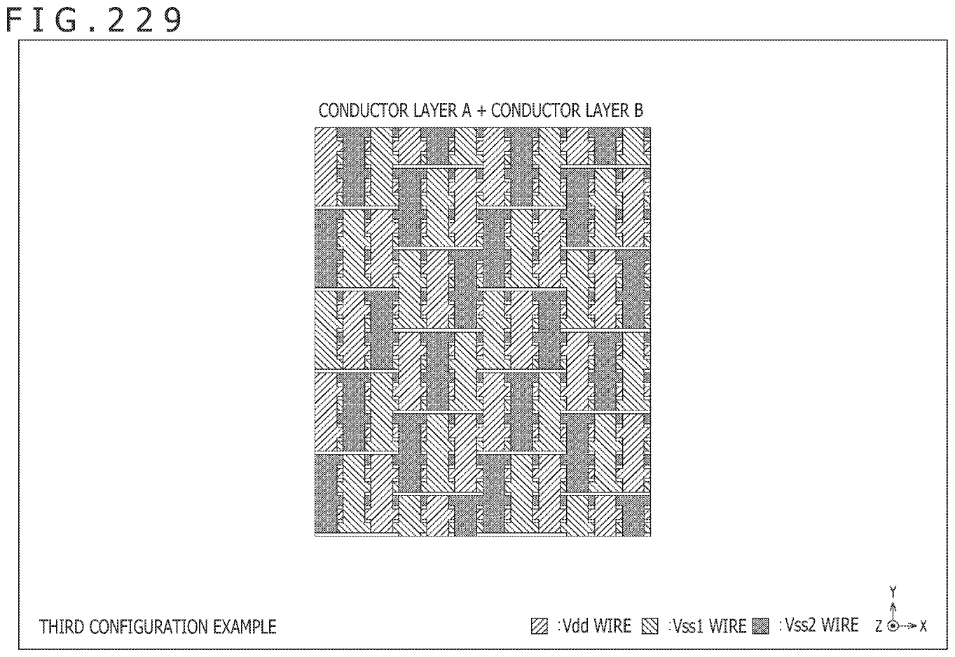

FIG. 228 and FIG. 229 depict a third configuration example of three power supplies.

In the coordinate systems in both FIG. 228 and FIG. 229, the X axis lies in the lateral direction, the Y axis lies in the longitudinal direction, and the Z axis lies in a direction perpendicular to the XY plane.

A in FIG. 228 depicts a plan view of the conductor layer A, and B in FIG. 228 depicts a plan view of the conductor layer B. Note that FIG. 228 may be regarded as depicting the entire region of each conductor layer or may be regarded as depicting a partial region of each conductor layer.

While the conductor layer A in the first configuration example and second configuration example mentioned above includes linear conductors that are long in the Y direction and are connected to the same power supplies even at different Y positions if the linear conductors are at the same X positions, the conductor layer A in A in FIG. 228 is different in that rectangular Vdd conductors, rectangular Vss1 conductors and rectangular Vss2 conductors are arranged repetitively at predetermined Y-direction pitches.

More specifically, at predetermined X positions of the conductor layer A, rectangular conductors 2211 (hereinafter, referred to as rectangular Vdd conductors 2211) connected to the first power supply Vdd, rectangular conductors 2212 (hereinafter, referred to as rectangular Vss1 conductors 2212) connected to the second power supply Vss1, and rectangular conductors 2213 (hereinafter, referred to as rectangular Vss2 conductors 2213) connected to the third power supply Vss2 are arranged regularly in this order in the positive direction along the Y axis. It should be noted however that the order of arrangement of the three rectangular conductors 2211 to 2213 is not limited to this example, but can be any order. The rectangular Vdd conductors 2211 have the X-direction conductor width WXAD, and a Y-direction conductor width WYAD. The rectangular Vss1 conductors 2212 have the X-direction conductor width WXAS1, and a Y-direction conductor width WYAS1. The rectangular Vss2 conductors 2213 have the X-direction conductor width WXAS2, and a Y-direction conductor width WYAS2. There are gaps with the X-direction gap width GXA and the Y-direction gap width GYB between adjacent rectangular conductors.

The X-direction pitches (rectangular-conductor pitches) at which rectangular conductors, the rectangular Vdd conductors, the rectangular Vss1 conductors or the rectangular Vss2 conductors, are arranged are (X-direction conductor width)+(X-direction gap width), and the Y-direction pitches (rectangular-conductor pitches) are (Y-direction conductor width)+(Y-direction gap width).

In addition, in the conductor layer A, three adjacent columns, each column of which includes sets of a rectangular Vdd conductor 2211, a rectangular Vss1 conductor 2212, and a rectangular Vss2 conductor 2213 that are arranged regularly in the Y direction, form one group, and the Y-direction positions of the rectangular conductors are displaced between the groups such that gap positions of groups that are adjacent to each other in the X direction are positioned at the middles, in the Y direction, of gap positions of adjacent groups.

Further, if attention is paid to the arrangement of a rectangular Vdd conductor 2211, a rectangular Vss1 conductor 2212, and a rectangular Vss2 conductor 2213 in each column in three columns included in one group, the Y-direction positions of the rectangular Vdd conductor, the rectangular Vss1 conductor and the rectangular Vss2 conductor are displaced between the columns such that rectangular conductors connected to the same power supplies are not arranged at the same Y-direction positions of the columns. On the other hand, when the arrangement of rectangular conductors in three columns is looked at separately for each power supply to which the rectangular conductors are connected, for example, the rectangular Vdd conductors 2211 are arranged at positions of . . . , the left column, the middle column, the right column, the left column, the middle column, the right column, . . . as the rectangular Vdd conductors 2211 are displaced at the rectangular-conductor pitch in the positive direction along the Y axis. This similarly applies also to the arrangement of the rectangular Vss1 conductors 2212 and the rectangular Vss2 conductors 2213.

By adopting the arrangement in which the positions of the rectangular Vdd conductors, the rectangular Vss1 conductors, and the rectangular Vss2 conductors are displaced between columns, the distribution of magnetic fields is dispersed, and so inductive noise can be reduced. In addition, by arranging Vdd conductors (rectangular Vdd conductors), and Vss conductors (rectangular Vss1 conductors and rectangular Vss2 conductors) alternately in one column, capacitive noise can be reduced. Furthermore, by forming one group with three columns, and displacing the Y-direction positions of rectangular conductors between the groups, the distribution of magnetic fields is dispersed further, and inductive noise can be reduced further.

On the other hand, the conductor layer B in B in FIG. 228 is the same as the conductor layer B in the second configuration example depicted in B in FIG. 222, and so an explanation thereof is omitted.

FIG. 229 is a plan view depicting the stacked state of the conductor layer A in A in FIG. 228, and the conductor layer B in B in FIG. 228.

As depicted in FIG. 229, the stacking of the conductor layer A in which three columns, each column of which includes rectangular Vdd conductors, rectangular Vss1 conductors and rectangular Vss2 conductors whose Y-direction positions are displaced between columns, form one group, and the Y-direction positions of the rectangular conductors are displaced between the groups, and the conductor layer B having a regular arrangement of the linear conductors 2191 to 2193 that are long in the X direction cannot realize a full light-blocking structure, but can provide a certain degree of light-blocking property.

Linear conductors that are in the conductor layers A and B, and connected to the same power supplies may be electrically connected via conductor vias extending in the Z direction, or the like in predetermined partial regions where the positions of the linear conductors overlap. While it is desirable in terms of voltage drops if linear conductors connected to the same power supplies are electrically connected, this is not essential, and they do not have to be connected.

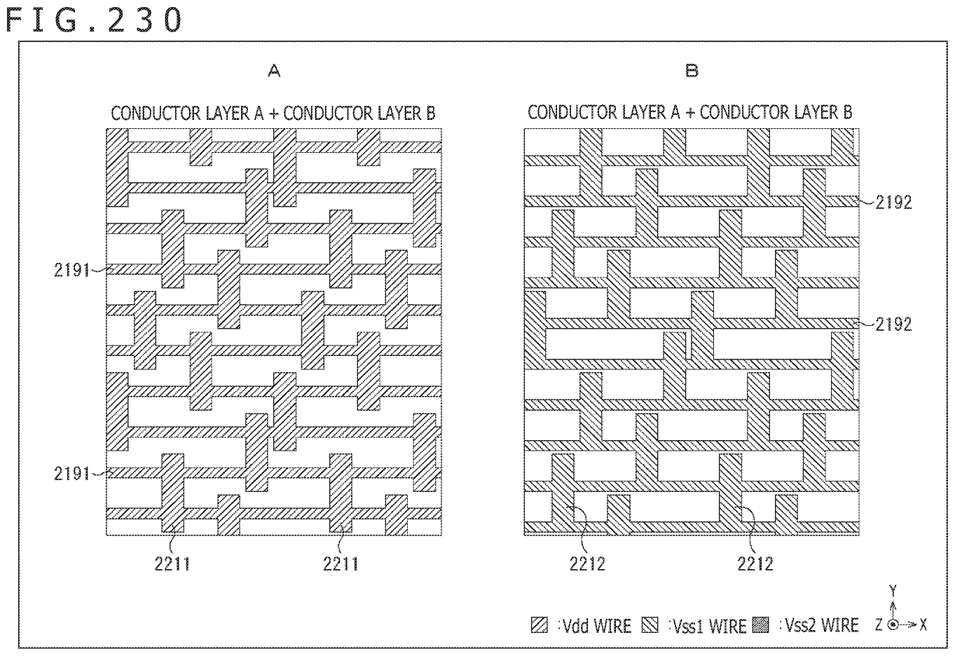

A in FIG. 230 is a plan view depicting the stacked state of only the rectangular Vdd conductors 2211 and the linear conductors 2191, which are Vdd conductors in the conductor layer A and the conductor layer B.

B in FIG. 230 is a plan view depicting the stacked state of only the rectangular Vss1 conductors 2212 and the linear conductors 2192, which are Vss1 conductors in the conductor layer A and the conductor layer B.

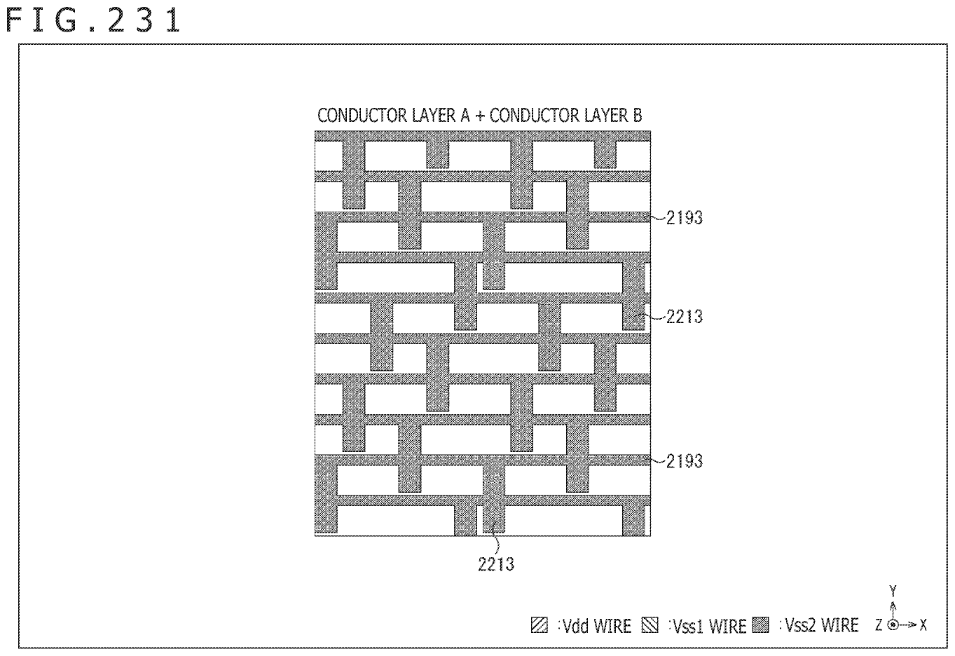

FIG. 231 is a plan view depicting the stacked state of only the rectangular Vss2 conductors 2213 and the linear conductors 2193, which are Vss2 conductors in the conductor layer A and the conductor layer B.

According to the third configuration example of three power supplies, by adopting a configuration in which the Y-direction positions of rectangular conductors are displaced between groups, it becomes possible to form a spurious mesh structure with the two layers, the conductor layer A and the conductor layer B, as depicted in FIG. 230 and FIG. 231 in a case in which conductors that are in the conductor layers A and B and are connected to the same power supplies are electrically connected. Accordingly, currents can be caused to flow in both the X direction and the Y direction, and the degree of freedom of layouts of wires can be enhanced. In a case in which the conductor layer B has a regular arrangement of linear conductors in the X direction or the Y direction, if the Y-direction pitch displacement between groups in the conductor layer A is eliminated, it becomes difficult to cause currents to flow in both the X direction and the Y direction with the two layers, the conductor layer A and the conductor layer B; however, by providing the Y-direction pitch displacement between groups in the conductor layer A, a spurious mesh structure can be realized, and so the degree of freedom of layouts of wires can be enhanced. For example, in a case in which the conductor layer B has diagonal-line-like conductors or stepwise conductors that extend in diagonal directions relative to the X direction or the Y direction, the Y-direction pitch displacement between groups of the conductor layer A does not have to be provided. Needless to say, the Y-direction pitch displacement between groups in the conductor layer A may be provided.

By realizing a spurious mesh structure of three power supplies with the two layers, the conductor layer A and the conductor layer B, currents are more easily diffused in the X direction, and so inductive noise can be ameliorated. In addition, depending on the pad arrangement, the conductor resistances as seen from pad ends can be reduced, and so voltage drops can be ameliorated.

### First Modification Example of Third Configuration Example of Three Power Supplies

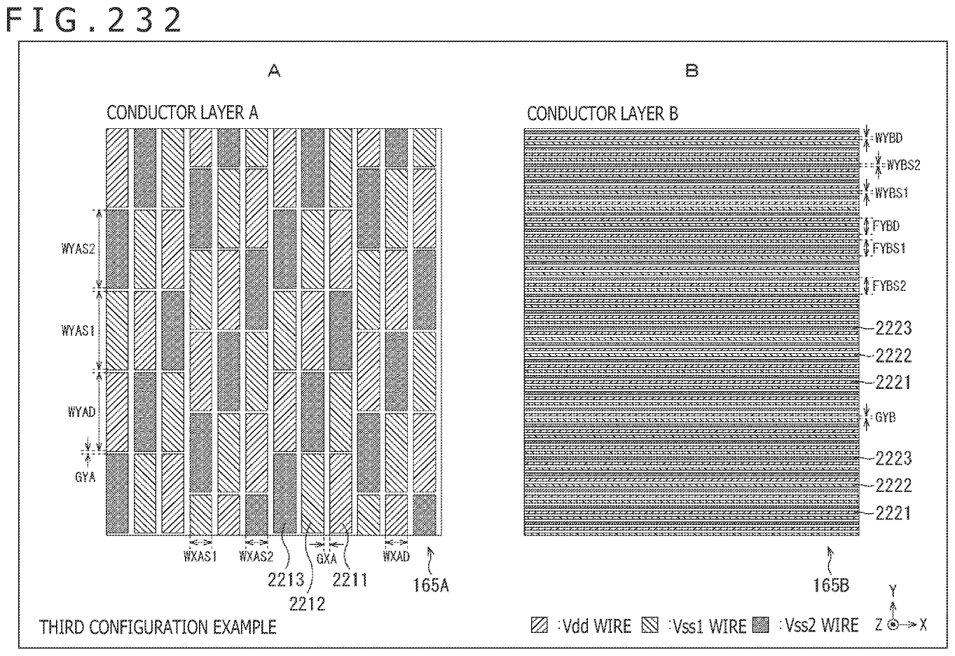

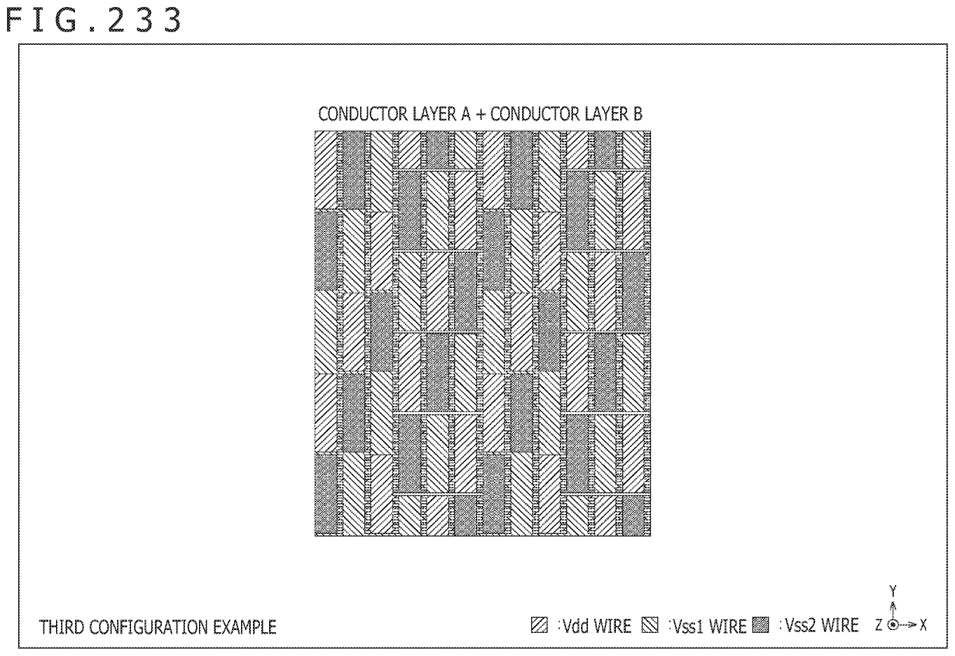

FIG. 232 and FIG. 233 depict a first modification example of the third configuration example of three power supplies.

In the coordinate systems in both FIG. 232 and FIG. 233, the X axis lies in the lateral direction, the Y axis lies in the longitudinal direction, and the Z axis lies in a direction perpendicular to the XY plane.

A in FIG. 232 depicts a plan view of the conductor layer A, and B in FIG. 232 depicts a plan view of the conductor layer B. Note that FIG. 232 may be regarded as depicting the entire region of each conductor layer or may be regarded as depicting a partial region of each conductor layer.

The conductor layer A in A in FIG. 232 is the same as the conductor layer A in the third configuration example depicted in A in FIG. 228, and so an explanation thereof is omitted.

The conductor layer B in B in FIG. 232 is different from the conductor layer B in the third configuration example depicted in B in FIG. 228 in that the conductor widths of Vdd conductors, Vss1 conductors and Vss2 conductors are made smaller.

Specifically, the conductor layer B includes three linear conductors 2221 to 2223 that are long in the X direction, and arranged in the Y direction in a predetermined order, and sets of the three linear conductors 2221 to 2223 are arranged regularly in the Y direction.

The linear conductors 2221 are wires (Vdd wires) connected to the first power supply Vdd. The linear conductors 2222 are wires (Vss1 wires) connected to the second power supply Vss1. The linear conductors 2223 are wires (Vss2 wires) connected to the third power supply Vss2.

Accordingly, while the three linear conductors 2221 to 2223 are arranged in the positive direction along the Y axis in the order of a Vdd wire, a Vss2 wire and a Vss1 wire in B in FIG. 232, the order of arrangement of the three linear conductors 2221 to 2223 is not limited to this example, but can be any order.

The linear conductors 2221 have the Y-direction conductor width WYBD, the linear conductors 2222 have the Y-direction conductor width WYBS1, and the linear conductors 2223 have the Y-direction conductor width WYBS2. For example, the conductor width WYBD of the linear conductors 2221, the conductor width WYBS1 of the linear conductors 2222, and the conductor width WYBS2 of the linear conductors 2223 are the same ((conductor width WYBD)=(conductor width WYBS1)=(conductor width WYBS2)). There is a gap with the gap width GYB between two adjacent ones of the linear conductors 2221 to 2223.

Then, the conductor width WYBD of the linear conductors 2221, the conductor width WYBS1 of the linear conductors 2222, and the conductor width WYBS2 of the linear conductors 2223 are smaller than the conductor width WYBD of the linear conductors 2191, the conductor width WYBS1 of the linear conductors 2192, and the conductor width WYBS2 of the linear conductors 2193 in the third configuration example depicted in B in FIG. 228. For example, in B in FIG. 232, the conductor width WYBD, the conductor width WYBS1 and the conductor width WYBS2 are the same width as the gap width GYB.

The linear conductors 2221 are arranged regularly in the Y direction at the conductor pitch FYBD. The linear conductors 2222 are arranged regularly in the Y direction at the conductor pitch FYBS1, and the linear conductors 2223 are arranged regularly in the Y direction at the conductor pitch FYBS2. For example, the conductor pitch FYBD, the conductor pitch FYBS1 and the conductor pitch FYBS2 are the same ((conductor pitch FYBD)=(conductor pitch FYBS1)=(conductor pitch FYBS2)).

Accordingly, in a rectangular region in a predetermined range of the conductor layer B, the sum total of the Y-direction conductor widths WYBD of linear conductors 2221 connected to the first power supply Vdd, the sum total of the Y-direction conductor widths WYBS1 of linear conductors 2222 connected to the second power supply Vss1, and the sum total of the Y-direction conductor widths WYBS2 of linear conductors 2223 connected to the third power supply Vss2 are the same.

In addition, in a rectangular region in a predetermined range of the conductor layer B, the conductor area size of linear conductors 2221 connected to the first power supply Vdd, the conductor area size of linear conductors 2222 connected to the second power supply Vss1, and the conductor area size of linear conductors 2223 connected to the third power supply Vss2 are the same.

FIG. 233 is a plan view depicting the stacked state of the conductor layer A in A in FIG. 232, and the conductor layer B in B in FIG. 232.

As depicted in FIG. 233, the stacking of the conductor layer A in which three columns, each columns of which includes rectangular Vdd conductors, rectangular Vss1 conductors and rectangular Vss2 conductors whose Y-direction positions are displaced between columns, form one group, and the Y-direction positions of the rectangular conductors are displaced between the groups, and the conductor layer B having a regular arrangement of the linear conductors 2221 to 2223 that are long in the X direction cannot realize a full light-blocking structure, but a certain degree of light-blocking property can be provided.

Linear conductors that are in the conductor layers A and B, and connected to the same power supplies may be electrically connected via conductor vias extending in the Z direction, or the like in predetermined partial regions where the positions of the linear conductors overlap. While it is desirable in terms of voltage drops if linear conductors connected to the same power supplies are electrically connected, this is not essential, and they do not have to be connected.

As in the first modification example of the third configuration example, the conductor width of linear conductors in the conductor layer B may be made extremely small, and conductor widths may be different between the conductor layer A and the conductor layer B, in one possible configuration. In this case, the conductor pitches of the conductor layer B also become smaller than the conductor pitches of the conductor layer A. Because the area size of an Aggressor loop that generates a magnetic field becomes smaller as the conductor pitches become smaller, inductive noise can be ameliorated.

### Second Modification Example of Third Configuration Example of Three Power Supplies

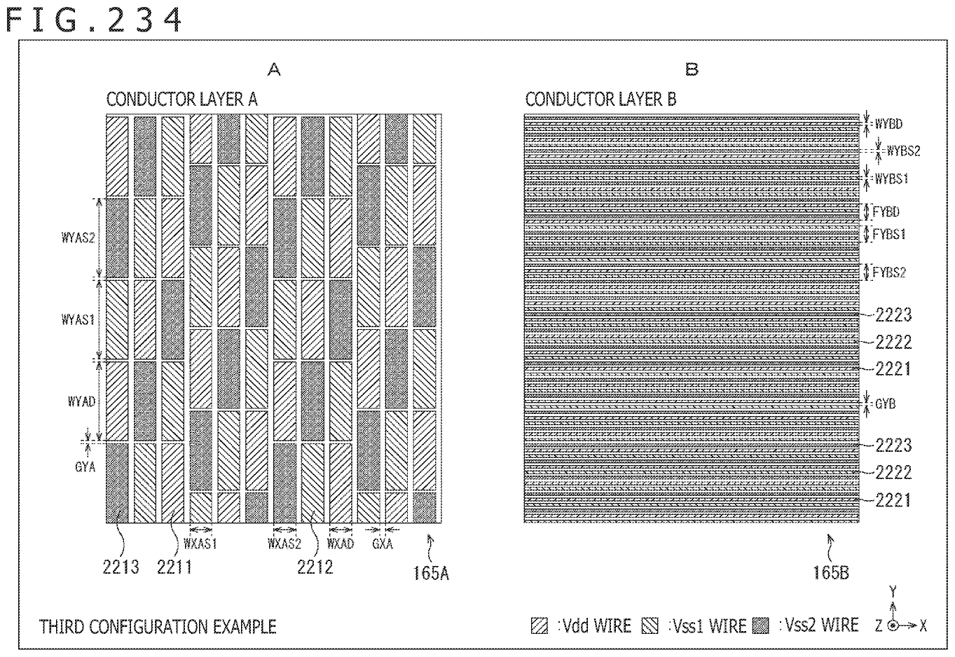

FIG. 234 depicts a second modification example of the third configuration example of three power supplies.

In the coordinate system in FIG. 234, the X axis lies in the lateral direction, the Y axis lies in the longitudinal direction, and the Z axis lies in a direction perpendicular to the XY plane.

A in FIG. 234 depicts a plan view of the conductor layer A, and B in FIG. 234 depicts a plan view of the conductor layer B. Note that FIG. 234 may be regarded as depicting the entire region of each conductor layer or may be regarded as depicting a partial region of each conductor layer. Regarding the second modification example of the third configuration example, a plan view depicting the stacked state of the conductor layer A and the conductor layer B is omitted.

The conductor layer A in A in FIG. 234 is the same as the conductor layer A in the third configuration example depicted in A in FIG. 228 in that they both satisfy the relation, “((conductor width WYAD)+(gap width GYA))=((conductor width WYAS1)+(gap width GYA))=((conductor width WYAS2)+(gap width GYA))=(5×(conductor pitch FYBD))=(5×(conductor pitch FYBS1))=(5×(conductor pitch FYBS2)),” but is different from the conductor layer A in the third configuration example depicted in A in FIG. 228 in terms of the Y-direction pitch displacement between groups.

That is, in the conductor layer A in the third configuration example depicted in A in FIG. 228, a group including three adjacent columns is displaced relative to another group adjacent on the positive side along the X axis by ½ of the Y-direction rectangular-conductor pitch such that gap positions of the former group are positioned at the middles, in the Y direction, of gap positions of the latter group.

In contrast, in the conductor layer A depicted in A in FIG. 234, relative to a predetermined group including three adjacent columns, gap positions of another group that is adjacent on the positive side along the X axis are displaced in the positive direction along the Y axis by 200% of the conductor pitch FYBD (≠½ of the Y-direction rectangular-conductor pitch). Relative to the predetermined group as the reference group, the other group that is adjacent on the positive side along the X axis is displaced in the positive direction along the Y axis in accordance with a rule by 200% of the conductor pitch FYBD (≠½ of the Y-direction rectangular-conductor pitch). In this manner, in a case in which the relation, “((conductor width WYAD)+(gap width GYA))=((conductor width WYAS1)+(gap width GYA))=((conductor width WYAS2)+(gap width GYA))=((integer N1)×(conductor pitch FYBD))=((integer N1)×(conductor pitch FYBS1))=((integer N1)×(conductor pitch FYBS2)),” is satisfied, and the displacement amount in the positive direction along the Y axis equals “(integer N2)×(conductor pitch FYBD),” the number of linear conductors 2221 connected to rectangular conductors 2211, the number of linear conductors 2222 connected to rectangular conductors 2212, and the number of linear conductors 2223 connected to rectangular conductors 2213 in a rectangular region in a predetermined range can be made the same with each other. In other words, in the rectangular region in the predetermined range, the sum total of the conductor area sizes of the linear conductors 2221 connected to the rectangular conductors 2211, the sum total of the conductor area sizes of the linear conductors 2222 connected to the rectangular conductors 2212, and the sum total of the conductor area sizes of the linear conductors 2223 connected to the rectangular conductors 2213 can be made the same with each other. In such a case, the current distributions in Vdd conductors, Vss1 conductors and Vss2 conductors can be made close to the same current distribution, and so inductive noise can be ameliorated. Note that in order to cause currents to flow in both the X direction and the Y direction without using diagonal-line-like conductors or stepwise conductors, the condition, “((conductor width WYAD)+(gap width GYA))=((conductor width WYAS1)+(gap width GYA))=((conductor width WYAS2)+(gap width GYA))>((conductor pitch FYBD)=(conductor pitch FYBS1)=(conductor pitch FYBS2)),” needs to be satisfied. That is, “(integer N1)>1” is satisfied desirably, but in order to cause currents to flow in both the X direction and the Y direction, the condition, “(integer N1)>(integer N2)≥1” needs to be further satisfied. It should be noted however that these relations may not be satisfied if inductive noise is within a range that satisfies the tolerated level range.

The conductor layer B in B in FIG. 234 is the same as the conductor layer B in the first modification example of the third configuration example depicted in B in FIG. 232, and so an explanation thereof is omitted.

### Third Modification Example of Third Configuration Example of Three Power Supplies

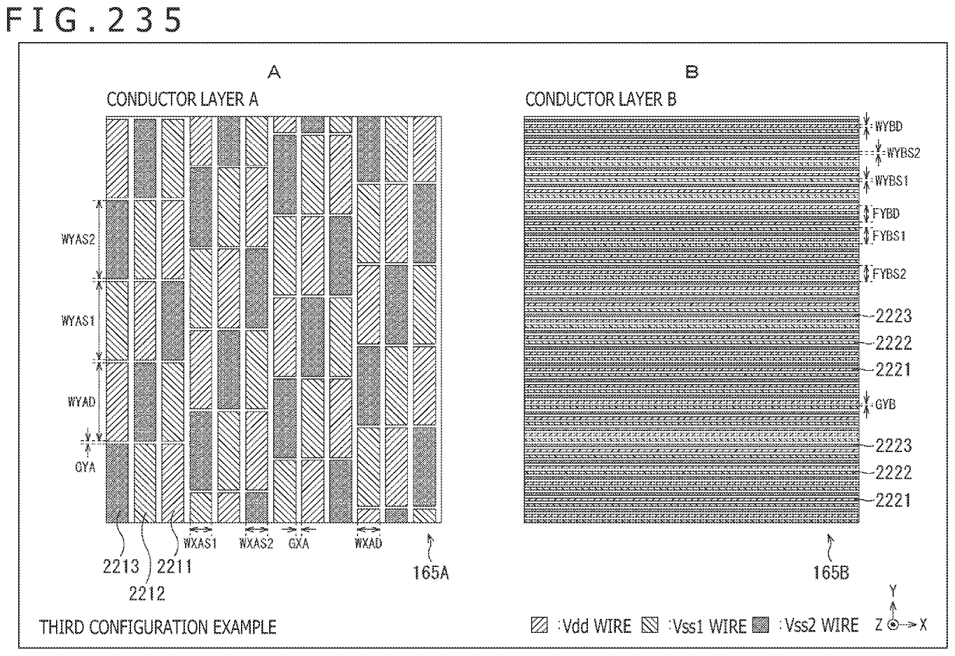

FIG. 235 depicts a third modification example of the third configuration example of three power supplies.

In the coordinate system in FIG. 235, the X axis lies in the lateral direction, the Y axis lies in the longitudinal direction, and the Z axis lies in a direction perpendicular to the XY plane.

A in FIG. 235 depicts a plan view of the conductor layer A, and B in FIG. 235 depicts a plan view of the conductor layer B. Note that FIG. 235 may be regarded as depicting the entire region of each conductor layer or may be regarded as depicting a partial region of each conductor layer. Regarding the third modification example of the third configuration example, a plan view depicting the stacked state of the conductor layer A and the conductor layer B is omitted.

The conductor layer A in A in FIG. 235 is different from the conductor layer A in the third configuration example depicted in A in FIG. 228 in terms of the Y-direction pitch displacement between groups.

That is, in the conductor layer A in the third configuration example depicted in A in FIG. 228, a group including three adjacent columns is displaced relative to another group adjacent on the positive side along the X axis by ½ of the Y-direction rectangular-conductor pitch such that gap positions of the former group are positioned at the middles, in the Y direction, of gap positions of the latter group.

In contrast, in the conductor layer A depicted in A in FIG. 235, relative to a predetermined group including three adjacent columns, gap positions of another group that is adjacent on the positive side along the X axis are displaced by 200% of the conductor pitch FYBD (≠½ of the Y-direction rectangular-conductor pitch).

It should be noted however that while, in the second modification example depicted in FIG. 234, the arrangement in which, relative to a predetermined group as the reference group, another group that is adjacent on the positive side along the X axis is displaced in the positive direction along the Y axis by 200% of the conductor pitch FYBD, and the arrangement in which, relative to a predetermined group as the reference group, another group that is adjacent on the positive side along the X axis is displaced in the negative direction along the Y axis by 200% of the conductor pitch FYBD are arranged alternately, another group that is adjacent on the positive side along the X axis is always displaced in the positive direction along the Y axis by 200% of the conductor pitch FYBD in the third modification example in FIG. 235.

The conductor layer B in B in FIG. 235 is the same as the conductor layer B in the first modification example of the third configuration example depicted in B in FIG. 232, and so an explanation thereof is omitted.

As in the third modification example and the fourth modification example, the Y-direction pitch displacement between groups may be displacement in the positive direction, may be displacement in the negative direction, and also may be any combination of displacement in the positive direction and displacement in the negative direction. Although a plan view depicting the stacked state of the conductor layer A and the conductor layer B is omitted, as in FIG. 230 and FIG. 231, a spurious mesh structure of three power supplies can be realized with the two layers, the conductor layer A and the conductor layer B, currents are more easily diffused in the X direction, and so inductive noise can be ameliorated. In addition, the degree of freedom of layouts of wires can be enhanced. Furthermore, depending on the pad arrangement, the conductor resistances as seen from pad ends can be reduced, and so voltage drops can be ameliorated.

### Fourth Modification Example and Fifth Modification Example of Third Configuration Example of Three Power Supplies

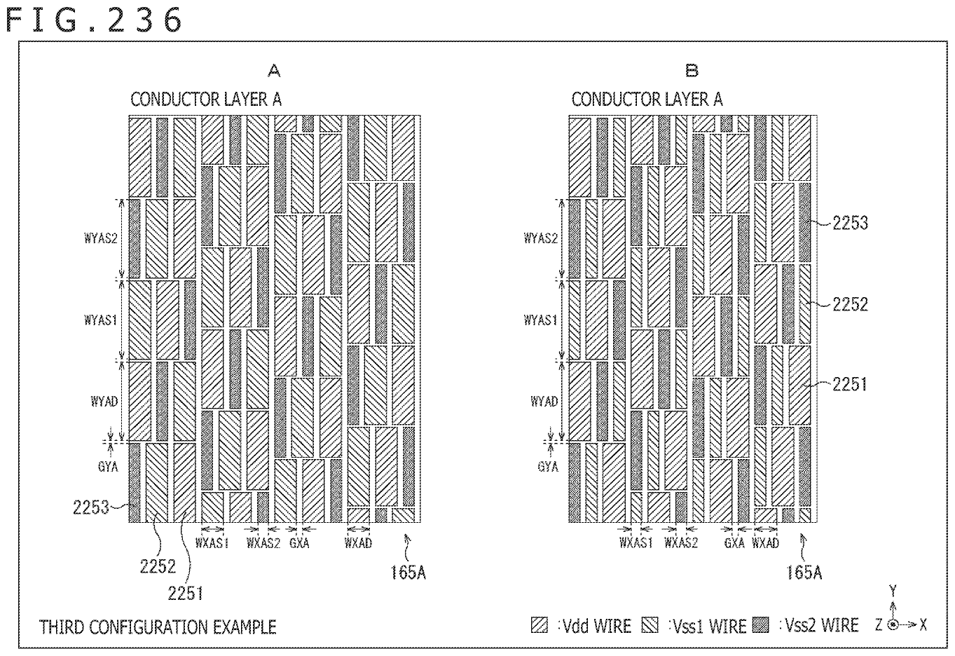

FIG. 236 depicts a fourth modification example and a fifth modification example of the third configuration example of three power supplies.

In the coordinate system in FIG. 236, the X axis lies in the lateral direction, the Y axis lies in the longitudinal direction, and the Z axis lies in a direction perpendicular to the XY plane.

Both A and B in FIG. 236 depict plan views of the conductor layer A. A in FIG. 236 is a plan view of the conductor layer A in the fourth modification example of the third configuration example, and B in FIG. 236 is a plan view of the conductor layer A in the fifth modification example of the third configuration example.

Although a plan view of the conductor layer B is omitted, the conductor layer B is the conductor layer B in the third configuration example depicted in B in FIG. 228, or the conductor layer B in the first modification example of the third configuration example depicted in B in FIG. 232, for example. A plan view depicting the stacked state of the conductor layer A and the conductor layer B also is omitted.

The conductor layer A in the fourth modification example depicted in A in FIG. 236, and the conductor layer A in the fifth modification example depicted in B in FIG. 236 have a commonality with the conductor layer A in the third modification example of the third configuration example depicted in A in FIG. 235 in that three columns, each column of which includes rectangular Vdd conductors, rectangular Vss1 conductors and rectangular Vss2 conductors whose Y-direction positions are displaced between columns, form one group, and the Y-direction positions of rectangular conductors are displaced between groups.

On one hand, in the conductor layer A in the third modification example of the third configuration example depicted in A in FIG. 235, the X-direction conductor widths of rectangular conductors are the same among rectangular Vdd conductors, rectangular Vss1 conductors and rectangular Vss2 conductors. In contrast, in the conductor layer A in the fourth modification example in A in FIG. 236, the X-direction conductor width of rectangular Vss2 conductors is made smaller than the X-direction conductor widths of rectangular Vdd conductors and rectangular Vss1 conductors.

More specifically, rectangular conductors 2251 (hereinafter, referred to as rectangular Vdd conductors 2251) connected to the first power supply Vdd have the X-direction conductor width WXAD, and the Y-direction conductor width WYAD. Rectangular conductors 2252 (hereinafter, referred to as rectangular Vss1 conductors 2252) connected to the second power supply Vss1 have the X-direction conductor width WXAS1, and the Y-direction conductor width WYAS1. Rectangular conductors 2253 (hereinafter, referred to as rectangular Vss2 conductors 2253) connected to the third power supply Vss2 have the X-direction conductor width WXAS2, and the Y-direction conductor width WYAS2. Then, the X-direction conductor width WXAD of the rectangular Vdd conductors 2251, and the X-direction conductor width WXAS1 of the rectangular Vss1 conductors 2252 are equal to each other, and the X-direction conductor width WXAS2 of the rectangular Vss2 conductors 2253 is smaller than the conductor width WXAD and the conductor width WXAS1.

On the other hand, in the conductor layer A in the fifth modification example in B in FIG. 236, the X-direction conductor widths of both rectangular Vss1 conductors and rectangular Vss2 conductors are made smaller than the X-direction conductor width of rectangular Vdd conductors.

More specifically, the X-direction conductor width WXAS1 of the rectangular Vss1 conductors 2252, and the X-direction conductor width WXAS2 of the rectangular Vss2 conductors 2253 are equal to each other, and the conductor width WXAS1 and the conductor width WXAS2 are smaller than the X-direction conductor width WXAD of the rectangular Vdd conductors 2251 ((conductor width WXAD)>(conductor width WXAS1)=(conductor width WXAS2)).

In this manner, the X-direction conductor widths of rectangular Vdd conductors, rectangular Vss1 conductors and rectangular Vss2 conductors may be the same or may be different. Although an illustration is omitted, the X-direction conductor width WXAS1 of the rectangular Vss1 conductors 2252 may be smaller than the X-direction conductor width WXAD of the rectangular Vdd conductors 2251, and the X-direction conductor width WXAS2 of the rectangular Vss2 conductors 2253 may be smaller than the X-direction conductor width WXAS1 of the rectangular Vss1 conductors 2252 ((conductor width WXAD)>(conductor width WXAS1)>(conductor width WXAS2)).

Because if the conductor width of Vss2 conductors is made smaller, Vdd conductors and Vss1 conductors can be arranged densely, this leads to amelioration of voltage drops of the Vdd conductors and the Vss1 conductors, if voltage drops are compared on the premise that the wire region has the same area size. Making the X-direction conductor widths of both the Vss1 conductors and the Vss2 conductors smaller leads to amelioration of voltage drops of the Vdd conductors, if voltage drops are compared on the premise that the wire region has the same area size. In addition, because the area size of an Aggressor loop that generates a magnetic field becomes smaller as the conductor pitches become smaller, inductive noise also can be ameliorated.

### Fourth Configuration Example of Three Power Supplies

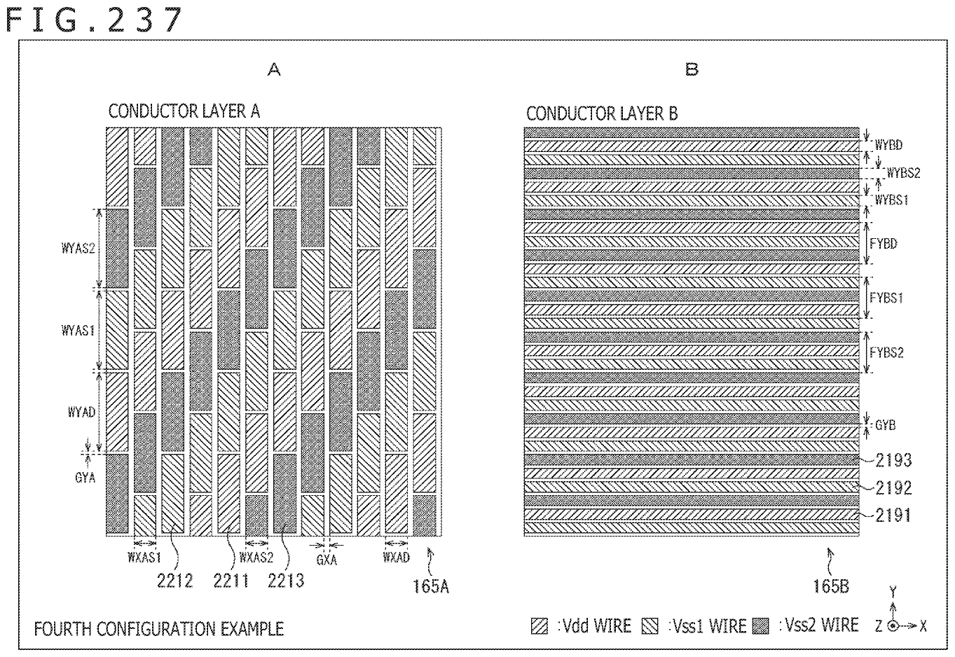

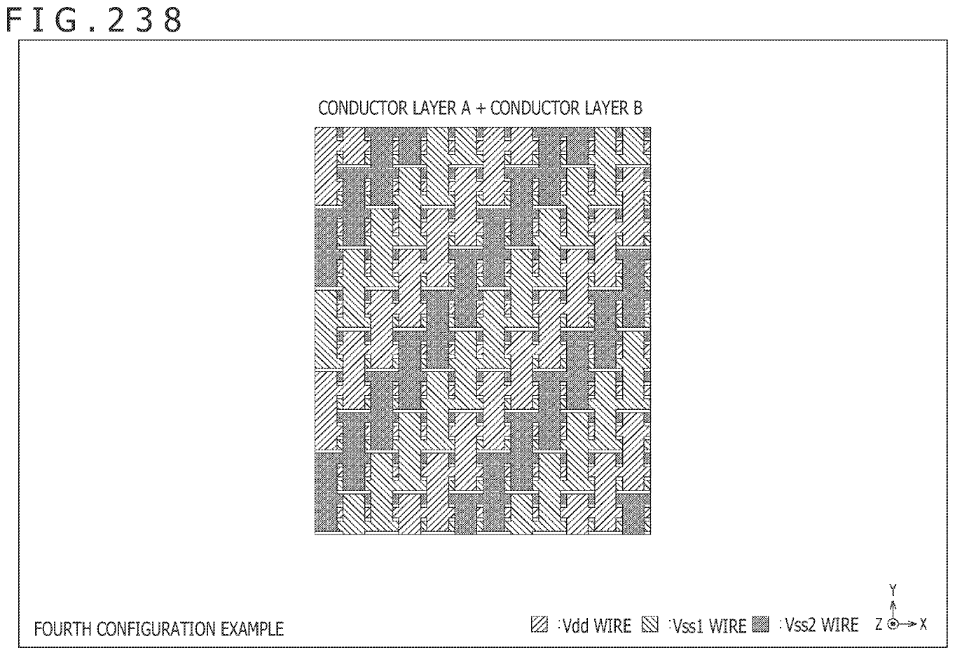

FIG. 237 and FIG. 238 depict a fourth configuration example of three power supplies.

In the coordinate systems in both FIG. 237 and FIG. 238, the X axis lies in the lateral direction, the Y axis lies in the longitudinal direction, and the Z axis lies in a direction perpendicular to the XY plane.

A in FIG. 237 depicts a plan view of the conductor layer A, and B in FIG. 237 depicts a plan view of the conductor layer B. Note that FIG. 237 may be regarded as depicting the entire region of each conductor layer or may be regarded as depicting a partial region of each conductor layer.

The conductor layer A has a commonality with the conductor layer A in the third configuration example depicted in A in FIG. 228 in that the conductor layer A includes sets of rectangular Vdd conductors 2211, rectangular Vss1 conductors 2212 and rectangular Vss2 conductors 2213 that are arrayed in the X direction and the Y direction, but is different from the conductor layer A in the third configuration example in terms of the rules of the array.

Specifically, the conductor layer A in the fourth configuration example includes columns each including a set of rectangular Vdd conductors 2211, rectangular Vss1 conductors 2212 and rectangular Vss2 conductors 2213 that are arranged regularly in the Y direction, the columns being arranged regularly in the X direction at an X-direction rectangular-conductor pitch. If a predetermined column in the conductor layer A and another column adjacent to the predetermined column on the positive side along the X axis are compared in terms of gap positions of rectangular conductors, gap positions of the former column are displaced by ½ of the Y-direction rectangular-conductor pitch such that the gap positions of the former column are positioned at the middles, in the Y direction, of gap positions of the latter column. Thereby, the conductor layer A has a spurious stepwise structure in which the Y-direction positions of rectangular Vdd conductors 2211, rectangular Vss1 conductors 2212 and rectangular Vss2 conductors 2213 in each column are displaced toward the positive side along the Y axis by ½ of the Y-direction rectangular-conductor pitch, as the position of a column of interest moves toward the positive side along the X axis. It should be noted however that the displacement amount in relation to the Y-direction rectangular-conductor pitch needs not be ½ of the Y-direction rectangular-conductor pitch. The displacement amount is desirably an integer multiple of the conductor pitch FYBD, but can be designed to have any value.

On the other hand, the conductor layer B in B in FIG. 237 is the same as the conductor layer B in the third configuration example depicted in B in FIG. 228, and so an explanation thereof is omitted.

FIG. 238 is a plan view depicting the stacked state of the conductor layer A in A in FIG. 237, and the conductor layer B in B in FIG. 237.

As depicted in FIG. 238, the stacking of the conductor layer A in which columns each including a set of rectangular Vdd conductors 2211, rectangular Vss1 conductors 2212 and rectangular Vss2 conductors 2213 that are arranged regularly in the Y direction are arranged regularly in the positive direction along the X axis while being displaced spuriously stepwise, and the conductor layer B having a regular arrangement of the linear conductors 2191 to 2193 that are long in the X direction cannot realize a full light-blocking structure, but can provide a certain degree of light-blocking property.

Linear conductors that are in the conductor layers A and B, and connected to the same power supplies may be electrically connected via conductor vias extending in the Z direction, or the like in predetermined partial regions where the positions of the linear conductors overlap. While it is desirable in terms of voltage drops if linear conductors connected to the same power supplies are electrically connected, this is not essential, and they do not have to be connected.

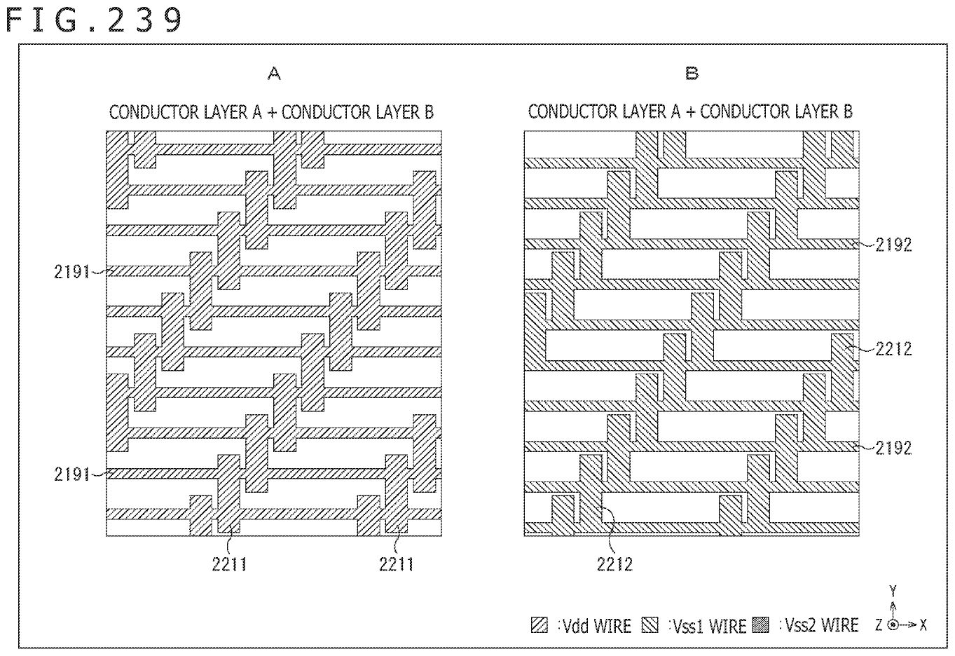

A in FIG. 239 is a plan view depicting the stacked state of only the rectangular Vdd conductors 2211 and the linear conductors 2191, which are Vdd conductors in the conductor layer A and the conductor layer B.

B in FIG. 239 is a plan view depicting the stacked state of only the rectangular Vss1 conductors 2212 and the linear conductors 2192, which are Vss1 conductors in the conductor layer A and the conductor layer B.

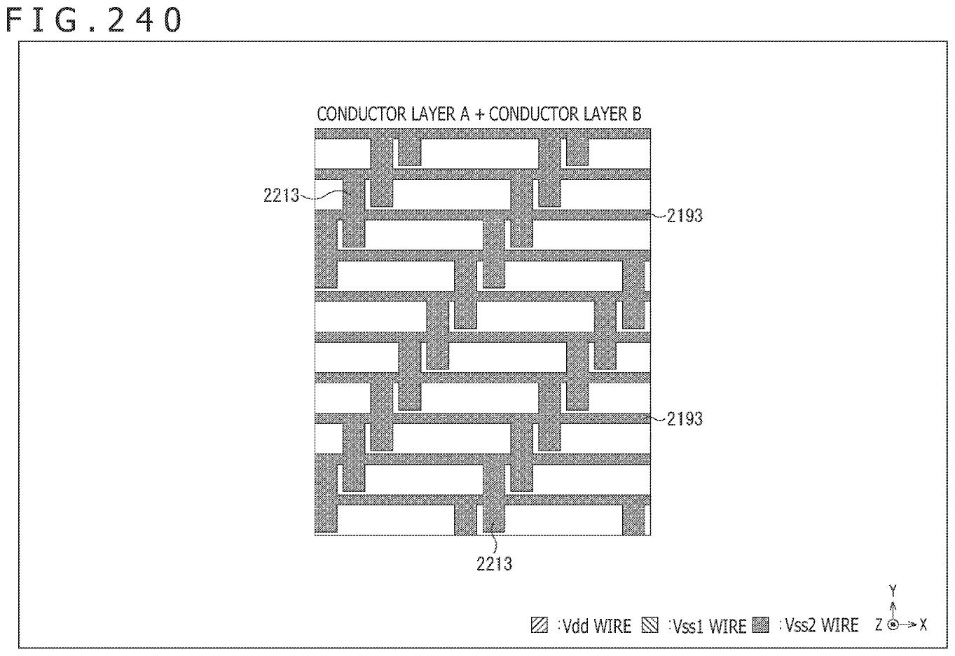

FIG. 240 is a plan view depicting the stacked state of only the rectangular Vss2 conductors 2213 and the linear conductors 2193, which are Vss2 conductors in the conductor layer A and the conductor layer B.

According to the fourth configuration example of three power supplies, by adopting a configuration in which the Y-direction positions of rectangular conductors are displaced between columns such that the Y-direction positions of rectangular conductors connected to power supplies become stepwise, it becomes possible to form a spurious mesh structure with the two layers, the conductor layer A and the conductor layer B, as depicted in FIG. 239 and FIG. 240 in a case in which conductors that are in the conductor layers A and B and are connected to the same power supplies are electrically connected via conductor vias in the Z direction, or the like. Accordingly, currents can be caused to flow in both the X direction and the Y direction, and the degree of freedom of layouts of wires can be enhanced.

By realizing a spurious mesh structure of three power supplies with the two layers, the conductor layer A and the conductor layer B, currents are more easily diffused in the X direction, and so inductive noise can be ameliorated. In addition, depending on the pad arrangement, the conductor resistances as seen from pad ends can be reduced, and so voltage drops can be ameliorated.

### Fifth Configuration Example of Three Power Supplies

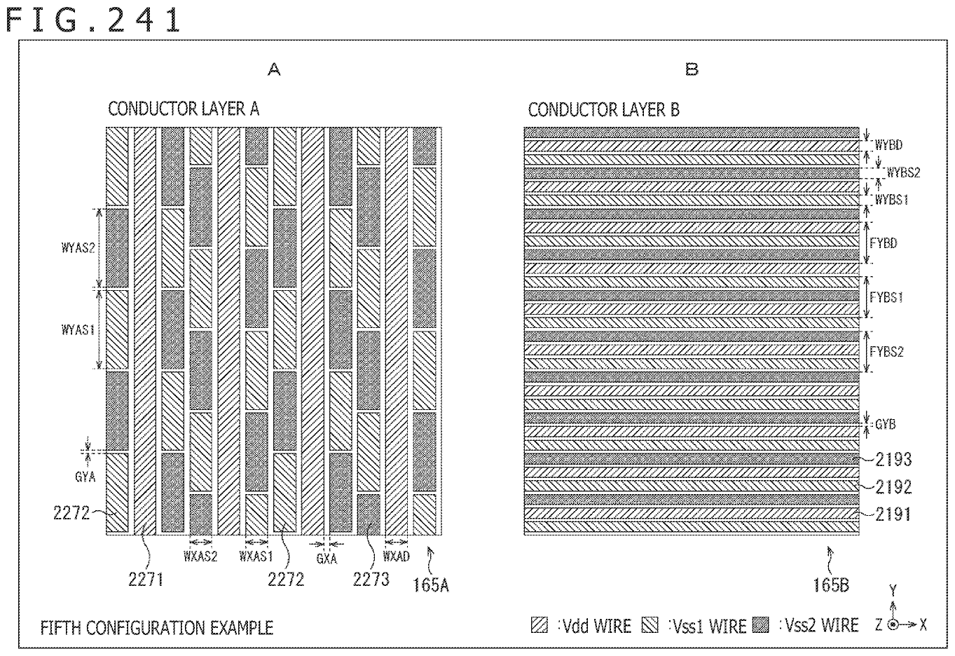

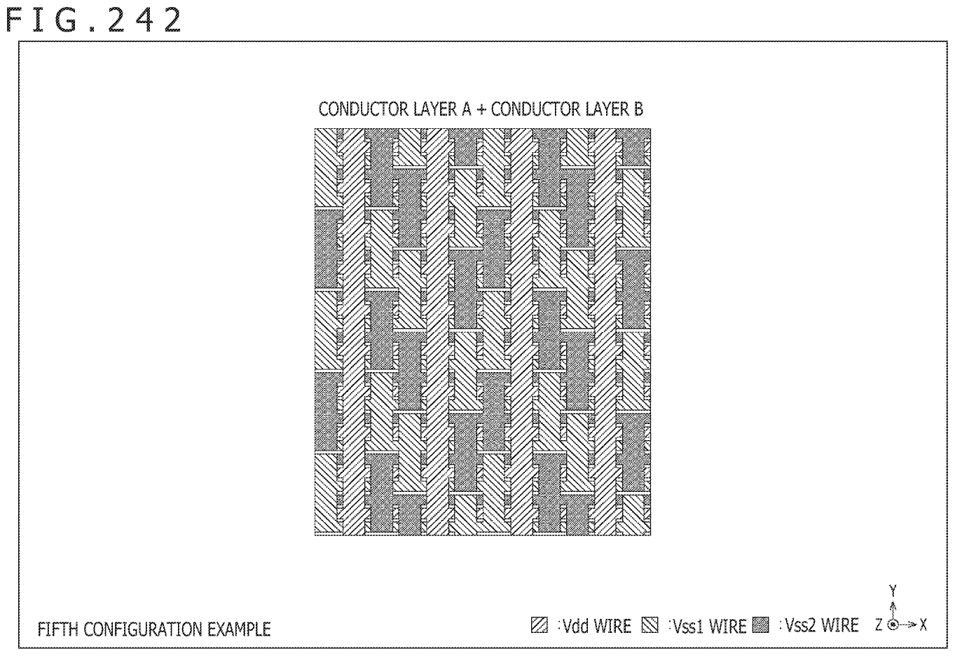

FIG. 241 and FIG. 242 depict a fifth configuration example of three power supplies.

In the coordinate systems in both FIG. 241 and FIG. 242, the X axis lies in the lateral direction, the Y axis lies in the longitudinal direction, and the Z axis lies in a direction perpendicular to the XY plane.

A in FIG. 241 depicts a plan view of the conductor layer A, and B in FIG. 241 depicts a plan view of the conductor layer B. Note that FIG. 241 may be regarded as depicting the entire region of each conductor layer or may be regarded as depicting a partial region of each conductor layer.

The conductor layer A in A in FIG. 241 includes groups that are arranged regularly in the X direction. Each group includes three columns which include one column of one linear conductor 2271 connected to the first power supply Vdd and two columns that are adjacent to the one column on both sides. In the two columns, rectangular conductors 2272 (hereinafter, referred to as rectangular Vss1 conductors 2272) connected to the second power supply Vss1, and rectangular conductors 2273 (hereinafter, referred to as rectangular Vss2 conductors 2273) connected to the third power supply Vss2 are arranged alternately in the Y direction.

The linear conductors 2171 have the X-direction conductor width WXAD and are arranged extending in the Y direction. The rectangular Vss1 conductors 2272 have the X-direction conductor width WXAS1 and the Y-direction conductor width WYAS1. The rectangular Vss2 conductors 2273 have the X-direction conductor width WXAS2 and the Y-direction conductor width WYAS2. For example, the X-direction conductor width WXAD, conductor width WXAS1, and conductor width WXAS2 are the same ((conductor width WXAD)=(conductor width WYAS1)=(conductor width WYAS2)). There are gaps with the X-direction gap width GXA and the Y-direction gap width GYB between adjacent conductors.

If attention is paid to the arrangement of rectangular Vss1 conductors 2272 and rectangular Vss2 conductors 2273 arranged in each column on both sides in three columns included in one group, a rectangular Vss1 conductor 2272 in one column, and a rectangular Vss2 conductor 2273 in the other column are arranged on both sides of a linear conductor 2271 at the same Y position such that the rectangular Vss2 conductor 2273 is arranged corresponding to a portion where the rectangular Vss1 conductor 2272 is arranged. In addition, Y-direction gap positions between rectangular Vss1 conductor 2272 and rectangular Vss2 conductor 2273 in the two columns on both sides are the same.

Furthermore, if attention is paid to the arrangement of rectangular Vss1 conductors 2272 and rectangular Vss2 conductors 2273 in two groups that are adjacent to each other in the X direction, the Y-direction positions of the rectangular Vss1 conductors 2272 and the rectangular Vss2 conductors 2273 in the two adjacent groups are arranged being displaced relative to each other by ½ of the Y-direction rectangular-conductor pitch.

The conductor layer B in B in FIG. 241 is the same as the conductor layer B in the third configuration example depicted in B in FIG. 228, and so an explanation thereof is omitted.

FIG. 242 is a plan view depicting the stacked state of the conductor layer A in A in FIG. 241, and the conductor layer B in B in FIG. 241.

As depicted in FIG. 242, the stacking of the conductor layer A in which groups each including three columns which include one column of a linear conductors 2271 that is long in the Y direction and two columns that are on both sides of the one column, and include alternately arranged rectangular Vss1 conductors 2272 and rectangular Vss2 conductors 2273 are arranged regularly in the X direction, and the conductor layer B having a regular arrangement, in the Y direction, of the linear conductors 2191 to 2193 that are long in the X direction cannot realize a full light-blocking structure, but can provide a certain degree of light-blocking property.

Conductors that are in the conductor layers A and B and are connected to the same power supplies may be electrically connected via conductor vias in the Z direction, or the like in predetermined partial regions where the positions of the conductors overlap. While it is desirable in terms of voltage drops if conductors that are in the conductor layers A and B and are connected to the same power supplies are electrically connected, this is not essential, and they do not have to be connected.

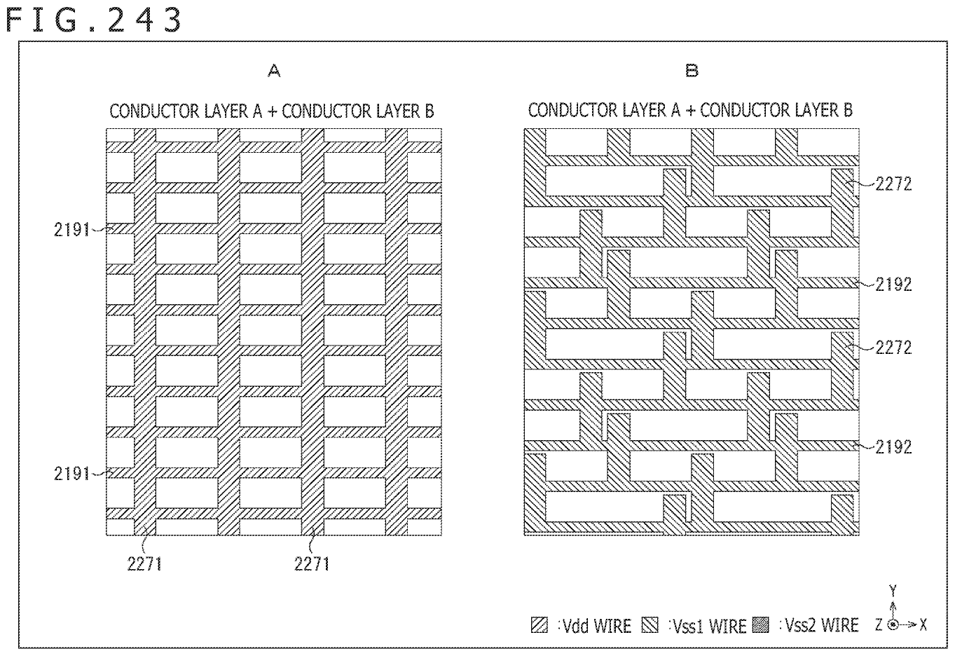

A in FIG. 243 is a plan view depicting the stacked state of only the linear conductors 2271 and the linear conductors 2191, which are Vdd conductors in the conductor layer A and the conductor layer B.

B in FIG. 243 is a plan view depicting the stacked state of only the rectangular Vss1 conductors 2272 and the linear conductors 2192, which are Vss1 conductors in the conductor layer A and the conductor layer B.

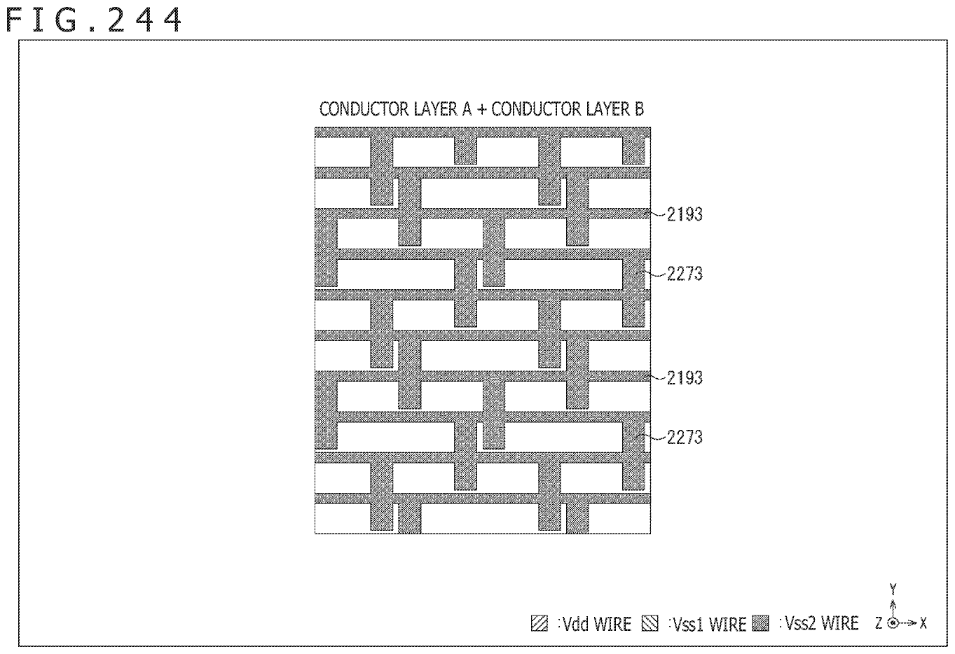

FIG. 244 is a plan view depicting the stacked state of only the rectangular Vss2 conductors 2273 and the linear conductors 2193, which are Vss2 conductors in the conductor layer A and the conductor layer B.

According to the fifth configuration example of three power supplies, in a case in which conductors that are in the conductor layers A and B and are connected to the same power supplies are electrically connected, as depicted in FIG. 243 and FIG. 244, Vdd conductors in the two layers, the conductor layer A and the conductor layer B, can form a mesh structure, and Vss1 conductors and Vss2 conductors in the two layers, the conductor layer A and the conductor layer B, can form a spurious mesh structure. Accordingly, currents can be caused to flow in both the X direction and the Y direction, and the degree of freedom of layouts of wires can be enhanced. By adopting a mesh structure for the Vdd conductors that are used in common in a configuration in which the second power supply Vss1 and the third power supply Vss2 are switched selectively, and a spurious mesh structure for the Vss1 conductors and the Vss2 conductors, voltage drops of the Vdd conductors that are used in common can be made smaller than voltage drops of the Vss1 conductors and the Vss2 conductors. By ameliorating voltage drops of the Vdd conductors, which are elements to be used in common, voltage drops of the stacked conductor layers as a whole can be ameliorated.

By realizing a spurious mesh structure of three power supplies with the two layers, the conductor layer A and the conductor layer B, currents are more easily diffused in the X direction, and so inductive noise can be ameliorated. In addition, depending on the pad arrangement, the conductor resistances as seen from pad ends can be reduced, and so voltage drops can be ameliorated.

### First Modification Example of Fifth Configuration Example of Three Power Supplies

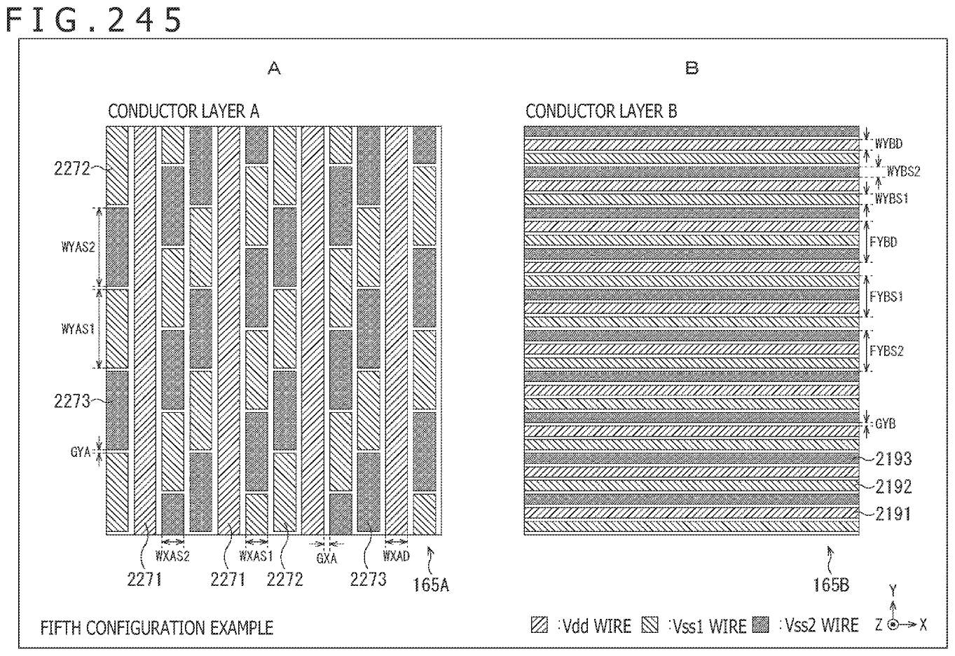

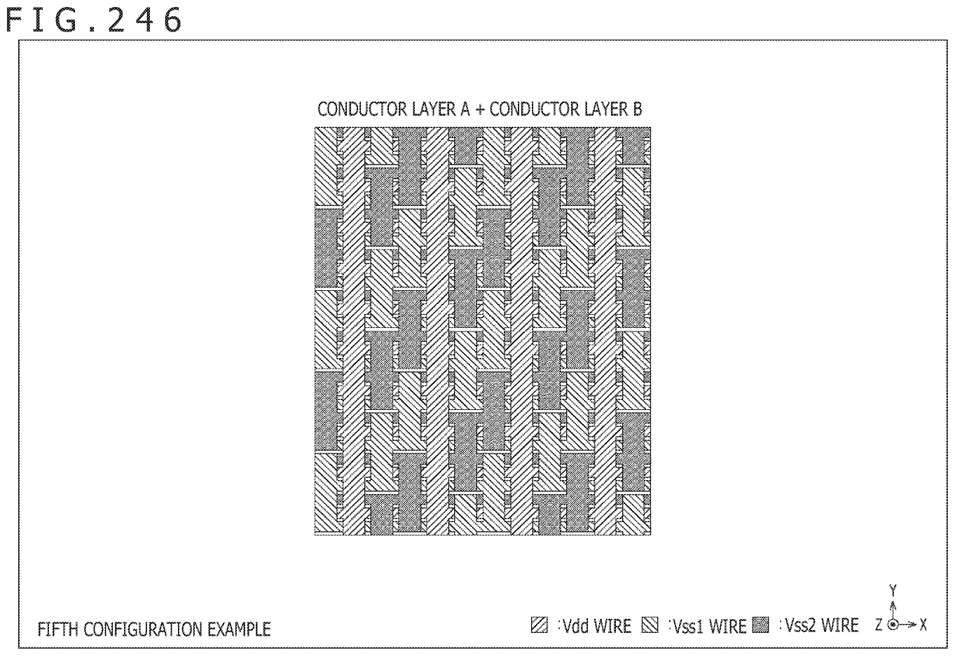

FIG. 245 and FIG. 246 depict a first modification example of the fifth configuration example of three power supplies.

In the coordinate systems in both FIG. 245 and FIG. 246, the X axis lies in the lateral direction, the Y axis lies in the longitudinal direction, and the Z axis lies in a direction perpendicular to the XY plane.

A in FIG. 245 depicts a plan view of the conductor layer A, and B in FIG. 245 depicts a plan view of the conductor layer B. Note that FIG. 245 may be regarded as depicting the entire region of each conductor layer or may be regarded as depicting a partial region of each conductor layer.

If the conductor layer A in A in FIG. 245, and the conductor layer A in the fifth configuration example depicted in A in FIG. 241 are compared with each other, they have a commonality in that groups each including three columns which include one column of a linear conductor 2271 that is long in the Y direction and two columns that are on both sides of the one column, and include alternately arranged rectangular Vss1 conductors 2272 and rectangular Vss2 conductors 2273 are arranged regularly in the X direction.

However, the conductor layer A in A in FIG. 245 is different from the conductor layer A in the fifth configuration example depicted in A in FIG. 241 in terms of the arrangement of the rectangular Vss1 conductors 2272 and the rectangular Vss2 conductors 2273 in the two columns on both sides of the linear conductor 2271 that is long in the Y direction.

That is, in the conductor layer A in the fifth configuration example depicted in A in FIG. 241, Y-direction gap positions of the rectangular Vss1 conductors 2272 and the rectangular Vss2 conductors 2273 that are arranged on both sides of the linear conductor 2271 that is long in the Y direction are the same.

In contrast, in the conductor layer A in A in FIG. 245, Y-direction gap positions of the rectangular Vss1 conductors 2272 and the rectangular Vss2 conductors 2273 that are arranged on both sides of the linear conductor 2271 that is long in the Y direction are different. Specifically, Y-direction gap positions in the right column, and Y-direction gap positions in the left column are displaced relative to each other by ½ of the Y-direction rectangular-conductor pitch. It should be noted however that the displacement amount in relation to the Y-direction rectangular-conductor pitch needs not be ½ of the Y-direction rectangular-conductor pitch. The displacement amount is desirably an integer multiple of the conductor pitch FYBD, but can be designed to have any value.

In addition, if attention is paid to the arrangements of rectangular Vss1 conductor 2272 and rectangular Vss2 conductors 2273 in two groups that are adjacent to each other in the X direction, and each group of which includes a linear conductor 2271 that is long in the Y direction, and two columns on both sides of the linear conductor 2271, the arrangements of the rectangular Vss1 conductors 2272 and the rectangular Vss2 conductors 2273 in the two adjacent groups are opposite arrangements.

The conductor layer B in B in FIG. 245 is the same as the conductor layer B in the fifth configuration example depicted in B in FIG. 241, and so an explanation thereof is omitted.

FIG. 246 is a plan view depicting the stacked state of the conductor layer A in A in FIG. 245, and the conductor layer B in B in FIG. 245.

As depicted in FIG. 246, the stacking of the conductor layer A in which groups each including three columns which include one column of a linear conductor 2271 that is long in the Y direction and two columns that are on both sides of the one column, and include alternately arranged rectangular Vss1 conductors 2272 and rectangular Vss2 conductors 2273 are arranged regularly in the X direction, and the conductor layer B having a regular arrangement of the linear conductors 2191 to 2193 that are long in the X direction cannot realize a full light-blocking structure, but can provide a certain degree of light-blocking property.

Conductors that are in the conductor layers A and B and are connected to the same power supplies may be electrically connected via conductor vias in the Z direction, or the like in predetermined partial regions where the positions of the conductors overlap. While it is desirable in terms of voltage drops if conductors that are in the conductor layers A and B and are connected to the same power supplies are electrically connected, this is not essential, and they do not have to be connected.

In the first modification example of the fifth configuration example also, in a case in which conductors that are in the conductor layers A and B and are connected to the same power supplies are electrically connected, Vdd conductors in the two layers, the conductor layer A and the conductor layer B, can form a mesh structure, and Vss1 conductors and Vss2 conductors in the two layers, the conductor layer A and the conductor layer B, can form a spurious mesh structure. Accordingly, currents can be caused to flow in both the X direction and the Y direction, and the degree of freedom of layouts of wires can be enhanced. By adopting a mesh structure for the Vdd conductors that are used in common in a configuration in which the second power supply Vss1 and the third power supply Vss2 are switched selectively, and a spurious mesh structure for the Vss1 conductors and the Vss2 conductors, voltage drops of the Vdd conductors that are used in common can be made smaller than voltage drops of the Vss1 conductors and the Vss2 conductors. By ameliorating voltage drops of the Vdd conductors, which are elements to be used in common, voltage drops of the stacked conductor layers as a whole can be ameliorated.

By realizing a spurious mesh structure of three power supplies with the two layers, the conductor layer A and the conductor layer B, currents are more easily diffused in the X direction, and so inductive noise can be ameliorated. In addition, depending on the pad arrangement, the conductor resistances as seen from pad ends can be reduced, and so voltage drops can be ameliorated.

### Second Modification Example and Third Modification Example of Fifth Configuration Example of Three Power Supplies

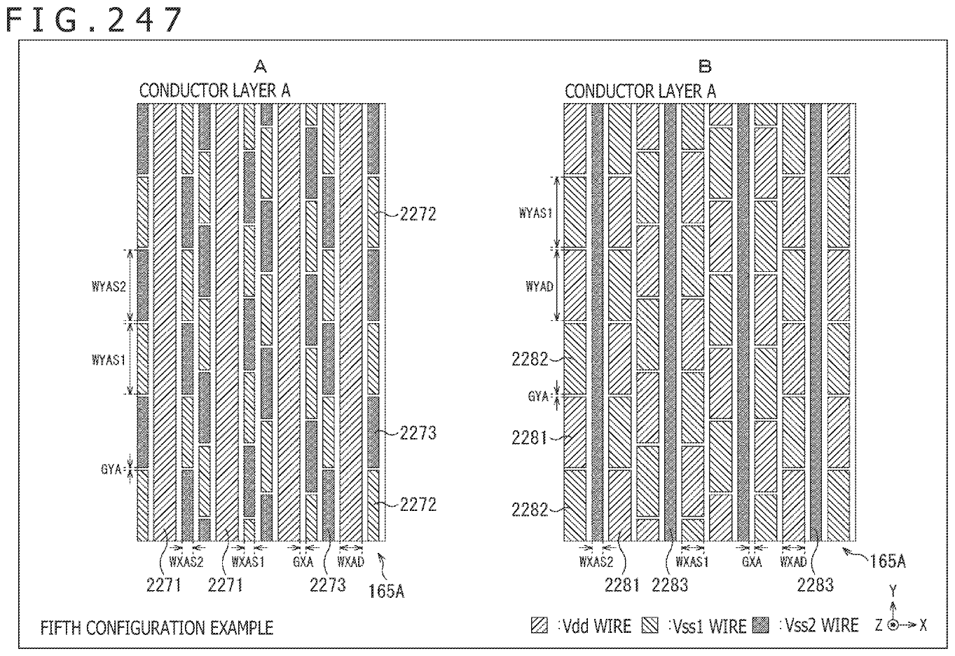

FIG. 247 depicts a second modification example and a third modification example of the fifth configuration example of three power supplies.

In the coordinate system in FIG. 247, the X axis lies in the lateral direction, the Y axis lies in the longitudinal direction, and the Z axis lies in a direction perpendicular to the XY plane.

Both A and B in FIG. 247 depict plan views of the conductor layer A. A in FIG. 247 is a plan view of the conductor layer A in the second modification example of the fifth configuration example, and B in FIG. 247 is a plan view of the conductor layer A in the third modification example of the fifth configuration example.

Although a plan view of the conductor layer B is omitted, for example, the conductor layer B is the same as the conductor layer B in the fifth configuration example depicted in B in FIG. 241. A plan view depicting the stacked state of the conductor layer A and the conductor layer B also is omitted.

In the conductor layer A in the second modification example in A in FIG. 247, the X-direction conductor widths of both rectangular Vss1 conductors and rectangular Vss2 conductors are made smaller than the X-direction conductor width of rectangular Vdd conductors.

That is, in the conductor layer A in the fifth configuration example depicted in A in FIG. 241, the X-direction conductor width WXAD of linear conductors 2171, the X-direction conductor width WXAS1 of rectangular Vss1 conductors 2272, and the X-direction conductor width WXAS2 of rectangular Vss2 conductors 2273 are made the same ((conductor width WXAD)=(conductor width WYAS1)=(conductor width WYAS2)).

In contrast, in the conductor layer A in the second modification example in A in FIG. 247, the X-direction conductor width WXAS1 of rectangular Vss1 conductors 2272, and the X-direction conductor width WXAS2 of rectangular Vss2 conductors 2273 are made equal to each other, and the conductor width WXAS1 and the conductor width WXAS2 are made smaller than the X-direction conductor width WXAD of the linear conductors 2171 ((conductor width WXAD)>(conductor width WXAS1)=(conductor width WXAS2)). In other respects, the configuration is similar to that of the conductor layer A in the fifth configuration example depicted in A in FIG. 241.

Note that the X-direction conductor width WXAS1 of the rectangular Vss1 conductors 2272, and the X-direction conductor width WXAS2 of the rectangular Vss2 conductors 2273 are the same width in the conductor layer A in A in FIG. 247, but may be different in another possible configuration. That is, the X-direction conductor width WXAS1 of the rectangular Vss1 conductors 2272 may be made smaller than the X-direction conductor width WXAD of the linear conductors 2171, and the X-direction conductor width WXAS2 of the rectangular Vss2 conductors 2273 may be made smaller than the X-direction conductor width WXAS1 of the rectangular Vss1 conductors 2272 ((conductor width WXAD)>(conductor width WXAS1)>(conductor width WXAS2)).

According to the second modification example in A in FIG. 247, Vss1 conductors and Vss2 conductors can be arranged densely by making their X-direction conductor widths small. Accordingly, by making the X-direction conductor pitches small, inductive noise can be ameliorated, and voltage drops also can be ameliorated, in some cases. By making voltage drops less likely to occur in the Vdd conductors to be used in common, voltage drops can be ameliorated for both the combination of the Vdd conductors and the Vss1 conductors, and the combination of the Vdd conductors and the Vss2 conductors in some cases.

Vdd conductors in the two layers, the conductor layer A and the conductor layer B, can form a mesh structure, and Vss1 conductors and Vss2 conductors in the two layers, the conductor layer A and the conductor layer B, can form a spurious mesh structure. Accordingly, currents can be caused to flow in both the X direction and the Y direction, and the degree of freedom of layouts of wires can be enhanced.

On the other hand, the conductor layer A in the third modification example in B in FIG. 247 includes groups that are arranged regularly in the X direction. Each group includes three columns which include one linear conductor 2283 connected to the third power supply Vss2 and two columns that are adjacent to the one column on both sides. In the two columns, rectangular conductors 2281 (hereinafter, referred to as rectangular Vdd conductors 2281) connected to the first power supply Vdd connected to the first power supply Vdd, and rectangular conductors 2282 (hereinafter, referred to as rectangular Vss1 conductors 2282) connected to the second power supply Vss1 are arranged alternately in the Y direction.

Accordingly, the conductor layer A in the third modification example in B in FIG. 247 has a configuration in which the arrangements of Vdd conductors, Vss1 conductors, and Vss2 conductors in the conductor layer A in the fifth configuration example depicted in A in FIG. 241 are replaced, the middle column in three columns included in one group is not a Vdd conductor, but a Vss2 conductor, and conductors on both sides of the Vss2 conductor are Vdd conductors and Vss1 conductors. Because Vdd conductors and Vss1 conductors are arranged alternately in the Y direction, capacitive noise can be cancelled.

In addition, according to the third modification example in B in FIG. 247, by realizing a spurious mesh structure of three power supplies with the two layers, the conductor layer A and the conductor layer B, currents are more easily diffused in the X direction, and so inductive noise can be ameliorated. In addition, depending on the pad arrangement, the conductor resistances as seen from pad ends can be reduced, and so voltage drops can be ameliorated.

### Sixth Configuration Example of Three Power Supplies

Next, a configuration example that realizes three power supplies by three wiring layers (the wiring layers 165A to 165C) is explained.

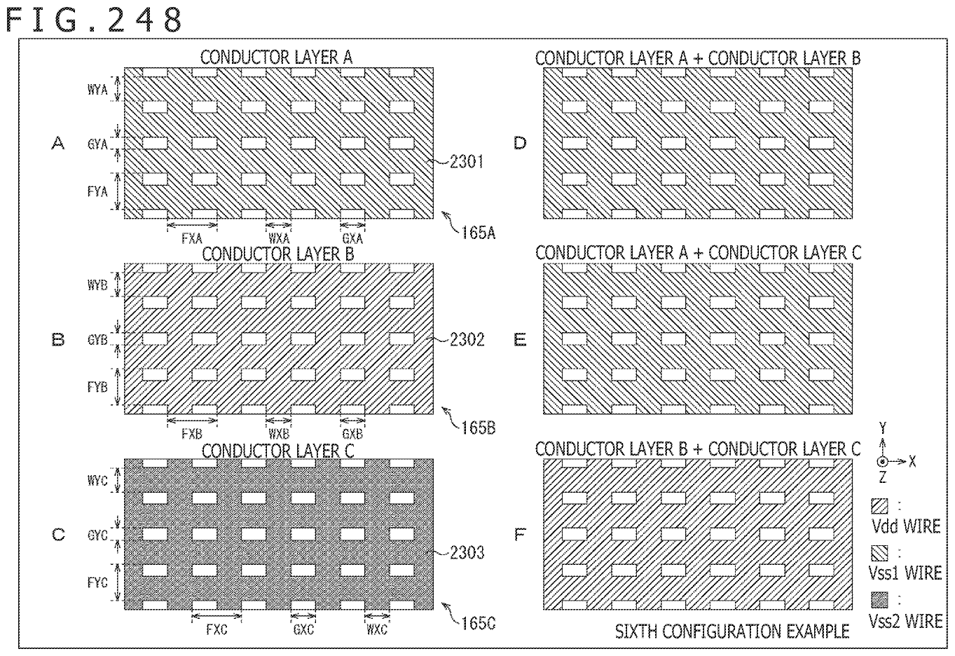

FIG. 248 depicts a sixth configuration example of three power supplies.

In the coordinate system in FIG. 248, the X axis lies in the lateral direction, the Y axis lies in the longitudinal direction, and the Z axis lies in a direction perpendicular to the XY plane.

A in FIG. 248 depicts the conductor layer A (wiring layer 165A), B in FIG. 248 depicts the conductor layer B (wiring layer 165B), and C in FIG. 248 depicts the conductor layer C (wiring layer 165C).

In addition, D in FIG. 248 is a plan view of the stacked state of the conductor layer A and the conductor layer B, E in FIG. 248 is a plan view of the stacked state of the conductor layer A and the conductor layer C, and F in FIG. 248 is a plan view of the stacked state of the conductor layer B and the conductor layer C. Note that FIG. 248 may be regarded as depicting the entire region of each conductor layer or may be regarded as depicting a partial region of each conductor layer.

The conductor layer A in A in FIG. 248 includes a mesh conductor 2301. That is, the mesh conductor 2301 has the X-direction conductor width WXA, gap width GXA, and conductor pitch FXA and has the Y-direction conductor width WYA, gap width GYA, and conductor pitch FYA. The mesh conductor 2301 is a conductor with a shape in which the basic pattern with the conductor pitch FXA and the conductor pitch FYA is arranged repetitively on the same plane. For example, the mesh conductor 2301 is a wire (Vss1 wire) connected to the second power supply Vss1.

The conductor layer B in B in FIG. 248 includes a mesh conductor 2302. That is, the mesh conductor 2302 has the X-direction conductor width WXB, gap width GXB, and conductor pitch FXB and has the Y-direction conductor width WYB, gap width GYB, and conductor pitch FYB. The mesh conductor 2302 is a conductor with a shape in which the basic pattern with the conductor pitch FXB and the conductor pitch FYB is arranged repetitively on the same plane. The mesh conductor 2302 is a wire (Vdd wire) connected to the first power supply Vdd, for example. For example, the conductor pitches of the mesh conductor 2301 and the mesh conductor 2302 are the same, and (conductor pitch FXA)=(conductor pitch FXB) and (conductor pitch FYA)=(conductor pitch FYB) are satisfied.

The conductor layer C in C in FIG. 248 includes a mesh conductor 2303. That is, the mesh conductor 2303 has an X-direction conductor width WXC and the X-direction gap width GXC and conductor pitch FXC, and has a y-direction conductor width WYC and the Y-direction gap width GYC and conductor pitch FYC. The mesh conductor 2303 is a conductor with a shape in which the basic pattern with the conductor pitch FXC and the conductor pitch FYC is arranged repetitively on the same plane. For example, the mesh conductor 2303 is a wire (Vss2 wire) connected to the third power supply Vss2. For example, the conductor pitches of the mesh conductor 2301 and the mesh conductor 2303 are the same, and (conductor pitch FXB)=(conductor pitch FXC) and (conductor pitch FYB)=(conductor pitch FYC) are satisfied.

The conductor layers A to C in FIG. 248 are stacked in the order of the conductor layers A, B and C such that the conductor layer B is positioned at the middle, for example. In this case, both the distance between the Vdd conductor and the Vss1 conductor, and the distance between the Vdd conductor and the Vss2 conductor can be made small, and inductive noise can be ameliorated. However, the conductor layer B needs not necessarily be positioned at the middle.

While the mesh conductor 2301, which is the Vss1 conductor, the mesh conductor 2302, which is the Vdd conductor, and the mesh conductor 2303, which is the Vss2 conductor, have completely matching shapes in the example depicted, there may be regions with different shapes in other regions.

### First Modification Example of Sixth Configuration Example of Three Power Supplies

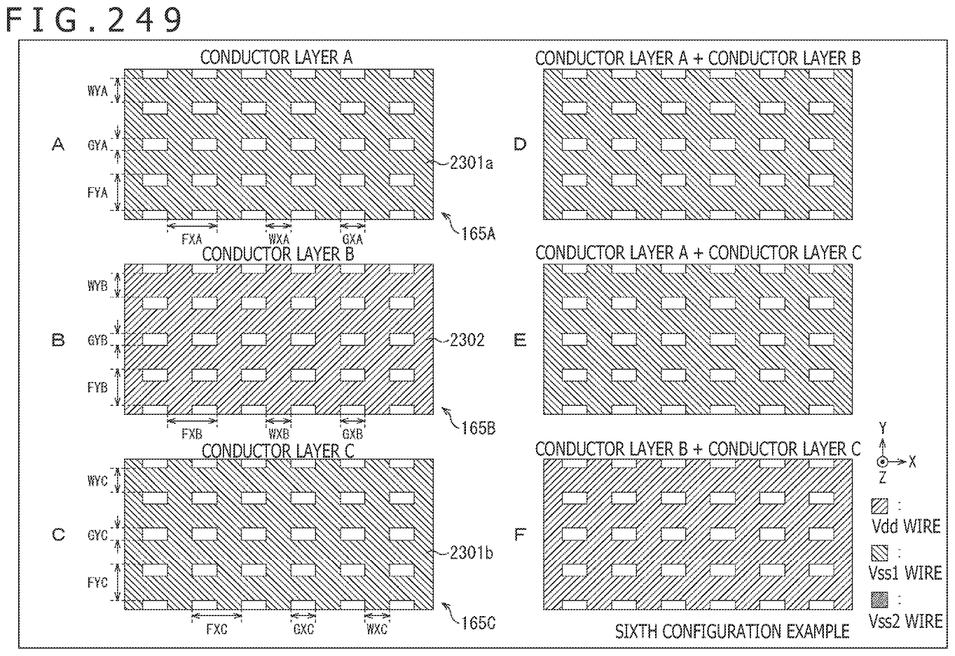

FIG. 249 to FIG. 253 depict a first modification example to a fifth modification example of the sixth configuration example depicted in FIG. 248.

In FIG. 249 to FIG. 253, the conductor layer A (wiring layer 165A), the conductor layer B (wiring layer 165B), the conductor layer C (wiring layer 165C), and the arrays in a plan view of the stacked state of the conductor layer A and the conductor layer B, a plan view of the stacked state of the conductor layer A and the conductor layer C, and a plan view of the stacked state of the conductor layer B and the conductor layer C are similar to those in FIG. 248. The coordinate systems also are similar.

FIG. 249 depicts a first modification example of the sixth configuration example of three power supplies.

While the conductor layer A is a Vss1 conductor connected to the second power supply Vss1, and the conductor layer C is a Vss2 conductor connected to the third power supply Vss2 in the sixth configuration example depicted in FIG. 248, both of the conductor layers A and C are Vss conductors connected to the same power supply Vss (the second power supply Vss1 or the third power supply Vss2) in the configuration in the first modification example in FIG. 249.

In the example in FIG. 249, the conductor layer A includes a mesh conductor 2301a, the conductor layer C includes a mesh conductor 2301c, and both of the mesh conductors 2301a and 2301c are the same as the mesh conductor 2301 connected to the second power supply Vss1.

The conductor layer B in B in FIG. 249 includes the mesh conductor 2302, similarly to the sixth configuration example depicted in FIG. 248.

By adopting a structure in which the Vdd conductor in the conductor layer B is sandwiched by the two layers of the Vss conductors in the first modification example of the sixth configuration example, further amelioration of inductive noise can be expected, and by adopting a three-layer stacked structure instead of a two-layer stacked structure, further amelioration of voltage drops also can be expected. Note that the sheet resistance of the conductor layer B, and the sheet resistance of the combination of the conductor layer A and the conductor layer B are substantially the same preferably, but this is not essential.

### Second Modification Example of Sixth Configuration Example of Three Power Supplies

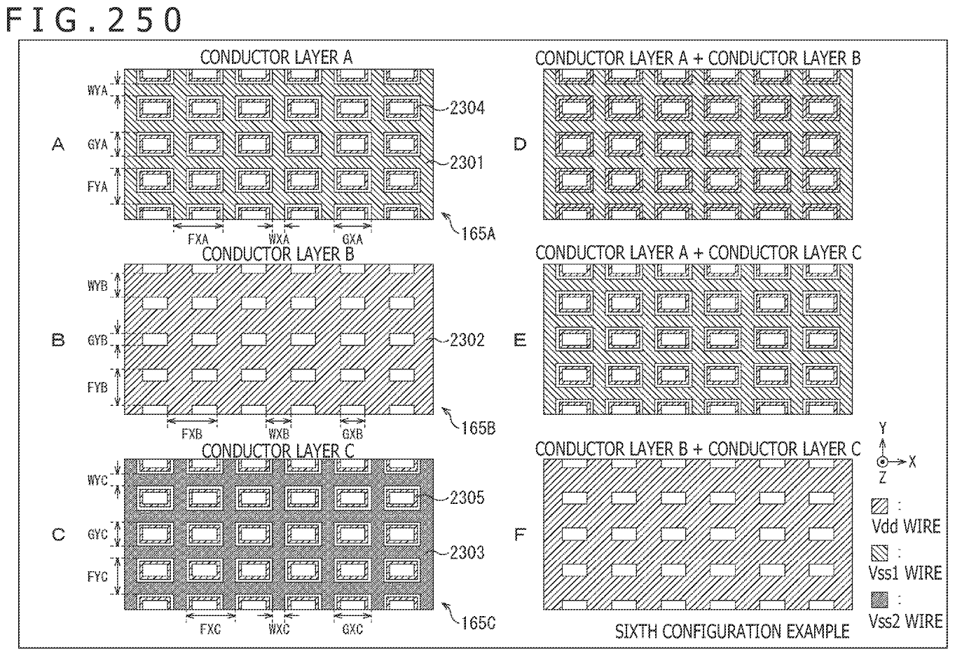

FIG. 250 depicts a second modification example of the sixth configuration example of three power supplies.

The conductor layer A in A in FIG. 250 includes relay conductors 2304, and the mesh conductor 2301 connected to the second power supply Vss1. The relay conductors 2304 are arranged in non-conductor gap regions in the mesh conductor 2301, are electrically insulated from the mesh conductor 2301, and, for example, are electrically connected to the mesh conductor 2302 in the conductor layer B, and another conductor layer.

The conductor layer B in B in FIG. 250 includes the mesh conductor 2302 connected to the first power supply Vdd, similarly to the sixth configuration example depicted in FIG. 248.

The conductor layer C in C in FIG. 250 includes relay conductors 2305, and the mesh conductor 2303 connected to the third power supply Vss2. The relay conductors 2305 are arranged in non-conductor gap regions in the mesh conductor 2303, are electrically insulated from the mesh conductor 2303, and, for example, are electrically connected to the mesh conductor 2302 in the conductor layer B, and another conductor layer.

While the planar shapes of the relay conductors 2304 and the relay conductors 2305 are rectangular shapes that have gaps therein and have predetermined conductor widths in the example in FIG. 250, this is not essential, and it is sufficient if the relay conductors 2304 and the relay conductors 2305 have shapes that can be formed in the gap regions.

### Third Modification Example of Sixth Configuration Example of Three Power Supplies

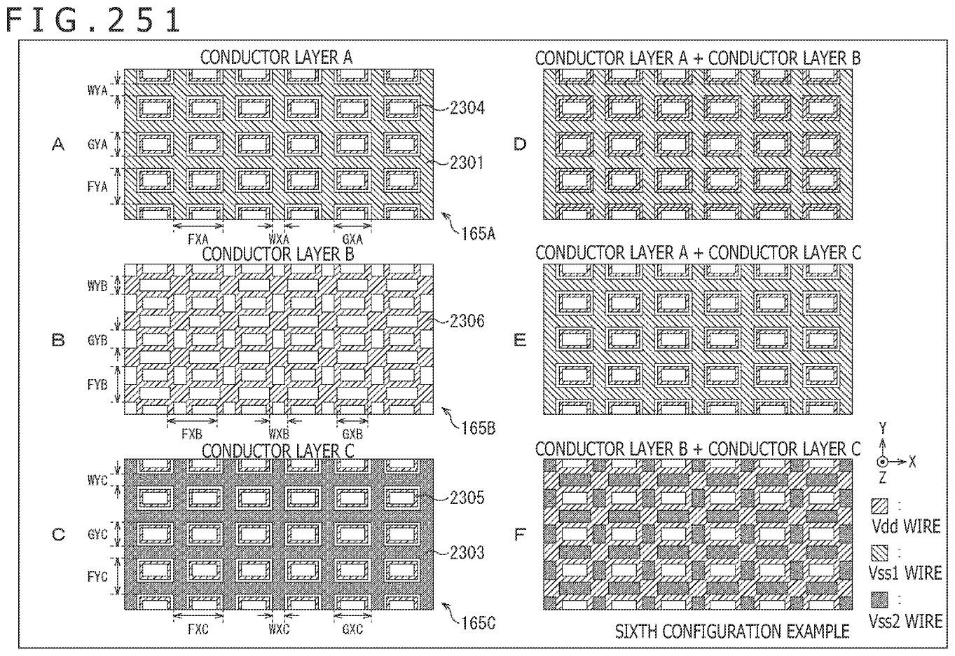

FIG. 251 depicts a third modification example of the sixth configuration example of three power supplies.

In the third modification example of the sixth configuration example depicted in FIG. 251, the conductor layer A and the conductor layer C are configured similarly to those in the second modification example of the sixth configuration example, and only the conductor layer B has a configuration different from that in the second modification example of the sixth configuration example.

Specifically, the conductor layer A in A in FIG. 251 includes the relay conductors 2304, and the mesh conductor 2301 connected to the second power supply Vss1.

The conductor layer B in B in FIG. 251 includes a mesh conductor 2306. The mesh conductor 2306 has a shape in which columns including rectangular conductors that are arranged in the Y direction with gaps therebetween and at a predetermined pitch, and columns including rectangular conductors with a predetermined conductor width that have gaps therein, and are arranged in the Y direction with gaps therebetween and at a predetermined pitch are arranged alternately in the X direction. The mesh conductor 2306 is a wire (Vdd wire) connected to the first power supply Vdd, for example.

The conductor layer C in C in FIG. 251 includes the relay conductors 2305, and the mesh conductor 2303 connected to the third power supply Vss2.

### Fourth Modification Example of Sixth Configuration Example of Three Power Supplies

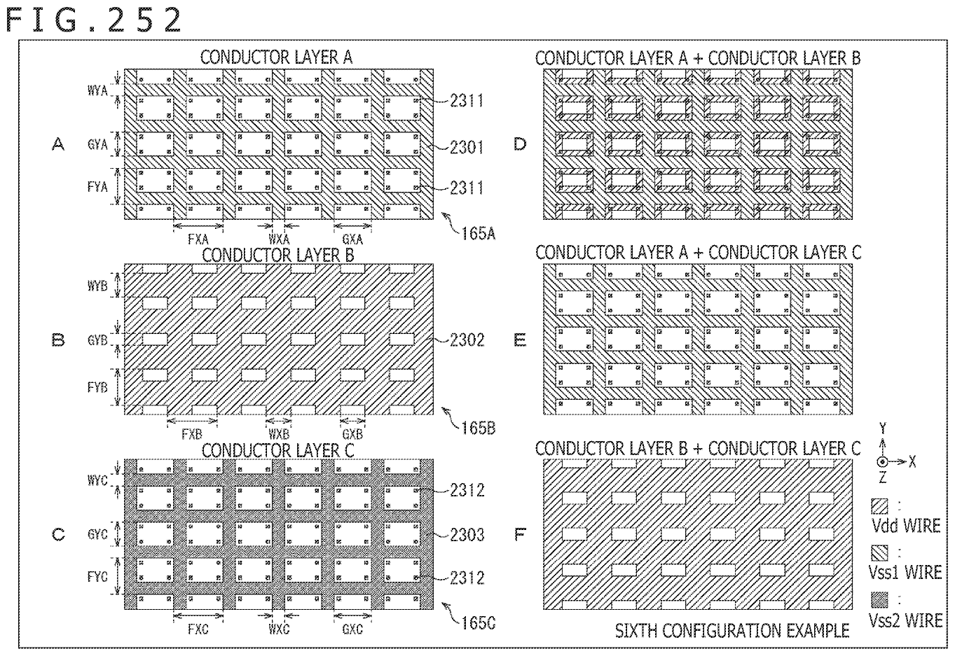

FIG. 252 depicts a fourth modification example of the sixth configuration example of three power supplies.

The fourth modification example of the sixth configuration example depicted in FIG. 252 is a configuration in which relay conductors in the conductor layer A and the conductor layer C in the second modification example of the sixth configuration example depicted in FIG. 250 are replaced.

Specifically, the conductor layer A in A in FIG. 252 includes relay conductors 2311, and the mesh conductor 2301 connected to the second power supply Vss1. The relay conductors 2304 in the conductor layer A in the second modification example depicted in FIG. 250 are rectangular conductors that have gaps therein and have a predetermined conductor width. In contrast, the relay conductors 2311 in the fourth modification example are rectangular conductors each of which is arranged being dispersed to one of four positions in a gap region of the mesh conductor 2301.

The conductor layer B in B in FIG. 252 includes the mesh conductor 2302 connected to the first power supply Vdd, similarly to the sixth configuration example depicted in FIG. 248.

The conductor layer C in C in FIG. 252 includes relay conductors 2312, and the mesh conductor 2303 connected to the third power supply Vss2. The relay conductors 2305 in the conductor layer C in the second modification example depicted in FIG. 250 are rectangular conductors that have gaps therein and have a predetermined conductor width. In contrast, the relay conductors 2312 in the fourth modification example are rectangular conductors each of which is arranged being dispersed to one of four positions in a gap region of the mesh conductor 2303.

### Fifth Modification Example of Sixth Configuration Example of Three Power Supplies

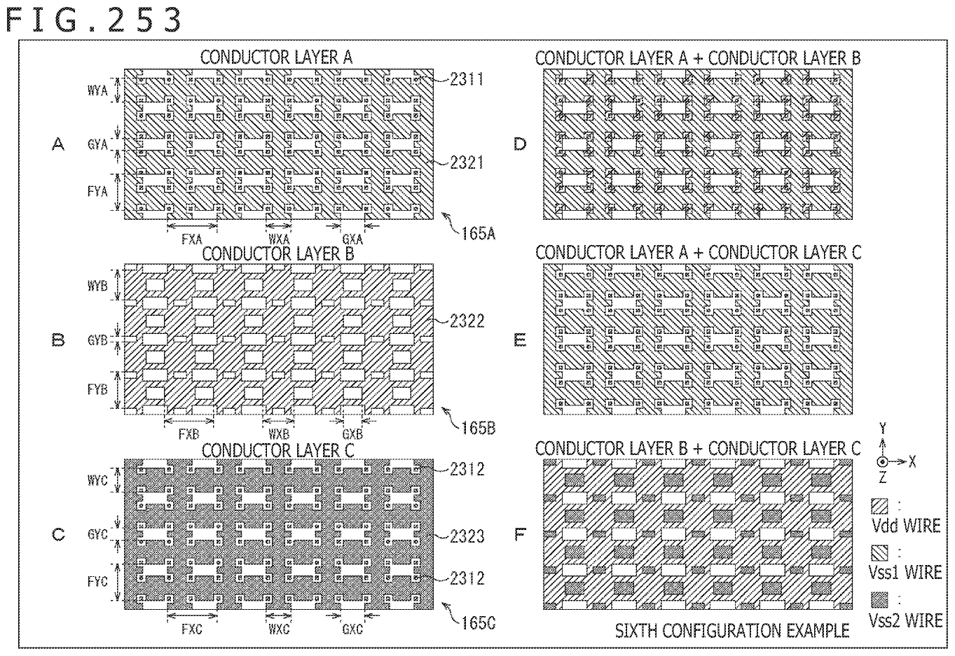

FIG. 253 depicts a fifth modification example of the sixth configuration example of three power supplies.

The fifth modification example of the sixth configuration example depicted in FIG. 253 has a configuration in which common relay conductors are provided, and mesh conductors are replaced in the fourth modification example of the sixth configuration example depicted in FIG. 252.

Specifically, the conductor layer A in A in FIG. 253 includes the relay conductors 2311, and a mesh conductor 2321 connected to the second power supply Vss1. In the mesh conductor 2321, the X-direction conductor width WXA and the Y-direction conductor width WYA are formed wider than those of the mesh conductor 2301 in the fourth modification example depicted in FIG. 252, and the X-direction gap width GXA and the Y-direction gap width GYA are formed narrower than those of the mesh conductor 2301 in the fourth modification example depicted in FIG. 252. The four corners of each gap region are non-conductor sections, and relay conductors 2311 are arranged there.

The conductor layer B in B in FIG. 253 includes a mesh conductor 2322. The mesh conductor 2322 has a shape in which columns including rectangular conductors that are arranged in the Y direction with gaps therebetween and at a predetermined pitch, and columns including rectangular shapes with a predetermined conductor width that have gaps therein, and are arranged in the Y direction with gaps therebetween and at a predetermined pitch are arranged alternately in the X direction. The mesh conductor 2322 is a wire (Vdd wire) connected to the first power supply Vdd, for example.

The conductor layer C in C in FIG. 253 includes the relay conductors 2312, and a mesh conductor 2323 connected to the third power supply Vss2. In the mesh conductor 2323, the X-direction conductor width WXC, and the Y-direction conductor width WYC are formed wider than those of the mesh conductor 2303 in the fourth modification example depicted in FIG. 252, and the X-direction gap width GXC, and the Y-direction gap width GYC are formed narrower than those of the mesh conductor 2303 in the fourth modification example depicted in FIG. 252. The four corners of each gap region are non-conductor sections, and relay conductors 2312 are arranged there.

In the configurations of all of the second modification example to the fifth modification example in FIG. 250 to FIG. 253, the conductor layer A and the conductor layer C have completely matching shapes, the conductor layer A and the conductor layer B do not have matching shapes, and the conductor layer B and the conductor layer C do not have matching shapes. However, designs regarding which two conductor layers have or do not have matching shapes can be determined as desired. In addition, conductor layers may have partial regions with matching shapes, and the other regions with unmatching shapes, in one possible configuration.

### Seventh Configuration Example of Three Power Supplies

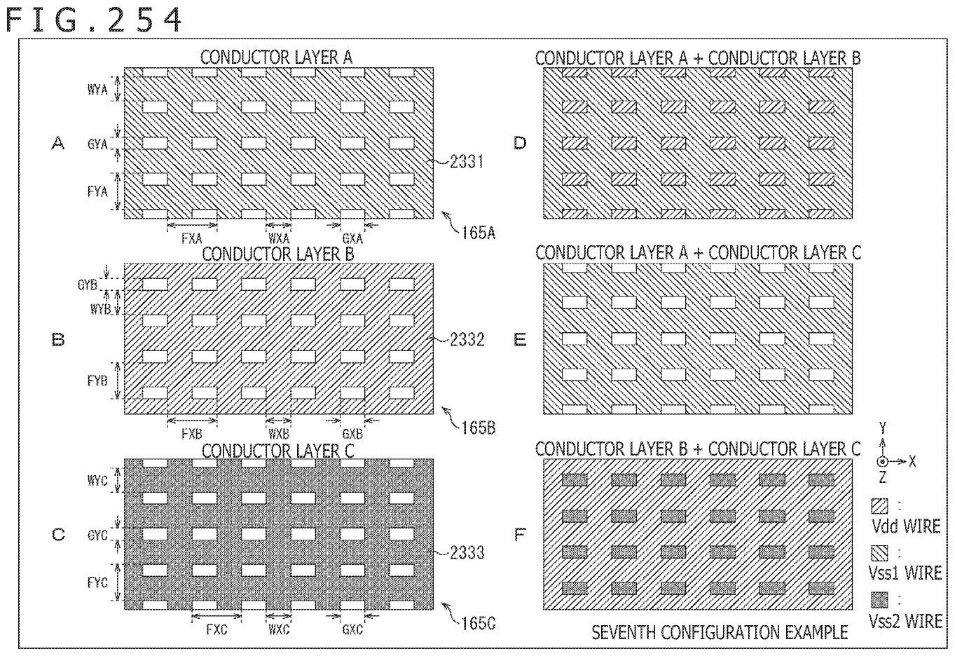

FIG. 254 depicts a seventh configuration example of three power supplies.

In the coordinate system in FIG. 254, the X axis lies in the lateral direction, the Y axis lies in the longitudinal direction, and the Z axis lies in a direction perpendicular to the XY plane.

A in FIG. 254 depicts the conductor layer A (wiring layer 165A), B in FIG. 254 depicts the conductor layer B (wiring layer 165B), and C in FIG. 254 depicts the conductor layer C (wiring layer 165C).

In addition, D in FIG. 254 is a plan view of the stacked state of the conductor layer A and the conductor layer B, E in FIG. 254 is a plan view of the stacked state of the conductor layer A and the conductor layer C, and F in FIG. 254 is a plan view of the stacked state of the conductor layer B and the conductor layer C. Note that FIG. 254 may be regarded as depicting the entire region of each conductor layer or may be regarded as depicting a partial region of each conductor layer.

The conductor layer A in A in FIG. 254 includes a mesh conductor 2331. That is, the mesh conductor 2331 has the X-direction conductor width WXA, gap width GXA, and conductor pitch FXA and has the Y-direction conductor width WYA, gap width GYA, and conductor pitch FYA. The mesh conductor 2331 is a conductor with a shape in which the basic pattern with the conductor pitch FXA and the conductor pitch FYA is arranged repetitively on the same plane. For example, the mesh conductor 2331 is a wire (Vss1 wire) connected to the second power supply Vss1.

The conductor layer B in B in FIG. 254 includes a mesh conductor 2332. That is, the mesh conductor 2332 has the X-direction conductor width WXB, gap width GXB, and conductor pitch FXB and has the Y-direction conductor width WYB, gap width GYB, and conductor pitch FYB. The mesh conductor 2332 is a conductor with a shape in which the basic pattern with the conductor pitch FXB and the conductor pitch FYB is arranged repetitively on the same plane. The mesh conductor 2332 is a wire (Vdd wire) connected to the first power supply Vdd, for example. For example, the conductor pitches of the mesh conductor 2331 and the mesh conductor 2332 are the same, and (conductor pitch FXA)=(conductor pitch FXB) and (conductor pitch FYA)=(conductor pitch FYB) are satisfied.

The conductor layer C in C in FIG. 254 includes a mesh conductor 2333. That is, the mesh conductor 2333 has the X-direction conductor width WXC, gap width GXC, and conductor pitch FXC and has the Y-direction conductor width WYC, gap width GYC, and conductor pitch FYC. The mesh conductor 2333 is a conductor with a shape in which the basic pattern with the conductor pitch FXC and the conductor pitch FYC is arranged repetitively on the same plane. For example, the mesh conductor 2333 is a wire (Vss2 wire) connected to the third power supply Vss2. The conductor pitches of the mesh conductor 2331 and the mesh conductor 2333 are the same, and (conductor pitch FXB)=(conductor pitch FXC) and (conductor pitch FYB)=(conductor pitch FYC) are satisfied.

While the positions of conductor sections of the mesh conductor 2331 in the conductor layer A and the mesh conductor 2333 in the conductor layer C overlap in both the X direction and the Y direction, the X-direction positions of conductor sections of the mesh conductor 2331 in the conductor layer A and the mesh conductor 2332 in the conductor layer B overlap, but the Y-direction positions of conductor sections of the mesh conductor 2331 in the conductor layer A and the mesh conductor 2332 in the conductor layer B are displaced. In other words, gap regions of the mesh conductor 2331 in the conductor layer A are positioned at the conductor sections of the mesh conductor 2332 in the conductor layer B, and gap regions of the mesh conductor 2333 in the conductor layer C are positioned at the conductor sections of the mesh conductor 2332 in the conductor layer B. Thereby, as depicted in D and F in FIG. 254, the stacking of the conductor layer A and the conductor layer B forms a light-blocking structure, and the stacking of the conductor layer B and the conductor layer C forms a light-blocking structure. Thereby, hot carrier light emissions can be blocked.

### Modification Example of Seventh Configuration Example of Three Power Supplies

FIG. 255 depicts a modification example of the seventh configuration example of three power supplies.

In the coordinate system in FIG. 255, the X axis lies in the lateral direction, the Y axis lies in the longitudinal direction, and the Z axis lies in a direction perpendicular to the XY plane.

A in FIG. 255 depicts the conductor layer A (wiring layer 165A), B in FIG. 255 depicts the conductor layer B (wiring layer 165B), and C in FIG. 255 depicts the conductor layer C (wiring layer 165C).

In addition, D in FIG. 255 is a plan view of the stacked state of the conductor layer A and the conductor layer B, E in FIG. 255 is a plan view of the stacked state of the conductor layer A and the conductor layer C, and F in FIG. 255 is a plan view of the stacked state of the conductor layer B and the conductor layer C. Note that FIG. 255 may be regarded as depicting the entire region of each conductor layer or may be regarded as depicting a partial region of each conductor layer.

The conductor layer A in A in FIG. 255 includes rectangular relay conductors 2341, and the mesh conductor 2331 connected to the second power supply Vss1. In other words, the conductor layer A in A in FIG. 255 has a configuration in which the relay conductors 2341 are added in gap regions of the mesh conductor 2331 depicted in A in FIG. 254, but the gap regions of the mesh conductor 2331 are formed larger than those of the mesh conductor 2331 in A in FIG. 254 in order to arrange the relay conductors 2341 therein. The relay conductors 2341 are arranged in non-conductor gap regions in the mesh conductor 2331, are electrically insulated from the mesh conductor 2331, and, for example, are electrically connected to the mesh conductor 2332 in the conductor layer B, and another conductor layer.

The conductor layer B in B in FIG. 255 includes the mesh conductor 2332 connected to the first power supply Vdd, similarly to the seventh configuration example depicted in FIG. 254.

The conductor layer C in C in FIG. 255 includes rectangular relay conductors 2342, and the mesh conductor 2333 connected to the third power supply Vss2. In other words, the conductor layer C in C in FIG. 255 has a configuration in which the relay conductors 2342 are added in gap regions of the mesh conductor 2333 depicted in C in FIG. 254, but the gap regions of the mesh conductor 2333 are formed larger than those of the mesh conductor 2333 in C in FIG. 254 in order to arrange the relay conductors 2342 therein. The relay conductors 2342 are arranged in non-conductor gap regions in the mesh conductor 2333, are electrically insulated from the mesh conductor 2333, and, for example, are electrically connected to the mesh conductor 2332 in the conductor layer B, and another conductor layer.

In the modification example of the seventh configuration example also, as depicted in D and F in FIG. 255, the stacking of the conductor layer A and the conductor layer B forms a light-blocking structure, and the stacking of the conductor layer B and the conductor layer C forms a light-blocking structure. Thereby, hot carrier light emissions can be blocked.

Note that while the stacking of two layers realizes a light-blocking structure in the configurations in the seventh configuration example and the modification example thereof in FIG. 254 and FIG. 255, the stacking of two layers may not form a light-blocking structure, but the stacking of three layers may form a light-blocking structure in one possible configuration.

### Eighth Configuration Example of Three Power Supplies

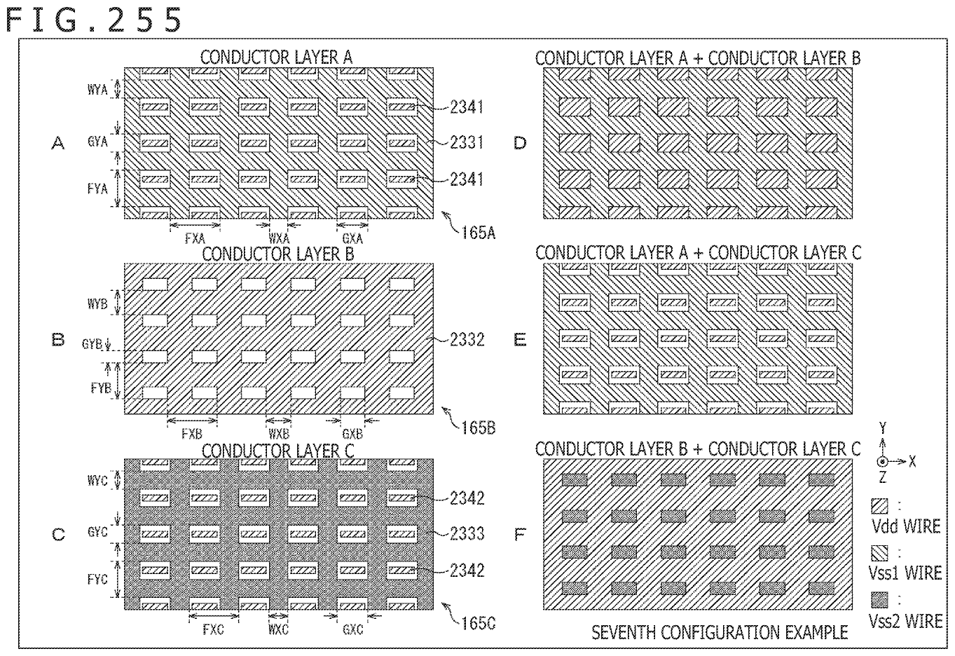

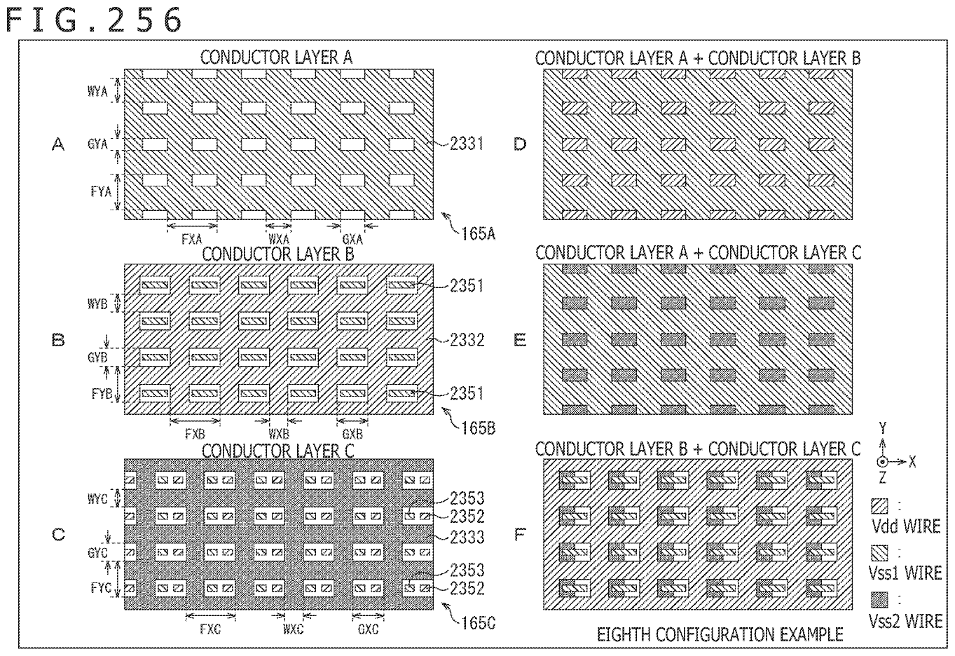

FIG. 256 depicts an eighth configuration example of three power supplies.

In the coordinate system in FIG. 256, the X axis lies in the lateral direction, the Y axis lies in the longitudinal direction, and the Z axis lies in a direction perpendicular to the XY plane.

A in FIG. 256 depicts the conductor layer A (wiring layer 165A), B in FIG. 256 depicts the conductor layer B (wiring layer 165B), and C in FIG. 256 depicts the conductor layer C (wiring layer 165C).

In addition, D in FIG. 256 is a plan view of the stacked state of the conductor layer A and the conductor layer B, E in FIG. 256 is a plan view of the stacked state of the conductor layer A and the conductor layer C, and F in FIG. 256 is a plan view of the stacked state of the conductor layer B and the conductor layer C. Note that FIG. 256 may be regarded as depicting the entire region of each conductor layer or may be regarded as depicting a partial region of each conductor layer.

The conductor layer A in A in FIG. 256 includes the mesh conductor 2331 connected to the second power supply Vss1, similarly to the seventh configuration example depicted in FIG. 254.

The conductor layer B in B in FIG. 256 includes rectangular relay conductors 2351, and the mesh conductor 2332 connected to the first power supply Vdd. In other words, the conductor layer B in B in FIG. 256 has a configuration in which the relay conductors 2351 are added in gap regions of the mesh conductor 2332 in the seventh configuration example depicted in B in FIG. 254, but the gap regions of the mesh conductor 2332 are formed larger than those of the mesh conductor 2332 in B in FIG. 254 in order to arrange the relay conductors 2351 therein. The relay conductors 2351 are arranged in non-conductor gap regions in the mesh conductor 2332, are electrically insulated from the mesh conductor 2332, and, for example, are electrically connected to the mesh conductor 2331 in the conductor layer A and relay conductors 2353 in the conductor layer C.

The conductor layer C in C in FIG. 256 includes rectangular relay conductors 2352 and 2353, and the mesh conductor 2333 connected to the third power supply Vss2. In other words, the conductor layer C in C in FIG. 256 has a configuration in which the relay conductors 2352 and 2353 are added in gap regions of the mesh conductor 2333 in the seventh configuration example depicted in C in FIG. 254, but the gap regions of the mesh conductor 2333 are formed larger than those of the mesh conductor 2333 in C in FIG. 254 in order to arrange the relay conductors 2352 and 2353 therein. The relay conductors 2352 are arranged in non-conductor gap regions in the mesh conductor 2333, are electrically insulated from the mesh conductor 2333, and, for example, are electrically connected to the mesh conductor 2332 in the conductor layer B, and another conductor layer. The relay conductors 2353 are arranged in non-conductor gap regions in the mesh conductor 2333, are electrically insulated from the mesh conductor 2333, and, for example, are electrically connected to the relay conductors 2351 in the conductor layer B, and another conductor layer.

The X-direction positions of the conductor sections of the mesh conductor 2331 in the conductor layer A and the mesh conductor 2332 in the conductor layer B overlap partially, but the Y-direction positions of the conductor sections of the mesh conductor 2331 in the conductor layer A and the mesh conductor 2332 in the conductor layer B are displaced. Thereby, the stacking of the conductor layer A and the conductor layer B forms a light-blocking structure. In addition, both the X-direction positions and Y-direction positions of conductor sections of the mesh conductor 2331 in the conductor layer A and the mesh conductor 2333 in the conductor layer C are displaced. Thereby, the stacking of the conductor layer A and the conductor layer C forms a light-blocking structure. Thereby, hot carrier light emissions can be blocked.

In the eighth configuration example in FIG. 256, by adopting an arrangement in which the X-direction positions of conductor sections of the mesh conductors in the conductor layer B and the conductor layer C are displaced, Vdd conductors and Vss conductors in the conductor layer A and the conductor layer B can be electrically connected to a layer below or above the conductor layer C through a short path via conductor vias extending in the Z direction, or the like.

Note that while relay conductors are not provided in the conductor layer A including a mesh conductor with the largest conductor widths among the conductor layers A to C in the eighth configuration example in FIG. 256, relay conductors may be provided also in the conductor layer A.

### First Modification Example of Eighth Configuration Example of Three Power Supplies

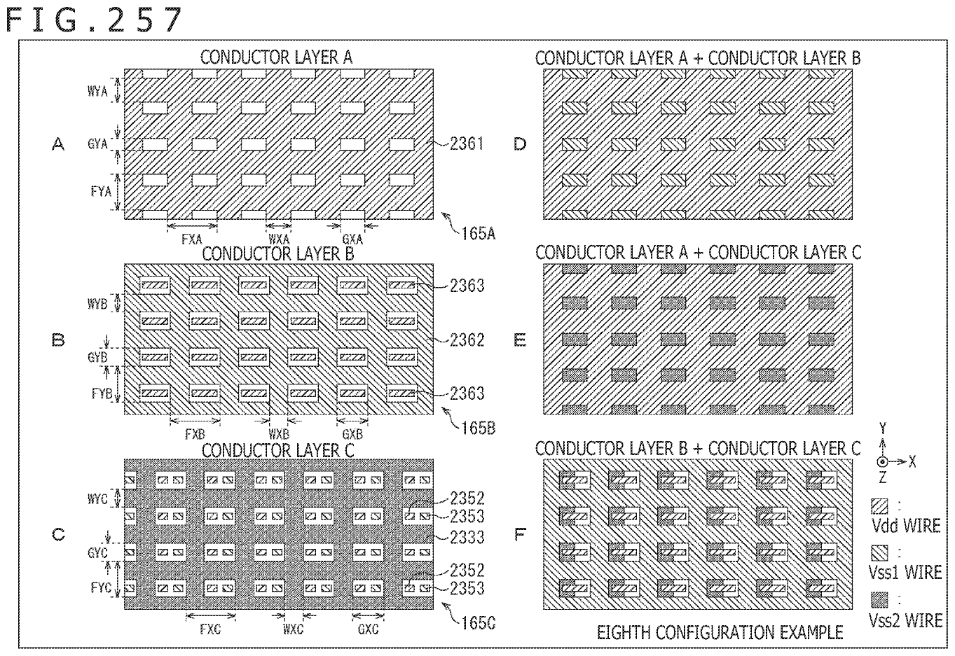

FIG. 257 to FIG. 260 depict a first modification example to a fourth modification example of the eighth configuration example of three power supplies.

In FIG. 257 to FIG. 260, the conductor layer A (wiring layer 165A), the conductor layer B (wiring layer 165B), the conductor layer C (wiring layer 165C), and the arrays in a plan view of the stacked state of the conductor layer A and the conductor layer B, a plan view of the stacked state of the conductor layer A and the conductor layer C, and a plan view of the stacked state of the conductor layer B and the conductor layer C are similar to those in FIG. 248. The coordinate systems also are similar.

FIG. 257 depicts a first modification example of the eighth configuration example of three power supplies.

The conductor layer A in A in FIG. 257 includes a mesh conductor 2361. That is, the mesh conductor 2361 has the X-direction conductor width WXA, gap width GXA, and conductor pitch FXA and has the Y-direction conductor width WYA, gap width GYA, and conductor pitch FYA. The mesh conductor 2361 is a conductor with a shape in which the basic pattern with the conductor pitch FXA and the conductor pitch FYA is arranged repetitively on the same plane. The mesh conductor 2361 is a wire (Vdd wire) connected to the first power supply Vdd, for example.

The conductor layer B in B in FIG. 257 includes rectangular relay conductors 2363, and a mesh conductor 2362 connected to the second power supply Vss1. The relay conductors 2363 are arranged in non-conductor gap regions in the mesh conductor 2362, are electrically insulated from the mesh conductor 2362, and, for example, are electrically connected to the mesh conductor 2361 in the conductor layer A and the relay conductors 2352 in the conductor layer C.

Similarly to the eighth configuration example depicted in FIG. 256, the conductor layer C in C in FIG. 257 includes the mesh conductor 2333 connected to the third power supply Vss2, the rectangular relay conductors 2352 connected to the first power supply Vdd, and the rectangular relay conductors 2353 connected to the second power supply Vss1.

Accordingly, the first modification example in FIG. 257 has a configuration in which power supplies to which the conductor layer A and the conductor layer B are connected are replaced in the eighth configuration example in FIG. 256. The first modification example in FIG. 257 has a configuration in which, for example, in a case in which the conductor layer A is a conductor layer with a sheet resistance lower than the sheet resistance of the conductor layer B or the conductor layer C, the conductor layer A with the lower sheet resistance is made a Vdd conductor. In such a case, it is desirable in terms of voltage drops if the conductor layer A has a configuration not provided with relay conductors. In this manner, the conductor layer A with a low sheet resistance can be made a conductor layer (Vdd conductor) connected to a power supply in common used in a configuration in which the second power supply Vss1 and the third power supply Vss2 are switched selectively.

### Second Modification Example of Eighth Configuration Example of Three Power Supplies

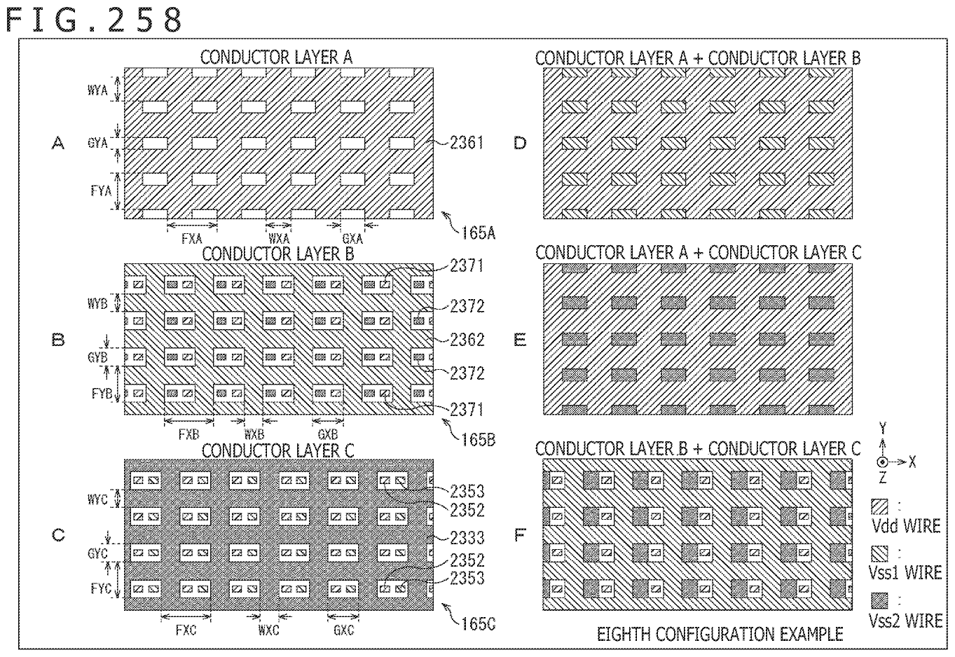

FIG. 258 depicts a second modification example of the eighth configuration example of three power supplies.

The conductor layer A in A in FIG. 258 includes the mesh conductor 2361 connected to the first power supply Vdd, similarly to the first modification example in A in FIG. 257.

The conductor layer B in B in FIG. 258 includes rectangular relay conductors 2371 and 2372, and the mesh conductor 2362 connected to the second power supply Vss1. The relay conductors 2371 are arranged in non-conductor gap regions in the mesh conductor 2362, are electrically insulated from the mesh conductor 2362, and, for example, are electrically connected to the mesh conductor 2361 in the conductor layer A and the relay conductors 2352 in the conductor layer C. The relay conductors 2372 are arranged in non-conductor gap regions in the mesh conductor 2362, are electrically insulated from the mesh conductor 2362, and, for example, are electrically connected to the mesh conductor 2333 in the conductor layer C, and another conductor layer.

Similarly to the eighth configuration example depicted in FIG. 256, the conductor layer C in C in FIG. 258 includes the mesh conductor 2333 connected to the third power supply Vss2, the rectangular relay conductors 2352 connected to the first power supply Vdd, and the rectangular relay conductors 2353 connected to the second power supply Vss1.

Accordingly, the second modification example in FIG. 258 has a configuration in which relay conductors in the conductor layer B are replaced in the first modification example in FIG. 257.

### Third Modification Example of Eighth Configuration Example of Three Power Supplies

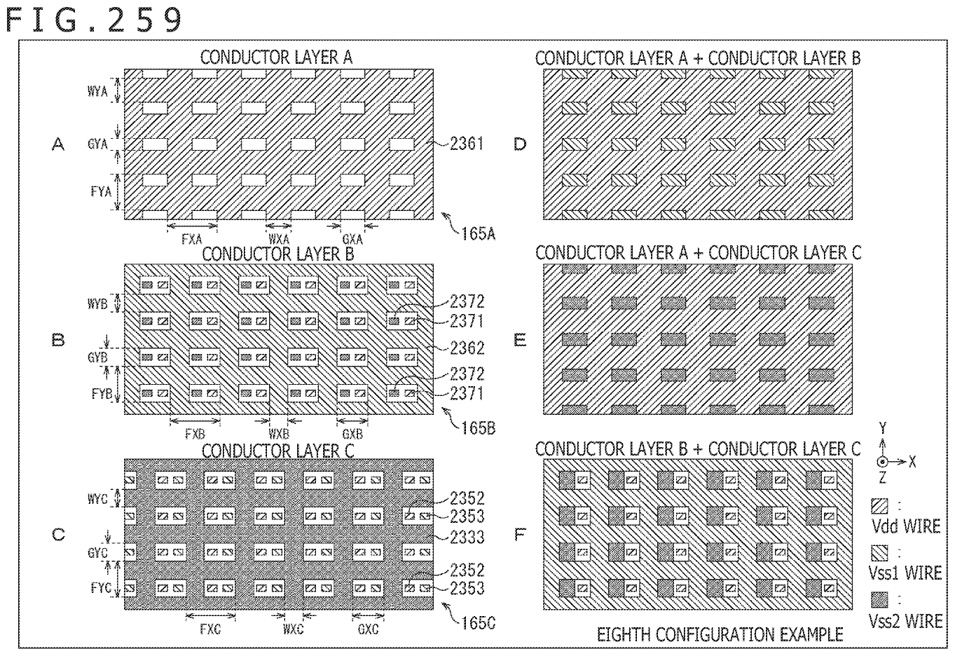

FIG. 259 depicts a third modification example of the eighth configuration example of three power supplies.

The conductor layer A in A in FIG. 259 includes the mesh conductor 2361 connected to the first power supply Vdd, similarly to the second modification example in A in FIG. 258.

Similarly to the second modification example in B in FIG. 258, the conductor layer B in B in FIG. 259 includes the mesh conductor 2362 connected to the second power supply Vss1, the rectangular relay conductors 2371 connected to the first power supply Vdd, and the rectangular relay conductors 2372 connected to the third power supply Vss2.

Similarly to the second modification example in C in FIG. 258, the conductor layer C in C in FIG. 259 includes the mesh conductor 2333 connected to the third power supply Vss2, the rectangular relay conductors 2352 connected to the first power supply Vdd, and the rectangular relay conductors 2353 connected to the second power supply Vss1.

Accordingly, the third modification example in FIG. 259 is the same as the second modification example depicted in FIG. 258 in terms of conductor configurations, but is different from the second modification example in terms of the positional relation among the conductor layers A to C.

Specifically, if the second modification example depicted in FIG. 258, and the third modification example in FIG. 259 are compared in terms of the X-direction positions of the conductor layer A and the conductor layer B, while conductor sections of the mesh conductor 2362 in the conductor layer B are arranged at the positions of gap regions of the mesh conductor 2361 in the conductor layer A in the second modification example depicted in FIG. 258, conductor sections of the mesh conductor 2362 in the conductor layer B are arranged at the positions of conductor sections of the mesh conductor 2361 in the conductor layer A in the third modification example in FIG. 259. The positional relation between the conductor layer B and the conductor layer C is the same in the second modification example and the third modification example.

The stacked state of two layers in D to F in FIG. 259 is the same in the second modification example and the third modification example.

The second modification example depicted in FIG. 258, and the third modification example in FIG. 259 have a commonality in that they have configurations in which the conductor layer B and the conductor layer C include mesh conductors as Vss1 conductors or Vss2 conductors, and two rectangular relay conductors are arranged in each gap region of the mesh conductors. In the configurations of the second modification example and the third modification example, the shape of the Vss1 conductors, and the shape of the Vss2 conductors become spuriously the same, and so this is suitable in some cases because the combination of the Vdd conductors and the Vss1 conductors, and the combination of the Vdd conductors and the Vss2 conductors can reduce the difference in voltage drops, and the difference in inductive noise. Note that, needless to say, the shape of the Vss1 conductors and the shape of the Vss2 conductors may not be spuriously the same in another possible configuration.

### Fourth Modification Example of Eighth Configuration Example of Three Power Supplies

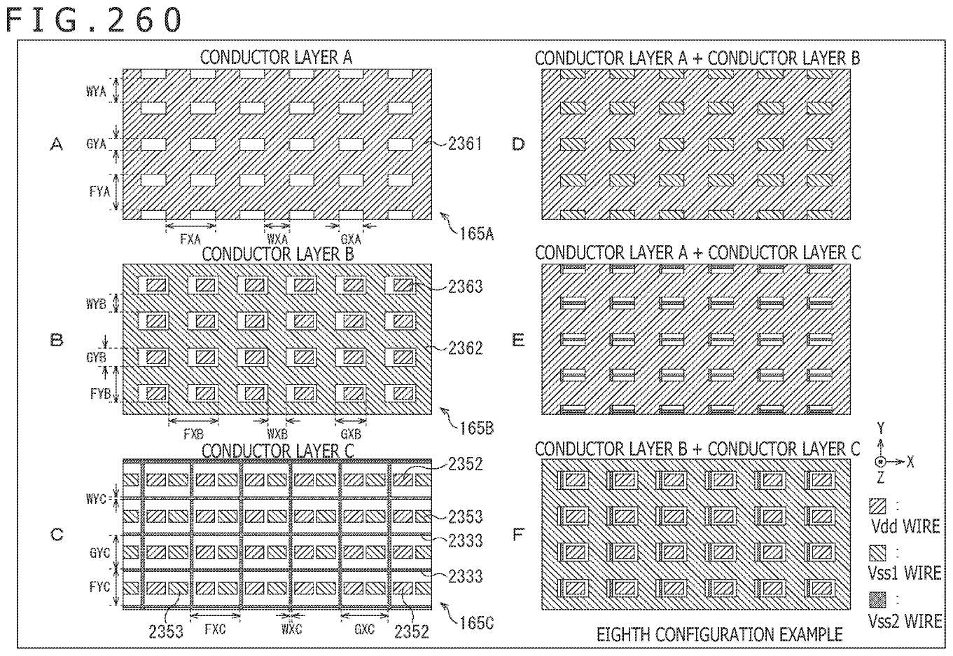

FIG. 260 depicts a fourth modification example of the eighth configuration example of three power supplies.

The conductor layer A in A in FIG. 260 includes the mesh conductor 2361 connected to the first power supply Vdd, similarly to the second modification example in A in FIG. 258.

The conductor layer B in B in FIG. 260 includes the mesh conductor 2362 connected to the second power supply Vss1, and the rectangular relay conductors 2363 connected to the first power supply Vdd. Accordingly, the conductor layer B has a commonality with the conductor layer B in the first modification example depicted in B in FIG. 257 in that the conductor layer B includes the mesh conductor 2362 and the rectangular relay conductors 2363, but is different from the first modification example in terms of the rectangular shape of the relay conductors 2363. While the rectangular shape of the relay conductors 2363 is a rectangular shape with a large difference between the X-direction and Y-direction conductor widths in the first modification example, the rectangular shape is a rectangular shape with a small difference between the X-direction and Y-direction conductor widths, and is close to a square in the fourth modification example.

The conductor layer C in C in FIG. 260 includes the mesh conductor 2333 connected to the third power supply Vss2, the rectangular relay conductors 2352 connected to the first power supply Vdd, and the rectangular relay conductors 2353 connected to the second power supply Vss1. Accordingly, while the conductor layer C has a commonality with the conductor layer C in the first modification example depicted in C in FIG. 257 in that the conductor layer C includes the mesh conductor 2333, the relay conductors 2352 and the relay conductors 2353, the conductor widths (the conductor width WXB and the conductor width WYB), and the gap widths (the gap width GXB and the gap width GYB) of the mesh conductor 2333 are different. The conductor widths in the fourth modification example in C in FIG. 260 are formed extremely thinner than the conductor widths in the first modification example depicted in C in FIG. 257. Thereby, gap regions of the mesh conductor 2333 are modified to be large, and the X-direction and Y-direction conductor widths of the relay conductors 2352 and 2353 in the fourth modification example are conversely modified to be larger than those of the relay conductors 2352 and 2353 in the first modification example.

Accordingly, in the fourth modification example, the conductor widths of the mesh conductor 2333, which is the Vss2 conductor, is made extremely smaller than the conductor widths of the mesh conductor 2361, which is the Vdd conductor, and the conductor widths of the mesh conductor 2362, which is the Vss1 conductor. In this manner, by giving the Vdd conductor and the Vss1 conductor the largest possible conductor widths, the Vdd conductor and the Vss1 conductor are prioritized in terms of voltage drops, in one possible configuration. Alternatively, the conductor widths of the mesh conductor 2362, which is the Vss1 conductor, also may be made extremely smaller than the conductor widths of the mesh conductor 2361, which is the Vdd conductor, and only the Vdd conductor may be prioritized in terms of voltage drops, in one possible configuration. Conversely, at least one of the Vss1 conductor or the Vss2 conductor may be prioritized over the Vdd conductor in terms of voltage drops, in one possible configuration.

### Ninth Configuration Example of Three Power Supplies

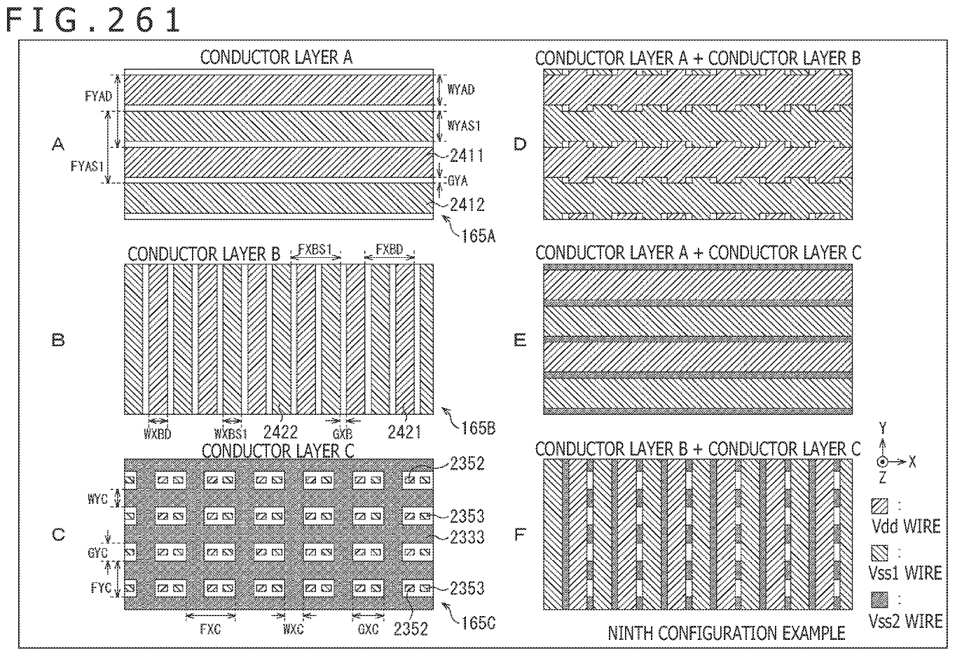

FIG. 261 depicts a ninth configuration example of three power supplies.

In the coordinate system in FIG. 261, the X axis lies in the lateral direction, the Y axis lies in the longitudinal direction, and the Z axis lies in a direction perpendicular to the XY plane.

A in FIG. 261 depicts the conductor layer A (wiring layer 165A), B in FIG. 261 depicts the conductor layer B (wiring layer 165B), and C in FIG. 261 depicts the conductor layer C (wiring layer 165C).

In addition, D in FIG. 261 is a plan view of the stacked state of the conductor layer A and the conductor layer B, E in FIG. 261 is a plan view of the stacked state of the conductor layer A and the conductor layer C, and F in FIG. 261 is a plan view of the stacked state of the conductor layer B and the conductor layer C. Note that FIG. 261 may be regarded as depicting the entire region of each conductor layer or may be regarded as depicting a partial region of each conductor layer.

In the conductor layer A in A in FIG. 261, linear conductors 2411 that are long in the X direction, and linear conductors 2412 that are long in the X direction are arranged regularly alternately in the Y direction.

For example, the linear conductors 2411 are wires (Vdd wires) connected to the first power supply Vdd. For example, the linear conductors 2412 are wires (Vss1 wires) connected to the second power supply Vss1. The linear conductors 2411 and the linear conductors 2412 are differential conductors (differential structures) in which currents flow in mutually opposite directions.

The linear conductors 2411 have the Y-direction conductor width WYAD, the linear conductors 2412 have the Y-direction conductor width WYAS1, and, for example, the conductor width WYAD of the linear conductors 2411, and the conductor width WYAS1 of the linear conductors 2412 are the same ((conductor width WYAD)=(conductor width WYAS1)). There is a gap with a gap width GYA between each linear conductor 2411 and each linear conductor 2412 in the Y direction.

The linear conductors 2411 that are long in the X direction are arranged regularly in the Y direction at a conductor pitch FYAD (=(conductor width WYAD)+(conductor width WYAS1)+2×(gap width GYA)). The linear conductors 2412 that are long in the X direction are arranged regularly in the Y direction at a conductor pitch FYAS1 (=(conductor width WYAD)+(conductor width WYAS1)+2×(gap width GYA)). For example, the conductor pitch FYAD of the linear conductors 2411, and the conductor pitch FYAS1 of the linear conductors 2412 are the same ((conductor pitch FYAD)=(conductor pitch FYAS1)).

In the conductor layer B in B in FIG. 261, linear conductors 2421 that are long in the Y direction, and linear conductors 2422 that are long in the Y direction are arranged regularly alternately in the X direction.

For example, the linear conductors 2421 are wires (Vdd wires) connected to the first power supply Vdd. For example, the linear conductors 2422 are wires (Vss1 wires) connected to the second power supply Vss1. The linear conductors 2421 and the linear conductors 2422 are differential conductors (differential structures) in which currents flow in mutually opposite directions.

The linear conductors 2421 have the X-direction conductor width WXBD, the linear conductors 2422 have the X-direction conductor width WXBS1, and, for example, the conductor width WXBD of the linear conductors 2421, and the conductor width WXBS1 of the linear conductors 2422 are the same ((conductor width WXBD)=(conductor width WXBS1)). There is a gap with the gap width GXB between each linear conductor 2421 and each linear conductor 2422 in the X direction.

The linear conductors 2421 that are long in the Y direction are arranged regularly in the X direction at the conductor pitch FXBD (=(conductor width WXBD)+(conductor width WXBS1)+2×(gap width GXB)). The linear conductors 2422 that are long in the Y direction are arranged regularly in the X direction at the conductor pitch FXBS1 (=(conductor width WXBD)+(conductor width WXBS1)+2×(gap width GXB)). For example, the conductor pitch FXBD of the linear conductors 2421, and the conductor pitch FXBS1 of the linear conductors 2422 are the same ((conductor pitch FXBD)=(conductor pitch FXBS1)).

Similarly to the eighth configuration example depicted in FIG. 256, the conductor layer C in C in FIG. 261 includes the mesh conductor 2333 connected to the third power supply Vss2, the rectangular relay conductors 2352 connected to the first power supply Vdd, and the rectangular relay conductors 2353 connected to the second power supply Vss1.

As depicted in D and F in FIG. 261, the stacking of the conductor layer A and the conductor layer B, and the stacking of the conductor layer B and the conductor layer C cannot form full light-blocking structures, but as depicted in E in FIG. 261, the stacking of the conductor layer A and the conductor layer C forms a light-blocking structure.

As in FIG. 261, in the ninth configuration example, the conductor layer A has a differential configuration of Vdd conductors and Vss1 conductors, the conductor layer B has a differential configuration of Vdd conductors and Vss1 conductors, and the conductor layer A and the conductor layer B form a configuration in which wiring directions are orthogonal to each other. Then, the conductor layer C includes a mesh conductor (Vss2 conductor) connected to the third power supply Vss2. In addition, the conductor layer C is provided with the rectangular relay conductors 2352 connected to the first power supply Vdd, and the rectangular relay conductors 2353 connected to the second power supply Vss1. Either one of or both the relay conductors 2352 and the relay conductors 2353 may be omitted.

### Modification Example of First to Ninth Configuration Examples of Three Power Supplies

Matters that are related to the linear conductors, mesh conductors, or rectangular conductors in the first configuration example to the ninth configuration example including three power supplies mentioned above, and are explained as being the same may be substantially the same. For example, the same conductor widths, the same conductor pitches and the same conductor area sizes may be substantially the same conductor widths, substantially the same conductor pitches and substantially the same conductor area sizes, respectively. Here, being substantially the same means that the differences are so small that they can be deemed to be the same, and it is sufficient if at least the differences are 200%-differences or smaller, for example.

In regions where conductors that are in any two conductor layers in the conductor layers A to C and are connected to the same power supplies overlap, the conductors can be connected electrically via conductor vias extending in the Z direction, or the like, as necessary.

In the examples of the stacking of two layers, the conductor layer A and the conductor layer B, or the three layers, the conductor layers A to C, mentioned above, any stacking order can be decided as the stacking order of the conductor layer A and the conductor layer B. In addition, in each configuration example mentioned above, conductors explained as being conductors connected to the first power supply Vdd (Vdd conductors) may be made conductors connected to the second power supply Vss1 or the third power supply Vss2, conductors explained as being conductors connected to the second power supply Vss1 (Vss1 conductors) may be made conductors connected to the first power supply Vdd or the third power supply Vss2, and conductors explained as being conductors connected to the third power supply Vss2 (Vss2 conductors) may be made conductors connected to the first power supply Vdd or the second power supply Vss1. While each of the gap widths GXA, GXB, GYA and GYB is the same irrespective of positions in the examples used for the explanation of each configuration example mentioned above, these gap widths may be varied depending on positions, and may be modulated according to positions. In addition, while each of the conductor widths WXAD, WXAS1, WXAS2, WXBD, WXBS1, WXBS2, WYAD, WYAS1, WYAS2, WYBD, WYBS1 and WYBS2 is the same irrespective of positions in some examples used for explanations, these conductor widths may be varied depending on positions, and may be modulated according to positions. In addition, while it is considered suitable if “(conductor width WYAD)=(conductor width WYAS1)=(conductor width WYAS2)” is satisfied, the relation may not be satisfied in one possible configuration. In addition, while each of the conductor pitches FXAD, FXAS1, FXAS2, FXBD, FXBS1, FXBS2, FYAD, FYAS1, FYBD, FYBS1, FYBS2, FXA, FXB, FXC, FYA, FYB and FYC is the same irrespective of positions in some examples used for explanations, these conductor pitches may be varied depending on positions, and may be modulated according to positions. In addition, while it is considered suitable if the condition, “(conductor pitch FXAD)=(conductor pitch FXAS1)=(conductor pitch FXAS2),” “(conductor pitch FXBD)=(conductor pitch FXBS1)=(conductor pitch FXBS2),” “(conductor pitch FYAD)=(conductor pitch FYAS1),” “(conductor pitch FYBD)=(conductor pitch FYBS1)=(conductor pitch FYBS2),” “(conductor pitch FXA)=(conductor pitch FXB)=(conductor pitch FXC),” or “(conductor pitch FYA)=(conductor pitch FYB)=(conductor pitch FYC)” is satisfied, the condition may not be satisfied in one configuration. In addition, at least some or all of the mesh conductors mentioned above may be planar conductors or linear conductors. Note that while configuration examples and modification examples are explained about the case in which the solid-state image pickup apparatus has three power supplies, these can be applied to configuration examples and modification examples in which the solid-state image pickup apparatus can have four or more power supplies. For example, in the case of four power supplies, at least one of the first to third power supplies may be replaced with a fourth power supply, and at least one of the first path and the second path may be replaced with a third path connected to the fourth power supply. In addition, the fourth power supply may be added in addition to the first to third power supplies, and the third path connected to the fourth power supply may be added in addition to the first path and the second path. Similar principles can be applied also to a case in which the solid-state image pickup apparatus has five or more power supplies.

### 16. Configuration Examples of Image Pickup Apparatus

The solid-state image pickup apparatus 100 mentioned above can be applied, for example, to camera systems such as a digital camera or a video camera, mobile phones having the image pickup functionality, other equipment having the image pickup functionality or electronic equipment including a semiconductor apparatus having high-sensitivity analog elements such as a flash memory.

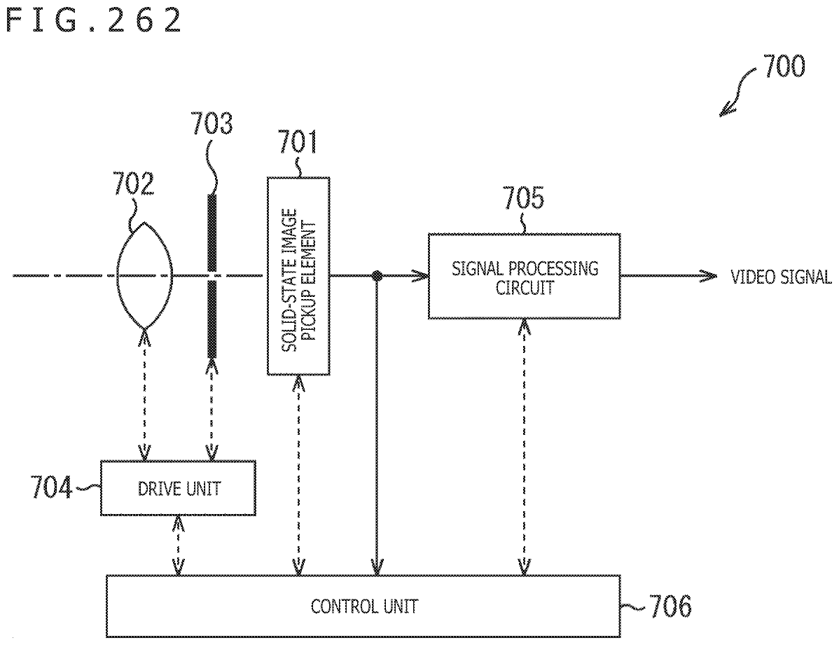

FIG. 262 is a block diagram depicting a configuration example of an image pickup apparatus 700 as one example of electronic equipment.

The image pickup apparatus 700 has a solid-state image pickup element 701, an optical lens group 702 that guides incident light to the solid-state image pickup element 701, a shutter mechanism 703 provided between the solid-state image pickup element 701 and the optical lens group 702, and a drive unit 704 that drives the optical lens group 702 and the shutter mechanism 703. Furthermore, the image pickup apparatus 700 has a signal processing circuit 705 that processes output signals of the solid-state image pickup element 701 and a control unit 706 that controls the operation of the entire image pickup apparatus 700.

The solid-state image pickup element 701 corresponds to the solid-state image pickup apparatus 100 mentioned above. The optical lens group 702 includes multiple optical lenses including a focus lens, a zoom lens, and the like and causes image light (incident light) from a subject to enter the solid-state image pickup element 701. Thereby, a signal electric charge is accumulated in the solid-state image pickup element 701 for a predetermined period. The shutter mechanism 703 controls the light illumination period and light blocking period of incident light to enter the solid-state image pickup element 701. Under the control of the control unit 706, the solid-state image pickup element 701 supplies an image pickup signal obtained by capturing an image of a subject to the signal processing circuit 705 and the control unit 706. Note that the solid-state image pickup element 701 may have a configuration from which at least one of the optical lens group 702 or the shutter mechanism 703 is omitted. In addition, the optical lens group 702 may have a configuration from which one of the zoom lens or the focus lens is omitted, or a configuration including only one lens.

Under the control of the control unit 706, the drive unit 704 drives the optical lens group 702 and the shutter mechanism 703. Specifically, the drive unit 704 shifts one or more optical lenses in the optical lens group 702 in the direction of an optical axis, and controls the shutter mechanism 703 to make it opened or closed. It should be noted however that the drive unit 704 may not control at least one of the optical lens group 702 or the shutter mechanism 703 in one possible configuration.

The signal processing circuit 705 performs various types of signal processing such as demosaicing, for example, on image signals output from the solid-state image pickup element 701. Then, the signals (video signals) on which the various types of signal processing have been performed are stored in a storage medium (not depicted) such as a memory or output to a monitor (not depicted).

The control unit 706 controls the operation of the entire image pickup apparatus 700. For example, on the basis of an image pickup signal supplied from the solid-state image pickup element 701, the control unit 706 supplies the solid-state image pickup element 701 with an image pickup control signal for controlling an image pickup timing and the like. In addition, for example, the control unit 706 supplies the drive unit 704 with drive orders for giving commands about the focus position or zoom position of the optical lens group 702, the opened/closed state of the shutter mechanism 703, and the like.

According to electronic equipment such as the image pickup apparatus 700 mentioned above, due to the at least two wiring layers 165 included in the solid-state image pickup element 701 corresponding to the solid-state image pickup apparatus 100, noise generation caused by leakages of light such as hot carrier light emissions from active elements such as MOS transistors or diodes at the time of operation in peripheral circuit units into light receiving elements can be suppressed. Accordingly, it is possible to provide electronic equipment that outputs high quality images with enhanced image quality.

### 17. Configuration Example Taking into Consideration Tamper Resistance to Electromagnetic Waves

In a configuration example explained next, the tamper resistance of the solid-state image pickup apparatus 100 to electromagnetic waves is enhanced.

In some cases, circuits storing to-be-protected information that should be protected from unintended electromagnetic waves from the outside or the like are formed in predetermined regions in the solid-state image pickup apparatus 100 mentioned above.

Here, electromagnetic waves generally represent “light, lasers, radio waves, electromagnetic waves, electromagnetic fields, magnetic fields, and electric field.” Light, lasers, and radio waves are types of electromagnetic wave. Electromagnetic waves represent variations of electromagnetic fields that are propagated through spaces as waves. Electromagnetic fields include magnetic fields and electric fields. Accordingly, “light, lasers, radio waves, electromagnetic waves, electromagnetic fields, magnetic fields, and electric fields” are collectively referred to as “electromagnetic waves.”

To-be-protected information includes, for example, unique information, bioinformation, personal information, information associated with encryption, and the like. Storage circuits such as a RAM or a ROM on which the to-be-protected information is stored are circuits associated with the to-be-protected information (hereinafter, also referred to as to-be-protected circuits). In addition, for example, circuits that support some encryption method such as public key encryption methods, symmetric key encryption methods, or unique encryption methods (hereinafter, also referred to as encryption circuits) may also be included in to-be-protected circuits. Examples of public key encryption methods include, for example, ECC (Elliptic Curve Cryptography), RSA (Rivest Shamir Adleman), and the like. Examples of symmetric key encryption methods include, for example, AES (Advanced Encryption Standard), DES (Data Encryption Standard), and the like. Encryption circuits may also include storage circuits on which information associated with encryption is stored, circuits that generate information necessary for information associated with encryption, circuits that use information associated with encryption, and the like. In addition, circuits that experience malfunctions if operation errors or tampering of processes, calculations, data, bit columns, or bit values occur, and authentication circuits that check the validity of some target may be included in to-be-protected circuits.

Typically, in light-reception sensors represented by image sensors or ToF (Time Of Flight) sensors, a back-illuminated sensor structure is used for enhancing the light-reception sensitivity.

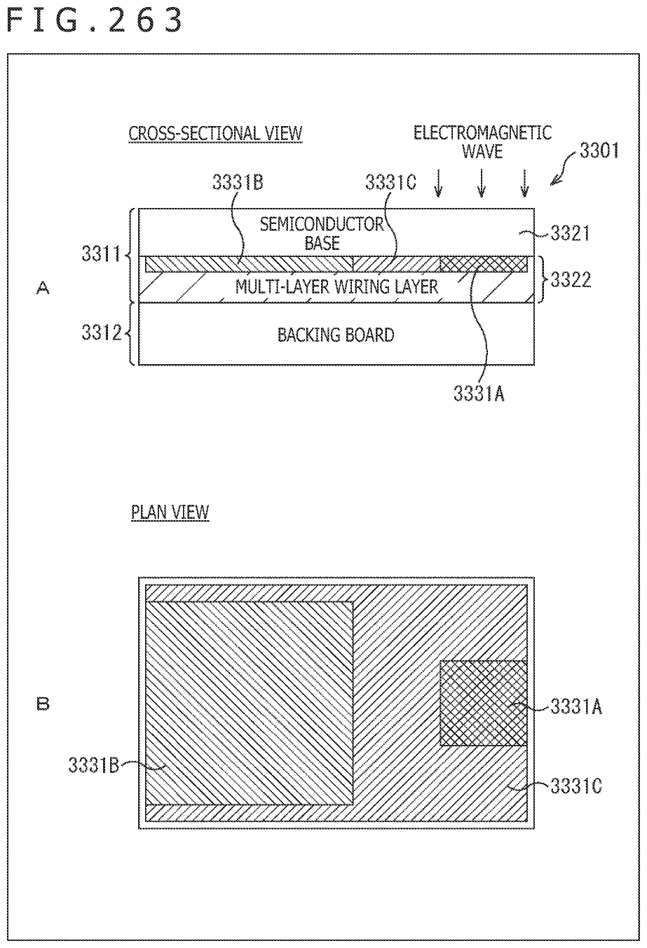

FIG. 263 depicts a schematic configuration example of a back-illuminated image sensor including a to-be-protected circuit.

A in FIG. 263 is a cross-sectional view of the back-illuminated image sensor, and B in FIG. 263 is a plan view of the back-illuminated image sensor.

An image sensor 3301 in FIG. 263 includes a semiconductor board 3311 joined with a backing board 3312 as depicted in A in FIG. 263. The semiconductor board 3311 includes a semiconductor base 3321, and a multi-layer wiring layer 3322 formed on the front side of the semiconductor base 3321 located on the lower side in the figure. A photodiode which is a photoelectric converting unit is formed on the backside of the semiconductor base 3321 located on the upper side in the figure, and the image sensor 3301 is a back-illuminated image sensor. On the backside of the semiconductor base 3321, for example, an antireflection film, a light-blocking film that blocks off a predetermined region from light, a color filter, a microlens, or the like is formed.

Multiple layers of wires are formed via interlayer dielectric films in the multi-layer wiring layer 3322. A transistor group 3331 formed as part of the multi-layer wiring layer 3322 and on the front side of the semiconductor base 3321 can be classified into, for example, a first transistor group 3331A, a second transistor group 3331B, and a third transistor group 3331C. The first transistor group 3331A is, for example, one or more MOS transistors included in to-be-protected circuits, and the like. The second transistor group 3331B is, for example, one or more pixel transistors such as the transfer transistor 142, the reset transistor 143, the amplification transistor 144, or the select transistor 145. The third transistor group 3331C is, for example, one or more MOS transistors such as the MOS transistors 164 formed as part of the logic circuit mentioned above, or the like.

In the arrangement of the first transistor group 3331A, the second transistor group 3331B, and the third transistor group 3331C in the plane direction, for example, as depicted in B in FIG. 263, the region of the second transistor group 3331B is a region corresponding to the region of a pixel array, and the first transistor group 3331A and the third transistor group 3331C are arranged in the other region.

A back-illuminated sensor structure like the one depicted in FIG. 263 can have increased light-reception sensitivity because the multi-layer wiring layer 3322 is not provided on a light-reception path. However, because the thickness of the semiconductor base 3321 is formed thin in this sensor structure in order to increase the light-reception sensitivity, the sensor structure is considered to be a structure that can more easily experience malfunctions arising from externally-generated electromagnetic waves or leaked electromagnetic waves. For example, because it is a structure in which the thickness of the semiconductor base 3321 is thin and externally-generated electromagnetic waves are transmitted easily (less likely to be attenuated), malfunctions occur more easily to a circuit including the transistor group 3331 due to electromagnetic waves from the side of the semiconductor base 3321, which is part of a light-reception path. For example, because it is a structure in which the thickness of the semiconductor base 3321 is thin and leaked electromagnetic waves are less likely to be attenuated, electromagnetic wave information generated from a circuit including the transistor group 3331 is transmitted more easily (leaked more easily) from the side of the semiconductor base 3321, which is part of a light-reception path, and there is a concern over malfunctions of an external circuit, apparatus, or equipment or attacks using the leaked electromagnetic waves. For example, in a case in which the circuit including the first transistor group 3331A is a to-be-protected circuit, in other words, in a case in which the implementation region of the first transistor group 3331A is a to-be-protected region where the to-be-protected circuit is formed, there is a concern over security threat of attacks using electromagnetic waves (electromagnetic attacks).

In view of this, structural examples explained below are suitable for a case in which the back-illuminated image sensor includes a to-be-protected circuit, and the structural examples make it possible to take measures more effectively against malfunctions arising from externally-generated electromagnetic waves or leaked electromagnetic waves.

### First Stacked Structure Example Including Electromagnetic-Wave Attenuating Unit

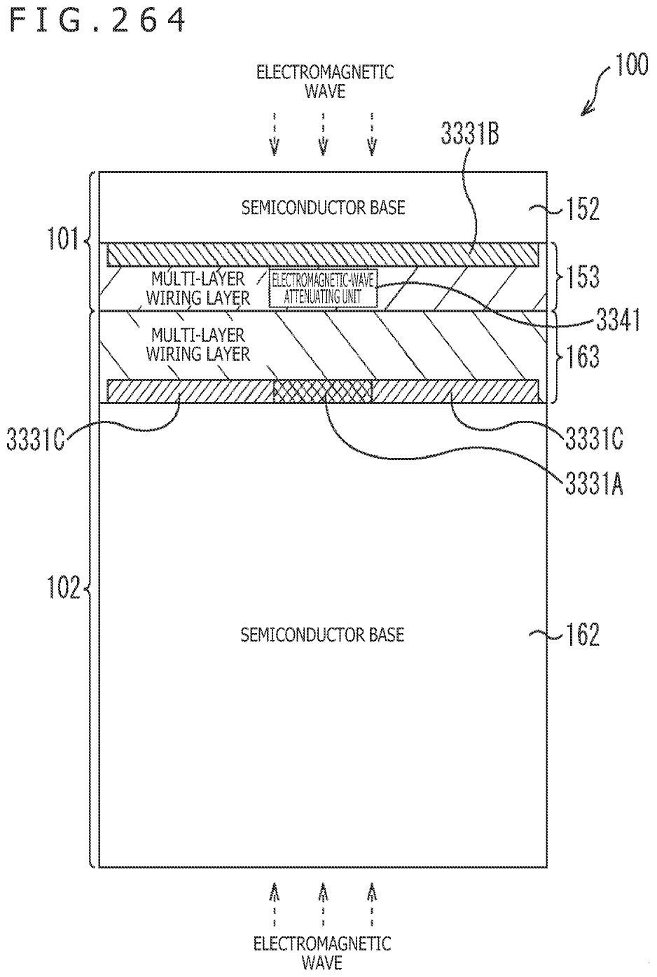

FIG. 264 is a cross-sectional view depicting a first stacked structure example of the solid-state image pickup apparatus to which the present technology is applied.

Sections in FIG. 264 to FIG. 268 that have counterparts in configuration examples mentioned above are given the same reference signs, and explanations of those sections are omitted as appropriate.

The solid-state image pickup apparatus 100 depicted in FIG. 264 includes the stacked first semiconductor board 101 and second semiconductor board 102, similarly to structures depicted in FIG. 6 and the like.

The first semiconductor board 101 includes the semiconductor base 152, and the multi-layer wiring layer 153 formed on the front side (the lower side in the figure) of the semiconductor base 152. The photodiodes 141 (FIG. 6) to be photoelectric converting units are formed on the backside (the upper side in the figure) of the semiconductor base 152. On the backside of the semiconductor base 152, for example, an antireflection film, a light-blocking film that blocks off a predetermined region from light, a color filter, a microlens, or the like is formed. In addition, the second transistor group 3331B related to pixels 131 such as the transfer transistor 142 to the select transistor 145 in FIG. 5 is formed on the front side (the lower side in the figure) of the semiconductor base 152.

At least part of the multi-layer wiring layer 153 formed on the front side of the semiconductor base 152 is provided with an electromagnetic-wave attenuating unit 3341 that attenuates externally-generated electromagnetic waves or leaked electromagnetic waves. For example, the electromagnetic-wave attenuating unit 3341 includes at least some of signal lines 132 that transfer pixel signals of pixels 131 in the pixel array 121, and at least some of control lines 133 that transfer control signals from the vertical scanning unit 123.

On the other hand, the second semiconductor board 102 includes the semiconductor base 162, and the multi-layer wiring layer 163 formed on the side of the light incidence surface of the semiconductor base 162 (on the side of the first semiconductor board 101). In a region which is in the multi-layer wiring layer 163 and is on the semiconductor base 162, the first transistor group 3331A which includes one or more MOS transistors related to to-be-protected information, and the third transistor group 3331C including the multiple MOS transistors 164 are formed. The region of the first transistor group 3331A is formed corresponding to the region of the electromagnetic-wave attenuating unit 3341 formed in the multi-layer wiring layer 153 of the first semiconductor board 101.

According to the first stacked structure example including the electromagnetic-wave attenuating unit 3341 above, the semiconductor base 152, the second transistor group 3331B, the first transistor group 3331A, and the semiconductor base 162 have a positional relation in terms of an order in the stacking direction of the first semiconductor board 101 and the second semiconductor board 102, and are arranged in this order.

More specifically, the first transistor group 3331A related to to-be-protected information is implemented in a transistor layer of the multi-layer wiring layer 163 which is on the side of the semiconductor base 162 and is far from the semiconductor base 152 that transmits at least part of electromagnetic waves. In a transistor layer of the multi-layer wiring layer 153 closer to the semiconductor base 152, for example, the second transistor group 3331B such as the transfer transistor 142 to the select transistor 145 is implemented. Then, the second transistor group 3331B is arranged in a region which is at least part of the region located between the semiconductor base 152 and the first transistor group 3331A and overlapping the first transistor group 3331A (and suitably is larger than the overlapping region). It is possible in this case to ensure that, in the thickness direction, there is a physical obstacle to an attacker, and so it is considered that the security threat is reduced.

In addition, a conductor is arranged as wires in the multi-layer wiring layer 153 near (the adjacent layer) the region where the second transistor group 3331B is implemented, and electromagnetic waves are attenuated. Accordingly, it is considered that it is a structure which is hard to attack on. Specifically, in a region which is in the multi-layer wiring layer 153, is at least part of the region overlapping the second transistor group 3331B, and is at least part of the region overlapping the first transistor group 3331A (and suitably is larger than the overlapping region), the signal lines 132 and the control lines 133 are arranged as the electromagnetic-wave attenuating unit 3341. The signal lines 132 and the control lines 133 form a mesh structure (mesh conductor), and the mesh conductor attenuates electromagnetic waves.

In addition, it is more desirable if the third transistor group 3331C included in a circuit related not significantly to to-be-protected information is arranged to surround the first transistor group 3331A, but this is not essential. It is possible in this case to ensure that, in the plane direction, there is a physical obstacle to an attacker, and so it is considered that the security threat is reduced further.

It is desirable for the purpose of ensuring the support strength that the semiconductor base 162 has a thickness which is at least 200% or greater, 500% or greater if possible, and suitably 1000% or greater of the semiconductor base 152. In addition, because the semiconductor base 162 is not included in a light-reception path, a board (e.g., a semiconductor board, a package board, a printed board, etc.) or a metallic material (e.g., a metallic film, metal foil, a metallic plate, etc.) can be arranged further on the outer side of the semiconductor base 162. For these reasons, it is considered that the first stacked structure example in FIG. 264 is a structure that is advantageous in terms of attacks from the side of the semiconductor base 162.

From the above, according to the first stacked structure example including the electromagnetic-wave attenuating unit 3341, it is possible to reduce the security threat arising from externally-generated electromagnetic waves or leaked electromagnetic waves.

### Second Stacked Structure Example Including Electromagnetic-Wave Attenuating Unit

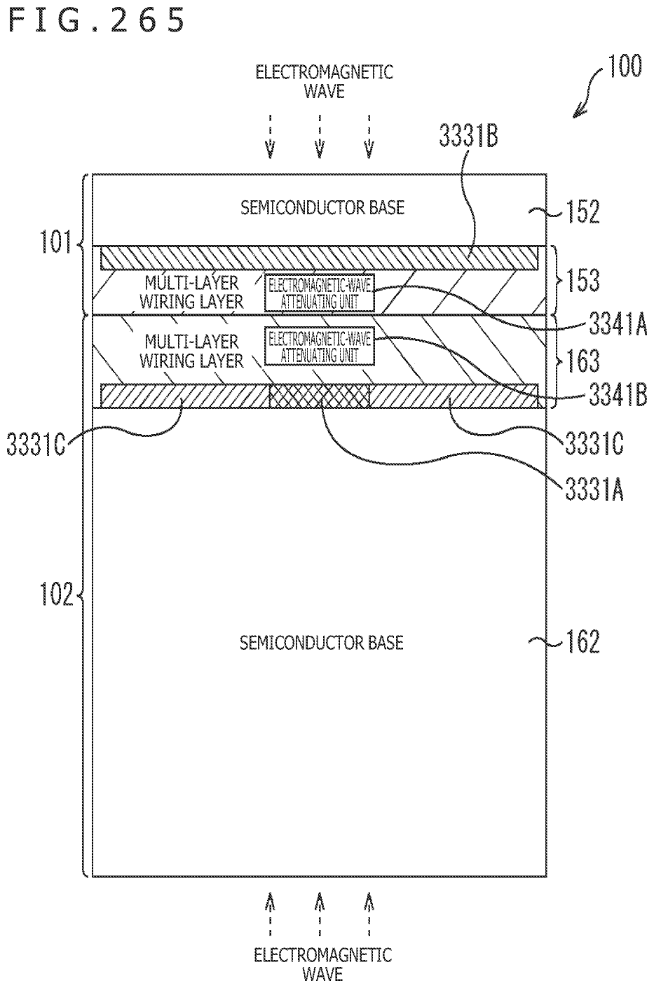

FIG. 265 is a cross-sectional view depicting a second stacked structure example of the solid-state image pickup apparatus to which the present technology is applied.

Sections in FIG. 265 that have counterparts in the first stacked structure example in FIG. 264 are given the same reference signs, and explanations of those sections are omitted as appropriate.

In the first stacked structure example in FIG. 264, the electromagnetic-wave attenuating unit 3341 is formed only in the multi-layer wiring layer 153 of the first semiconductor board 101.

In contrast, in the second stacked structure example in FIG. 265, electromagnetic-wave attenuating units 3341 are formed in both the multi-layer wiring layer 153 of the first semiconductor board 101 and the multi-layer wiring layer 163 of the second semiconductor board 102. Specifically, an electromagnetic-wave attenuating unit 3341A is formed in the multi-layer wiring layer 153, and an electromagnetic-wave attenuating unit 3341B is formed in the multi-layer wiring layer 163.

While, in the second stacked structure example in FIG. 265, the electromagnetic-wave attenuating unit 3341A and the electromagnetic-wave attenuating unit 3341B are not joined and are arranged separately, the electromagnetic-wave attenuating unit 3341A and the electromagnetic-wave attenuating unit 3341B may be arranged being joined with each other.

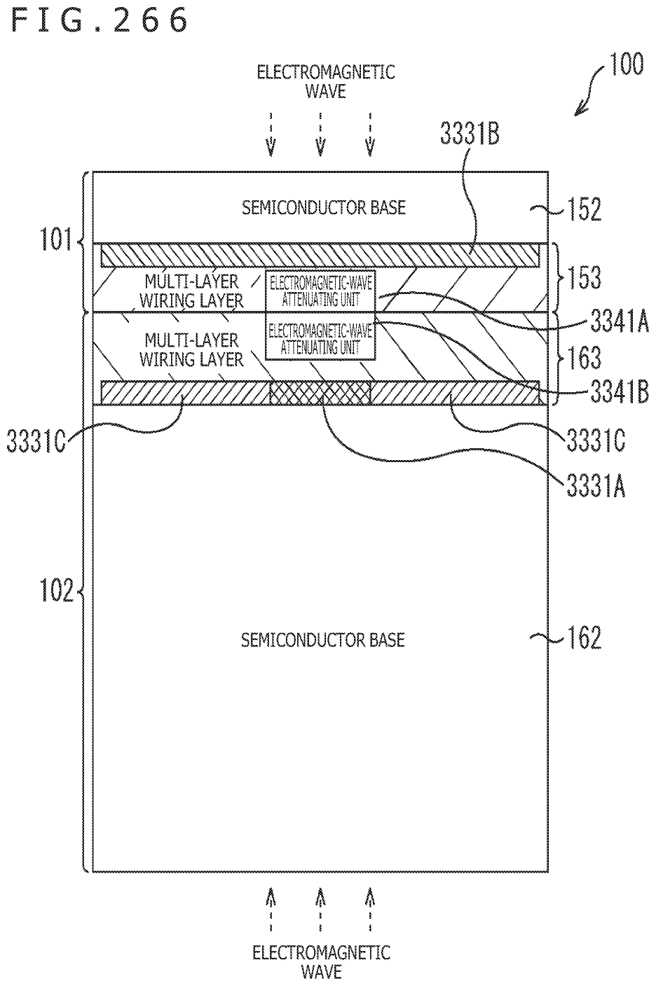

FIG. 266 depicts a modification example of the second stacked structure example and depicts an example in which the electromagnetic-wave attenuating unit 3341A and the electromagnetic-wave attenuating unit 3341B are arranged being at least partially electrically joined with each other. In a case in which the electromagnetic-wave attenuating unit 3341A and the electromagnetic-wave attenuating unit 3341B are arranged being joined with each other in this manner, the electromagnetic-wave attenuating units 3341 (3341A and 3341B) can reinforce the joining of the first semiconductor board 101 and the second semiconductor board 102.

The electromagnetic-wave attenuating unit 3341A may be electrically linked with the second transistor group 3331B directly or indirectly. In this case, the electromagnetic-wave attenuating unit 3341A can also be regarded as part of conductor wires of the second transistor group 3331B. For example, a mesh conductor or planar conductor as the electromagnetic-wave attenuating unit 3341A can be used also as a conductor wire of the second transistor group 3331B, and so is desirably electrically linked with the second transistor group 3331B, but this is not essential.

The electromagnetic-wave attenuating unit 3341B may be electrically linked with the first transistor group 3331A directly or indirectly. In this case, the electromagnetic-wave attenuating unit 3341B can also be regarded as part of conductor wires of the first transistor group 3331A. For example, a mesh conductor or planar conductor as the electromagnetic-wave attenuating unit 3341B can be used also as a conductor wire of the first transistor group 3331A, and so is desirably electrically linked with the first transistor group 3331A, but this is not essential.

The electromagnetic-wave attenuating unit 3341B may be electrically linked with the third transistor group 3331C directly or indirectly. In this case, the electromagnetic-wave attenuating unit 3341B can also be regarded as part of conductor wires of the third transistor group 3331C. For example, a mesh conductor or planar conductor as the electromagnetic-wave attenuating unit 3341B can be used also as a conductor wire of the third transistor group 3331C, and so is desirably electrically linked with the third transistor group 3331C, but this is not essential.

The electromagnetic-wave attenuating unit 3341B may be electrically linked with the first transistor group 3331A and the third transistor group 3331C directly or indirectly. In this case, direct influence on the first transistor group 3331A (e.g., electromagnetic attacks, inductive noise, and capacitive noise) is reduced, and so it is considered that this is desirable in some cases.

In contrast, the electromagnetic-wave attenuating units 3341 may be electrically disconnected from the first to third transistor groups 3331A to 3341C directly or indirectly. In this case, the electromagnetic-wave attenuating units 3341 can also be regarded as being electrically insulated from the first to third transistor groups 3331A to 3341C. Because direct influence on the first to third transistor groups 3331A to 3341C is reduced, it is considered that such an insulation configuration is desirable in some cases. Depending on configurations, the electrically disconnected electromagnetic-wave attenuating units 3341 can be used also as the conductive shield 1151. That is, the electromagnetic-wave attenuating units 3341 can be used as both a shield that guards against capacitive noise from the second semiconductor board 102 and a shield that guards against electromagnetic waves from the outside.

### Third Stacked Structure Example Including Electromagnetic-Wave Attenuating Unit

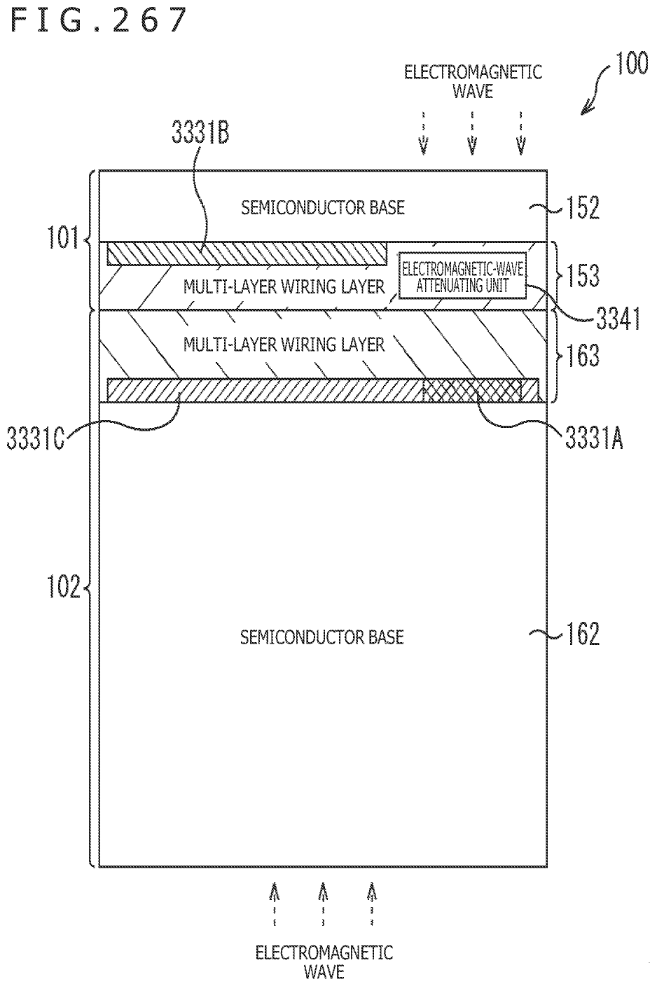

FIG. 267 is a cross-sectional view depicting a third stacked structure example of the solid-state image pickup apparatus to which the present technology is applied.

Sections in FIG. 267 that have counterparts in the first stacked structure example in FIG. 264 are given the same reference signs, and explanations of those sections are omitted as appropriate.

In the first stacked structure example in FIG. 264, the second transistor group 3331B is formed between the electromagnetic-wave attenuating unit 3341 and the semiconductor base 152.

In contrast, in the third stacked structure example in FIG. 267, the second transistor group 3331B is not formed between the electromagnetic-wave attenuating unit 3341 and the semiconductor base 152. In other words, the electromagnetic-wave attenuating unit 3341 is arranged in a region which is in the region not overlapping the second transistor group 3331B and is at least part of the region overlapping the first transistor group 3331A (and suitably is larger than the overlapping region).

Even in a case in which the second transistor group 3331B is not arranged between the semiconductor base 152 and the first transistor group 3331A, a physical obstacle to the source of an attack can be added in the thickness direction by an amount corresponding to the thicknesses of the multi-layer wiring layer 153 and the multi-layer wiring layer 163, and so it is considered that the security threat is reduced. It should be noted however that it is desirable if the electromagnetic-wave attenuating unit 3341 is arranged in a region which is at least part of the region located between the semiconductor base 152 and the first transistor group 3331A and overlapping the first transistor group 3331A, and suitably is larger than the overlapping region.

### Detailed Cross-Sectional View of Second Stacked Structure Example

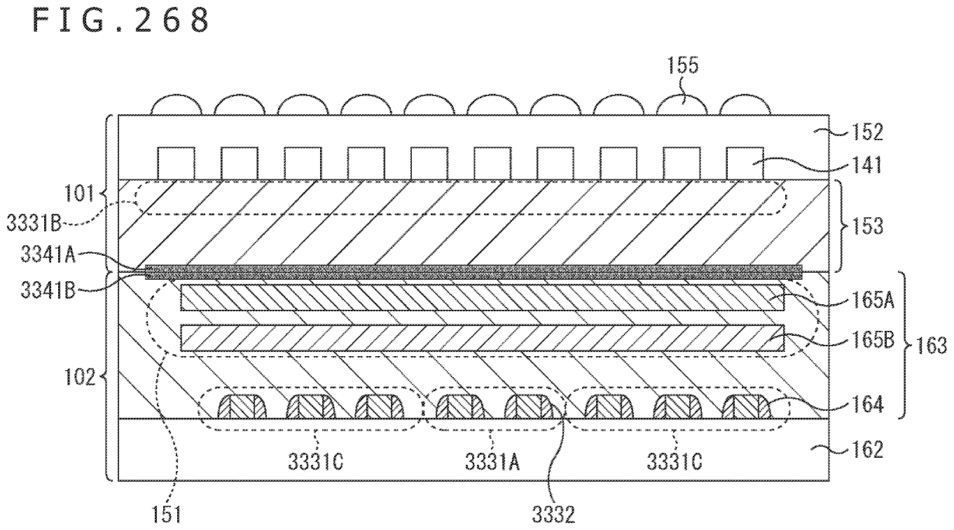

FIG. 268 depicts a more detailed cross-sectional view of the modification example of the second stacked structure example depicted in FIG. 266.

That is, FIG. 268 is a detailed cross-sectional view of the solid-state image pickup apparatus 100 having the joined electromagnetic-wave attenuating unit 3341A and electromagnetic-wave attenuating unit 3341B.

The third transistor group 3331C formed in the multi-layer wiring layer 163 of the semiconductor base 162 includes MOS transistors 164, and the first transistor group 3331A includes MOS transistors 3332.

In the multi-layer wiring layer 163, the two wiring layers 165A and 165B are arranged as part of multiple wiring layers forming the multi-layer wiring layer 163. The wiring layer 165A and the wiring layer 165B are arranged between the joined electromagnetic-wave attenuating unit 3341A and electromagnetic-wave attenuating unit 3341B, and the first transistor group 3331A and the third transistor group 3331C.

The two wiring layers 165A and 165B can include planar conductors or mesh conductors as mentioned above, and, in this case, the wiring layers 165A and 165B also can function as electromagnetic-wave attenuating units 3341. In a case in which the conductors are planar conductors, mesh conductors, conductor coils (including conductor loops without multiple turns), or conductor wires, electromagnetic waves can be attenuated. Accordingly, the conductors function as electromagnetic-wave attenuating units 3341. Note that, regarding the conductor coils, the inner regions of the coils also can be regarded as part of electromagnetic-wave attenuating units 3341.

The electromagnetic-wave attenuating unit 3341A and the electromagnetic-wave attenuating unit 3341B may each be a planar conductor or a mesh conductor, or the electromagnetic-wave attenuating unit 3341A and the electromagnetic-wave attenuating unit 3341B may have structures which, by a combination of the two layers, form a planar conductor or a mesh conductor. For example, each of the electromagnetic-wave attenuating unit 3341A and the electromagnetic-wave attenuating unit 3341B may include linear conductors that are regularly arranged in one direction, and the two types of linear conductor may be electrically joined at at least part of overlapping regions to form a planar conductor. In a case in which the power supply of the two types of linear conductor as the electromagnetic-wave attenuating unit 3341A and the electromagnetic-wave attenuating unit 3341B and GND are not distinguished from each other (have the same polarity), they form a light-blocking structure, and so can be regarded as a planar conductor by electrically joining at least part of the overlapping regions. Similarly, a mesh conductor may be formed by providing linear conductors that are regularly arranged in one direction in one conductor layer (e.g., the electromagnetic-wave attenuating unit 3341A), providing linear conductors that are regularly arranged in a direction orthogonal to the one direction in the remaining one conductor layer (e.g., the electromagnetic-wave attenuating unit 3341B), and electrically joining at least part of overlapping regions of the two conductor layers. It should be noted however that the linear conductors may be rectangular conductors. In other words, at least partially overlapping conductors may be included in the two conductor layers (the electromagnetic-wave attenuating unit 3341A and the electromagnetic-wave attenuating unit 3341B), and at least part of overlapping regions of the conductor layers may be electrically joined. The electromagnetic-wave attenuating unit 3341A and the electromagnetic-wave attenuating unit 3341B can be electrically connected with each other via conductor vias, junctions between the same type of metal such as Cu—Cu junctions, Au—Au junctions, or Al—Al junctions, or junctions between different types of metal such as Cu—Au junctions, Cu—Al junctions, or Au—Al junctions, for example. In addition to measures against inductive noise and capacitive noise, a to-be-protected region can be protected, and joints can be reinforced.

It is considered that a configuration in this manner in which four conductor layers with relatively low sheet resistances (in which currents flow more easily), that is, the electromagnetic-wave attenuating unit 3341A, the electromagnetic-wave attenuating unit 3341B, the wiring layer 165A, and the wiring layer 165B are used as electromagnetic-wave attenuating units 3341 is suitable for attenuating electromagnetic waves and reducing the security threat.

For the purpose of reducing the security threat by attenuating electromagnetic waves, it is desirable if, as electromagnetic-wave attenuating units 3341, the wiring layer 165A and the wiring layer 165B including planar conductors or mesh conductors, the conductive shields 1151 depicted in FIG. 114 to FIG. 119, and the like are provided in a region which is at least part of the region located between the semiconductor base 152 and the first transistor group 3331A and overlapping the first transistor group 3331A (and suitably is larger than the overlapping region). It is desirable in terms of implementation efficiency if the wiring layer 165A and the wiring layer 165B form a light-blocking structure 151. Electromagnetic-wave attenuating units 3341 may be formed in one conductor layer or may be formed in multiple conductor layers including two or more layers. In addition, multiple planar or mesh conductors including two or more conductors may be arranged in the thickness direction and form electromagnetic-wave attenuating units 3341. There may not be pixels in the region overlapping the first transistor group 3331A. Furthermore, the first semiconductor board 101 may not be provided.

<Effects of Electromagnetic-Wave Attenuating Unit>

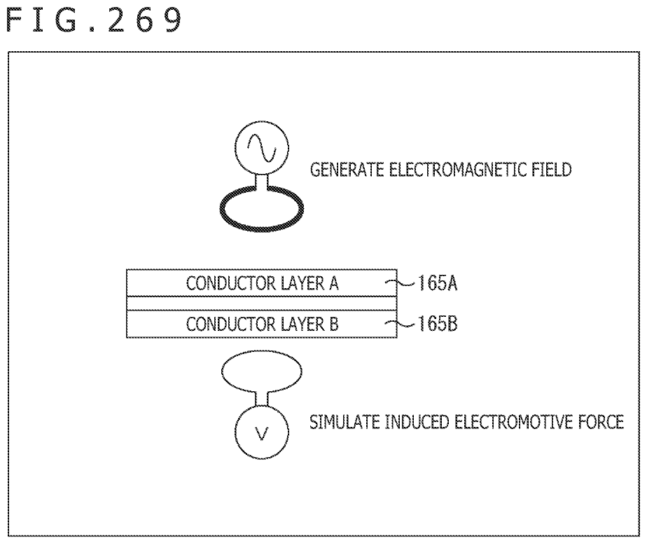

A simulation result with which effects of an electromagnetic-wave attenuating unit 334 have been confirmed is explained with reference to FIG. 269 to FIG. 273.

FIG. 269 is an image figure of simulation conditions under which a simulation was performed.

At one of positions that face each other and sandwich the stacked conductor layer A (wiring layer 165A) and conductor layer B (wiring layer 165B), an electromagnetic field is generated, and an induced electromotive force generated at the other one of the positions is measured (simulation measurement).

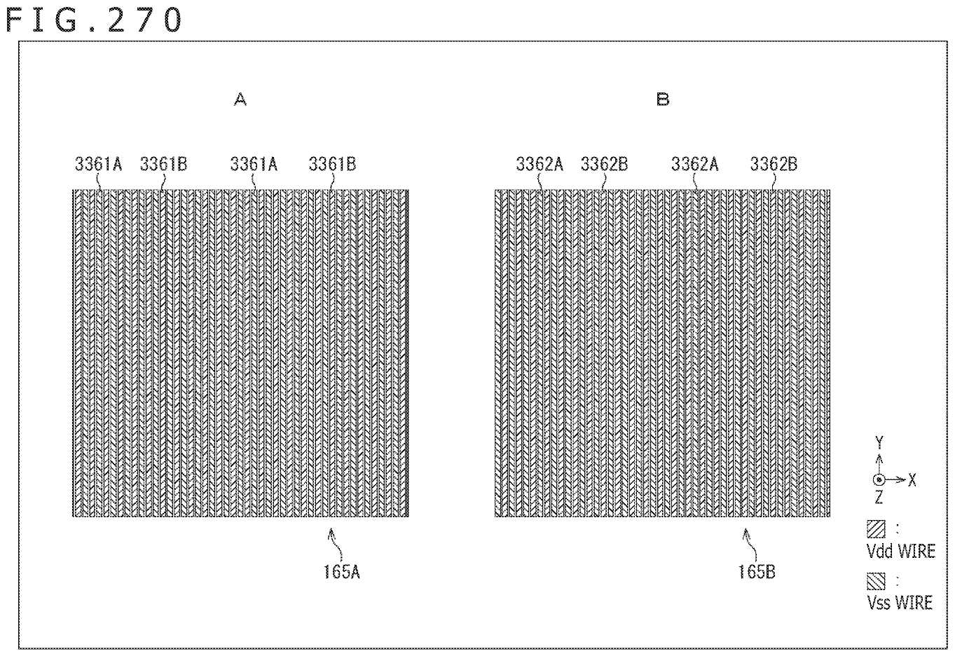

First, as a comparative example to be compared with the electromagnetic-wave attenuating unit 3341, the inventors used linear conductors like the ones depicted in FIG. 270 as the conductor layer A and the conductor layer B, and measured an induced electromotive force.

A in FIG. 270 depicts a plan view of the conductor layer A. In the conductor layer A, linear conductors 3361A that are long in the Y direction and linear conductors 3361B that are long in the Y direction are arranged regularly alternately in the X direction.

The linear conductors 3361a are wires (Vss wires) connected to GND or a negative power supply, for example. The linear conductors 3361B are wires (Vdd wires) connected to a positive power supply, for example. The linear conductors 3361A and the linear conductors 3361B are differential conductors in which currents flow in mutually opposite directions. Details of the linear conductors 3361A and the linear conductors 3361B are similar to those about the conductor layer C in FIG. 129, for example.

B in FIG. 270 depicts a plan view of the conductor layer B. In the conductor layer B, linear conductors 3362A that are long in the Y direction and linear conductors 3362B that are long in the Y direction are arranged regularly alternately in the X direction.

The linear conductors 3362A are wires (Vss wires) connected to GND or a negative power supply, for example. The linear conductors 3362B are wires (Vdd wires) connected to a positive power supply, for example. The linear conductors 3362A and the linear conductors 3362B are differential conductors in which currents flow in mutually opposite directions. Details of the linear conductors 3362A and the linear conductors 3362B are similar to those about the conductor layer C in FIG. 129, for example.

The conductor layers A and B are stacked such that they form a light-blocking structure.

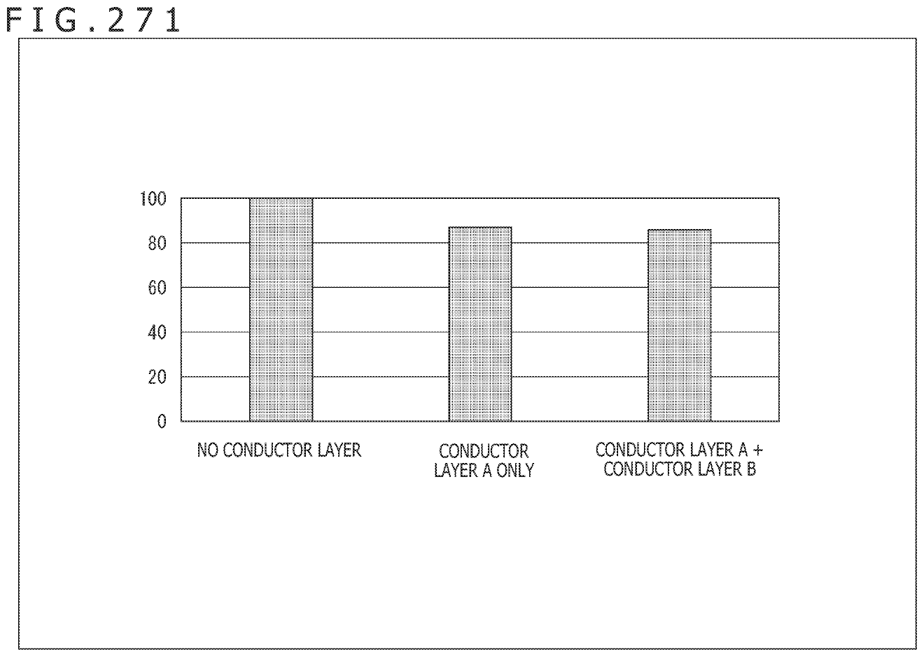

FIG. 271 depicts results of a simulation of induced electromotive forces using the conductor layers A and B depicted in FIG. 270.

FIG. 271 depicts (the ratios of) induced electromotive forces that are generated in a case in which only the conductor layer A is arranged, and in a case in which the conductor layers A and B are arranged, assuming that an induced electromotive force in a case in which the conductor layers A and B depicted in FIG. 270 are not arranged is 100%.

According to the simulation results in FIG. 271, induced electromotive forces lower only to approximately 80% in both the case in which only the conductor layer A is arranged and the case in which both of the conductor layers A and B are arranged, as compared with the case in which the conductor layers A and B are not arranged.

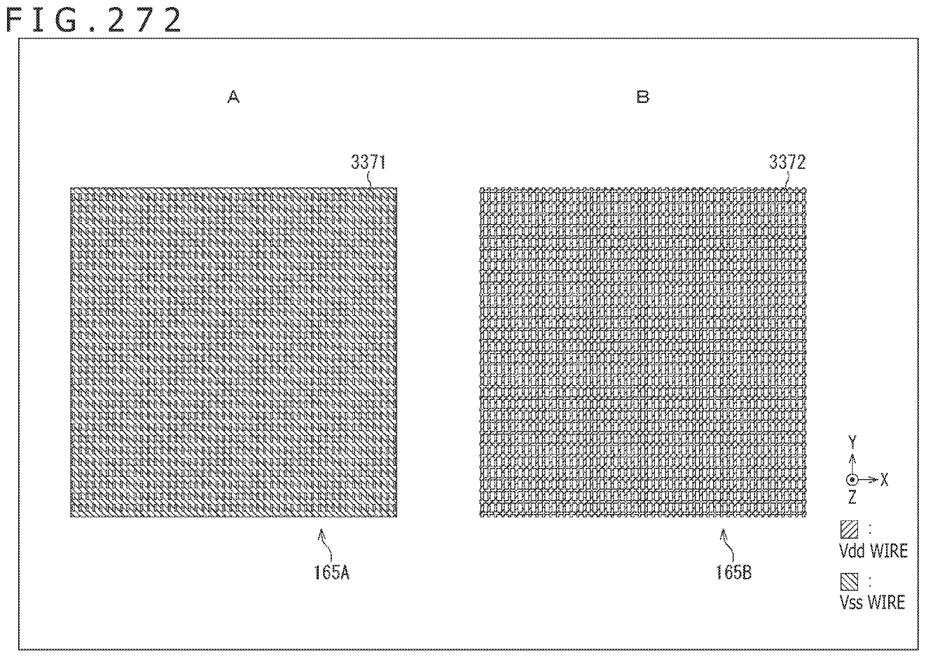

Next, the inventors used mesh conductors like the one depicted in FIG. 272 as the conductor layer A and the conductor layer B in which electromagnetic-wave attenuating units 3341 are formed, and measured induced electromotive forces. Note that conditions of voltages applied to generate electromagnetic fields are the same as those in the case of FIG. 270.

A in FIG. 272 depicts a plan view of the conductor layer A. The conductor layer A includes a mesh conductor 3371. The mesh conductor 3371 is a wire (Vss wire) connected to GND or a negative power supply, for example. Details of the mesh conductor 3371 are similar to those about the conductor layer A in FIG. 36, for example. In a case in which Vdd wires and Vss wires are not distinguished from each other, the X-direction conductor pitch of the mesh conductor 3371 is the same as the X-direction conductor pitch of the conductor layer A in A in FIG. 270.

B in FIG. 272 depicts a plan view of the conductor layer B. The conductor layer B includes a mesh conductor 3372. The mesh conductor 3372 is a wire (Vdd wires) connected to a positive power supply, for example. Details of the mesh conductor 3372 are similar to those about the conductor layer B in FIG. 36, for example. In a case in which Vdd wires and Vss wires are not distinguished from each other, the X-direction conductor pitch of the mesh conductor 3372 is the same as the X-direction conductor pitch of the conductor layer B in B in FIG. 270.

The conductor layers A and B are stacked such that they form a light-blocking structure.

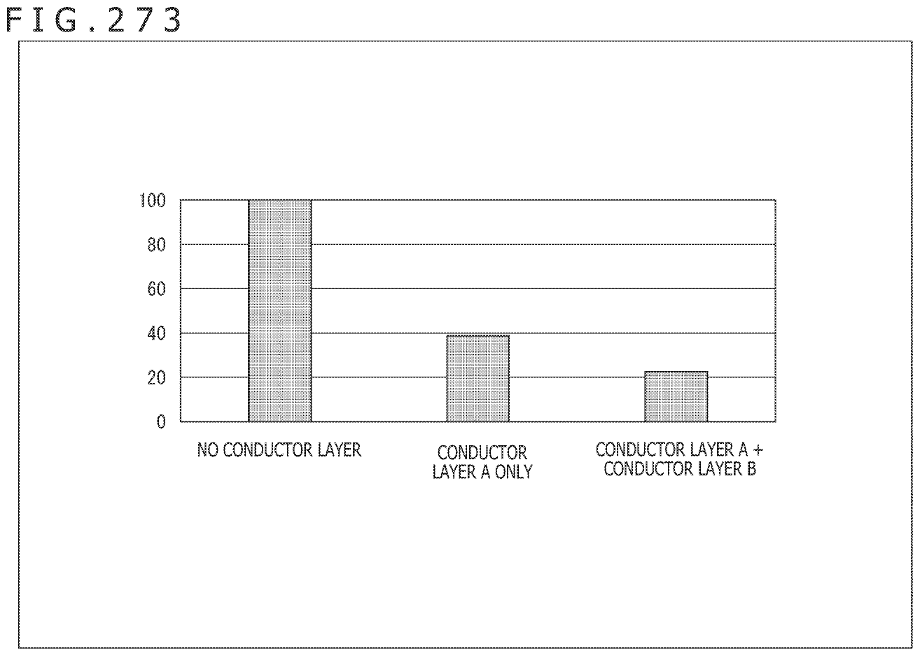

FIG. 273 depicts results of a simulation of induced electromotive forces using the conductor layers A and B depicted in FIG. 272.

FIG. 273 depicts (the ratios of) induced electromotive forces that are generated in the case in which only the conductor layer A is arranged, and in the case in which the conductor layers A and B are arranged, assuming that an induced electromotive force in the case in which the conductor layers A and B depicted in FIG. 272 are not arranged is 100%.

According to the simulation results in FIG. 273, the induced electromotive force lowers approximately to 40% in the case in which only the conductor layer A is arranged, and the induced electromotive force lowers approximately to 20% in the case in which both of the conductor layers A and B are arranged, as compared with the case in which the conductor layers A and B are not arranged. Accordingly, it can be known that the conductor layers A and B as electromagnetic-wave attenuating units 3341 provide significant electromagnetic-wave blocking effects as compared with the case of FIG. 270. This is due to the fact that, in a case in which the conductor layers A and B include mesh conductors, circular currents (eddy currents) are generated more easily to the conductor layers A and B.

By providing electromagnetic-wave attenuating units 3341 in a region which is at least part of the region overlapping the first transistor group 3331A as a to-be-protected circuit associated with to-be-protected information and suitably is larger than the overlapping region, in the solid-state image pickup apparatus 100 including the stacked first semiconductor board 101 and second semiconductor board 102 in the manner above, it is possible to more effectively take measures against malfunctions arising from electromagnetic waves.

<Positional Relation between Electromagnetic-Wave Attenuating Unit and To-Be-Protected Circuit>

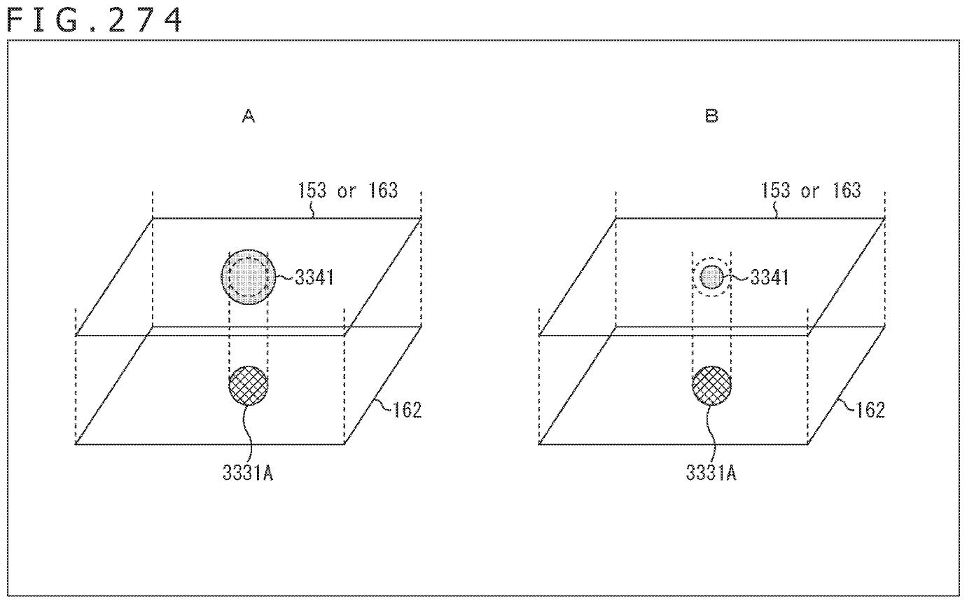

The positional relation between an electromagnetic-wave attenuating unit 3341, and the first transistor group 3331A as a to-be-protected circuit associated with to-be-protected information is explained with reference to FIG. 274 to FIG. 276.

While it is explained in the example mentioned above that it is sufficient if the region where an electromagnetic-wave attenuating unit 3341 is arranged is a region which is in the first semiconductor board 101, and is at least part of the region located between the semiconductor base 152 and the first transistor group 3331A and overlapping first transistor group 3331A, specifically, the positional relation can be realized in manners like the ones depicted in FIG. 274 to FIG. 276.

A in FIG. 274 depicts a conceptual diagram of a case in which a region where an electromagnetic-wave attenuating unit 3341 is arranged is as large as or larger than the region of the first transistor group 3331A, which is a to-be-protected circuit.

Note that in FIG. 274 to FIG. 276, an electromagnetic-wave attenuating unit(s) 3341 is/are arranged in one of the multi-layer wiring layer 153 or the multi-layer wiring layer 163 or both of them, and the first transistor group 3331A is arranged on the top surface of the semiconductor base 162.

B in FIG. 274 depicts a conceptual diagram of a case in which a region where an electromagnetic-wave attenuating unit 3341 is arranged is smaller than the region of the first transistor group 3331A, which is a to-be-protected circuit.

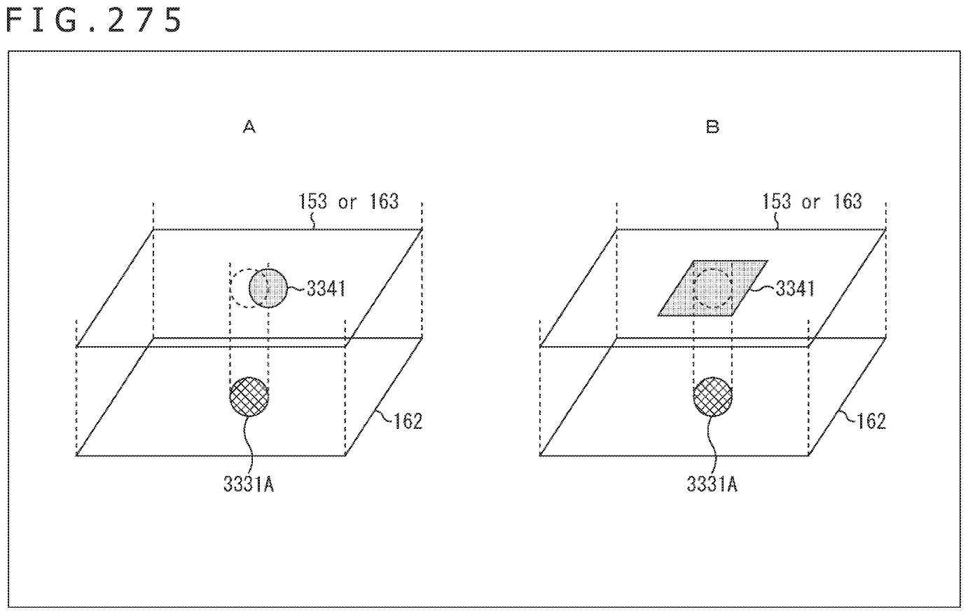

A in FIG. 275 depicts a conceptual diagram of a case in which the centroid of a region where an electromagnetic-wave attenuating unit 3341 is arranged and the centroid of the region of the first transistor group 3331A, which is a to-be-protected circuit, are not aligned. The sizes of a region where the electromagnetic-wave attenuating unit 3341 is arranged and the region of the first transistor group 3331A can be any sizes, and it is sufficient if the regions overlap at least partially.

While, in A in FIG. 274, B in FIG. 274, and A in FIG. 275, the regions of the electromagnetic-wave attenuating unit 3341 and the first transistor group 3331A are represented by circular shapes, the shapes of the regions can be any shapes and are not limited to circular shapes. For example, as depicted in B in FIG. 275, the region of the electromagnetic-wave attenuating unit 3341 may have an oblong rectangular shape. That is, B in FIG. 275 depicts a conceptual diagram of a case in which the shape of the region of the electromagnetic-wave attenuating unit 3341 and the shape of the region of the first transistor group 3331A are different.

The number of each of the region of the electromagnetic-wave attenuating unit 3341 and the region of the first transistor group 3331A is not limited one. In a case in which at least one of the electromagnetic-wave attenuating unit 3341 or the first transistor group 3331A is divided into multiple regions also, it is sufficient if the region(s) of the electromagnetic-wave attenuating unit 3341 and the region(s) of the first transistor group 3331A overlap at least partially.

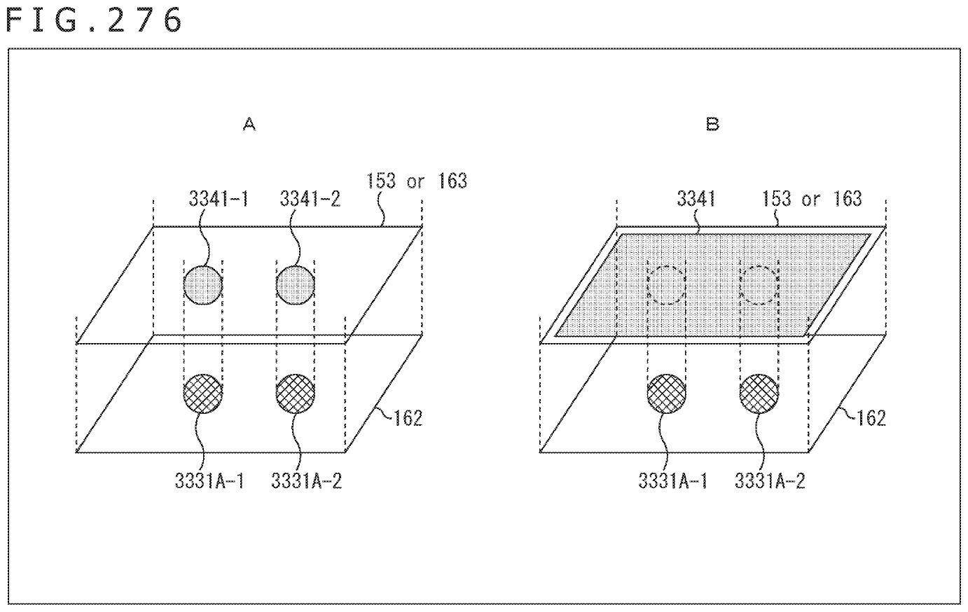

A in FIG. 276 depicts a conceptual diagram of a case in which each of the regions of the electromagnetic-wave attenuating unit 3341 and the first transistor group 3331A is arranged at two separate portions.

An electromagnetic-wave attenuating unit 3341-1 is arranged in the multi-layer wiring layer 153 or 163 such that it at least partially overlaps a first transistor group 3331A-1 formed on the top surface of the semiconductor base 162.

An electromagnetic-wave attenuating unit 3341-2 is arranged in the multi-layer wiring layer 153 or 163 such that it at least partially overlaps a first transistor group 3331A-2 formed on the top surface of the semiconductor base 162.

Note that the multiple regions of the electromagnetic-wave attenuating unit 3341 or the first transistor group 3331A that are arranged being divided can have any size relation. That is, it may be any of the following relations: (region area size of electromagnetic-wave attenuating unit 3341-1)>(region area size of electromagnetic-wave attenuating unit 3341-2); (region area size of electromagnetic-wave attenuating unit 3341-1)=(region area size of electromagnetic-wave attenuating unit 3341-2); and (region area size of electromagnetic-wave attenuating unit 3341-1)<(region area size of electromagnetic-wave attenuating unit 3341-2). Similarly, it may be any of the following relations: (first transistor group 3331A-1)>(first transistor group 3331A-2); (first transistor group 3331A-1)=(first transistor group 3331A-2); and (first transistor group 3331A-1)<(first transistor group 3331A-2).

B in FIG. 276 depicts a conceptual diagram of a case in which multiple regions of first transistor groups 3331A are arranged and the electromagnetic-wave attenuating unit 3341 is arranged such that it overlaps the regions of the multiple first transistor groups 3331A.

As compared with the case in which an electromagnetic-wave attenuating unit 3341 is arranged for each region of a first transistor group 3331A as in A in FIG. 276, it is desirable if an electromagnetic-wave attenuating unit 3341 is arranged such that the region of the electromagnetic-wave attenuating unit 3341 includes the regions of the multiple first transistor groups 3331A as in B in FIG. 276 because this can make it difficult to identify a to-be-protected region, but this is not essential.

While A and B in FIG. 276 depict examples in which the numbers of regions of electromagnetic-wave attenuating units 3341 and first transistor groups 3331A in a case in which an electromagnetic-wave attenuating unit 3341 and a first transistor group 3331A are arranged being divided into multiple regions are two, the numbers are not limited to two and may be three or larger.

<Probe Sensing Functionality>

An electromagnetic-wave attenuating unit 3341 can include a probe sensing functionality for sensing an attack probe.

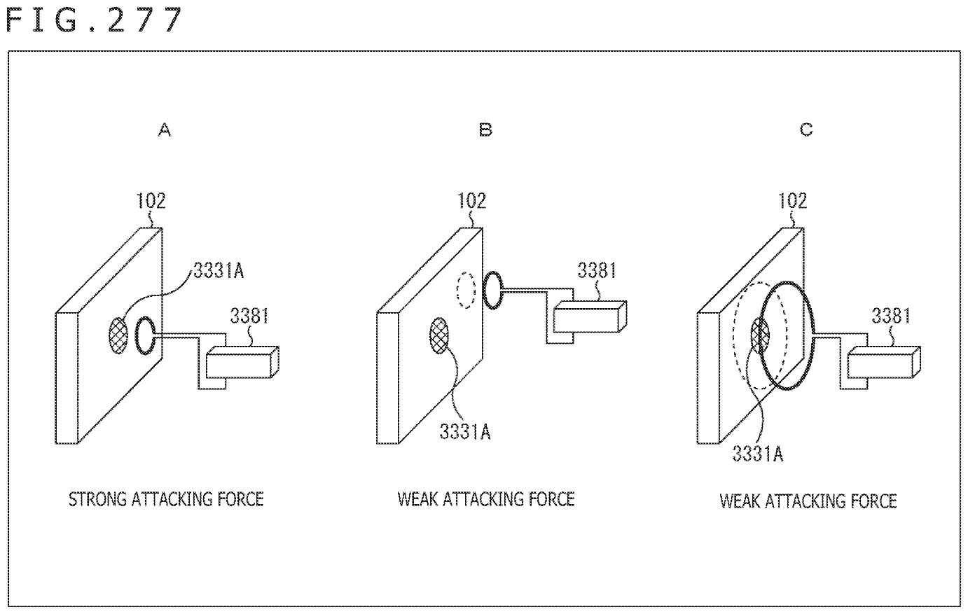

For example, it is supposed that, as depicted in FIG. 277, an attack is made by an attack probe 3381 on the first transistor group 3331A as a to-be-protected region formed in the second semiconductor board 102.

In a case in which there is the attack probe 3381 near the first transistor group 3331A, which is a to-be-protected region, as depicted in A in FIG. 277, the attacking force becomes strong, and so this state should be avoided most. On the other hand, in cases as depicted in B in FIG. 277 that the position of the attack probe 3381 is away from the region of the first transistor group 3331A, which is a to-be-protected region, and that the region of an occurrence of an electromagnetic field is not matching the to-be-protected region, the attacking force becomes weak, and so the influence of electromagnetic waves is small.

Accordingly, in a case in which the electromagnetic-wave attenuating unit 3341 includes a sensing unit that senses an attack probe, it is sufficient if the sensing unit can sense that there is the attack probe 3381 near the to-be-protected region.

In view of this, for example, it is assumed, as explained with reference to FIG. 264, that the electromagnetic-wave attenuating unit 3341 includes some of signal lines 132 that transfer pixel signals of pixels 131 in the pixel array 121 of the first semiconductor board 101, and control lines 133 that transfer control signals from the vertical scanning unit 123, for example.

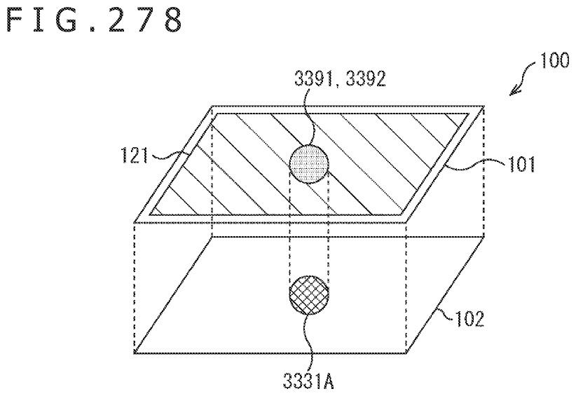

That is, as depicted in FIG. 278, at least a signal line 132 and a control line 133 of each pixel 131 in a region in the pixel array 121 of the first semiconductor board 101 corresponding to the region of the first transistor group 3331A as a to-be-protected region formed in the second semiconductor board 102 correspond to the electromagnetic-wave attenuating unit 3341. If the region in the pixel array 121 corresponding to the region of the first transistor group 3331A as the to-be-protected region is referred to as a sensing region 3391, (a photodiode 141, a transfer transistor 142 to a select transistor 145, or the like of) each pixel 131 included in the sensing region 3391 corresponds to a sensing unit (sensing circuit) 3392.

The positional relation between the region of the first transistor group 3331A as the to-be-protected region and the sensing region 3391 is similar to the positional relation between the region of the first transistor group 3331A as the to-be-protected region and the electromagnetic-wave attenuating unit 3341 explained with reference to FIG. 274 to FIG. 276. That is, there may be differences between the region sizes, and the centroids may not be aligned. In addition, there may be multiple to-be-protected regions and sensing regions 3391. It is sufficient if the regions of a sensing region 3391 and a first transistor group 3331A overlap at least partially. The sensing region 3391 may be a region according to the shape of the attack probe 3381 that is supposed to make an attack.

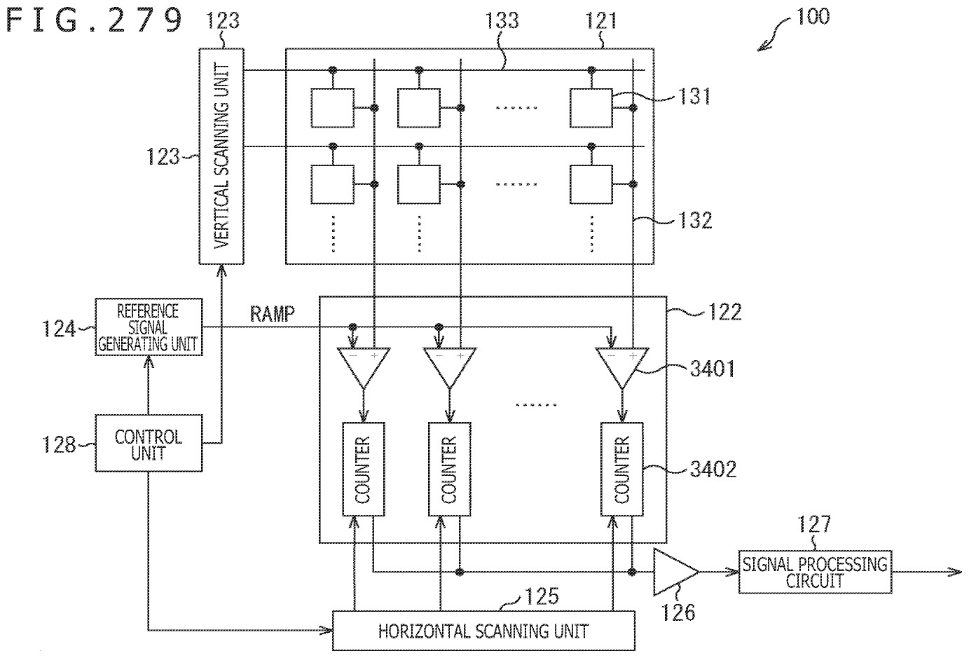

FIG. 279 is a block diagram depicting a main circuit configuration of the solid-state image pickup apparatus 100.

The solid-state image pickup apparatus 100 has the pixel array 121, the A/D converting unit 122, the vertical scanning unit 123, a reference signal generating unit 124, a horizontal scanning unit 125, an output buffer 126, a signal processing circuit 127, a control unit 128, and the like.

FIG. 279 depicts a configuration including the reference signal generating unit 124, the horizontal scanning unit 125, the output buffer 126, the signal processing circuit 127, and the control unit 128 in addition to the pixel array 121, the A/D converting unit 122, and the vertical scanning unit 123 depicted in FIG. 3, and so explanations of the sections having counterparts in FIG. 3 are omitted.

The A/D converting unit 122 has a comparator 3401 and an up/down counter 3402 for each pixel column in the pixel array 121. The comparator 3401 compares an analog pixel signal output from a pixel 131 in the column, and a ramp signal RAMP from the reference signal generating unit 124, and outputs a comparison result signal which is a result of the comparison to the up/down counter 3402. By counting comparison time on the basis of comparison result signals from the comparator 3401, the up/down counter 3402 converts analog pixel signals into digital pixel signals.

The reference signal generating unit 124 generates a ramp signal RAMP whose level (voltage) changes stepwise according to the lapse of time, and supplies the ramp signal RAMP to each comparator 3401 of the A/D converting unit 122.

The horizontal scanning unit 125 includes a shift register, an address decoder, and the like, and outputs, to the output buffer 126 and in a predetermined order, pixel data (pixel signals after AD conversion) temporarily retained in each up/down counter 3402 of the A/D converting unit 122.

The output buffer 126 performs only buffering in some cases, for example, and performs black level adjustment, column variation correction, various types of digital signal processing, and the like in some cases.

The signal processing circuit 127 performs predetermined signal processing by using pixel data supplied from the output buffer 126. In the present embodiment, for example, the signal processing circuit 127 performs a probe-deciding process of deciding whether or not there is an attack probe 3381 on the basis of pixel signals of pixels 131 as the sensing unit 3392 included in the sensing region 3391. For example, the probe-deciding process can be executed as part of an authentication process which is set as a process that needs to be executed when a process associated with to-be-protected information is performed.

From the outside of the apparatus, the control unit 128 receives an input clock, and data as commands about an operation mode and the like, and controls the operation of the entire solid-state image pickup apparatus 100. For example, the control unit 128 generates a vertical synchronization signal and a horizontal synchronization signal on the basis of an input master clock. The vertical synchronization signal is supplied to the vertical scanning unit 123, and the horizontal synchronization signal is supplied to the horizontal scanning unit 125. In addition, for example, the control unit 128 supplies the vertical scanning unit 123, the signal processing circuit 127, and the like with various types of control signal according to an operation mode.

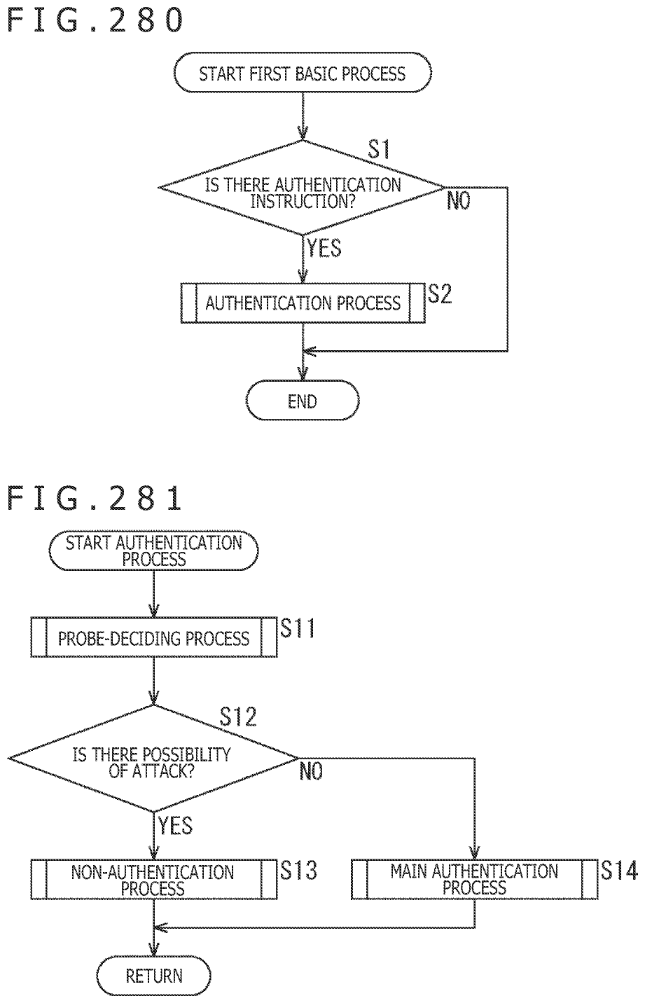

FIG. 280 is a flowchart of a first basic process of performing an authentication process including a probe-deciding process.

In the first basic process, first, at Step S1, the control unit 128 decides whether or not there is an authentication instruction. The authentication instruction is supplied from the outside of the apparatus, for example. In a case in which it is decided at Step S1 that there is not an authentication instruction, the process of Step S2 is skipped, and the first basic process is ended.

On the other hand, in a case in which it is decided at Step S1 that there is an authentication instruction, the process proceeds to Step S2, and the control unit 128 controls each section of the solid-state image pickup apparatus 100 to execute the authentication process.

FIG. 281 is a flowchart depicting details of the authentication process executed at Step S2 in FIG. 280.

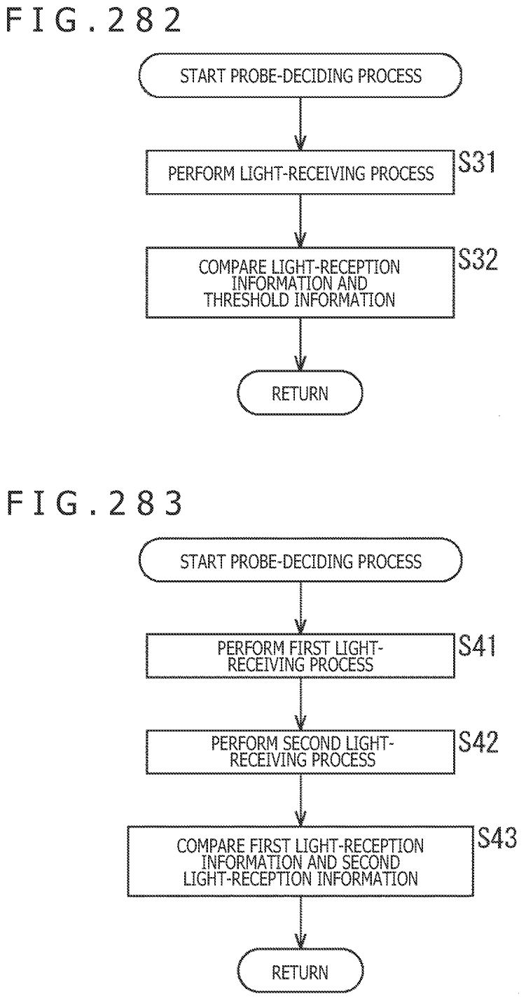

In the authentication process, at Step S11, the control unit 128 executes a probe-deciding process. As the probe-deciding process, a probe-deciding process in FIG. 282 mentioned below or a probe-deciding process in FIG. 283 mentioned below can be adopted. As a result of the probe-deciding process, it is decided whether or not there is an attack probe 3381 near a to-be-protected region. After Step S11, the process proceeds to Step S12.

At Step S12, the control unit 128 decides whether or not there is a possibility of an attack. In a case in which a result of the probe-deciding process is that there is an attack probe, the control unit 128 decides that there is a possibility of an attack. In a case in which a result of the probe-deciding process is that there is not an attack probe, the control unit 128 decides that there is not a possibility of an attack.

In a case in which it is decided at Step S12 that there is a possibility of an attack, the process proceeds to Step S13, and the control unit 128 executes a non-authentication process, and ends the authentication process. With the end of the authentication process, the first basic process ends.

Examples of the “non-authentication process” includes various processes such as re-execution from the first process, skipping or forced termination of subsequent processes, execution of dummy processes that resemble subsequent processes, noticing a user of electronic equipment on which the solid-state image pickup apparatus 100 is mounted, forced termination or forced locking of a semiconductor apparatus or electronic equipment itself on which the solid-state image pickup apparatus 100 is mounted, transmission of a notice to the outside of the semiconductor apparatus or the electronic equipment about the situation of the damage, a warning notice to an attacker, or a counterattack by vibration.

On the other hand, in a case in which it is decided at Step S12 that there is not a possibility of an attack, the process proceeds to Step S14, and the control unit 128 executes a main authentication process and ends the authentication process. With the end of the authentication process, the first basic process ends.

Note that the “authentication process” can include a process related to encryption. For example, processes that can be performed as the authentication process include processes that are associated with any of terms such as “individual authentication,” “biometric authentication,” “personal authentication,” “electronic signature,” “digital signature,” “RSA (mentioned before),” “DSA: Digital Signature Algorithm,” “ECDSA: Elliptic Curve Digital Signature Algorithm,” “PUF: Physically Unclonable Function,” “MAC: Message Authentication Code,” “HMAC: Hash-based Message Authentication Code,” “hash function,” “signature generation,” “signature verification,” “signature reception,” “signature passage,” “key generation,” “key exchange,” “public key,” “verification key,” “private key,” “signature key,” “random number generation,” “manipulation detection,” “encryption,” “decoding,” “secure communication” or “security,” and processes that use a combination of these terms.

FIG. 282 is a flowchart depicting a first process (first probe-deciding process) that can be executed as the probe-deciding process in Step S11 in FIG. 281.

First, at Step S31, the control unit 128 causes a light-receiving process of the sensing region 3391 corresponding to a to-be-protected region to be performed. It is sufficient if the sensing region 3391 corresponding to the to-be-protected region at least partially overlaps the to-be-protected region. Each pixel 131 of the sensing region 3391 in the pixel array 121 as the sensing unit 3392 follows the control of the control unit 128 to perform the light-receiving process. A pixel signal of each pixel 131 as the sensing unit 3392 obtained by the light-receiving process is supplied to the signal processing circuit 127.

At Step S32, the signal processing circuit 127 compares light-reception information obtained by the light-receiving process, and threshold information. More specifically, the signal processing circuit 127 makes a comparison to find whether or not the pixel value of each pixel 131 in the sensing region 3391 is smaller than a threshold prestored inside as the threshold information. In a case in which the pixel value of the sensing region 3391 is smaller than the threshold, that is, in a case in which the space above the to-be-protected region is dark, the signal processing circuit 127 decides that there is an attack probe 3381 near the to-be-protected region. On the other hand, in a case in which the pixel value of each pixel 131 as the sensing unit 3392 is equal to or higher than the threshold, that is, in a case in which the space above the to-be-protected region is bright, the signal processing circuit 127 decides that there is not an attack probe 3381 near the to-be-protected region.

In the first probe-deciding process, in the manner above, it is possible to decide whether or not there is an attack probe 3381 near the to-be-protected region by comparing the light-reception information of the sensing region 3391 corresponding to the to-be-protected region, and the threshold information prestored inside.

FIG. 283 is a flowchart depicting a second process (second probe-deciding process) that can be executed as the probe-deciding process at Step S11 in FIG. 281.

First, at Step S41, the control unit 128 causes a first light-receiving process of the sensing region 3391 corresponding to a to-be-protected region to be performed. Each pixel 131 of the sensing region 3391 in the pixel array 121 as the sensing unit 3392 follows the control of the control unit 128 to perform the first light-receiving process. A pixel signal of each pixel 131 in the sensing region 3391 obtained by the first light-receiving process is supplied to the signal processing circuit 127.

At Step S42, the control unit 128 causes the second light-receiving process of the sensing region 3391 corresponding to the to-be-protected region to be performed. Each pixel 131 of the sensing region 3391 in the pixel array 121 as the sensing unit 3392 follows the control of the control unit 128 to perform the second light-receiving process. A pixel signal of each pixel 131 in the sensing region 3391 obtained by the second light-receiving process is supplied to the signal processing circuit 127. Although the first light-receiving process and the second light-receiving process are light-receiving processes whose target regions are the same sensing region 3391, the light-reception timings are different.

At Step S43, the signal processing circuit 127 compares first light-reception information obtained by the first light-receiving process and second light-reception information obtained by the second light-receiving process. More specifically, the signal processing circuit 127 makes a comparison to find whether or not the pixel value in the second light-receiving process is lower than the pixel value in the first light-receiving process, and whether or not the difference therebetween is equal to or larger than a predetermined value. In a case in which the pixel value in the second light-receiving process is lower than the pixel value in the first light-receiving process and the difference therebetween is equal to or larger than the predetermined value, that is, in a case in which the space above the to-be-protected region has turned dark, the signal processing circuit 127 decides that there is an attack probe 3381 near the to-be-protected region. On the other hand, in a case in which it is decided that the pixel value of each pixel 131 as the sensing unit 3392 stays within a predetermined value range and does not exhibit a change, the signal processing circuit 127 decides that there is not an attack probe 3381 near the to-be-protected region.

In the second probe-deciding process, in the manner above, it is possible to decide whether or not there is an attack probe 3381 near the to-be-protected region by a comparison between the first light-reception information and the second light-reception information that are obtained at different light-reception timings.

Note that while it is detected in the second probe-deciding process mentioned above that the space above the to-be-protected region has turned dark, it is possible to decide that there is an attack probe 3381 near the to-be-protected region also in a case in which, although the difference between the pixel value in the first light-receiving process and the pixel value in the second light-receiving process is not equal to or larger than the predetermined value, it is decided that the pixel value is lower than a threshold prestored inside, and the space above the to-be-protected region has remained dark continuously. In addition, it may be decided that there is an attack probe 3381 near the to-be-protected region in a case in which it is detected that the space above the to-be-protected region has turned dark and it is decided the space remains dark continuously thereafter.

In addition, while the light-reception timings are made different between the first light-receiving process and the second light-receiving process in the second probe-deciding process mentioned above, the light-reception timings may be made the same, and the target regions of the light-receiving processes may be made different. For example, each pixel 131 in the sensing region 3391 in the pixel array 121 as the sensing unit 3392 performs the first light-receiving process, and each pixel 131 in a region different from the sensing region 3391 in the pixel array 121 performs the second light-receiving process. The signal processing circuit 127 makes a comparison to find whether or not the pixel value in the first light-receiving process is lower than the pixel value in the second light-receiving process, and whether or not the difference therebetween is equal to or larger than a predetermined value. In a case in which the pixel value in the first light-receiving process is lower than the pixel value in the second light-receiving process, and the difference therebetween is equal to or larger than the predetermined value, that is, in a case in which the space above the to-be-protected region is darker than another region, the signal processing circuit 127 decides that there is an attack probe 3381 near the to-be-protected region. On the other hand, in a case in which the pixel value in the first light-receiving process and the pixel value in the second light-receiving process are within a predetermined value range, the signal processing circuit 127 decides that there is not an attack probe 3381 near the to-be-protected region.

In this manner, in the second probe-deciding process, it may be decided whether or not there is an attack probe 3381 near the to-be-protected region by a comparison between the first light-reception information and the second light-reception information that are obtained at different light reception regions.

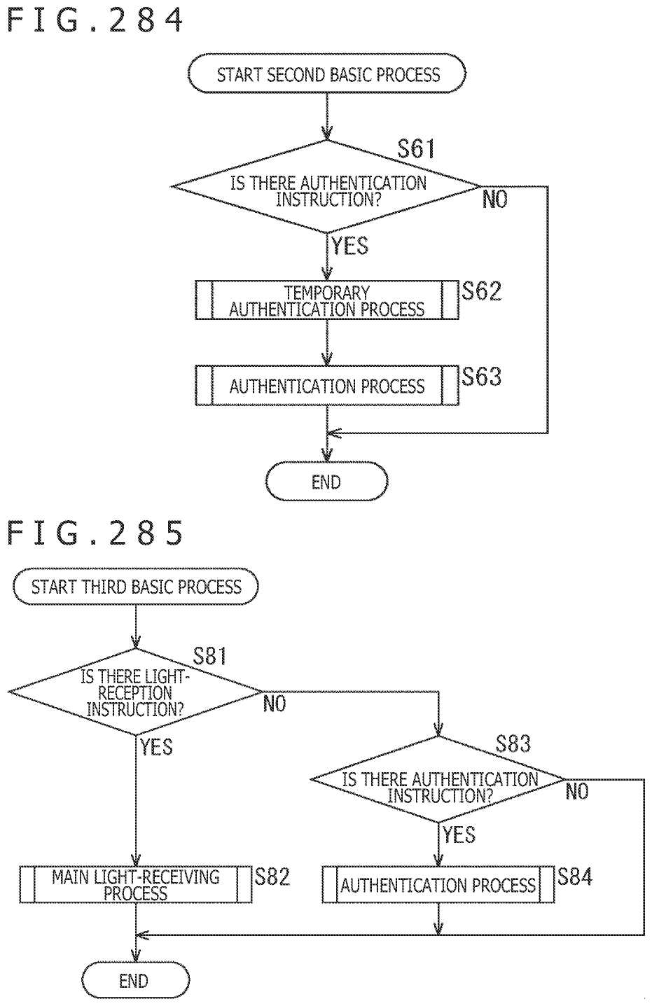

FIG. 284 is a flowchart of a second basic process of performing an authentication process including a probe-deciding process.

In the second basic process, first, at Step S61, the control unit 128 decides whether or not there is an authentication instruction. The authentication instruction is supplied from the outside of the apparatus, for example.

In a case in which it is decided at Step S61 that there is an authentication instruction, the process proceeds to Step S62, and the control unit 128 controls each section of the solid-state image pickup apparatus 100 to execute a temporary authentication process. The temporary authentication process is an authentication process to be executed in a simplified manner before the authentication process.

Then, after Step S62, at Step S63, the control unit 128 executes the authentication process explained in FIG. 281.

On the other hand, in a case in which it is decided at Step S61 that there is not an authentication instruction, the processes of Steps S62 and S63 are skipped, and the second basic process is ended.

FIG. 285 is a flowchart of a third basic process of performing an authentication process including a probe-deciding process.

In the third basic process, first, at Step S81, the control unit 128 decides whether or not there is a light-reception instruction.

In a case in which it is decided at Step S81 there is a light-reception instruction, the process proceeds to Step S82, and the control unit 128 causes the pixel array 121 to execute a main light-receiving process which is a light-receiving process for generating a captured image. When the main light-receiving process ends, the third basic process ends.

On the other hand, in a case it is decided at Step S81 that there is not a light-reception instruction, the process proceeds to Step S83, and the control unit 128 decides whether or not there is an authentication instruction. In a case in which it is decided at Step S83 that there is not an authentication instruction, the process of Step S84 is skipped, and the third basic process is ended.

On the other hand, in a case in which it is decided at Step S83 that there is an authentication instruction, the process proceeds to Step S84, and the control unit 128 executes the authentication process explained in FIG. 281. After the end of the authentication process, the third basic process ends. It should be noted however that the positions where the processes of Step S83 and Step S84 are inserted may be at least any of the position before Step S81, the position between YES at Step S81 and Step S82, or the position after Step S82.

The solid-state image pickup apparatus 100 can sense an attack probe by executing any of the first to third basic processes above.

Note that while, in the first to third basic processes mentioned above, it is decided whether or not there is an authentication instruction, and in a case in which there is an authentication instruction, the authentication process in FIG. 281 is performed, the decision about whether or not there is an authentication instruction may be omitted, and the authentication process may be performed regularly.

In addition, while pixel data input from the output buffer 126 to the signal processing circuit 127 is used as the light-reception information in the probe-deciding processes in FIG. 282 and FIG. 283, signals obtained at an intermediate step other than that, for example, analog pixel signals that are transferred through signal lines 132, output signals of comparators 3401, output signals of up/down counters 3402, or the like may be used. The light-reception information may be information associated with at least any of distance measurement, depth, and ToF, or information associated with at least any of pixels 131, signal lines 132, and control lines 133.

In addition, incident light received by each pixel 131 in the pixel array 121 can be light with any wavelength such as visible rays, RGB (Red/Green/Blue), infrared rays (near infrared rays, far infrared rays), ultraviolet rays, X-rays, or gamma rays. Acquisition of the light-reception information of the entire pixel region in the pixel array 121 (reception of entire light) is not essential.

<Electromagnetic-Wave Sensing Functionality>

An electromagnetic-wave attenuating unit 3341 can include an electromagnetic-wave sensing functionality for sensing (measuring) electromagnetic waves.

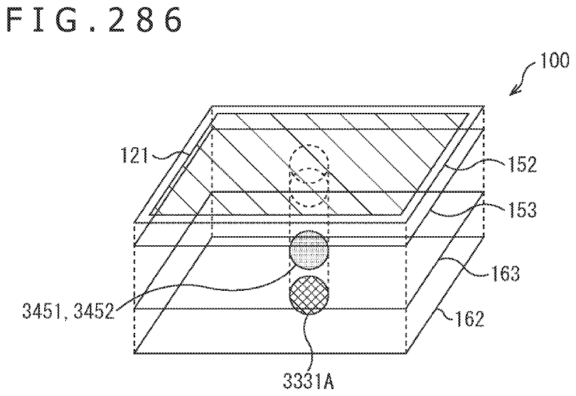

FIG. 286 is a schematic diagram of the solid-state image pickup apparatus 100 in a case in which the electromagnetic-wave attenuating unit 3341 includes the electromagnetic-wave sensing functionality.

For the first transistor group 3331A as a to-be-protected region formed on the top surface of the second semiconductor board 102, a sensing unit (sensing circuit) 3451 that senses electromagnetic waves by detecting changes of an electrical parameter that are caused by the presence or absence of an attack probe 3381 is arranged in the multi-layer wiring layer 163.

The sensing unit 3451 determines whether or not there is a probe on the basis of the value of an electrical parameter, a change amount of an electrical parameter, or the value of an electrical parameter that changes according to an electrical parameter or a change amount thereof. Specifically, for example, a conductor coil, a conductor loop, an electrode, an electrode pair, a temperature detecting unit, a magnetostatic detecting unit, an electrostatic detecting unit, or a light detecting unit can be the sensing unit 3451. The sensing unit 3451 can determine whether or not there is a probe on the basis of voltage values, current values, electric power values, frequencies, cycles, phases, amplitudes, waveform heights, waveform time widths, waveform time inclinations, L values (inductance), C values (capacitance), R values (resistance), Z values (impedance), Q values (Quality factor), K values (coefficients of connection), M values (mutual inductance), temperatures, heat amounts, magnetic field strengths, magnetic charge strengths, magnetic flux densities, magnetic fluxes, induced electromotive forces, electrical field strengths, electric charge densities, electric flux densities, electric fluxes, charge accumulation amounts, light amounts, luminous fluxes, luminous radiance, luminous energy, luminous intensity, luminance, illuminance, luminosity factor, luminous efficacy, energy losses, wavelengths, or electrical parameters that change according to any of these. In other words, it is sufficient if the sensing unit 3451 determines whether or not there is a probe on the basis of information associated with electromagnetic waves.

The region where the sensing unit 3451 is arranged is also a sensing region 3452 where electromagnetic waves are sensed. Part of the sensing unit 3451 may be formed in a region other than the sensing region 3452 such as the region of a transistor included in the third transistor group 3331C, for example. The positional relation between the region of the first transistor group 3331A as the to-be-protected region and the sensing region 3452 is similar to the positional relation between the region of the first transistor group 3331A and the electromagnetic-wave attenuating unit 3341 explained with reference to FIG. 274 to FIG. 276. Accordingly, it is sufficient if the sensing region 3452 at least partially overlaps the region of the first transistor group 3331A.

The sensing region 3452 can be set in at least one of the multi-layer wiring layer 153 or the multi-layer wiring layer 163, and FIG. 286 depicts an example in which the sensing region 3452 is set in the multi-layer wiring layer 163 which is on the side of the second semiconductor board 102.

The electromagnetic sensing process by the sensing unit 3451 can be performed similarly to the first to third basic processes explained with reference to FIG. 280 to FIG. 285. In the electromagnetic sensing process by the sensing unit 3451, the probe-deciding processes in FIG. 282 and FIG. 283 are executed with the “sensing process,” “the first sensing process,” and the “second sensing process” of measuring and sensing electromagnetic waves replacing the “light-receiving process,” the “first light-receiving process,” and the “second light-receiving process,” respectively. In the third basic process in FIG. 285, it is desirable for the purpose of reducing noise that is mixed in at the time when electromagnetic waves are measured that the execution timings of the main light-receiving process at Step S82 and the authentication process at Step S84 are different (do not overlap), but this is not essential. The execution timings of the main light-receiving process at Step S82 and the authentication process at Step S84 may partially overlap.

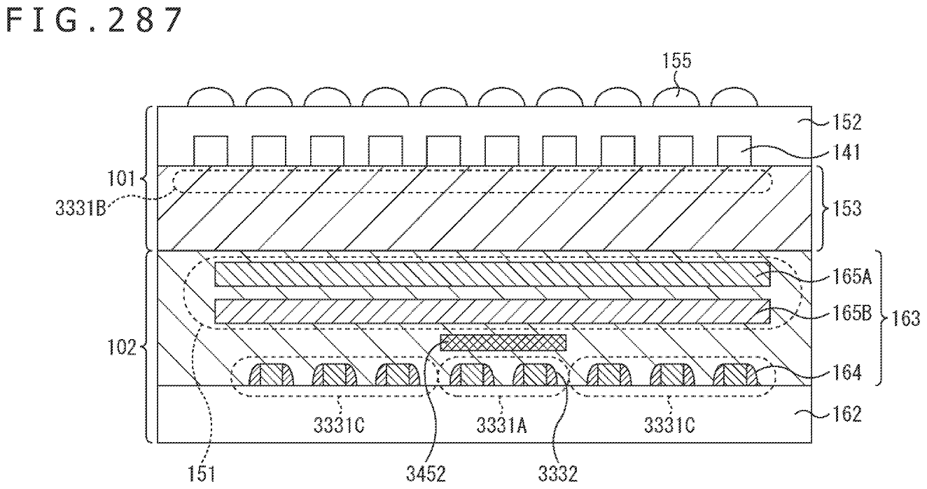

FIG. 287 is a detailed cross-sectional view of a case in which the sensing region 3452 is formed in the multi-layer wiring layer 163.

The sensing region 3452 is arranged in a region which is in the multi-layer wiring layer 163, and is at least part of the region located between the wiring layer 165B (conductor layer B) that functions also as the electromagnetic-wave attenuating unit 3341 and the first transistor group 3331A, and overlapping the first transistor group 3331A. The sensing region 3452 may be located between the wiring layer 165A and the wiring layer 165B. Furthermore, the sensing region 3452 may be in the wiring layer 165A or 165B. It should be noted however that if the wiring layer 165A or 165B includes a mesh conductor, and the sensing region 3452 is in the wiring layer 165A or 165B to hinder the regularity of the mesh conductor, the inductive noise worsens. Accordingly, it is desirable if the regularity of the mesh conductor is not hindered, but this is not essential.

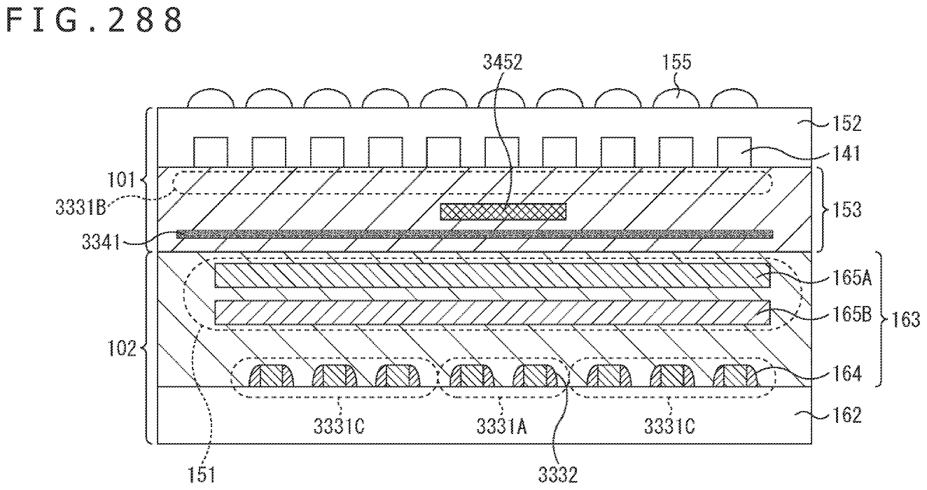

FIG. 288 is a detailed cross-sectional view of a case in which the sensing region 3452 is formed in the multi-layer wiring layer 153.

The sensing region 3452 is arranged in a region which is in the multi-layer wiring layer 153, and is at least part of the region located between the second transistor group 3331B and the first transistor group 3331A, and overlapping the first transistor group 3331A. The electromagnetic-wave attenuating unit 3341 also is arranged in the multi-layer wiring layer 153.

In both the case in which the sensing region 3452 is arranged in the multi-layer wiring layer 153 and the case in which the sensing region 3452 is arranged in the multi-layer wiring layer 163, the sensing region 3452 is set in a region that at least partially overlaps the region of the first transistor group 3331A and suitably is larger than the region of the first transistor group 3331A.

In a case in which the sensing region 3452 is arranged in the multi-layer wiring layer 163 as depicted in FIG. 287, it is possible to connect the sensing region 3452 with transistors in the third transistor group 3331C included in part of the sensing unit 3451 with a short distance, and so it becomes possible to make the frequency band sensed by the sensing unit 3451 higher (it becomes possible to expand the frequency band to a higher band). By making the frequency band of the sensing unit 3451 higher, it is possible to make it easier to sense attacks of higher frequencies.

On the other hand, in a case in which the sensing region 3452 is arranged in the multi-layer wiring layer 163, the sensitivity to attack probes themselves and to electromagnetic waves generated by attack probes becomes lower than in a case in which the sensing region 3452 is arranged in the multi-layer wiring layer 153. In addition, the wiring layer 165A and the wiring layer 165B, or the first transistor group 3331A which is a to-be-protected region become(s) a noise generation source in some cases. For these reasons, it is desirable in some cases to provide the sensing region 3452 on the outer side of the noise generation source in the stacking direction (between the noise generation source and the attack probe), that is, on the side of the first semiconductor board 101, as depicted in FIG. 288. In this case, it is possible to sense attacks more precisely than in a case in which the sensing region 3452 is arranged in the second semiconductor board 102.

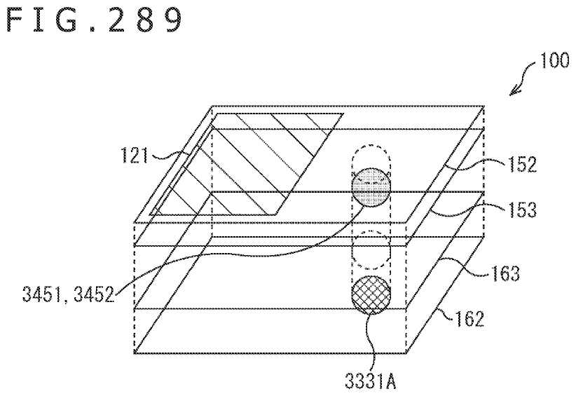

In a case in which the sensing region 3452 is arranged in the multi-layer wiring layer 153 on the side of the first semiconductor board 101, the sensing region 3452 of the sensing unit 3451 may be provided such that it is not superimposed on the pixel array 121 of the first semiconductor board 101 as depicted in FIG. 289.

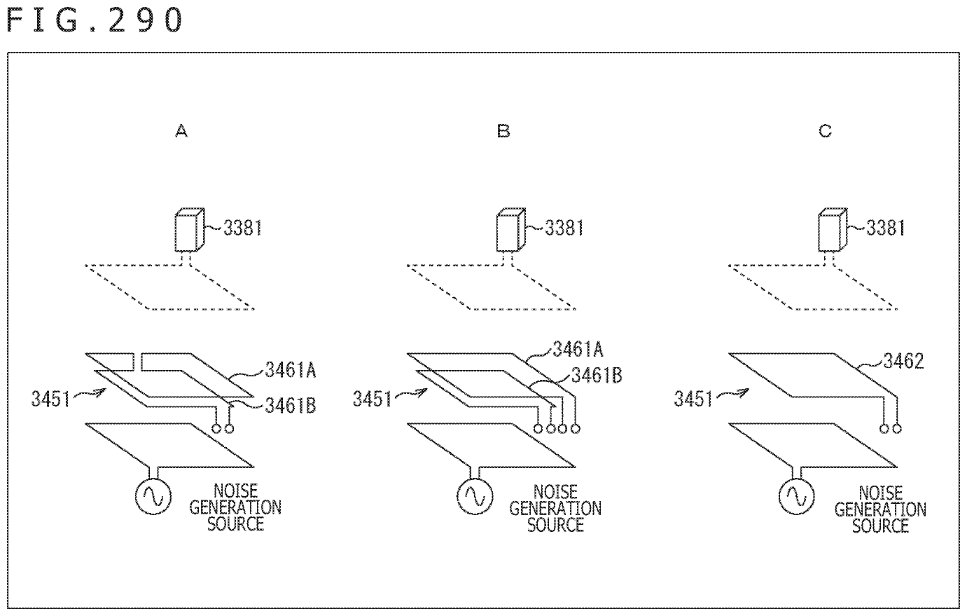

FIG. 290 depicts an example in which the sensing unit 3451 includes a coil.

In a case in which an attack probe 3381 includes at least any of a coil, metal, or a magnetic material, the sensing unit 3451 can include a coil. The sensing unit 3451 including the coil may observe a response of the coil by measuring the voltage at the ends of the coil, or may observe a response of the coil by connecting a signal source or an oscillation source to the coil, and performing measurement. At the time of the measurement, a frequency sweep may be performed.

A in FIG. 290 depicts an example in which the sensing unit 3451 includes an offset sensing coil.

The sensing unit 3451 in A in FIG. 290 has a configuration in which an outer coil 3461A (first conductor coil) and an inner coil 3461B (second conductor coil) having a difference in their coil diameters are connected. In this case, an induced electromotive force of the outer coil end, and an induced electromotive force of the inner coil end that are generated by a noise generation source have reverse polarities, and so electromagnetic waves from the noise generation source (electromagnetic wave noise) can be offset to observe a response to electromagnetic waves from an attack probe 3381. It is particularly desirable if the induced electromotive force of the outer coil end and the induced electromotive force of the inner coil end generated by the noise generation source have reverse polarities and are equal to each other (or substantially equal to each other). For example, it is sufficient if the outer coil 3461A is arranged in a conductor layer that is located on the outer side, in the stacking direction, of the inner coil 3461B relative to the noise generation source, and “(coil outer diameter of outer coil 3461A)>(coil outer diameter of inner coil 3461B),” “(coil outer diameter of outer coil 3461A)>(coil inner diameter of inner coil 3461B),” or “(coil inner diameter of outer coil 3461A)>(coil outer diameter of inner coil 3461B)” is satisfied. On the other hand, in another possible manner, “(number of coil turns of outer coil 3461A)>(number of coil turns of inner coil 3461B)” is satisfied, and “(coil outer diameter of outer coil 3461A)≤(coil outer diameter of inner coil 3461B)” or the like is satisfied.

B in FIG. 290 depicts an example in which the sensing unit 3451 includes double sensing coils.

The sensing unit 3451 in B in FIG. 290 has a configuration in which the outer coil 3461A and the inner coil 3461B having a difference in their coil diameters are separated. In this case, it is sufficient if the coils have a coil structure that makes it possible to determine that there is an attack probe 3381 in a case in which “(reaction of outer coil 3461A)>(reaction of inner coil 3461B)” is detected, one possible example of the relation between the diameters or numbers of turns of the outer coil 3461A and the inner coil 3461B is that of a structure similar to A in FIG. 290. Strictly speaking, it is desirable if “(reaction of outer coil 3461A)>((reaction of inner coil 3461B)+margin)” is satisfied, and in a case in which this relation is satisfied, a structure similar to A in FIG. 290 is not essential.

C in FIG. 290 depicts an example in which the sensing unit 3451 includes a single sensing coil.

The sensing unit 3451 in C in FIG. 290 includes a single coil 3462. In this case, measurement is implemented twice, and it can be determined that there is an attack probe 3381 in a case in which there is a large difference between measurement results of the first measurement and the second measurement. Measurement may be implemented multiple times, and a determination may be made by comparing measurement results of a first measurement group and a second measurement group.

Sensing methods that can be used in a case in which the sensing unit 3451 includes a coil includes the method disclosed in Japanese Patent No. 5976385 (Japanese Patent Laid-open No. 2013-236422), for example.

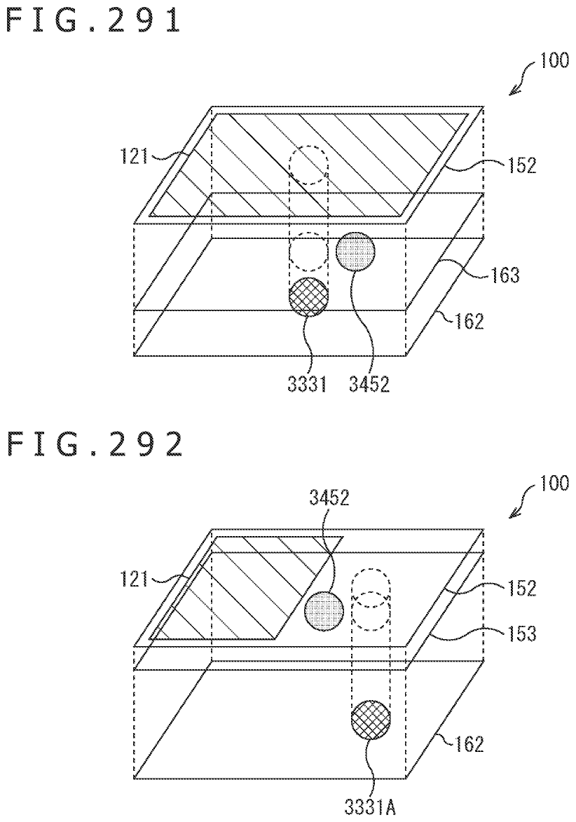

FIG. 291 and FIG. 292 depict configuration examples in which the sensing region 3452 is arranged not to overlap the region of the first transistor group 3331A which is a to-be-protected region.

FIG. 291 depicts a configuration example corresponding to the structure in FIG. 286 in which the sensing region 3452 is arranged in the multi-layer wiring layer 163, and in this configuration example, the sensing region 3452 is arranged not to overlap the region of the first transistor group 3331A which is a to-be-protected region. Note that an illustration of the multi-layer wiring layer 153 is omitted from FIG. 291.

FIG. 292 depicts a configuration examples corresponding to the structure in FIG. 289 in which the sensing region 3452 is arranged in the multi-layer wiring layer 153 such that it is not superimposed on the pixel array 121, and in this configuration example, the sensing region 3452 is arranged not to overlap the region of the first transistor group 3331A which is a to-be-protected region. Note that an illustration of the multi-layer wiring layer 163 is omitted from FIG. 292.

While it is explained that the sensing region 3452 at least partially overlaps the region of the first transistor group 3331A in the examples mentioned above, it is possible in some cases to sense attacks even with arrangements in which the sensing region 3452 does not overlap the region of the first transistor group 3331A as in FIG. 291 and FIG. 292 because enormous electromagnetic waves are generated when a to-be-protected region is attacked by an electromagnetic attack such as a magnetic field attack, an electrical field attack, or a laser attack. In addition, this provides an advantage because it is made more difficult to identify the implementation position of a to-be-protected region (the region of the first transistor group 3331A.

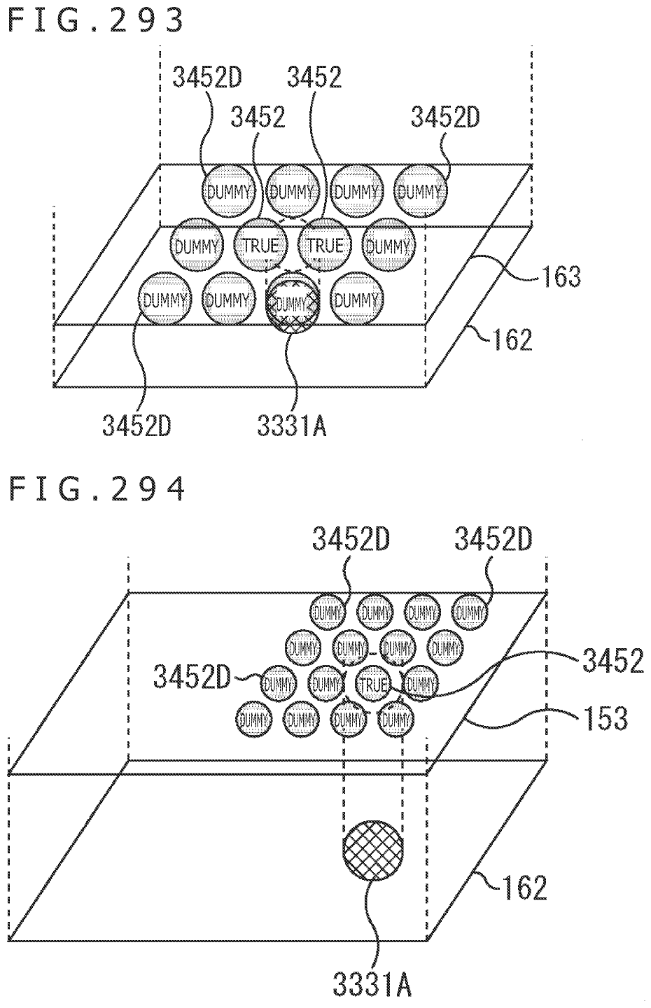

FIG. 293 and FIG. 294 depict examples in which dummy sensing regions are provided.

Because attackers are supposed not to know the implementation position of a to-be-protected region, one or more dummy sensing regions can be provided in order to make it difficult to identify the implementation position of the to-be-protected region.

FIG. 293 depicts an example corresponding to the structure in FIG. 286 in which the sensing region 3452 is arranged in the multi-layer wiring layer 163, and in this example, “dummy” sensing regions 3452D are provided in addition to “true” sensing regions 3452. In FIG. 293, ten “dummy” sensing regions 3452D are arranged around two “true” sensing regions 3452. Illustrations of the semiconductor base 152 and the multi-layer wiring layer 153 are omitted from FIG. 293, for convenience.

FIG. 294 depicts an example corresponding to the structure in FIG. 289 in which the sensing region 3452 is arranged in the multi-layer wiring layer 153 such that it is not superimposed on the pixel array 121, and in this example, “dummy” sensing regions 3452D are provided in addition to a “true” sensing region 3452. In FIG. 294, fifteen “dummy” sensing regions 3452D are arranged around one “true” sensing region 3452. Illustrations of the semiconductor base 152 and the multi-layer wiring layer 163 are omitted from FIG. 294, for convenience.

As in FIG. 293 and FIG. 294, the number of “true” sensing regions 3452 may be one or may be larger than one. In addition, the positions of “true” sensing regions 3452 may be arranged such that they do not overlap a to-be-protected region, as in FIG. 291 and FIG. 292. “True” sensing regions 3452 need not be implemented at positions that are relatively close to a to-be-protected region, for example, and may be implemented at relatively far positions. In addition, “dummy” sensing regions 3452D may not be provided and all the regions may be “true” sensing regions 3452.

Furthermore, in a case in which the sensing unit 3451 includes a coil as depicted in FIG. 290, the coil as the sensing unit 3451 can include a signal lines 132 that transfers a pixel signal of each pixel 131 in the pixel array 121 or a control line 133 that transfers a control signal from the vertical scanning unit 123, in one possible configuration.

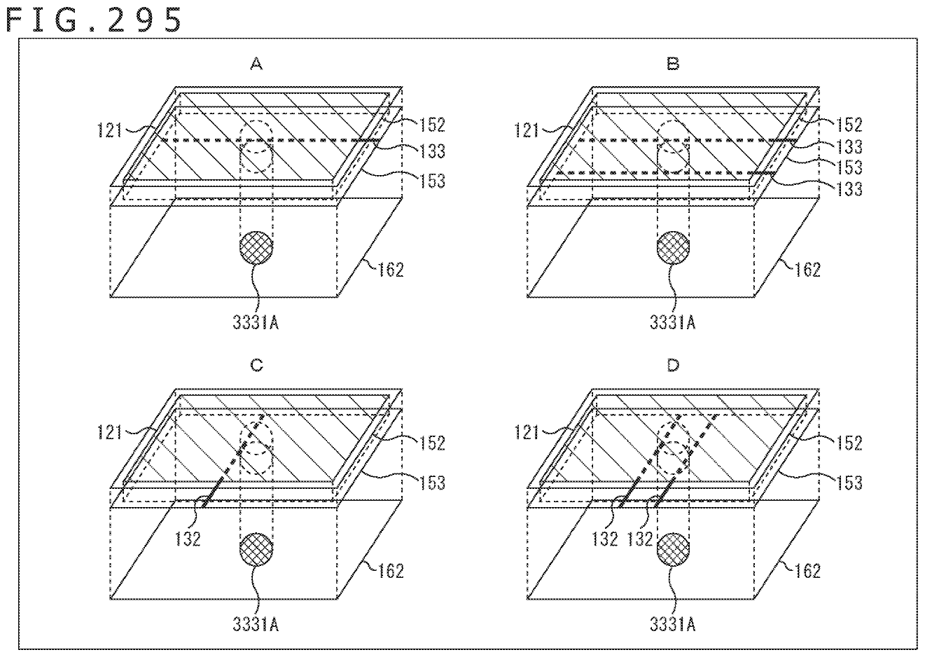

A in FIG. 295 depicts a case in which the coil as the sensing unit 3451 includes at least part or the whole of one control line 133.

B in FIG. 295 depicts a case in which the coil as the sensing unit 3451 includes at least part or the whole of two control lines 133.

C in FIG. 295 depicts a case in which the coil as the sensing unit 3451 includes at least part or the whole of one signal line 132.

D in FIG. 295 depicts a case in which the coil as the sensing unit 3451 includes at least part or the whole of two signal lines 132.

Because conductor loops also are included in conductor coils, a conductor loop including one or more signal lines 132 or control lines 133 can be used as part of the sensing unit 3451. Because it is possible to switch enormous conductor coils in the pixel array 121 in this case, it is possible to make it difficult for an attacker to predict the implementation position of a to-be-protected region on the basis of the coil position.

<Circuit Configuration Examples of Sensing Unit>

Next, circuit configuration examples of the sensing unit 3392 that senses an attack probe and the sensing unit 3451 that senses electromagnetic wave are explained.

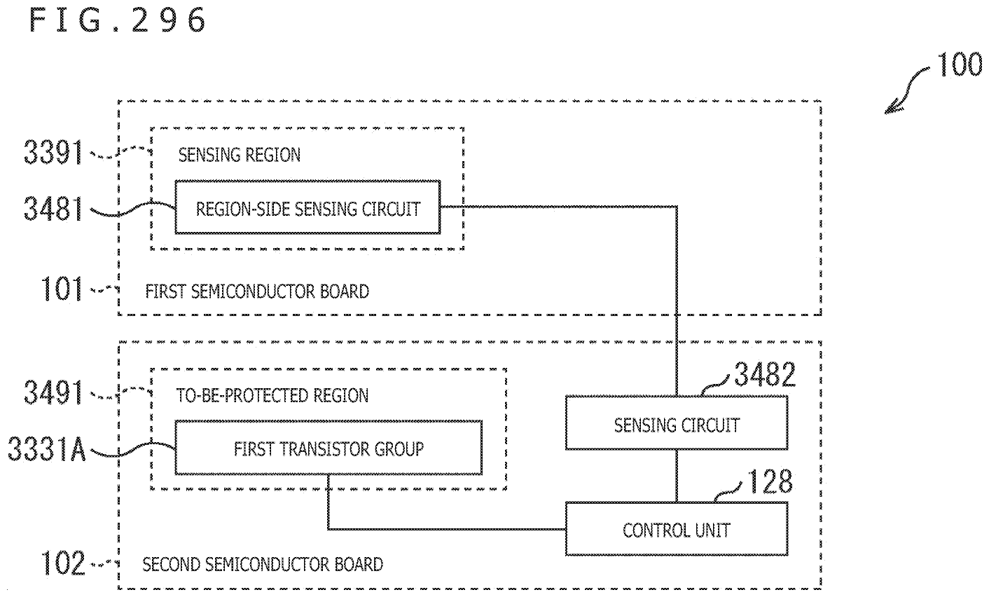

FIG. 296 is a block diagram depicting a circuit configuration example of the solid-state image pickup apparatus 100 with a focus on the sensing unit 3392 that senses an attack probe.

Note that a circuit configuration example of the sensing unit 3451 that senses electromagnetic waves also can be configured similarly to the configuration example in FIG. 296, and so an explanation about the sensing unit 3451 is omitted.

The sensing unit 3392 that senses an attack probe includes a region-side sensing circuit 3481 formed in the sensing region 3391 of the first semiconductor board 101, and a sensing circuit 3482 formed on the side of the second semiconductor board 102. A transistor of the sensing circuit 3482 is included in the third transistor group 3331C. The sensing region 3391 where the region-side sensing circuit 3481 is formed is formed at a position (e.g., an overlapping region) corresponding to a to-be-protected region 3491 where the first transistor group 3331A is formed.

In the second semiconductor board 102, the control unit 128 that controls the operation of the whole of the solid-state image pickup apparatus 100 also is arranged. Under the control of the control unit 128, the sensing circuit 3482 executes a process of sensing an attack probe, that is, the probe-deciding process in FIG. 282 or FIG. 283. The control unit 128 also performs an authentication process by using to-be-protected information stored in the to-be-protected region 3491.

While FIG. 296 depicts an example of a case in which the sensing region 3391 formed in the first semiconductor board 101 includes one region, the sensing region 3391 includes multiple separate regions in some cases.

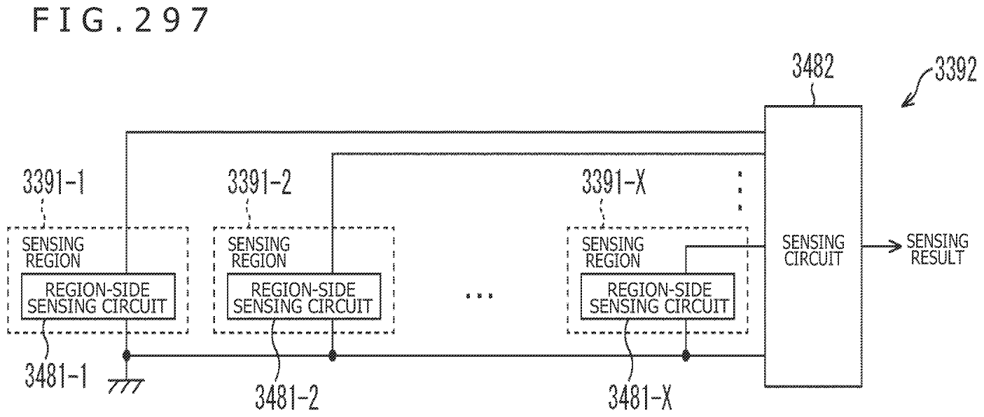

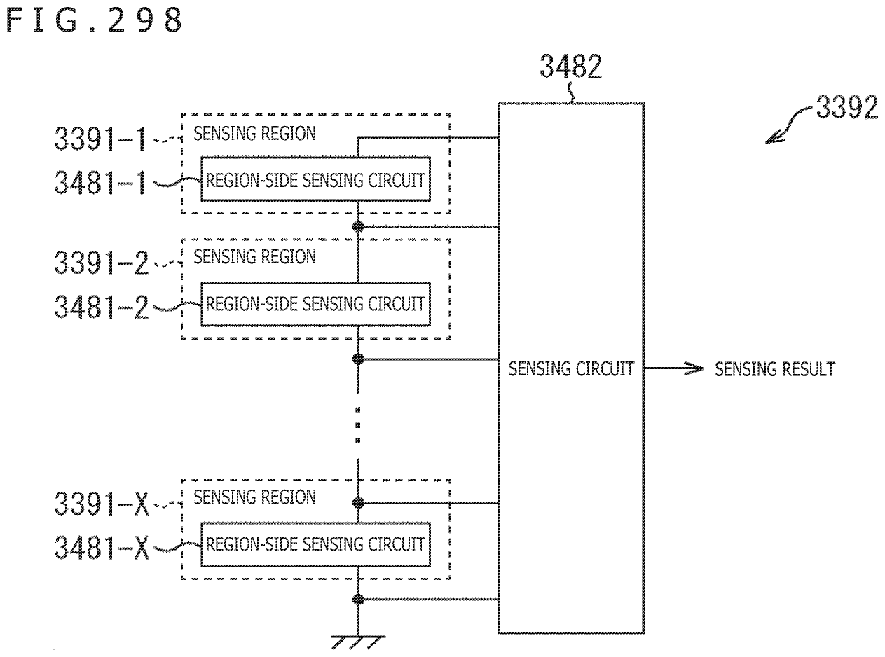

FIG. 297 and FIG. 298 depict configuration examples of the sensing unit 3392 in a case in which the sensing region 3391 formed in the first semiconductor board 101 includes multiple regions (X regions).

In FIG. 297 and FIG. 298, a region-side sensing circuit 3481 is arranged in each of X sensing regions 3391-1 to 3391-X formed in the first semiconductor board 101. That is, the region-side sensing circuits 3481 arranged in the sensing regions 3391-1 to 3391-X are region-side sensing circuits 3481-1 to 3481-X.

FIG. 297 is a block diagram depicting a configuration example of the sensing unit 3392 in which the region-side sensing circuits 3481-1 to 3481-X are connected in parallel.

FIG. 298 is a block diagram depicting a configuration example of the sensing unit 3392 in which the region-side sensing circuits 3481-1 to 3481-X are connected in series.

In a case in which multiple sensing regions 3391 are formed each for one of multiple regions in this manner, the multiple region-side sensing circuits 3481 may be connected in parallel and output sensing signals to the sensing circuit 3482 in one possible configuration, or the multiple region-side sensing circuits 3481 may be connected in series and output sensing signals to the sensing circuit 3482 in another possible configuration. In addition, parallel connection and series connection may be combined in one possible configuration, or parallel connection or series connection may be selected as appropriate in another possible configuration.

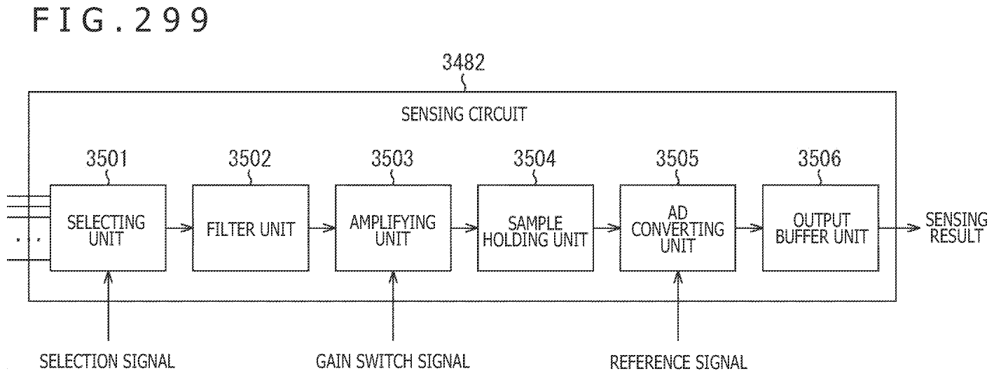

FIG. 299 is a block diagram depicting a detailed configuration example of the sensing circuit 3482.

The sensing circuit 3482 includes a selecting unit 3501, a filter unit 3502, an amplifying unit 3503, a sample holding unit 3504, an AD converting unit 3505, and an output buffer unit 3506.

The selecting unit 3501 is selectively connected with one or more of the region-side sensing circuits 3481-1 to 3481-X according to a selection signal from the control unit 128 and acquires outputs from the region-side sensing circuit(s) 3481 to which the selecting unit 3501 is connected. In a case in which the selecting unit 3501 is connected with any one of the region-side sensing circuits 3481-1 to 3481-X, a current path that goes through GND is formed, but in a case in which the selecting unit 3501 is connected with two or more of them, it may not be connected with GND (GND may be omitted).

The filter unit 3502 filters sensing signals output from the selecting unit 3501 and eliminates unnecessary noise. The amplifying unit 3503 amplifies the sensing signals after the filtering at a gain according to a gain switch signal. The sample holding unit 3504 temporarily retains the sensing signals from the amplifying unit 3503 as sampling values. The AD converting unit 3505 converts the sampling values held at the sample holding unit 3504 into digital values according to reference signals. The output buffer unit 3506 outputs the digital values as sensing results generated by the AD converting unit 3505.

Part or the whole of the sensing circuit 3482 may be used also (used in a shared manner) as some of pixel circuits in the pixel array 121 or some of peripheral circuit units such as the A/D converting unit 122, the vertical scanning unit 123, the horizontal scanning unit 125, or the output buffer 126 in one possible configuration.

Note that the sensing circuit 3482 may be configured to output sensing results only in a case in which an input value (e.g., a voltage value that changes according to an induced electromotive force) is too large or too small, that is, in a case in which the input value falls below or exceeds a threshold.

### Configuration Example of Circuit that Performs Damage Sensing Also

If an attacker cuts the first semiconductor board 101, the security threat increases. In view of this, the sensing unit 3392 that senses an attack probe can additionally have a board-damage sensing functionality of sensing damages of boards.

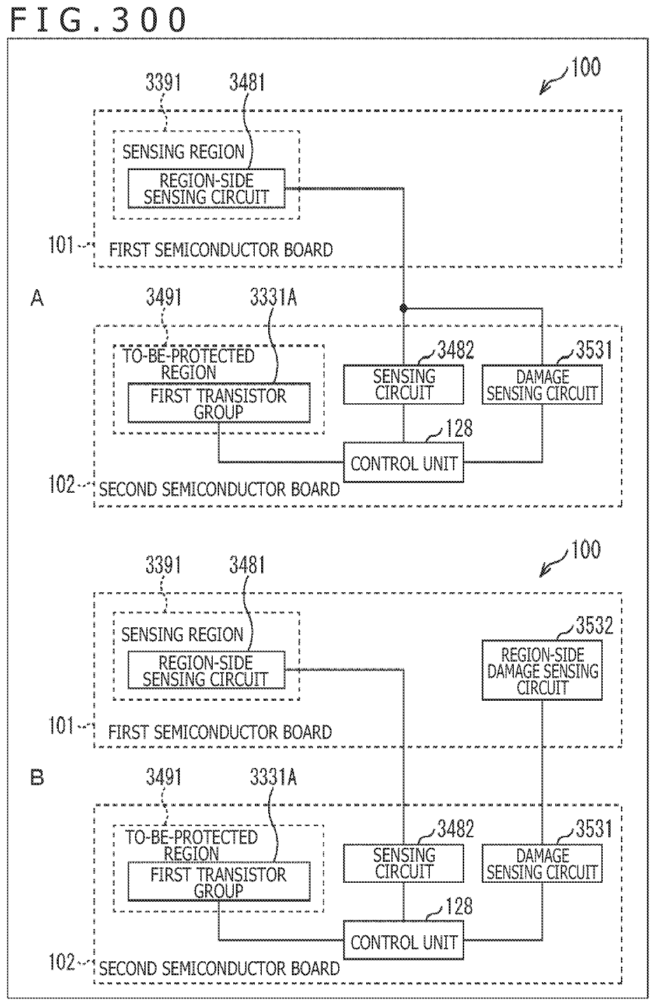

A and B in FIG. 300 are block diagrams depicting circuit configuration examples of the solid-state image pickup apparatus 100 in a case in which it additionally has a board-damage sensing functionality.

In A in FIG. 300, the second semiconductor board 102 is provided with a damage sensing circuit 3531, separately from the sensing circuit 3482. The damage sensing circuit 3531 acquires a sensing signal from the region-side sensing circuit 3481 of the first semiconductor board 101 and senses a damage of the first semiconductor board 101. For example, in a case in which the region-side sensing circuit 3481 is a pixel circuit of a pixel 131 in the pixel array 121, an abnormal value, a fixed value, or the like is output if the pixel 131 is damaged, and so the region-side sensing circuit 3481 can sense a damage on the basis of the output value. For example, in a case in which the region-side sensing circuit 3481 is a coil, the coil is short-circuited or opened if it is damaged, and so the region-side sensing circuit 3481 can sense a damage on the basis of a value output in that state. In a case in which a damage is sensed, it is sufficient if the control unit 128 does not execute the main authentication process, similarly to a case in which it is decided that there is an attack probe in the probe-deciding process. Thereby, a security attack due to a damage of the first semiconductor board 101 can be prevented before it happens.

B in FIG. 300 depicts a configuration in which a sensing signal from the region-side sensing circuit 3481 is not used for damage sensing but a sensing circuit for damage sensing is provided in the first semiconductor board 101 separately from the region-side sensing circuit 3481. A region-side damage sensing circuit 3532 of the first semiconductor board 101 outputs a sensing signal for damage sensing to the damage sensing circuit 3531.

In FIG. 296 and FIG. 300, at least one of the region-side sensing circuit 3481 and the region-side damage sensing circuit 3532 that are arranged on the side of the first semiconductor board 101 may be arranged on the side of the second semiconductor board 102; in contrast, at least one of the sensing circuit 3482 and the damage sensing circuit 3531 may be arranged on the side of the first semiconductor board 101. Alternatively, at least one of the region-side sensing circuit 3481, the region-side damage sensing circuit 3532, the sensing circuit 3482, and the damage sensing circuit 3531 may be arranged across the first semiconductor board 101 and the second semiconductor board 102.

Furthermore, the damage sensing circuit 3531 may be incorporated in the sensing circuit 3482; in contrast, the sensing circuit 3482 may be omitted, the damage sensing circuit 3531 may be provided, and only damage sensing may be performed, in another possible configuration. A similar configuration can be applied also to a case in which the sensing unit 3451 that senses electromagnetic waves additionally has the board-damage sensing functionality. That is, the solid-state image pickup apparatus 100 can have a circuit configuration for which at least one desired functionality of the attack probe sensing functionality of sensing attack probes, the electromagnetic-wave sensing functionality of sensing electromagnetic waves, and the board-damage sensing functionality of sensing damages of boards is selected.

<Electromagnetic Wave Detection by Image Pickup Apparatus 700>

Next, detection of electromagnetic attacks in the image pickup apparatus 700 on which the solid-state image pickup element 701 (corresponding to the solid-state image pickup apparatus 100) depicted in FIG. 262 is mounted, not by detection of electromagnetic waves inside the solid-state image pickup element 701 but by detection of a state of an element other than the solid-state image pickup element 701, is explained.

For example, in a case in which an electromagnetic attack is to be attempted on the solid-state image pickup element 701 in the image pickup apparatus 700 depicted in FIG. 262, it is necessary to put a predetermined lens in the optical lens group 702 out of its normal position. Accordingly, an image-formation state at the reception surface of the solid-state image pickup element 701 changes depending on the presence or absence of a lens in the optical lens group 702, and so an electromagnetic attack can be detected by detecting the change of the image-formation state.

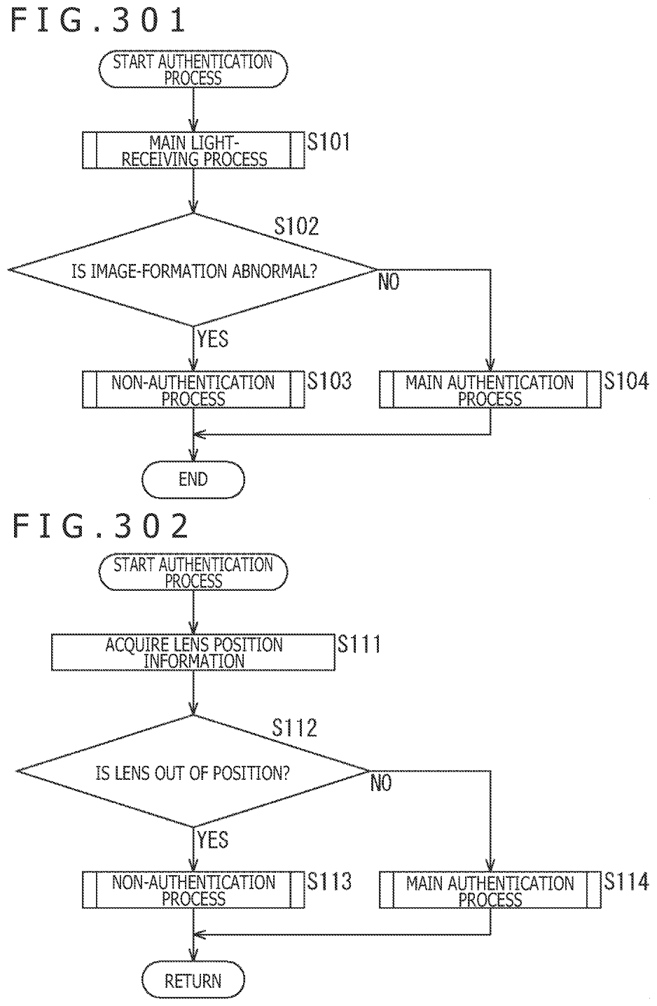

FIG. 301 is a flowchart of the authentication process in a case in which an authentication process is performed by using a change in an image-formation state. The authentication process in FIG. 301 can be executed instead of the authentication process in FIG. 281, as the authentication processes at Step S2 in FIG. 280, Step S63 in FIG. 284, and Step S84 in FIG. 285.

First, at Step S101, the control unit 706 sets the lens position of the optical lens group 702 and the state of the shutter mechanism 703 to predetermined states (controls them such that they assume predetermined control values) and causes the solid-state image pickup element 701 to execute the main light-receiving process, which is a light-receiving process for generating a captured image.

After Step S101, at Step S102, the control unit 706 decides whether or not image-formation is abnormal, on the basis of an output (image pickup signal) from the solid-state image pickup element 701. For example, the control unit 706 can decide that image-formation is abnormal in a case in which all the pixel values of pixels obtained in the main light-receiving process are pixel values representing a dark state, all the pixels values are pixel values representing a bright state, the pixel values are pixel values representing a unfocused “blurred state” (e.g., the differences between the pixel values of the pixels are smaller than a threshold), or there is excessive light at part of an active pixel region. In addition, it may be decided whether or not image-formation is abnormal on the basis of not an output of image pickup performed once but multiple outputs of image pickup performed by the solid-state image pickup element 701 twice or more. For example, it can be decided whether or not image-formation is abnormal on the basis of a difference between pixel values of the pixels obtained in the first main light-receiving process and the second main light-receiving process. Lens positions of the optical lens group 702 in the first main light-receiving process and the second main light-receiving process may be altered.

In a case in which it is decided at Step S102 that image-formation is abnormal, the process proceeds to Step S103, and the control unit 706 executes the non-authentication process and ends the authentication process.

On the other hand, in a case in which it is decided at Step S102 that image-formation is not abnormal, the process proceeds to Step S104, and the control unit 706 executes the main authentication process and ends the authentication process.

Note that the decision at Step S102 whether or not image-formation is abnormal may be made by using a signal after signal processing by the signal processing circuit 705, instead of an output (image pickup signal) from the solid-state image pickup element 701.

In addition, the decision at Step S102 may be performed on the basis of three-dimensional distribution information which includes depth information (depthwise information) in addition to two-dimensional distribution information which is plane information output by the solid-state image pickup element 701, that is, on the basis of multidimensional information. Note that, if the depth information can be acquired, it may be decided whether or not there is an object at a distance shorter than a prescribed distance, and in a case in which it is decided that there is an object at a short distance, the main authentication process at Step S104 may not be executed.

FIG. 302 is a flowchart of the authentication process in a case in which the authentication process is performed by using a lens state of the optical lens group 702. The authentication process in FIG. 302 can be executed instead of the authentication process in FIG. 281, as the authentication processes at Step S2 in FIG. 280, Step S63 in FIG. 284, and Step S84 in FIG. 285.

First, at Step S111, the control unit 706 acquires lens position information of the optical lens group 702 via the drive unit 704. For example, the control unit 706 may read out current position information of a drivable lens in the optical lens group 702 as is, or after the drivable lens is shifted to a predetermined lens position, the control unit 706 may read out lens position information after the shift.

After Step S111, at Step S112, the control unit 706 decides whether or not the lens is out of position on the basis of the acquired lens position information. For example, in a case in which the acquired lens position information represents a value out of a normal driving range, or in a case in which an error or the like has occurred when the lens is shifted to the predetermined lens positions, the control unit 706 can decide that the lens is out of position.

In a case in which it is decided at Step S112 that the lens is out of position, the process proceeds to Step S113, and the control unit 706 executes the non-authentication process and ends the authentication process.

On the other hand, in a case in which it is decided at Step S112 that the lens is not out of position, the process proceeds to Step S114, and the control unit 706 executes the main authentication process and ends the authentication process.

In the manner above, it is possible to determine whether there is a possibility of electromagnetic attacks on the basis of information associated with image pickup (image pickup information) or information related to a lens (lens information), and to decide whether or not to execute the main authentication process.

Note that, instead of performing detection about whether or not a lens is out of position on the basis of the control state or the image pickup state as mentioned above, detection may be performed by providing an electrical contact or a mechanical contact. It should be noted however that there is a possibility that a lens is simply moved from its normal position by disabling sensing by electrically connecting an extension line to the electrical contact or by fixing a solid object to the mechanical contact. Accordingly, it is considered that it is possible to take measures against electromagnetic attacks reasonably and at low costs if the detection is based on image pickup information or lens position information. It should be noted however that the solid-state image pickup element 701 and the optical lens group 702 may be configured such that they are difficult to disassemble completely without tools. For example, the solid-state image pickup element 701 and the optical lens group 702 may be completely covered around by metallic bodies by using fusion or welding.

With the authentication processes in FIG. 301 and FIG. 302, the security threat can be reduced simply.

### Configuration Example of Image Pickup Apparatus 700 Including Vibration Unit

It can be predicted also that, in a case in which an attack probe 3381 is to make an attack on an attacked target (semiconductor board), the attack probe 3381 makes an attack by being adhered to the attacked target because it is easier to attack (the attacking force is strong) if the attack probe 3381 is adhered to it.

In view of this, it is possible to provide the image pickup apparatus 700 on which the solid-state image pickup element 701 which is an attacked target is mounted with a vibration unit (vibration motor) that executes a vibration functionality mounted on a smartphone, a mobile phone, or the like.

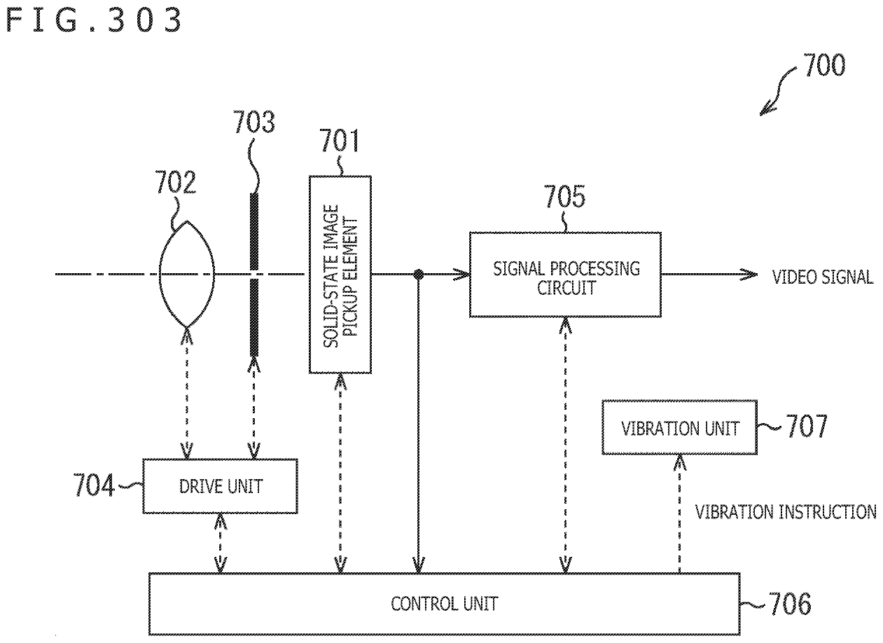

FIG. 303 is a block diagram depicting a configuration example of the image pickup apparatus 700 provided with a vibration unit.

While a vibration unit 707 is added to the image pickup apparatus 700 in FIG. 303, other than that, the image pickup apparatus 700 is similar to the image pickup apparatus 700 in FIG. 262, and so explanations of elements other than the vibration unit 707 are omitted.

The vibration unit 707 vibrates the entire apparatus according to a vibration instruction from the control unit 706. The vibration unit 707 realizes a vibration functionality in smartphones, feature phones, and the like, for example. In a case in which the control unit 706 has sensed that there is an attack probe 3381, the control unit 706 outputs a vibration instruction to the vibration unit 707 and causes the entire apparatus to be vibrated. Thereby, it becomes possible to make a counterattack, for example, by breaking (destroying) the attack probe 3381. In addition, because bonding wires and the like of an attacked target (semiconductor board) are attacked in a state in which they are uncovered in some cases, it becomes possible to make a counterattack, for example, by making it impossible for the attacked target to operate normally (by destroying the attacked target) by vibrating the attacked target or the attack probe 3381 and destroying part of the bonding wires or the attacked target by the attack probe 3381. If the attacked target is electrically connected with an external vibration unit (one example of counterattack means) directly or indirectly, it becomes possible to make a counterattack in manners like these.

Note that it may be configured such that vibration (counterattack) is activated in a case in which the number of times of the authentication process exceeds a prescribed number of times, or it may be configured such that vibration is activated in a case in which the number of times of the authentication process exceeds a prescribed number of times in a certain length of time. In addition, it may be configured such that vibration is activated before the authentication process is started and the authentication process is started after the vibration. This vibration may be activated every time the authentication process is performed, or there may be some cases when the vibration is not activated, by omitting the vibration operation in those cases. It may be made possible for the solid-state image pickup element 701 to output information necessary for a vibration instruction (counterattack instruction).

As explained above, according to the solid-state image pickup apparatus 100 and the image pickup apparatus 700 including the electromagnetic-wave attenuating unit 3341, the sensing unit (sensing circuit) 3392 that senses attack probes, the sensing unit (sensing circuit) 3451 that senses (measures) electromagnetic waves, or the damage sensing circuit 3531 that senses damages of boards, it is possible to take measures against malfunctions caused by at least one of externally-generated electromagnetic waves or leaked electromagnetic waves, but measures the present technology can take are not limited to those against security malfunctions. For example, the present technology can take measures against malfunctions caused by externally-generated electromagnetic waves of at least any of sunlight, cosmic rays, and radioactive rays. In addition, the present technology can ameliorate electromagnetic interference (EMI) from semiconductor apparatuses or electronic equipment and can improve the noise resistance or electromagnetic susceptibility (EMS) of a semiconductor apparatus or electronic equipment. For these reasons, the present technology is considered to be particularly suitable for enhancing the reliability of a semiconductor apparatus or electronic equipment.

### 18. Examples of Application to In-vivo Information Acquisition System

The technology (the present technology) according to the present disclosure can be applied to various products. For example, the technology according to the present disclosure may be applied to patient in-vivo information acquisition systems using capsule type endoscopes.

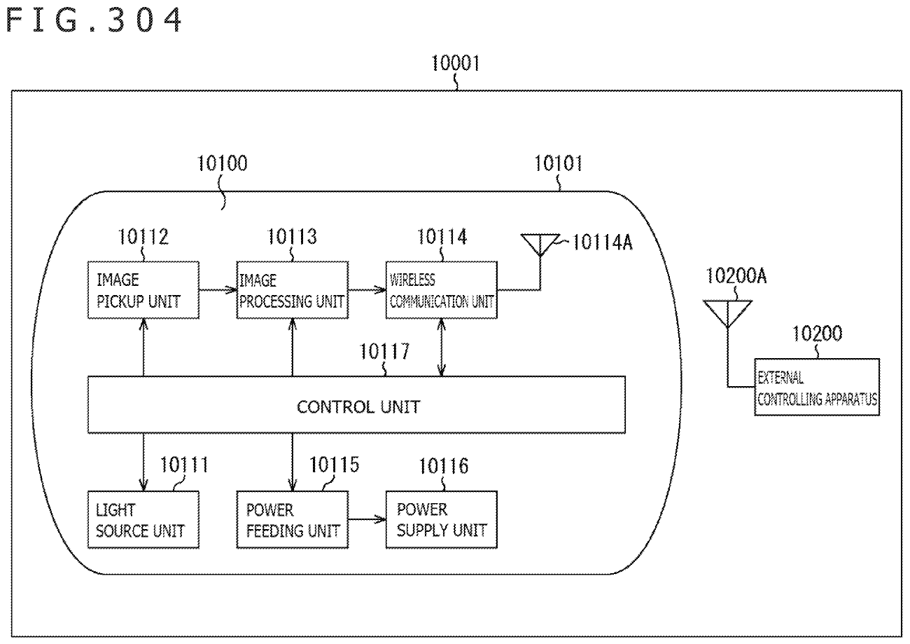

FIG. 304 is a block diagram depicting an example of a schematic configuration of an in-vivo information acquisition system of a patient using a capsule type endoscope, to which the technology according to an embodiment of the present disclosure (present technology) can be applied.

The in-vivo information acquisition system 10001 includes a capsule type endoscope 10100 and an external controlling apparatus 10200.

The capsule type endoscope 10100 is swallowed by a patient at the time of inspection. The capsule type endoscope 10100 has an image pickup function and a wireless communication function and successively picks up an image of the inside of an organ such as the stomach or an intestine (hereinafter referred to as in-vivo image) at predetermined intervals while it moves inside of the organ by peristaltic motion for a period of time until it is naturally discharged from the patient. Then, the capsule type endoscope 10100 successively transmits information of the in-vivo image to the external controlling apparatus 10200 outside the body by wireless transmission.

The external controlling apparatus 10200 integrally controls operation of the in-vivo information acquisition system 10001. Further, the external controlling apparatus 10200 receives information of an in-vivo image transmitted thereto from the capsule type endoscope 10100 and generates image data for displaying the in-vivo image on a display apparatus (not depicted) on the basis of the received information of the in-vivo image.

In the in-vivo information acquisition system 10001, an in-vivo image imaged a state of the inside of the body of a patient can be acquired at any time in this manner for a period of time until the capsule type endoscope 10100 is discharged after it is swallowed.

A configuration and functions of the capsule type endoscope 10100 and the external controlling apparatus 10200 are described in more detail below.

The capsule type endoscope 10100 includes a housing 10101 of the capsule type, in which a light source unit 10111, an image pickup unit 10112, an image processing unit 10113, a wireless communication unit 10114, a power feeding unit 10115, a power supply unit 10116 and a control unit 10117 are accommodated.

The light source unit 10111 includes a light source such as, for example, a light emitting diode (LED) and irradiates light on an image pickup field-of-view of the image pickup unit 10112.

The image pickup unit 10112 includes an image pickup element and an optical system including a plurality of lenses provided at a preceding stage to the image pickup element. Reflected light (hereinafter referred to as observation light) of light irradiated on a body tissue which is an observation target is condensed by the optical system and introduced into the image pickup element. In the image pickup unit 10112, the incident observation light is photoelectrically converted by the image pickup element, by which an image signal corresponding to the observation light is generated. The image signal generated by the image pickup unit 10112 is provided to the image processing unit 10113.

The image processing unit 10113 includes a processor such as a central processing unit (CPU) or a graphics processing unit (GPU) and performs various signal processes for an image signal generated by the image pickup unit 10112. The image processing unit 10113 provides the image signal for which the signal processes have been performed thereby as RAW data to the wireless communication unit 10114.

The wireless communication unit 10114 performs a predetermined process such as a modulation process for the image signal for which the signal processes have been performed by the image processing unit 10113 and transmits the resulting image signal to the external controlling apparatus 10200 through an antenna 10114A. Further, the wireless communication unit 10114 receives a control signal relating to driving control of the capsule type endoscope 10100 from the external controlling apparatus 10200 through the antenna 10114A. The wireless communication unit 10114 provides the control signal received from the external controlling apparatus 10200 to the control unit 10117.

The power feeding unit 10115 includes an antenna coil for power reception, a power regeneration circuit for regenerating electric power from current generated in the antenna coil, a voltage booster circuit and so forth. The power feeding unit 10115 generates electric power using the principle of non-contact charging.

The power supply unit 10116 includes a secondary battery and stores electric power generated by the power feeding unit 10115. In FIG. 304, in order to avoid complicated illustration, an arrow mark indicative of a supply destination of electric power from the power supply unit 10116 and so forth are omitted. However, electric power stored in the power supply unit 10116 is supplied to and can be used to drive the light source unit 10111, the image pickup unit 10112, the image processing unit 10113, the wireless communication unit 10114 and the control unit 10117.

The control unit 10117 includes a processor such as a CPU and suitably controls driving of the light source unit 10111, the image pickup unit 10112, the image processing unit 10113, the wireless communication unit 10114 and the power feeding unit 10115 in accordance with a control signal transmitted thereto from the external controlling apparatus 10200.

The external controlling apparatus 10200 includes a processor such as a CPU or a GPU, a microcomputer, a control board or the like in which a processor and a storage element such as a memory are mixedly incorporated. The external controlling apparatus 10200 transmits a control signal to the control unit 10117 of the capsule type endoscope 10100 through an antenna 10200A to control operation of the capsule type endoscope 10100. In the capsule type endoscope 10100, an irradiation condition of light upon an observation target of the light source unit 10111 can be changed, for example, in accordance with a control signal from the external controlling apparatus 10200. Further, an image pickup condition (for example, a frame rate, an exposure value or the like of the image pickup unit 10112) can be changed in accordance with a control signal from the external controlling apparatus 10200. Further, the substance of processing by the image processing unit 10113 or a condition for transmitting an image signal from the wireless communication unit 10114 (for example, a transmission interval, a transmission image number or the like) may be changed in accordance with a control signal from the external controlling apparatus 10200.

Further, the external controlling apparatus 10200 performs various image processes for an image signal transmitted thereto from the capsule type endoscope 10100 to generate image data for displaying a picked up in-vivo image on the display apparatus. As the image processes, various signal processes can be performed such as, for example, a development process (demosaic process), an image quality improving process (bandwidth enhancement process, a super-resolution process, a noise reduction (NR) process and/or image stabilization process) and/or an enlargement process (electronic zooming process). The external controlling apparatus 10200 controls driving of the display apparatus to cause the display apparatus to display a picked up in-vivo image on the basis of generated image data. Alternatively, the external controlling apparatus 10200 may also control a recording apparatus (not depicted) to record generated image data or control a printing apparatus (not depicted) to output generated image data by printing.

One example of the in-vivo information acquisition system to which the technology according to the present disclosure can be applied is explained above. The technology according to the present disclosure can be applied to the image pickup unit 10112 in the configuration explained above. Specifically, the solid-state image pickup apparatus 100 mentioned above can be applied as the image pickup unit 10112. By applying the technology according to the present disclosure to the image pickup unit 10112, by applying the technology according to the present disclosure to the image pickup unit 10112, the occurrence of noise is suppressed, and clearer images of surgical regions can be obtained. Accordingly, the precision of inspection is enhanced.

### 19. Examples of Application to Endoscopic Surgery System

The technology (the present technology) according to the present disclosure can be applied to various products. For example, the technology according to the present disclosure may be applied to endoscopic surgery systems.

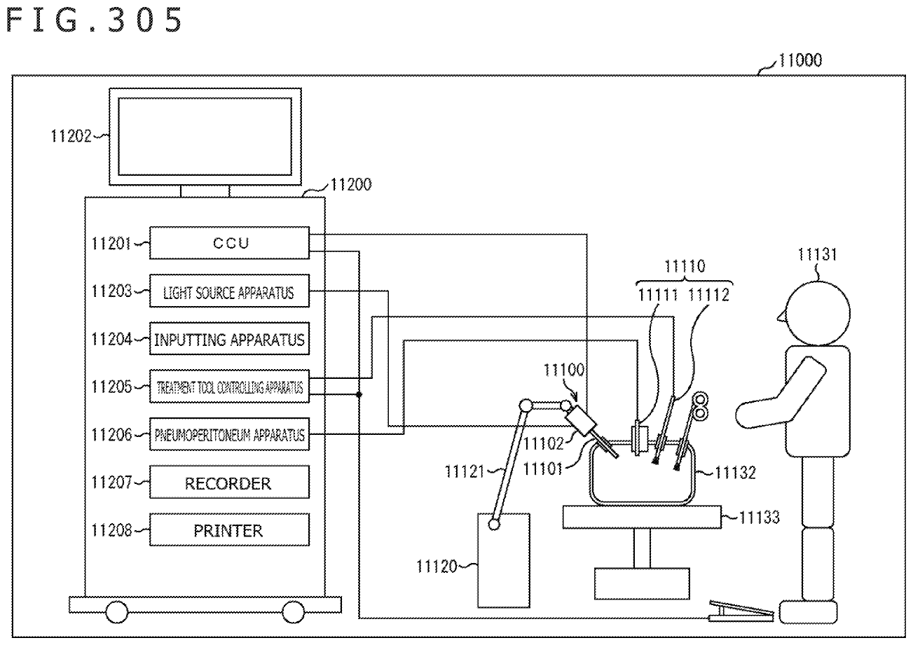

FIG. 305 is a view depicting an example of a schematic configuration of an endoscopic surgery system to which the technology according to an embodiment of the present disclosure (present technology) can be applied.

In FIG. 305, a state is illustrated in which a surgeon (medical doctor) 11131 is using an endoscopic surgery system 11000 to perform surgery for a patient 11132 on a patient bed 11133. As depicted, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the example depicted, the endoscope 11100 is depicted which includes as a rigid endoscope having the lens barrel 11101 of the hard type. However, the endoscope 11100 may otherwise be included as a flexible endoscope having the lens barrel 11101 of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an image pickup element are provided in the inside of the camera head 11102 such that reflected light (observation light) from the observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a CCU 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 includes a light source such as, for example, a light emitting diode (LED) and supplies irradiation light upon imaging of a surgical region to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are irradiated time-divisionally on an observation target and driving of the image pickup elements of the camera head 11102 are controlled in synchronism with the irradiation timings. Then images individually corresponding to the R, G and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

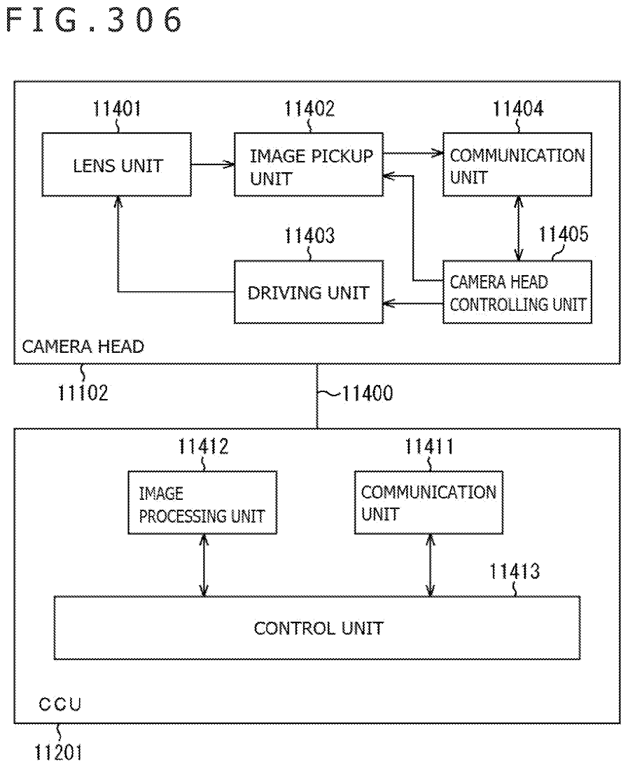

FIG. 306 is a block diagram depicting an example of a functional configuration of the camera head 11102 and the CCU 11201 depicted in FIG. 305.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the image pickup elements, and the image signals may be synthesized to obtain a color image. The image pickup unit 11402 may also be configured so as to have a pair of image pickup elements for acquiring respective image signals for the right eye and the left eye ready for three dimensional (3D) display. If 3D display is performed, then the depth of a living body tissue in a surgical region can be comprehended more accurately by the surgeon 11131. It is to be noted that, where the image pickup unit 11402 is configured as that of stereoscopic type, a plurality of systems of lens units 11401 are provided corresponding to the individual image pickup elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated and/or information that a magnification and a focal point of a picked up image are designated.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy device 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

One example of the endoscopic surgery system to which the technology according to the present disclosure can be applied is explained above. The technology according to the present disclosure can be applied, for example, to the image pickup unit 11402 of the camera head 11102 in the configuration explained above. Specifically, the solid-state image pickup apparatus 100 mentioned above can be applied as the image pickup unit 11402. By applying the technology according to the present disclosure to the image pickup unit 11402, the occurrence of noise is suppressed, and clearer images of surgical regions can be obtained. Accordingly, it becomes possible for a surgeon to check surgical regions surely.

Note that while the endoscopic surgery system is explained as one example here, the technology according to the present disclosure may be applied to others, for example, microscopic surgery systems and the like.

### 20. Examples of Application to Mobile Body

Furthermore, the technology according to the present disclosure may be realized as an apparatus to be mounted on any type of mobile body such as, for example, an automobile, an electric automobile, a hybrid electric automobile, a motorcycle, a bicycle, a personal mobility, an airplane, a drone, a ship, or a robot.

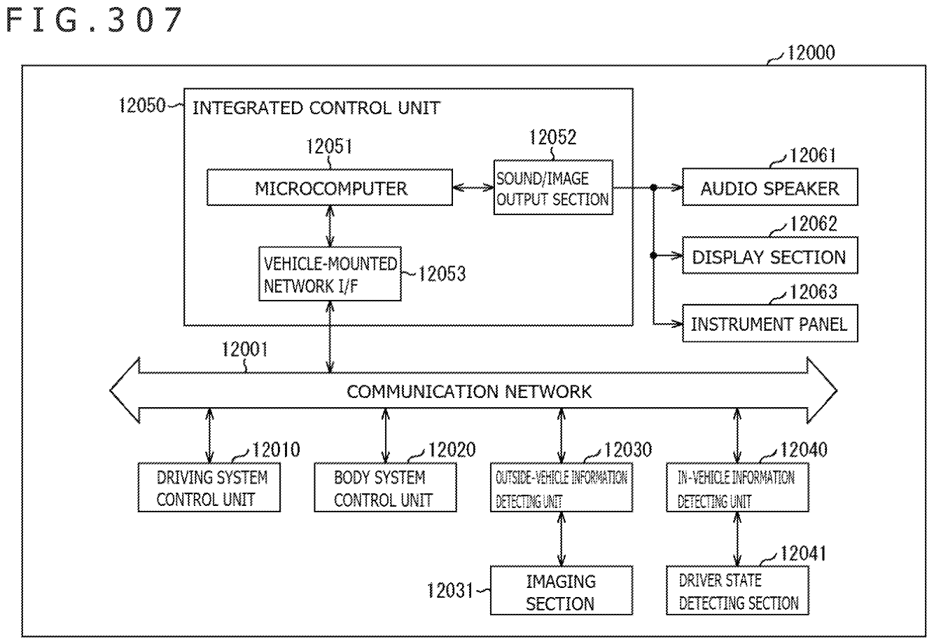

FIG. 307 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 307, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 307, an audio speaker 12061, a display section 12062, and an instrument panel 12063 are illustrated as the output device. The display section 12062 may, for example, include at least one of an on-board display and a head-up display.

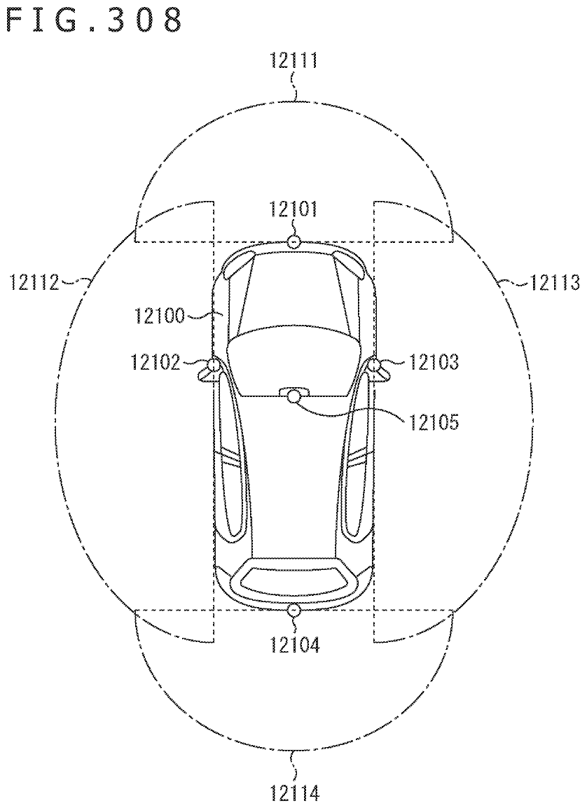

FIG. 308 is a diagram depicting an example of the installation position of the imaging section 12031.

In FIG. 308, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 308 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

One example of the vehicle control system to which the technology according to the present disclosure can be applied is explained above. The technology according to the present disclosure can be applied, for example, to the imaging section 12031 in the configuration explained above. Specifically, the solid-state image pickup apparatus 100 mentioned above can be applied as the imaging section 12031. By applying the technology according to the present disclosure to the imaging section 12031, the occurrence of noise is suppressed, and captured images that are easier to see can be obtained. Accordingly, it becomes possible to assist driving by drivers appropriately.

Embodiments of the present technology are not limited to the embodiments mentioned above, and various modifications are possible within the scope not deviating from the gist of the present technology.

Note that the effects described in the present specification are described merely for illustrative purposes, but not for limiting purposes. There may be effects other than those described in the present specification.

Note that the present technology can have configurations like the ones mentioned below.

(1)

A semiconductor apparatus including:

a first base that transmits at least part of an electromagnetic wave;

a first transistor group related to to-be-protected information; and

an electromagnetic-wave attenuating unit that is provided in at least part of a region between the first base and the first transistor group and attenuates the electromagnetic wave.

(2)

The semiconductor apparatus according to (1) above, including:

a stacked first board and second board, in which

the first board includes the first base, and a second transistor group related to a pixel,

the second board includes the first transistor group and a second base,

a thickness of the second base is greater than a thickness of the first base, and

the first base, the second transistor group, the first transistor group, and the second base have a positional relation in terms of an order in a stacking direction and are arranged in an order of the first base, the second transistor group, the first transistor group, and the second base.

(3)

The semiconductor apparatus according to (1) or (2) above, in which the first transistor group includes at least part of an encryption circuit associated with at least any one encryption method of a public key encryption method, a symmetric key encryption method, or a unique encryption method.

(4)

The semiconductor apparatus according to any of (1) to (3) above, including:

a stacked first board and second board, in which

the first board includes the first base, and a second transistor group related to a pixel,

the second board includes the first transistor group, and

as seen in a stacking direction, the electromagnetic-wave attenuating unit is arranged in a region which is at least part of a region overlapping a region of the first transistor group and is at least part of a region overlapping a region of the second transistor group.

(5)

The semiconductor apparatus according to any of (1) to (3) above, including:

a stacked first board and second board, in which

the first board includes the first base, and a second transistor group related to a pixel,

the second board includes the first transistor group, and

as seen in a stacking direction, the electromagnetic-wave attenuating unit is arranged in a region which is at least part of a region overlapping a region of the first transistor group and is a region not overlapping a region of the second transistor group.

(6)

The semiconductor apparatus according to any of (1) to (5) above, including:

a stacked first board and second board, in which

the first board includes the first base,

the second board includes the first transistor group, and

the electromagnetic-wave attenuating unit includes a planar or mesh conductor including a single conductor layer or multiple conductor layers and, as seen in a stacking direction, is arranged in at least part of a region overlapping a region of the first transistor group.

(7)

The semiconductor apparatus according to any of (1) to (6) above, including:

a stacked first board and second board, in which

the electromagnetic-wave attenuating unit includes a planar or mesh conductor including a first conductor layer and a second conductor layer and, as seen in a stacking direction, is arranged in at least part of a region overlapping a region of the first transistor group,

the first board includes the first base and the first conductor layer,

the second board includes the second conductor layer and the first transistor group, and

a conductor of the first conductor layer and a conductor of the second conductor layer are electrically joined in at least part of an overlapping region as seen in the stacking direction.

(8)

The semiconductor apparatus according to any of (1) to (7) above, including:

a stacked first board and second board, in which

the first board includes the first base,

the second board includes the first transistor group, and

the electromagnetic-wave attenuating unit includes a conductor coil including a single conductor layer or multiple conductor layers and is arranged in at least part of a region overlapping a region of the first transistor group.

(9)

The semiconductor apparatus according to any of (1) to (7) above, including:

a stacked first board and second board, in which

the first board includes the first base,

the second board includes the first transistor group, and

the electromagnetic-wave attenuating unit includes a conductor coil including a single conductor layer or multiple conductor layers and is arranged in a region not overlapping a region of the first transistor group.

(10)

The semiconductor apparatus according to any of (1) to (9) above, in which

the electromagnetic-wave attenuating unit includes a conductor coil including a single conductor layer or multiple conductor layers, and

the conductor coil includes a first conductor coil and a second conductor coil.

(11)

The semiconductor apparatus according to any of (1) to (10) above, including:

a stacked first board and second board, in which

the first board includes the first base, a second transistor group related to a pixel, and the electromagnetic-wave attenuating unit,

the second board includes the first transistor group, and

the electromagnetic-wave attenuating unit is electrically linked with the second transistor group directly or indirectly.

(12)

The semiconductor apparatus according to any of (1) to (11) above, including:

a stacked first board and second board, in which

the first board includes the first base,

the second board includes the electromagnetic-wave attenuating unit, the first transistor group, and a third transistor group, and

the electromagnetic-wave attenuating unit is electrically linked with at least one of the first transistor group or the third transistor group directly or indirectly.

(13)

The semiconductor apparatus according to any of (1) to (10) above, including:

a stacked first board and second board, in which

the first board includes the first base, and a second transistor group related to a pixel,

the second board includes the first transistor group, and

the electromagnetic-wave attenuating unit is electrically disconnected from the first and second transistor groups.

(14)

The semiconductor apparatus according to any of (1) to (13) above, in which the electromagnetic-wave attenuating unit includes a sensing unit that senses whether or not there is a probe.

(15)

The semiconductor apparatus according to any of (1) to (14) above, in which the electromagnetic-wave attenuating unit includes a sensing unit that senses whether or not there is an electromagnetic wave.

(16)

The semiconductor apparatus according to any of (1) to (15) above, in which the electromagnetic-wave attenuating unit includes a sensing unit that senses whether or not there is a damage of the first base.

(17)

The semiconductor apparatus according to any of (1) to (16) above, including:

a control unit that controls a process related to the to-be-protected information, in which

the control unit determines whether or not it is possible to execute at least part of the process related to the to-be-protected information on a basis of information related to a lens arranged near the first base.

(18)

The semiconductor apparatus according to any of (1) to (17) above, including:

a control unit that controls a process related to the to-be-protected information, in which

the control unit determines whether or not it is possible to execute at least part of the process related to the to-be-protected information on a basis of multidimensional information obtained by image pickup.

(19)

Electronic equipment including:

a semiconductor apparatus including
a first base that transmits at least part of an electromagnetic wave,
a first transistor group related to to-be-protected information, and
an electromagnetic-wave attenuating unit that is provided in at least part of a region between the first base and the first transistor group and attenuates the electromagnetic wave.
   (20)

The electronic equipment according to (19) above, further including:

a vibration unit.

### REFERENCE SIGNS LIST

10: Pixel board
11: Victim conductor loop
20: Logic board
21: Power supply wire
100: Solid-state image pickup apparatus
101: First semiconductor board
102: Second semiconductor board
121: Pixel array
122: A/D converting unit
123: Vertical scanning unit
131: Pixel
132: Signal line
133: Control line
141: Photodiode
Vdd: First power supply
Vss1: Second power supply
Vss2: Third power supply
152: Semiconductor base
153: Multi-layer wiring layer
162: Semiconductor base
163: Multi-layer wiring layer
165A to 165C: Wiring layer
700: Image pickup apparatus
701: Solid-state image pickup element
702: Optical lens group
703: Shutter mechanism
704: Drive unit
706: Control unit
707: Vibration unit
3331: Transistor group
3331A: First transistor group
3331B: Second transistor group
3331C: Third transistor group
3341: Electromagnetic-wave attenuating unit
3381: Attack probe
3391: Sensing region
3392: Sensing unit
3451: Sensing unit
3452: Sensing region
3461A: Outer coil
3461B: Inner coil
3462: Coil
3481: Region-side sensing circuit
3482: Sensing circuit
3491: To-be-protected region
3531: Damage sensing circuit
3532: Region-side damage sensing circuit

1. A semiconductor apparatus comprising:
a first base that transmits at least part of an electromagnetic wave;
a first transistor group related to to-be-protected information; and
an electromagnetic-wave attenuating unit that is provided in at least part of a region between the first base and the first transistor group and attenuates the electromagnetic wave.

2. The semiconductor apparatus according to claim 1, comprising:
a stacked first board and second board, wherein
the first board includes the first base, and a second transistor group related to a pixel,
the second board includes the first transistor group and a second base,
a thickness of the second base is greater than a thickness of the first base, and
the first base, the second transistor group, the first transistor group, and the second base have a positional relation in terms of an order in a stacking direction and are arranged in an order of the first base, the second transistor group, the first transistor group, and the second base.

3. The semiconductor apparatus according to claim 1, wherein the first transistor group includes at least part of an encryption circuit associated with at least any one encryption method of a public key encryption method, a symmetric key encryption method, or a unique encryption method.

4. The semiconductor apparatus according to claim 1, comprising:
a stacked first board and second board, wherein
the first board includes the first base, and a second transistor group related to a pixel,
the second board includes the first transistor group, and
as seen in a stacking direction, the electromagnetic-wave attenuating unit is arranged in a region which is at least part of a region overlapping a region of the first transistor group and is at least part of a region overlapping a region of the second transistor group.

5. The semiconductor apparatus according to claim 1, comprising:
a stacked first board and second board, wherein
the first board includes the first base, and a second transistor group related to a pixel,
the second board includes the first transistor group, and
as seen in a stacking direction, the electromagnetic-wave attenuating unit is arranged in a region which is at least part of a region overlapping a region of the first transistor group and is a region not overlapping a region of the second transistor group.

6. The semiconductor apparatus according to claim 1, comprising:
a stacked first board and second board, wherein
the first board includes the first base,
the second board includes the first transistor group, and
the electromagnetic-wave attenuating unit includes a planar or mesh conductor including a single conductor layer or multiple conductor layers and, as seen in a stacking direction, is arranged in at least part of a region overlapping a region of the first transistor group.

7. The semiconductor apparatus according to claim 1, comprising:
a stacked first board and second board, wherein
the electromagnetic-wave attenuating unit includes a planar or mesh conductor including a first conductor layer and a second conductor layer and, as seen in a stacking direction, is arranged in at least part of a region overlapping a region of the first transistor group,
the first board includes the first base and the first conductor layer,
the second board includes the second conductor layer and the first transistor group, and
a conductor of the first conductor layer and a conductor of the second conductor layer are electrically joined in at least part of an overlapping region as seen in the stacking direction.

8. The semiconductor apparatus according to claim 1, comprising:
a stacked first board and second board, wherein
the first board includes the first base,
the second board includes the first transistor group, and
the electromagnetic-wave attenuating unit includes a conductor coil including a single conductor layer or multiple conductor layers and is arranged in at least part of a region overlapping a region of the first transistor group.

9. The semiconductor apparatus according to claim 1, comprising:
a stacked first board and second board, wherein
the first board includes the first base,
the second board includes the first transistor group, and
the electromagnetic-wave attenuating unit includes a conductor coil including a single conductor layer or multiple conductor layers and is arranged in a region not overlapping a region of the first transistor group.

10. The semiconductor apparatus according to claim 1, wherein
the electromagnetic-wave attenuating unit includes a conductor coil including a single conductor layer or multiple conductor layers, and
the conductor coil includes a first conductor coil and a second conductor coil.

11. The semiconductor apparatus according to claim 1, comprising:
a stacked first board and second board, wherein
the first board includes the first base, a second transistor group related to a pixel, and the electromagnetic-wave attenuating unit,
the second board includes the first transistor group, and
the electromagnetic-wave attenuating unit is electrically linked with the second transistor group directly or indirectly.

12. The semiconductor apparatus according to claim 1, comprising:
a stacked first board and second board, wherein
the first board includes the first base,
the second board includes the electromagnetic-wave attenuating unit, the first transistor group, and a third transistor group, and
the electromagnetic-wave attenuating unit is electrically linked with at least one of the first transistor group or the third transistor group directly or indirectly.

13. The semiconductor apparatus according to claim 1, comprising:
a stacked first board and second board, wherein
the first board includes the first base, and a second transistor group related to a pixel,
the second board includes the first transistor group, and
the electromagnetic-wave attenuating unit is electrically disconnected from the first and second transistor groups.

14. The semiconductor apparatus according to claim 1, wherein the electromagnetic-wave attenuating unit includes a sensing unit that senses whether or not there is a probe.

15. The semiconductor apparatus according to claim 1, wherein the electromagnetic-wave attenuating unit includes a sensing unit that senses whether or not there is an electromagnetic wave.

16. The semiconductor apparatus according to claim 1 wherein the electromagnetic-wave attenuating unit includes a sensing unit that senses whether or not there is a damage of the first base.

17. The semiconductor apparatus according to claim 1, comprising:
a control unit that controls a process related to the to-be-protected information, wherein
the control unit determines whether or not it is possible to execute at least part of the process related to the to-be-protected information on a basis of information related to a lens arranged near the first base.

18. The semiconductor apparatus according to claim 1, comprising:
a control unit that controls a process related to the to-be-protected information, wherein
the control unit determines whether or not it is possible to execute at least part of the process related to the to-be-protected information on a basis of multidimensional information obtained by image pickup.

19. Electronic equipment comprising:
a semiconductor apparatus including
a first base that transmits at least part of an electromagnetic wave,
a first transistor group related to to-be-protected information, and
an electromagnetic-wave attenuating unit that is provided in at least part of a region between the first base and the first transistor group and attenuates the electromagnetic wave.

20. The electronic equipment according to claim 19, further comprising:
a vibration unit.
